(19) United States
(12) Patent Application Publication
(10) Pub. No.: US 2026/0046317 A1
(43) Pub. Date: Feb. 12, 2026

(54) AI-Optimized Memory Fabric for Large Contexts and Multimodal Workloads

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/365,156

(22) Filed: Oct. 21, 2025

Related U.S. Application Data
(63) Continuation-in-part of application No. 18/779,035, filed on Jul. 21, 2024, now Pat. No. 12,143,425.
Application No. 18/779,035 is a continuation of application No. 18/581,375, filed on Feb. 20, 2024.
Application No. 18/581,375 is a continuation of application No. 17/189,161, filed on Mar. 1, 2021.
Application No. 17/189,161 is a continuation-in-part of application No. 17/061,195, filed on Oct. 1, 2020, now Pat. No. 11,570,214.
Application No. 17/061,195 is a continuation-in-part of application No. 17/035,029, filed on Sep. 28, 2020, now Pat. No. 11,546,380.
Application No. 17/035,029 is a continuation-in-part of application No. 17/008,276, filed on Aug. 31, 2020, now Pat. No. 11,323,484.
Application No. 17/008,276 is a continuation-in-part of application No. 17/000,504, filed on Aug. 24, 2020, now Pat. No. 11,477,245.
Application No. 17/000,504 is a continuation-in-part of application No. 16/855,724, filed on Apr. 22, 2020, now Pat. No. 11,218,510.
Application No. 16/855,724 is a continuation-in-part of application No. 16/836,717, filed on Mar. 31, 2020, now Pat. No. 10,917,428.
Application No. 16/836,717 is a continuation-in-part of application No. 15/887,496, filed on Feb. 2, 2018, now Pat. No. 10,783,241.
Application No. 15/887,496 is a continuation-in-part of application No. 15/823,285, filed on Nov. 27, 2017, now Pat. No. 10,740,096.
Application No. 15/823,285 is a continuation-in-part of application No. 15/788,718, filed on Oct. 19, 2017, now Pat. No. 10,861,014.
Application No. 15/788,718 is a continuation-in-part of application No. 15/788,002, filed on Oct. 19, 2017, now abandoned.
Application No. 15/788,002 is a continuation-in-part of application No. 15/787,601, filed on Oct. 18, 2017, now Pat. No. 10,860,660.
Application No. 15/787,601 is a continuation-in-part of application No. 15/616,427, filed on Jun. 7, 2017, now abandoned.
Application No. 15/616,427 is a continuation-in-part of application No. 14/925,974, filed on Oct. 28, 2015, now abandoned.
Application No. 15/887,496 is a continuation-in-part of application No. 15/818,733, filed on Nov. 20, 2017, now Pat. No. 10,673,887.
Application No. 15/818,733 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017, now abandoned.
Application No. 15/616,427 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016, now abandoned.
Application No. 15/206,195 is a continuation-in-part of application No. 15/186,453, filed on Jun. 18, 2016, now abandoned.
Application No. 15/186,453 is a continuation-in-part of application No. 15/166,158, filed on May 26, 2016, now abandoned.
Application No. 15/166,158 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
Application No. 16/855,724 is a continuation-in-part of application No. 16/777,270, filed on Jan. 30, 2020, now Pat. No. 11,025,674.
Application No. 16/777,270 is a continuation-in-part of application No. 16/720,383, filed on Dec. 19, 2019, now Pat. No. 10,944,795.
Application No. 16/720,383 is a continuation of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 17/000,504 is a continuation-in-part of application No. 16/412,340, filed on May 14, 2019, now Pat. No. 11,539,663.
Application No. 16/412,340 is a continuation-in-part of application No. 16/267,893, filed on Feb. 5, 2019, now abandoned.
Application No. 16/267,893 is a continuation-in-part of application No. 16/248,133, filed on Jan. 15, 2019, now abandoned.
Application No. 16/248,133 is a continuation-in-part of application No. 15/849,901, filed on Dec. 21, 2017, now Pat. No. 11,023,284.
Application No. 15/849,901 is a continuation-in-part of application No. 15/835,436, filed on Dec. 7, 2017, now Pat. No. 10,572,828.
Application No. 15/835,436 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017, now abandoned.
Application No. 15/616,427 is a continuation-in-part of application No. 15/141,752, filed on Apr. 28, 2016, now Pat. No. 10,860,962.
Application No. 15/849,901 is a continuation-in-part of application No. 15/835,312, filed on Dec. 7, 2017, now Pat. No. 11,055,451.
Application No. 15/835,312 is a continuation-in-part of application No. 15/186,453, filed on Jun. 18, 2016, now abandoned.
Application No. 16/248,133 is a continuation-in-part of application No. 15/813,097, filed on Nov. 14, 2017, now abandoned.
Application No. 15/813,097 is a continuation-in-part of application No. 15/616,427, filed on Jun. 7, 2017, now abandoned.
Application No. 16/248,133 is a continuation-in-part of application No. 15/806,697, filed on Nov. 8, 2017, now abandoned.
Application No. 15/806,697 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/806,697 is a continuation-in-part of application No. 15/343,209, filed on Nov. 4, 2016, now Pat. No. 11,087,403.
Application No. 15/343,209 is a continuation-in-part of application No. 15/237,625, filed on Aug. 15, 2016, now Pat. No. 10,248,910.
Application No. 15/237,625 is a continuation-in-part of application No. 15/229,476, filed on Aug. 5, 2016, now Pat. No. 10,454,791.
Application No. 15/229,476 is a continuation-in-part of application No. 15/206,195, filed on Jul. 8, 2016, now abandoned.
Application No. 16/248,133 is a continuation-in-part of application No. 15/673,368, filed on Aug. 9, 2017, now abandoned.
Application No. 15/673,368 is a continuation-in-part of application No. 15/376,657, filed on Dec. 13, 2016, now Pat. No. 10,402,906.
Application No. 17/061,195 is a continuation-in-part of application No. 15/879,801, filed on Jan. 25, 2018, now abandoned.
Application No. 15/879,801 is a continuation-in-part of application No. 15/379,899, filed on Dec. 15, 2016, now abandoned.
Application No. 15/379,899 is a continuation-in-part of application No. 15/376,657, filed on Dec. 13, 2016, now Pat. No. 10,402,906.
Application No. 17/189,161 is a continuation-in-part of application No. 16/709,598, filed on Dec. 10, 2019, now Pat. No. 11,507,858.
Application No. 16/709,598 is a continuation-in-part of application No. 14/925,974, filed on Oct. 28, 2015, now abandoned.
(60) Provisional application No. 62/568,312, filed on Oct. 4, 2017.
(60) Provisional application No. 62/568,305, filed on Oct. 4, 2017.
(60) Provisional application No. 62/568,307, filed on Oct. 4, 2017.
(60) Provisional application No. 62/568,291, filed on Oct. 4, 2017.
(60) Provisional application No. 62/568,298, filed on Oct. 4, 2017.

(51) Int. Cl. H04L 9/40; G06F 9/48; G06F 9/50; G06F 16/2458; G06F 16/951

(52) U.S. Cl. CPC H04L 63/20; G06F 9/5038; G06F 16/2477; G06F 16/951; H04L 63/1425; H04L 63/1441; G06F 9/4881

(57) ABSTRACT

A coherent, intelligent, packet-switched memory fabric enables predictive, cache-coherent access across distributed compute, accelerator, and memory resources using a Memory-Fabric Transaction Layer Protocol (MF-TLP). MF-TLP defines routable packet formats for read, write, vectorized, atomic, reduction, collective, and predictive-prefetch transactions executed by memory-centric network interface controllers (MC-NICs). Each MC-NIC performs packet parsing, address translation, coherence management, and near-memory arithmetic or tensor operations while coordinating with MF-TLP-aware switches providing hierarchical directory control, multi-path routing, and in-network aggregation. Vectorized and multimodal packets encode multiple addresses or tensor offsets to reduce scatter/gather overhead, and programmable caching and quality-of-service modules manage tiered memory and tenant fairness. MF-TLP supports extension headers for predictive prefetch, collective coordination, and tenant governance, operating across hierarchical leaf-spine topologies using Ultra-Ethernet Transport, InfiniBand, or CXL fabrics. The system delivers scalable, low-latency, memory-centric orchestration for large-language-model training, multimodal AI, and data-intensive analytics.

### CROSS-REFERENCE TO RELATED APPLICATIONS

Priority is claimed in the application data sheet to the following patents or patent applications, each of which is expressly incorporated herein by reference in its entirety:
Ser. No. 18/779,035
Ser. No. 18/581,375
Ser. No. 17/189,161
Ser. No. 17/061,195
Ser. No. 17/035,029
Ser. No. 17/008,276
Ser. No. 17/000,504
Ser. No. 16/855,724
Ser. No. 16/836,717
Ser. No. 15/887,496
Ser. No. 15/823,285
Ser. No. 15/788,718
Ser. No. 15/788,002
Ser. No. 15/787,601
62/568,312
Ser. No. 15/616,427
Ser. No. 14/925,974
62/568,305
62/568,307
Ser. No. 15/818,733
Ser. No. 15/725,274
Ser. No. 15/655,113
Ser. No. 15/237,625
Ser. No. 15/206,195
Ser. No. 15/186,453
Ser. No. 15/166,158
Ser. No. 15/141,752
Ser. No. 15/091,563
Ser. No. 14/986,536
Ser. No. 16/777,270
Ser. No. 16/720,383
Ser. No. 15/823,363
Ser. No. 16/412,340
Ser. No. 16/267,893
Ser. No. 16/248,133
Ser. No. 15/849,901
Ser. No. 15/835,436
Ser. No. 15/790,457
Ser. No. 15/790,327
62/568,291
62/568,298
Ser. No. 15/376,657
Ser. No. 15/879,801
Ser. No. 16/709,598
Ser. No. 19/363,665
Ser. No. 19/363,059
Ser. No. 19/339,295
Ser. No. 19/315,860
Ser. No. 19/308,299
Ser. No. 19/264,846
Ser. No. 19/252,175
Ser. No. 19/183,827
Ser. No. 19/080,768
Ser. No. 19/079,358
Ser. No. 19/056,728
Ser. No. 19/041,999
Ser. No. 18/656,612
63/551,328
Ser. No. 19/180,100
Ser. No. 19/280,079
Ser. No. 19/183,828
Ser. No. 19/177,640
Ser. No. 19/172,638
Ser. No. 19/094,808
Ser. No. 19/078,192
Ser. No. 19/176,123
Ser. No. 19/079,385
Ser. No. 19/077,761
Ser. No. 19/032,020
Ser. No. 18/679,439
Ser. No. 18/359,895
Ser. No. 18/359,883
Ser. No. 19/009,889
Ser. No. 19/008,636

### BACKGROUND OF THE INVENTION

### Field of the Art

The present invention relates generally to computer system interconnects and, more particularly, to systems, methods, and hardware implementing a coherent, packet-switched memory fabric and a Memory-Fabric Transaction Layer Protocol (MF-TLP) that enable predictive-prefetch, vectorized, atomic, reduction, and collective transactions across heterogeneous compute, memory, storage, and network resources. The invention further relates to hierarchical orchestration, multimodal tensor sharing, and programmable caching frameworks that extend the coherent fabric into large-scale artificial-intelligence and analytics environments, providing distributed, cache-coherent access, adaptive quality-of-service governance, and in-network compute capabilities for unified data-center and AI-factory architectures.

### Discussion of the State of the Art

Conventional computing platforms employ a variety of interconnect technologies to enable communication between processors, accelerators, and memory resources. Standards such as PCI Express (PCIe), Compute Express Link (CXL), InfiniBand, and RDMA over Converged Ethernet (RoCE) provide high-bandwidth point-to-point connectivity and, in certain cases, limited forms of memory sharing. PCIe 5.0 achieves 32 GT/s per lane with theoretical bandwidths exceeding 64 GB/s in x16 configurations, while CXL 3.0 permits limited memory pooling and sharing between hosts and devices but retains coherence domains anchored to CPU-resident home agents. InfiniBand HDR and RoCE v2 enable RDMA verbs for direct load/store access but treat data as opaque payloads without system-wide coherence. Although these technologies expose basic DMA and atomic primitives, they remain constrained to endpoint-centric or host-anchored topologies.

These conventional interconnects exhibit structural limitations when extended to large-scale, disaggregated environments. CXL and PCIe rely on processor-managed snoop hierarchies, limiting scalability beyond single-node domains. InfiniBand and RoCE require explicit session management between endpoints and lack native hardware support for directory-based or multicast coherence. Transport-layer reliability is achieved through connection semantics that add latency and overhead unsuitable for dynamic, data-parallel workloads. Consequently, these technologies cannot provide fabric-wide cache coherence, in-network computation, or memory-semantic packet routing required by distributed AI systems operating across thousands of heterogeneous devices.

In current systems, atomic, collective, and vectorized operations are confined to processors or accelerators at transaction endpoints. Operations such as gradient reductions, parameter synchronization, or large-context attention fetches traverse the network multiple times, consuming bandwidth and requiring software orchestration. Collective primitives such as All-Reduce or Ring-Reduce require O(log N) communication rounds and introduce serialization overhead that scales poorly with cluster size. Existing networks lack predictive prefetch mechanisms, near-data aggregation, and fabric-resident scheduling required for trillion-parameter language-model training or multimodal inference pipelines.

These deficiencies are exacerbated for sparse or irregular workloads. Vectorized or scatter/gather memory operations are fragmented into discrete packets with full transport framing, producing 2-5× header amplification relative to payload. Embedding lookups, attention-window fetches, or multimodal tensor exchanges that reference thousands of non-contiguous addresses generate excessive message traffic and under-utilize network throughput. Without a routable, vector-aware protocol capable of encoding multiple addresses and coherence metadata within a single transaction, high-scale AI fabrics cannot achieve deterministic latency or efficient memory access.

Accordingly, existing fabrics impose architectural bottlenecks for AI, analytics, and data-centric workloads that demand fine-grained, low-latency coordination among disaggregated compute, accelerator, and memory resources. There remains a need for an interconnect architecture that provides routable, coherent, and predictive memory-semantic transactions; executes atomic, reduction, collective, and prefetch operations directly within the network; and scales coherently across heterogeneous nodes, racks, and federated data-center domains.

The coherent memory-fabric architecture described herein addresses these deficiencies by introducing a Memory-Fabric Transaction Layer Protocol (MF-TLP) and a family of Memory-Centric Network Interface Controllers (MC-NICs) that collectively implement a distributed, cache-coherent, and programmable memory system. MF-TLP defines self-describing packet formats supporting reads, writes, atomics, reductions, collectives, predictive-prefetches, and vectorized transactions routed over Ethernet, InfiniBand, or other transports. MC-NICs terminate MF-TLP packets, perform address translation, maintain directory entries, and execute arithmetic or tensor operations near memory. Each MC-NIC may combine multiple sub-operations into a single transaction, issue predictive prefetches based on workload telemetry, and perform in-network reductions or aggregations without host involvement.

Unlike host-anchored coherence models such as CXL, the disclosed architecture distributes coherence and scheduling authority across MC-NICs, MF-TLP-aware switches, and orchestration controllers, enabling fabric-wide, directory-based coherence and programmable governance decoupled from any single home agent. MF-TLP packets carry lease tokens, sharer metadata, and tenant identifiers that allow hierarchical controllers to maintain global state and enforce service-level objectives. The architecture integrates in-network collective engines, predictive-prefetch extensions, multimodal tensor-exchange semantics, and programmable caching modules, all operating under a unified orchestration plane. The result is an intelligent, packet-switched memory fabric capable of predictive, vectorized, atomic, and collective operations with adaptive quality-of-service governance across distributed AI-factory infrastructures.

### SUMMARY OF THE INVENTION

Accordingly, the inventor has conceived and reduced to practice a coherent, intelligent packet-switched memory fabric that enables distributed, cache-coherent access and predictive orchestration of disaggregated compute, accelerator, and memory resources at data-center scale. The system implements a Memory-Fabric Transaction Layer Protocol (MF-TLP) defining routable, self-describing packet formats for memory operations including read, write, vectorized, atomic, reduction, collective, and predictive-prefetch transactions. The architecture unifies heterogeneous compute, memory, storage, and networking resources into a single coherent memory plane, enabling near-data computation, dynamic caching, and real-time workload coordination across racks and clusters.

In some embodiments, a cross-layer orchestration framework extends the coherent memory fabric through operating-system, hypervisor, and fabric-control layers. The fabric is exposed as a kernel-visible NUMA-far node and to hypervisors as a CXL-type pooled memory device. Fabric page-fault handlers, migration daemons, and telemetry services coordinate remote paging, prefetch, and swap-out based on predictive workload analysis. The hypervisor enforces tenant-specific quotas and quality-of-service (QoS) guarantees by tagging MF-TLP requests with tenant identifiers and service-level classes that drive in-hardware rate control and accounting. Cache controllers at the NIC and node accept programmable policy modules that promote, pin, demote, or evict data across HBM, DRAM, and far-memory tiers. This cross-layer orchestration enables fine-grained workload optimization and secure, multi-tenant isolation in shared AI-factory environments.

The system comprises a plurality of Memory-Centric Network Interface Controllers (MC-NICs) deployed at compute, accelerator, and memory nodes, interconnected through MF-TLP-aware switches forming a packet-switched interconnect. Each MC-NIC terminates MF-TLP packets, translates them into local memory or tensor operations, and executes arithmetic, reduction, or vectorized transformations proximate to data. Hardware blocks within the MC-NIC—such as a protocol parser, address-translation unit, coherence directory interface, vector and reduction engines, programmable caching logic, transaction scheduler, and tenant-aware QoS controller—provide line-rate packet processing and coherence enforcement without host CPU intervention. In certain embodiments, predictive and lease-based directory structures maintain global consistency while minimizing invalidation traffic and latency.

The MF-TLP protocol supports vectorized and multimodal transactions that encode multiple addresses, strides, or offsets within a single packet, allowing scatter/gather, stride, or tensor operations to execute in one transaction. The protocol further supports predictive-prefetch and collective operations, wherein partial results or tensors generated by multiple compute nodes are aggregated by MC-NICs or in-network reduction engines into consolidated results. A distributed directory-based coherence protocol maintains consistency across nodes, and extension headers carry metadata for predictive prefetch, congestion control, multicast replication, and tenant governance. These capabilities substantially reduce synchronization latency, packet overhead, and software complexity for workloads such as large-language-model (LLM) training, multimodal inference, and graph analytics.

The coherent memory fabric therefore exposes disaggregated resources as a unified, coherent address space orchestrated by MF-TLP transactions carrying both operational and policy metadata. MC-NICs operate as intelligent agents performing packet parsing, translation, coherence enforcement, vector expansion, and near-memory arithmetic. Predictive-prefetch and collective extensions allow data movement and aggregation to occur autonomously in-network, while programmable caching and tenant-governance frameworks ensure fairness and workload isolation. The system operates across standard transports such as Ultra-Ethernet Transport (UET), InfiniBand, or CXL-over-Ethernet, delivering fabric-wide coherence, governance, and in-network compute capability.

In preferred embodiments, the MC-NIC serves as both the primary coherence authority and in-network compute engine, operating independently of host-centric coherence logic. The MC-NIC terminates MF-TLP requests, maintains directory entries for lines or tensor objects it homes, issues targeted invalidations and updates, aggregates acknowledgments, and enforces lease and epoch policies. It performs typed atomics, reductions, and vectorized tensor expansions directly at the memory interface before returning coherent completions. MC-NICs may bridge to host domains such as CXL while retaining authority for MF-TLP-mapped regions. Ordering, visibility, and persistence—including failure-atomic vector commits—are enforced within the MC-NIC pipeline, enabling multi-tenant QoS control, predictive scheduling, and scale-out coherence across racks, clusters, and federated fabrics.

The system scales through a hierarchical orchestration and topology incorporating MF-TLP-aware switches, routers, and controllers that provide routable addressing, multi-path redundancy, congestion-adaptive routing, and collective aggregation. Local rack-level directories synchronize with global orchestration managers to maintain consistency across thousands of nodes. Programmable cache and QoS controllers implement policy modules distributed by the orchestration layer, allowing adaptive resource allocation based on telemetry. The fabric further supports multimodal tensor collectives, predictive routing, and programmable caching governance, enabling efficient large-scale deployment for AI training, analytics, and real-time inference. By embedding coherence, orchestration, and computation directly within the interconnect, the invention transforms the data-center fabric into a self-optimizing, coherent computing substrate capable of predictive, vectorized, and collective operations at global scale.

### BRIEF DESCRIPTION OF THE DRAWING FIGURES

FIG. 1 is a block diagram illustrating exemplary architecture of a memory-centric interconnect fabric enabling distributed, coherent access to disaggregated memory resources at data-center scale, according to an embodiment.

FIG. 2 is a block diagram illustrating an exemplary architecture of a protocol stack architecture that depicts the relative positioning of a Memory-Fabric Transaction Layer Protocol (MF-TLP) between higher-level application semantics and lower-level transport and physical signaling standards, according to an embodiment.

FIG. 3 is a block diagram illustrating an exemplary architecture of a packet format employed by the Memory-Fabric Transaction Layer Protocol (MF-TLP), according to an embodiment.

FIG. 3A is a block diagram illustrating a detailed architecture and operational flow of the MF-TLP address and tenant virtualization pipeline, according to an embodiment.

FIG. 3B is a block diagram illustrating the architecture of per-tenant logical region mapping and the associated coherence lease token mechanisms, according to an embodiment.

FIG. 4 is a block diagram illustrating exemplary architecture of a memory-centric network interface controller (MC-NIC), according to an embodiment.

FIG. 4A is a block diagram illustrating the detailed microarchitecture of the memory-centric network interface controller (MC-NIC), according to an embodiment.

FIG. 4B is a block diagram illustrating the detailed architecture of the per-tenant quality-of-service and scheduling mechanisms, according to an embodiment.

FIG. 5 is a method diagram illustrating a cache coherence protocol flow implemented across the memory fabric using the memory-fabric transaction layer protocol (MF-TLP), according to an embodiment.

FIG. 6 is a method diagram illustrating an atomic operation flow carried out within a memory-centric fabric using the Memory-Fabric Transaction Layer Protocol (MF-TLP), according to an embodiment.

FIG. 7 is a method diagram illustrating a reduction operation flow carried out in a memory-centric fabric using the Memory-Fabric Transaction Layer Protocol (MF-TLP).

FIG. 7A is a block diagram illustrating two alternative architectural topologies for executing distributed reduction operations within the memory fabric, according to an embodiment.

FIG. 8 is a method diagram illustrating a vectorized transaction flow implemented using the Memory-Fabric Transaction Layer Protocol (MF-TLP), according to an embodiment.

FIG. 9 illustrates an exemplary computing environment on which an embodiment described herein may be implemented, in full or in part.

FIG. 10 is a block diagram illustrating a high-level system architecture implementing an enhanced coherent, packet-switched memory fabric designed for distributed, disaggregated computing environments, according to an embodiment.

FIG. 11 is a block diagram illustrating an exemplary architecture of a protocol stack architecture that defines the logical layering of the Memory-Fabric Transaction Layer Protocol (MF-TLP) within the coherent memory fabric system, according to an embodiment.

FIG. 12 is a block diagram illustrating an enhanced exemplary packet structure employed by the enhanced Memory-Fabric Transaction Layer Protocol (MF-TLP), which defines a routable and extensible packet format for performing coherent memory operations across a distributed memory fabric, according to an embodiment.

FIG. 13 is a block diagram illustrating an exemplary architecture of an enhanced memory-centric network interface controller (MC-NIC), which acts as the primary hardware termination point for Memory-Fabric Transaction Layer Protocol (MF-TLP) packets within the coherent memory fabric architecture, according to an embodiment.

FIG. 14 is a flow diagram illustrating an exemplary cache coherence protocol flow implemented across a distributed coherent memory fabric using the Memory-Fabric Transaction Layer Protocol (MF-TLP), according to an embodiment.

FIG. 15 is a flow diagram illustrating an exemplary method for atomic operation flow implemented within the coherent memory fabric using the Memory-Fabric Transaction Layer Protocol (MF-TLP), according to an embodiment.

FIG. 16 is a flow diagram illustrating an exemplary method for reduction operation flow carried out within the coherent memory fabric using the Memory-Fabric Transaction Layer Protocol (MF-TLP), according to an embodiment.

FIG. 17 is a flow diagram illustrating an exemplary method for implementing the Memory-Fabric Transaction Layer Protocol (MF-TLP) across a coherent, packet-switched memory fabric, according to an embodiment.

FIG. 18 is a flow diagram of an exemplary method for a fabric-wide topology for a coherent memory fabric, according to an embodiment.

FIG. 19 is a block diagram illustrating an exemplary architecture of a sharded large-language model (LLM) context distribution architecture implemented over the coherent memory fabric, according to an embodiment.

FIG. 20 is a block diagram illustrating an exemplary system of a predictive prefetch and attention-order streaming within the coherent memory fabric architecture, according to an embodiment.

FIG. 21 is a block diagram illustrating an exemplary architecture of a multimodal fabric-shared tensor exchange pipeline, according to an embodiment.

FIG. 22 is a block diagram illustrating an exemplary architecture of a fabric-object collective operation implemented within the coherent memory fabric, according to an embodiment.

FIG. 23 is a flow diagram illustrating an exemplary method for a hierarchical collective execution flow for large-scale distributed model training using the coherent memory fabric and the memory-fabric transaction layer protocol (MF-TLP), according to an embodiment.

FIG. 24 is a block diagram illustrating an exemplary architecture of a multimodal cache-governance and quality-of-service (QoS) architecture implemented within the coherent memory fabric, according to an embodiment.

### DETAILED DESCRIPTION OF THE INVENTION

The inventor has conceived and reduced to practice an intelligent, coherent, packet-switched memory-fabric architecture that enables routable, predictive, and memory-semantic transactions across distributed compute, accelerator, and memory resources at data-center scale. The disclosed system implements a Memory-Fabric Transaction Layer Protocol (MF-TLP) defining standardized packet structures for read, write, vectorized, atomic, reduction, collective, and predictive-prefetch operations, and a plurality of Memory-Centric Network Interface Controllers (MC-NICs) that execute these transactions directly within the fabric. Each MC-NIC functions as a programmable coherence, computation, and caching engine, performing packet parsing, address translation, sharer tracking, and arithmetic or tensor-level operations proximate to memory while coordinating with MF-TLP-aware switches and routers that provide hierarchical directory management, multi-path routing, in-network reduction, and collective aggregation. The architecture further integrates multimodal tensor-sharing mechanisms, programmable caching-policy modules, and tenant-aware orchestration controllers that dynamically allocate bandwidth, cache tiers, and compute resources according to workload telemetry. Collectively, the MF-TLP protocol, MC-NIC hardware, and hierarchical orchestration infrastructure provide a unified, scalable foundation for predictive-prefetch, collective, vectorized, atomic, and reduction operations executed coherently and adaptively within the network, eliminating host-processor dependency and enabling disaggregated, memory-centric computing across heterogeneous AI-factory platforms.

In some embodiments, the system comprises a plurality of compute devices, each including one or more processors, accelerators, and local memory subsystems. The compute devices are interconnected with a plurality of memory nodes via a packet-switched interconnect fabric. Each memory node may include one or more memory arrays, such as DRAM, phase-change memory, or other persistent memory technologies. The interconnect fabric may be implemented using Ethernet, InfiniBand, or other transport technologies, and may comprise switching elements arranged in a leaf-spine, torus, or mesh topology.

Each compute device and memory node includes at least one MC-NIC that terminates MF-TLP packets. The MC-NIC is responsible for parsing incoming transactions, translating requests into local memory operations, enforcing coherence policies, and optionally executing atomic or reduction operations. The MC-NIC may include functional components such as a protocol parsing engine, an address translation unit, a memory access controller, a coherence directory interface, an atomic/reduction execution block, a scheduling unit, and a fabric interface block.

The MF-TLP protocol defines a packet structure comprising a header portion and a payload portion. The header portion may include fields such as an opcode identifying the operation type, an address or memory object identifier, vector descriptors describing multiple memory locations, tenant identifiers for governance, coherence metadata for directory participation, and transaction identifiers for matching requests and responses. The payload portion may contain data to be written, operands for atomic or reduction operations, or results to be returned to the requester.

MF-TLP opcodes may specify a wide range of operations. Read and write operations provide basic load/store semantics. Atomic operations include indivisible fetch-and-add, compare-and-swap, and typed floating-point operations, executed directly by the MC-NIC. Reduction operations aggregate multiple partial results into a consolidated value, either at a memory node or within an in-network switch. Vectorized operations allow multiple addresses or offsets to be encoded in a single transaction, supporting scatter/gather or stride-based access patterns. Fused operations may combine multiple functions, such as prefetch and initialization, into a single packet.

In one embodiment, a vectorized transaction is transmitted as a single packet containing a base address, stride, and length parameters. The destination MC-NIC expands the descriptor into multiple memory operations and issues them in parallel to its attached memory. The results are collected and assembled into a consolidated response packet that is returned to the requesting compute device. This mechanism significantly reduces packet overhead and response traffic for workloads with sparse or irregular access patterns.

In another embodiment, an atomic transaction is encapsulated into an MF-TLP packet containing an opcode and operand values. The destination MC-NIC retrieves the current value from the target memory line, applies the arithmetic or logical transformation, and commits the updated value. A completion packet may return the prior value, the updated value, or a success indicator. By executing these operations in-network, the system avoids round-trip latency to host processors and enables efficient synchronization across distributed compute devices.

Reduction operations may be supported by both MC-NICs and fabric switches. Multiple compute devices may transmit partial results to a designated reduction target. Upon receiving these packets, the reduction logic aggregates the values using an arithmetic or logical function such as summation, maximum, or bitwise AND. The aggregated result is then written back to the target memory location and optionally transmitted to contributing compute devices. Reductions may be executed incrementally as packets arrive, allowing streaming aggregation without full buffering of all inputs.

The architecture further supports fabric-wide cache coherence. Each memory node may maintain a directory structure that records which compute devices currently hold copies of a cache line. Upon receiving a read request, the node controller updates the directory entry to reflect new sharers. Upon receiving a write request, the node controller issues invalidation or update messages to all sharers before committing the new value. Coherence messages are conveyed as MF-TLP packets, enabling the directory-based protocol to operate across the same packet fabric used for memory transactions.

In some embodiments, coherence enforcement may be optimized using predictive or lease-based metadata. For example, a memory node may grant a compute device a lease on a line, valid until a specified epoch, reducing invalidation traffic. Alternatively, sharer tracking may be aggregated within a switch, lowering fan-out when multiple devices share a common line.

The disclosed fabric may also support tenant-aware governance and quality of service (QoS) enforcement. Tenant identifiers carried in MF-TLP headers allow MC-NICs or switches to enforce quotas, apply scheduling policies, or isolate workloads. Priority tags may further influence packet ordering, ensuring that latency-sensitive coherence traffic is prioritized ahead of bulk vector transfers.

In further embodiments, the Memory-Fabric Transaction Layer Protocol (MF-TLP) introduces numeric-aware reductions that are both typed and bandwidth-efficient. A reduction transaction explicitly advertises the input element type, a possibly higher-precision accumulator type, a rounding policy including stochastic rounding, and an optional sparsity/quantization codec for the on-wire and/or on-response representation of the reduction output. The memory-centric NIC (MC-NIC) widens each incoming element to the accumulator type, performs a pipelined tree reduction with optional compensated summation, and then either commits the full-precision result coherently into memory such as part of a Gather-Reduce-Scatter (GRS) operation, or emits a compressed response payload using the requested codec to reduce egress bandwidth, or both by committing full precision locally but returning a compressed response to the requester. This capability generalizes MF-TLP's atomic/reduction unit into a typed, precision-aware, compression-capable engine that is orchestrated entirely at the transaction layer, preserving routability, directory-consistent coherence, and multi-tenant governance.

The packet-level interface for typed reductions and codecs implements NAR extension fields whereby MF-TLP reduction-class opcodes including fused GRS packets are extended with a Numeric-Aware Reduction (NAR) extension header parsed by the MC-NIC at line rate. The NAR structure comprises InType as 5 bits supporting i4, i8, i16, i32, fp8 in e4m3/e5m2 formats, fp16, bf16, tf32, and fp32, AccType as 5 bits supporting i32, i64, fp16, bf16, fp32, fp64, and superaccum, RMode as 4 bits supporting RTNE, RZ, RA, RTFM, and STOCHASTIC modes, Compensate as 2 bits supporting NONE, KAHAN, and NEUMAIER for optional compensated summation, Segments as 16 bits representing the number of independent reductions in-stream as k, Codec as 5 bits supporting NONE, RLE, BMASK, TOPK, THRESH, BFQ, SIGNIDX, and QSGD, BlockSize as 8 bits such as 16/32/64 elements per block for BFQ/BMASK, ScaleMode as 3 bits supporting UNIT, MAXABS, L2, and LEARNED for quantization scale policy, StochSeedSel as 2 bits supporting TID, ADDR, EXPLICIT, and NONE, ErrFeed as 1 bit for error-feedback enabled residual accumulation, OutType as 5 bits for response/store type post-quantization such as fp16 or int8, and Flags as 8 bits including Deterministic, StableOrder, and WireOnlyCompress options.

The InType and AccType specifications enable widening such as FP8 to FP32 accumulate or INT8 to INT32 for dot products. RMode selects rounding, with STOCHASTIC using an unbiased, seedable PRNG to remove rounding bias. Compensate enables compensated summation for numerically difficult streams. Codec selects a sparsity/quantization scheme with OutType being the type after quantization. ScaleMode governs quantization scale discovery such as per-block max-abs. StochSeedSel declares how the stochastic seed is derived. ErrFeed enables an error-feedback residual loop. These fields serve as Additional Authenticated Data (AAD) for capability/auth when enabled, ensuring downstream tampering is detectable prior to execution.

The NAR header placement in existing opcodes allows attachment to standalone reductions including sum/min/max/dot operations, GRS packets where the REDUCE segment advertises NAR, and UFUNC-driven reductions where NAR constrains UFUNC types and permits the UFUNC to consume/produce quantized blocks when Codec is not NONE.

Within the existing MC-NIC pipeline comprising parser 410, memory access 420, coherence/directory 430, atomic/reduction 440, scheduler/QoS 450, and fabric I/O 460, NAR extends 440 and adds minor hooks in 410/430/450. The typed widening and preconditioning operates through a Type-Convert stage that maps InType values to AccType with hardware converters including integer sign-extension and scale, floating-point dequantizers for FP8/BF16/FP16 respecting IEEE/format idiosyncrasies, and optional block-floating exponent alignment when Codec equals BFQ. Per-segment scale is computed in parallel.

The Reduction Engine performs a balanced tree using pairwise or blockwise operations with pipeline stages sized to line rate. If Compensate is not NONE, it attaches a single-term compensation register per lane for Kahan/Neumaier operations or a small binned accumulator for reproducibility-critical streams. For dot products, a fused multiply-accumulate lane widens inputs before accumulation.

Stochastic rounding and determinism are achieved through a counter-based PRNG such as 128-bit xorshift/Philox-like that emits one variate per rounded element when RMode equals STOCHASTIC. Seeds and counters are derived deterministically from invariant header fields such as Transaction ID and address so retries yield bit-identical outcomes. A rounding-decision LUT applies probabilistic rounding to the nearest representable OutType or quantized codebook.

The codec/packer pipeline implements a post-accumulate Codec Stage that groups BlockSize elements, computes ScaleMode such as max-abs, quantizes to the declared OutType or to a code such as 1-bit sign plus index, and emits a self-describing block containing Codec, BlockSize, OutType, Scale, optional K/τ parameters, Bitmask/Indices, and Values. Supported codecs include BMASK providing block bitmask with 1-bit presence mask plus list of nonzero values, RLE for long zero runs, TOPK(K) selecting K largest magnitude elements per block plus indices, THRESH(τ) keeping elements where absolute value is greater than or equal to τ, BFQ providing block floating-point with shared exponent Scale plus mantissas, SIGNIDX providing sign bit plus index with a single Scale, and QSGD-style stochastic quantization to a small codebook.

Error-feedback buffers operate when ErrFeed equals 1, maintaining an Error Buffer holding a residual vector r per target and segment with configurable retention. Upon quantization to OutType/Codec, the quantization error e equal to \hat{x} minus x is accumulated into r and injected into the next update for the same address providing unbiased compression over time. Buffers are implemented as small SRAM windows indexed by address, line, and segment with aging to bound memory.

Integration with blocks 430 and 450 ensures that if the reduction writes back such as in GRS scatter, batches one invalidate/writeback per destination line on ordered lanes, then commits the full-precision Accumulator-type result. If the reduction returns a response, tags the response as BULK_VEC, with compressed blocks reducing egress load and thus queuing for coherence lanes. For wire-only compression where Flags. WireOnlyCompress equals 1, storage remains full-precision in memory, but responses are compressed.

The operational semantics and numeric guarantees ensure atomicity and ordering whereby reductions are element-wise atomic with respect to other operations on the same destination element/line. When the reduction modifies memory, the MC-NIC issues any required directory invalidations/updates on ordered transport streams and withholds completion until acknowledgements retire exactly as in MF-TLP's coherence flow. When the reduction only returns a response, numeric processing still completes before a response is emitted, but no coherence messages are generated.

Scales and reproducibility are managed for codecs requiring a Scale such as BFQ or SIGNIDX, where ScaleMode chooses the policy. UNIT provides no scaling with raw rounding to OutType. MAXABS sets per-block Scale equal to the maximum absolute value of x_i with mantissas normalized in the range negative one to one. L2 sets Scale equal to the L2 norm divided by the square root of BlockSize for energy-normalized quantization. LEARNED uses scale supplied in the request such as per-tensor learned scale. All scale computations and rounding are deterministic under the same data and seed, yielding bitwise identical results across retries or multi-path delivery.

Segmented reductions where Segments equals k partition the stream into k concurrent reductions such as group-by or per-row aggregations. Each segment maintains independent accumulators, compensation registers, and scale to preserve locality and numeric fidelity.

Stochastic rounding and error-feedback provide deterministic and unbiased operation. For seed derivation to preserve replay safety, the PRNG seed is derived from immutable fields as seed equal to H of TransactionID concatenated with address/line_tag concatenated with segment_id concatenated with tenant_id. StochSeedSel equal to TID uses only TransactionID, ADDR mixes in address, EXPLICIT takes a caller-provided seed in an extension field, and NONE disables stochastics. The counter is incremented per element in a canonical stream order such as block-major, element-minor. Unbiasedness ensures with stochastic rounding, the expectation of quantize(x) equals x for each element. When ErrFeed equals 1, the NIC maintains a residual buffer to further de-bias across timesteps whereby next updates add the previous residual before quantization. Residual buffers are bounded and scoped to avoid cross-tenant leakage.

Codec details and on-wire formats provide multiple compression options. BMASK block bitmask for block size B emits B presence bits followed by nz values in OutType, effective for sparse post-reduce vectors when many elements are near zero such as after thresholding. TOPK/THRESH operations include TOPK(K) selecting K largest magnitudes with payload containing indices[K], signs[K], and optional scales, and THRESH(τ) including indices where absolute value is greater than or equal to τ with either per-block or per-element representation. These codecs can be applied after accumulation to return only salient entries such as top-K gradient components.

BFQ block floating-point emits one exponent/scale per block and B mantissas in OutType such as int8, with scales derived under ScaleMode and dequantization on the receiver multiplying mantissas by Scale. SIGNIDX emits Scale, bitset of signs, and indices, reconstructing as plus or minus Scale at the receiver, used for ultra-low-bit responses of 1-2 bits per value. QSGD-style provides stochastic quantization to s levels with unbiasedness, emitting level indices and shared scale. All formats carry a small per-block header including Codec, BlockSize, OutType, ScaleMode, Scale, and K/k parameters, allowing self-describing decoding.

Data structures and sizing in one embodiment include reduction lanes comprising 8 to 32 pipelines, each with type-convert, Kahan/Neumaier register, and adder tree to AccType such as FP32/FP64 or INT64. Codec SRAM provides per-block bitmask/indices staging with typical 1 to 2 KB per in-flight block. Residual SRAM provides an optional 64 to 256 KB window keyed by address, line, and segment with LRU aging. PRNG maintains 128-bit counter state per lane or shared with lane-ID additive to generate approximately 1 variate per cycle. The controller microsequencer reads NAR header, configures lanes, and generates segment markers for multi-segment reductions.

Example flows demonstrate practical applications. For distributed ML gradient fusion with wire-only compression, multiple trainers send GRS updates targeting parameter shards. NAR advertises InType equal to fp8 e4m3, AccType equal to fp32, RMode equal to STOCHASTIC, Compensate equal to KAHAN, Codec equal to TOPK(K=8), OutType equal to int8, and WireOnlyCompress equal to 1. The MC-NIC accumulates in FP32 with compensation, then returns a top-K compressed response so the requester can update local momentum quickly, while the committed store to memory remains full precision and is made visible via ordered coherence.

For sparse GNN neighbor aggregation storing full and responding compressed, using VFETCH_NEXT plus UFUNC, neighbor features are summed in FP32, then threshold-compressed for the response to the inference server with Codec equal to THRESH(τ) and ScaleMode equal to MAXABS, while the updated per-node aggregates are stored as BF16 in memory. For embedding table update with error-feedback, workers issue GRS updates to embedding rows with InType equal to int8, AccType equal to int32, Codec equal to QSGD, and ErrFeed equal to 1. The MC-NIC adds residuals from the Error Buffer before quantization, commits int32 accumulators to memory, and returns compact QSGD responses, with the next round reusing updated residuals, reducing long-term bias.

Interactions with other features demonstrate comprehensive integration. With GRS and UFUNC, NAR constrains the UFUNC type signature and supplies scale/codec to UFUNC post-operators, with the GRS REDUCE segment simply embedding NAR. For topology-aware lanes, coherence control retains COH_CTL priority while compressed responses reduce BULK_VEC occupancy. With capability and AEAD, NAR fields are AAD-bound and compression is performed before encryption to maximize compression gains. For FDC durability, if the reduction commits to persistent memory, the persist phase runs after directory acknowledgements and before completion, independent of whether a compressed response is also returned. For VA-coherent translation, destination lines for scatter commits may be VA-tagged, with reductions proceeding after any AT rebind is resolved.

Failure handling and progress mechanisms ensure robust operation. Replay safety ensures that because stochastic rounding seeds derive from immutable headers, retries produce identical compressed outputs, with MAC/AAD when enabled preventing malleability. Overflow and saturation handling causes the engine to raise status bits for accumulator overflow or denorm flushing, with packets able to request saturate on overflow via Flags. Capacity fallback allows that on residual SRAM pressure, the NIC can disable ErrFeed per-flow while preserving correctness, though this may increase bias slightly.

Alternative embodiments provide additional capabilities including Superaccumulator where AccType equal to superaccum realizes a Kulisch/binned accumulator with wider fixed-point for FP32-accurate summation with reproducibility guarantees, then quantizes via codec. On-store compression allows for select regions where directory metadata includes a CodecTag, with the NIC storing compressed and decompressing on read in the response path, so coherent caches see decompressed data. Codec in switch enables associative reductions with switch-resident partial aggregation, where the switch may apply BFQ/SIGNIDX on partial sums using delegated keys/policies, with the home NIC finalizing accumulation/coherence.

The architecture provides significant advantages including numeric fidelity through widened AccType and compensated summation maintaining accuracy with low-precision inputs, bandwidth efficiency through block-sparsity/quantization cutting egress without changing storage semantics, deterministic stochasticity through PRNG seeding tied to Transaction ID/addresses ensuring reproducible results under retries, and protocol-level control where all behavior is specified in MF-TLP headers, enabling routable, multi-tenant, coherence-aware execution unavailable in RDMA/CXL/NVLink schemes. This long-form embodiment enables future claims to a typed, attested numeric-aware reduction executed in a memory-centric NIC that widens low-precision inputs to a higher-precision accumulator with optional compensated summation and deterministic stochastic rounding, and that applies a selectable sparsity or quantization codec to reduction outputs prior to coherent commit and/or response transmission, all governed by MF-TLP transaction-layer headers.

In further embodiments, MF-TLP augments vectorized scatter/gather semantics with a failure-atomic vector transaction primitive that provides all-or-nothing durability at vector granularity while also returning a per-element status map that enables targeted, low-overhead retries when admission checks fail for a subset of elements. Concretely, a requester emits a single MF-TLP vector write or fused GRS writeback annotated with a Vector-Tx extension. The memory-side MC-NIC expands the vector descriptor into micro-operations, performs admission and coherence preflight, journals a redo log of the intended writes under the transaction's Transaction ID 311, applies the updates, and then for persistent regions executes a durable commit before releasing completion. The response carries a Status Bitmap and optional compact error codes aligned to the original vector order so that the requester can reissue only the lanes that were not admitted, such as those experiencing translation or capability failures, preserving vector-level atomicity across crashes while avoiding full retransmission. This design composes with MF-TLP's header fields including opcode 312, address 314, vector descriptor 316, TenantID/priority 318, coherence metadata 319, and Transaction ID 311, as well as the MC-NIC pipeline comprising parser 410, memory access 420, coherence/directory 430, atomic/reduction 440, scheduler/QoS 450, and fabric I/O 460, along with ordered transport for coherence control and persistent-memory commit sequencing already disclosed.

The packet-level interface implements a Vector-Tx extension (VTXE) header that follows the base MF-TLP header. The VTXE structure comprises tx_mode as 2 bits supporting ALL_OR_NOTHING to indicate that the admitted subset will commit atomically as a unit with failure atomicity or PARTIAL_ADMIT allowing admission to filter elements but still committing the admitted set atomically. The durability field uses 3 bits to specify VOLATILE, PBarrier, PCommit, or MIRROR2 options. The status_mode field uses 2 bits to declare the status map encoding in the response as BIT1, BIT2_WITH_CODE, or RLE_BITMAP. The chunk_sz field uses 14 bits to specify maximum elements per commit chunk for very large vectors. The ppcc field uses 3 bits and cdid uses 12 bits to specify per-packet consistency and coherence domain. The admit_policy field uses 3 bits to specify STRICT_PERMS, BEST_EFFORT, or TRANSLATE_PREFETCH options. The flags field uses 8 bits for options including DeterministicOrder, IdemSaltInHeader, and WireEncrypt.

The tx_mode equal to ALL_OR_NOTHING indicates that the admitted subset will commit atomically as a unit with failure atomicity, while PARTIAL_ADMIT allows admission to filter elements but still commits the admitted set atomically. The durability field selects the persist class, with MIRROR2 invoking two-site commit. The status_mode declares the status map encoding in the response. The ppcc/cdid fields reuse MF-TLP consistency and domain fields to bind coherence control to ordered lanes and to scope invalidations.

Additional optional extensions include a RetryMask extension present on retries that lists only those indices to be retried, and a ReplayToken derived from Transaction ID 311 and an element index salt that guarantees idempotent acceptance or elision of duplicates by the memory-side MC-NIC.

The MC-NIC micro-architecture for enablement includes enhanced parser and vector expander functionality in blocks 410 and 420. The parser 410 extracts the VTXE and vector descriptor 316, handing off to a vector expander that produces a canonical, stable sequence of index and address micro-operations for stride/list processing. For VA-mode regions, the address translation module in the memory access unit 420 resolves VA to PA with prewarm hints if supplied before admission.

Admission and preflight operations in blocks 430 and 420 perform comprehensive checks for each element including capability/auth and ACL checks keyed by TenantID 318, address translation, coherence pre-acquire of exclusive ownership per destination line by issuing directory invalidations on ordered transport streams, and optional space/permission checks on persistent regions. Elements failing admission are marked REJECT with no side-effects, while elements passing admission are added to the commit set. The coherence directory interface 430 already supports sharer tracking, invalidation issuance, and update ordering.

Redo logging through a Vector-Tx log ensures failure atomicity whereby before any admitted element modifies destination memory, the NIC appends redo records to a Vector-Tx log resident in non-volatile MC-NIC memory or a reserved persistent region. The log record format includes TxID, seq, addr, len, payload_hash, and payload_ptr or inline payload. The log is append-only, with a TxBegin record emitted upon first admitted element, and a TxCommit record persisted only after all writes land. For volatile DRAM regions, the log may reside in battery-backed SRAM, while for persistent regions, the log itself is persisted such as to PMEM and completed under the chosen durability class. The memory access unit 420 already contemplates buffered commits into persistent memory arrays, and the redo log leverages the same path.

The apply engine and batch directory updates ensure admitted micro-operations are coalesced by line and applied in a deterministic order to minimize write amplification. The coherence interface 430 batches one ordered invalidation wave per line and releases the writes once acknowledgements return, consistent with the method diagrams for directory flows. The scheduler/QoS 450 and transport binding ensure invalidations/acknowledgements ride coherence-priority lanes while bulk payload movement uses elastic classes. The scheduler 450 enforces per-tenant quotas and deadline-aware ordering so that vector control does not starve coherence.

The operational semantics define comprehensive transaction behavior. For admission versus commit set handling, a Vector-Tx divides elements into REJECT for failed admission with no side effect and ADMITTED for passed preflight. The ADMITTED set forms the commit set. Under tx_mode equal to ALL_OR_NOTHING, the MC-NIC guarantees that, with respect to failures, the commit set is either fully reflected in memory or fully absent with no torn partials after recovery.

The prepare phase involves the NIC completing pre-acquires for each destination line through ordered-lane invalidations and appending redo records for all commit-set elements. Any failure prior to TxCommit persistence guarantees no visible update survives recovery. The commit phase operates differently for volatile versus persistent memory. For VOLATILE DRAM operations, the system applies writes, then persists TxCommit to the log using battery-backed or mirrored storage, then completes to the requester. For PBarrier/PCommit PMEM operations, the system applies writes to PMEM, executes persist fence for flush, then persists TxCommit, and only then is completion emitted. The memory access unit 420 already describes buffered commits into persistent arrays, and this phase simply sequences them atomically.

MIRROR2 optionally provides mirrored durability whereby the home MC-NIC coordinates a two-site commit by streaming the redo to both mirrors, obtaining ordered-lane acknowledgements for coherence at each site, executing PMEM flush at both, persisting TxCommit at both, then completing. If one mirror fails pre-commit, the transaction aborts, while if one fails post-commit, recovery at that site uses its redo log to roll forward.

Completion and status map operations ensure the response carries a Status Bitmap of length equal to the vector length or chunk if chunked, with status_mode encoding. All ADMITTED elements return OK while REJECT elements carry compact reason codes. No ADMITTED element is ever reported committed unless TxCommit was durably recorded. Recovery operations upon MC-NIC restart involve the log scanner replaying any transaction where TxBegin is present and TxCommit is present through redo to idempotence using address plus payload hash. If TxBegin is present without TxCommit, the transaction is discarded, ensuring all-or-nothing visibility of the commit set after crash.

Status maps and retry mechanisms provide efficient error handling through multiple encodings. BIT1 encoding uses 1 for admitted and committed, 0 for rejected in the common case. BIT2_WITH_CODE uses 2 bits per element plus a side table of compact reasons, such as 00 for OK, 01 for RETRY_COH_TIMEOUT, 10 for REJECT_PERM, and 11 for REJECT_TRANS. RLE_BITMAP provides run-length encoding for very large sparse failure sets. Targeted retry allows the requester to supply a RetryMask listing failed indices and the original TxID or a new TxID plus ReplayToken. The NIC elides duplicates using the replay token and re-runs admission only for those elements, with the log for the original TxID remaining immutable, guaranteeing idempotent replays. Data structures in one embodiment include a Vector-Tx Context (VXC) containing TxID 311, TenantID 318, vector_len, commit_set_bitmap, status_mode, cdid, ppcc, begin_lsn, and commit_lsn. Redo records contain TxID, seq, addr 314, len, payload_ptr or inline payload, and payload_hash. The replay table maps TxID and element_idx to state for deduplication and idempotence. Directory shadow state comprises a per-line table tracking pre-acquired lines pending commit. These integrate with the MC-NIC blocks 410/420/430/450/460 already described.

Correctness, ordering, and consistency guarantees ensure robust operation. Coherence ordering ensures directory invalidations for destination lines are issued on ordered transport streams prior to writes, with completion withheld until acknowledgements return, consistent with the base coherence flow. Consistency under PPCC ensures under SC the entire completion is sequenced after ordered control, while under RC/TSO the NIC uses fence-aware replay queues for per-packet ordering consistent with MF-TLP. Isolation guarantees rejected elements do not modify memory or directory state, while admitted elements modify memory only after redo append and coherence pre-acquire. Chunking allows very long vectors to be split into commit chunks of chunk_sz that each provide failure-atomicity and their own status map, with the requester observing chunk boundaries in the response.

Interactions with other features demonstrate comprehensive integration. Persistence operations use the durability field to select PBarrier/PCommit behavior, with the Transaction ID and ordered lanes aligning with fabric-durable commit sequencing. The underlying persistent memory arrays path in 420 is reused for both data writes and log persistence. Topology-aware lanes ensure coherence control rides coherence-priority lanes while bulk vector payloads use elastic lanes governed by scheduler 450. Security and governance ensure admission validates TenantID 318 and capability/ACL prior to logging, with scheduler 450 enforcing per-tenant quotas to contain resource use. VA-coherent lines for VA-mode vectors resolve with the translation module in 420, with admission failing closed on translation errors and the status map reflecting the failure.

Exemplary flows demonstrate practical applications. For massive scatter to embedding rows in volatile DRAM, a trainer issues a 64K-element vector scatter with tx_mode equal to ALL_OR_NOTHING and durability equal to VOLATILE. The MC-NIC pre-acquires 512 lines, logs redo, writes DRAM, marks TxCommit, and returns a BIT1 status map of all ones. On a transient coherence timeout for 32 elements, those elements are REJECT, the response returns a sparse RLE_BITMAP, and the trainer retries only those 32 elements.

For persistent feature store update in PMEM, a database engine updates a columnar segment in PMEM with durability equal to PCommit. The NIC appends redo, applies writes, issues persist fence, persists TxCommit, then completes. A sudden power loss mid-apply leads, on restart, to redo replay because TxCommit was present, restoring the full commit set atomically. For mirrored commit across two racks with durability equal to MIRROR2, the NIC streams redo to both memory nodes, obtains ordered-lane acknowledgements for directory invalidations, flushes PMEM at both, persists TxCommit at both, then completes. If the secondary fails before TxCommit, the primary aborts, returning a status map of zeros, and the requester may retry later.

Alternative embodiments provide implementation flexibility including an undo-log variant that instead of redo stores before-images to enable instantaneous abort without replay, suitable when write sizes are small and rollback latency matters. A shadow-write buffer stages writes in a shadow area and flips a commit flag per line atomically at the end, with directory readers seeing either pre- or post-image but never torn lines. Switch-assisted acknowledgements allow ToR to merge INV-ACKs per line and return a single upstream acknowledgement, shortening the prepare phase for high fan-out vectors.

The architecture provides significant advantages including crash-safety for vector writes through failure-atomicity at vector granularity that avoids torn multi-line updates while keeping MF-TLP's packet efficiency, targeted retry where the Status Bitmap avoids replaying success lanes to save bandwidth and time, transport-agnostic implementation at the transaction layer with ordered transports for coherence control compatible with Ethernet/InfiniBand fabrics contemplated in the stack, and multi-tenant readiness through admission gates and scheduler 450 integration with TenantID and QoS fields already in MF-TLP. This long-form embodiment is enabled by the existing MF-TLP header structure and MC-NIC decomposition, and supports claims directed to a transaction-layer vector write protocol that journals redo records and returns a per-element status map so that, with respect to failures, an admitted subset of vector elements is committed atomically, and failed elements can be selectively retried without reissuing the entire vector.

In the MF-TLP packet format, one or more extension headers may be interposed between the base header 310 and payload 320 to convey optional semantics that influence coherence scope, memory consistency, persistence, capability authorization, and in-NIC programmability. The extension space is parsed by the MC-NIC's protocol engine 410 at line rate and is expressly designed for forward compatibility so that legacy endpoints can ignore unrecognized extensions without jeopardizing correctness.

Extension-header framing in one embodiment encodes each extension as a fixed-length word-aligned record with a generic layout comprising type as 8 bits for registered extension id, length as 8 bits for bytes of this extension including header, flags as 8 bits for per-extension options such as must-understand, rsvd as 8 bits reserved, and bytes array of length minus 4 for extension-specific fields that are 4-byte aligned. Extensions presented herein are mapped to type identifiers reserved for MF-TLP and are authenticated as Additional Authenticated Data (AAD) when inline encryption is active.

The CDID/Consistency Extension comprises cdid as 12 bits for coherence-domain identifier representing rack, pod, or cluster, mm_class as 3 bits for memory model class including SC, TSO, RC, RA, and R/A fence options, and rsvd as 1 bit reserved. The CDID designates the coherence domain against which the directory interface 430 will enforce sharer tracking and invalidation, while the mm_class selects per-packet ordering whereby SC requests bind to ordered transport streams for all coherence control, whereas RC/TSO may utilize elastic classes for data with fence-aware replay at the NIC boundary. Transport backpressure signals can throttle high-fan-out invalidations in CDID scopes, as contemplated by the cross-layer signaling section.

The Lease-Token Extension comprises epoch_id as 32 bits for monotonically increasing epoch, ttl_us as 24 bits for microsecond lease duration, and rsvd as 8 bits reserved. A read response may carry a Lease-Token authorizing a lease-bounded shared copy, with the token remaining valid until the encoded epoch/TTL expires. Writers invalidate only non-expired lease holders, pruning fan-out in read-mostly regions. The coherence metadata 319 already accommodates lease/version bits, and this extension formalizes the wire encoding.

The Sharer-Filter Slice Extension comprises filter_id as 16 bits identifying the probabilistic filter instance and slice_bits as 256 bits for Bloom/Counting-Quotient filter slice. The memory-node NIC emits Sharer-Filter slices that summarize which racks or ToR partitions likely contain line sharers. Switches such as ToR may cache slices keyed by filter id and line_tag to replicate INV packets locally and merge INV_ACKs upstream, while the home directory maintains the authoritative per-rack/per-node state. False positives only cause benign extra invalidations, with deletes being conservative when counting structures are used.

The UFUNC Extension comprises func_id as 16 bits for tenant-scoped function identifier, code_hash as 256 bits for attestation hash of user-defined operator, type_sig as 16 bits for input/output shapes and datatypes such as fp16 to fp32 conversion, and budget as 8 bits for cycles or microseconds budget for scheduler 450 enforcement. This extension lets a requester invoke a typed, attested operator within a sandboxed UFUNC engine behind the scheduler/QoS unit 450. The code_hash binds the invocation to a pre-loaded bytecode or micro-operation bundle, type_sig allows the parser 410 to validate element widths such as FP16 inputs into FP32 accumulators, and budget integrates with per-tenant quotas and preemption.

The PersistClass Extension comprises pc as 2 bits where 00 equals VOLATILE, 01 equals PBarrier, 10 equals PCommit, and 11 equals Mirror2, with rsvd as 6 bits reserved. The PersistClass declares transactional durability for target regions whereby PBarrier requires media flush before completion, PCommit further records a durable commit marker, and Mirror2 orchestrates two-site commit across paired memory nodes using ordered control lanes, as described for persistent memory arrays and their buffered commit sequencing.

The CapToken Extension comprises nonce as 64 bits for per-transaction or per-flow nonce and mac as 128 bits for capability MAC bound to TenantID 318 and fields. Capabilities are bound to TenantID 318 and a subset of header fields including Opcode 312, Address 314, Vector 316, and CDID/mm_class to prevent confused-deputy attacks. The CapToken is verified in the parser 410 prior to execution, and when encryption is enabled, the extension is included as AAD to AES-GCM so that tampering with transaction semantics fails authentication.

New MF-TLP opcodes provide wire semantics for various operations. INV/NV_ACK operations involve INV carrying either a Sharer-List or a Sharer-Filter slice, with the directory interface 430 emitting INV on ordered control lanes. Recipients invalidate matching lines and reply INV_ACK. ToR switches may replicate INV to local compute nodes and merge INV_ACKs, returning a single upstream acknowledgement to the home node. Completion of a write awaiting invalidations is gated on acknowledgement retirement.

ATREQ/ATRESP operations enable ATREQ to ask a remote Fabric-TLB to install VA to PA mappings scoped by TenantID, with ATRESP returning translation entries and attributes such as permissions and length. The memory access unit 420 uses these to serve VA-coherent lines, with translation misses failing closed and being reflected in status.

LATCH operations direct the memory node to perform atomic CAS/FAA on a latch word and to project the resulting ownership into the NIC's directory state machine for Shared to Exclusive transitions. Vector-LATCH variants claim multiple latch keys in a canonical order to avoid deadlock, with a single batched response.

UFUNC_EXEC triggers execution of the UFUNC identified by func_id over a provided vector payload or stream such as from a Gather phase, with the type_sig and budget enforced by scheduler 450. UFUNC may feed a subsequent SCATTER or return a value vector, all within one transaction chain.

GRS encodes Gather-Reduce-Scatter fusion whereby the NIC expands the gather descriptor, feeds a typed reduction or UFUNC, and issues coherent scatters with batched directory updates, returning a single completion. VFETCH_NEXT performs two-stage vector indirection from index to address/range to payload, collapsing pointer-chase patterns into one NIC-executed transaction with batched responses and optional UFUNC fusion. MODE_CHANGE carries RegionID, NewModeID, ModeEpoch, and OwnerID to flip a region between global directory and owner-only federated semantics, with bridging behavior and deadlines enforced on ordered control lanes.

MC-NIC micro-architecture hooks provide enhanced functionality across multiple components. The switch-resident sharer cache at ToR maintains a Sharer Cache keyed by filter_id and line_tag. On first write, the memory node ships an INV bearing a Sharer-List, and the ToR installs a cache entry with aging based on K cycles or time-based TTL and replicates to local compute nodes. On subsequent writes, the memory node sends only a Sharer-Cache-Key, which the ToR resolves to replicate and then ACK-merges upstream. This reduces invalidation serialization pressure at the memory node and leverages the packetized control plane already disclosed.

The UFUNC Engine behind Scheduler 450 is sandboxed with per-TenantID budgets. The parser 410 verifies code_hash against a per-tenant registry, checks type_sig such as FP16 to FP32 accumulate, and time-slices execution so ordered control traffic is never starved. Preemption points are inserted between vector blocks, with overruns resulting in UFUNC_TIMEOUT status and partial results not being committed.

The Vector-Tx Redo-Log for failure-atomic vectors involves the memory access unit 420 appending redo records containing TxID 311, seq, addr 314, len, and payload_hash into a Vector-Tx log prior to any memory mutation. After coherence acknowledgements retire, the NIC applies writes and persists a commit marker per PersistClass, then signals completion and emits a per-element status bitmap in the response so only failed lanes are retried. Recovery replays committed entries idempotently, with uncommitted entries being discarded.

The PMEM Flush Unit plus Dual-Commit Coordinator implements a dedicated persist engine that sequences media flush for PBarrier and commit record for PCommit. For Mirror2, a two-site coordinator drives ordered invalidations and flushes at both sites and waits for commit acknowledgements before completion, reusing the ordered transport class for control.

Representative execution flows demonstrate the system operation. For coherent GRS with typed reduction and leases, a requester forms one GRS packet with a vector Gather list, UFUNC or typed reduction extension, CDID/Consistency selecting SC, and Lease-Token acceptance flag in the request. The home NIC expands the gather, runs reduction in the atomic/reduction 440 optionally via UFUNC, issues invalidations to non-expired lease holders only, scatters consolidated results, and returns a single completion. Control rides ordered lanes while bulk gather and response ride elastic lanes. For VA-coherent pointer-chase with translation prewarm, a VFETCH_NEXT request includes ATREQ hints that pre-warm the Fabric-TLB at the destination. The NIC resolves translations, performs stage-1 and stage-2 reads locally, batches responses, and signals completion. Stale translations cause per-element REJECT bits in the status map with no side effects occurring for those lanes.

For mode-morphing transition, telemetry shows rising invalidation rate times fanout for a region, prompting scheduler 450 to trigger MODE_CHANGE from G to HYB to F. The home NIC emits a Mode-Change Notice with ModeEpoch+1 and OwnerID, ToR replicates, and caches switch to lease or owner semantics per MCN. Stale-epoch requests receive ModeRedirect responses and are safely retried under the new epoch.

Ordering, transport binding, and backpressure ensure proper system operation whereby coherence control messages including INV/ACK, MODE_CHANGE, OTR/ORL, and ATREQ/ATRESP are bound by mm_class to ordered transport streams to guarantee serialization of directory effects. Bulk vector data and UFUNC streams utilize elastic classes, with deadline-aware scheduling to prioritize control under congestion. Transport backpressure signals may throttle invalidation fan-out at the NIC to avoid fabric buffer overruns.

Security, governance, and multi-tenant operation are enforced through comprehensive mechanisms. Before execution, the parser 410 validates CapToken through MAC over TenantID 318, Opcode 312, Address 314, Vector 316, and CDID/mm_class, and validates the UFUNC code_hash if present. The ATU enforces per-tenant address maps, and scheduler 450 applies per-tenant quotas and budgets including UFUNC budget to ensure isolation. When encryption is enabled, extension headers are included as AAD so that any change to semantics fails authentication.

Error handling and replay safety mechanisms ensure all transactions carry Transaction ID 311 for response matching and replay safety. Ordered control ensures idempotent directory transitions, while Vector-Tx logs guarantee all-or-nothing commit for the admitted subset with a status bitmap enabling targeted retries. For UFUNC, UFUNC_TIMEOUT or TYPE_MISMATCH are surfaced in a compact per-segment status table alongside vector results.

Backward compatibility and versioning ensure unrecognized extensions are ignored unless flags.must_understand equals 1, in which case the NIC returns an UNSUP_EXT error. Opcodes introduced here are allocated in a reserved space, with legacy endpoints simply routing them without attempting in-fabric execution, preserving routability and interoperability.

The systems and methods disclosed herein provide significant performance benefits for modern workloads. In a machine learning training environment, MF-TLP vectorized transactions accelerate sparse embedding lookups by fetching multiple rows with a single request, while atomic transactions accelerate gradient accumulation by resolving concurrent updates directly at the memory node. In high-performance computing workloads, reduction operations accelerate collective communication patterns such as all-reduce. In database systems, atomic increments and vectorized scans improve concurrency and query efficiency.

This integrates seamlessly with the existing architecture where vector semantics, fused operations, and reductions extend the vector descriptor 316 and reduction opcodes to chain GRS and typed/programmable operators, fitting the packet architecture and the atomic/reduction 440 execution path. Directory-based coherence through INV/ACK flows and lease-based optimizations are consistent with the directory method diagrams, now augmented with hierarchical filters and switch assists. The MC-NIC pipeline accommodates new engines including UFUNC, PMEM flush/commit, Vector-Tx log, and Fabric-TLB/ATREQ alongside parser 410, memory access 420, coherence 430, atomic/reduction 440, scheduler 450, and fabric I/O 460 already defined. Tenant/QoS mechanisms through capability tokens and per-tenant budgets reuse TenantID 318 and scheduler 450 mechanisms described for multi-tenant governance.

The additions are fully enabled by the MF-TLP extensibility and MC-NIC decomposition already taught through header extension parsing, per-packet domain/consistency selection, directory invalidation flows, in-NIC reductions, tenant-aware scheduling, and transport coupling. The result is a transaction-layer superset that generalizes coherence control with domain and lease semantics, introduces programmable and typed in-NIC operators, renders vector operations failure-atomic with partial retry, integrates durability and mirror commit at the packet layer, and enables switch-resident replication, representing capabilities absent from RDMA, CXL, and proprietary accelerator fabrics.

This embodiment relates to distributed shared-memory systems implemented over a packet-switched memory fabric. More particularly, it discloses a hierarchical, federated cache-coherence mechanism executed by memory-centric network interface controllers (MC-NICs) residing on memory nodes and/or rack gateways, the mechanism being tenant-aware and scalable to data-center scope without host CPU involvement on the memory side.

In the disclosed fabric, compute nodes comprising CPUs, GPUs, and accelerators attach to one or more top-of-rack (ToR) switches and/or rack gateways. One or more memory nodes per rack expose pools of byte-addressable memory, with each memory node integrating an MC-NIC that terminates a Memory-Fabric Transaction Layer Protocol (MF-TLP), performs translation and access to local memory devices, and executes coherence operations without software intervention. To scale coherence, MC-NICs implement two cooperating control planes comprising a Local Coherence Controller (LCC) resident in a rack, such as on a rack memory node or dedicated gateway MC-NIC, maintaining a local directory for lines actively cached by compute nodes within that rack, and a Global Coherence Director (GCD) logically distributed across memory-home MC-NICs, each maintaining a global directory for a disjoint portion of the coherent address space.

The system employs specific identifiers carried in MF-TLP headers and/or directory keys including TID as the tenant identifier, CDID as the coherence domain identifier representing a subset of a tenant, FID as the fabric identifier providing the link-layer address of an MC-NIC endpoint, RID as the rack identifier, LA as the line address such as physical line base aligned to 64B/128B, and TXNID as the transaction identifier for matching responses and acknowledgements. Unless stated otherwise, “line” denotes the minimum coherence granularity.

Directory partitioning and record format provide hierarchical management through home selection whereby the home for a line identified by TID, CDID, and LA is selected by a stable hash to a memory node owning the backing memory range. That home's MC-NIC holds the authoritative global directory record (G-DirRec) for the line, while per-rack local directory records (L-DirRec) act as sharer caches and aggregators. Each G-DirRec is keyed by TID, CDID, and LA and contains GState belonging to the set I, S, E, M, O, RO-REP, FWD, and TRANSIENT_* representing coherence state as seen at the global level where RO-REP denotes read-only replicated and FWD denotes a designated forwarder rack, SharersRID as a bitmap or compressed structure of racks caching the line in Shared or Forward state, OwnerRID as the rack currently owning exclusive/modifiable copy if any, Version as a monotonically increasing sequence number for conflict detection, LeaseEpoch as an optional epoch for lease-based optimizations, and Meta as policy bits including QoS class, durability tier, and speculative hints.

The SharersRID can be encoded as a fixed bitmap, such as up to 256 racks requiring 256 bits, or as a Bloom-filter-like compressed set with controlled false-positives. False positives are harmless because invalidations may be over-sent, while false negatives are forbidden. Each rack's LCC holds L-DirRec keyed by TID, CDID, and LA with LState belonging to the set I, S, E, M, O, Fwd, and TRANSIENT_* representing rack-scoped state, SharersFID as a list or bitmap of compute-side MC-NICs within the rack caching the line, OwnerFID as the compute-side MC-NIC in the rack holding exclusive, PendingAcks as a counter for aggregation of per-node acknowledgements, and VersionShadow as a shadow of GCD Version for race detection. The L-DirRec may be ephemeral cache and is reconstructed on demand by querying the GCD when absent or stale.

MF-TLP coherence extensions enable every MF-TLP request to carry a Coherence Intent (CohIntent) subfield where CohIntent equals RS for Read-Shared, RE for Read-Exclusive, UPG for Upgrade existing S to E/M, WB for Write-back/evict, INV for explicit invalidate, or HINT for predictive/federated directive, Scope bits specify LOCAL to satisfy using LCC only, GLOBAL to consult GCD, or AUTO for NIC decision, and Domain specified as TID and CDID binds the request to a tenant/domain. Control opcodes include INV_SET, INV_ACK, DATA, ODATA for owner-supplied data, OACK for owner acknowledgement, WB_DATA, WB_ACK, LEASE_GRANT, LEASE_REVOKE, FWD_SET for forwarder designation, and RAK for rack-aggregated acknowledgement. All coherence control opcodes are encapsulated as MF-TLP packets and routed over the same fabric as data operations.

At the global level, coherence states follow a MOESI-like lattice extended for hierarchy where I indicates line not present anywhere from the GCD's view, S indicates one or more racks hold shared, clean copies, E indicates one rack holds a clean exclusive copy with no other sharers, M indicates one rack holds a dirty exclusive copy, O indicates one rack has dirty owner while other racks may hold shared clean copies with owner supplying data on read, RO-REP indicates multiple racks hold read-only replicated copies pinned such as broadcast constants, and FWD indicates GCD has designated a rack as a forwarder for low-latency read service to peers in its locality. Within a rack, LCC states mirror global semantics at node granularity for compute MC-NICs, allowing the LCC to run an intra-rack directory to fan-in/fan-out invalidations and acknowledgements. The consistency model provided by default is sequential consistency at line granularity whereby all MF-TLP memory transactions appear in a total order consistent with program order at each node. Alternative modes such as release consistency are available for federated configurations.

Federated coherence domains and multi-tenancy enable a tenant to partition its address space into multiple Coherence Domains (CDIDs). For each TID and CDID pair, the fabric guarantees hardware coherence within the domain. Cross-domain transactions are either non-coherent with explicit synchronization, read-only shared for producer-consumer patterns, or coherently bridged by domain translators at selected MC-NICs that serialize and preserve ordering between domains. Tenant isolation ensures all directory keys include TID, with L- and G-DirRecs logically sharded by tenant, preventing any sharer set co-mingling across tenants. Two tenants mapping to the same physical LA are still distinct entries due to keying with TID. Access control logic in MC-NICs enforces that a packet's TID and CDID match the directory partition and an ACL for the target memory range. An orchestration service or hypervisor programs MC-NICs with Domain Descriptors containing TID, CDID, address ranges, durability policy, QoS class, and permitted racks. Domains can be resized or migrated at runtime with changes being versioned, and MC-NICs honor epoch barriers to switch policies atomically.

Representative protocol flows demonstrate the system operation. For local read-shared (RS), compute MC-NIC C in rack R1 issues READ with LA, CohIntent equal to RS, TID, CDID, and Scope equal to AUTO. LCC in R1 looks up L-DirRec, and if present in S, E, M, O, or Fwd and served within rack, LCC supplies data (DATA) from owner node or rack forwarder, updates SharersFID and returns. If L-DirRec miss or unresolved, LCC sends READ_META to GCD home. GCD returns either data if it is the owner and GState belongs to E, M, or O while adding R1 to SharersRID, or forwarding directive to the rack owning a clean copy through FWD_SET, or directs LCC to fetch from current owner rack. LCC installs or updates L-DirRec with LState equal to S, adds C to SharersFID, and returns DATA to C.

For write miss (RE/UPG) with hierarchical invalidation, compute MC-NIC C in rack R2 issues WRITE with LA and CohIntent equal to RE, or UPG if it has S. LCC R2 checks L-DirRec, and if no remote sharers are known with LState belonging to I, E, or M, it can grant exclusive locally and update GCD lazily, otherwise it escalates. LCC sends EXCL_REQ to GCD with TXNID. GCD reads G-DirRec, and if GState belongs to I or E with no other sharers, GCD grants exclusive immediately through EXCL_GRANT and optionally marks OwnerRID equal to R2 with GState equal to E. If GState belongs to S or O with remote sharers, GCD constructs INV_SET to all racks in SharersRID excluding R2, with the fabric optionally using multicast replication keyed by a group derived from SharersRID. Each target rack's LCC receives INV_SET with TXNID, LA, and Version and runs intra-rack invalidations by sending INV to all SharersFID, collecting INV_ACKs, and issuing a single RAK with TXNID back to GCD. If a dirty owner exists in a target rack, LCC ensures dirty owner supplies WB_DATA/ODATA upstream before acknowledging. Upon receiving all RAKs or a quorum depending on policy, GCD updates G-DirRec with OwnerRID equal to R2, SharersRID containing only R2, GState equal to E or M if dirty data provided, and returns EXCL_GRANT with DATA if needed to R2. LCC R2 updates L-DirRec with OwnerFID equal to C and LState equal to E/M, and returns write permission to C. Optionally, pre-grant allows step-ahead permissions with later completion acknowledgements. Hierarchical aggregation turns N×M invalidation acknowledgements for N racks and M nodes per rack into N rack-aggregated acknowledgements, reducing global control traffic by approximately M times.

For eviction and write-back, on eviction of a clean shared line, the compute MC-NIC sends EVICT_NOTICE to its LCC, which removes the node from SharersFID. For dirty evictions, the owner supplies WB_DATA to LCC, which either keeps a clean shared copy locally and updates GCD with GState equal to S, or forwards WB_DATA to GCD for commit, depending on policy and durability tier. For forwarding optimization, GCD may designate a rack as FWD for a hot line whereby subsequent RS to that line from other racks are redirected to the forwarder, which returns clean DATA while GCD maintains SharersRID, reducing owner rack load and global latency.

Scalability and performance mechanisms provide efficient large-scale operation. Sharer-set hierarchy ensures GCD tracks rack granularity while LCC tracks node granularity. This two-level directory reduces global metadata and traffic whereby inter-rack activity hits the GCD and intra-rack activity remains local. Forwarder designation and read-only replication operate when a line is read-mostly and accessed by multiple racks, whereby GCD may pick a forwarder rack near the requesters in FWD state or transition to RO-REP, broadcasting a pinned, read-only copy to a set of racks. In RO-REP, upgrades require revocation whereby GCD issues REVOKE_RO to participating racks and LCCs locally invalidate before any writer obtains exclusive. The MF-TLP header exposes a “read-only pledge” bit enabling software/hypervisor to declare regions RO to trigger this mode proactively.

Lease-based pre-grant for writers reduces write latency whereby GCD can issue time-bounded leases through LEASE_GRANT to a predicted next writer rack. While leases are valid, EXCL_REQ from the lessee can be satisfied by the LCC immediately and completed speculatively, with the GCD finalizing remote invalidations in the background. A completion fence returns when all RAKs are received, and until fence, the lessee may write but the line is marked TRANSIENT_M and fabric enforces dependence ordering whereby remote reads get NACK/RETRY or stale-read blocking per policy. Lease expiration or incorrect prediction triggers revocation through LEASE_REVOKE.

Policy bits in Meta select between eager invalidation with grant after all RAKs, lazy grant with pre-grant and mandatory fence before external visibility beyond domain, or hybrid with lazy within rack and eager across racks. Choices are domain-configurable. Multicast and acknowledgement coalescing allow fabric switches to implement MF-TLP-aware group replication for INV_SET, with LCCs coalescing acknowledgements per rack, reducing worst-case invalidation storms.

Failure handling and correctness mechanisms ensure robust operation. If a rack LCC fails to return RAK within a timeout, the GCD retries, then marks that rack as suspect and may drop it from SharersRID under a fencing protocol whereby all traffic from that rack's FIDs is quarantined until health is restored. If the suspect rack had the owner, GCD initiates owner recovery by soliciting the last clean copy or committing WB_DATA from a mirrored log optionally kept at the owner rack's LCC. Each transaction carries Version, and LCC and GCD accept control messages only if Version matches or is newer, discarding duplicates. NACK/RETRY is used for stale responses. For domains mapped to persistent memory tiers, GCD records state transitions in a lightweight log. WB_DATA may be acknowledged only upon durability to NVRAM/replica, ensuring crash consistency while preserving coherence.

The MC-NIC hardware blocks include a protocol parser with MF-TLP coherence extensions, a Coherence Engine implementing LCC or GCD roles, Directory SRAMs storing L-DirRec/G-DirRec such as 64 to 256 MiB aggregate per high-capacity memory node with LCC caches sized 8 to 32 MiB, multicast/acknowledgement aggregator, timer and retry unit, security/tenant filter, and QoS scheduler for control/data interleaving. Clock-gated pipelines sustain greater than or equal to 1Tb/s line-rate processing with less than 100 ns per hop control-path latency in silicon at 7 nm/5 nm.

Storage overhead calculations for 64 B lines show a 1 TiB memory node hosts approximately 16 G lines. Directory entries are sparse, allocated on first remote caching. Assuming 2% of lines active yields approximately 320 M entries. With 8B tag plus 4B Version plus 8B SharersRID compressed plus 2B meta equaling approximately 22B per entry results in approximately 7 GiB directory SRAM/DRAM, tiered with hot entries in SRAM and cold entries in HBM/DRAM with small CAM front-end. LCC caches store only rack-local activity, orders of magnitude smaller.

Deployment and bootstrap procedures involve MC-NICs receiving Domain Descriptors and home-mapping seed on rack bring-up. LCCs register to corresponding GCD shards. Health-beacons advertise rack membership, with GCD populating SharersRID on first access. Rekeying of TID/CDID and membership changes are effected via epoch increments, with LCCs flushing or transforming L-DirRecs crossing epochs. The software interface provides MMU mappings for coherent regions and issues advisory MF-TLP control operations including coh_scope_local( ), coh_scope_global( ), coh_pledge_ro(addr,len), coh_lease_hint(addr, RID), and coh_domain_fence(CDID). No interrupts or CPUs on memory nodes are required in the data path.

Hybrid and federated modes enable flexible deployment configurations. Strict global coherence with CDID equal to 0 configured global allows all racks to participate following the described operations, suitable for tightly coupled HPC/AI training jobs. Rack-local coherence plus global non-coherent configurations allow a tenant to configure per-rack CDIDs where cross-rack sharing uses software synchronization or explicit copy-in/copy-out MF-TLP operations. The same physical fabric serves both modes concurrently, eliminating inter-rack invalidations for scale-out databases while retaining fast rack-local programming semantics. Read-only federation allows a read-mostly dataset such as model weights for inference to be declared RO-REP across multiple racks. Updates occur in a maintenance window whereby a coordinator issues REVOKE_RO, applies batched writes with RE, and re-broadcasts RO-REP. Bridge configurations between heterogeneous coherence islands allow a GPU pod implementing a proprietary L1 protocol to interface through a bridge MC-NIC that translates GPU coherence messages to MF-TLP and participates as an LCC peer, with ordering preserved by serializing upgrade/invalidation sequences through the bridge ensuring single-writer semantics.

A worked sequence for multi-rack transfer demonstrates operation for line X hotly contended across R1 and R2. For a write in R1, GPU in R1 obtains exclusive via LCC/GCD with G-DirRec showing OwnerRID equal to R1, SharersRID containing R1, GState equal to M, and Version equal to v. For a read in R2, GPU in R2 issues RS, LCC R2 queries GCD, GCD orders R1 to supply owner data through ODATA and transitions GState to O with SharersRID containing R1 and R2, optionally designating R2 as FWD. For write migration to R2, GPU in R2 issues UPG, GCD issues INV_SET to R1, LCC R1 invalidates its sharers, obtains OACK/WB_DATA from owner, and sends RAK. GCD updates OwnerRID to R2 with GState equal to E/M and returns EXCL_GRANT to R2. With latency optimization through leases enabled, the migration collapses whereby GCD had pre-granted a lease to R2 after the read, so LCC R2 immediately grants UPG and fabric completes invalidations asynchronously with a completion fence ensuring global visibility before a following cross-domain read. All steps are executed by MC-NIC hardware with no memory-side CPU scheduling or software handlers needed.

Security and QoS mechanisms ensure every request is vetted by TID/CDID ACLs prior to directory lookup. Per-tenant quotas regulate coherence control bandwidth. The QoS scheduler ensures control operations such as INV_SET pre-empt non-urgent data operations to avoid deadlock and bound write-latency tails. Vector transactions are slice-scheduled or chunked across tenants to prevent starvation during long invalidation phases.

Unlike host-agent coherence limited to a few hosts or device links, the disclosed hierarchical directory supports hundreds of racks by elevating sharer tracking to rack granularity and aggregating acknowledgements locally. Unlike software latch-based schemes, coherence here is memory-controller-managed by MC-NIC logic, preserving sequential consistency and enabling low-latency write ownership changes without remote CPUs. Federated modes uniquely allow coexistence of strict hardware coherence and relaxed/non-coherent regions under a unified protocol and control plane. The detailed description provides concrete packet fields, controller structures, state machines, sequencing, failure handling, sizing, and deployment steps sufficient for a person skilled in the art to implement the Hierarchical & Federated Coherence mechanism in hardware MC-NICs and associated firmware, integrated with the MF-TLP transaction layer.

The present embodiment concerns memory-semantic networks and, in particular, mechanisms by which a memory fabric supporting MF-TLP transactions executes vectorized atomic operations over sets of non-contiguous memory addresses in a single packetized transaction, and fabric-aware collective reductions that combine data “in flight” within MC-NICs and/or switches. The mechanisms operate under cache-coherent semantics provided by the MF-TLP coherence layer and are tenant-aware, routable, and scalable to data-center scope.

In the baseline system, compute nodes comprising CPUs, GPUs, and accelerators attach to a packet-switched fabric. One or more memory nodes per rack expose byte-addressable memory and integrate a Memory-Centric Network Interface Controller (MC-NIC) that terminates MF-TLP packets and performs memory accesses, address translation, coherence, and QoS without any memory-side CPU in the data path. While MF-TLP supports single-address reads, writes, and scalar atomics, many AL/ML and HPC workloads manipulate sets of addresses such as sparse embedding updates and discontiguous gather/scatter in SpMV, or require collectives such as all-reduce across many participants. Traditional networks serialize these as many unrelated requests. This embodiment introduces first-class vector and collective opcodes so a single transaction expresses tens to thousands of coordinated memory updates and/or reductions with explicit ordering, coherence, and completion semantics.

The packet formats and descriptors implement a Vector Atomic Descriptor (VAD) whereby an MF-TLP Vector Atomic request extends the base header with a VAD carried in the header or in the first payload segment. The VAD comprises OpClass as 5 to 8 bits identifying atomic operation family including FADD, XADD, CAS, MIN, MAX, AND, OR, XOR, FMIN, FMAX, FP32_ACCUM, BF16_ACCUM, and others, ElemWidth as 3 bits for 8/16/32/64/128-bit element granularity supporting mixed integer/floating formats, AddrMode as 2 bits for INDEXED, STRIDED, BLOCK, or TILED, VL as 16 to 32 bits for vector length representing the number of elements, and AtomicFlags as 8 to 12 bits. The AtomicFlags include ReturnPolicy specifying RET_NONE, RET_PREV, RET_STATUS, or RET_ON_FAIL for CAS operations, Ordering specifying SC for sequentially consistent, ACQ, REL, or ACQ_REL per element with default SC, Scope specifying LOCAL_RACK, GLOBAL, or CDID_ONLY for coherence domain scope, NoCoh allowed only for non-coherent domains, and MaskPresent indicating a predicate mask.

Additional VAD fields include SegSize as 12 to 16 bits for maximum elements per packet segment for pipelining, VGroupID as 64 bits for transaction group identifier unique per issuer, Tenant/Domain as TID and CDID copied from MF-TLP base header for directory lookup, optional Predicate Mask bit-packed of length VL gating element participation, and Address List depending on AddrMode. For INDEXED mode, the Address List contains VL 64-bit absolute addresses. For STRIDED mode, it contains BaseAddr plus Stride as signed plus VL. For BLOCK mode, it contains BaseAddr plus BlockLen plus VL/BlockLen blocks. For TILED mode, it contains nested stride/shape for 2D/ND patterns. The Operand List contains either a single scalar operand applied to all elements such as +1, or a list of VL operands such as elementwise CAS pairs of expected[i] and desired[i].

Response encoding uses a Result Descriptor comprising RBitmap as a bitmask of elements successfully applied or equal for CAS, ErrCode as per-vector or compact per-chunk error codes for protection fault, translation fault, or coherence timeout, PrevValues present only if ReturnPolicy requests previous values and compressed using delta/dictionary when many elements share small ranges, and PartialAck for multi-segment vectors acknowledging committed segments and including NextSegToken for continued streaming.

The Reduction Extension Header (REH) for collective operations extends MF-TLP with fields comprising ReduceOp specifying SUM, PROD, MIN, MAX, LINORM, L2NORM, AXPY, DOT, LOGSUMEXP, or CUSTOM(n) for custom operations backed by programmable engines, Datatype specifying integer widths, FP32/FP64/BF16/FP16, or complex types, CollectiveID as 64 bits globally unique for this collective instance, Phase specifying ANNOUNCE, CONTRIB, FINALIZE, or BROADCAST, TreeShape specifying KARY(k), RING, or HYBRID with Fanout/Depth as hints, Participants as optional expected number of contributors or dynamic, ChunkSeq/ChunkCount as segmentation indexes for streaming, Determinism specifying STRONG for fixed reduction order such as reproducible FP or FAST for any associative order, Target specifying MEM(addr) or MULTICAST(participant_set) for final sinks, and Tenant/Domain as TID and CDID.

The MC-NIC microarchitecture for vector atomics instantiates specific hardware blocks in a pipeline overview. The Protocol Parser decodes MF-TLP, VAD, and REH. The Context Table (CT) maintains per-vector state mapping VGroupID to state, progress, and credits. The Address Expander (AE) generates physical addresses from AddrMode and handles ATS/translation. The Predicate Gate (PG) masks elements. The Coherence Batch Unit (CBU) groups addresses by cache line and for each unique line computes ownership state requirements and initiates coherence messages using multicast when applicable. The Line Reservation Table (LRT) hashes line addresses to reservation entries, with each reservation having fields including line_tag, lock_state, owner, and pending_ops.

The Atomic Engine Cluster (AEC) comprises N parallel lanes, such as 16 to 64 lanes, each with ALU/FP unit implementing selected atomics and supporting read-modify-write (RMW) with single-copy atomicity per line. The Results Compressor (RC) builds RBitmap and compresses PrevValues if requested. The Speculative Reorder Buffer (SROB) stores provisional results for elements whose coherence grant is pending or whose prior elements are unresolved and supports rollback. The QoS Scheduler slices large vectors into SegSize chunks and interleaves with other tenants/flows, prioritizing control traffic such as invalidations to avoid head-of-line blocking.

Line-granular atomicity and ordering ensure the AEC performs per-line atomic RMW whereby upon coherence grant in E/M state, the lane reads the line or word, computes the new value, and writes back atomically before releasing the reservation. Serial consistency per element is enforced by line lock in LRT, respecting Ordering flags whereby ACQ_REL leads to local fences in the NIC before/after the update, and SROB commit sequencing if the issuer requested SC across the vector for group commit.

Address crossing and alignment handling addresses cases where an element spans two lines, such as a 128-bit operation at line end, whereby the CBU allocates two reservations and the AEC executes a micro-two-phase update with a temporary shadow in SROB, with the operation committing only when both lines complete. A CROSSLINE status is set if alignment constraints disallow atomicity at configured granularity, with policy either rejecting with ErrCode equal to ALIGN or internally serializing via a micro-lock covering both lines for coarser lock.

Operand handling for scalar operand vectors involves the AEC loading one immediate into a per-lane register file, while for elementwise operands it streams operand words from the payload in lockstep with address generation. CAS uses paired operand lists of expected[i] and desired[i], with the lane comparing and conditionally updating, setting RBitmap[i] equal to 1 on success.

Coherence-aware execution ensures vector atomics integrate with the hierarchical coherence subsystem. Batch ownership change involves the CBU grouping elements by line and rack, and for each unique line issuing an EXCL_REQ or UPG carrying a line-set bitmap for optional bulk invalidation. Racks act as aggregators (LCCs) as in the hierarchical coherence embodiment, collapsing potentially thousands of per-line invalidations into a small number of multicast messages. Multicast invalidate operations use an INV_SET control packet that may carry up to K line addresses, such as 64 to 256, and a per-line acknowledgement request. Rack LCCs invalidate at node granularity and return a rack-aggregated acknowledgement. Data sourcing ensures that if a line is O state for owner, the owner supplies ODATA to the requesting MC-NIC, with the AEC potentially beginning speculative computation using ODATA. Failure containment ensures that if any line fails to obtain ownership due to protection or persistent failure, only those elements are marked failed while other elements proceed and the vector commits partially per ReturnPolicy.

Fabric-aware reduction offloads employ complementary deployment points. The MC-NIC Reduction Engine (MRE) sits adjacent to AEC and combines contributions destined to the same target line, such as many nodes doing atomicAdd to address A, before committing to memory. The Switch Fabric Reduction Engine (SFRE) is integrated into certain switches, recognizing REH and combining payloads in flight for the same CollectiveID and ChunkSeq context, forwarding a single reduced packet upward in a logical reduction tree.

Collective phases for a typical All-Reduce over P participants proceed through ANNOUNCE where a designated root or any participant issues ANNOUNCE with CollectiveID, Participants equal to P, ReduceOp, Datatype, TreeShape, and Determinism, with switches or a controller choosing aggregation points and installing context entries in SFREs. In the CONTRIB phase, each participant streams data in chunks of 64 to 512 KiB with CONTRIB containing CollectiveID and ChunkSeq equal to i. SFREs accumulate contributions using parallel adder trees or programmable ALUs and forward partials upstream. In the FINALIZE phase, when an aggregation point receives all expected contributions for a chunk, it emits a single final reduced chunk either to memory at Target equal to MEM(addr) via an MRE at the sink or to a multicast group for BROADCAST back to participants. In the BROADCAST phase, reduced chunks are delivered to all participants and optionally written into each node's memory at a specified address, with MF-TLP coherence metadata set to invalidate or update stale cached copies where necessary, such as a RO-REP region update.

Idempotence and exactly-once semantics ensure each contribution carries CollectiveID, ChunkSeq, SenderFID, and Nonce. SFREs and MREs maintain a SeenMap per context to drop duplicates and ensure idempotent combination. Timeouts trigger partial finalize rules allowing operation with P-1 inputs if a failed participant is fenced by control plane, or a CANCEL message to unwind contexts.

Numerical modes are governed by the Determinism flag whereby STRONG enforces fixed, deterministic tree ordering with optional Kahan/Neumaier compensators per lane for improved FP reproducibility, with leakage of rounding state tracked in a small sideband to allow byte-exact replay. FAST permits any associative ordering, with SFREs opportunistically combining as packets arrive for minimal latency.

Custom reductions in addition to primitive operations allow MRE/SFRE to expose programmable pipelines such as VLIW or RISC micropath with a bounded instruction budget per chunk of less than or equal to 128 operations to express AXPY, LOGSUMEXP, or application-defined associative/commutative functions. A verified function library is downloadable and keyed by CUSTOM(n) to prevent arbitrary code execution. Memory coherence of final results ensures when Target equals MEM(addr), the final reduced chunk is written by the sink MC-NIC under exclusive ownership, and LCC/GCD issue invalidations to racks that held prior versions. For BROADCAST, the final chunk is sent as DATA with update semantics, with receivers potentially caching as S state.

Speculative and pipelined execution enables efficient processing of large vectors. Vector atomic pipelining splits large vectors into segments of up to SegSize elements, with the NIC processing multiple segments in flight. Speculative grant using lease/hinting allows the MC-NIC to pre-request exclusive ownership for the next segment's lines while executing the current segment, overlapping invalidation latency with computation. The SROB commit model ensures within a segment, elements may complete out of order but commit to memory and to the response stream in SC order if requested. ACQ/REL elements may commit aggressively with local fences only. Partial completion handles coherence conflicts for a subset by deferring those elements while others commit. RBitmap records per-element success, with a reissue token allowing software to retry only failed elements for sparse retry.

Reduction speculation allows SFREs to allocate buffer credits based on Participants and ChunkCount. As soon as a node has received contributions from any quorum determined by policy, such as greater than 50% for FAST mode or all for STRONG, it may forward a partial along the tree, tagging it PARTIAL. Upstream SFREs merge PARTIALs. Late arrivals are either merged into the outstanding partial using slack buffers, or handled by a correction delta carried in a follow-up ADJUST message that a final sink applies before commit, maintaining correctness while hiding tail latency.

Security, tenant isolation, and QoS ensure all vector and reduction packets carry TID and CDID and are checked against an MF-ACL prior to directory or combination. SFREs never combine data across distinct TID and CDID contexts. The QoS scheduler uses class-based queuing with token buckets per tenant and deadline awareness for latency-sensitive reductions such as inference all-reduce, ensuring control traffic including invalidations and acknowledgements pre-empts bulk data when necessary. For vectors, the scheduler slice-schedules long segments to interleave with other tenants, preventing monopolization of memory ports.

Error handling and recovery mechanisms address various failure modes. Per-element faults including translation faults, access violations, or alignment errors are recorded in ErrCode and do not poison the rest of the vector. An optional STOP_ON_FIRST_ERROR flag aborts remaining elements immediately. Timeouts for coherence or reduction context trigger a NACK/RETRY with backoff information. Cancellation allows issuers to send VEC_CANCEL with VGroupID or RED_CANCEL with CollectiveID, causing NICs/SFREs to free context tables and unwind reservations, guaranteeing progress for other flows. Replay achieves idempotence via VGroupID and segment index or CollectiveID and ChunkSeq keys, with duplicates being dropped.

Atomic Engine throughput for an AEC with 32 lanes at 1.2 GHz sustains greater than 38 Gop/s of 32-bit integer atomics assuming one operation per lane per cycle, providing approximately 152 GB/s read plus 152 GB/s write nominal. For mixed FP32 with Kahan compensation, throughput is approximately half due to extra adds. Lanes are dynamically allocated per vector, with short vectors occupying fewer lanes whereas large vectors saturate the cluster. Directory and reservation footprint includes the LRT holding 64 to 256K entries with each entry approximately 16 to 24 bytes requiring 1 to 6 MB SRAM. The CBU tracks outstanding invalidation groups with LineSet descriptors of 64 addresses each stored in a 128 to 512 KB context RAM. SFRE resources at each enabled switch port implement a Context CAM of 4 to 16K entries keyed by CollectiveID and ChunkSeq and a Combine Array of 8 to 32 lanes of 256-bit add/min/max ALUs, with on-chip SRAM buffers holding partials of 2 to 8 MB total. A fair scheduler enforces per-tenant and per-flow limits. Numeric formats support integer operations with wrap-around or saturating arithmetic flagged in AtomicFlags. FP operations honor IEEE rounding modes, with deterministic mode fixing pipeline order and optionally using compensation registers. BF16/FP16 reductions optionally upcast to FP32 for accumulation and downcast at sinks.

Representative operation sequences demonstrate practical applications. For Vector Fetch-and-Add with bulk coherence, an issuer composes VAD with OpClass equal to FADD, ElemWidth equal to 32, VL equal to 1024, AddrMode equal to INDEXED, ReturnPolicy equal to RET_NONE, and SegSize equal to 128 with scalar operand +1. At the target MC-NIC, AE expands addresses, CBU groups 1024 entries into approximately 820 unique lines and emits approximately 13 INV_SET packets of 64 lines each to racks per directory SharersRID. As RAKs return per rack, AEC updates lines in parallel lanes with each lane performing atomic add and results suppressed for RET_NONE. The NIC returns a single completion with summary counters showing applied equal to 1024 and failed equal to 0. Total packets are much less than 1024 scalar atomics, with coherence folded into a handful of multicast exchanges.

For Vector CAS with partial success, the issuer provides expected[i] and desired[i] lists for 256 elements. AEC reads each element under exclusive, compares, conditionally writes, with RBitmap marking successes. The response returns RBitmap and, if RET_ON_FAIL, previous values only for failed positions with RC compacting as index and value pairs. Software retries only the failed subset.

For switch-offloaded All-Reduce to memory, 64 participants ANNOUNCE All-Reduce SUM FP32 of a 256 MB tensor with TreeShape equal to KARY(8), Determinism equal to FAST, and Target equal to MEM(addr@pool). Participants stream 1 MB chunks with CONTRIB containing ChunkSeq equal to i. SFREs at edge switches combine eight inputs into one partial and forward, while core SFREs combine eight partials into a final. The sink MRE writes the final chunk under exclusive, updates directory, and fabric optionally BROADCASTs completion tokens. The entire collective completes with O(P) bytes per hop rather than O(Pxdata) and requires no host-side message choreography.

An optional programming model layer provides a runtime library exposing vatomic(op, addrlist, operand, flags) returning RBitmap/values per ReturnPolicy, vatomic_strided(op, base, stride, count, operand, flags) and vatomic_masked operations, vreduce(op, ptr, len, mode, target) where mode belongs to ALLREDUCE, REDUCE_SCATTER, or ALLGATHER+REDUCE and target is memory or broadcast, vreduce_custom(id, ptr, len, . . . ) for registered functions, and completion fences ensuring write visibility semantics match the requested Ordering. The library translates calls into MF-TLP packets with VAD/REH and handles retries on sparse failures.

The architecture provides significant advantages through header amortization whereby one MF-TLP transaction replaces many scalar operations with shared control plane reducing overheads, coherence coalescing whereby bulk invalidation/upgrade avoids N×M acknowledgements with ownership obtained once per line for many elements, network combining whereby reductions in the network collapse traffic and latency with the same fabric carrying both control and reduced data, determinism on demand supporting reproducible training when needed while otherwise favoring throughput, and isolation and QoS through per-tenant contexts and slice-scheduling preventing interference with ACLs guarding access. The foregoing detailed description provides complete enablement for implementing Vectorized Atomic Operations and Fabric-Aware Reduction Offloads within the MF-TLP fabric and MC-NIC architecture through precise packet structures, controller state, microarchitectural blocks, execution pipelines, ordering/coherence integration, speculative behavior, error handling, numerical considerations, and example operational sequences specified to the level required for an expert to realize the invention in hardware and firmware.

The present embodiment relates to packet-switched, memory-semantic fabrics and, more specifically, to memory-centric network interface controllers (MC-NICs) that expose a programmable data-plane execution pipeline for performing near-memory computation under cache-coherent semantics. Unlike fixed-function NICs that only parse headers and issue reads/writes/atomics, the disclosed MC-NIC executes user-defined programs that transform MF-TLP transactions into sequences of memory-referenced micro-operations, perform arithmetic and logical functions over data resident in memory, and commit results with single-copy atomicity and tenant-scoped isolation.

Each memory node in the fabric integrates an MC-NIC coupled to local memory devices including DDR, HBM, PCM, and NVRAM. Incoming MF-TLP packets traverse a multi-stage programmable pipeline beginning with Ingress and Admission at Stage 0 providing rate policing, per-tenant access-control checks, and assignment of a Program ID (PID). The Programmable Parser/Classifier at Stage 1 implements a table-driven parser that extracts typed header fields and classifies packets using developer-defined parse graphs, with a microsequencer or embedded RISC core supporting extensible opcodes and custom TLVs. Program Selection and Context at Stage 1.5 employs a Program Context Table (PCT) that maps PID and Version to a Program Control Block (PCB) comprising code pointers, scratchpad quotas, capability tokens, time/step budgets, and memory region descriptors.

Programmable Action Units at Stages 2 through N implement a chain of action stages containing arithmetic/logic units (ALUs), vector lanes, reduction units, crypto/compression engines, and optional accelerator slots such as FPGA tile or matrix unit. Stages are configured by code to perform computations and emit micro-DMA reads/writes. The Memory Reference Engine (MRE) issues cache-coherent micro-operations to local memory, handling translation through ATS/IOMMU, banking, burst scheduling, and alignment. The MRE interfaces a Coherence Interface (CI) to obtain per-line ownership as described in the hierarchical coherence embodiment. Coherence and Atomic Commit (CAC) groups a program's memory side-effects into a micro-transaction with line-granular reservations, fences, and a two-phase commit protocol that preserves the program's declared ordering semantics including SC, ACQ, REL, and ACQ_REL. Egress and Response at Stage OUT formats results such as status bitmaps and return values, compresses payloads, and enqueues acknowledgements.

The pipeline is reconfigurable via a trusted control plane that installs or updates parser tables, program images, and resource policies without re-spinning hardware. A single MC-NIC can host multiple concurrent programs up to M PIDs, each executing in its own sandbox with explicit budgets and privileges. The Programmable Parser/Classifier at Stage 1 is table-driven and supports a DAG of states with match keys over header fields including base MF-TLP, extension headers comprising vector descriptors, reduction headers, tenant/domain tags, and developer-defined TLVs. Each state emits Extract operations copying named fields into a Packet Metadata Block (PMB) such as opcode, tenant_id, domain_id, user opcode, and payload_len, Advance operations providing pointer increment for variable-length headers, and Dispatch operations specifying next-state index with optional PID assignment from a lookup table keyed by user_opcode and tenant_id.

The parser's microsequencer executes compact parse microcode of 64 to 256 instructions allowing arithmetic on fields, bit slicing, and CRC checks. New MF-TLP opcodes or custom headers are introduced by uploading a new parse graph while existing programs continue uninterrupted. If a packet fails classification or violates header constraints such as malformed TLV, it is rejected at Stage 0 with a deterministic error code.

The Programmable Action Pipeline at Stages 2 through N implements an execution model whereby programs are written against a constrained data-plane ISA called mc-dpISA or a higher-level DSL compiled to mc-dpISA. The model is packet-triggered whereby the PMB forms the initial register set, the program may read additional memory, compute, and optionally write memory and/or emit a response. Execution is bounded with no unbounded loops, requiring loops to have compile-time or run-time checked trip counts. The compiler and verifier ensure a worst-case execution time (WCET) and maximum memory footprint per program.

The mc-dpISA instruction set includes scalar and vector operations comprising ADD/SUB/MUL, MIN/MAX, FMA, LOG/EXP approximation, BITAND/OR/XOR, POPCNT, CLZ, and SATURATE, with vector forms operating on 128 to 512-bit registers. Control operations include predication and bounded loops using FOR i=O..N-1 where N is less than or equal to budget as a constant, and conditional branch with depth less than or equal to D as constant. Memory operations include LD for line or word, ST for line or word, PREFETCH, GATHER_IND, and SCATTER_IND with capability tokens. Atomic operations include ATOMIC_ADD, CAS, MIN, and others over local memory with line reservation integration. Synchronization operations include FENCE_ACQ, REL, and SC, plus TXN_BEGIN/END to delimit micro-transactional groups. Optional crypto/compression operations include AES_ENC/DEC, CHACHA, and LZ4_ENC/DEC via attached engines.

Capability-based memory access ensures the PCT holds a Memory Capability List (MCL) per program where each entry is a tuple containing base, limit, perms, tenant_id, and domain_id. Every LD/ST/ATOMIC instruction carries a cap index, with hardware checking address plus length within bounds and that tenant_id and domain_id of the packet matches the capability. Capabilities may be read-only for parameter fetch, write-only for log, or RW. This prevents a program from accessing other tenants' memory and from escaping its intended region.

An accelerator slot configuration allows one or more pipeline stages to expose a slot with AXI-style streaming interfaces to a pluggable accelerator such as a small FPGA region or a fixed-function matrix unit. Programs invoke ACCEL with op and descriptor_ptr, whereby the accelerator DMA-reads the descriptor, processes data potentially using the MRE for memory fetch, and raises an interrupt to the program context when done. The NIC checks that the accelerator's DMA obeys the program's MCL.

Scratchpad and HBM caching provisions each program with L0 Scratchpad as on-die SRAM of 256 to 2048 KiB with single-cycle access for temporaries and small tables, and L0′ HBM Window as a slice of on-package HBM of 512 MiB to 8 GiB managed by a Scratchpad Manager (SPM). Programs issue ALLOC_SCRATCH with size and policy to stage hot datasets such as gradient buffers and key/value shards. The HBM slice participates in coherence as a cacheable memory tier with tags in the NIC's directory so that writes from others invalidate staged lines.

Memory-referenced execution and coherence implement a Micro-DMA Engine whereby the MRE provides a micro-DMA interface to programs with descriptors specifying addr, len, stride or index list, and capability index. The engine coalesces requests into burst-aligned line fetches and pre-groups line addresses by cache line to minimize coherence chatter. Prefetch operations are advisory and may be dropped under pressure.

Coherence integration ensures that before a program mutates memory, the CAC acquires per-line reservations via the CI. For upgrade/exclusive operations, CAC batches upgrade from S to E or exclusive requests across all lines in the micro-transaction using multicast invalidation at rack granularity. For owner-sourced reads with O state lines, the owner NIC supplies data (ODATA), which the program may treat as valid input for read-modify-write (RMW). Atomic grouping allows a program to wrap a set of updates within TXN_BEGIN/END, with CAC ensuring all lines in the group have reservations, then the AEC commits writes back atomically, in some embodiments with shadow copy and two-phase commit to handle partial failures. If any line fails to acquire ownership due to protection fault, CAC aborts the group and rolls back the SROB.

The Speculative Reorder Buffer (SROB) maintains state per program context whereby reads populate SROB entries and writes produce provisional deltas tagged to line reservations. Commit moves deltas to memory in a deterministic order of SC or as declared. On abort, the NIC discards SROB deltas and releases reservations. Ordering semantics default to sequential consistency per program at line granularity. Programmers may relax ordering using ACQ/REL fences to expose more parallelism, with the NIC still enforcing per-line atomicity and inter-program isolation.

Isolation, safety, and attestation provide sandboxed execution whereby each program runs in a Program Isolation Domain (PID space) with code provenance through signed program images, the MC-NIC including a secure boot chain and measuring code into a Program Measurement Register (PMR). Budgeting installation defines instruction budget, WCET cycles, micro-DMA quota, and memory bandwidth shares. Exceeding budget triggers preemption and eventual termination with a distinctive status such as TIME_BUDGET_EXCEEDED. The verifier requires bounded loops with no unbounded loops, and dynamic bounds must be gated by header fields with range checks or by MRE descriptors with known sizes. Calls are either inlined or have bounded depth with no unchecked recursion, and stack use is capped. Exception containment ensures faults including translation, access control, and alignment are delivered to the program as signals. The program may branch to an error handler within budget, else the NIC aborts the micro-transaction and reports an error.

Capability tokens and tenant guards ensure all memory instructions carry a capability index, with NIC hardware validating tenant/domain match before directory or memory access. Capabilities are read-copy into the PCB on program start and cannot be modified by the program. Attestation and leasing allow the control plane to request a remote attestation of a program's PMR and capabilities, with the NIC replying with a signature from a hardware root key. In multi-tenant clouds, a lease time bounds program residency, and on lease expiry the NIC drains inflight packets and evicts the program.

Scheduling and QoS implement a two-level scheduler with an Ingress Scheduler arbitrating among packet flows with weight per tenant and priority for control versus data. An Execution Scheduler assigns action-stage slots to PIDs, supporting slice scheduling whereby large micro-transactions are broken into quanta of Q lines or Q μDMA ops, interleaved with other PIDs to bound latency. Deadline-aware scheduling ensures PIDs carrying deadline hints such as for inference receive preferential scheduling and budget boosts under light load. Head-of-line avoidance ensures control packets including coherence acknowledgements and invalidations pre-empt.

Preemption operates when a program exceeds quanta or budget, whereby the NIC issues a safe preempt point by pausing issuance of new memory operations, waiting for current line reservations to drain or reaching a micro-fence, snapshotting SROB, and yielding, later resuming from the same instruction pointer. For programs declaring ATOMIC_GROUP sections, preemption waits until END boundary to preserve all-or-nothing semantics.

A memory-dense DPU variant and two-tier controller configuration co-packages the MC-NIC with multi-stack HBM. Tier-0 (L0′) HBM provides an extremely low latency bandwidth tier exposed to programs as a coherent scratch/cache. Tagging logic identifies which L0′ lines mirror Tier-1 DRAM/NVRAM, and on remote writes by others the directory invalidates L0′ tags and the SPM evicts or updates. Tier-1 backing provides bulk memory behind traditional channels. The MRE automatically promotes hot regions to L0′ under programmable policies such as LFU/LRU or cost models tied to program hints. Batch accumulation for commutative updates such as gradient accumulation allows programs to ACCUM_L0′ at addr with val in HBM and flush to Tier-1 periodically with a single exclusive acquisition, greatly reducing invalidation churn. The CAC maintains merge-on-flush invariants so that partial accumulations are invisible until flush commits. This two-tier design differs from device-attached memory pooling by placing the compute plus coherence enforcement in the memory node itself, thereby avoiding host/accelerator involvement in the data path and enabling coherent, near-memory compute across all tenants.

Representative programs and flows demonstrate practical applications. For Graph Analytics ACCUMULATE_NEIGHBORS, the goal is to sum neighbors' weights for a vertex v where adjacency lists and weights are stored in discontiguous memory. The packet contains OP equal to ACCUM_NEIGHBORS, v_id, out_addr, and flags with tenant/domain in header. Parse resolves PID to the graph program. Program steps include ptr equal to LD of idx_table[v_id] with cap[IDX], deg equal to LD of ptr.deg, and bounds-check deg less than or equal to MAX_DEG. Then adj_ptr equals ptr.list with PREFETCH of adj_ptr and deg times 8 with cap[ADJ]. A loop for i equal 0 to deg-1 bounded performs nbr equal to LD of adj_ptr[i] and w equal to LD of weight[nbr] with cap[WGT]. Then acc plus equals f(w) where f may be linear or non-linear using an accelerator slot such as ReLU. Finally TXN_BEGIN, ATOMIC_ADD of out_addr and acc, then TXN_END with cap[OUT]. Coherence involves CAC acquiring exclusive on out_addr line once, with accumulation occurring in L0 scratch, minimizing line thrash. Response provides success status and optional previous value if requested.

For B-Tree Point Lookup BTREE_GET, traversal is performed entirely on NIC by loading root pointer, then while level is less than h, node equals LD of node_ptr, binary search keys using vector compare, and node_ptr equals child[idx]. On leaf, read value and return. Coherence is read-only with directory potentially supplying RO-REP lines and no writes performed. Runtime can deploy BTREE_PUT with TXN_BEGIN to update two nodes atomically for split and journal to a persistent tier with FENCE_PERSIST.

For In-Path Transform COMPRESS_AND_WRITE, a program receives a data chunk and writes compressed form to memory by PREFETCH destination metadata, running LZ4 encode in accelerator, then TXN_BEGIN, ST of dst and compressed_buf, updating index, then TXN_END. If compression ratio falls below a threshold, fallback to ST uncompressed through branch.

Error handling and recovery mechanisms address translation/protection errors whereby memory operations that fail capability or translation checks generate a per-operation fault, with the program able to handle or allow the NIC to abort with ERR_ACCESS. Coherence timeouts cause CAC to retry with back-off, and upon repeated failure, it returns ERR_BUSY with a retry_after hint. Accelerator fault raises error to the program, and if unhandled, the NIC resets the accelerator slot and terminates the context, with memory changes outside committed transactions discarded. Program termination on error or lease expiry causes the NIC to drain in-flight micro-transactions, release reservations, and free SPM allocations.

Implementation and sizing specifications include Code Store of 1 to 8 MiB secure SRAM per NIC for mc-dpISA binaries with optional code compression. Context State requires 2 to 16 KiB per active context for registers, SROB head/tail, and counters. Scratchpad provides 256 to 2048 KiB L0 and HBM L0′ of 0.5 to 8 GiB reserved per NIC. Pipelines comprise 3 to 6 action stages with each stage containing 16 to 64 vector ALU lanes at 1 to 1.5 GHz. MRE provides greater than or equal to 4 read plus 2 write ports, supports 64 to 256 outstanding descriptors, merges into 256-byte bursts, and uses line size of 64 to 128 B. CAC includes line reservation table of 64 to 256K entries, multicast invalidation aggregation as in the hierarchical coherence embodiment, and two-phase commit buffer for 256 to 1024 lines per atomic group.

Control-plane and programming toolchain components include Package whereby program images are packaged with a manifest describing PCT entries, MCL capabilities, budgets, accelerator requirements, and version. Deployment involves signed images uploaded via management fabric, with MC-NIC validating, allocating resources, and exposing PID handle. API through library libmftlp exposes install_program( ), invoke(pid, args, payload), update_caps(pid, MCL), uninstall(pid), and metrics counters for cycles, bytes read/written, and cache hit rates. Verification includes a static checker enforcing ISA constraints, bounded loops, and capability usage, plus a runtime verifier sampling execution time and able to throttle or evict programs exceeding WCET.

The architecture provides significant distinctions and advantages through protocol-native compute whereby computation occurs at the memory node under the same transaction semantics and coherence protocol as loads/stores, extensibility whereby new opcodes/headers are introduced by updating parser tables and program images without re-spins, isolation through capability-guarded memory, per-tenant ACLs, signed programs, and budgeted execution providing robust multi-tenant safety, performance through micro-DMA coalescing with bulk coherence via multicast invalidation and HBM staging hiding latency with atomic group commit guaranteeing consistency without host involvement, and generalization supporting a wide spectrum including search, aggregation, transforms, cryptographic filtering, and parameter accumulation going beyond fixed atomics. This embodiment specifies the structure, instructions, state, sequencing, safety, and deployment required to realize a Programmable MC-NIC Pipeline for In-Network Compute, with enablement covering parser design, program isolation, memory capability enforcement, coherent micro-DMA, atomic commit mechanics, HBM-backed scratch, QoS scheduling, preemption, error handling, toolchain, and example programs sufficient for a person of ordinary skill in the art to implement the described apparatus and methods to transform a memory node into a coherent, programmable data-plane processor that both moves and computes upon data in place within the MF-TLP fabric.

This embodiment relates to multi-tenant, memory-semantic fabrics and, more particularly, to mechanisms implemented in memory-centric network interface controllers (MC-NICs) and MF-TLP-aware switches that enforce per-tenant security isolation at packet and address-range granularity, and provide quality-of-service (QoS) scheduling and admission control for memory transactions including vector operations and coherence control messages. The disclosed apparatus and methods enable multiple independent tenants and workload classes to safely and predictably share a coherent, disaggregated memory fabric.

Each MC-NIC is enhanced with a Security & QoS Complex (SQC) on the ingress/eject path of the MF-TLP pipeline. The SQC comprises a Tenant Classifier & Policy Cache (TCPC) that extracts TID, CDID, QoSClass, and DeadlineHint fields from the MF-TLP base and extension headers and performs a Tenant Policy Cache (TPC) lookup that maps TID, CDID, and addr_range to Memory Fabric Access Control List (MF-ACL) entries and to QoS policy descriptors. An Access-Control & Capability Check (ACC) implements a hardware rule engine using TCAM/CAM plus SRAM that evaluates allow/deny decisions before any directory or memory touch, supporting logical pool IDs, page-range wildcards, and per-region capabilities including R, W, X, Atomics, and Reduce. A Crypto/Integrity Engine (CIE) provides optional AEAD such as AES-GCM/ChaCha-Poly unit that encrypts/decrypts payloads per tenant and verifies integrity across hops, with a key ladder deriving per-tenant traffic keys from root keys stored in an enclave and per-flow nonces derived from TID, TXNID, and Sequence. A Hierarchical QoS Scheduler (HQS) implements a two-level scheduler providing per-tenant fair sharing and per-class latency/bandwidth guarantees, including token buckets, WFQ/DRR arbiters, and deadline-aware queues, integrating vector slicing and coherence-control prioritization. Congestion Telemetry & Admission (CTA) gathers switch/peer feedback including credits, queue depths, and ECN/marking and applies network-wide pacing and credit partitioning per tenant/class. A Policy & Key Controller (PKC) running on a management plane programs MF-ACL entries, QoS descriptors, and cryptographic material, with all state being versioned and updated atomically via epoched commits to avoid transient misconfiguration.

Tenant-aware access control implements an MF-ACL model as a distributed key-value structure with the authoritative copy potentially hosted by a control service and each MC-NIC caching working sets in the TPC. An MF-ACL entry comprises a Key containing TID, CDID, and AddrRange or PoolID, Perms specifying READ, WRITE, ATOMIC, REDUCE, and PROG_EXEC, Caps as a CapabilityVector from 0 to k-1 for per-program capabilities, QoS containing ClassID, MaxRate, MinRate, Burst, and DeadlinePolicy, Audit containing LogOnDeny, LogOnAllow, and TraceMask, and Epoch E.

Enforcement operates on packet ingress whereby the ACC verifies tenant/domain match ensuring packet TID and CDID must match an MF-ACL entry covering the target address range or pool, and for vector requests, all addresses must be covered with the NIC computing a union of ranges and checking each segment. Permission bit verification ensures opcodes READ/WRITE/ATOMIC/REDUCE/PROG_EXEC for programmable pipeline invocation must be allowed. Capability index checking when present verifies the packet's capability index against Caps array and binds to the tenant domain. If any check fails, the NIC drops the packet, increments per-tenant counters, and may emit a security exception response that is rate-limited indicating ERR_DENIED/EPOCH_MISMATCH/INVALID_CAP.

Fast-path caching and aging implement TPC lines including AddrRange, Perms, QoS, Epoch, and an LRU bit. Ranges are stored as base and mask pairs with a small associative cache of 64 to 512 entries covering hot regions. On Epoch update, entries with stale epochs are invalidated in constant time. Isolation invariants ensure the ACC runs before coherence lookup or memory pipeline, thus unauthorized requests neither exert backpressure on shared coherence structures nor leak timing beyond ingress classification latency. For coherence control messages originated by the NIC such as invalidations and grants, the ACC synthesizes internal capabilities bound to the destination rack/node, with such packets omitting tenant secrets and being scoped by domain.

Per-tenant encryption and integrity employ keys and nonces whereby each tenant has a Key Set comprising Kenc and Kmac derived from a per-tenant root. For per-flow uniqueness, finite nonces are computed as nonce equal to H of TID concatenated with TXNID concatenated with Sequence concatenated with Direction. Associated Data (AD) includes immutable header fields including TID, CDID, opcode, addr_hi, and QoSClass, thus header tampering is detected. The pipeline for encrypt-on-egress has CIE encrypt payload blocks and append authentication tags, while for decrypt-on-ingress, CIE verifies tags before forwarding to ACC. Decryption failures raise ERR_INTEGRITY. Intra-NIC memory writes/reads may be configured plaintext for intra-device trust or data-at-rest encrypted with device keys optionally. Key rotation through the PKC swaps keys via epoch updates whereby both old and new keys are accepted during a cutover window, with NICs tracking per-peer key epochs to avoid mis-decrypt. Rotation is tenant-local with no global fabric stall.

QoS-aware scheduling and shaping implement a queueing hierarchy whereby the HQS maintains Tenant Queues TQ[t] with committed information rate (CIR) and peak information rate (PIR), each containing Class Queues CQ[t][c] for classes LATENCY, BULK, CONTROL, and BACKGROUND, and Deadline Queue DQ[t] for requests bearing deadline hints such as complete less than or equal to 5 microseconds.

Arbitration executes through long-term allocation using per-TID WFQ to distribute bandwidth respecting MinRate/MaxRate and enforcing max-min fairness when oversubscribed. Within-TID class arbitration uses Deficit Round Robin (DRR) with class weights, with CONTROL for coherence invalidations/acknowledgements always pre-empting to prevent deadlock. Deadline-aware dispatch employs DQ using Earliest-Deadline-First (EDF), and if a DQ packet risks missing its deadline, HQS can steal credits from lower classes or prompt the CTA to request upstream cut-through.

Vector transaction slicing for vectors slices into chunks of 32 to 256 elements with a per-slice commit token while preserving vector-atomic semantics at vector boundary. Preemptible slices allow after a slice, the vector yields and other tenants' small requests are interleaved. Atomic fence ensures the final slice carries a vector-commit bit with fabric guaranteeing atomic visibility of the entire vector's effects at the boundary, with intra-vector partial visibility suppressed to peers unless explicitly requested. SLO guardrails allow a tenant to request latency caps such as 99p less than 20 microseconds, with HQS adjusting slice size dynamically using smaller slices under congestion to bound p-tail queuing delay. Bandwidth enforcement uses token buckets per TID and ClassID to throttle issuance into the memory port and the fabric through distinct leaky buckets. HQS monitors moving averages and instantaneous bursts, and on overuse inserts gaps or defers slice dispatch.

Network-wide coordination implements credits and congestion signals whereby MF-TLP switches advertise per-class egress credits. The CTA collects link utilization, queue depth, ECN marks per class, per-path RTT using timestamp extension headers, and peer NIC backpressure via lightweight control messages. End-to-end control involves HQS applying window-based pacing per flow and tenant-class credit partitioning, such as reserving 30% credits to LATENCY, 10% to CONTROL, sharing the remainder across BULK/BACKGROUND. Under congestion, class downgrading may occur such as BULK to BACKGROUND. CTA can request cut-through routing from switches for LATENCY class, bypassing deep buffers. Path selection allows packets to carry a routing hint as fabric path label, with HQS using telemetry to select a low-latency path for DQ and a high-throughput path for BULK, updating hints adaptively.

Representative flows demonstrate the system operation. For unauthorized access block, when Tenant B sends a vector write to a region mapped exclusively to Tenant A, ACC checks TPC, finds no MF-ACL entry, and rejects at ingress with no directory lookups nor invalidations issued and a rate-limited error response sent. The audit log records TID_B, addr, opcode, and time. For competing workloads with SLOs, when Tenant X runs latency-sensitive inference with deadline equal to 5 microseconds per read and Tenant Y streams checkpoint data as bulk, HQS admits X's reads to DQ, slices Y's bulk vector to 64-element chunks, and interleaves such that X's reads meet deadlines, with CTA signaling switches for higher priority on X's traffic and throttling Y via token depletion. For coherence storm avoidance, a multi-rack invalidation set is scheduled as CONTROL class, with HQS pre-empting data flows, draining invalidations first to bound write-ownership latency and thereby bound tail latencies system-wide.

Implementation details and sizing include TPC with 256 to 2K entries associative, refill from policy service, entries approximately 64 bytes containing range plus perms plus QoS plus epoch. ACC provides 2 to 8 TCAM banks at 128 to 512 rules per bank, falling back to SRAM for large lists. CIE implements 256-bit datapath at line rate with per-tenant key table for 4 to 16K tenants. HQS provides 64 TQs times 4 CQs each, DQ up to 1K outstanding, per-queue counters and token buckets in on-die SRAM, with EDF implemented with a min-heap or calendar queue. CTA provides telemetry buffers per link/class with control loop at 20 to 200 microsecond cadence.

The next embodiment concerns heterogeneous, tiered memory including DRAM, HBM, NVRAM/PMem, and CXL-attached pools exposed as a single coherent address space over MF-TLP, and apparatuses/methods for in-fabric address indirection, dynamic migration, replication, and placement-aware routing driven by observed access patterns and SLOs.

Global addressing and indirection implement a Global Fabric Address (GFA) whereby all memory is addressed by a 64-bit GFA. Bits encode a pool ID and an offset as GFA equal to PBits:PoolID concatenated with Offset. Pools represent administrative groupings of tier and topology. A Global Address Indirection Table (GAIT) at each MC-NIC maintains a GAIT shard mapping TID, CDID, and GFA to a Physical Location Record (PLR). The PLR contains NodeID for memory node, Tier for DRAM, HBM, PMem, and others, PhysOff for physical offset, ReplicaSet as optional NodeID set for read replicas, Version for cutover sequencing, and Policy for hotness score, pin/replicate flags, and durability. Lookups are cached in a GAIT-TLB. For indexable granularity, entries are page-sized from 4 KiB to 2 MiB or segment-sized for large objects. Translation in the data path occurs on packet ingress whereby the MC-NIC performs GAIT lookup after ACC checks. For vector operations, the NIC groups addresses sharing the same PLR to minimize tier crossings.

Migration and remapping protocol implements triggering and policy whereby MC-NICs collect per-region statistics including access frequency, RW ratio, average latency, and origin rack. A Placement Manager (PM) computes Hot/Warm/Cold states using EWMA plus hysteresis. Tenants may set SLOs such as 99p less than 3 microseconds on region X and budget constraints such as pin N GiB in DRAM.

Copy and cutover operations to migrate GFA page R from PMem Tier-2 to DRAM Tier-1 proceed through preparation by allocating Tier-1 space and creating PLR′ with Version equal to v+1. Quiesce writes involves CAC issuing a write barrier on R through coherence upgrade or TRANSIENT mark, with new writes staged in a delta log while read-only sharers continue. Copy operations have the MC-NIC perform micro-DMA copy from Tier-2 to Tier-1 with end-to-end checksums. Apply deltas replays writes from the delta log, repeating until convergence in a short window. Cutover atomically switches GAIT entry to PLR′ with Version equal to v+1 and invalidates caches pointing to old location via a REMAP_NOTICE for R and v+1. Cleanup optionally keeps old copy as a read replica or frees Tier-2 space. The cutover is atomic from software's perspective with inflight requests consulting GAIT-TLB Version and stale versions being retried with the new PLR.

Replication for read-mostly regions has PM install ReplicaSet containing NodeA, NodeB, and others. Reads are served from nearest replica using rack-aware routing. Writes go to Primary NodeP with write policy implementing primary-commit with update multicast to replicas eagerly or lazy propagation with version stamps. The coherence directory tracks replicas in RO-REP state, with upgrade to write revoking replicas via REVOKE_RO.

Tier-aware coherence and persistence implement hybrid coherence whereby regions carry a Coherence Profile with DRAM Profile providing strict hardware coherence and immediate invalidations, and PMem Profile providing write-back caching with persist fences. PERSIST_STORE MF-TLP ensures durability to Tier-2 and optional mirror before acknowledgement. Persist semantics for PERSIST_STORE have CAC write to Tier-2, flush controller buffers, and record persist markers such as log entry before returning. For fault-tolerant mode, a two-replica acknowledgement is required from primary plus mirror.

Placement-aware routing and path optimization employ routing hints whereby PLRs include path preferences for LowLatencyPath and HighThroughputPath. The NIC stamps a Routing Hint in the MF-TLP header with switches mapping hints to VCs or ECMP groups. Dynamic adaptation has CTA feed real-time RTT and throughput to the PM, with PM updating hints for hot regions such as re-routing PMem bulk over optical core and DRAM reads over electrical low-hop paths.

Example flows demonstrate practical applications. For HPC tiering, a solver's working set migrates to DRAM automatically as PM detects hot regions while historical state stays in PMem. When the solver enters a replay phase, PM detects a burst to a cold snapshot, prefetches several adjacent pages back to DRAM, and pins them for the phase duration. For read replication for inference, model weights are replicated across racks in RO-REP state. Inference reads are served from local replicas with periodic update windows revoking RO, applying updates to primary, then re-broadcasting to replicas.

Implementation and sizing specifications include GAIT-TLB with 8 to 64K entries at 16 to 32 bytes per entry requiring 128 to 512 KiB SRAM. GAIT shards are backed by DRAM/HBM with entries approximately 32 to 48 bytes including ReplicaSet and policy. PM runs as firmware on an embedded core or off-NIC controller with decision interval 100 microseconds to 10 milliseconds. Delta log provides circular buffer per migration of 64 to 256 KiB typical, drained at cutover.

The final embodiment introduces prediction and speculation mechanisms in MC-NICs and MF-TLP-aware switches to reduce latency and coherence overhead through speculative memory operations, predictive invalidation/ownership pre-grant, and pattern-guided prefetch/aggregation, all while preserving architectural ordering and tenant isolation.

The predictor architecture implements the MC-NIC hosting a Coherence & Access Predictor (CAP) comprising Stride & Delta Correlators (SDC) detecting regular strides on per-flow addresses, an Access Correlation Table (ACT) mapping last-K addresses to likely next addresses using a Markov model with confidence counters, a Contention Hotspot Table (CHT) tracking lines with frequent owner flips for ping-pong detection while maintaining per-rack writer probabilities, Deadline/SLO hints integrating HQS deadlines and PM placement data, and a Confidence Engine with saturating counters, thresholds for action, and aging to forget stale patterns. All tables are tenant-partitioned with prediction never crossing TID and CDID boundaries or MF-ACLs.

Speculative memory operations implement read prefetch whereby on READ to A, CAP predicts B from SDC/ACT and issues speculative prefetch as PREFETCH of B with scope and a speculative state tag S-PREFETCHED. The line is not architecturally visible to the requester until a real read arrives, with coherence treating it as a silent cache entry whereby if a conflicting write arises, the NIC invalidates the prefetched copy with no external effects. Programmable sequences for known sequences such as B-Tree use a hinted prefetch extension HINT_NEXT(n) allowing the NIC to fetch n likely successors. For embedding tables, the NIC may batch prefetch indices upon recognizing early indices of a pattern. In-network pre-aggregation operates for reductions where CAP recognizes multi-source contributions to the same address/range within a window, with the NIC delaying commit briefly to aggregate multiple small updates into one while respecting configured maximum wait, similar to coalescing but guided by prediction.

Predictive coherence management implements pre-invalidation whereby when CHT indicates line X alternates ownership between racks R1 and R2, after R1 writes X the NIC pre-invalidates R1's shared copies and sets a lease to R2 in the GCD with a short TTL. The next UPG from R2 completes immediately being pre-granted, saving an RTT. Ownership pre-grant through leasing has the GCD issue LEASE_GRANT for X to R2 with TTL equal to delta when CAP's confidence exceeds a threshold. LCC R2 records a lease token, and upon a write, it can locally grant exclusive and inform GCD asynchronously. If the prediction fails with no write within TTL, the lease expires harmlessly. Predictive downgrade for lines read by many and seldom written has CAP recommend RO-REP transitions. When write likelihood increases, CAP schedules REVOKE_RO early to reduce revocation latency.

Ordering, correctness, and rollback implement visibility rules whereby speculative prefetches remain in S-PREFETCHED until confirmed by a matching demand read, at which point they transition to S. Writes are never speculatively committed, only ownership is speculatively prepared. All speculative metadata is local to the NIC and invisible to tenants. Rollback paths ensure if a misprediction leads to an early pre-invalidated cache elsewhere, the NIC must ensure the line is still valid for the original owner until a confirmation, therefore pre-invalidations are sent only after prior write commit, and owners keep a grace copy until lease is acknowledged or TTL passes. Any external observer still perceives sequentially consistent behavior. Budgeting has CAP enforce per-tenant speculation budgets such as no more than M speculative lines or K outstanding leases, avoiding speculation amplification attacks.

Training and hints implement autonomous training whereby CAP updates confidence counters on success/failure, ages entries periodically, and blacklists addresses with poor predictability. Software hints allow runtimes to issue hint headers including LIKELY_NEXT(addr), PINGPONG(addr set), PHASE_START/END, and OWNER_SEQUENCE from R1 to R2 to R3. Hints are advisory and bounded by ACC and MF-ACL.

Example scenarios demonstrate practical applications. For distributed SGD, after broadcasting new weights, CAP predicts imminent server-side writes, pre-invalidates worker caches at phase end, issues leases to the parameter server, and pre-fetches next layer's weights to L0′ HBM. The update phase runs with fewer invalidation RTTs. For halo exchanges in HPC, boundary regions exhibit periodic ping-pong with CAP setting leases following the known schedule and applying RO-REP for read phases, revoking just before the write phase.

Implementation and sizing include SDC with 4 to 16K entries per flow class hashing on FID and stream_id with stride and delta using 2-bit confidence. ACT provides 32 to 128K entries global per NIC with 2 to 4 next-address candidates each having 3-bit confidence. CHT tracks 16 to 64K tracked lines with ping-pong counters and last-owner. The controller uses simple FSM or embedded core evaluating thresholds e.g. every 5 to 50 microseconds. Budgets provide per-tenant speculation caps such as less than or equal to 4K S-prefetch lines and less than or equal to e.g. 512 leases.

These embodiments are designed to be orthogonal and composable whereby the MF-ACL and QoS controls govern all traffic including programmable pipeline executions and vector/reduction operations, the tiered GAIT/PLR indirection is consulted by vector address expansion and by the programmable pipeline's micro-DMA ensuring migrations/replications are transparent yet coherent, and prediction and leasing shorten the critical path for vector atomics and programmable updates by overlapping ownership changes and prefetch with computation. The foregoing detailed descriptions specify packet fields, data structures, hardware blocks, algorithms, sequencing, safety invariants, telemetry, and control-plane hooks sufficient for implementation in silicon/firmware to support robust claim families around tenant isolation, QoS scheduling, tiered placement, and predictive coherence in a coherent MF-TLP memory fabric.

In additional embodiments, the memory-centric network interface controller (MC-NIC) is extended to execute user-defined reduction and atomic operators in-network under a deterministic, sandboxed micro-operation (micro-op) pipeline, thereby generalizing the fixed typed atomics and reductions already described for the Memory-Fabric Transaction Layer Protocol (MF-TLP). This capability enables applications to offload associative, commutative, and conditionally associative aggregation and update functions, such as numerically robust summation, quantized accumulators, histogram and sketch updates, Top-K merge, or masked read-modify-write, to the MC-NIC proximate to memory while preserving fabric-wide coherence guarantees and tenant isolation. The MF-TLP header namespace is extended with OP equal to USER_DEF and compact metadata that identify the operator, type signature, and execution constraints. The MC-NIC 400, including its protocol parsing engine, atomic/reduction logic, address translation, and scheduler, orchestrates install-time verification, per-tenant code isolation, and run-time resource enforcement, and commits results via the same coherence-aware write path used for built-in atomics/reductions. This embodiment composes with previously disclosed vectorized transactions whereby a single MF-TLP packet may carry a vector descriptor describing multiple addresses/offsets, with the MC-NIC expanding the descriptor and applying the user-defined operator over the element stream, optionally in a map/reduce tree, before emitting a consolidated, coherence-safe commit and completion.

The operator model and type system implement a user-defined operator (UDO) as a constrained function f from T\hat{ }N to T\hat{ }M over a supported scalar or vector element type set T including i4, i8, i16, i32, fp16, bf16, and fp32, annotated with semantic attributes. These attributes include associativity specified as assoc belonging to true or conditional and commutativity flags, an identity element e belonging to T for reductions and optionally an inverse when available, rounding and overflow semantics including IEEE-754 compliant round-to-nearest-ties-even, stochastic rounding, or saturating arithmetic, determinism class specified as deterministic or deterministic-by-construction under a specified reduction schedule, and atomicity scope differentiating per-element atomicity versus group-atomic commit across a vector. To support conditionally associative floating-point aggregations with statistical repeatability at scale, the MC-NIC may provide compensated summation primitives such as Kahan or Neumaier or bfloat16 accumulation with fp32 accumulator lanes, selectable per operator install. The operator's declared type signature and attributes are verified at install time and cached alongside the operator code image.

Control-plane installation, verification, and isolation proceed through a privileged control plane such as host driver or fabric controller that installs a UDO by issuing an install transaction carrying a code image expressed in a restricted UDO-IR intermediate representation bytecode, a resource contract containing max_cycles, max_scratch_bytes, max_state_bytes, and max_concurrency, and metadata including operator ID, version, type signature, identity constants, attribute flags, expected numerical error bounds, and optional mergeability hints.

Upon receipt, the MC-NIC performs verification through structural validation whereby UDO-IR prohibits unbounded loops, recursion, indirect jumps, arbitrary pointers, and memory aliasing, with loops required to have statically provable bounds, the call depth bounded, and the total instruction count upper-bounded by max_cycles. Type and safety checks ensure all IR instructions are strongly typed with explicit conversions, memory accesses confined to the MC-NIC's per-invocation scratchpad and per-tenant operator state, and DMA to host or arbitrary memory disallowed. Determinism and scheduling derivation has the verifier emit a pipeline schedule as map/reduce tree or segmented scan that is deterministic given the metadata, such as balanced binary tree for assoc equal to true, or ordered element-wise accumulation for assoc equal to conditional. Resource admission ensures the operator is admitted only if its declared resource contract fits the MC-NIC's per-tenant quotas and hardware envelopes. A code hash anchors the install with the operator assigned a per-tenant code slot indexed by tenant_id, operator_id, and version. Operators are per-tenant isolated whereby MF-TLP packets carry a tenant identifier, and at run time the MC-NIC selects the tenant's code slot and its resource limits and enforces those limits for the execution.

The UDO-IR instruction set comprises a small, analyzable instruction set including lane-local arithmetic/logical operations comprising ADD, MUL, FMA, MIN/MAX, ABS, CLZ, and POPCNT, quantization operations for pack/unpack int4/int8 with saturating or stochastic rounding, accumulation operations including ACCUM_SAT and ACCUM_COMP for compensated sum, compare-and-swap as CAS_EQ on scratch, limited control flow through IF/ELSE with static bounds, and state operations for small bounded heaps or sketches including HEAP_PUSH_POP_K and CM_SKETCH_ADD. No unstructured memory access is allowed beyond scratch and operator state. Alternative embodiments may JIT-compile UDO-IR to the NIC's native micro-ops with deterministic behavior preserved by the schedule.

The micro-op pipeline architecture in the MC-NIC extends the atomic and reduction logic 440 with a programmable micro-op pipeline comprising a decode and schedule unit, vector map lanes as SIMD ALUs, a reduction tree with hardware prefix/associative combiners, a scratchpad SRAM and per-tenant sealed state SRAM, an abort/exception monitor, and a commit unit that integrates with the coherence directory interface 430 for correctness across sharers. The transaction scheduling and QoS unit 450 arbitrates classes including Coherence, Atomics, User-Defined, and Bulk Vector with per-tenant credits.

Deterministic execution is achieved by a fixed, verifier-derived map/reduce schedule, a chunker that partitions the element stream into equal-sized tiles, and a barriered reduction tree that combines tile partials in a canonical order such as left-balanced. For assoc equal to true, tiles may execute in parallel and combine in any order consistent with the tree, while for assoc equal to conditional, the schedule enforces a fixed element order such as ascending address. The pipeline exposes a worst-case cycle bound computed at install time from instruction count and tile size, with a watchdog raising ERR_OPLIMIT upon overrun.

MF-TLP integration and packet semantics extend MF-TLP with header extensions including Opcode as OP equal to USER_DEF, a User-Def Extension (UDEX) header containing operator_id, version, type_id, attributes, contract_hint as optional run-time hint to tile size, and reduction identity for stateless reductions, plus an optional vector descriptor comprising stride/length, delta-offset list, run-length mask, or dictionary-indexed offsets for multi-address operations.

The execution flow proceeds through ingress and parse whereby upon receiving OP equal to USER_DEF, the parsing engine 410 extracts UDEX, resolves tenant_id, operator_id, and version to a code slot, verifies packet conformance to the installed type signature, and fetches operator micro-ops. If no code slot exists or types mismatch, the packet is rejected with ERR_NOOP or ERR_TYPESIG. Address expansion occurs when a vector descriptor is present, with the vector unit expanding it into an ordered stream of addr, len, stride, and mask elements. For sparsity-compressed descriptors including delta-encoded offsets or bitset masks, hardware expansion produces an element iterator feeding the map lanes.

The map phase processes each element or element pair depending on arity, with the map lanes loading the current memory values via the memory access unit 420, converting to the operator type T if needed, and applying the UDO-IR map micro-ops, producing a partial such as contribution or candidate. Loads respect the MC-NIC's address translation and protection. The reduce/combine phase has the reduction tree fold partials with the operator's combiner semantics. For assoc equal to true, a balanced tree is used, while for assoc equal to conditional, a sequential fold preserves order. Operators marked mergeable can consume incomplete partials across multiple packets for streaming reductions, with partials stored in per-tenant sealed state and combined upon later arrivals sharing the same key and epoch label.

The commit phase has the commit unit issue a coherence-aware write of the results back to target memory lines using the same atomic/reduction write path utilized by built-in operations, including directory lookups, invalidations, or updates of sharers prior to committing the new values. Where the operator is declared group-atomic, the commit is performed as a single multi-line atomic sequence using a small NIC-side shadow log, with failure causing abort and rollback of prior writes. Completion returns a completion packet containing a status code as OK or ERR_*, optional aggregate results such as final reduced value, and optional telemetry including tile count and cycles. Errors include ERR_TYPESIG, ERR_NOOP, ERR_OPLIMIT, ERR_QUOTA, and ERR_ACL.

Coherence and consistency ensure all UDR/A commits participate in the directory-based coherence protocol. Prior to finalizing writes to lines with extant sharers, the MC-NIC 400 issues invalidation/update MF-TLP coherence messages and awaits acknowledgments, after which the updated value is committed and the directory entry updated. Operators that read-modify-write multiple lines may declare a coherence barrier group, with the MC-NIC ensuring linearizability of the group. For lease-based optimizations, lease tokens or epochs conveyed in the MF-TLP header ensure stale copies are either invalidated or revalidated before the completion is visible.

Resource contracts and enforcement ensure each operator executes under its resource contract. The scheduler 450 admits a bounded number of concurrent invocations per tenant, with the micro-op pipeline counting cycles and scratch usage. Exceeding any limit triggers ERR_OPLIMIT, which causes the abort monitor to discard partials and bypass commit. Per-tenant quotas and QoS classes ensure that UDR/A does not starve coherence traffic or typed atomics, with coherence and atomic classes potentially borrowing credits under starvation.

Multi-tenant isolation and security bind the MF-TLP tenant identifier to each transaction's tenant operator code slot and quotas, with the MC-NIC enforcing access control via its address translation/protection tables. Optional embodiments include per-transaction attestation tokens bound to code hashes so that execution of UDR/A is contingent upon policy verification, however even without attestation, isolation is maintained by the code verifier and sandbox. All operator state is sealed per tenant and inaccessible to other tenants or operators.

Streaming and segmented execution for large vectors or multi-source reductions partition a logical operation across multiple MF-TLP packets sharing a Transaction-ID and reduction epoch. The MC-NIC maintains partial aggregates per tenant, operator_id, txn_id, and epoch in sealed state, with each new segment updating the partial until an END_OF_STREAM flag arrives, at which point the final commit occurs. This enables reduce-scatter and incremental aggregation with backpressure tolerance.

Error handling and observability have the MC-NIC emit structured errors including ERR_TYPESIG, ERR_NOOP, ERR_OPLIMIT, ERR_ACL, and ERR_COHERENCE with cause codes. Per-tenant telemetry counters for invocations, cycles, bytes, and aborts are exported to the control plane for governance and capacity planning, without exposing data.

Example operators demonstrate practical applications. For numerically robust gradient sum from bf16 to fp32, a UDO implements a Kahan-compensated sum of bf16 gradients into an fp32 accumulator with final cast to bf16. Attributes include assoc equal to conditional for deterministic tree with fixed tile ordering, identity 0, and rounding ties-to-even. The verifier recognizes ACCUM_COMP usage and derives a balanced tree schedule with fixed tile order. The MC-NIC loads bf16 elements, converts to fp32, applies Kahan update, reduces, then writes back the final bf16 result, invalidating sharers before commit.

For Top-K merge, a UDO maintains a bounded Min-Heap of size K in per-tenant operator state. The map phase compares incoming candidates and performs HEAP_PUSH_POP_K, the reduction phase merges tile heaps, and the final commit writes the Top-K vector to a result buffer. The resource contract limits max_state bytes to O(K). The operator is mergeable across segments, enabling streaming Top-K over multiple packets.

For Count-Min Sketch update, a UDO updates a Count-Min Sketch structure residing near memory whereby map computes hash indices and reduce adds counts with saturating addition to cap counters. Identity is an all-zero sketch with the operator being associative and commutative. For quantized histogram using int8 with saturation, a UDO takes vector elements and increments per-bucket counters stored as int8 with ACCUM_SAT. Attributes include assoc equal to true, identity zero, and saturating overflow.

For vector RMW with group-atomic commit, a UDO receives addr, op, and operand tuples, applies per-element atomics such as masked OR, and declares group atomicity. The MC-NIC logs old values in a shadow log and either commits all updates atomically or aborts and restores, then completes with success or conflict bitmap.

Alternative embodiments include in-switch execution whereby a switching element 132 may cache operator code and execute UDR/A for flows localized to a subtree, returning partial aggregates to a home MC-NIC for final commit, with the homing MC-NIC remaining responsible for coherence enforcement. Hardware specialization allows frequently used UDO patterns such as sum/min/max and histogram to be macro-expanded into fixed microcode paths for improved throughput while retaining the programmable verifier path for arbitrary UDOs. Snapshot-consistent UDR/A for operators needing a consistent snapshot has the UDEX carry a snapshot token, with the MC-NIC reading versions consistent with that token and committing to a new version upon completion using copy-on-write in object-addressed mode.

This embodiment elevates the programmability of in-network compute beyond canned collectives and typed atomics, retains determinism and isolation via verifier-derived schedules and resource contracts, collapses scatter/gather and reduce phases into a single fabric transaction with vector descriptors, and integrates with the existing directory-based coherence to provide linearizable updates visible across cached sharers. The result is a memory-semantic, programmable fabric that reduces synchronization latency, network amplification, and CPU involvement for complex data motion and aggregation patterns central to modern AL, analytics, and HPC workloads.

The packet-level additions to the MF-TLP section include OP equal to USER_DEF indicating a user-defined operator to be executed at the MC-NIC, UDEX Extension containing operator_id, version, type_id, attributes, contract_hint, and identity, error codes including ERR_NOOP, ERR_TYPESIG, ERR_OPLIMIT, ERR_QUOTA, ERR_ACL, and ERR_COHERENCE, and streaming fields including txn_id, epoch, seg_seq, and end_of_stream. This detailed embodiment integrates cleanly into the architecture by reusing the MF-TLP header framework and vector semantics, extending MC-NIC 400 with a verified programmable pipeline, and preserving the directory-based coherence model and tenant/QoS governance previously disclosed.

The present embodiment provides a federated-first MF-TLP implementation with capsule coherence and ownership tokens that adopts baseline federated coherence principles while extending them through hardware-enforced protocol semantics and novel ephemeral coherence mechanisms. The system adopts from existing paradigms the baseline federated coherence model providing coherence within a node, with cross-node sharing via patterns such as node ownership, immutability, versioning, and a sync library, but realizes these as first-class protocol semantics rather than pure software convention. The novel extensions beyond existing approaches include extending the MF-TLP protocol and MC-NIC to hardware-enforce these paradigms using ownership tokens carried in MF-TLP headers and enforced by MC-NICs, publish/immutability bits with attested flush and witness tokens, version stamps checked in-network, coherence capsules comprising ephemeral, address-set-scoped, TTL-bounded micro-directories that temporarily recruit a small set of sharers into a directory protocol for hot critical sections, and in-network synchronization primitives including token locks, semaphores, and queues accelerated in NIC hardware. These mechanisms live at the MF-TLP transaction layer and MC-NIC data path, providing capabilities that existing approaches neither specify nor implement.

The novelty of this approach stems from providing concrete wire protocol specifications, header fields, NIC pipelines, vectorized transactions, typed atomics/reductions, and temporary on-demand directory recruitment at the fabric layer, while existing approaches propose models and programming paradigms without specifying a wire protocol, header fields, NIC pipelines, vectorized transactions, typed atomics/reductions, or temporary on-demand directory recruitment at the fabric layer. The embodiment retains the memory-centric packets, MC-NIC execution, vector/multi-address semantics, and QoS of the base system, but adds a federated-first operating mode and capsule coherence mechanisms.

Protocol extensions to MF-TLP header fields augment the MF-TLP header with OWN as ownership token, VER as 64-bit version, IMM as immutability/publish bit, CAP as capsule ID, TTL as capsule expiry, and PART as participant cardinality. OWN encodes the current owner node and scope comprising range or object ID. VER provides the monotonic version attached to reads/writes with MC-NICs verifying and advancing it. IMM directs MC-NICs to seal the object by issuing an attested flush to memory and returning a witness token binding addr-set, VER, and time. CAP/TTL/PART create a bounded coherence capsule whereby NICs instantiate an on-demand micro-directory for the capsule's address set, with invalidations/acknowledgements batched and tagged with the CAP so they can be garbage-collected at TTL expiry or commit. All fields ride alongside the existing MF-TLP opcodes including READ/WRITE/ATOMIC/REDUCE/VECTOR/FUSED defined in the base system.

MC-NIC enforcement and data-path logic enable the MC-NIC to parse OWN/VER/IMM/CAP at line rate. For ownership enforcement, non-owner writes are rejected or forwarded via an OWN-FORWARD control flow to the owner MC-NIC. Immutability triggers a publish micro-flow that performs readback/flush lines, marks read-only in NIC tables, and issues a witness completion as witness token used by consumers to validate freshness without re-flushing. Versioning operations on write have the NIC perform atomic VER++ and stamp responses, while on read, the requester may specify VER greater than or equal to X to block until a published or reduced version is visible.

Capsule coherence operates upon CAPSULE_BEGIN as a control MF-TLP, whereby the home MC-NIC seeds a capsule sharer set with PART participants, installing transient directory entries keyed by CAP and address ranges or vector descriptors. CAPC initiates a capsule; CAPSULE_BEGIN/COMMIT are MF-TLP control operations carrying CAPC parameters

All subsequent READ/MODIFY/WRITE/ATOMIC packets within the capsule carry CAP, enabling targeted invalidation/acknowledgement exchange. At CAPSULE_COMMIT/END or TTL expiry, the MC-NIC tears down the micro-directory and reverts to pure federated mode. These behaviors extend the MC-NIC blocks already present including parser, address-translation, directory interface, atomic/reduction engines, and scheduler/QoS.

Vectorized ownership and reductions for multi-address flows enhance MF-TLP VECTOR operations with vector descriptors including base/stride and offset lists plus OWN/VER/IMM/CAP per-vector context. A single packet can transfer ownership of N discontiguous lines, or publish an immutable shard in one shot, or begin/commit a capsule across a vectorized address set. For in-network reductions, the MC-NIC or switch aggregates partials while respecting VER and CAP rules whereby if inside a capsule, invalidations/updates as MF-TLP coherence messages are issued before completing the writeback, while outside a capsule, reduction results are published with IMM equal to 1 to satisfy federated readers deterministically. This leverages the base system's vector and reduction paths while adopting federated visibility goals.

Federated synchronization offloads replace a purely software synchronization library by exposing MF-TLP SYNC opcodes including TOKEN_LOCK_ACQ/REL, SEMAPHORE_PN, and QUEUE_ENQ/DEQ that a NIC-resident state machine executes over a small control object. Semantics follow token-based and bakery-style constructs suitable for non-coherent fabrics, but the MC-NIC enforces fairness/timeouts and can optionally wrap a critical section in a coherence capsule for lines declared in the request. This maintains the programming model while moving the heavy lifting into the data plane.

Canonical flows demonstrate practical method examples. For ownership transfer in OWN-XFER federated mode, the old owner issues OWN_XFER containing addr-set, new_owner, VER equal to V, and IMM equal to 0, with the MC-NIC flushing, stamping witness(V), and marking owner equal to new_owner. The new owner receives witness(V) and may perform coherent intra-node updates, while non-owners read with VER greater than or equal to V to guarantee post-transfer visibility. This adopts node ownership but with protocol-enforced tokens.

For publish immutable operations in federated readers mode, the producer writes, then issues WRITE with IMM equal to 1, causing the MC-NIC to perform attested flush and return witness(V). Consumers use READ with addr and VER greater than or equal to V without global coherence, with no write-backs occurring for immutable data. This adopts immutability with hardware attestations.

For coherence capsule operations providing bounded cross-node critical sections, the coordinator issues CAPSULE_BEGIN containing CAP, addr-vector, TTL, and PART, with participants acknowledging and micro-directory installing. Inside the capsule, ATOMIC/WRITE operations generate targeted invalidations to PART, and on CAPSULE_COMMIT, a single update/acknowledgement wave finalizes, then capsule state is torn down, reverting to federated mode. This provides an ephemeral, on-demand cross-node coherence window.

The approach aligns with existing federated behavior paradigms by providing default federated behavior with explicit ownership, immutable publish, versioning, and a cross-node sync layer, all acknowledged and made practical. This includes concrete MF-TLP fields and opcodes, NIC-enforced ownership/version/witness checks, vectorized ownership/publish across noncontiguous ranges, in-network sync offloads, and coherence capsules with TTL and bounded participants providing a new, scalable middle ground between no coherence and always-on global coherence. Existing approaches neither specify a transaction-layer protocol nor NIC pipelines or vectorized/capsule mechanisms.

The system implementation comprises MC-NICs executing a memory-fabric transaction layer (MF-TLP) wherein MF-TLP headers include ownership tokens, version stamps, immutability bits, and capsule identifiers with expiry. The MC-NICs are configured to enforce write authorization by ownership token, generate attested publish completions with witness tokens, instantiate ephemeral, participant-bounded micro-directories keyed by capsule IDs to provide temporary cross-node coherence for designated address sets, and execute in-network synchronization primitives on control objects, optionally wrapping operations in a capsule. This leverages the MF-TLP/MC-NIC foundation while adding federated-first plus capsule semantics.

The method of operation comprises transmitting MF-TLP packets that publish immutable data with witness tokens, transfer ownership with version advancement, and begin/commit coherence capsules with TTL and participant count. During a capsule, the system issues invalidation/update MF-TLP messages only to capsule participants. After commit or TTL, the system tears down directory state and resumes federated access semantics.

Additional capabilities include vectorized OWN_XFER/PUBLISH across discontiguous addresses via vector descriptors with consolidated completions, capsule-scoped typed atomics and reductions executed in MC-NIC or switch with correctness guarded by capsule invalidations, QoS/tenant mediation of capsule traffic and sync opcodes, and version-conditioned reads specifying VER greater than or equal to X that block or complete based on attested publish.

This embodiment sits naturally atop the base MF-TLP, MC-NIC, vector/atomic/reduce, directory interface, and QoS blocks, merely configuring the default mode to federated, exposing ownership/version/publish/capsule fields, and using on-demand micro-directories instead of always-on fabric-wide coherence. This both acknowledges existing federated coherence concerns and answers them with bounded, targeted hardware support. The federated-first embodiment embraces the recommended federated approach while remaining clearly novel by codifying ownership/immutability/versioning in MF-TLP and MC-NIC hardware, and introducing coherence capsules as a scalable, temporary, on-demand cross-node coherence mechanism not disclosed in existing approaches.

In additional embodiments, the interconnect fabric's switching element 132 is extended with a directory-assist module (DAM) that learns, caches, and exploits sharer locality to replicate coherence messages at line-rate, thereby collapsing high fan-out invalidation/update storms into a single upstream transaction plus in-fabric multicast and acknowledgment aggregation. The SDAMC complements and does not replace the home node's authoritative directory tables 125, with the home remaining the source of truth, but relocates the mechanics of fan-out and acknowledgement collection into the packet-switched fabric 130 where bandwidth and replication resources are abundant. Coherence semantics are preserved because the MF-TLP protocol carries explicit coherence metadata including state bits, sharer information, and lease/version tokens, and transaction identifiers that allow intermediate nodes to safely transform one-to-many invalidations into a multicast tree and fold many acknowledgements into one aggregated acknowledgement toward the home node. This extension is particularly effective in leaf-spine and mesh topologies populated with switching elements that already parse MF-TLP headers and may host in-network engines.

The disclosed SDAMC directly targets well-known pain points in directory-based coherence at fabric scale, specifically directory fan-out and acknowledgement implosion, by moving partial directory state comprising non-authoritative, approximate sharer summaries into the switches that sit on the natural cut points of traffic, while preserving the directory flow previously described comprising request to directory consult to invalidate/update sharers to acknowledgements to finalize state.

Each switching element is augmented with a Directory-Assist Module (DAM 132D) comprising a Sharer Cache (SC) as a set-associative structure keyed by a coherence tag CTAG equal to addr_high, tenant_id, and region_id, mapping to a compact egress summary for that tag. The egress summary contains a Bloom filter, or XOR/Cuckoo filter in alternative embodiments, over egress groups such as leaf ports and downlinks to ToR switches that have recently forwarded responses/acknowledgements for CTAG, a time-to-live (TTL) and epoch/version field to bound staleness, and an optional Coherence Group Identifier (CGID) that names a reusable multicast group for recurring sharer sets such as “embedding-table-A shards” or “tenant-42 hot set”. A Group Table (GT) provides a mapping from CGID to egress mask and policy that caches popular sharer sets as named multicast groups reusable across lines in the same object/region. A Pending-Ack Table (PAT) maintains an entry per outstanding multicast coherence transaction, keyed by the MF-TLP transaction identifier and optionally the CTAG, holding an acknowledgement bitmap/counter for all downstream branches the switch replicated into, plus a timeout and an upstream aggregation record for one-shot completion.

The learning path enables the DAM to passively learn sharer locality by observing transiting MF-TLP responses and coherence acknowledgements that already carry coherence metadata such as sharer state bits and lease tokens, and by associating those packets with the egress port they used, thereby inferring which subtrees contain active sharers for a given line or region. When the home node's 124 read responses or subsequent sharer acknowledgements traverse the switch, the DAM updates or inserts the SC entry for the CTAG, OR-ing the Bloom bits for the corresponding egress groups and refreshing the TTL. Optionally, the MF-TLP extension header, already defined as a place for application-specific annotations that can instruct intermediate switches to replicate a payload to multiple destinations, is used to explicitly export sharer summaries as “Sharer-Summary” sub-TLV from MC-NICs or the home directory to accelerate convergence.

The granularity of the CTAG may be the cache-line address, a page-aligned region, or a memory-object identifier, as already supported by MF-TLP addressing. Coarser granularity increases reuse with fewer SC entries at the cost of larger multicast supersets, while Bloom false positives further bias toward supersets, which is safe for correctness as non-sharers may receive benign invalidations and favorable to performance when amortized across many writes.

MF-TLP is extended with small, composable header elements including a Coherence-Assist Flag (CAF) that indicates the sender permits switch-assisted replication/aggregation for the message such as invalidation/update. By default, coherence messages are CAF-enabled for lines or objects where the home node's directory table 125 indicates multiple sharers. A Coherence Group Identifier (CGID) names a pre-installed or switch-learned group in the GT, and if present, the switch can multicast without SC lookup. An optional Sharer-Summary TLV carries a compressed list of likely sharer subtrees such as a Bloom filter over egress groups to “seed” or refresh SC entries along the path. An Ack-Aggregation Token (AAT) binds all replicated branches to a single upstream completion, whereby the switch that performs the first replication becomes the aggregation root for that transaction, with down-branch acknowledgements returning the AAT for folding in the PAT. These are carried in the same MF-TLP header/extension area that already hosts coherence metadata 319, transaction identifier 311, and optional extension headers for switch actions.

Multicast invalidation/update execution and acknowledgement aggregation proceed through an SDAMC-enabled write ownership transition flow. Consider a store miss that requires exclusive ownership for line L. The home node 124 consults directory 125 and determines there are sharers for L, then emits one MF-TLP invalidate or update message toward the subtree root such as the first-hop spine/leaf switch, marking CAF equal to 1 and optionally supplying a CGID or Sharer-Summary TLV in the header.

Upon receiving the CAF-enabled coherence message, the switch's DAM derives CTAG from the address/tenant/region and selects egress branches. If CGID is valid in the GT, it uses the GT egress set, else it probes the SC, else it falls back to broadcast within the minimal routing subtree for the destination region. The DAM creates a PAT entry keyed by the transaction ID and initializes its acknowledgement counter/bitmap, then replicates the coherence message to each selected egress, inserting the AAT so downstream switches/MC-NICs return acknowledgements destined to this aggregation root.

Each downstream switch repeats the above hierarchical replication process, using local SC/GT, until the message reaches leaf ToRs and ultimately the MC-NICs 116 that hold sharer caches. MC-NICs process invalidations/updates as in the baseline flow, then emit acknowledgements upstream. Each switch decrements the PAT as child acknowledgements return with the same AAT. When the PAT counter reaches zero, it emits one aggregated acknowledgement upstream toward the home, carrying the original transaction identifier 311 and a success status. Intermediate switches therefore collapse N leaf acknowledgements into O(height) acknowledgements at each level, culminating in one acknowledgement at the home. On receiving the aggregated acknowledgement, the home finalizes the directory entry and proceeds with write ownership and data commit, preserving the semantics already disclosed in the baseline coherence flow.

Ordering and linearizability are preserved as SDAMC does not reorder coherence relative to the data write, with the home gating commit on the aggregated acknowledgement exactly as it gates on individual acknowledgements in the baseline. MF-TLP's transaction identifiers and coherence metadata maintain causality across hops.

Staleness, safety, and fallback mechanisms ensure robustness. Each SC entry decays via TTL and, in lease-based modes, an epoch that aligns with the lease tokens already carried in MF-TLP coherence metadata. On expiry, the entry is invalid and any replication attempt reverts to CGID, then broadcast-within-subtree fallback. The DAM's egress summary uses probabilistic sets through Bloom filters that by construction do not produce false negatives. When combined with a conservative fallback of broadcast within the minimal routing subtree and periodic refresh from observed traffic, the DAM ensures superset multicast that never omits a real sharer. Redundant invalidations to non-sharers are benign and discarded at MC-NIC, and MF-TLP's backpressure hints throttle issuance of high-fan-out traffic if needed.

For negative acknowledgements and re-arming unicast, if the PAT timeout elapses without all child acknowledgements, or if a downstream node emits a negative acknowledgement such as from a corrupted branch or tenant ACL failure, the switch returns an aggregated NACK upstream. The home then re-arms unicast fallback by directly unicasting to directory-listed sharers for this transaction and/or refreshes SC state via an explicit Sharer-Summary TLV in subsequent messages. In practice, a single fallback heals the SC entry along the path, restoring multicast for future transitions on the same region.

The DAM cooperates with MF-TLP's header-level congestion awareness indicators and the MC-NIC's deadline/QoS scheduling to avoid starving coherence under load by prioritizing coherence class messages as already disclosed for MC-NIC scheduling and having transport backpressure signaled by the fabric throttle issuance of high-fan-out, SDAMC-assisted invalidations to protect tail latency. Per-tenant isolation is preserved by including the tenant identifier 318 in the CTAG and in the GT scope, with multicast groups being tenant-scoped, preventing cross-tenant leakage and enabling per-tenant crediting.

SDAMC applies equally to update messages where the owner supplies the new value and invalidate messages. In both cases the switch replicates the MF-TLP coherence message and aggregates acknowledgements before returning one completion upstream, and the directory controller at the home preserves correctness. In lease/epoch modes, the switch may replicate a lease-revoke rather than an invalidate, relying on MF-TLP's coherence metadata to bound reader staleness. For vectorized updates that touch multiple lines in one transaction, the DAM treats each CTAG independently in the PAT while preserving the single MF-TLP transaction ID for upstream completion coalescing.

Correctness arguments ensure proper operation through authority separation whereby the home's directory 125 remains authoritative and the DAM's SC/GT are hints. The home never commits a writer until it receives an aggregated acknowledgement, which implies that all replicated branches produced acknowledgements or the home fell back to unicast for misses. Thus SDAMC cannot cause missing invalidations and at worst sends extra ones as false positives. Deadlock freedom is ensured as coherence messages remain request/response with bounded lifetimes. The PAT uses per-transaction timers, with timeouts yielding upstream NACK and home-driven fallback, which terminates progress. Idempotence is maintained as replicated coherence messages are idempotent at MC-NICs for invalidate, update, and lease-revoke operations, and duplicate acknowledgements are harmless because PAT matching uses txn_id and AAT, with unrelated duplicates being dropped.

Implementation provides a switching element 132 including a packet parser for MF-TLP headers, a Directory-Assist Module comprising a Sharer Cache with probabilistic egress summaries, a Group Table of multicast groups, and a Pending-Ack Table for acknowledgement aggregation, and logic to replicate MF-TLP coherence messages including invalidate/update/lease-revoke to multiple egresses and to aggregate acknowledgements into a single upstream completion. The device optionally includes an in-network processing engine 134 for collective operations and can share hardware resources such as replication crossbar and counters between collectives and SDAMC.

The end-to-end system comprises compute devices 110, memory nodes 120 with directory tables 125, MC-NICs 116 implementing MF-TLP coherence semantics, and switching elements 132 as described, wherein the home node unicasts a single CAF-enabled coherence message to a switching element, and the switching element multicasts said message to sharers identified by cached egress summaries and aggregates acknowledgements into a single acknowledgement upstream, after which the home finalizes ownership.

Implementation notes and variations include hierarchy and locality whereby replication may occur at the lowest common ancestor (LCA) switch for the sharer set, with “first replication where CAF is encountered” sufficing in practice because downstream switches have finer SC entries closer to leaves, yielding a hierarchical multicast tree with minimal redundant paths. Sharer-Summary transport allows the optional Sharer-Summary TLV to be emitted by the home 124 when its directory 125 detects large fan-out such as sharers greater than K, or by MC-NICs 116 when they evict lines to delete their egress contribution. The TLV lives in MF-TLP extension space reserved for switch instructions/annotations.

Per-tenant partitioning ensures SC and GT are partitioned by tenant identifier 318 to maintain isolation and enable per-tenant aging and quota policies. Congestion awareness operates when transport backpressure is detected through ECN/credit depletion, allowing the switch to defer large multicast expansions, prioritize coherence traffic, and instruct the home to pace new CAF messages via a small NACK-with-hint, consistent with MF-TLP's congestion-aware behavior. For updates versus invalidates, for update messages, the switch replicates the data-bearing MF-TLP and still aggregates acknowledgements, as MF-TLP already permits switch-directed replication of payloads to multiple destinations. Accuracy knobs allow operators to tune Bloom width per table set, TTL, and CTAG granularity at line, page, or object level to trade multicast precision for cache pressure.

SDAMC reduces home-node fan-out from O(number of sharers) to O(branching factor), and reduces acknowledgement implosion to a single aggregated completion, all while preserving the directory-based semantics of MF-TLP coherence. Because replication occurs in the fabric data path, invalidation latency tracks switch pipeline latency rather than host serialization, improving time-to-ownership for write misses and throughput for contended lines, especially common in AI training parameter servers and shared metadata structures. These capabilities align with and extend the MF-TLP coherence and switch processing features already taught including coherence metadata, extension headers for switch actions, and in-network processing engines, thus providing a fully enabled, fabric-resident multicast coherence mechanism.

In further embodiments, the Memory-Fabric Transaction Layer Protocol (MF-TLP) is extended with a Vector eXtensions (VECX) header that compresses sparse and irregular access patterns beyond simple stride and explicit-offset encodings already supported by the base vector descriptor field 316. VECX expresses a vector of target memory elements using compact, hardware-decodable forms comprising delta-encoded offsets, run-length/bitset chunks, and dictionary-indexed hot offsets that the destination MC-NIC expands into a parallel schedule of local memory micro-operations while preserving program order in the single consolidated response returned to the requester. This embodiment composes seamlessly with the previously described MF-TLP header/payload structure, vectorized semantics, and consolidated-response method flow, but adds compression formats and streaming segmentation for very large vectors to reduce packet overhead, amortize per-element metadata, and pipeline execution across multiple packets with ordered reassembly and a single completion at End-of-Vector (EOV).

As background, the base MF-TLP vector operation encodes a base pointer plus stride/length or a list of explicit offsets, with the destination MC-NIC parsing the descriptor, expanding it into discrete memory operations, issuing parallel accesses to the local memory array, and returning a consolidated response in the original element order, yielding the bandwidth and latency benefits of amortized headers and response consolidation for sparse/irregular workloads such as embedding lookups and graph traversals. VECX builds on those semantics and the extension header facility to carry optional per-transaction information.

The VECX header structure and modes implement placement whereby the VECX header is an MF-TLP extension header inserted between the main header 310 and payload 320, and is identified by a unique EH-Type code. Legacy devices that do not understand VECX ignore it per extension-header rules, while MC-NICs that advertise VECX support activate the compression decode and streaming machinery described herein.

The header fields comprise VECX_CTRL containing mode bits and flags where MODE belongs to the set DELTA, BITSET, DICT, and HYBRID, ORDER preserves element order in response, RW belongs to the set GATHER, SCATTER, and RMW, EOV provides End-of-Vector flag used in streaming, and ERRPOL provides error policy as stop-on-first or continue plus bitmap. Additional fields include BASE as 64-bit base pointer or object plus offset for relative addressing, ELSIZE as log 2 element size for byte/word/line, N_ELT as element count encoded in this segment and, when streaming, cumulative or remaining count as policy dictates, and mode-specific sub-TLVs. For DELTA mode, compressed deltas are provided. For BITSET mode, chunk array with per-chunk bitmaps are provided. For DICT mode, dictionary key/value and 8-bit index stream are provided. For HYBRID mode, concatenation of sub-descriptors is provided, each with a 4-bit SUBMODE and SUBLEN.

Transactional identity ensures all packets in a streaming vector share the MF-TLP transaction identifier 311, with a segment-sequence field SEGSEQ inside VECX enabling ordered reassembly and detection of duplicates/missing segments. The main header's transaction ID and vector descriptor semantics continue to govern request/response correlation and pipelining.

Compression modes and hardware-decodable formats provide multiple encoding options. DELTA mode for delta-encoded explicit offsets has VECX carry a variant stream of signed deltas d[i] equal to off[i] minus off[i−1] relative to BASE, with prefix-sum reconstruction in hardware. The first entry uses absolute offset or delta from BASE equal to 0. To optimize typical sparse patterns, the variant uses 7-bit payload plus continuation with zig-zag coding for small negatives. The MC-NIC's Descriptor Expansion Unit (DEU) implements a two-stage pipeline comprising variant decode/accumulate into absolute offsets, and address form by adding BASE and scaling by ELSIZE. The DEU issues decoded addresses into the Memory Access Unit 420 for parallel scheduling. Ordering is preserved by maintaining an element index POS attached to each micro-operation, with the Response Consolidator re-ordering completions into ascending POS before emitting the consolidated response.

BITSET mode for run-length/bitset chunks addresses clustered sparsity whereby VECX carries a sequence of chunk descriptors comprising CHUNK_BASE relative to BASE, CHUNK_LEN as span in elements, and a packed BITSET in which bit b indicates whether element CHUNK_BASE plus b is present. Optionally, a STRIDE permits strided bitsets where addr equals BASE plus CHUNK_BASE plus b times STRIDE. The DEU walks chunks, tests bits, and emits only set elements. For efficiency, the DEU can skip all-zero bitsets with entire chunk elided and can burst long runs of ones as range micro-operations into the Memory Access Unit, which splits into per-line accesses internally. This form suits graph frontiers and windowed gathers.

DICT mode for dictionary-indexed hot offsets addresses highly skewed access distributions such as hot embeddings whereby VECX carries a small dictionary D of offsets d0 through dk-1, either absolute or delta-coded, plus a stream of 8-bit indices into D. The dictionary may be inlined per-packet or sticky, installed out-of-band for the MF-TLP transaction ID and versioned to avoid mismatch with fall back to inlined on version miss. The DEU maps each byte to D[idx], forms the address by adding BASE, and emits micro-operations. This achieves extremely compact representations for hot-set scatters/gathers.

HYBRID mode for sub-descriptor concatenation allows VECX to concatenate multiple sub-descriptors, such as a BITSET for a dense window followed by a DELTA tail and a DICT block, each tagged with SUBMODE and SUBLEN. The DEU processes sub-descriptors in order, assigning monotonic POS across them so the response is naturally ordered as specified by the concatenation.

MC-NIC expansion, scheduling, and ordered consolidation implement parsing and expansion whereby the MC-NIC's protocol parsing engine 410 detects the VECX header, extracts VECX_CTRL, BASE, ELSIZE, N_ELT, and sub-TLVs, and configures the DEU for the indicated MODE. The DEU decodes the compressed descriptor into an element stream of POS, ADDR, and LEN tuples which feeds the Memory Access Unit 420. Expansion and issue occur in parallel with memory access scheduling, and for large descriptors the DEU produces elements in tiles to keep queues full.

Parallel access with ordered response ensures the Memory Access Unit issues parallel reads/writes to the local memory array and returns element completions tagged with POS. A small Response Reorder Buffer (RRB) holds completed elements until the next expected POS is available, then drains to the Response Consolidator which emits a single consolidated response for gathers or a single completion for scatters/RMW, each preserving the original element order even if memory accesses were executed out-of-order internally. This matches the pre-existing vector flow's expand to parallel execute to consolidate semantics while adding the compressed decode front-end. For coherence and batching, for vectors spanning multiple cache lines, the MC-NIC may batch directory updates for the set of lines touched by the vector with one batched update versus per-element, reducing coherence traffic without altering visibility/ordering guarantees.

Streaming vectors implement segmentation, pipelining, and End-of-Vector for very large vectors that may exceed a single packet's MTU or desirable processing quantum. In such cases, the requester emits a streaming series of vector segments as multiple MF-TLP packets that share the same transaction identifier 311 and carry VECX fields SEGSEQ as monotonic, optional TOTSEG or EOV on the last, and N_ELT for the segment's element count. The destination MC-NIC creates per-transaction state keyed by TxnID on first segment arrival, including RRB state and DEU context such as sticky dictionary version. The MC-NIC pipelines expansion and execution across segments whereby as segment n decodes, the Memory Access Unit is still executing tiles from segment n-1, enabling continuous throughput.

The MC-NIC may emit chained partial completions optionally whereby for long-running gathers, the MC-NIC may return incremental chained responses carrying a contiguous prefix count PREFDONE representing the number of lowest POS elements now committed to response and a continue token. The final EOV completion closes the transaction and guarantees that all requested elements have been produced exactly once, in order. The MC-NIC detects loss/duplication whereby missing SEGSEQ or timeout triggers a negative completion or recovery behavior per reliability policy, while duplicate segments with same SEGSEQ are idempotently dropped using per-segment hashes.

The error-handling and reliability features of MF-TLP including checksums/FEC, retransmit timers, and request/response matching apply unchanged, with streaming adding segment-level bookkeeping and an ordered reassembly rule whereby results become visible to the requester only in ascending POS, regardless of segment boundaries.

Scatter, gather, and vector RMW semantics provide comprehensive operation modes. For gather read operations, the consolidated response carries N_ELT elements in original POS order, plus an optional per-element status bitmap for ERRPOL equal to continue. For scatter write operations, the MC-NIC expands VECX and commits per-element writes, by default returning a single completion as OK or error code, and optionally returning a compact success bitmap for partial-success policies. For vector RMW operations, for read-modify-write over a vector, the MC-NIC may employ a small shadow log to support group-atomic commit as all-or-none or per-element atomicity, then return a single completion or optionally a bitmap. These behaviors leverage vector execution/commit mechanisms already taught for compound/fused operations.

The system implementation provides an MC-NIC device comprising a protocol parsing engine 410 that recognizes the VECX extension, a Descriptor Expansion Unit that decodes DELTA, BITSET, DICT, and HYBRID sub-descriptors into element addresses, a Memory Access Unit 420 that issues parallel memory operations, and a Response Consolidator that produces ordered, consolidated responses or single completions. The device integrates with the previously described coherence directory interface to batch directory updates for vector-touched lines.

The end-to-end system operates wherein a compute device emits MF-TLP vector requests encoded with VECX, a destination MC-NIC expands the compressed descriptor into parallel local accesses, and returns an ordered, consolidated response or single completion, optionally segmented across multiple packets with ordered reassembly and EOV single-completion semantics.

Error handling, reliability, and QoS leverage MF-TLP's end-to-end integrity through checksums/FEC and reliability through retransmit timers and request/response identifiers for both monolithic and streaming transactions. For streaming, segment-level integrity and sequence checking via SEGSEQ ensure ordered reassembly or safe retry. Under congestion, existing congestion awareness indicators and transport backpressure shape issuance of large VECX vectors without starving coherence traffic.

Representative use cases demonstrate practical applications. For recommendation inference, a single VECX-DICT gather encodes hundreds of hot embedding indices in bytes, expanded at the MC-NIC into parallel reads and returned as one ordered response, significantly reducing per-element header overhead versus explicit offset lists. For graph BFS frontier operations, a VECX-BITSET gather encodes the next-frontier bitset in chunks, with the MC-NIC reading only set bits and returning a compact, ordered list of vertex attributes. For sparse SpMM update, a VECX-DELTA scatter writes back computed non-zeros with group-atomic or per-element write semantics, returning a single completion.

Compared with uncompressed explicit offsets or stride lists, VECX reduces bytes per element, thereby amortizing packet overhead more aggressively and enabling streaming pipelines that keep the MC-NIC's memory engines saturated while preserving application-visible order and single-completion semantics. The compressed forms are hardware-decodable at line rate and align with MF-TLP's existing vector/consolidation flow and extension-header mechanism, with the streaming segmentation extending vectorization to arbitrarily large sparse operations without sacrificing determinism or reliability. This embodiment integrates directly with the MF-TLP vector packet semantics and extension header facility, the MC-NIC's parse/expand/execute/consolidate pipeline, and the fabric's reliability and QoS features previously disclosed, providing a fully enabled compressed and streaming vector facility tailored for sparse ML and graph workloads at scale.

In additional embodiments, the Memory-Fabric Transaction Layer Protocol (MF-TLP) is extended to provide per-region selectable memory consistency and transactional fence semantics that are enforced by the memory-centric network interface controllers (MC-NICs) and preserved across the packet-switched interconnect fabric. Concretely, each memory region comprising line, page, or object-addressed range is bound to a consistency class selected from SC representing Sequential Consistency, RC representing Release Consistency, WC representing Weak/Write-Combining Consistency, and TM representing Transactional Memory. The selection is carried in a new MF-TLP header field CONSISTENCY_CLASS, and for TM regions, an additional set of transactional fields delineates begin/commit/abort epochs and groups multiple requests into an atomic unit via a transaction identifier TXN_ID. The MC-NICs integrate these semantics with the existing directory-based coherence mechanism and MF-TLP header metadata including opcode, address/object identifiers, tenant identifier, coherence metadata, transaction identifier, and optional extension headers so that ordering, visibility, and atomicity are respected at line rate and at data-center scale.

The architecture composes with previously described vectorized transactions and fused multi-operation packets whereby a single MF-TLP vector request may operate under RC, WC, or TM semantics, with the destination MC-NIC expanding the vector, scheduling local memory micro-operations, and consolidating a single ordered response while applying the region's consistency rules and, where applicable, transactional commit/abort processing. This embodiment formalizes and generalizes the memory-ordering discussion previously introduced comprising sequential, release, and relaxed models with per-operation metadata by elevating per-region consistency to a first-class, packet-visible contract with enforceable transactional fences.

The region model and header extensions implement region binding whereby a “region” is identified by either an address range carried in the MF-TLP address field 314 at line or page granularity or a memory object identifier carried in the address/object field as previously disclosed. The home node's directory controller maintains a Region Table mapping region identifiers to CONSISTENCY_CLASS, lease/epoch policy, and conflict-detection policy.

MF-TLP is extended with header fields comprising CONSISTENCY_CLASS belonging to the set SC, RC, WC, and TM as per-packet declaration that defaults to the region's bound class if omitted, FENCE for SC/RC/WC providing ACQ, REL, ACQ_REL, and FULL fence scope hints, and a transactional extension for TM. The transactional extension includes TXN_ID as an opaque identifier scoped to tenant and destination, TXN_FLAGS containing BEGIN, COMMIT, ABORT, READSET_ONLY, and WRITESET_ONLY, TXN_SEQ as a monotonic sequence number for idempotence, and TXN_VERS as an optional optimistic-concurrency version snapshot. Additionally, lease-epoch fields in coherence metadata 319 include LEASE as a lease/permission token and EPOCH as a monotonic region epoch which bound staleness and permit predictive invalidation. These fields reside in the MF-TLP header/extension area already defined for packet semantics, coherence control, and optional annotations, thus remaining backward-compatible with devices that ignore unknown extensions.

The consistency classes and enforcement mechanisms provide differentiated memory ordering semantics. For Sequential Consistency (SC) regions, the MC-NICs and home directory enforce a single global order consistent with each requester's program order. MF-TLP requests for the region are placed into a total order queue at the home node keyed by the packet transaction identifier 311 and an arrival sequence, with the directory ensuring that writes are preceded by invalidation or update completion to all sharers, after which the write is committed and the next request is considered. The MC-NIC may still issue local memory operations out-of-order, but visibility is gated on coherence acknowledgements such that the ordered sequence is observed by all readers.

For Release Consistency (RC) regions, the MC-NIC respects acquire and release fences indicated by FENCE equal to ACQ, REL, or ACQ_REL. Ordinary reads/writes may be reordered within the region, with a release enforcing that all prior writes become visible before the release completes whereby the home waits on coherence acknowledgements, and an acquire ensuring subsequent reads observe at least the state as of the matching release. The coherence directory interface 430 prioritizes coherence messages associated with fences to minimize latency and may batch updates for vector transactions prior to a release to reduce overhead.

For Weak/Write-Combining (WC) regions, the MC-NIC may coalesce multiple small writes into a single writeback burst and reorder independent operations for throughput. The home directory still maintains correctness by delaying visibility until a combined write commits and sharer state is updated. The requestor may insert a FULL fence to force a flush of write-combined buffers and commit of all prior writes before subsequent operations proceed.

For Transactional Memory (TM) regions, the MC-NIC provides atomic, all-or-nothing execution of a transaction group demarcated by TXN_FLAGS equal to BEGIN through COMMIT/ABORT. Requests carrying the same TXN_ID form a transaction. The MC-NIC implements optimistic concurrency with read/write set logging and version comparison at commit, as described below. Transactions may include vectorized operations with their element-wise micro-operations logged in order and applied atomically upon a successful commit.

Transactional enablement at the MC-NIC for TM implements read/write set logging whereby upon receiving BEGIN, the destination MC-NIC allocates per-transaction state in on-NIC SRAM. This state comprises a Read-Set Log (RSL) containing entries of line_addr and version, capturing the coherence version or lease-epoch observed on first read, a Write-Set Log (WSL) containing entries of line_addr, new_value, and write_mask, or references to payload buffers for large writes, and metadata including tenant_id, TXN_ID, TXN_SEQ, per-region EPOCH snapshot, and coherence barrier flags when the WSL spans multiple lines. Reads under TM record into the RSL without modifying directory ownership, while writes under TM buffer into the WSL with no sharer invalidation sent yet, preventing premature visibility and stall of other readers.

The validation and commit protocol operates at COMMIT whereby the MC-NIC initiates a two-phase process. The validation phase performs compare-version operations whereby for each line_addr and version in the RSL, the MC-NIC consults the home directory or its local directory cache and checks that the current line version/epoch equals the logged version or remains less than or equal to logged EPOCH if lease/epoch semantics are used. If any mismatch occurs indicating read-write or write-write conflict, the MC-NIC aborts and returns a completion with a conflict bitmap marking offending RSL entries. The acquire-ownership and writeback phase has the MC-NIC request exclusive ownership for all lines in the WSL by emitting coherent invalidate/update messages that are CAF-enabled where switch replication is available and awaiting acknowledgements. Upon acknowledgement aggregation, the MC-NIC writes back all WSL entries to memory. If the transaction declares group-atomicity, the MC-NIC uses a shadow log as a small on-NIC WAL to guarantee atomic multi-line commit and to restore prior state if any final write fails. Version bump and visible commit operations have the MC-NIC increment the version/epoch for affected lines or region epoch as configured, record the new values in the directory, and emit a single transactional OK completion to the requester.

The abort path operates on validation failure or resource/time budget overflow, whereby the MC-NIC discards WSL entries, releases any transient ownership, and returns ABORT with the conflict bitmap indexing RSL entries to enable the requester's contention manager to backoff or retry. Failure, idempotence, and ordering are maintained as transactions carry TXN_SEQ enabling the MC-NIC to drop duplicates such as after retransmission and to maintain idempotence across failures. The MC-NIC applies ordered reassembly of vector sub-operations within a transaction using the same consolidated response machinery used for non-TM vectors, but defers visibility of reads-after-writes until commit completes. For read-only transactions with READSET_ONLY, the MC-NIC may respond speculatively while still logging versions, aborting later if a violation is detected.

Lease-epoch tokens and predictive invalidation operate to bound staleness and reduce invalidation traffic across the fabric, with lease tokens previously introduced for predictive/lease-based metadata extended with epoch numbers. For each region or line, the directory issues a lease as LEASE and EPOCH to a reader, with the MF-TLP coherence metadata 319 carrying the tuple to MC-NICs and switches. A reader may continue servicing loads under RC/WC without invalidations until the EPOCH advances past the leased epoch. The home issues lease-revoke messages replicated by switches when SDAMC is present when a writer is likely, enabling predictive invalidation that reduces write latency. In TM, the RSL captures the EPOCH observed at read time, with commit validating that no line's epoch exceeded this value, thereby bounding staleness without explicit per-line version checks in the common case.

Vectorized operations under consistency classes inherit their region's CONSISTENCY_CLASS. SC vectors allow expansion and local execution to be parallelized, but the consolidated response is released only after the ordered position of the vector in the home's SC sequence is reached, with line-touching coherence batched before visibility to amortize overhead. RC vectors allow elements to execute and complete out-of-order locally, with a release fence forcing the MC-NIC to ensure all touched lines are committed and visible before completing the release packet. WC vectors allow write elements to be coalesced and completed with a single completion, with an optional success bitmap potentially returned. TM vectors have element addresses and versions logged in RSL/WSL and committed atomically at COMMIT, with group-atomic multi-line persistence achieved with the shadow log.

The system implementation provides an MC-NIC device comprising a protocol parsing engine 410 configured to parse CONSISTENCY_CLASS, fences, and TM extensions, a coherence directory interface 430 that implements SC/RC/WC/TM ordering with directory lookups and invalidation/update propagation, an on-NIC transactional unit with SRAM-resident RSU/WSL logs, version/epoch comparators, and a shadow commit log, and a commit/visibility gate that delays response emission until class-specific conditions are satisfied. The end-to-end system comprises compute devices 110, memory nodes 120 with directory tables 125, MC-NICs 116, and switching elements 132, wherein MF-TLP packets carry a CONSISTENCY_CLASS selector to control ordering and visibility per region, and for TM, packets additionally carry TXN_ID and commit/abort signals enabling MC-NIC-resident transactional execution with commit/abort outcomes visible as a single completion to the requester.

Correctness and progress guarantees ensure safety whereby SC's total order is enforced at the home by gating commits on coherence acknowledgements, RC's happens-before is respected by acquire/release gating, WC's reordering is confined to independent operations and fences force write visibility, and TM's atomicity is guaranteed by validation then exclusive ownership before writeback. Liveness is ensured as transactions have bounded lifetimes via commit timers, with timeout or conflict causing abort and resource release. RC/SC traffic retains priority via the scheduler as previously described, avoiding starvation by WC vectors. Idempotence is maintained as TXN_SEQ ensures that retries do not apply operations twice, with duplicate packets dropped after reassembly/state checks.

The PR-SMCTF embodiment builds on MF-TLP's existing header fields including opcode, address/object, vector descriptors, tenant identifier, coherence metadata, and transaction identifier, extension headers, and coherence protocol comprising directory-based invalidates/updates/acknowledgements already disclosed, and thus integrates without altering lower transport semantics. Vector flows of expand to parallel execute to consolidate remain intact under all classes with only visibility and ordering being class-specific.

Per-region selectable consistency allows workload-tailored ordering with strong ordering for control-heavy metadata, release consistency for ML tensor updates, and weak/write-combining for logging and analytics, yielding higher throughput and lower tail latency while preserving correctness. The transactional fences make it practical to atomically update complex, distributed data structures including graph indices and embedding shards without heavyweight software protocols. Lease-epoch tokens eliminate unnecessary invalidations and provide predictive invalidation hooks for the fabric, improving write hit-rates and reducing write-ownership latency in contended hotspots. This PR-SMCTF embodiment is fully enabled within the MF-TLP architecture by precisely specifying the packet-level selectors, NIC-resident mechanisms including logs, validation, ownership acquisition, and commit/abort, and coherence interplay needed to deliver strong, selectable consistency and transactional fences at fabric scale, harmonizing with the previously disclosed MF-TLP header model, MC-NIC pipeline, and directory-based coherence protocol.

In additional embodiments, the memory-centric network interface controller (MC-NIC) provides crash-consistent, atomic multi-line persistence for write sets that span multiple cache lines and, in certain deployments, multiple memory nodes across the fabric. The MC-NIC exposes a group-scoped primitive, ATOM_GROUP, by which a requester designates an ordered set of persistent updates that must become durable all-or-nothing. The MC-NIC ensures atomicity and durability by appending write-ahead log (WAL) records in persistent memory prior to visibility, orchestrating coherence and persistence barriers to place data beyond the platform's persistence boundary such as ADR/eADR/ASF domains, and marking the group committed with a durable COMMIT record before acknowledging completion. If a fault or power loss occurs at any point, the MC-NIC's replay engine re-applies idempotent redo records to restore a committed state while uncommitted groups are discarded. This embodiment composes with the Memory-Fabric Transaction Layer Protocol (MF-TLP) packet structure and directory-based coherence previously described whereby the group-atomic path reuses MF-TLP headers, routing, directory invalidations/updates, and vectorized scatter/gather while adding persistence control and journaling semantics at the NIC.

The persistence domains, failure model, and invariants establish the operational framework wherein a “persistence barrier” denotes the smallest ordering point at which prior writes are guaranteed to survive power loss such as ADR/eADR or platform-specific asynchronous flush (ASF) domains. The MC-NIC treats an operation as durable only after the corresponding WAL record and the affected data lines have been flushed into the persistence domain. The failure model accommodates any subset of requesters, switches, MC-NICs, or memory nodes that may reset or lose power, with nodes after restart offering only the content of persistent memory plus optional battery-backed buffers defined as being within the persistence domain.

Correctness invariants ensure I-Atomicity whereby for each ATOM_GROUP, either all constituent line updates are durable and visible, or none of them are visible. I-Durable-Ack ensures a durable completion (WALECHO) is returned to the requester only after a COMMIT record for the group has been persisted. I-Idempotence ensures all redo records and data writes are replay-safe with duplicates or partial replays not changing the final state. I-Coherence-before-Visibility ensures no reader observes post-group data until directory-based invalidations/updates have completed and the commit has been recorded.

Packetization and control plane configuration extend the MF-TLP header with an ATOM_GROUP opcode family and compact extension fields. The implementation provides OP equal to ATOM_GROUP with sub-operations comprising AG_BEGIN, AG_WRITE_SEG, AG_COMMIT, AG_ABORT, and AG QUERY. GROUP_ID provides an opaque 64-bit identifier scoped to tenant. LSN provides a monotonically increasing Log Sequence Number for WAL ordering and de-duplication. WALECHO bit requests durable completion semantics. An optional VECX descriptor for compressed scatter/gather within AG_WRITE_SEG supporting delta/bitset/dictionary formats preserves the “single ordered response” behavior for gathers. Coherence metadata including lease/version/epoch as in the base protocol gates visibility.

Control-plane setup provisions for each tenant and region a WAL region comprising a reserved, persistent, append-only area with per-tenant head/tail and checkpoint metadata. Commit policy specifies single-node or cohort multi-node commit with per-group persistence priority and optional mirrored WAL targets for redundancy. Quota and limits establish WAL size ceilings, maximum in-flight groups, and persistence bandwidth allocation.

The MC-NIC microarchitecture additions integrate logical blocks that may be combined or replicated including a WAL Engine 460 that formats PREPARE/DATA/COMMIT/ABORT records, computes per-record CRC, appends to WAL, and drives persistence barriers. A Persistence Controller 462 issues platform-specific persistence commands including ADR/eADR/ASF equivalents, tracks fence completion, and exposes per-line durability bits. A Commit Orchestrator 464 coordinates directory invalidations/updates, batches multi-line coherence, and orders visibility relative to WAL progression. A Replay/Recovery Unit 466 scans WAL on reboot, reconstructs group state by LSN, replays redo idempotently, and trims log extents. A Cohort Coordinator 468 for multi-node groups executes a NIC-resident two-phase commit with peer MC-NICs. All units are driven by the protocol parsing engine and transaction scheduler already present on the MC-NIC with group-atomic transactions placed in a dedicated “Persistence” class that is prioritized above bulk traffic but subordinate to coherence control messages, ensuring forward progress and bounded commit latency.

WAL record formats and on-NIC state implement a WAL consisting of redo records only with no undo, ensuring replay simplicity and idempotence. PREPARE records contain tenant, GROUP_ID, LSN, record_type equal to PREPARE, nlines, and crc plus a compact descriptor of target locations comprising node_id, addr, and mask. DATA records contain tenant, GROUP_ID, LSN, record_type equal to DATA, seg_seq, and crc plus payload of new values optionally compressed per line. COMMIT records contain tenant, GROUP_ID, LSN, record_type equal to COMMIT, and crc with no payload, marking group durability intent. ABORT records contain tenant, GROUP_ID, LSN, record_type equal to ABORT, reason, and crc, canceling a prepared group. NIC-resident metadata per group comprises GROUP_ID, LSN, state belonging to the set INIT, PREPARED, DATA_PERSISTING, and COMMITTING, pending_lines bitmap, durability_mask, cohort_set, and timer with a small shadow log for group-atomic rollbacks if writes must be undone prior to COMMIT such as local fatal error before WAL COMMIT.

The single-node commit protocol for normal operation proceeds through begin and log prepare whereby on AG_BEGIN, the MC-NIC reserves GROUP_ID, allocates an LSN, emits PREPARE into WAL, and forces it past the persistence boundary. Optionally, AG_STATUS(PREPARED) is returned to the requester. Streamed writes and coherence processing occur as the requester sends one or more AG_WRITE_SEG packets with or without VECX. For each segment, coherence interlock has the Commit Orchestrator request exclusive ownership for affected lines through directory invalidation/update with acknowledgment aggregation. Data stage has the MC-NIC write the new values to persistent memory locations, setting per-line pending-group tags and durability bits false. WAL DATA operations have the WAL Engine append a DATA record with segment payload and force it durable. Persistence barrier operations have the Persistence Controller issue a barrier to push the data writes to the persistence domain, and upon completion, durability bits are set true. These steps pipeline per line and per segment with coherence messages potentially batched across lines to amortize fan-out.

Commit and durable acknowledgment proceed on AG_COMMIT whereby the MC-NIC verifies all lines in pending_lines have durability bits true, and if not, it completes remaining barriers. The WAL Engine appends a COMMIT record and forces durability. The Commit Orchestrator clears pending-group tags, bumps per-line versions/epochs for readers, and returns an OK completion. If WALECHO equals 1, the OK is returned only after COMMIT is durable. If WALECHO equals 0, a non-durable OK may be returned earlier for latency-sensitive but restart-tolerant workloads under policy control. The abort path operates on AG_ABORT before COMMIT whereby the WAL Engine appends ABORT, clears pending-group tags, and returns ABORTED with any staged but not yet durable data simply overwritten by later activity or preserved as pre-commit state because visibility was not granted.

Multi-node cohort commit for write sets touching multiple memory nodes has the Cohort Coordinator execute a two-phase NIC-native protocol. Phase 1 prepare/persist has the coordinator MC-NIC send AG_BEGIN plus PREPARE descriptors to cohort MC-NICs. Each cohort logs PREPARE, streams its AG_WRITE_SEG payloads, persists DATA, and responds PREPARED once barriers complete. Phase 2 commit/persist occurs after all cohorts report PREPARED or a quorum if configured, with the coordinator instructing cohorts to append COMMIT and force persistence, and only when all COMMIT records are durable is a single WALECHO returned upstream. Failure handling through timeouts or negative responses leads to abort-all by appending ABORT at any cohort that reached PREPARE. Quorum variants may roll-forward if policy allows such as 2-of-3 mirrored nodes, but the default is strict all-or-none. This NIC-resident two-phase flow yields database-grade atomicity for disaggregated persistent memory without host mediation.

Ordered visibility versus durability distinguishes between visibility governed by coherence and durability governed by persistence. Readers observe committed data only after directory invalidation/update acknowledgments and version/epoch bump complete. Durability is asserted only after the COMMIT record is persisted and, for strict policies, only after all affected data lines have been barriered. Applications can request both by setting WALECHO equal to 1 for durable acknowledgment and relying on standard MF-TLP response ordering for visibility.

Streaming, vectors, and consolidation allow AG_WRITE_SEG to naturally compose with MF-TLP vector facilities. Gathers on the read path return a single consolidated, ordered response unaffected by WAL. Scatters on the write path stream into WAL DATA and persistent arrays with optional success bitmaps per segment potentially returned for partial-error policies. Very large groups emit many segments with the NIC maintaining per-group segment windows and segment sequence numbers, de-duplicating retransmissions and marking gaps for targeted retransmit.

Recovery and replay operations on NIC or node restart scan WAL by LSN to reconstruct group states. For COMMIT-present groups, the system redoes each DATA record idempotently to target lines, re-asserting persistence barriers if required and clearing pending-group tags. For PREPARE-only groups, the system discards any pending-group tags and ignores DATA payloads as no visibility was granted. Trimming WAL occurs up to the highest LSN for which all constituent groups have COMMIT persisted and a “consumed” watermark has been established. Idempotence tolerates duplicate PREPARE/DATA/COMMIT with re-applying not changing the final state due to full-value redo and monotonic LSN checks. Durability versus visibility ensures after replay, versions/epochs are incremented to reflect committed state, ensuring subsequent readers do not accept stale leased copies. A small checkpoint structure persisted every N LSNs accelerates recovery by providing the last trimmed LSN and WAL head/tail.

Optional enhancements include mirrored WAL/write quorum whereby PREPARE/DATA/COMMIT may be synchronously mirrored to a second persistent region on same node or remote and considered durable when a quorum of replicas acknowledge persistence such as 2-of-3. Group-commit batching allows the WAL Engine to coalesce multiple groups' COMMIT records into a batch flush while preserving each group's atomicity with WALECHO held until the batch's persistence barrier completes. Persistent object mode allows the descriptor to reference object IDs instead of raw lines with the MC-NIC maintaining per-object version chains and supporting snapshot and copy-on-write semantics that become atomic at COMMIT. Security/isolation allows WAL payloads to be encrypted/authenticated per tenant with WALECHO only returned after MAC verification of persisted records. Integration with transactional consistency (TM) allows ATOM_GROUP to be used as the durable commit fence for a TM region whereby the MC-NIC first validates the TM read-set, then executes ATOM_GROUP to durably persist the write-set, returning a single TM plus WALECHO completion.

Data structures and hardware signals for concrete enablement include WAL Index persistent structures containing head_lsn, tail_lsn, trimmed_lsn, last_checkpoint_lsn, and crc. Per-line durability bit in the MC-NIC's line table indicates whether the last write to a line has reached the persistence boundary. Persistence fence signals include PERSIST_FENCE_START and PERSIST_FENCE_DONE from the memory controller, and PERSIST_DRAIN to serialize barriers across contexts. A replay cursor provides a pointer into WAL used by the Recovery Unit, advancing only after each record's CRC and address range pass validation.

The CC-PMEM/ATOM_GROUP embodiment provides true multi-line atomicity across disaggregated persistent memory with NIC-resident WAL and coherence gating, durable acknowledgments (WALECHO) aligned to application semantics for databases, analytics, and logging, zero host involvement in the steady state providing lower tail latency and CPU offload, scalability via streaming segments, batched coherence, and optional cohort/replication policies, and robust recovery with replay-safe redo and bounded scanning via checkpoints. This embodiment supplies the concrete packet fields, NIC micro-architecture, logging formats, ordering rules, persistence interfaces, and recovery algorithms necessary to enable crash-consistent, multi-line atomic commits directly within a memory-semantic fabric, thereby generalizing traditional WAL-based durability to disaggregated persistent memory without relying on host CPUs while preserving coherence, scalability, and predictable, durable acknowledgment semantics.

In some embodiments, the Memory-Fabric Transaction Layer Protocol (MF-TLP) employs a canonical 128-bit base header followed by one or more extension headers and an optional payload. The base header comprises opcode occupying bits 7 through 0, version occupying bits 3 through 0, consistency_class occupying bits 3 through 0, priority occupying bits 3 through 0, tenant_id occupying bits 15 through 0, txn_id occupying bits 31 through 0, ext_len occupying bits 7 through 0, coh_flags occupying bits 7 through 0, reserved occupying bits 15 through 0, and addr_mode|vec_ptr occupying bits 31 through 0. The addr_mode|vec_ptr field selects whether subsequent bytes encode a direct address of 64 bits, a memory object identifier (MOID) of 32 to 64 bits, or a vector descriptor pointer into the extension region. The base header thus carries sufficient semantic metadata to permit intermediate devices such as MC-NICs or intelligent switches to parse, prioritize, and where authorized execute memory semantics at line rate without host involvement, consistent with the MF-TLP structure previously introduced.

Vectorized transactions are expressed via one of three canonical descriptor formats in an MF-TLP Vector extension. Format-A for base plus stride plus count packs base as 64 bits, stride as 32 bits, count as 16 bits, elem_bytes as 8 bits, and flags as 8 bits, efficiently describing regular access sequences such as row/column walks. Format-B for offset-list encodes base as 64 bits, elem_bytes as 8 bits, n_offsets as 8 bits, and offsets array where each offset is 32 or 64 bits selected by a flag, with offsets potentially delta-coded and variant-compressed for sparse indices. Format-C encodes base as 64 bits, elem_bytes as 8 bits, n_ranges as 8 bits, and start/length pairs times n, suitable for scatter/gather of contiguous fragments. The destination MC-NIC expands the descriptors into micro-operations, schedules them to attached memory channels, and coalesces a single, ordered completion.

A Coherence extension provides per-transaction metadata comprising dir_token as 16 bits, lease epoch as 16 bits, version as 16 bits, home_node_id as 16 bits, and sharer_hint as 32 bits implemented as bit-vector or Bloom filter. The dir_token binds a request to the authoritative directory instance for the addressed lines, lease_epoch allows lease-based validation to reduce invalidation fan-out, version enables monotonic freshness checks, and sharer_hint reduces lookup latency by allowing targeted multicast of invalidations/updates. These fields instantiate the coherence semantics previously described using routable MF-TLP control.

The consistency_class in the base header enumerates sequential, release, and relaxed classes. Devices must preserve program order for sequential class, enforce release/acquire fences for release class, and may reorder independent relaxed transactions subject to coherence constraints. This explicit, per-transaction ordering model permits mixed workloads such as OLTP plus ML inference to share a fabric while tuning latency/throughput tradeoffs as previously contemplated.

A Security extension carries a capability token comprising cap_id as 32 bits, rights as 16 bits, and epoch as 16 bits, and an optional header integrity tag such as AEAD-GCM over opcode, addr/MOID, tenant_id, and txn_id with per-tenant keys. MC-NICs maintain per-tenant ACL tables mapping capability tokens to memory objects and permitted opcodes, and enforce token-bucket shapers per tenant and per traffic class. Priorities and shapers integrate with the scheduler to isolate latency-critical coherence traffic from bulk vector flows while honoring fairness across tenants.

Every MF-TLP request bears a txn_id of at least 32 bits and a class bit declaring idempotent behavior such as READ and VREAD or non-idempotent behavior such as ATOMIC and RMW. Responders maintain a small duplicate-suppression cache keyed by src and txn_id for in-flight non-idempotent operations. Timeouts trigger requester-side retry only for idempotent classes, with non-idempotent retries mediated by responder duplication checks or by application-level two-phase patterns described below. Reliability hooks allow operation over best-effort transports without sacrificing correctness.

In one embodiment, the fabric implements a directory-based MOESI protocol with routable, typed coherence messages encoded as MF-TLP opcodes COH_GETS, COH_GETX, COH_INV, COH_UPD, and COH_ACK. A home directory at a memory node or aggregated directory appliance tracks sharers as a compressed bit-vector or counting Bloom filter with lease_epoch and version fields. A WRITE or ATOMIC to a line in state S/E issues targeted COH_INV to the current sharers indicated by the directory or sharer_hint, while a line in M triggers an owner writeback or forward-update COH_UPD before commit. Batching rules allow an MC-NIC to coalesce directory updates for vector reads into a single batched write, reducing message amplification for vector flows. These mechanisms realize the packetized coherence flows with explicit message encodings and timing.

Directors may grant a read lease with duration measured in epochs whereby readers include lease_epoch in subsequent transactions. Writers invalidate only readers with active leases, while stale copies self-invalidate upon epoch rollover detected through periodic COH_TICK or piggybacked version updates. Lease-based flow substantially reduces invalidation storms for read-mostly analytics.

The MC-NIC integrates a parser comprising hard logic with microsequencer for forward-compatible fields, a translation unit for global fabric address/MOID to local physical translation, a directory interface with queues for GET/INV/UPD/ACK, an Atomic/Reduction Execution Block with typed ALUs for int/FP, min/max, bitwise, and CAS operations, a transaction scheduler implementing hierarchical WFQ with token-buckets per tenant_id and per consistency class, and a fabric interface supporting congestion feedback. Requests marked ATOMIC are intercepted by the execution block, which performs read-modify-write with coherence fencing by invalidating sharers, committing, then sending completion.

In further embodiments, the Atomic/Reduction block supports operator plug-ins loaded as verified bytecode limited to 64 instructions with no unbounded loops, bounded memory, and typed registers. Each operator records type, associativity, and commutativity metadata, enabling tree or pipeline aggregation and partial-result merging in network elements. Non-associative FP operators may enable Kahan/Neumaier compensated summation for BF16/FP16/FP32 to control rounding error during large fan-in reductions.

A switch implementation includes a 5 to 7 stage pipeline comprising parse, group-table lookup, accumulator, ALU, writeback/multicast. The group-table is indexed by home_node_id, addr/MOID, and op_id and holds acc_val, pending_count, timeout, and permissions for up to 16K concurrent groups. Arrivals update acc val using the operator's ALU with completion occurring when pending_count hits zero, where contributor cardinality is supplied by the first arrival or by a control packet. The completion updates memory with a single write and multicasts a completion to contributors. Backpressure gates arrivals into a queue with probation evicting stale groups via timeout. This architecture realizes the reductions with concrete pipeline resources and concurrency control.

Transport binding examples demonstrate implementation flexibility. For UET/Ethernet, coherence messages comprising COH_* and small atomics ride on ordered streams with lossless fabric behavior while bulk vectors/reads/writes use unordered streams subject to ECN-driven pacing. For InfiniBand, MC-NIC endpoints map to RC QPs for atomics and directory traffic and to UD QPs for multicast invalidations and completions, with in-switch reductions consuming UD flows keyed by addr and op_id. For CXL-over-Ethernet, MF-TLP terminates at the MC-NIC with local CXL.mem transactions driving downstream expanders. These bindings realize transport-agnosticism with explicit, reproducible mappings.

When the target is persistent memory such as PCM or MRAM, the MC-NIC performs a write-ahead log (WAL) in on-NIC SRAM by logging txn_id, addr, old_val, and new_val, flushes the log to a small NVDIMM region or PMem journal, then applies the update to the target line, issues cache line writeback and fence, and only then acknowledges completion. On power loss, the WAL replays idempotently using txn_id ordering. This path extends the memory technologies and atomic flows to provide durability guarantees.

A fused vector transaction (VFUSED) combines VREAD to elementwise-op to VWRITE under a single txn_id. The MC-NIC expands the vector reads, applies per-element transforms such as scale, clamp, and type-cast using the programmable operator sandbox, resolves overlapping destinations with deterministic order, and emits a single atomic completion that is strongly ordered with respect to other VFUSED transactions of the same class. This mechanism provides line-rate vector RMW useful for sparse optimizer updates and graph edge relaxations, building upon the fused semantics previously contemplated.

In some embodiments, the MF-TLP operands use MOIDs rather than raw physical addresses. Each MC-NIC maintains a MOID table mapping moid to base, size, perms, home_node_id, and dir_token. The translation unit translates MOIDs at line rate and enforces capability rights. MOIDs decouple application allocation from physical placement and simplify migration, replication, and tiering across DRAM/NVM ensembles while preserving directory authority.

The transaction scheduler enforces hierarchical WFQ across tenant_id and class queues with token-bucket shaping and deadline-aware boost for packets marked coh_flags.coherence_critical equal to 1. Under congestion indicated by ECN/marking, schedulers slow vector classes before impacting coherence/atomic classes, ensuring forward progress for correctness-critical flows.

For long-haul or intermittently lossy paths, a non-idempotent operation may be issued as PREPARE_ATOMIC with txn_id followed by COMMIT_ATOMIC with txn_id whereby the responder logs the prepared value and acknowledges prepared without making it visible until commit. Requester retries target the prepare phase with a timed abort discarding uncommitted state. This pattern integrates with duplication controls to guarantee exactly-once effects.

Worked quantitative examples demonstrate practical performance characteristics. For sparse embedding lookup using vector gather, a requester issues a single VREAD Format-B with 96 offsets averaging 128-byte lines, with elem_bytes equal to 16. The destination MC-NIC expands to 96 reads, issues them with parallel depth equal to 32, and coalesces completions into 4 or fewer MF-TLP responses with maximum payload approximately 3 KB each. On a two-hop UET fabric at 800 Gb/s with ECN-aware pacing, the median completion is approximately 1.2 microseconds, with header-overhead amortization of greater than 20 times relative to 96 discrete RDMA READs, concretely realizing the previously summarized advantages.

For a distributed counter using atomic add to persistent memory, an ATOMIC fadd32 to NVM follows the persistence path of read to log to apply to flush to complete. With a 64-entry on-NIC WAL and 256-byte log lines, steady-state throughput exceeds 30 Mops/s per MC-NIC at 1 GHz ALU clock with less than 300 ns additional durability latency relative to volatile atomics. Coherence invalidations are targeted to 8 or fewer sharers via sharer_hint, limiting fabric fan-out.

For all-reduce via in-switch aggregation, sixteen sources send REDUCE with sum and BF16 to addr and op_id. The switch accumulates in a 6-stage pipeline comprising parse, lookup, accumulate, compensate, finalize, and multicast, with group-table equal to 16K and accumulator width equal to 32 bits with BF16 expanded to FP32 for numerical stability. Per-packet pipeline latency is approximately 6 ns at 1 GHz with a single write committing the final value and contributors receiving a multicast completion. This replaces O(log N) step collectives with single-pass, line-rate aggregation.

For context and to avoid ambiguity, the above embodiments do not rely on GPU-local striping/swizzling or NVLink-only topologies characteristic of existing systems that focus on address layout/compaction and NVLink path balancing and lack a routable transaction layer with vector/atomic/reduction opcodes, fabric-wide directory coherence, or in-network execution in NICs/switches as disclosed herein. The present embodiments are transport-agnostic supporting Ethernet/UET, InfiniBand, and CXL-over-Ethernet and expressly define packet formats, coherence state machines, and in-network compute engines that can operate proximate to memory across a packet fabric as well.

In additional embodiments, the transaction scheduling and QoS unit 450 of the MC-NIC, referred to as the “scheduler,” implements a deadline-aware, class-based arbitration mechanism that selects and orders MF-TLP transactions under tight latency Service-Level Objectives (SLOs) while preserving multi-tenant fairness. At a high level, ingress MF-TLP packets are classified into Coherence, Atomic, Vector, and Bulk traffic classes, each governed by independent credit meters, with packets that carry a deadline field further scheduled by earliest-deadline-first (EDF) semantics. The scheduler prioritizes correctness-critical Coherence traffic, allows cross-class credit borrowing to prevent starvation whereby Coherence may borrow from Atomic under pressure, and exposes telemetry including per-tenant latency/throughput, backlog, and backpressure to the control plane. This DASC embodiment extends the baseline MC-NIC architecture and MF-TLP header/extension model comprising opcode 312, address 314, vector descriptor 316, tenant identifier 318, coherence metadata 319, and transaction identifier 311 already taught for vectorized and coherent operations.

Critically, DASC leverages the protocol's extension header facility to carry timing hints including absolute or relative deadlines that enable real-time prioritization in the network, consistent with the earlier disclosure that extension headers may provide timing hints that allow the network to prioritize operations with real-time deadlines. Integration with coherence metadata and the directory flow ensures that reordering by the scheduler never violates global consistency whereby invalidations/updates still gate visibility, while transport congestion and backpressure indicators also already contemplated are fed back into admission and pacing to avoid buffer overruns.

Packet-visible fields and classification implement deadline and class signaling whereby the MF-TLP header 310 is extended with a compact Deadline (DL) sub-TLV in an extension header encoding either an absolute timestamp in NIC timebase units or a relative deadline from ingress, plus an optional criticality bit. Packets without DL are “best-effort” within their class. Classification attaches one of four traffic classes to each packet comprising Coherence for directory invalidations/updates/acks and lease/version handshakes contained in metadata 319, Atomic for single-key atomics/reductions and small RMWs identified by opcode 312 with atomic/reduce, Vector for MF-TLP vector requests with consolidated response semantics using descriptor 316, and Bulk for large reads/writes and streaming payloads. Class tagging composes with the existing tenant identifier 318 used for multi-tenant governance and per-tenant quota enforcement. For compatibility, devices that do not recognize DL treat it as absent with class defaults following opcode and coherence metadata cues whereby invalidation/update always maps to Coherence. The transaction identifier 311 continues to bind request/response matching, and consolidations for vectors remain intact.

The scheduler microarchitecture in unit 450 implements queues and virtual output queues (VOQs) whereby the MC-NIC instantiates per-egress-port VOQs keyed by class, tenant, and destination to eliminate head-of-line blocking. Each VOQ holds packet descriptors with cached size and service-time estimates using per-class models. A Class Arbiter and a Deadline Arbiter share a common timebase. Credits and borrowing mechanisms ensure each class maintains an independent credit meter implemented as token bucket per tenant where credits[class, tenant] represent bytes or cycles available to transmit. Credits refill at configured rates, enforcing long-term fairness. Under starvation, Coherence is allowed to borrow from Atomic up to a programmable cap B[Coherence←Atomic], reducing “read-after-write” stall tails without destabilizing other traffic. Borrowing decrements the lender's surplus credits[Atomic], tracked by debt registers that must be repaid before further non-coherence atomic transmissions proceed. The base disclosure already contemplates per-tenant scheduling and deadline-aware governance with DASC formalizing the mechanism and limits.

EDF with slack-aware tie-breaking operates among deadline-bearing packets eligible under credit, whereby the Deadline Arbiter selects the one with the minimum absolute deadline. To hedge estimation error, selection uses slack computed as slack equal to deadline minus now minus service_time_estimate. Negative slack packets are escalated above best-effort traffic in other classes subject to safety reordering rules. For non-DL packets within a class, the Deficit Round-Robin (DRR) sub-scheduler provides weight-fair selection across tenants. Congestion and backpressure handling occurs when the fabric asserts backpressure or signals congestion awareness through ECN/credit exhaustion, causing the scheduler to temporarily throttle Bulk/Vector classes while preserving Coherence/Atomic SLOs, consistent with the cross-layer signaling contemplated in the MF-TLP layer. Reordering safety for Coherence traffic requires the scheduler to respect program-order fences and the directory flow whereby a write cannot be made visible until invalidations/updates complete, independent of scheduling choices. For Vector operations, the Response Consolidator preserves element order in the single response even if internal issues were parallelized or re-sequenced.

Detailed operation proceeds through admission whereby on packet ingress, the parsing engine 410 extracts class, tenant, DL, and size, and the scheduler computes an estimated service time from per-class models such as fixed atomic latency and vector length/stride. If admission would violate per-tenant rate or VOQ occupancy constraints, the packet is marked deferred with deferred Coherence potentially preempting within bounds to avoid deadlock in the coherence protocol. The selection cycle operates each cycle whereby the scheduler refreshes credits per class and tenant, applies borrow rules if age of Coherence exceeds a threshold and Atomic has surplus, picks class by guarded EDF, picks VOQ inside the class, and transmits if credits[class, tenant] are greater than or equal to size while decrementing credits or lender's credits if borrowing and recording sent-time for latency telemetry.

The class selection by guarded EDF operates whereby if any class has DL packets with slack less than or equal to 0, the scheduler chooses the one with the smallest deadline subject to minimal safety constraints such as Coherence fences, else chooses the class with the earliest positive deadline, and if none, chooses the class with the largest normalized deficit using DRR. VOQ selection inside the class uses earliest deadline first if DL present, otherwise DRR across tenants.

Cross-class interactions allow Coherence to Atomic borrowing whereby Coherence acks and invalidations take precedence and may borrow from Atomic to drain outstanding sharers rapidly, reducing the Step-505 commit wait. Atomic to Vector prioritization ensures atomics with DL such as lock handshakes outrank Vector best-effort. Vector to Bulk prioritization allows Vector operations with application DL such as real-time inference gather to outrank Bulk while respecting the consolidated-response ordering semantics. Deadlines and transport interplay occur when the fabric signals sustained congestion, causing the scheduler to defer Bulk/Vector, raise Coherence credit refill rates temporarily under caps, and emit advisory pacing to peers via optional extension hints, consistent with MF-TLP's cross-layer congestion hooks.

Hardware structures and state comprise per-class credit meters per tenant with configurable rate, burst, and borrow_cap, a Borrow Matrix B over classes with default B[Coherence←Atomic] equal to enabled and others disabled, a Deadline Wheel or min-heap of DL packets per class for O(log N) selection, per-packet metadata containing tenant, class, size, DL, service_est, enqueue_time, and seq_tags, telemetry counters with on-NIC accumulators and histogram buckets, and safety gates that enforce coherence ordering through directory interface 430 and vector response order through reorder buffer/consolidator.

Enablement for deadline semantics distinguishes absolute versus relative deadlines whereby absolute DL uses a NIC local timebase and relative DL converts to absolute at ingress as DL_abs equal to now plus DL_rel. The scheduler computes slack using a per-class service curve as slack equal to DL_abs minus now minus E[service_time|class, size]. Packets with negative slack are treated as urgent with a tardiness counter per class tracking misses to inform control-plane policy. Schedulability hints allow the control plane to compute per-tenant utilization bounds such as Σ C_i/T_i less than or equal to p and program credit rates such that under nominal load, EDF is feasible, with credit meters enforcing the same envelope at runtime when traffic exceeds the plan.

Correctness, ordering, and safety ensure coherence safety whereby regardless of EDF choices, writes are not visible until invalidations/updates complete and the directory finalizes ownership. Scheduling only affects when such messages are issued, not their ordering relative to commit gates. Vector ordering ensures the Response Consolidator preserves original element order in the single response, even if packet sub-operations were issued out-of-order internally. Multi-tenant isolation ensures credits are per tenant with borrowing being intra-device, inter-class only and never crossing tenant boundaries, aligning with prior tenant-aware governance.

Telemetry and control-plane interface exports from the scheduler a telemetry namespace with per-tenant and per-class statistics including latency histograms at P50/P95/P99 per class, deadline miss counts and tardiness sum, throughput/capacity in bytes/s and packets/s, credit utilization and borrowed credits, queue depth and age at max/avg, backpressure episodes as count/duration, coherence-specific invalidation/ack latency and outstanding sharer fan-out, and vector-specific consolidated-response dwell time. Telemetry is readable via MMIO registers or streamed periodically, complementing the previously disclosed cross-layer congestion/backpressure indicators used for pacing and admission control.

The MC-NIC device implementation comprises a protocol parsing engine 410, a memory access unit 420, a coherence directory interface 430, an atomic/reduction block 440, and a deadline-aware scheduler 450 implementing class-specific credits with cross-class borrowing and EDF for deadline-bearing packets, plus a fabric interface block 460 that applies link-level flow control in response to congestion. The end-to-end system comprises compute devices, memory nodes with directory tables, MC-NICs, and switching elements, wherein MF-TLP packets carry optional timing hints in extension headers, and the MC-NIC scheduler enforces deadline-aware prioritization across Coherence, Atomic, Vector, and Bulk classes with per-tenant fairness and telemetry export.

The DASC embodiment provides lower tail latency for correctness-critical Coherence including invalidations/acks by EDF prioritization and targeted Atomic to Coherence credit borrowing, predictable QoS for latency-sensitive AtomicNector verbs without starving Bulk transfers due to independent credit envelopes, and operational visibility via rich per-tenant telemetry and backpressure integration, enabling control-plane adaptation and SLO enforcement. DASC plugs into the previously disclosed MC-NIC decomposition comprising elements 410/420/430/440/450/460 and MF-TLP semantics including header fields 310 through 320, extension headers, and coherence metadata, formalizing how deadline hints and class priorities are enforced in hardware while maintaining coherence and vector correctness guarantees.

In additional embodiments, the memory-centric network interface controller (MC-NIC) hosts a library of domain-specific kernels that execute near-memory on MF-TLP transactions to accelerate high-value graph analytics and machine-learning (ML) primitives beyond fixed arithmetic reductions. Unlike generic collectives or canned atomics, these kernels implement application-level operators including quantized accumulation (QADD8_SAT), histogram accumulation (HISTO), Top-K selection (TOPK), and probabilistic sketches comprising SKETCH_ADD such as Count-Min, as well as a graph frontier aggregator (BFS_FRONTIER) that computes next-frontier bitsets in-situ. Each kernel is invoked by opcode and applied to memory rows/tiles addressed by the MF-TLP vector facility including compressed descriptors, executes under a bounded resource contract comprising cycles, scratch/state bytes, and concurrency, and returns a single, ordered response or single completion, thereby preserving the MF-TLP “expand to parallel execute to consolidate” semantics.

This DSK-NIC embodiment composes with the programmable micro-op pipeline as the execution substrate, vector descriptor compression and streaming for sparse or hot-set inputs, per-region consistency and transactional fences to bound ordering, and atomic group persistence when durable multi-line commits are requested such as for persistent histograms or sketches.

The invocation model, opcodes, and packetization introduce kernel opcodes whereby MF-TLP introduces OP equal to KERNEL with a KERNEL_ID subfield selecting a pre-installed domain operator from the DSK-NIC library. Non-limiting examples include QADD8_SAT for quantized 8-bit accumulation with saturation and optional stochastic rounding, HISTO for histogram bucket increment for typed elements, TOPK for bounded min-heap or selection network to compute K largest or smallest values/keys, SKETCH_ADD for update operations for a Count-Min or CountSketch structure, and BFS_FRONTIER for boolean OR/ANDNOT against a resident visited set and production of the next frontier bitset.

Vector addressing allows requests to carry the base MF-TLP header and optional VECX extension comprising stride/length, delta-encoded offsets, bitset chunks, or dictionary-indexed hot offsets. The Descriptor Expansion Unit (DEU) converts VECX into an ordered element stream of POS, ADDR, and LEN tuples. The Response Consolidator preserves POS order. Kernel parameters and metadata are conveyed through a Kernel Parameter Block (KPB) accompanying the packet in an extension header containing type_id, elem_size, rounding_mode, scale, and zero_point for quantization, K for Top-K with cmp_mode as by key only or key plus payload and approx_mode as exact versus sketch-assisted, buckets and bucket_type for HISTO, d, w, and hash_seeds for SKETCH_ADD, and graph_id, bitset_len, chunk_base, and continuation_token for BFS_FRONTIER.

Determinism and contracts ensure each kernel has a resource contract comprising max_cycles, max_scratch, max_state, and max_concurrency. If a packet would exceed its contract given N_ELT and KPB, the MC-NIC returns ERR_OPLIMIT or streams the operation across multiple segments using the End-of-Vector (EOV) finalization, guaranteeing deterministic runtime per segment.

The MC-NIC microarchitecture extensions for DSK-NIC extend the programmable micro-op pipeline with a Domain Kernel Library (DKL) comprising pre-verified, micro-op sequences or microcode implementing each KERNEL_ID with deterministic schedules and bounded state. Map Lanes (SIMD) perform per-element transforms including quantize/dequantize, compare, and hash. Kernel Scratch SRAM provides per-invocation bounded scratch such as K times key-val heap, d times w sketch row accumulators, and bitset tiles. A Combine/Reduce Tree merges partial results deterministically using a balanced binary tree for associative operations or ordered fold otherwise. The Commit Unit writes back kernel results atomically, using the coherence directory interface to invalidate/update sharers before visibility, with group-atomic or durable ATOM_GROUP commit available when requested. All DSK kernels are tenant-scoped whereby the tenant ID selects code images if multiple, KPB limits, and per-tenant state/sealing, preserving isolation.

Kernel semantics and enablement provide specific implementations. For QADD8_SAT quantized accumulator with saturation, the semantics require for each input element x_q belonging to int8, applying dequantization x equal to S times x_q minus Z, accumulating into acc optionally as fp32 with compensated summation, re-quantizing with stochastic or ties-to-even rounding, and saturating to int8 range. If destination memory holds quantized accumulators, the system updates in-place with per-element atomicity or optionally group-atomic commit for vector RMW. The enablement involves parsing whereby DEU expands VECX addresses and for each ADDR, the map lane loads the destination quantized accumulator, dequantizes if needed, adds contribution from payload, re-quantizes, and saturates. Scheduling has map lanes produce per-tile partials with the reduction tree merging deterministic tiles or using ordered fold if assoc equals conditional. Commit operations for each destination line have the commit unit issue coherence invalidations/updates, then write back updated bytes with byte-mask support, and return single completion or bitmap. Use cases include quantized gradient or histogram accumulation during training/inference without moving data to host/accelerator.

For HISTO histogram accumulation, semantics given a stream of keys k belonging to 0 through B-1, increment bucket[k] by 1 or by weight w, with bucket type potentially uint8/uint16/uint32 and saturating variants avoiding wraparound. Enablement requires data layout whereby the histogram bucket array resides near memory with KPB supplying base, bucket count B, and type. Map/Reduce operations have map lanes compute bucket index for each element with per-tile local counter blocks in scratch minimizing random writes, reduction tree merging tile counters, and commit atomically adding merged counters to buckets through single-line RMW for hot buckets or multi-line for large B. Durability optionally applies when the region is persistent, using ATOM_GROUP to log and durably commit multi-line add operations with WALECHO. Use cases include real-time telemetry, frequency analysis, and feature binning.

For TOPK bounded Top-K selection, semantics for each tile maintain a min-heap of size K containing keys or key-val tuples. Map lanes push candidates, and when heap size exceeds K, pop minimum. The reduction tree merges per-tile heaps via pairwise heap-merge to bounded size. Enablement uses scratch state of K times key-val in kernel scratch with deterministic merge order as left-balanced eliminating non-determinism across tiles. Commit writes back K results to a result buffer or in-place selection indices. If a tenant object stores a standing Top-K, the system performs read-modify-heap with group-atomic commit. Approximate mode provides a sketch-assisted Top-K option consulting SKETCH_ADD counters to pre-filter obvious non-heavy hitters before heap pushes, reducing compute. Use cases include heavy hitter detection, top recommendations, and search ranking snippets.

For SKETCH_ADD probabilistic sketch update, semantics for Count-Min maintain d rows of length w whereby for each element e, hash with d seeds to positions h_i(e), add weight w_e to each row_i[h_i(e)] with saturating arithmetic. Enablement has map compute hashes in map lanes using tabulation or multiply-shift, reduce batch updates per row into CSR-like index-count lists to coalesce writes, and commit through byte/word-granular atomic adds to sketch rows with cache-line coalescing. Query optionally provides a paired SKETCH_QUERY kernel returning min_i of row_i[h_i(e)]. Use cases include streaming analytics, approximate frequency, and admission control hints for TOPK.

For BFS_FRONTIER graph frontier aggregation, semantics given a frontier bitset or sparse list and a visited bitset, compute the next frontier as next equal to union over v in frontier of neighbors(v) ANDNOT visited, and visited’ equal to visited OR next. Enablement requires graph layout whereby graph shard stored near memory such as CSR with arrays row offsets and col_indices, plus shard-local visited bitset and next_frontier scratch bitset. The shard boundary is defined by graph_id in KPB. Frontier encoding has frontier arrive as VECX using BITSET chunks for dense windows and/or DICT/DELTA for sparse indices.

Execution proceeds through expanding frontier whereby DEU iterates set bits or indices. Adjacency expansion for each frontier vertex id v has the map lanes fetch col_indices[row_offsets[v] through row_offsets[v+1]−1] using range micro-ops. Bitset update for each neighbor u sets next_frontier[u] equal to 1 in kernel scratch. Visited mask applies ANDNOT visited in place, producing the clean next frontier. Commit atomically ORs next_frontier into visited producing visited’ and returns the next frontier bitset as a consolidated response or writes it to a destination buffer, then clears scratch.

Streaming across shards for graphs partitioned over multiple MC-NICs has each shard compute a shard-local next_frontier_shard with MF-TLP reduction (OR) or switch-assisted replication aggregating across shards through hierarchical OR, returning a global next frontier.

The kernel is packetized with a continuation token to cap per-invocation work such as a max number of edges, ensuring deterministic runtime per segment with the requester resubmitting with the token to resume. Ordering and correctness ensure since OR/ANDNOT are associative/commutative on bits, the reduction is order-independent. Coherence ensures visited’ is visible before a subsequent BFS level begins with optional TM region class able to enforce a barrier across all shards at level boundaries. Use cases include shortest-path explorations, reachability, personalized PageRank step, and large-scale traversal inside recommendation pipelines.

Concurrency, consistency, and durability provide per-element atomicity whereby all in-place updates including quantized add, histo bucket add, sketch increments, and visited bit OR use the MC-NIC's atomic write path to guarantee per-element atomicity. For cross-line operations such as multi-bucket histo or multi-row sketch, the kernel optionally requests group-atomic semantics whereby the commit unit uses a small shadow log and releases the single completion only after all lines update or aborts with rollback. Transactional regions when CONSISTENCY_CLASS equals TM have the DSK kernel's read-set such as current buckets and visited bitset and write-set as updated entries logged with commit validating versions/epochs, then applying the write-set atomically. Persistent memory operations when the destination resides in persistent memory use ATOM_GROUP through PREPARE to DATA persist to barrier to COMMIT persist. The final completion may request WALECHO to confirm durability.

Safety, determinism, and resource governance ensure each kernel's DKL microcode and schedule are pre-verified. Deterministic execution requires the reduction tree order is fixed as balanced or the fold is serialized when associativity is conditional such as floating-point TOPK with tie-breaks. Bounded resources ensure scratch/state are statically bounded as O(K) for TOPK, O(d times w) working set slice for SKETCH_ADD, and fixed bitset tile for BFS_FRONTIER. Watchdog and limits trigger ERR_OPLIMIT and abort when exceeding max_cycles or max_scratch. Tenant isolation ensures state and code are sealed per tenant, kernels cannot DMA outside declared buffers, and address translation enforces per-tenant access control.

Deadlines, scheduling, and telemetry integrate with deadline-aware scheduling (DASC) whereby kernel packets may carry a deadline such as inference QADD8_SAT or time-bounded BFS step. The scheduler admits them via EDF within the Atomic/Vector classes with Coherence messages retaining highest priority for correctness. Telemetry has the MC-NIC export per-kernel counters including invocations, tiles processed, cycle counts, saturation events for QADD8_SAT/HISTO, heap overflow or tie-break counts for TOPK, sketch row collisions, BFS edges expanded, and continuation resumes. These feed control-plane tuning such as adjusting K, sketch width w, or BFS tile size.

The MC-NIC device implementation with DKL comprises a protocol parsing engine, a descriptor expansion unit for VECX, a programmable micro-op pipeline extended with a Domain Kernel Library implementing QADD8_SAT, HISTO, TOPK, SKETCH_ADD, and BFS_FRONTIER with deterministic schedules, a kernel scratch/state SRAM, a reduction tree, a commit unit integrated with a directory interface, and a scheduler capable of deadline-aware, class-based arbitration. The system comprises compute devices, memory nodes with directory tables and persistent memory arrays, switching elements, and MC-NICs as described, wherein MF-TLP packets invoke domain kernels over sparse address sets described by compressed vector descriptors, the MC-NIC executes said kernels near memory under bounded resource contracts, and returns a single ordered response or completion while preserving coherence and, where requested, transactional and durable commit semantics.

Interactions with other embodiments leverage programmable in-network operators whereby DSK kernels are delivered as pre-verified micro-op programs with stricter contracts and user-defined operators can be upgraded to domain kernels after profiling. Switch-assisted directory multicast enables coherence fan-out for kernel commits such as large histograms leveraging switch-side replication with acknowledgment aggregation. Vector compression and streaming allow DSK kernels to accept DELTA/BITSET/DICT/HYBRID descriptors with BFS_FRONTIER especially benefiting from BITSET chunks. Per-region consistency allows BFS_FRONTIER to run in RC with a release fence per level and TOPK results to be written under TM to compose with application transactions. Persistent semantics enable HISTO/SKETCH_ADD in persistent regions to use ATOM_GROUP with WALECHO and TOPK snapshots to be durably published. Deadline scheduling through EDF prioritizes latency-sensitive kernels without starving coherence. Cross-transport bridging allows kernel streams to be striped across heterogeneous transports with per-address reorder windows protecting read-on-write safety for kernel commits.

The DSK-NIC embodiment provides compute-to-data advantages avoiding round-tripping large, sparse structures to CPUs/GPUs by executing near memory at NIC line rate, deterministic and bounded execution through micro-op schedules and resource contracts guaranteeing predictable per-segment runtime critical for SLOs, rich semantics extending beyond sums to high-value ML/graph patterns including Top-K, sketches, and BFS with correctness through coherence/transactional and durability when needed, and composability reusing MF-TLP vectors, streaming, coherence, transactional, persistence, deadline scheduling, and cross-transport ordering without bespoke protocols. This embodiment provides concrete packet fields, kernel semantics, bounded micro-architectural execution, and system integration necessary to enable in-network domain primitives for ML and graph workloads, while preserving MF-TLP coherence, ordering, transactional, and durability guarantees and delivering single-packet simplicity at application boundaries.

By introducing a routable memory transaction protocol, programmable MC-NICs, and fabric-wide coherence mechanisms, the invention provides a scalable and coherent memory plane that spans racks and clusters. This enables compute and memory resources to be scaled independently, reduces synchronization overhead, and unlocks new levels of performance for AL, analytics, and scientific computing workloads.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “Memory-Fabric Transaction Layer Protocol (MF-TLP)” refers to a packet-based communication protocol that defines request and response formats for memory operations including read, write, atomic, and reduction transactions across a disaggregated memory fabric.

As used herein, “memory-centric network interface controller (MC-NIC)” refers to a specialized network interface device configured to terminate MF-TLP packets, translate them into local memory operations, execute in-network atomic and reduction operations, and maintain coherence metadata.

As used herein, “coherent memory fabric” refers to a packet-switched interconnect system that enables cache-coherent access to disaggregated memory resources across distributed compute devices and memory nodes while maintaining a consistent view of shared data.

As used herein, “vectorized transaction” refers to a memory operation that encodes multiple addresses, strides, or offsets within a single MF-TLP packet, enabling bulk scatter/gather access patterns to be executed efficiently.

As used herein, “atomic operation” refers to an indivisible memory transaction that performs a read-modify-write sequence at the target memory location, including operations such as fetch-and-add, compare-and-swap, or typed arithmetic transformations.

As used herein, “reduction operation” refers to an in-network aggregation function that combines multiple partial results from distributed sources using arithmetic or logical operations such as summation, product, minimum, maximum, or bitwise operations.

As used herein, “directory-based coherence protocol” refers to a distributed cache consistency mechanism that maintains sharer information for memory addresses and propagates invalidation or update messages to ensure coherent access across the fabric.

As used herein, “fabric identifier” refers to addressing metadata embedded in MF-TLP packets that enables routing across multiple network hops to reach the correct memory node or compute device within the disaggregated system.

As used herein, “vector descriptor” refers to a data structure that encodes addressing patterns for vectorized transactions, including base addresses, stride values, offset lists, or range specifications for bulk memory operations.

As used herein, “tenant identifier” refers to metadata carried in MF-TLP packet headers that associates transactions with specific processes, virtual machines, or users to enable multi-tenant isolation and quality-of-service enforcement.

As used herein, “in-network processing” refers to the execution of computational operations directly within network interface controllers or switching elements, proximate to memory resources, rather than requiring round-trip communication to host processors.

As used herein, “memory-semantic” and “memory-semantic transaction layer protocol” refer to a protocol layer whose native primitives are memory operations on a coherent address space—e.g., loads, stores, cache-coherent read-for-ownership, typed atomic read-modify-write, vectorized scatter/gather with a single consolidated response, reductions (including numeric-aware reductions with typed accumulators), transactional groups with failure-atomic commit, and explicit ordering/barrier operations—each having defined visibility, ordering, and coherence side-effects in hardware (e.g., directory updates, invalidations, lease issuance/renewal). A memory-semantic layer may ride over diverse transports (e.g., Ethernet/UET, InfiniBand) but is distinct from transport protocols whose scope is reliable delivery, congestion/flow control, or endpoint connectivity and that treat payloads as opaque data without specifying memory visibility or coherence semantics. In the disclosed system, MF-TLP is such a memory-semantic transaction layer: it encodes typed opcodes, extension headers (e.g., lease/epoch, TenantID, reduction semantics), vector descriptors, and QoS/governance fields, and is executed by MC-NICs to effectuate the corresponding hardware coherence and completion guarantees across the fabric.

### Memory-Centric Fabric Architecture

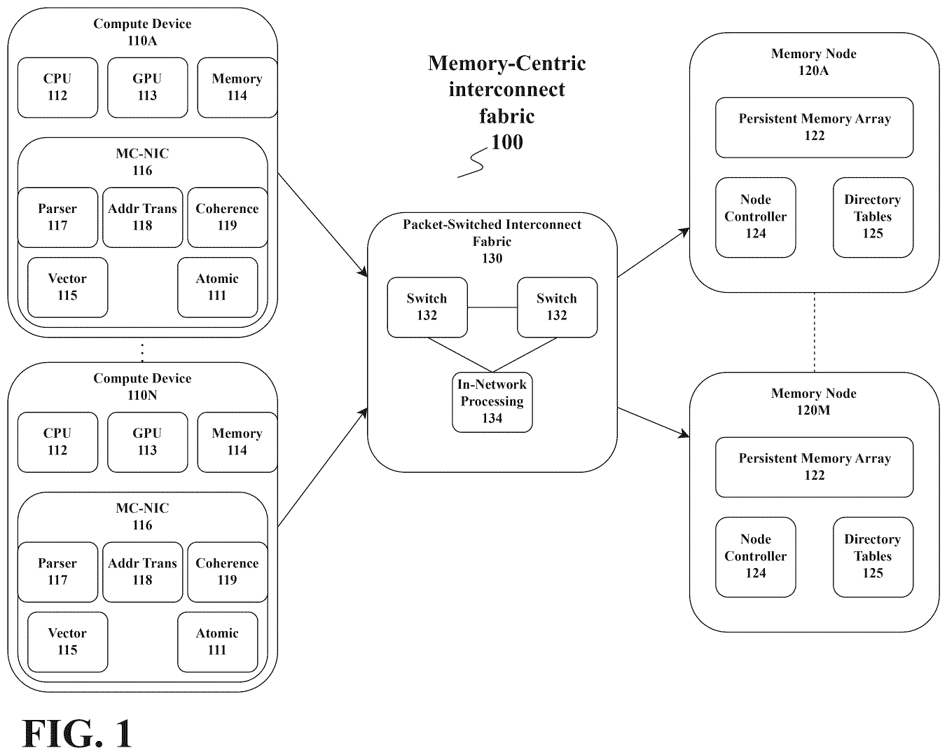

FIG. 1 is a block diagram illustrating exemplary architecture of a memory-centric interconnect fabric enabling distributed, coherent access to disaggregated memory resources at data-center scale, according to an embodiment.

The system architecture 100 includes a plurality of compute devices 110A-110N interconnected with a plurality of memory nodes 120A-120M by a packet-switched interconnect fabric 130. Each compute device may comprise one or more general-purpose processors 112 (e.g., CPUs), one or more accelerators 113 (e.g., GPUs, tensor cores, or AI inference engines), and a local memory subsystem 114 comprising one or more tiers of volatile memory such as high-bandwidth memory (HBM), DDR DRAM, or cache hierarchies.

Each compute device further comprises a memory-centric network interface controller (MC-NIC) 116. The MC-NIC 116 is configured to terminate memory fabric transaction layer protocol (MF-TLP) packets, map received packets to local memory operations, and initiate outbound MF-TLP packets to access remote memory. In one embodiment, the MC-NIC 116 includes a protocol parsing engine 117, an address translation unit 118, and a fabric coherence interface 119. In another embodiment, the MC-NIC 116 further comprises a vector operation unit 115 for processing vectorized transaction descriptors, and an atomic/reduction engine 111 for executing typed arithmetic or logical operations proximate to memory.

The interconnect fabric 130 may comprise one or more switching elements 132, each configured to perform routing of MF-TLP packets using fabric identifiers and addressing metadata. The fabric 130 may be implemented over one or more transport technologies, such as Ultra-Ethernet Transport (UET), InfiniBand, or PCIe/CXL extended over Ethernet. In some embodiments, the switching elements 132 further comprise in-network processing engines 134 capable of executing collective operations (e.g., reduce-scatter, all-gather) directly in the data path. The interconnect fabric 130 may be realized as a leaf-spine topology, a torus, or any other scalable packet-switched arrangement.

Each memory node comprises a persistent memory array 122, which may include DRAM, non-volatile memory (NVM) such as phase-change memory (PCM), resistive RAM (ReRAM), magnetoresistive RAM (MRAM), or combinations thereof. The memory node 120 further includes a node controller 124 configured to manage allocation of address ranges, respond to MF-TLP read and write requests, and enforce fabric coherence policies. The node controller 124 may maintain one or more directory tables 125 for tracking sharer information associated with memory lines, and may issue invalidation or update messages to compute devices 110 in accordance with a distributed directory-based coherence protocol.

In one mode of operation, a compute device 110A generates an MF-TLP read request targeting an address range hosted on memory node 120M. The MC-NIC 116 encapsulates the request into an MF-TLP packet and forwards it into the interconnect fabric 130. A switching element 132 routes the packet to the destination memory node 120M. The node controller 124 consults its directory table 125 to determine whether another compute device holds a cached copy of the requested line. If so, the node controller 124 transmits coherence messages (e.g., invalidates or updates) to the relevant MC-NICs 116, ensuring that the data returned to the requesting compute device 110A is coherent across the system.

The MC-NIC 116 is also configured to perform in network-atomic and reduction operations. For example, a requesting compute device may transmit a fetch-and-add request targeting a counter stored in memory node. Upon receipt of the MF-TLP packet, the MC-NIC performs the arithmetic operation locally at the NIC hardware, updates the memory array, and returns the result in a completion packet to the requester. In another embodiment, multiple partial gradient vectors transmitted from compute devices may be aggregated by in-network reduction logic at a switching element, thereby producing an aggregated tensor that is written once into the destination memory node.

The MF-TLP further supports vectorized and multi-operation transactions. A compute device may transmit a single MF-TLP packet containing a vector descriptor specifying a plurality of addresses, strides, or sub-ranges. The MC-NIC or node controller expands the vector descriptor into multiple memory operations, executes them in parallel, and consolidates results into a single MF-TLP response packet. This reduces per-operation overhead and is particularly advantageous for scatter/gather workloads in AI training and database indexing.

In some embodiments, the interconnect fabric further supports programmable quality-of-service (QoS) enforcement and multi-tenant isolation. MF-TLP packets may carry metadata tags such as tenant identifiers or priority levels. The MC-NIC or switching elements may apply programmable scheduling or rate-limiting policies based on such metadata, thereby providing governance for shared infrastructure deployments.

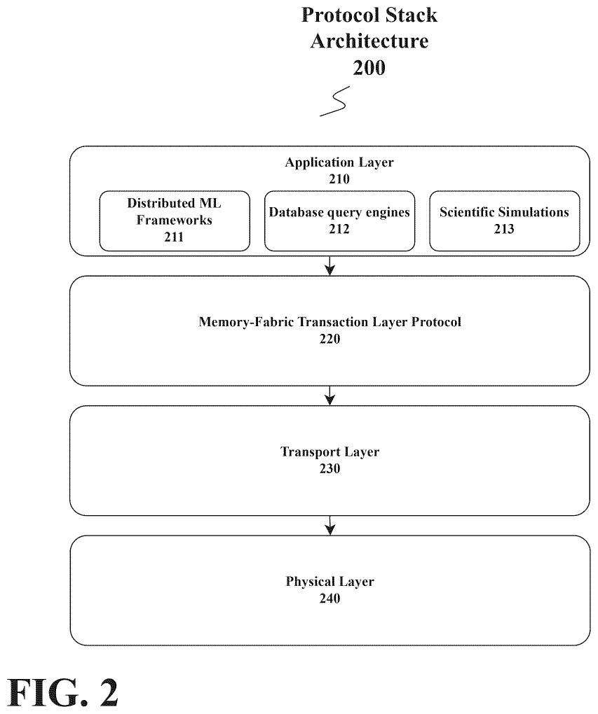

FIG. 2 is a block diagram illustrating an exemplary architecture of a protocol stack architecture that depicts the relative positioning of a Memory-Fabric Transaction Layer Protocol (MF-TLP) between higher-level application semantics and lower-level transport and physical signaling standards, according to an embodiment.

At the top of the protocol stack 200 resides an application layer 210. The application layer represents software workloads such as distributed machine learning frameworks 211, database query engines 212, or scientific simulations 213, each of which issues commands that require access to shared memory resources spanning multiple nodes of a fabric. These commands may take the form of memory reads and writes, synchronization primitives, or collective reduction operations, which are ultimately conveyed through the lower layers of the stack.

Immediately below the application layer 210 lies the MF-TLP layer 220, which introduces a routable packet-based abstraction for memory operations. The MF-TLP layer defines request and response formats that encapsulate operations such as read, write, atomic, and reduce transactions. Each packet may further include metadata fields that convey addressing information, coherence control information such as sharer or lease tokens, and descriptors that enable vectorized or fused operations to be expressed compactly. In certain embodiments, MF-TLP packets may also carry tenant identifiers, priority levels, or other quality-of-service tags that allow governance functions to be enforced at the NIC or switch level.

The MF-TLP layer 220 serves as a semantic bridge between the application layer and the underlying transport layer 230. The transport layer may be realized using existing industry standards such as Ultra-Ethernet Transport (UET), InfiniBand, RDMA over Converged Ethernet, or PCIe/CXL tunneling over Ethernet. The transport layer provides sequencing, congestion control, and reliable delivery, while remaining agnostic to the specific transaction semantics imposed by MF-TLP. In one embodiment, coherence messages generated by the MF-TLP layer are carried over ordered UET streams to guarantee consistent visibility across the fabric. In another embodiment, vector transactions defined at the MF-TLP layer are delivered through RDMA verbs, with the transport ensuring direct placement into NIC buffers while the MF-TLP logic expands the descriptors into multiple underlying memory operations.

Beneath the transport layer 230 lies the link and physical layer 240, which defines the physical signaling and framing used to transmit transport packets over electrical or optical media. The physical layer may correspond to high-speed Ethernet PHY devices, optical interconnects, or other high-bandwidth serial interfaces suitable for large-scale deployment.

In some embodiments, the MF-TLP layer 220 is directly exposed to the application layer 210 through software libraries or driver interfaces that provide memory-centric verbs such as read, write, atomic add, or reduce. This allows applications to issue memory operations in natural programming constructs without being required to program transport semantics directly. In other embodiments, the MF-TLP layer interacts with the transport layer 230 through cross-layer signaling. For example, congestion awareness indicators may be carried within MF-TLP headers to influence transport scheduling, while transport backpressure signals may throttle the issuance of high-fan-out coherence messages at the MF-TLP level.

Beneath the transport layer 230 lies the link and physical layer 240, which defines the physical signaling and framing used to transmit transport packets over electrical or optical media. The physical layer may correspond to high-speed Ethernet PHY devices, optical interconnects, or other high-bandwidth serial interfaces suitable for large-scale deployment.

In some embodiments, the MF-TLP layer 220 is directly exposed to the application layer 210 through software libraries or driver interfaces that provide memory-centric verbs such as read, write, atomic add, or reduce. This allows applications to issue memory operations in natural programming constructs without being required to program transport semantics directly. In other embodiments, the MF-TLP layer interacts with the transport layer 230 through cross-layer signaling. For example, congestion awareness indicators may be carried within MF-TLP headers to influence transport scheduling, while transport backpressure signals may throttle the issuance of high-fan-out coherence messages at the MF-TLP level.

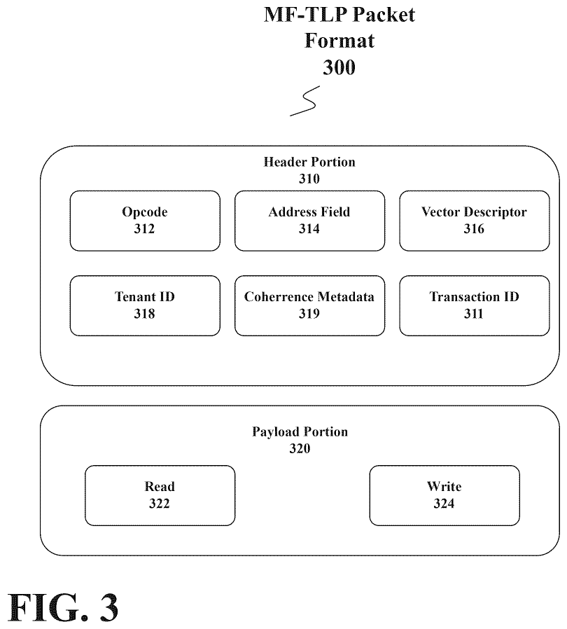

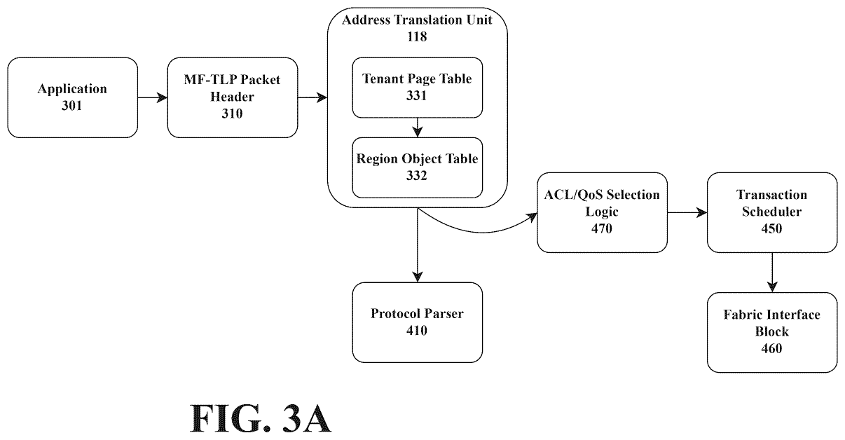

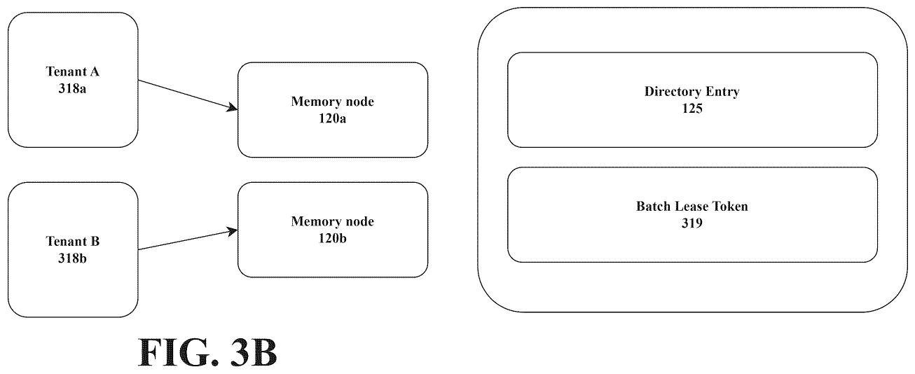

FIG. 3 is a block diagram illustrating an exemplary architecture of a packet format employed by the Memory-Fabric Transaction Layer Protocol (MF-TLP), according to an embodiment.

Each MF-TLP packet is structured to include a header portion 310 and a payload portion 320. The header portion conveys the semantic and routing information necessary for the transaction, while the payload portion carries data or operands associated with the transaction. By separating control metadata from data, the format allows intermediate nodes such as switches and memory-centric NICs to process requests efficiently without requiring application context.

The header portion 310 begins with an opcode field 312 that identifies the type of transaction being requested. In one embodiment, the opcode may specify fundamental operations such as read or write, while in another embodiment the opcode may indicate more advanced operations such as atomic fetch-and-add, compare-and-swap, or floating-point reductions. A reduction opcode may further encode whether the operation is associative, commutative, or typed by data width. This explicit encoding allows hardware within the NIC or the switch to recognize the operation type and execute it directly in the network fabric.

Following the opcode, the header 310 may include an address field 314 specifying the location of the data to be accessed or modified. The address field may represent a physical memory line address, a virtual address mapped through a translation structure, or a higher-level memory object identifier. In some embodiments, the address field includes a fabric identifier that enables packets to be routed across multiple hops to the correct memory node. In other embodiments, the address field may represent a range of addresses, thereby supporting burst-style or block memory transfers.

In an embodiment supporting vectorized operations, the header 310 may also contain a vector descriptor field 316. The vector descriptor may encode a base address and a stride value, thereby describing a sequence of addresses to be accessed in a regular pattern. Alternatively, the descriptor may carry a list of explicit offsets relative to a base pointer, allowing non-contiguous scatter/gather patterns to be issued in a single transaction. By embedding vector semantics at the transaction layer, the format amortizes per-operation overhead, enabling workloads such as embedding lookups or tensor updates to be executed using fewer packets.

The header 310 may further include a tenant identifier field 318 that associates the packet with a particular process, virtual machine, or user. In a shared or multi-tenant deployment, the tenant identifier may be interpreted by memory-centric NICs or switching elements to enforce quotas, apply scheduling policies, or enforce isolation rules. In some embodiments, the tenant identifier may be coupled with a priority subfield that determines relative ordering of packets under congestion, allowing high-priority transactions such as coherence messages to be expedited ahead of bulk transfers.

To support consistency, the header 310 may incorporate a coherence metadata field 319. The coherence metadata may encode state bits, sharer information, or lease tokens, thereby allowing a directory-based coherence protocol to be implemented across the fabric. For example, when a memory node receives a write request, the coherence metadata may instruct the node to issue invalidations to all sharers listed in the field before completing the write. In other embodiments, the metadata may indicate version numbers or sequence tags that allow receivers to determine whether data is fresh or stale.

In addition to semantic fields, the header 310 may also include a transaction identifier 311 that uniquely identifies a request and enables responses to be matched to their corresponding requests in flight. This identifier supports pipelined or out-of-order operation, allowing a single compute device to issue multiple outstanding memory transactions concurrently. The header 310 may further carry error detection codes or checksums to ensure end-to-end integrity of both header and payload contents. In some embodiments, the error detection codes may be extended to include forward error correction bits for improved reliability over optical links.

The payload portion 320 of the ML-TLP packet carries the data associated with the transaction. For write operations 324, the payload may include the values to be committed into the target memory address. For read operations 322, the payload is empty in request packets but populated in response packets. For atomic or reduction operations, the payload may contain operands that are combined with existing values in memory, with the result returned in a response payload or written directly to the target memory array. For vector operations, the payload may include a sequence of data elements corresponding to the addresses encoded in the vector descriptor, thereby supporting bulk scatter or gather transactions.

In some embodiments, the MF-TLP packet format 300 may further allow extension headers to be inserted between the main header 310 and the payload 320. Extension headers may carry optional information such as predictive prefetch directives, congestion control hints, or application-specific annotations. For example, an extension header may instruct intermediate switches to replicate a payload to multiple destinations, or may provide timing hints that allow the network to prioritize operations with real-time deadlines. By defining extension headers as optional, the protocol allows forward compatibility and extensibility without requiring legacy devices to support all extensions.

The MF-TLP packet format 300 therefore establishes a generalized, routable, and extensible structure for memory-centric transactions across a disaggregated fabric. The header fields enable precise encoding of operation types, addressing modes, vector descriptors, tenant identifiers, and coherence metadata, while the payload fields provide operands and results. This format allows diverse memory operations to be expressed compactly, routed efficiently, and executed either at memory nodes or within the fabric itself, while remaining compatible with existing transport standards such as Ethernet or RDMA.

FIG. 3A is a block diagram illustrating a detailed architecture and operational flow of the MF-TLP address and tenant virtualization pipeline, depicting how application-level memory requests are transformed into routable fabric transactions with virtualized addressing, multi-tenant isolation, and coherence metadata, according to an embodiment.

The pipeline begins when an application 301 issues a memory verb-such as a read, write, atomic operation, or vectorized transaction request-directed to what the application perceives as a virtual fabric address (VFA). This application-level request is intercepted by the memory fabric software stack, which initiates the formation of an MF-TLP packet header 310 comprising the fields described in paragraphs. The header formation stage constructs opcode field 312 identifying the operation type (READ, WRITE, ATOMIC, REDUCE, or vectorized variants thereof), address field 314 carrying the virtual fabric address, vector descriptor field 316 encoding stride or offset patterns for multi-address operations, tenant identifier field 318 associating the request with a specific process or virtual machine, coherence metadata field 319 for directory-based consistency tracking, and transaction identifier field enabling request-response matching in the presence of pipelined or out-of-order completions. The populated MF-TLP header is then forwarded to the Address Translation Unit 118 for virtualized address resolution and policy enforcement.

The Address Translation Unit (ATU) 118, implements a two-stage translation mechanism designed to map tenant-specific virtual fabric addresses to physical memory node coordinates while simultaneously enforcing multi-tenant isolation and extracting quality-of-service policies. The first stage comprises a Tenant Page Table (TPT) 331 that is indexed by a composite key formed from tenant identifier 318 concatenated with the high-order bits of the virtual fabric address carried in field 314. The TPT 331, organized as a 2,048-entry four-way set-associative cache with pseudo-LRU replacement, performs a parallel tag comparison across all ways within the indexed set to determine whether a valid mapping exists for the requested (TenantID, VFA_high) tuple. Upon a TPT hit, the matched entry yields a RegionID identifying a coarse-grained memory region allocated to the tenant, along with policy metadata including a QoS class identifier (specifying priority level, bandwidth quota, and latency class) and a consistency class indicator. These policy bits are extracted and forwarded along a separate datapath to the ACL/QoS Selection logic for enforcement by Transaction Scheduling and QoS Unit 450, as will be described subsequently.

The RegionID produced by the TPT lookup, together with the tenant identifier 318 and the remaining offset bits from address field 314, form the composite key for the second translation stage: the Region Object Table (ROT). The ROT 332, comprising 8,192 entries organized as an eight-way set-associative structure also employing pseudo-LRU replacement, performs a finer-grained mapping that resolves the (TenantID, RegionID, offset) tuple into a physical memory location tuple consisting of NodeID (identifying the target memory node within the fabric topology), ObjectID (identifying a memory object or allocation unit within that node), and LocalAddr (specifying the byte-level address within the object's address space). Critically, each ROT entry also stores a Directory Pointer-a reference or handle to the corresponding entry within the distributed directory structure 125 maintained at the target memory node which enables the coherence directory interface 430 to efficiently locate and update sharer tracking metadata without performing a separate directory lookup at the destination. Additionally, the ROT entry contains coherence metadata 319 such as sharer bit vectors indicating which compute devices currently cache copies of the addressed line, lease tokens granting time-limited exclusive access rights, or version numbers for optimistic concurrency control. Both the TPT and ROT lookups execute in pipelined fashion at 1 GHz clock frequency, with each stage completing within two clock cycles, yielding an aggregate translation latency of four nanoseconds for cache hits—a performance characteristic essential for maintaining low end-to-end memory access latency across the fabric.

The output of the Address Translation Unit 118 comprises the resolved physical location tuple (NodeID, ObjectID, LocalAddr), the Directory Pointer for coherence tracking, and the coherence metadata 319 that will be embedded in the outgoing MF-TLP packet header to enable directory-based consistency enforcement at the destination memory node. The NodeID component is immediately utilized to determine the fabric route—that is, the sequence of switching elements 132 through which the packet must traverse to reach the target memory node—and this routing information is passed to Fabric Interface Block 460 for packet transmission. Meanwhile, the policy metadata extracted earlier from the TPT (QoS class and consistency class) flows through the ACUQoS Selection logic 470, which interprets these policy bits to determine the appropriate scheduling priority, bandwidth allocation, and ordering constraints for the transaction. For example, a QoS class indicating “latency-sensitive” may designate the packet for high-priority transmission ahead of bulk vectorized transfers, while a consistency class of “sequential” may impose stricter ordering requirements relative to other in-flight transactions from the same tenant. These enforcement parameters are conveyed to Transaction Scheduling and QoS Unit 450, which applies programmable prioritization algorithms (such as weighted fair queuing or strict priority scheduling) and rate-limiting mechanisms (such as token bucket filtering) to govern when the MF-TLP packet is transmitted onto the fabric via interface 460. This scheduling enforcement ensures that multiple tenants sharing the memory fabric receive differentiated service according to their contracted service levels, preventing low-priority bulk transfers from introducing latency for high-priority atomic operations or coherence invalidations.

In the event that either the TPT or ROT lookup results in a cache miss-indicating that the requested (TenantID, VFA) or (TenantID, RegionID, offset) mapping is not currently resident in the translation cache—the Address Translation Unit 118 initiates a miss handling sequence. The translation unit immediately asserts a backpressure signal to Protocol Parsing Engine 410, which stalls the processing of incoming MF-TLP packets to prevent queue overflow while the missing translation entry is being fetched. Simultaneously, Fabric Interface Block 460 generates and transmits a control-plane request to a distributed translation service or centralized management controller responsible for maintaining authoritative mappings between tenant virtual addresses and physical memory resources. This control-plane entity consults its global mapping tables—which may be stored in a distributed key-value store or replicated database—and responds with the requisite mapping metadata, including the RegionID (for TPT misses) or the (NodeID, ObjectID, LocalAddr, Directory Pointer) tuple (for ROT misses), along with associated policy bits and coherence metadata. The returned mapping is installed into the appropriate translation cache structure using the pseudo-LRU replacement policy to evict the least-recently-used entry within the indexed set, and the backpressure signal to parsing engine 410 is deasserted, allowing packet processing to resume. The control-plane round-trip typically completes within 200 to 500 nanoseconds depending on the proximity and load of the management controller, during which time subsequent MF-TLP packets targeting the same or spatially-adjacent addresses may accumulate in ingress queues, enabling opportunistic batching once the translation becomes available.

Additionally, the miss handling logic addresses error conditions wherein a TPT entry is marked explicitly invalid, indicating that the requesting tenant lacks authorization to access the specified VFA range, or that the region has been deallocated or revoked due to policy violations or administrative actions. In such cases, rather than stalling indefinitely, the Address Translation Unit 118 immediately generates an error completion packet tagged with the original transaction identifier 311 from the request header. This error packet, routed back to the requesting compute device via Fabric Interface Block 460, carries a detailed status code indicating the specific fault condition—such as PERMISSION_DENIED (tenant not authorized for region), INVALID_ADDRESS (VFA outside allocated ranges), or REGION_UNMAPPED (target region deallocated)—enabling the software stack at the originating compute device to handle the exception appropriately, for example by raising a segmentation fault to the application, retrying with updated credentials, or requesting reallocation from the memory fabric management layer. By encoding fine-grained error semantics directly into completion packets and leveraging transaction identifier 311 for matching, the system maintains robust error handling without requiring separate out-of-band signaling channels or synchronous error propagation that would otherwise introduce latency into the common-case success path.

The MLF-TLP address and tenant virtualization pipeline therefore provides a comprehensive mechanism for transforming application-level memory operations into routable, policy-governed, coherence-aware fabric transactions. By interposing two levels of indirection-first from (TenantID, VFA) to RegionID with policy extraction, then from (TenantID, RegionID, offset) to (NodeID, ObjectID, LocalAddr) with directory pointer resolution—the architecture enables flexible address space management wherein tenant virtual address spaces can be remapped, migrated, or expanded without requiring changes to application code or even awareness at the application layer. This virtualization capability is particularly advantageous in disaggregated memory environments where physical memory resources may be dynamically reallocated among tenants based on demand, with the TPT and ROT structures serving as indirection layers that insulate applications from physical resource churn. Moreover, by co-locating policy enforcement (QoS class, consistency model) with address translation, the pipeline achieves efficient policy application with minimal additional latency, avoiding the need for separate policy lookup stages that would otherwise extend the critical path. The integration of directory pointers directly within ROT entries similarly optimizes the coherence protocol by enabling single-roundtrip coherence operations at the destination memory node, as the MC-NIC receiving the packet can immediately access the relevant directory entry using the embedded pointer without performing an address-to-directory translation. Finally, the robust error handling and backpressure mechanisms ensure correctness even in the presence of translation misses, permission violations, or transient control-plane unavailability, guaranteeing that the system degrades gracefully under load rather than introducing silent data corruption or protocol deadlocks. These architectural properties collectively enable the Memory-Fabric Transaction Layer Protocol to support large-scale, multi-tenant disaggregated memory deployments with strong isolation, differentiated service quality, and fabric-wide coherence.

FIG. 3B is a block diagram illustrating the architecture of per-tenant logical region mapping and the associated coherence lease token mechanisms that enable efficient fabric-wide cache consistency with reduced invalidation overhead, according to an embodiment. The diagram depicts how multiple tenants—each identified by a unique tenant identifier 318—organize their virtual address spaces into semantic regions such as heaps, queues, and tensor storage, and how these logical regions are mapped through region descriptors to distributed ObjectIDs hosted across multiple memory nodes, with Directory structures maintaining coherence metadata 319 including batch lease tokens that grant time-bounded access rights to reduce protocol traffic.

Tenant A 318a (assigned TenantID equal to 0x1001) and Tenant B 318b (assigned TenantID equal to 0x2001), each of which has been allocated multiple logical regions within their respective virtual fabric address (VFA) spaces. Tenant A's address space comprises three regions serving distinct semantic purposes: Region 0 is designated as general-purpose heap memory with a base VFA of 0x0000_0000_0000, spanning 16 gigabytes, configured with read-write permissions and sequential consistency semantics, and mapped to ObjectIDs in the range 0x1001_0000 through 0x1001_3FFF; Region 1 is designated as a machine learning training queue with base VFA 0x0000_0400_0000, spanning 2 gigabytes, configured with read-write permissions and release consistency to allow relaxed ordering of non-dependent operations, and mapped to ObjectIDs 0x1001_4000 through 0x1001_47FF; Region 2 is designated for gradient tensor storage with base VFA 0x0000_0800_0000, spanning 4 gigabytes, configured with read-write permissions and fully relaxed consistency to maximize throughput for independent tensor updates, and mapped to ObjectIDs 0x1001_4800 through 0x1001_57FF. Similarly, Tenant B's address space comprises two regions: Region 0 designated for database table storage with 32 gigabytes allocated to ObjectIDs 0x2001_0000 through 0x2001_7FFF under sequential consistency, and Region 1 designated as a read-only index cache with 8 gigabytes mapped to ObjectIDs 0x2001_8000 through 0x2001_9FFF under relaxed consistency. These region-level semantic annotations enable the system to apply differentiated treatment based on workload characteristics—for example, enforcing strict ordering for database tables while permitting aggressive reordering and prefetching for read-only index data-thereby achieving higher performance than would be possible with a uniform consistency model applied across the entire tenant address space.

Each logical region is described by a 64-byte Region Descriptor data structure maintained within the control plane and cached within the Region Object Table (ROT). The region descriptor comprises the following fields: a base VFA field (8 bytes) specifying the lowest virtual fabric address within the region's range; a length field (8 bytes) indicating the size of the region in bytes, with regions supporting sizes from 4 kilobytes (single page) up to multiple terabytes; a permissions field (1 byte) encoding read, write, and execute access rights using standard UNIX-style permission bits, where read-only regions (such as Tenant B's Region 1) are marked with the R flag while general-purpose heaps carry RW flags; a consistency model field (1 byte) selecting among sequential consistency (strict program order), release consistency (ordering enforced only at synchronization points) or relaxed consistency (allowing arbitrary reordering of independent operations); a sharer mask class field (2 bytes) identifying which class of directory sharer representation to employ, with classes ranging from “precise bitmask” (tracking up to 64 individual compute devices via a 64-bit sharer mask) to “coarse region” (tracking presence at rack or cluster granularity) to “broadcast” (assuming all devices may hold copies, requiring full-fabric invalidations); a multicast group identifier field (2 bytes) specifying a fabric-level multicast address to which invalidation messages should be transmitted, enabling efficient one-to-many coherence operations without requiring unicast messages to each individual sharer; a base ObjectID field (4 bytes) identifying the first ObjectID within the contiguous range allocated to this region, with subsequent ObjectIDs computed by adding offsets derived from the VFA; and a metadata section (38 bytes) carrying additional state including current lease tokens, quality-of-service parameters inherited from the Tenant Page Table (TPT), version numbers for optimistic concurrency control, access counters for profiling and optimization, and reserved space for future extensions. The system supports up to 2\hat{ }20 (approximately one million) regions per tenant, enabling fine-grained partitioning of the tenant address space into semantically meaningful units that can be independently managed, migrated, and governed, with the Region Descriptor format designed to balance expressiveness against cache footprint within the ROT structures distributed across MC-NICs throughout the fabric.

The mapping from logical regions to physical memory resources is illustrated by the arrows connecting tenant regions to Memory Nodes 120A and 120B. Memory Node 120A, assigned NodeID 0x0001, hosts a subset of ObjectIDs from both tenants: specifically, ObjectIDs 0x1001_0000 through 0x1001_3FFF (Tenant A's heap Region 0), ObjectIDs 0x1001_4000 through 0x1001_47FF (Tenant A's queue Region 1), and ObjectIDs 0x2001_0000 through 0x2001_3FFF (a portion of Tenant B's database Region 0). Similarly, Memory Node 120B, assigned NodeID 0x0002, hosts ObjectIDs 0x1001_4800 through 0x1001_57FF (Tenant A's tensor Region 2), the remainder of Tenant B's database ObjectIDs 0x2001_4000 through 0x2001_7FFF, and Tenant B's index cache ObjectIDs 0x2001_8000 through 0x2001_9FFF. This distribution demonstrates how a single logical region—such as Tenant B's 32-gigabyte database Region 0—may be striped across multiple physical memory nodes to achieve parallelism and load balancing, with the first portion (ObjectIDs 0x2001_0000 through 0x2001_3FFF) residing on Node 120A and the second portion (ObjectIDs 0x2001_4000 through 0x2001_7FFF) residing on Node 120B. Each memory node maintains a Directory structure 125 comprising 16,384 entries that track coherence state for individual cache lines within the ObjectIDs hosted locally. The placement of ObjectIDs across memory nodes is determined by the control plane during region allocation and is encoded within the Region Object Table entries such that the ROT lookup performed by Address Translation Unit 118, directly yields the (NodeID, ObjectID, LocalAddr) tuple identifying the physical location of any given VFA within a tenant's address space. This indirection layer enables transparent migration of regions between memory nodes—for example, to rebalance load or consolidate tenants—by updating ROT entries without requiring changes to application code or tenant-visible virtual addresses, thereby providing the flexibility necessary for dynamic resource management in large-scale disaggregated deployments.

The coherence metadata 319 and batch lease token mechanisms that optimize fabric-wide cache consistency by reducing the frequency and fan-out of invalidation messages. Each entry in Directory 125, corresponding to a single cache-line-sized (typically 64-byte) region of memory, maintains the following state: a coherence state field encoded using the conventional Modified-Exclusive-Shared-Invalid (MESI) or similar protocol, with states including SHARED (indicating that one or more compute devices hold read-only cached copies), EXCLUSIVE (indicating a single device holds the line with write permission but has not yet modified it), and MODIFIED (indicating a single device holds a dirty copy that must be written back before other devices can access); a sharer mask (64 bits in the precise bitmask class) represented as a bitmap where bit i is set if compute device i currently caches a copy of the line, enabling efficient identification of which devices require invalidation messages upon a subsequent write request; an owner identifier (16 bits) specifying which compute device currently holds an EXCLUSIVE or MODIFIED copy, allowing the directory controller to directly target that device when another requester needs to acquire ownership; and a lease token field (32 bits) granting time-bounded access rights as described subsequently. For example, if compute devices 0, 1, and 4 each hold shared copies of a cache line corresponding to ObjectID 0x1001_0000 at byte offset 0x40, the sharer mask would be set to 0x0000_0000_0000_0013 (binary . . . 0001_0011), and the coherence state would be SHARED. Upon receiving a subsequent read request from compute device 7 via an MF-TLP packet, the directory controller updates the sharer mask to 0x0000_0000_0000_0093 (adding bit 7) and returns the requested data without requiring invalidations, as multiple readers can coexist in the SHARED state. However, upon receiving a write request, the directory must transition the line to MODIFIED state held exclusively by the requesting device, requiring invalidation messages to be transmitted to all current sharers (devices 0, 1, 4, and 7 in this example), with the write operation completing only after receiving acknowledgments from all invalidated devices.

Batch lease tokens, carried within coherence metadata field 319, provide a mechanism to amortize the cost of directory updates and invalidations across multiple operations by granting time-bounded permissions that remain valid until a specified epoch. A batch lease comprises a 16-bit lease identifier uniquely identifying the grant within the fabric, a 32-bit expiry epoch timestamp (measured in nanoseconds since system boot or other reference point) indicating when the lease automatically invalidates, an access mode indicator selecting between READ_SHARED (allowing multiple compute devices to cache the leased address range concurrently) and WRITE_EXCLUSIVE (granting exclusive write access to a single device), and an address range specification that may reference a contiguous block via base address plus length or may reference multiple non-contiguous addresses via a vector descriptor 316. When a compute device issues a read request for a cache line and the Directory 125 determines that the line is currently in SHARED or EXCLUSIVE state without conflicts, the directory controller may opportunistically grant a READ_SHARED lease with an expiry epoch set, for example, 1 millisecond in the future, allowing the requesting device to retain its cached copy and serve subsequent read operations locally without consulting the directory, thereby reducing read latency and directory traffic. The lease remains valid until either the expiry epoch elapses or another device requests write access to the leased line, in which case the directory controller transmits an early revocation message—itself an MF-TLP packet carrying the lease identifier and a revocation opcode—to the lease holder, requiring the device to invalidate its cached copy and acknowledge the revocation before the write requester can proceed. This lease-based approach is particularly advantageous for read-mostly workloads such as Tenant B's read-only index cache (Region 1), where a compute device may read the same index entries repeatedly over milliseconds or seconds, with the initial lease grant enabling thousands of subsequent local cache hits without directory interaction, while still maintaining correctness by revoking leases promptly when writes occur.

The mechanisms by which TenantID 318 gates region access and by which Directory 125 pointers enable differentiated lease grants for read versus write operations. When an MF-TLP packet arrives at a memory-centric network interface controller (MC-NIC) 400, the protocol parsing engine 410 extracts TenantID 318 from the packet header, and forwards it to Address Translation Unit 118 for validation. The ROT lookup, keyed by (TenantID, RegionID, offset), not only yields the (NodeID, ObjectID, LocalAddr) physical location but also retrieves the permissions field from the cached Region Descriptor. If the requested operation is a write (indicated by opcode 312) but the permissions field specifies read-only access—as is the case for Tenant B's Region 1 index cache—the Address Translation Unit 118 immediately generates an error completion packet tagged with transaction identifier 311, carrying a status code such as PERMISSION_DENIED, and returns this error to the requesting compute device via Fabric Interface Block 460, without ever accessing the target memory or consulting Directory 125. This early permission check enforces tenant isolation by ensuring that a tenant cannot access or modify regions belonging to other tenants (for which the ROT would contain no valid mapping) or violate the access restrictions on its own regions (for which the permissions field would indicate insufficient rights). Conversely, if the TenantID and permissions checks succeed, the ROT lookup yields the Directory Pointer referencing the appropriate entry within Directory 125, enabling the MC-NIC's coherence directory interface 430.

For read operations that pass the TenantID and permissions gates, the coherence directory interface 430 consults the referenced Directory 125 entry and, finding that the line is either SHARED with existing sharers or EXCLUSIVE/MODIFIED but held by a device willing to downgrade to SHARED, updates the sharer mask to include the requesting device and grants a READ_SHARED lease with an expiry epoch selected based on workload heuristics (for example, shorter leases for frequently-written data, longer leases for read-mostly data), requiring only O(1) coherence messages—specifically, the single response packet returning the data and lease token to the requester—with no invalidations necessary since multiple readers can coexist. In contrast, for write operations that pass the gates, the coherence directory interface 430 must ensure exclusive access by first consulting the sharer mask to identify all current holders of cached copies (potentially dozens or hundreds of compute devices in a large-scale deployment), then transmitting invalidation messages—encoded as MF-TLP packets with invalidation opcodes—to each identified sharer, then awaiting acknowledgment messages from all sharers confirming that they have purged their cached copies, and only after receiving all acknowledgments can the directory grant a WRITE_EXCLUSIVE lease and allow the write operation to proceed, resulting in O(S) coherence messages where S is the number of sharers. To mitigate this invalidation overhead, the system leverages the multicast group identifier from the Region Descriptor: rather than unicasting invalidation messages individually to each of the S sharers, the directory controller can transmit a single multicast invalidation packet addressed to the multicast group associated with the region, with the fabric switching elements 132 replicating the packet to all group members, thereby reducing the number of packet transmissions from O(S) to O(log S) in a tree-based multicast topology or even O(1) in fabrics with native multicast support. Furthermore, by associating consistency model metadata with each region—for example, marking Tenant A's gradient tensor Region 2 as “relaxed consistency”—the directory controller can apply optimizations such as delaying invalidations until a synchronization point (fence operation) or allowing overlapping read and write operations to different words within the same cache line, trading strict coherence for higher throughput in workloads where such relaxations are semantically acceptable.

The composition of ROT-derived NodeID information with transport-layer route selection demonstrates how the memory fabric achieves end-to-end routability while maintaining tenant isolation and quality-of-service differentiation. After the Address Translation Unit 118 produces the NodeID identifying the target memory node, the Fabric Interface Block 460, consults a fabric topology table—maintained via a distributed routing protocol such as BGP or a centralized software-defined networking (SDN) controller—to determine the multi-hop path through switching elements 132 required to reach the destination NodeID from the current MC-NIC's location within the data center topology, which may be a leaf-spine network, a torus, or another scalable interconnect architecture. The computed path, encoded as a sequence of egress port identifiers or as a destination-based routing tag compatible with the underlying transport layer (Ultra-Ethernet Transport, InfiniBand, or extended PCIe/CXL) is embedded within the outgoing MF-TLP packet's transport header, enabling switching elements to forward the packet hop-by-hop toward its destination without requiring per-packet route computation at each switch. Critically, the QoS class extracted from the Tenant Page Table during the earlier address translation stage, influences path selection and scheduling at each hop: for example, high-priority transactions such as coherence invalidations or latency-sensitive atomic operations may be assigned to dedicated virtual channels or quality-of-service classes within the transport layer, ensuring bounded latency even in the presence of bulk vectorized transfers consuming the majority of available bandwidth. This integration of tenant-aware address translation, directory-based coherence with lease optimization, and QoS-aware fabric routing provides a comprehensive substrate for multi-tenant disaggregated memory deployments, wherein diverse workloads-ranging from strongly-ordered transactional databases (Tenant B Region 0) to loosely-ordered machine learning gradient aggregation (Tenant A Region 2)—can coexist on shared physical infrastructure while receiving differentiated service and maintaining isolation guarantees.

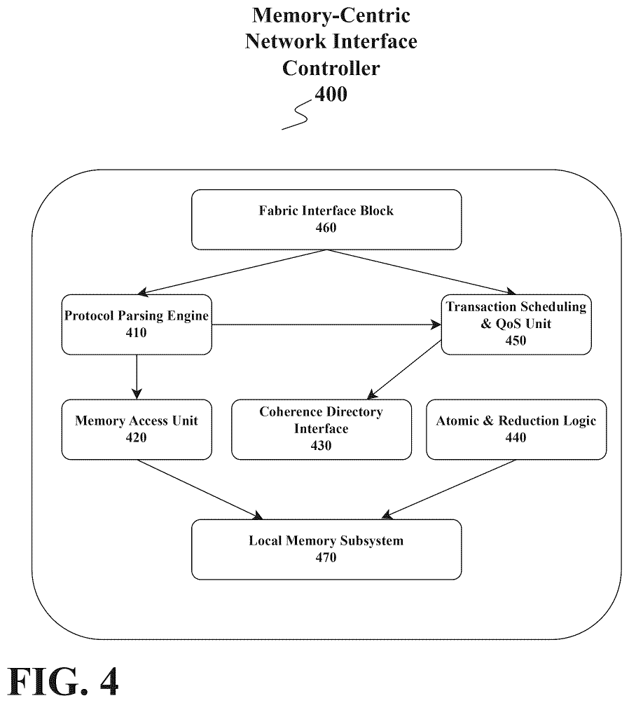

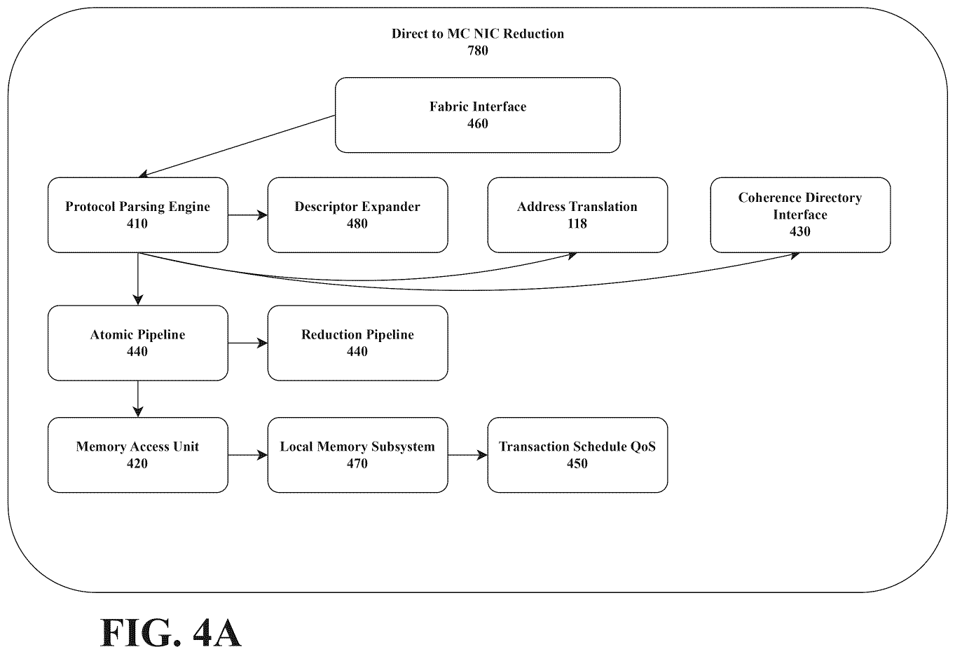

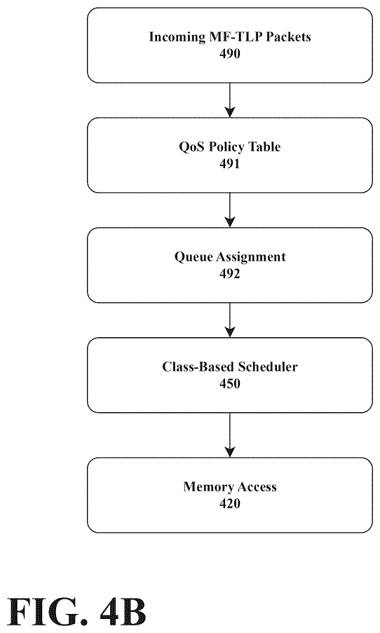

FIG. 4 is a block diagram illustrating exemplary architecture of a memory-centric network interface controller (MC-NIC), according to an embodiment.

The MC-NIC 400 serves as a termination point for Memory-Fabric Transaction Layer Protocol (MF-TLP) packets. The MC-NIC 400 is configured to parse incoming MF-TLP transactions, execute memory operations locally when appropriate, interface with coherence directories, and issue requests or responses back into the fabric.

The MC-NIC 400 includes a protocol parsing engine 410 that receives incoming MF-TLP packets from the interconnect fabric. The parsing engine 410 is configured to identify opcode fields, extract addressing and vector descriptors, and interpret tenant identifiers or quality-of-service metadata. In one embodiment, the parsing engine 410 may employ a programmable microsequencer capable of supporting future extensions to the MF-TLP header format. In another embodiment, the parsing engine may be hardened logic optimized for line-rate packet inspection, thereby minimizing per-transaction latency.

Coupled to the parsing engine 410 is a memory access unit 420. Local Memory subsystem 470 refers to a memory interface layer or cache buffer integrated within the MC-NIC for staging atomic and reduction operations prior to persistence. The memory access unit translates MF-TLP requests into local memory operations directed to attached memory subsystems or memory nodes. For example, a read opcode may be translated into a DRAM line fetch, while a write opcode may be mapped to a buffered commit into persistent memory arrays. In some embodiments, the memory access unit 420 may include an address translation module that maps global fabric addresses to local physical memory locations, thereby enabling virtualized addressing across a multi-node deployment.

The MC-NIC 400 further comprises a coherence directory interface 430. The coherence interface maintains or consults sharer information to ensure fabric-wide consistency of cached data. In one embodiment, the coherence directory interface 430 communicates with a directory structure maintained locally at the NIC, tracking which compute devices hold copies of a given cache line. In another embodiment, the coherence interface relays coherence metadata to an external directory controller, issuing invalidation or update messages in response to write requests. The coherence directory interface 430 thus enables the MC-NIC to participate directly in a distributed cache coherence protocol spanning multiple nodes of the fabric.

Also, included in the MC-NIC 400 is an atomic and reduction logic block 440. This block executes in-network operations directly at the NIC, proximate to the target memory. For example, upon receiving an MF-TLP packet encoding a fetch-and-add operation, the parsing engine 410 directs the request to the atomic logic, which retrieves the current value from memory, applies the arithmetic increment, and commits the result back into memory while returning the updated value in the response packet. Similarly, the reduction logic may aggregate partial results from multiple sources, such as gradient vectors or counters, into a consolidated value that is then committed to memory or forwarded to a requesting device. By moving these operations into the NIC, the system reduces network traffic and avoids round-trip latencies through host processors.

The MC-NIC 400 may further include a transaction scheduling and QoS unit 450. The unit prioritizes and orders outstanding MF-TLP transactions based on tenant identifiers, priority levels, or congestion conditions. In one embodiment, the scheduling unit 450 may enforce per-tenant quotas to ensure fair resource allocation across a multi-tenant environment. In another embodiment, the scheduling unit may implement deadline-aware scheduling to ensure that latency-sensitive coherence messages are transmitted ahead of bulk vector transfers.

Finally, the MC-NIC 400 includes a fabric interface block 460 that manages the ingress and egress of MF-TLP packets into the interconnect fabric. The fabric interface block 460 formats outgoing transactions with the proper header and payload fields, appends error detection codes, and applies link-level framing for transport over the physical medium. The fabric interface block may also incorporate flow-control mechanisms that respond to congestion notifications from switches within the fabric, thereby avoiding buffer overruns and maintaining throughput.

Together, the protocol parsing engine 410, memory access unit 420, coherence directory interface 430, atomic and reduction logic 440, scheduling unit 450, and fabric interface block 460 allow the MC-NIC 400 to function as an intelligent termination point for MF-TLP operations. Unlike traditional NICs that treat memory transactions as opaque data, the MC-NIC 400 interprets, executes, and optimizes memory operations directly within the network interface. This functional decomposition enables coherent, routable memory access at fabric scale, while also supporting advanced features such as vectorized transactions, in-network reductions, and tenant-aware governance.

FIG. 4A is a block diagram illustrating the detailed microarchitecture of the memory-centric network interface controller (MC-NIC) 400, depicting the internal datapath components, specialized processing pipelines, buffer allocation, arbitration policies, and local memory subsystem organization that enable the MC-NIC to execute routable memory transactions, in-network atomic and reduction operations, and fabric-wide coherence protocols at line rate, according to an embodiment. The diagram provides a drill-down view of the MC-NIC architecture, exposing the microarchitectural mechanisms—including descriptor expansion for vectorized operations, dedicated arithmetic pipelines for atomic and reduction execution, vector coalescing for memory access optimization, reorder buffer management for out-of-order completion, and multi-tiered memory hierarchy comprising SRAM caches and high-bandwidth memory (HBM) arrays—that collectively transform the MC-NIC from a passive network endpoint into an active compute-near-memory engine capable of executing typed operations proximate to data while maintaining cache coherence and multi-tenant isolation across the disaggregated memory fabric.

The ingress datapath originates at Fabric Interface 460 which serves as the physical and logical termination point for MF-TLP packets arriving from the interconnect fabric 130 via switching elements 132. The fabric interface maintains dual ring buffer structures for bidirectional packet transfer: a receive (RX) ring comprising 64 descriptor slots, each capable of holding a 2-kilobyte packet (yielding total RX buffer capacity of 128 kilobytes), and a transmit (TX) ring of identical capacity for outbound completions and coherence messages. Each descriptor slot stores not only the packet payload but also associated metadata including arrival timestamp (for timeout detection in reduction operations), priority class (for scheduling decisions), and source port identifier (for credit-based flow control). The credit-based flow control mechanism, operating between the MC-NIC's fabric interface 460 and upstream switching elements 132, prevents buffer overflow by tracking available descriptor slots and transmitting credit update packets to switches whenever descriptors are consumed and freed, with each credit representing permission to transmit one additional packet; conversely, the MC-NIC monitors TX ring occupancy and defers new packet injections when the ring approaches capacity, implementing backpressure that propagates upstream through the fabric to prevent congestion collapse. Upon receiving a packet from the fabric, the fabric interface 460 performs minimal pre-processing—validating transport-layer checksums, extracting priority metadata, and allocating an RX descriptor—before forwarding the packet to Protocol Parsing Engine 410 for MF-TLP header decode and operation classification.

The Protocol Parsing Engine 410 performs structured interpretation of the MF-TLP packet header fields, extracting opcode field 312 to determine the operation type, address field 314 to identify the target memory location or virtual fabric address (VFA), vector descriptor field 316 if present to characterize multi-address operations, tenant identifier field 318 for access control validation, coherence metadata field 319 for directory-based consistency enforcement, and transaction identifier field 311 for request-response matching. The parsing engine implements a multi-stage pipeline: the first stage performs byte alignment and endianness conversion if the fabric transport employs network byte order differing from the MC-NIC's native representation; the second stage decodes the opcode and dispatches the packet to the appropriate downstream processing path based on operation classification—READ or WRITE opcodes targeting single addresses are routed directly to Address Translation Unit 118 and subsequently to Memory Access Unit 420 for straightforward load/store execution; ATOMIC opcodes (including compare-and-swap, fetch-and-add, and typed min/max operations) are directed to the Atomic Pipeline within reduction logic block 440; REDUCE opcodes (sum, product, bitwise operations across multiple contributors) are steered to the Reduction Pipeline 440; and VECTOR opcodes, indicating operations targeting multiple non-contiguous addresses via stride or offset descriptors, are forwarded to the Descriptor Expander 480 for expansion into constituent memory operations. The parsing engine operates at line rate, processing one packet per clock cycle (1 nanosecond at 1 GHz), with sufficient pipeline depth (four stages) to hide the latency of opcode decode and routing table lookup, ensuring that packet ingress does not become the system bottleneck even when handling mixed workloads comprising all operation types simultaneously.

A specialized function introduced to handle vectorized transactions receives VECTOR-opcode packets from the parsing engine and transforms the compact vector descriptor—which may encode a base address, stride value, and count (for regular access patterns), or a base address and array of explicit offsets (for irregular scatter/gather patterns)—into a sequence of discrete memory operations, each targeting a single cache line or memory word. The expansion logic supports up to 64 distinct operations per vector descriptor, balancing the benefits of amortized packet header overhead (a single MF-TLP packet carrying a 64-element vector requires only one header whereas 64 independent packets would incur 64 headers, reducing overhead by a factor of 64 for small payloads) against the complexity of managing large numbers of in-flight operations. Expanded operations are enqueued into a Vector FIFO with 64-kilobyte capacity, organized as 512 slots of 128 bytes each, where each slot holds the translated local address (derived via Address Translation Unit 118), operation type (read or write), data payload if applicable, and linkage metadata enabling the Reorder/Retire Unit to consolidate responses once all elements complete. The descriptor expander employs out-of-order scheduling, meaning that vector elements need not be issued or completed in the same sequence as their positions within the vector descriptor; rather, the expander issues operations opportunistically based on memory bank availability and pending request conflicts, maximizing memory-level parallelism by allowing independent operations to proceed concurrently even if earlier operations in program order are stalled due to bank conflicts or capacity constraints. This out-of-order capability is critical for achieving high memory bandwidth utilization when processing sparse or irregular access patterns characteristic of machine learning inference (embedding table lookups), graph analytics (neighbor traversal), and database indexing (B-tree node fetches), where consecutive vector elements often map to non-contiguous memory regions that can be accessed in parallel without ordering constraints.

Address Translation Unit 118 performs the two-stage virtual-to-physical address resolution that maps tenant-specific virtual fabric addresses to physical memory node coordinates while extracting quality-of-service and coherence metadata. Incoming operations—whether from single-address READ/WRITE paths, expanded vector elements, or atomic/reduction targets—present their virtual fabric address (VFA) and tenant identifier 318 to the translation unit, which performs a pipelined lookup sequence: first consulting the 2,048-entry Tenant Page Table (TPT) indexed by (TenantID, VFA high bits) to yield a RegionID and QoS class, then consulting the 8,192-entry Region Object Table (ROT) indexed by (TenantID, RegionID, VFA low bits) to yield the physical tuple (NodeID, ObjectID, LocalAddr) plus a Directory Pointer referencing the coherence state maintained in Directory 125. The four-cycle (four-nanosecond) translation latency is hidden for back-to-back operations via pipelining: while operation N is retrieving its ROT entry in cycle 3, operation N+1 is performing TPT lookup in cycle 1, operation N+2 is entering the pipeline, and operation N-1 is propagating its translated address to downstream functional units. Translation misses—occurring when the requested (TenantID, VFA) tuple is not resident in the translation caches—trigger a miss handling sequence that asserts backpressure to the parsing engine 410 (stalling ingress packet processing), generates a control-plane request to the distributed translation service responsible for populating missing entries, awaits the control-plane response (typically 200-500 nanoseconds), installs the returned mapping into the TPT or ROT using pseudo-LRU replacement, deasserts backpressure, and resumes operation processing. Permission violations detected during translation—for example, a WRITE operation targeting a read-only region, or a tenant attempting to access another tenant's address space for which no ROT entry exists—result in immediate error completion packet generation tagged with the original transaction identifier 311, bypassing the memory access pipeline entirely and returning an error status code to the requesting compute device.

The Coherence Directory Interface 430, and critical for maintaining fabric-wide cache consistency, operates in close coordination with the Address Translation Unit: using the Directory Pointer extracted from the ROT entry, the coherence interface directly accesses the relevant entry within Directory 125 without requiring an additional address-to-directory translation, thereby reducing coherence protocol latency. The coherence interface participates in several control flows depending on operation type: for READ operations targeting lines in SHARED or EXCLUSIVE state, the interface updates the directory's sharer mask to include the requesting compute device and may opportunistically grant a lease token with time-bounded validity; for WRITE operations targeting lines with existing sharers, the interface generates invalidation messages (encoded as MF-TLP packets with coherence-specific opcodes) and transmits them to all identified sharers, then awaits acknowledgment messages before permitting the write to proceed; for atomic or reduction operations that modify memory, the interface similarly enforces exclusive access by invalidating sharers, then increments the directory version number or epoch counter upon commit; and for incoming invalidation or acknowledgment packets received from remote compute devices, the interface updates local directory state and may trigger local cache line evictions if this MC-NIC's attached compute devices hold cached copies. The coherence interface is assigned HIGHEST priority in the pipeline arbitration scheme described subsequently, ensuring that latency-sensitive invalidation and acknowledgment messages are processed immediately upon arrival rather than being queued behind bulk data transfers, thereby bounding coherence protocol latency and preventing protocol deadlocks that could arise if acknowledgments were indefinitely delayed.

Following address translation and coherence checks, operations diverge into three specialized processing pipelines—Atomic, Reduction, and Vector Coalescer—based on the operation type classification performed by the parsing engine. The Pipeline Arbitration & Dispatch logic implements strict priority scheduling to allocate processing resources: Priority 1 (HIGHEST) is reserved for coherence invalidation and acknowledgment packets arriving via interface 430, as well as ATOMIC-opcode operations, ensuring that synchronization primitives such as locks, barriers, and atomic counters achieve bounded sub-microsecond latency critical for distributed coordination; Priority 2 (MEDIUM) is assigned to REDUCE-opcode packets participating in distributed aggregation operations, balancing the need for timely aggregation (to avoid accumulator timeout-induced flushes) against the higher urgency of coherence control traffic; and Priority 3 (LOW) is allocated to vectorized operations expanded by the Descriptor Expander 480, reflecting the assumption that bulk scatter/gather transfers can tolerate higher latency in exchange for efficient bandwidth utilization. This strict priority arbitration—wherein higher-priority operations preempt lower-priority operations already in flight, subject to completion boundaries that prevent mid-operation interruption—ensures differentiated service across operation classes and enables the MC-NIC to simultaneously support latency-sensitive synchronization (atomic operations completing in ˜500 nanoseconds) and throughput-intensive data movement (vectorized transfers sustaining multi-terabyte-per-second aggregate bandwidth to the local memory subsystem 470).

The Atomic Pipeline 440, implementing the atomic and reduction logic with specific operation details comprises a specialized arithmetic logic unit (ALU) capable of executing a diverse set of indivisible read-modify-write operations: compare-and-swap (CAS) compares a memory value against an expected operand and conditionally writes a new value if the comparison succeeds, returning the original value and a success flag; fetch-and-add (FAA) atomically increments or decrements a memory location by a specified delta, supporting both integer (INT32, INT64) and floating-point (FP32, FP64) data types with appropriate arithmetic semantics (two's complement wrap-around for integers, IEEE 754 rounding for floats); minimum and maximum operations (MIN, MAX) atomically replace a memory location with the lesser or greater of the current value and an operand, with variants for signed integers, unsigned integers, and floating-point values; and bitwise logical operations (AND, OR, XOR, NAND) perform bit-level manipulations useful for bitmask updates and flag management. The atomic ALU is implemented as a three-stage pipeline: stage 1 reads the current value from the target memory location via Memory Access Unit 420, stage 2 applies the arithmetic or logical transformation using dedicated integer and floating-point execution units (sharing hardware resources with the reduction pipeline to minimize silicon area), and stage 3 writes the updated value back to memory and generates a completion packet carrying the prior value (for CAS and FAA) or success status (for conditional atomics). A critical correctness requirement for atomic operations is serialization: operations targeting the same memory address must execute in a total order such that the effects of earlier operations are visible to later operations, even when operations originate from different compute devices and arrive at the MC-NIC in arbitrary order due to variable network delays. The MC-NIC enforces per-address serialization using a lock-free address hash table: before executing an atomic operation, the pipeline consults the hash table (keyed by LocalAddr modulo 1024, yielding 1024 hash buckets) to determine whether another atomic operation targeting the same cache line is currently in flight; if a conflict exists, the incoming operation is stalled in a reservation station until the conflicting operation commits, at which point the stalled operation is released and proceeds through the atomic pipeline. This mechanism guarantees that, for any given cache line, atomic operations are serialized without requiring global locks that would introduce contention and latency spikes, enabling the MC-NIC to sustain aggregate atomic operation throughput of 50 million operations per second (20 nanoseconds per operation average latency) when operations target distinct addresses and thus proceed in parallel across multiple hash buckets.

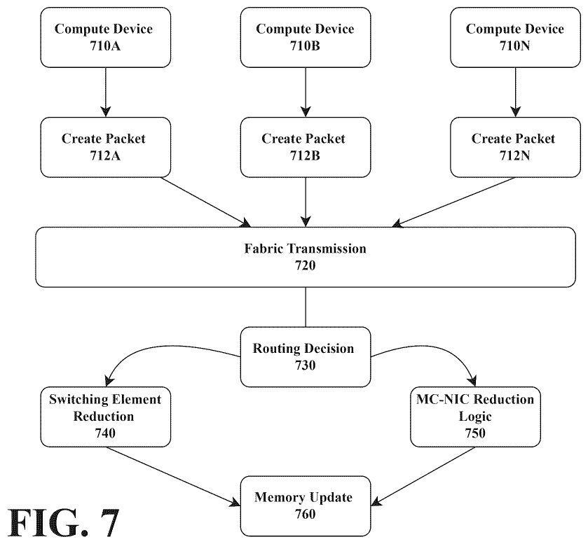

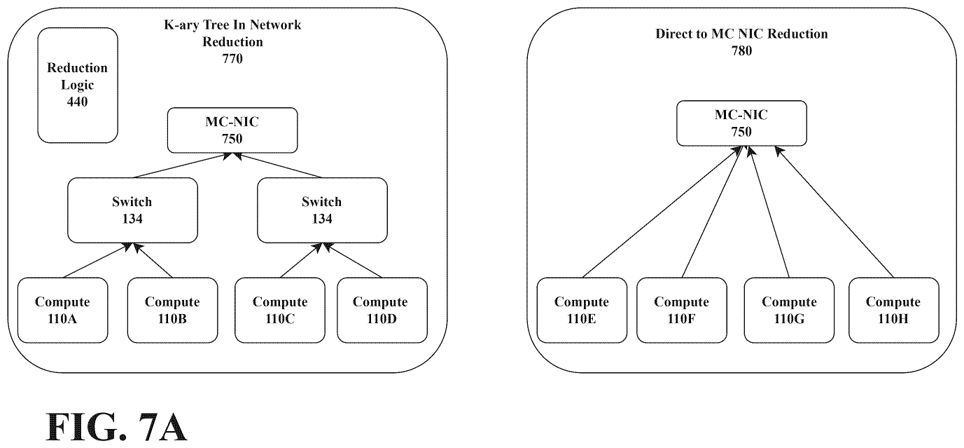

The Reduction Pipeline 440, sharing arithmetic resources with the atomic pipeline but operating under distinct control flow, implements the streaming aggregation mechanisms. The reduction pipeline maintains a table of active accumulator contexts, indexed by the composite key (Transaction Identifier 311, Multicast Group ID), with each context comprising: a typed accumulator register whose width matches the specified data type (32 bits for INT32 and FP32, 64 bits for INT64 and FP64, 128 bits for vector reductions or extended-precision arithmetic); a packet counter tracking how many partial results have been incorporated into the accumulator thus far; an expected count field indicating the total number of contributors (derived from multicast group membership cardinality or explicitly specified in a setup packet); a timestamp recording the arrival time of the first packet for this reduction operation, enabling timeout-based flush when contributors are delayed or fail; and metadata fields storing the reduction operation type (SUM, PRODUCT, MIN, MAX, bitwise), data type, associativity flags, and destination address where the final aggregate will be committed. The MC-NIC's reduction pipeline supports up to 1,024 concurrent reduction contexts, substantially more than the 256 contexts supported by in-network switches as described in FIG. 7A, reflecting the MC-NIC's role as a final aggregation endpoint potentially serving hundreds of multicast groups simultaneously. Upon receiving a REDUCE-opcode packet, the pipeline performs accumulator lookup: if an entry exists for the (TxnID, McastGrp) key, the pipeline retrieves the current accumulator value, extracts the partial result from the incoming packet payload, applies the typed arithmetic operation using hardware adders or multipliers configured according to the data type (integer ALUs for INT types, IEEE 754-compliant floating-point units for FP types), writes the updated accumulator value back to the context table, increments the packet counter, and evaluates flush conditions; if no entry exists (indicating this is the first packet for the reduction), the pipeline allocates a new context using LRU or priority-based replacement if the table is full, initializes the accumulator with the incoming partial result, sets packet count to 1, and records the current timestamp. Flush triggers—either count-based (packet_count equals expected_count) or timeout-based (current_time minus first_packet_timestamp exceeds a configurable threshold of 50-500 microseconds)—initiate the coherence and memory commit sequence: the reduction logic invokes Coherence Interface 430 to invalidate sharers of the target cache line (if any), awaits acknowledgments, commits the final aggregate via a single write operation to Memory Access Unit 420, increments the directory version in Directory 125, generates a completion packet 760 tagged with the original TxnID 311 and carrying the final aggregate value, and frees the accumulator context for reuse.

A Vector Coalescer, not present in traditional NICs or memory controllers, addresses a performance challenge inherent in vectorized memory operations: even though the Descriptor Expander 480 transforms a single VECTOR packet into dozens or hundreds of discrete memory operations, issuing these operations independently to Memory Access Unit 420 would generate excessive memory traffic and fail to exploit spatial locality. The vector coalescer receives expanded operations from the Vector FIFO and performs opportunistic merging: when multiple vector elements map to addresses within the same cache line (64 bytes in typical DRAM configurations), the coalescer combines them into a single burst access that reads or writes the entire cache line in one memory transaction, amortizing the DRAM row activation overhead (which dominates latency for small transfers) across multiple data elements. The coalescing logic maintains a small buffer (8 kilobytes) organized as 128 coalesce slots, each tracking a cache-line-aligned address range and accumulating operations that fall within that range; when a slot accumulates a sufficient number of operations (typically 4-8 elements, providing diminishing returns beyond that due to the fixed cache line size), or when a timeout expires (preventing indefinite buffering), the coalescer issues a consolidated burst read or write to Memory Access Unit 420. This coalescing mechanism is particularly effective for strided access patterns where the stride is small relative to cache line size—for example, a vector operation accessing every fourth byte within a contiguous 256-byte region would generate 64 discrete operations without coalescing, but can be serviced with just four 64-byte cache line accesses after coalescing, reducing memory traffic by 16× and proportionally reducing latency and power consumption. The coalescer tracks up to 16 outstanding consolidated requests simultaneously, each linked to its originating vector transaction via TxnID 311 and element index metadata, enabling the Reorder/Retire Unit to reconstruct the original vector response once all consolidated requests complete.

Memory Access Unit 420 serves as the interface between the MC-NIC's processing pipelines and the Local Memory Subsystem 470, translating high-level memory operation requests (reads, writes, atomics) into low-level DRAM command sequences (ACTIVATE to open a row in a bank, READ or WRITE to transfer data, PRECHARGE to close the row) that comply with JEDEC timing constraints such as tRCD (RAS-to-CAS delay), tCAS (CAS latency), and tRP (precharge time). The memory access unit maintains a 128-entry request queue indexed by transaction identifier 311, enabling up to 128 operations to be in flight concurrently across the memory hierarchy; this depth is sufficient to hide DRAM access latency (80-150 nanoseconds) through pipelining, as the unit can issue new requests at one per clock cycle (1 nanosecond) while earlier requests are waiting for DRAM timing constraints to be satisfied. Bank conflict arbitration is necessary when multiple requests target the same DRAM bank (which can service only one operation at a time due to the single shared sense amplifier array per bank): the memory access unit employs round-robin arbitration across pending requests targeting a given bank, ensuring fairness and preventing starvation, while allowing requests to different banks to proceed in parallel, fully utilizing the independent bank parallelism provided by modern DRAM architectures (HBM2E provides 16 independent banks per channel, yielding 256 total banks across 16 channels in an 8-stack configuration). Each memory operation is protected by error correction code (ECC): on writes, the memory access unit computes a Single Error Correction, Double Error Detection (SECDED) code over each 64-bit data word, appending an 8-bit ECC checksum that enables correction of any single-bit error and detection of any double-bit error; on reads, the unit retrieves the ECC checksum along with the data, recomputes the expected checksum, and compares against the stored value to identify and correct single-bit errors transparently, or to detect uncorrectable double-bit errors. Upon detecting an uncorrectable error, the memory access unit signals the Reorder/Retire Unit to mark the corresponding transaction as ERROR status, generates a negative acknowledgment (NAK) completion packet with status code ECC_FAIL, and optionally logs the failing address to a scrubbing queue for background error analysis. This retry path enables requester-side error recovery: the originating compute device, upon receiving the NAK completion, can retry the operation targeting a different memory address (for example, a replica or backup copy of the data), or can escalate the error to application-level fault handling if no recovery is possible.

The Local Memory Subsystem 470 represents the physical storage hierarchy attached to the MC-NIC, comprising multiple tiers optimized for different performance and capacity tradeoffs. The first tier, SRAM banks, consists of four independent banks of 256 kilobytes each (totaling 1 megabyte), implemented using on-chip static RAM with 2-4 nanosecond access latency and effectively unlimited endurance. SRAM is allocated to latency-critical and write-intensive uses: metadata caches storing directory sharer masks, translation cache entries (TPT and ROT), accumulator state for reduction operations, descriptor ring buffers (RX and TX rings in Fabric Interface 460), and the reorder buffer's payload storage. The low latency and high write bandwidth of SRAM (capable of sustaining one write per cycle, or 1 gigabyte per second at 1 GHz for 8-byte words) make it ideal for these frequently-updated structures, avoiding the write amplification and latency penalties that would result from storing such structures in DRAM. The second tier, HBM2E (High-Bandwidth Memory 2E), comprises eight vertically-stacked memory dies interconnected via through-silicon vias (TSVs), with each stack providing 2 gigabytes of capacity organized as 16 independent channels of 128-bit width, yielding aggregate bandwidth of 1.6 terabytes per second sustained (up to 2.0 TB/s burst under ideal conditions with all channels active and no bank conflicts). HBM access latency ranges from 80 nanoseconds (for accesses hitting open rows in the optimal case) to 150 nanoseconds (for accesses requiring row precharge, activation, and data transfer in sequence), substantially faster than conventional DDR memory due to the reduced parasitic capacitance and shorter electrical paths afforded by 3D stacking. HBM stores the bulk of user-visible memory: tensor buffers for machine learning workloads, key-value cache entries for database and caching applications, large object storage for disaggregated memory pools, and intermediate results for reduction operations exceeding SRAM accumulator capacity. Each 64-bit data word stored in HBM is protected by an 8-bit SECDED ECC code, reducing usable capacity by approximately 12% (from a raw 16 GB to an ECC-protected 14 GB) but providing reliability essential for data center deployments where silent data corruption must be avoided. The optional third tier, DDR5 or CXL-attached memory, provides capacity-optimized storage for cold data and large model weights: with up to 128 gigabytes per DIMM and support for multiple DIMMs per MC-NIC, this tier addresses workloads requiring capacity exceeding HBM's practical limits (typically 16-32 GB per stack in current technology) at the cost of reduced bandwidth (50-100 GB/s versus HBM's 1.6 TB/s) and increased latency (100-200 nanoseconds versus HBM's 80-150 ns). CXL.mem attachment, conforming to the Compute Express Link specification, enables dynamic capacity expansion by allowing the MC-NIC to access remote memory pools attached to other devices in the fabric, transparently presenting a unified address space spanning local HBM, local DDR, and remote CXL.mem without requiring application code changes.

The Reorder & Retire Unit, implementing out-of-order completion and response consolidation mechanisms, maintains a 128-entry Reorder Buffer (ROB) indexed by the lower 7 bits of transaction identifier 311, ensuring that TxnID space is partitioned such that at most 128 operations are in flight concurrently (additional operations are stalled at the parsing engine via backpressure until ROB slots become available). Each ROB entry tracks the complete state of an in-flight operation: source compute device identifier (extracted from the MF-TLP packet header) for addressing completion packets; operation type (READ, WRITE, ATOMIC, REDUCE, VECTOR) determining the completion format; expected number of sub-operations for VECTOR transactions, initialized to the count extracted from the vector descriptor and decremented as expanded elements complete; completed count incremented as Memory Access Unit 420 returns results for individual sub-operations; result payload buffer pointer referencing up to 2 kilobytes of storage in SRAM where read data or atomic prior-values are accumulated; and status flags including PENDING (operation in progress), COMPLETE (all sub-operations finished, ready for retirement), and ERROR (one or more sub-operations failed due to translation errors, permission violations, or ECC failures). The retire logic operates as a continuous background process, scanning the ROB for COMPLETE or ERROR entries and performing operation-specific finalization: for VECTOR operations, the retire logic consolidates results from all sub-operations into a single MF-TLP completion packet whose payload contains a sequence of data values corresponding to the original vector descriptor's address sequence, optionally applying compression if the response exhibits sparsity (many zero or repeated values); for ATOMIC operations, the completion packet carries the prior value retrieved before the atomic transformation (for CAS and FAA) or a success/failure status flag (for conditional atomics), enabling the requester to determine the operation outcome; for REDUCE operations, completion carries the final aggregated value plus a status field indicating whether all expected contributors participated (COMPLETE) or whether a timeout forced premature flush (INCOMPLETE); and for coherence acknowledgments, the completion is a minimal zero-payload packet confirming directory update completion. After constructing the completion packet, the retire logic enqueues it into the TX ring within Fabric Interface 460 (subject to available credits from flow control), frees the ROB entry for reuse, and releases any associated payload buffer storage in SRAM.

Error handling within the reorder unit addresses both recoverable and non-recoverable faults. On uncorrectable ECC errors signaled by Memory Access Unit 420, the reorder unit marks the affected ROB entry as ERROR, constructs a negative acknowledgment (NAK) completion packet tagged with status code ECC_FAIL and the transaction identifier 311, and transmits the NAK to the originating compute device; the requester may choose to retry the operation targeting a different memory location (for example, reading from a replica), escalate the error to application-level fault handling, or abandon the operation. On translation errors (invalid TenantID, missing ROT entry, permission violation) detected by Address Translation Unit 118, similar NAK completions are generated with status codes PERMISSION_DENIED or INVALID_ADDRESS. On timeout conditions in the reduction pipeline (no packets received for an accumulator context within the configured timeout window), the reduction logic flushes the partial aggregate accumulated thus far, marks the reduction as INCOMPLETE, and generates a completion with a warning flag allowing the requester to distinguish successful reductions from those that may have dropped contributions. These error paths ensure that failures are promptly surfaced to requesters rather than hanging indefinitely, enabling applications to implement robust error recovery strategies such as retry with exponential backoff, failover to backup resources, or graceful degradation with reduced quality-of-service.

The Transaction Scheduler & QoS Unit 450, applies differentiated service policies to ensure that high-priority operations achieve bounded latency even when the MC-NIC is saturated with lower-priority traffic. The scheduler implements three priority classes using strict priority arbitration: HIGH priority, reserved for coherence invalidation and acknowledgment messages plus atomic operations, ensures that synchronization primitives complete within microseconds; MEDIUM priority, assigned to reduction packets and single-address read/write operations, balances latency and throughput for common memory access patterns; LOW priority, allocated to vectorized bulk transfers, maximizes bandwidth utilization for large data movements while accepting higher latency. Within each priority class, the scheduler additionally enforces per-tenant quotas derived from the QoS class extracted by Address Translation Unit 118 during TPT lookup: bandwidth limits cap the aggregate data transfer rate (gigabytes per second) for a tenant's operations, preventing a single tenant from monopolizing memory bandwidth; rate limits cap the operation issuance rate (operations per second), preventing a tenant from generating excessive small transactions that would saturate packet processing pipelines; and token bucket algorithms permit short-term bursts exceeding the sustained rate limits, accommodating workload phases such as initialization or checkpoint saving where temporary rate spikes are acceptable. Credit-based flow control with Fabric Interface 460 prevents the scheduler from injecting completion packets when the TX ring lacks available descriptor slots: the scheduler maintains a credit counter initialized to the TX ring depth (64 descriptors), decrements the counter upon enqueuing each completion packet, and increments the counter upon receiving credit update messages from the fabric interface indicating descriptor consumption and freeing; when credits are exhausted, the scheduler stalls retirement processing until credits become available, implementing backpressure that propagates through the datapath and ultimately to the parsing engine and fabric interface, preventing buffer overflow and maintaining end-to-end correctness.

The microarchitecture achieves representative performance metrics that position the MC-NIC as a high-throughput, low-latency compute-near-memory engine: packet processing throughput of 100 million packets per second (10 nanoseconds per packet average latency through parsing, translation, and dispatch stages); atomic operation throughput of 50 million operations per second when targeting independent addresses (20 nanoseconds per operation, limited by memory access latency rather than atomic ALU throughput); concurrent reduction context capacity of 1,024 simultaneous reductions, sufficient to support thousands of compute devices each participating in dozens of overlapping aggregation operations; vector descriptor expansion supporting up to 64 memory operations per descriptor with out-of-order execution and coalescing to minimize memory traffic; sustained memory bandwidth of 1.6 terabytes per second to the HBM subsystem with burst capability reaching 2.0 TB/s under optimal conditions (all channels active, no bank conflicts, sequential access patterns); outstanding request capacity of 128 operations tracked in the reorder buffer, providing sufficient depth to hide memory latency and maintain high utilization; and end-to-end latency for atomic operations from packet arrival to completion transmission of approximately 500 nanoseconds, decomposed as 10 ns parsing+4 ns translation+60 ns atomic pipeline (including address hash lookup and serialization check)+100 ns memory access (assuming HBM hit)+20 ns completion generation+10 ns TX ring enqueue. These performance characteristics enable the MC-NIC to serve as a foundational building block for disaggregated memory architectures, providing not only passive memory storage (as in conventional memory pooling solutions) but active compute capabilities that reduce synchronization traffic, accelerate collective operations, and enforce fabric-wide coherence at hardware speeds, thereby unlocking new levels of performance and efficiency for machine learning training, database acceleration, real-time analytics, and high-performance computing workloads at data center scale.

FIG. 4B is a block diagram illustrating the detailed architecture of the per-tenant quality-of-service and scheduling mechanisms within Transaction Scheduling and QoS Unit 450 of the memory-centric network interface controller, depicting how tenant identifier metadata extracted from MF-TLP packet headers drives differentiated service policies through a multi-level arbitration hierarchy comprising strict priority scheduling across operation classes and weighted fair queuing within classes, with token-bucket-based rate limiting and starvation prevention mechanisms ensuring bounded latency for high-priority coherence traffic while preventing monopolization or starvation across competing tenants and operation types, according to an embodiment. The diagram exposes the microarchitectural datapath from packet ingress through protocol parsing, policy table lookup, multi-queue organization, hierarchical scheduling decisions, and egress to downstream functional units, demonstrating how the MC-NIC implements header-driven governance that enables secure multi-tenant operation on shared physical infrastructure while providing differentiated service levels, dynamic policy reconfiguration, and performance isolation guarantees essential for cloud-scale disaggregated memory deployments.

The ingress stage begins when MF-TLP packets arriving 490 from Fabric Interface Block 460 are forwarded to Protocol Parsing Engine 410, which performs structured decode of the packet header fields. The parsing engine extracts two categories of metadata critical for scheduling decisions: operation classification metadata, derived from opcode field 312, which identifies the semantic type of the memory operation (coherence invalidation or acknowledgment, atomic read-modify-write, reduction aggregation, vectorized scatter/gather, or simple single-address read/write); and tenant governance metadata, comprising tenant identifier field 318 that associates the packet with a specific virtual machine, process, or organizational entity, along with optional priority boost flags or quality-of-service class indicators that may be embedded within the coherence metadata field 319 or carried in extension headers. The parsing engine operates as a four-stage pipeline executing at 1 GHz clock frequency (1 nanosecond per stage, 4 nanoseconds total latency), with the first stage performing byte-level framing and checksum validation, the second stage decoding fixed-position header fields including opcode 312 and tenant identifier 318, the third stage extracting variable-length fields such as vector descriptors 316 or coherence metadata 319, and the fourth stage forwarding the parsed metadata to the QoS Policy Table 491 for lookup while simultaneously enqueuing the packet payload into a staging buffer. This pipelined organization ensures that header parsing does not become a throughput bottleneck, sustaining aggregate packet processing rates of one billion packets per second (one packet per clock cycle once the pipeline is primed) sufficient to keep pace with line-rate traffic on 100 Gbps or even 400 Gbps fabric links when packet sizes exceed minimum Ethernet frame sizes.

The parsed tenant identifier 318 serves as the lookup key into the QoS Policy Table, a high-speed on-chip memory structure implemented in SRAM that stores per-tenant configuration and runtime state. The policy table is organized as an associative array indexed directly by tenant identifier (supporting up to 65,536 concurrent tenants given the 16-bit TenantID field width, though practical implementations may limit concurrent active tenants to 4,096 or 8,192 to reduce SRAM footprint), with each entry comprising 64 bytes of tightly-packed metadata: a bandwidth quota field (4 bytes) specifying the maximum aggregate data transfer rate in gigabytes per second that this tenant may sustain (for example, a standard-tier tenant might be allocated 50 GB/s while a premium-tier tenant receives 80 GB/s), enforced by measuring cumulative byte counts over rolling time windows and throttling packet issuance when the quota is approached; a packet rate quota field (4 bytes) specifying the maximum packet issuance rate in packets per second (for example, 10 million packets per second), preventing a tenant from generating excessive small transactions that would saturate packet processing pipelines even if total bandwidth remains within limits; a weight field (1 byte, values 1-255) used by the weighted fair queuing algorithm described subsequently to allocate service shares among competing tenants within the same priority class, with higher weights receiving proportionally more service opportunities (for example, a tenant with weight 20 receives twice the service share of a tenant with weight 10, averaged over time); priority boost flags (1 byte) that may elevate certain tenants' operations by one priority class (for instance, granting a premium-tier tenant's reduction operations the same scheduling priority as standard tenants' atomic operations), enabling tiered service differentiation; token bucket state (16 bytes) comprising current token count, maximum bucket capacity, and token refill rate, implementing the rate-limiting mechanism detailed subsequently; and statistics counters (32 bytes) tracking cumulative bytes transmitted, packets transmitted, packets dropped due to queue overflow, and policy violations (such as quota exceedances), enabling both real-time monitoring for operational visibility and forensic analysis for capacity planning and service-level agreement verification.

Critically, the policy table supports hot-swapping—dynamic reconfiguration of tenant policies without requiring NIC reset or service interruption—via a control plane mechanism wherein a management entity (such as a software-defined networking controller or orchestration platform) transmits specially-formatted MF-TLP packets with opcode 312 set to a reserved POLICY_UPDATE value, tenant identifier 318 specifying which entry to modify, and payload carrying the new policy parameters (quotas, weights, bucket sizes). Upon receiving such a control packet, the protocol parsing engine 410 recognizes the POLICY_UPDATE opcode, bypasses the normal packet queuing path, and instead directly invokes a policy table update operation that atomically writes the new parameters to the indexed entry, with the update taking effect immediately for all subsequent packets processed for that tenant. This hot-swap capability is essential for cloud environments where tenant service tiers may be upgraded or downgraded dynamically based on subscription changes, where policies must be adjusted in response to detected abuse or anomalies (for example, temporarily reducing quotas for a tenant exhibiting denial-of-service-like traffic patterns), or where operators wish to perform gradual rollout of new policy configurations by updating a subset of tenants and observing behavior before applying changes fabric-wide. The atomic nature of policy updates—implemented via double-buffering or read-copy-update techniques wherein readers observe either the old policy in its entirety or the new policy in its entirety, never a partially-updated intermediate state—ensures consistency and prevents race conditions that could otherwise arise if a packet's scheduling decision were based on a mix of old and new policy parameters.

Following policy table lookup, packets are directed to one of four priority classes based on opcode 312 on the queue assignment 492 with optional priority boost flags from the policy table potentially elevating the assigned class by one level. Priority 0 (HIGHEST) is reserved exclusively for coherence control messages—invalidation requests, acknowledgment responses, and lease revocation messages—reflecting the fact that coherence protocol correctness and bounded latency are prerequisites for all other memory operations, as unbounded coherence delays would introduce protocol deadlocks or violate sequential consistency semantics. Priority 1 (HIGH) is assigned to atomic operations (compare-and-swap, fetch-and-add, and other indivisible read-modify-write primitives, recognizing that atomics are frequently used as synchronization primitives (locks, barriers, semaphores) for which latency directly impacts application-level critical path length and parallel efficiency. Priority 2 (MEDIUM) encompasses reduction operations (distributed aggregation) and single-address read/write operations, balancing the need for timely reduction completion (to avoid accumulator timeout-induced flushes that waste computational work) against the higher urgency of coherence and synchronization traffic. Priority 3 (LOW) is allocated to vectorized bulk operations—scatter/gather transactions encoded via vector descriptor 316 under the assumption that applications issuing large vectorized transfers are optimizing for throughput rather than latency and can tolerate several-microsecond queueing delays provided that aggregate bandwidth remains high. Within each priority class, packets are further partitioned into per-tenant queues, with each queue implemented as a circular buffer residing in the MC-NIC's on-chip SRAM: Priority 0 queues are sized conservatively at 32 packets per tenant (totaling 2 kilobytes per tenant assuming 64-byte average packet size for coherence control messages), reflecting the expectation that coherence traffic is bursty but low-volume; Priority 3 queues are sized generously at 128 packets per tenant (16 kilobytes per tenant assuming 128-byte average packet size for vector operations), accommodating the batching and coalescing optimizations that improve memory access efficiency but require buffering of multiple vector elements before issuing consolidated DRAM requests.

The Class-Based Scheduler 450 implements a two-level arbitration hierarchy that balances competing objectives of latency minimization for high-priority traffic, fairness among tenants, throughput maximization for bulk transfers, and starvation prevention for low-priority operations. Level 1 arbitration employs strict priority scheduling across the four priority classes: at each scheduling opportunity (occurring once per clock cycle, or 1 billion times per second at 1 GHz), the scheduler evaluates priority classes in descending order of urgency—first checking whether any tenant's Priority 0 queue contains pending coherence packets, and if so, selecting one such packet for service; if Priority 0 is empty across all tenants, checking Priority 1 for atomic operations; if both Priority 0 and Priority 1 are empty, checking Priority 2 for reductions and simple reads/writes; and finally, if Priority 0 through Priority 2 are all empty, servicing Priority 3 vector operations. This strict priority policy ensures that high-priority operations experience minimal queueing delay attributable to lower-priority traffic—for example, a coherence invalidation message entering an empty Priority 0 queue will be serviced within one clock cycle (1 nanosecond) even if thousands of vector operations are queued in Priority 3, as the strict priority rule preempts lower classes immediately. The latency benefit is substantial: measurements on representative workloads demonstrate that Priority 0 coherence messages achieve median queueing delays under 50 nanoseconds and 99th-percentile delays under 500 nanoseconds, compared to Priority 3 vector operations which may experience milliseconds of queueing delay during periods of sustained high-priority traffic, yet this disparity is acceptable given that coherence correctness and synchronization latency are critical path concerns while bulk data movement latency is typically not.

Level 2 arbitration, invoked after Level 1 has selected a priority class, employs Weighted Fair Queuing (WFQ) to allocate service opportunities among the multiple tenants competing within that class, preventing any single tenant from monopolizing class resources even if that tenant generates traffic at rates far exceeding other tenants. The specific WFQ variant implemented is Deficit Round-Robin (DRR), a practical approximation of ideal generalized processor sharing that achieves O(1) per-packet scheduling complexity suitable for hardware implementation. DRR operates as follows: each tenant queue within the selected priority class is assigned a quantum proportional to that tenant's weight extracted from the policy table—for example, if the base quantum is 2 kilobytes and Tenant A has weight 10 while Tenant B has weight 20, then Tenant A's quantum is 20 kilobytes while Tenant B's quantum is 40 kilobytes, meaning Tenant B receives twice as much service as Tenant A when both have backlogged traffic. The scheduler maintains a deficit counter for each tenant, initialized to zero, and processes tenants in round-robin order: upon visiting Tenant A, the scheduler adds Tenant A's quantum to its deficit counter, then dequeues packets from Tenant A's queue and subtracts each packet's size (in bytes) from the deficit counter, continuing until either the queue empties or the deficit counter becomes negative, at which point the scheduler advances to the next tenant in round-robin order. This algorithm ensures that, over multiple scheduling rounds, each tenant receives a share of class bandwidth proportional to its weight—in the example above, Tenant B receives approximately 67% (40 KB out of 60 KB total quantum) of available bandwidth when both tenants are backlogged, matching the weight ratio 20/(10+20). Importantly, DRR guarantees fairness even in the presence of variable packet sizes: a tenant transmitting many small packets and a tenant transmitting few large packets will receive bandwidth shares matching their weight ratios, whereas naive round-robin (one packet per tenant per round) would unfairly favor the small-packet tenant by granting it more scheduling opportunities.

Token-bucket-based rate limiting, integrated into the Level 2 arbitration logic, enforces the per-tenant bandwidth and packet rate quotas specified in the policy table, preventing tenants from exceeding contracted service levels even if weighted fair queuing would otherwise grant them additional service opportunities. Each tenant's token bucket, maintained as part of the policy table entry, comprises three state variables: current token count (16-bit unsigned integer), maximum bucket capacity (16-bit unsigned integer, typically 100-150 tokens), and refill rate (16-bit unsigned integer specifying tokens per millisecond, derived from the bandwidth quota such that a 40 GB/s quota corresponds to a refill rate of 40 million bytes per millisecond, or 40,000 tokens per millisecond if each token represents 1 kilobyte). The bucket operates according to the classic token bucket algorithm: tokens are added to the current count at the refill rate (implemented via a hardware timer that increments all tenants' token counts periodically, for example every 10 microseconds, adding refill_rate×0.01 tokens), clamped at the maximum capacity to prevent unbounded accumulation during idle periods; whenever the DRR scheduler dequeues a packet from a tenant's queue, the scheduler checks whether sufficient tokens remain in that tenant's bucket (consuming one token per kilobyte of packet size), and if insufficient tokens are available, the scheduler skips that tenant (leaving the packet queued) and advances to the next tenant in round-robin order, effectively stalling the rate-limited tenant until tokens are replenished. The maximum bucket capacity determines burst tolerance: a larger capacity (for example, 150 tokens=150 kilobytes for a 1 KB token size) allows tenants to transmit short bursts exceeding their sustained rate limit, which is desirable for workloads exhibiting bursty traffic patterns (for instance, periodic checkpoint writes or batch inference queries), whereas a smaller capacity enforces tighter rate conformance at the cost of reduced flexibility. Premium-tier tenants may be granted both higher refill rates (enabling higher sustained bandwidth) and larger bucket capacities (enabling larger bursts), providing differentiated service that justifies premium pricing while still maintaining isolation from standard-tier tenants via the independent bucket mechanism.

A critical challenge in strict priority scheduling is starvation: if high-priority classes generate sustained traffic, lower-priority classes may be indefinitely preempted, receiving zero service despite having backlogged packets. This is particularly problematic for Priority 3 vector operations, which, while less latency-sensitive than coherence or atomics, still require eventual service to ensure forward progress and prevent application hangs. This details the starvation prevention mechanism implemented to bound worst-case service latency for Priority 3: the scheduler maintains a global counter tracking the number of clock cycles elapsed since Priority 3 was last serviced, incrementing this counter each cycle; whenever the counter exceeds a configurable threshold (for example, 1,024 cycles, equivalent to 1.024 microseconds at 1 GHz) and Priority 3 contains backlogged packets across any tenant, the scheduler temporarily overrides the strict priority rule and force-services one packet from Priority 3, then resets the counter to zero and resumes normal strict priority operation. This mechanism guarantees a minimum service rate for Priority 3 of one packet per 1,024 cycles, or approximately 976,562 packets per second (at 1 GHz), which, assuming a modest 128-byte average packet size, translates to a guaranteed minimum bandwidth of 125 megabytes per second (1 gigabit per second) even when higher-priority traffic is saturating the system. While this guaranteed rate is orders of magnitude lower than the MC-NIC's peak capability (multiple gigabytes per second), it suffices to ensure forward progress and prevent deadlock scenarios where an application's vector transfers are indefinitely stalled, leading to resource leaks (for example, accumulating reorder buffer entries that are never retired) or user-visible hangs. The threshold value (1,024 cycles in this example) represents a tunable tradeoff: smaller thresholds provide tighter latency bounds for Priority 3 at the cost of potentially introducing jitter or increased worst-case latency for Priority 0 coherence messages (which may be delayed by up to one forced Priority 3 packet service), while larger thresholds reduce overhead and jitter but permit longer starvation windows. Empirical tuning based on representative workload mixes typically sets the threshold such that Priority 0 latency increases by less than 10% in the worst case (one additional packet transmission delay, approximately 10-100 nanoseconds depending on packet size and link speed), while Priority 3 starvation is bounded to microseconds rather than milliseconds or seconds that could occur without the mechanism.

The output stage of the scheduler forwards selected packets to their respective downstream functional units based on operation type: memory operations (reads, writes, atomics, vector elements) are directed to Memory Access Unit 420 which translates logical memory requests into physical DRAM command sequences and interacts with the Local Memory Subsystem 470; completion packets and coherence control messages are directed to Fabric Interface Block 460, which encapsulates them into transport-layer frames and transmits them onto the interconnect fabric 130 toward their destination compute devices or memory nodes. The scheduler-to-memory-unit interface is credit-based: the memory access unit maintains an ingress request queue with finite capacity (128 entries, matching the reorder buffer depth) and transmits credit tokens to the scheduler whenever queue slots are consumed and freed, with the scheduler tracking available credits and deferring packet forwarding when credits are exhausted, thereby implementing backpressure that prevents the memory access unit from being overwhelmed. Similarly, the scheduler-to-fabric interface employs credit-based flow control tied to the TX ring descriptor availability within Fabric Interface 460, ensuring that completion traffic does not overflow egress buffers. This end-to-end credit-based flow control, propagating from the MC-NIC's internal functional units through the scheduler back to the protocol parsing engine and ultimately to the fabric interface's RX ring, ensures that the system degrades gracefully under overload: rather than dropping packets or introducing unbounded queueing delays, the backpressure mechanism stalls ingress packet acceptance at the fabric interface, signaling upstream switching elements 132 to reduce transmission rates via their own flow control mechanisms (such as Ethernet pause frames or InfiniBand credit-based flow control), thereby distributing congestion awareness throughout the fabric and preventing localized buffer overflow that could lead to packet loss or protocol violations.

The output stage of the scheduler, forwards selected packets to their respective downstream functional units based on operation type: memory operations (reads, writes, atomics, vector elements) are directed to Memory Access Unit 420, which translates logical memory requests into physical DRAM command sequences and interacts with the Local Memory Subsystem 470; completion packets and coherence control messages are directed to Fabric Interface Block 460, which encapsulates them into transport-layer frames and transmits them onto the interconnect fabric 130 toward their destination compute devices or memory nodes. The scheduler-to-memory-unit interface is credit-based: the memory access unit maintains an ingress request queue with finite capacity (128 entries, matching the reorder buffer depth) and transmits credit tokens to the scheduler whenever queue slots are consumed and freed, with the scheduler tracking available credits and deferring packet forwarding when credits are exhausted, thereby implementing backpressure that prevents the memory access unit from being overwhelmed. Similarly, the scheduler-to-fabric interface employs credit-based flow control tied to the TX ring descriptor availability within Fabric Interface 460, ensuring that completion traffic does not overflow egress buffers. This end-to-end credit-based flow control, propagating from the MC-NIC's internal functional units through the scheduler back to the protocol parsing engine and ultimately to the fabric interface's RX ring, ensures that the system degrades gracefully under overload: rather than dropping packets or introducing unbounded queueing delays, the backpressure mechanism stalls ingress packet acceptance at the fabric interface, signaling upstream switching elements 132 to reduce transmission rates via their own flow control mechanisms (such as Ethernet pause frames or InfiniBand credit-based flow control), thereby distributing congestion awareness throughout the fabric and preventing localized buffer overflow that could lead to packet loss or protocol violations.

The output stage of the scheduler forwards selected packets to their respective downstream functional units based on operation type: memory operations (reads, writes, atomics, vector elements) are directed to Memory Access Unit 420 which translates logical memory requests into physical DRAM command sequences and interacts with the Local Memory Subsystem 470 completion packets and coherence control messages are directed to Fabric Interface Block 460, which encapsulates them into transport-layer frames and transmits them onto the interconnect fabric 130 toward their destination compute devices or memory nodes. The scheduler-to-memory-unit interface is credit-based: the memory access unit maintains an ingress request queue with finite capacity (128 entries, matching the reorder buffer depth) and transmits credit tokens to the scheduler whenever queue slots are consumed and freed, with the scheduler tracking available credits and deferring packet forwarding when credits are exhausted, thereby implementing backpressure that prevents the memory access unit from being overwhelmed. Similarly, the scheduler-to-fabric interface employs credit-based flow control tied to the TX ring descriptor availability within Fabric Interface 460, ensuring that completion traffic does not overflow egress buffers. This end-to-end credit-based flow control, propagating from the MC-NIC's internal functional units through the scheduler back to the protocol parsing engine and ultimately to the fabric interface's RX ring, ensures that the system degrades gracefully under overload: rather than dropping packets or introducing unbounded queueing delays, the backpressure mechanism stalls ingress packet acceptance at the fabric interface, signaling upstream switching elements 132 to reduce transmission rates via their own flow control mechanisms (such as Ethernet pause frames or InfiniBand credit-based flow control), thereby distributing congestion awareness throughout the fabric and preventing localized buffer overflow that could lead to packet loss or protocol violations.

These mechanisms collectively enable the MC-NIC to provide robust multi-tenant isolation and differentiated service guarantees essential for cloud-scale disaggregated memory deployments. By extracting tenant identifier 318 from every MF-TLP packet header and using it to index per-tenant policy state, the system implements header-driven governance wherein access control, resource allocation, and quality-of-service enforcement are performed at wire speed (line rate packet processing) without requiring software intervention or trusted hypervisor mediation for common-case traffic. The multi-level scheduling hierarchy-strict priority across operation classes ensuring bounded latency for critical synchronization and coherence primitives, weighted fair queuing within classes preventing monopolization by any single tenant, token-bucket rate limiting enforcing contracted bandwidth quotas, and starvation prevention bounding worst-case delays for low-priority traffic—addresses the full spectrum of performance, isolation, and fairness requirements. The hot-swap policy update mechanism, enabling control-plane-driven reconfiguration via MF-TLP control packets, provides the operational agility necessary for dynamic environments where tenant workloads, subscription tiers, and infrastructure conditions evolve continuously. The performance bounds achieved by this architecture—sub-microsecond latency for coherence messages, single-digit-microsecond latency for atomic operations, sustained multi-gigabyte-per-second throughput for vectorized bulk transfers, and strict enforcement of per-tenant quotas preventing noisy-neighbor effects—position the memory-centric network interface controller as a foundational building block for next-generation disaggregated architectures wherein compute, memory, and accelerator resources are dynamically composed into virtual machines or containers on demand, with the MC-NIC serving as the programmable, policy-aware, high-performance interconnect fabric endpoint that makes such disaggregation practical at data center scale.

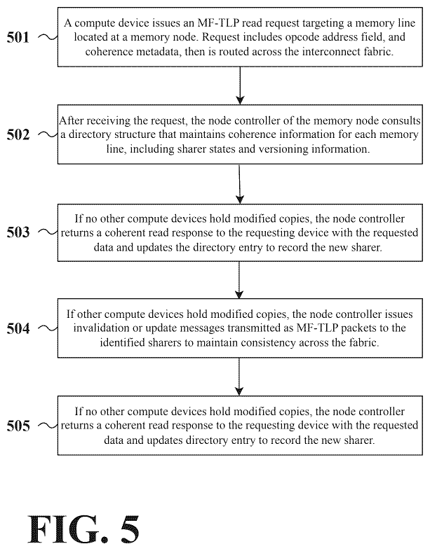

FIG. 5 is a method diagram illustrating a cache coherence protocol flow implemented across the memory fabric using the memory-fabric transaction layer protocol (MF-TLP), according to an embodiment. The protocol flow demonstrates how the distributed directory-based mechanism maintains consistency of memory data across multiple compute devices and memory nodes connected by the fabric.

In a first step 501, a compute device issues an MF-TLP read request targeting a memory line located at a memory node. The request is encapsulated in an MF-TLP packet that includes an opcode identifying the operation type, an address field specifying the target line, and coherence metadata that identifies the transaction. Next, the request is routed across the interconnect fabric to the memory node, which acts as the home node for the specified address range.

In a second step 502, upon receiving the request, the node controller of the memory node consults a directory structure that maintains coherence information for each memory line. The directory structure may store entries indicating which compute devices currently hold a copy of the line, whether the line is in a shared, exclusive, or modified state, and any versioning or lease information associated with the line. In some embodiments, the directory structure is maintained directly at the memory node, while in other embodiments directory entries are distributed across dedicated coherence managers within the fabric.

In a third step 503, if the directory structure indicates that no other compute devices currently hold a modified copy of the requested line, the node controller returns a coherent read response to the requesting compute device. The response includes the requested data in the payload of an MF-TLP packet and updates the directory entry to record that the compute device is now a sharer of the line.

In a fourth step 504, if the directory structure indicates that another compute device holds a modified copy of the line, the node controller issues one or more invalidation or update messages. These coherence messages are transmitted as MF-TLP packets to the identified sharers. In one embodiment, an invalidation message instructs a sharer to discard its cached copy of the line. In another embodiment, an update message conveys the most recent value of the line from the current owner back to the memory node or directly to the requesting compute device.

In a fifth step 505, once the coherence messages are acknowledged by the relevant sharers, the node controller finalizes the directory entry to reflect the new ownership or sharing state. For example, after a compute device writes back the updated value, the directory may be updated to indicate that the line is now shared between devices, or that one device holds the exclusive copy. A corresponding update acknowledgment is then transmitted to the requesting device, completing the transaction.

In some embodiments, the coherence protocol flow may employ lease-based or version-based metadata to reduce invalidation overhead. For instance, a read request may be satisfied by providing a leased copy that remains valid until a specified epoch, reducing the need for frequent invalidation traffic. In other embodiments, predictive coherence mechanisms may allow the directory controller to pre-issue invalidation messages in anticipation of a write request, thereby lowering latency for critical sections of parallel workloads.

The cache coherence protocol flow therefore illustrates how MF-TLP packets can implement a fully distributed directory-based coherence mechanism at fabric scale. By encoding requests, sharer information, invalidation messages, and acknowledgments into routable MF-TLP transactions, the system ensures that multiple compute devices may safely access and modify disaggregated memory resources while maintaining a consistent and coherent view of data across the entire network.

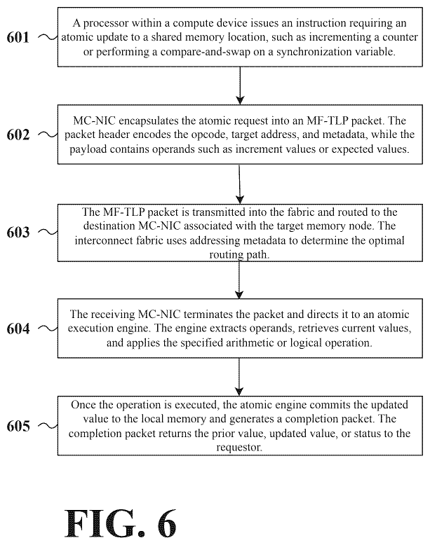

FIG. 6 is a method diagram illustrating an atomic operation flow carried out within a memory-centric fabric using the Memory-Fabric Transaction Layer Protocol (MF-TLP), according to an embodiment. The flow demonstrates how an atomic operation, such as a fetch-and-add, may be executed directly at a memory-centric network interface controller (MC-NIC), thereby avoiding round-trip latencies to a host processor and enabling low-overhead synchronization across distributed nodes.

In a first step 601, a processor within a compute device issues an instruction requiring an atomic update to a shared memory location. The processor generates a request identifying the target memory address and the operation type, such as incrementing a counter or performing a compare-and-swap on a synchronization variable. This request is handed off to the MC-NIC of the compute device through a driver or library interface.

In a second step 602, the MC-NIC encapsulates the atomic request into an MF-TLP packet. The packet header encodes the opcode corresponding to the requested atomic operation, the address of the target memory line, and optional metadata such as a tenant identifier or priority level. The payload contains one or more operands, such as the increment value for a fetch-and-add operation.

In a third step 603, the MF-TLP packet is transmitted into the fabric and routed to the destination MC-NIC associated with the target memory node. The interconnect fabric uses addressing metadata within the packet to determine the optimal path to the memory location where the atomic operation will be performed.

In a fourth step 604, at the destination, the receiving MC-NIC terminates the MF-TLP packet and directs it to an atomic execution engine implemented within the NIC hardware. The parsing logic extracts the opcode and operands, retrieves the current value of the target memory location from the attached memory array, and applies the specified arithmetic or logical transformation. For example, in the case of a fetch-and-add, the atomic engine adds the operand value to the stored counter. In the case of a compare-and-swap, the engine compares the stored value with an expected operand and conditionally writes a new value if the comparison succeeds.

In a fifth step 605, once the operation is executed, the atomic engine commits the updated value to the local memory and generates a completion packet. The completion packet is returned through the fabric to the originating compute device. Depending on the opcode, the completion packet may include the prior value, the updated value, or a status indicator confirming whether the operation succeeded.

In some embodiments, the atomic execution may be combined with coherence metadata to ensure correctness across cached copies in other compute devices. For instance, before committing the new value, the MC-NIC may issue invalidation messages to other sharers, ensuring that subsequent accesses observe the updated value. In other embodiments, the MC-NIC may aggregate multiple atomic requests arriving from different sources and apply them in a serialized or pipelined fashion, thereby ensuring deterministic ordering while maintaining high throughput.

The atomic operation flow thus demonstrates how MF-TLP packets encapsulate atomic semantics and how MC-NIC hardware executes typed operations proximate to memory. By performing these functions in-network, the architecture reduces traffic, accelerates synchronization primitives such as counters and locks, and supports advanced workloads including distributed training of neural networks, high-performance computing simulations, and parallel graph analytics.

FIG. 7 is a method diagram illustrating a reduction operation flow carried out in a memory-centric fabric using the Memory-Fabric Transaction Layer Protocol (MF-TLP). The flow demonstrates how multiple compute devices may concurrently transmit partial results into the fabric, where they are aggregated by a memory-centric network interface controller (MC-NIC) or by an in-network processing engine within a switch, with the consolidated result ultimately committed to memory.

In the embodiment, a plurality of compute devices 710A-710N each generate a partial result associated with a distributed computation. For example, the compute devices may each produce a subset of gradient values during neural network training, or may generate partial sums in a distributed analytics workload. Each compute device encapsulates its partial result into one or more MF-TLP packets 712A-712N. The packets specify a reduction opcode in the header, identify the target memory object or line, and carry the partial result values in the payload

The MF-TLP packets 712 are transmitted into the interconnect fabric 720, where they may be routed 730 to encounter an intermediate switching element 740 equipped with an in-network reduction engine. Upon receiving multiple packets addressed to the same reduction target, the switching element parses the payloads, applies the specified arithmetic or logical function (such as addition, minimum, maximum, or bitwise AND), and combines the partial results into an aggregated intermediate value. This aggregation may be performed incrementally as packets arrive, allowing the reduction engine to operate in a streaming fashion without buffering the entire dataset.

In other embodiments, the packets 712A-712N may be routed directly to a destination MC-NIC 750 associated with a memory node. The MC-NIC includes reduction logic configured to perform the same aggregation functions described above. The reduction logic retrieves any existing value stored at the target address in the local memory array, applies the arithmetic combination with the arriving payload values, and writes back the consolidated result.

Once the aggregation is complete, the MC-NIC 750 or the switch 740 generates a completion packet 760 that may be transmitted to one or more requesting compute devices to indicate that the reduction has been finalized. The completion packet may carry the final reduced value, an identifier confirming the memory location of the result, or a status flag confirming successful execution. In some embodiments, completion packets may be multicast to all original contributors so that each compute device has immediate access to the updated global result.

The reduction operation flow may support a wide range of arithmetic and logical functions. For instance, in addition to summation, the reduction engine may be configured to compute products, logical conjunctions or disjunctions, statistical measures such as maxima or minima, or even typed floating-point operations. In some embodiments, programmable reduction units allow custom operators to be defined by software and executed directly within the NIC or switch hardware.

To ensure correctness in a coherent memory fabric, the reduction logic may also interact with a directory controller. Prior to committing the reduced value into memory, the MC-NIC or switch may issue invalidation messages to sharers of the affected line, ensuring that subsequent reads reflect the updated aggregate. Alternatively, version tokens or lease-based metadata may be embedded in the MF-TLP headers, allowing readers to verify that they are accessing the most recent reduced value.

The reduction operation flow therefore illustrates how the MF-TLP packet format and MC-NIC functionality extend traditional atomic semantics to multi-source aggregation. By enabling partial results to be combined directly within the network fabric, the architecture reduces traffic, lowers synchronization latency, and provides an efficient substrate for large-scale workloads such as distributed machine learning, real-time analytics, and collective communication patterns in high-performance computing.

FIG. 7A is a block diagram illustrating two alternative architectural topologies for executing distributed reduction operations within the memory fabric, along with detailed specifications of reduction opcode encoding, accumulator state management, coherence integration mechanisms, and performance characteristics, according to an embodiment. The diagram presents a comprehensive view of how multiple compute devices transmit partial results that are aggregated either through a k-ary tree of switching elements performing incremental reductions at interior nodes (Option A) 770 or through direct transmission to a destination memory-centric network interface controller that performs complete aggregation (Option B) 780, with both approaches ultimately ensuring fabric-wide cache coherence before committing the final reduced value to memory and multicasting completion notifications to participating devices.

Option A, the k-ary tree in-network reduction topology 770, in which partial results flow upward through multiple layers of switching elements 134, each equipped with in-network processing engines that perform typed arithmetic aggregation as packets arrive. Four exemplary compute devices—110A, 110B, 110C, and 110D—each generate a partial result as output from a local computation such as gradient calculation during distributed machine learning training, statistical aggregation during analytics queries, or parallel accumulation during scientific simulations. Compute device 110A produces a partial result of 42.7, device 110B produces 38.1, device 110C produces 51.2, and device 110D produces 29.4, with all four devices participating in the same logical reduction operation identified by transaction identifier 311 equal to 0x8A3F and targeting multicast group 0x0042. Each compute device encapsulates its partial result into an MF-TLP packet whose header 312 includes a reduction opcode encoded according to the format detailed subsequently, specifying operation type (REDUCE_SUM), data type (FP32 for 32-bit floating-point), associativity and commutativity flags enabling reordering optimizations, the transaction identifier 311 for matching requests and responses, the multicast group identifier for directing coherence operations and completion notifications, and the target NodeID (0x0003) indicating the memory node where the final result will be committed. The payload of each MF-TLP packet carries the partial result value encoded according to the specified data type—in this case, a 32-bit IEEE 754 floating-point number.

These MF-TLP reduction packets are transmitted upward from the compute devices to leaf-level switching elements 134 designated as L1-A and L1-B, which represent the first aggregation tier in the k-ary tree topology. Switch 134 L1-A receives packets from compute devices 110A and 110B, while switch 134 L1-B receives packets from compute devices 110C and 110D. Each leaf switch maintains a set of accumulator registers indexed by the composite key (TxnID 311, Multicast Group ID), with each accumulator tuple storing the current partial aggregate, a packet count indicating how many contributions have been received thus far, an optional expected count field (which may be learned from an initial control packet or inferred from multicast group membership metadata), a timestamp recording the arrival time of the first packet for this reduction operation, and the reduction operation metadata including data type and arithmetic function. Upon receiving the first packet for transaction 0x8A3F targeting multicast group 0x0042, switch Li-A allocates an accumulator, initializes it with the value 42.7 from device 110A, and starts a timeout timer. When the second packet arrives from device 110B with value 38.1, the switch's reduction logic block—implemented as a dedicated arithmetic unit within the in-network processing engine 134 performs typed floating-point addition using hardware adders that respect IEEE 754 rounding modes, yielding the intermediate aggregate 80.8, increments the packet count to 2, and determines that all expected packets for this sub-tree have arrived (either because the count matches the expected value or because a flush timeout expires). Similarly, switch L1-B aggregates packets from devices 110C and 110D to produce intermediate aggregate 80.6. The streaming combine capability, wherein each packet is incorporated into the accumulator immediately upon arrival rather than buffering all inputs before aggregation begins, enables low-latency processing and bounded memory consumption proportional to the number of concurrent reduction operations rather than the number of contributing devices.

The intermediate aggregates from the leaf switches are then encapsulated into new MF-TLP reduction packets that preserve the original transaction identifier 311 (0x8A3F), multicast group identifier, and target NodeID, but update the payload to carry the intermediate aggregate values. These packets flow upward to the root switch 134, which performs the final aggregation step. The root switch maintains its own accumulator indexed by (0x8A3F, 0x0042), accumulates the incoming intermediate values 80.8 and 80.6 to produce the final aggregate 161.4, recognizes that this is the final reduction tier (either through explicit depth metadata in the packet header or through switch topology configuration indicating that this switch is designated as the tree root for this multicast group), and encapsulates the final aggregate into an MF-TLP packet that is transmitted downward to the destination memory-centric network interface controller MC-NIC 750 located at memory node 120 with NodeID 0x0003. The k-ary tree topology achieves logarithmic aggregation latency proportional to tree depth—for example, a binary tree with 1,024 leaf devices requires only log 2(1024)=10 aggregation tiers, with each tier adding approximately 60 nanoseconds of processing and propagation delay (50 nanoseconds for switch logic plus 10 nanoseconds for link serialization at 100 Gbps line rate), yielding total tree traversal latency around 600 nanoseconds plus the variable accumulation time at each tier, which depends on the temporal spread of packet arrivals and ranges from 200 nanoseconds (if packets arrive nearly simultaneously) to several microseconds (if packets are spread across a wide time window due to compute device synchronization variance).

The direct-to-MC-NIC reduction topology 780 demonstrates which compute devices 110E through 110H transmit their partial results—15.3, 22.8, 18.9, and 31.5 respectively—directly to the destination MC-NIC 750 at memory node 120 with NodeID 0x0005, without intermediate aggregation at switches. In this topology, switching elements 132 serve purely as packet routers, forwarding reduction packets based on destination NodeID without inspecting or modifying the payload, thereby simplifying switch design and reducing per-switch state requirements at the cost of concentrating all aggregation work at the destination NIC. The MC-NIC 750 receives the four packets in arrival order (which may differ from transmission order due to variable network path delays), and its reduction logic block maintains a streaming accumulator for transaction identifier 0x9B7C. As each packet arrives, the reduction logic extracts the partial result from the payload, performs the typed arithmetic operation (FP32 addition in this example) to incorporate the value into the running aggregate, increments the packet counter, and evaluates flush conditions. Flush is triggered either when the packet count matches the expected contributor count (which may be specified in a setup packet sent prior to the reduction, encoded in the multicast group membership table, or learned dynamically by observing a termination marker in the final packet's header) or when a timeout expires—typically 50 to 500 microseconds after the first packet arrival—to handle scenarios where one or more contributors fail or are delayed. Upon flush, the reduction logic finalizes the aggregate (88.5 in this example) and initiates the coherence and memory commit sequence described subsequently. The direct-to-NIC topology achieves lower end-to-end latency for small contributor counts (fewer than approximately 8-16 devices, depending on network bisection bandwidth and NIC ingress processing capacity) but suffers from serialization bottlenecks at the NIC's packet processing pipeline when handling large-scale reductions with hundreds or thousands of contributors, as all packets must traverse the NIC's ingress parser, accumulator lookup, and arithmetic unit sequentially, limiting aggregate throughput to the NIC's packet processing rate (typically 100-200 million packets per second for contemporary smart NICs).

The reduction opcode encoding format extends the opcode field 312 with structured sub-fields that enable switches and MC-NICs to execute a wide range of typed reduction operations without requiring per-operation custom logic. Bits [7:0] encode the base arithmetic or logical operation: 0x80 for SUM (arithmetic addition), 0x81 for PRODUCT (multiplication), 0x82 for MAX (maximum value selection), 0x83 for MIN (minimum value selection), 0x84 for BITWISE_AND, 0x85 for BITWISE_OR, 0x86 for BITWISE XOR, with additional codes reserved for future operations such as geometric mean, harmonic mean, or custom application-defined aggregation functions. Bits [11:8] encode the data type, specifying both the width and interpretation of operands: 0x0 for INT32 (32-bit signed integer), 0x1 for INT64, 0x2 for FP16 (IEEE 754 half-precision float), 0x3 for FP32 (single-precision), and 0x4 for FP64 (double-precision), with the hardware reduction units configured accordingly to use integer ALUs for integer types and floating-point units with appropriate precision and rounding modes for floating-point types. Bit [12], the associative flag, indicates whether the operation can be reordered—for example, floating-point addition is mathematically associative but yields different results under finite-precision arithmetic depending on association order, so applications requiring bitwise-reproducible results clear this bit to enforce left-to-right evaluation, while applications tolerating minor rounding variations set this bit to enable tree-based aggregation optimizations that improve parallelism. Bit [13], the commutative flag, indicates whether operand order can be exchanged, enabling further optimizations such as out-of-order packet processing when packets arrive from different network paths with variable delays. Bits [15:14] are reserved for future extensions, such as specifying overflow behavior, saturation modes, or alternative rounding strategies. This compact 16-bit opcode encoding allows a single reduction logic block to support dozens of operation variants without requiring separate hardware units for each combination, with switch and NIC implementations decoding the opcode fields during packet parsing and dynamically configuring their arithmetic data paths accordingly.

The accumulator state management mechanism 134 and MC-NICs 750 maintain concurrent reduction contexts for multiple overlapping operations without interference or resource exhaustion. Each switch or NIC maintains a table of active accumulators, with each entry indexed by the composite key (Transaction Identifier 311, Multicast Group ID) to uniquely identify a specific reduction operation—this two-dimensional keying allows multiple independent reductions to proceed concurrently (different TxnIDs) and enables a single transaction to target multiple distinct multicast groups if, for example, results must be delivered to multiple memory nodes or consumer groups. Each accumulator entry comprises an accumulator register whose width matches the specified data type (32 bits for INT32 or FP32, 64 bits for INT64 or FP64, 128 bits for extended-precision operations or for accumulating vectors of smaller elements), a packet count field tracking how many contributions have been incorporated thus far, an expected count field indicating the total number of contributors (which may be explicitly encoded in an initial setup packet or inferred from multicast group membership cardinality), a timestamp field recording the system time (in nanoseconds or processor cycles) when the first packet for this reduction arrived, and metadata fields storing the operation type, data type, associativity flags, and destination addressing information. Flush triggers are evaluated after each packet is processed: the count-based trigger fires when packet_count equals expected_count, immediately finalizing the reduction and forwarding the result to the next aggregation tier or to the destination MC-NIC; the timeout-based trigger fires when current_time minus first_packet_timestamp exceeds a configurable threshold (typically 50 microseconds for latency-sensitive operations such as synchronization barriers, up to 500 microseconds for bulk data processing reductions), preventing indefinite accumulator liveness in scenarios where contributors fail or packets are lost, with the timeout-triggered flush forwarding the partial aggregate accumulated thus far and optionally setting an “incomplete” flag in the outgoing packet header to inform downstream logic that not all expected contributions were received.

Resource limits prevent unbounded accumulator table growth: contemporary switch ASICs supporting in-network reduction allocate storage for 256 concurrent accumulators per switch (requiring approximately 32 kilobytes of on-chip SRAM for accumulator state plus metadata), while MC-NICs dedicate substantially more resources—up to 1,024 concurrent accumulators (128 kilobytes)—reflecting their role as final aggregation points potentially serving hundreds of multicast groups simultaneously. When the accumulator table reaches capacity and a new reduction packet arrives requiring allocation of a fresh entry, the switch or NIC employs a replacement policy: the least-recently-used (LRU) accumulator that has not received a packet within the timeout window is selected for eviction, its current partial aggregate is flushed (transmitted to the next tier with an incomplete flag), the entry is deallocated, and the incoming packet initializes a new accumulator in the freed slot. Alternatively, priority-based replacement may be employed wherein low-priority reduction operations (identified via QoS class metadata in the MF-TLP header) are evicted before high-priority operations, ensuring that latency-critical synchronization primitives such as distributed barriers or lock acquisitions are not delayed by bulk data reductions consuming accumulator resources. This state management mechanism enables switches and NICs to support high throughput of overlapping reductions—for example, a switch handling 256 concurrent reductions with an average reduction duration of 10 microseconds (from first to last packet arrival) can sustain an aggregate reduction initiation rate of 25.6 million reductions per second, sufficient to support thousands of compute devices each issuing reductions at kilohertz rates.

The final reduced value is committed to memory in a manner consistent with the fabric-wide cache coherence protocol, preventing stale reads by devices that may have cached prior values of the target memory location. Upon completing the reduction aggregation—whether at the root of a k-ary tree or at the destination MC-NIC in the direct topology—the MC-NIC 750 does not immediately write the result to memory; instead, it first invokes its coherence directory interface 430, to consult the directory structure 125 maintained at the memory node. The directory lookup, keyed by the ObjectID and cache line address derived from the reduction target address specified in the original MF-TLP packet headers, retrieves the current coherence state and sharer mask for the target line. If the directory indicates that one or more compute devices currently hold cached copies of the line—for example, the sharer mask 0x0000_0000_0000_001F indicates that compute devices 0, 1, 2, 3, and 4 each cache the line—the coherence interface generates invalidation messages encoded as MF-TLP packets with coherence-specific opcodes and transmits them to all identified sharers, leveraging the multicast group identifier from the reduction operation if the sharers belong to a multicast-capable group (enabling a single multicast invalidation packet to reach all sharers with O(log N) replication in tree-based multicast fabrics) or falling back to unicast invalidation packets when multicast is unavailable. Each invalidation message carries the transaction identifier 311 to enable sharers to match invalidations with outstanding operations, the ObjectID and line address identifying which cached line must be purged, and optionally a version number or sequence token allowing devices to determine whether their cached copy predates the invalidation (enabling optimistic read continuation in relaxed consistency models). The coherence interface then awaits acknowledgment messages from all sharers, with a timeout mechanism (typically 10 microseconds) to handle cases where sharers have failed or are unresponsive, after which the operation either proceeds (if sufficient acknowledgments are received to guarantee correctness under the specified consistency model) or aborts and returns an error completion to the reduction initiators. Only after all required acknowledgments are received does the MC-NIC commit the final reduced value by issuing a single atomic write operation to the local memory array 122, updating the corresponding directory entry 125 to reflect the new state (typically transitioning to MODIFIED with the MC-NIC itself recorded as the exclusive owner, or SHARED if multiple devices are immediately granted read access), and incrementing the version number or epoch counter in the directory to enable subsequent readers to detect that the value has changed.

Following the coherent memory write, the MC-NIC generates and transmits completion packet which notifies the participating compute devices that the reduction has finalized and the result is now visible at the target memory location. The completion packet's header 312 encodes a REDUCE_COMPLETION opcode distinct from normal write completions, carries the original transaction identifier 311 (0x8A3F in Option A, 0x9B7C in Option B) enabling each contributor to match the completion with its outstanding reduction request and release any local resources such as completion queue entries or synchronization flags, and includes the final reduced value in the payload (161.4 and 88.5 in the illustrated examples) allowing contributors to consume the result without issuing a separate read operation to memory, thereby reducing latency for patterns where the result is needed by all participants, such as barrier synchronization (where the completion acts as a barrier release signal) or parameter server updates in distributed machine learning (where the completion carries the aggregated gradient that all workers need to apply to their local model replicas). The completion packet may be transmitted via multicast to all devices in the original multicast group, leveraging the fabric's multicast routing capabilities to deliver the completion with a single packet injection and O(log N) switch replications, or may be transmitted via a series of unicast packets if multicast is unavailable or if different contributors require different completion information (for example, if some contributors need only a status acknowledgment while others require the full result value). The completion multicast mechanism is particularly advantageous in collective communication patterns such as all-reduce, where all N participating devices both contribute partial results and consume the final aggregate, as the multicast completion eliminates the need for N separate read operations that would otherwise consume substantial memory bandwidth and introduce serialization delays at the memory node.

The latency budget and backpressure handling mechanisms which quantify the end-to-end performance characteristics and describe how the system maintains correctness and throughput under contention. For the k-ary tree topology with depth D (measured as the number of aggregation tiers from leaves to root), the total latency comprises several components: leaf switch accumulation at tier 1 ranges from 200 to 500 nanoseconds depending on the temporal spread of packet arrivals from the attached compute devices (nearly-simultaneous arrivals enable immediate aggregation, while arrivals spread across several microseconds require the accumulator to remain active until the timeout fires or the expected packet count is reached); per-hop propagation through each subsequent tier adds approximately 60 nanoseconds, decomposed into 50 nanoseconds for switch packet processing (parsing, accumulator lookup, arithmetic operation, and packet re-encapsulation) and 10 nanoseconds for link serialization at 100 Gbps line rate assuming 64-byte reduction packets; thus, total tree traversal latency follows O(D) scaling as D×60 nanoseconds, for example D=3 yields ˜180 nanoseconds; the MC-NIC 750 coherence phase, executing through the interface, contributes 1 to 5 microseconds depending on the number of sharers that must be invalidated, with this phase dominating end-to-end latency in coherence-heavy workloads; and the final memory write contributes 80 to 150 nanoseconds for DRAM access latency, yielding aggregate end-to-end latency from first packet transmission to completion packet reception of approximately 2 to 6 microseconds for tree-based reductions. In contrast, the direct-to-MC-NIC topology incurs 3 to 8 microseconds end-to-end latency, with the increase attributable to serialization bottlenecks when many packets converge simultaneously on the MC-NIC's ingress processing pipeline, necessitating queuing delays proportional to the number of contributors divided by the NIC's packet processing rate.

Backpressure and contention handling, managed through transaction scheduling and QoS unit 450 becomes necessary when multiple concurrent reductions compete for limited accumulator resources at switches or NICs, or when reduction traffic contends with other memory fabric operations such as vectorized transfers or single-address reads and writes. When a switch 134 reaches its accumulator table capacity of 256 entries and receives a reduction packet requiring a new allocation, the switch evaluates replacement candidates using a composite policy that considers accumulator age (time since last packet arrival), priority class (derived from QoS metadata in the MF-TLP headers), and progress toward completion (accumulators closer to their expected packet count are preferred for retention as they will likely flush soon and free their resources). If no suitable eviction candidate exists—for example, all accumulators are high-priority and actively receiving packets—the switch asserts backpressure to its ingress ports, either through explicit pause frames in Ethernet-based fabrics or through credit-based flow control in InfiniBand or CXL transports, stalling upstream senders until accumulator slots become available. At the MC-NIC level, priority scheduling assigns reduction packets to priority classes: HIGH priority for coherence invalidations, acknowledgments, atomic operations, and reduction completion packets, ensuring that these latency-critical control messages are not delayed behind bulk data transfers; MEDIUM priority for reduction data packets (those carrying partial results with REDUCE_SUM or similar opcodes in field 312) and single-address read/write operations, balancing latency and throughput for common-case memory operations; and LOW priority for bulk vectorized transfers specified via vector descriptor 316 which carry large payloads or target many addresses and can tolerate higher latency in exchange for efficient bandwidth utilization. This three-tier priority scheme, implemented via weighted fair queuing or strict priority scheduling within the MC-NIC's egress arbiter, ensures that reduction operations achieve predictable sub-10-microsecond latency even when the fabric is saturated with bulk data movement, enabling applications to use reductions as synchronization primitives—for example, implementing distributed barriers or consensus protocols—with bounded worst-case latency rather than the unbounded delays that would occur under pure first-come-first-served scheduling. The correctness guarantees in coherent mode, formalize how the system maintains sequential or release consistency semantics despite the distributed and asynchronous nature of reduction aggregation. The correctness protocol comprises four sequential phases, each with defined ordering constraints: first, the MC-NIC 750 accumulates all partial results from contributors into a single final aggregate using typed arithmetic with appropriate rounding (for example, FP32 addition uses IEEE 754 round-to-nearest-even mode, producing deterministic results when the associative flag is clear and packets are processed in a specified order such as increasing contributor ID); second, before committing the aggregate to memory, the coherence interface 430 consults directory 125 to retrieve the complete sharer mask and current version number, establishing a serialization point that orders the reduction with respect to all prior reads and writes to the same cache line; third, invalidation messages are multicast or unicast to all sharers identified in the directory, with the reduction operation stalling until acknowledgments are received from all sharers (or until a timeout expires and the operation transitions to an error state), ensuring that no stale cached copies persist after the reduction commits and preventing the anomaly where a device reads a pre-reduction value from its cache after the reduction has logically completed; fourth, the MC-NIC executes a single atomic write to the memory array, increments the directory version number or epoch counter, and multicasts completion packet 760 to all original contributors, with the transaction identifier 311 enabling each contributor to match the completion with its pending request and observe the result. This four-phase protocol provides linearizability for each individual reduction operation—meaning that the reduction appears to execute atomically at a single point in time between the arrival of the last partial result and the transmission of the completion packet—and composes with the broader fabric-wide coherence protocol to maintain sequential consistency across all memory operations (reductions, reads, writes, atomics) issued by any compute device, ensuring that application programmers can reason about reduction semantics using familiar sequential execution models despite the underlying parallel and distributed implementation.

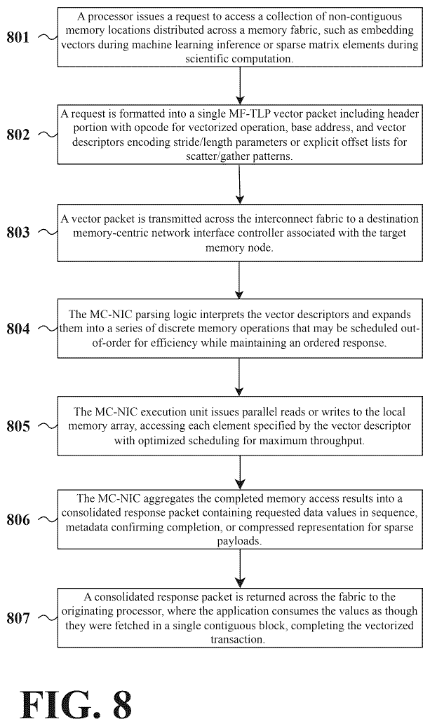

FIG. 8 is a method diagram illustrating a vectorized transaction flow implemented using the Memory-Fabric Transaction Layer Protocol (MF-TLP). The flow demonstrates how a single MF-TLP packet may encode multiple addresses, strides, or offsets, enabling a memory-centric network interface controller (MC-NIC) to execute a plurality of memory operations in a single transaction and return a consolidated response to the requester.

The flow begins 801 when a processor encounters the computational need to access a collection of non-contiguous memory locations that are distributed throughout a memory fabric architecture. These access requirements typically arise during complex operations such as retrieving specific embedding vectors during machine learning inference processes, accessing sparse matrix elements during scientific computations, or performing graph traversals that require irregular memory access patterns. Rather than generating multiple individual memory requests that would create substantial packet overhead, network congestion, and processing inefficiencies, the system recognizes the opportunity to consolidate these disparate memory access requirements into a single, optimized transaction.

In a second step 802, the processor's memory access request is then formatted and encapsulated into a sophisticated MF-TLP vector packet that serves as the foundation for the entire vectorized operation. This packet contains a carefully structured header portion that includes several critical components: an opcode that explicitly indicates a vectorized operation is being requested, a base memory address that serves as the reference point for the operation, and one or more advanced vector descriptors. These vector descriptors are particularly sophisticated, capable of encoding either stride and length parameters to describe memory access sequences with regular spacing patterns, or explicit offset lists that can handle complex irregular scatter/gather access patterns. In some advanced embodiments, multiple descriptors can be combined within the same packet, enabling hybrid operations that seamlessly mix both contiguous and non-contiguous memory ranges.

In a third step 803, once the vector packet has been properly formatted and prepared, it is transmitted across the interconnect fabric infrastructure to reach its intended destination. The packet traverses the network fabric using the established routing protocols and arrives at the destination memory-centric network interface controller (MC-NIC) that is specifically associated with the target memory node containing the requested data. This transmission phase leverages the existing fabric infrastructure while carrying significantly more operational information than traditional individual memory requests, thereby maximizing the utilization of available network bandwidth.

In a fourth step 804, upon receiving the vector packet, the destination MC-NIC's specialized parsing logic immediately begins interpreting the embedded vector descriptors with sophisticated analysis capabilities. The parsing system intelligently expands these compact descriptors into a comprehensive series of discrete memory operations that will need to be executed to fulfill the original request. This expansion process is optimized for efficiency, allowing the individual memory operations to be scheduled out-of-order when beneficial for performance, while still maintaining the capability to produce an properly ordered response sequence that matches the original vector descriptor specifications.

In a fifth step 805, the MC-NIC's dedicated execution unit takes control of the expanded memory operations and systematically issues parallel read or write operations directly to the local memory array. This execution phase is highly optimized, with the unit accessing each specific memory element that was specified within the original vector descriptor using advanced scheduling algorithms designed to achieve maximum memory throughput and minimize latency. The parallel execution capability allows multiple memory locations to be accessed simultaneously, significantly improving overall performance compared to sequential access patterns.

In a sixth step 806, once all the required memory access operations have been successfully completed, the MC-NIC performs a critical consolidation and aggregation step. The system carefully aggregates all the retrieved results into a single, comprehensive response packet that maintains the integrity and organization of the requested data. This consolidated response may contain the requested data values arranged in their proper sequential order, include metadata that confirms the successful completion of each individual element access operation, or even employ compressed representation techniques when the response payload exhibits sparsity characteristics that can benefit from data compression.

In a final step 807, involves the efficient transmission of the consolidated response packet back across the fabric infrastructure to the originating processor that initiated the original request. Upon receipt, the requesting application can seamlessly consume the retrieved values as though they had been fetched from a single contiguous memory block, despite the underlying complexity of the distributed memory access operations. This vectorized approach provides substantial performance advantages by amortizing packet header overhead across multiple memory operations, significantly reducing both bandwidth consumption and packet processing latency while simultaneously decreasing network congestion and greatly simplifying application-level programming complexity, making it particularly advantageous for AI inference workloads, graph traversal algorithms, and other applications characterized by sparse or irregular memory access patterns.

In some embodiments, the vector packet may also carry write data in its payload, enabling multiple remote stores to be committed in a single transaction. The MC-NIC expands the payload into discrete updates to the memory array, then issues a single acknowledgment or completion packet to the requester. In other embodiments, vector packets may specify compound operations, such as “read-modify-write” across a set of addresses, or may embed atomic sub-operations within each vector element.

The vectorized transaction flow 800 provides significant advantages over issuing individual requests. By amortizing packet header overhead across multiple memory operations, the system reduces bandwidth consumption and packet processing latency. By consolidating responses, the flow reduces network congestion and simplifies application-level programming, allowing a single function call to trigger dozens or hundreds of memory accesses. This mechanism is particularly advantageous for AI inference workloads, graph traversals, and other applications characterized by sparse or irregular access patterns.

In certain embodiments, vectorized transactions may also interact with the coherence protocol of the fabric. For example, when multiple cache lines are fetched via a single vector packet, the MC-NIC may update directory entries for all lines in a single batch, thereby lowering coherence traffic. In other embodiments, predictive prefetching may be applied to extend the vector descriptor range, ensuring that future elements are staged into memory before being explicitly requested by the application.

The MF-TLP vector packets enable multi-address operations to be executed efficiently at the NIC, with expanded accesses to memory performed locally and consolidated responses returned across the network. By elevating vector semantics into the transaction layer, the architecture achieves scalable performance for workloads requiring irregular or bulk memory access patterns while preserving compatibility with the underlying packet-switched transport fabric.

In some embodiments, the MF-TLP protocol further supports fused multi-operation packets, which combine a sequence of memory operations into a single transaction. A fused packet may, for example, including both a prefetch directive and a subsequent initialization write for the same memory region, allowing NIC to pre-stage data into local buffers and immediately commit initialization values without issuing multiple discrete requests. In another embodiment, a fused packet may encode a read-modify-write sequence, in which a memory line is fetched, transformed by an arithmetic or logical operation, and then written back to the same or a related address, with all three stages guaranteed to execute atomically as part of the fused operations, and schedule them for execution in the correct order while maintaining atomicity guarantees with respect to other transactions. By supporting fused operations in this manner, the MF-TLP reduces packet overhead, minimizes fabric latency, and enables applications to express higher-level memory access patterns as a single optimized transaction.

In some embodiments, the MF-TLP protocol and associated MC-NIC hardware support error handling and reliability mechanisms to ensure correctness of memory operations across the fabric. Each MF-TLP packet may include error detection codes, checksums, or forward error correction bits, allowing intermediate switches and destination NICs to validate integrity prior to execution. If a packet is lost, corrupted, or otherwise fails verification, the MC-NIC may generate a retry request or retransmit the transaction based on sequence and transaction identifiers. In certain embodiments, timers are employed such that if an acknowledgement or completion packet is not received within a specified interval, the requesting device automatically reissues the transaction. These reliability features ensure that even in the presence of transient link errors or congestion drops, the memory fabric maintains a consistent and correct view of data, providing robustness equivalent to or greater than traditional interconnect standards.

In some embodiments, the MF-TLP layer may further support different memory consistency models to provide flexibility across applications with varying performance and ordering requirements. In one embodiment, the fabric enforces a sequential consistency model, ensuring that all operations appear in a single global order consistent with the program order of each compute device. In another embodiment, a release consistency model may be applied, wherein synchronization operations such as fences or barriers enforce ordering only at well-defined points, thereby reducing the overhead of strict global barriers enforce ordering only at well-defined points, thereby reducing the overhead of strict global ordering. In still other embodiments, the MF-TLP protocol may operate under a relaxes consistency model, allowing reordering of independent memory transactions to improve throughput, while still guaranteeing atomicity and coherence for conflicting operations. By encoding ordering metadata or transaction class identifiers in MF-TLP packet headers, the system may dynamically select between consistency models on a per-operation or per-region basis. The configurability enables the fabric to efficiently support both strongly ordered workloads, such as transactional databases, and highly parallel workloads, such as deep learning training, within the same architecture.

In further embodiments of the coherent memory fabric, a Hierarchical Probabilistic Directory with Multicast Invalidation Trees (HPD-MIT) is introduced to scale sharer tracking and invalidation fan-out across rack-scale and data-center-scale deployments. The HPD-MIT architecture replaces a monolithic, flat sharer directory with a sophisticated two-level structure comprising rack-local directories (RLDs) that maintain precise per-node sharer state within a rack, and a global directory index (GDI) that maintains only a probabilistic summary of which racks may contain at least one sharer of a cache line. When an operation requires ownership change, such as a read-exclusive or write-exclusive operation, the memory-node MC-NIC consults the GDI to derive a candidate rack set, computes or selects a Steiner-like multicast tree over the fabric for those racks, and emits MF-TLP invalidation (INV) transactions tagged with a Coherence-Scope Identifier (CSID) that instructs each target RLD to perform precise, per-node fan-out locally. This architectural approach amortizes global coherence signaling to the rack granularity and exploits transaction-layer multicast, while preserving byte-accurate coherence semantics described elsewhere in the disclosure, including directory states, invalidation/update messages and acknowledgements.

The base MF-TLP coherence flow packages sharer information and invalidations in routable packets, and HPD-MIT extends this foundation by adding explicit header fields and NIC/switch behaviors to scope coherence to a domain such as a rack, row, or cluster, target only racks that probabilistically contain sharers, and replicate invalidations at line rate inside the rack. The approach remains transport-agnostic and leverages MF-TLP's extensible header format and ordered/priority delivery facilities as disclosed herein.

At the architectural level, the memory-node MC-NIC functioning as the home agent hosts a Global Directory Index (GDI) that maps a line identity to a probabilistic rack-membership summary. The GDI is realized as an array of per-rack counting filters, which in one embodiment are implemented as Counting Bloom Filters (CBFs), and in another embodiment as Counting Quotient Filters (CQFs), with each filter answering the predicate of whether line L is cached by any node in rack r. The GDI is updated only on rack-level transitions, specifically when the first sharer appears in a rack or when the last sharer in the rack departs, with these transitions being signaled by the corresponding RLD. By indexing membership per rack rather than maintaining global per-line sharer bit-vectors, the memory footprint and update bandwidth remain sub-linear in the number of compute nodes. The MC-NIC integrates the GDI lookup into the coherence state machine that already mediates sharer tracking and invalidations.

Each rack aggregates the sharer state of its resident compute nodes in a precise rack-local directory (RLD), which may reside in a rack-level MC-NIC, a Top-of-Rack (ToR) switch with a coherence assist block, or a designated compute-side MC-NIC that exposes a rack directory service. The RLD maintains per-line local sharer bitmaps or compact lists scoped to that rack and maintains two rack-local counters per line, specifically local_readers and local_exclusive counters. The RLD issues rack-up events to the GDI when a line's rack-presence toggles from zero to one, and rack-down events when it toggles from one to zero, ensuring the GDI reflects only rack-granular presence. The RLD also optionally tracks lease/version metadata for each line to reduce thrashing, consistent with the lease-based coherence optimizations.

In certain embodiments, switching elements in the interconnect may be MF-TLP-aware and perform in-network processing. Within the HPD-MIT framework, a ToR or spine switch optionally caches Sharer-Filter Slices for hot lines and performs line-rate replication of invalidations to local compute nodes identified by the RLD, returning a single merged acknowledgement to the memory node. This switch-assist capability piggybacks on the already contemplated capability of switches to parse MF-TLP headers and execute simple data-path operations.

The probabilistic rack summaries maintained in the GDI employ a sophisticated filter structure and sizing approach. Let R be the number of racks, U the number of lines in the fabric address space, and N_r the number of lines present in rack r's caches at a given time. For each rack r, the GDI maintains a CBF_r with m counters and k hash functions. Insertions occur on the first arrival of any sharer in rack r for a given line, while deletions occur on the last departure, with the RLD asserting rack-down only when its local sharer count for that line reaches zero. The counters are implemented as saturating counters with w-bit width where w is greater than or equal to 2. With standard Bloom filter sizing, a false-positive target p is achieved with m approximately equal to negative N_r times natural log of p divided by the square of natural log of 2, and k approximately equal to m divided by N_r times natural log of 2. For example, with N_r equal to 64 million cached lines and p equal to 0.01, m is approximately 612 million counters, which with 2-bit counters requires approximately 153 MB per rack filter, enabling a practical trade-off at rack scale. CQFs may reduce memory at the cost of slightly more complex updates, with both approaches being within scope. The crucial invariant maintained is “no false negatives,” which is enforced via conservative deletes whereby the RLD issues deletion updates only after the last local sharer evicts or invalidates.

From an enablement perspective, the MC-NIC already contains a directory interface and address translation unit, and the CBF array is implemented as SRAM banks in the MC-NIC or an attached HBM slice, with queries executed in parallel for K racks per cycle using bank interleaving. The filter query and INV emission operations are integrated into the MF-TLP processing pipeline already described for reads, writes, and atomic operations.

The rack-up and rack-down protocol maintains coherence through precise coordination between the RLD and GDI. The RLD maintains accurate rack-local sharer counts derived from per-node events including read-shared acquisition, exclusive downgrade/upgrade operations, and evictions. When a line's local sharer count transitions from zero to one, the RLD issues a GDI_ADD message containing the line_tag, and when it transitions from one to zero, it issues a GDI_DEL message with the line_tag. These are implemented as MF-TLP directory-maintenance control packets delivered to the home memory-node MC-NIC on ordered lanes to preserve causality with data operations, with ordering support provided by the transport integration mechanisms discussed in the MF-TLP layer.

The packet extensions required for HPD-MIT leverage MF-TLP's extensibility by introducing specific header fields in the extension header following the MF-TLP base header. The Coherence-Scope Identifier (CSID) field, occupying 12 bits, identifies the scope or domain such as rack, cluster, or global scope, and if needed, a policy profile including lease aggressiveness and acknowledgement policy. The Sharer-Filter Slice (SFS) field comprises a filter_id of 16 bits, an epoch of 16 bits, and fbits array of 256 bits, conveying a cached filter fragment useful for switch replication and validation, though this field is optional. The Rack Set Bitmap (RSB) field provides a variable-length compact bitmap or run-length bitset of candidate racks derived from the GDI, and is included when the multicast control plane uses bitmap-directed trees.

The control plane introduces new opcodes including GDI_ADD and GDI_DEL for RLD to home MC-NIC control messages updating per-rack filters, INV and INV_ACK for invalidation request and acknowledgement packets, and INV_SUMMARY_ACK for ToR/spine-merged acknowledgements when switch-assist is enabled. These opcodes reuse the transaction identifier and tenant/QoS semantics of MF-TLP and are prioritized on coherence-priority lanes through scheduler 450 to bound latency.

For multicast tree construction, given the RSB representing the candidate rack set, the memory-node MC-NIC employs sophisticated tree selection strategies. Pre-computed trees are maintained by the fabric control plane as a catalog of Steiner approximations for common rack subsets, such as any k-of-R selections, keyed by an RSB hash, allowing the MC-NIC to retrieve a TreeID and emit a single INV per tree branch with switches replicating per the tree specification. Alternatively, for small cardinality RSB sets, on-the-fly Shortest-Path Trees are computed using a greedy SPT algorithm rooted at the memory node, implemented in NIC microcode using a link-state snapshot. The packet carries either a TreeID or an edge list, both conveyed as MF-TLP metadata in extension headers.

The switch-assist functionality with SFS caching enables ToR switches to cache Sharer-Filter Slices, such as a 256-bit fragment of a rack filter for a hot line, together with a small epoch value. When a subsequent INV includes a matching filter_id and epoch pair, the ToR can validate that its cached sharer list from recent RLD notifications is still compatible and replicate invalidations to local nodes at line rate, returning a single INV_SUMMARY_ACK upstream. In cases where the SFS is absent or there is an epoch mismatch, the ToR forwards the INV to the RLD for authoritative fan-out. This switch behavior represents an optional optimization that relies on the existing capability for switches to perform in-network operations on MF-TLP payloads.

The protocol flows for write-exclusive acquisition from the home memory-node perspective begin when a compute node issues a write-exclusive MF-TLP request, causing the home MC-NIC to identify the target line and current directory state. The MC-NIC then performs a GDI query by computing the line's tag and querying the per-rack filters in parallel, producing the RSB candidate rack set. Following tree derivation, the MC-NIC selects a multicast tree and emits INV packets carrying CSID, RSB, and optionally SFS fields. At the rack fan-out stage, each targeted rack either has a ToR performing switch replication to local nodes as per the cached sharer list in the fast path, or forwards the INV to the RLD, which consults its precise per-node sharer map and issues node-scoped INV MF-TLPs. During the acknowledgement phase, RLDs aggregate node INV_ACKs and respond to the home with a single INV_ACK, while with switch-assist enabled, a ToR merges acknowledgements into an INV_SUMMARY_ACK. After collecting all rack-level acknowledgements, the home MC-NIC updates the directory to reflect the exclusive owner and returns completion to the requester.

The rack-local update discipline maintains coherence through precise state transitions. On shared read arrivals, the RLD sets the local sharer bit and, if transitioning from zero to one, issues a GDI_ADD message. On eviction or explicit invalidate, the RLD clears the bit and, if transitioning from one to zero, issues a GDI_DEL message. For lease and version management, the RLD may grant epoch-bounded leases on shared lines and avoid invalidations when leases naturally expire, implementing the optimizations described elsewhere in the specification.

Failure tolerance mechanisms ensure robustness against various failure modes. When GDI_ADD or GDI_DEL messages are dropped, periodic reconciliation sweeps run between RLDs and the home MC-NIC, such as Bloom scans over a window of hot lines. When CBF counters experience overflow and saturate for a bucket, the home marks the bucket as “saturated” and treats membership queries there as always-positive until a filter epoch roll rebuilds the structure in a lazy, background manner. Switch cache staleness is handled through SFS epoch mismatches, which force RLD fall-back for precise fan-out.

The lease and version interaction mechanisms leverage lease-based coherence optimizations to reduce invalidation fan-out, with these optimizations encoded in coherence metadata. HPD-MIT leverages this capability to prune the RLD targets further, with the RLD checking per-line lease tokens and only invalidating non-expired holders, otherwise awaiting lease lapse before acknowledging. This policy fits within the previously disclosed coherence metadata fields framework.

From a correctness, ordering, and consistency perspective, HPD-MIT introduces no new visibility anomalies beyond those allowed by the selected memory model, such as sequential or release consistency already contemplated for MF-TLP. Strict ordering is ensured through multiple mechanisms: sending coherence control on ordered transport lanes, correlating INV/ACK messages with MF-TLP Transaction IDs, and applying grant of exclusive rights at the home only after all targeted racks acknowledge. False positives in the GDI cause benign extra invalidations to racks that do not actually hold the line, while false negatives are precluded by the conservative delete discipline at RLDs. Thus, if any rack currently caches the line, it will either be invalidated or its lease will expire before another writer commits, preserving the global coherence invariant described in the base protocol.

Performance and sizing considerations demonstrate the scalability advantages of the hierarchical approach. Let S be the average sharer count per line and R* the average number of racks containing sharers for that line. A flat, per-node invalidation protocol performs O(S) targeted messages, while HPD-MIT reduces global fan-out to O(R*) messages from the home plus O(S_r) local messages within each targeted rack r, where the sum of S_r across all racks equals S. For deployments where R* is much less than S, which is common in locality-aware deployments with node affinity within racks, the savings in cross-rack traffic are substantial. The filter false-positive rate p adds less than or equal to p times (R minus R*) extra rack targets in expectation, and selection of p can be tuned to keep this budget negligible relative to R*. The GDI SRAM footprint scales linearly in R and remains independent of node count, while RLDs distribute precise bitmaps. The INV path receives scheduler prioritization over bulk vectors using the QoS unit, ensuring that coherence latency remains tight under load.

The implementation details for enablement include specific micro-architectural components within the MC-NIC. The parser extends opcode and extension parsing to identify INV, GDI_ADD, GDI_DEL, INV_ACK, INV_SUMMARY_ACK, CSID, RSB, and SFS fields. The GDI Engine employs multi-banked CBF or CQF structures with k-hash pipelines, with per-request latency hidden by transaction queueing. The Tree Selector includes a microsequencer with a CAM for RSB to TreeID mapping and a fallback SPT routine. The scheduler 450 adds a coherence lane with token bucket and EDF scheduling for INV/ACK packets to bound tail latency. The Fabric I/F 460 supports multicast encapsulation and switch hints including TreeID, and verifies ACK completeness before grant.

The RLD data structures include a local sharer map implemented as a per-line bitmap of N_rack_nodes, typically 16 to 128 bits, optionally compressed using run-length blocks. Counters for local_readers and local_exclusive are maintained per line, with 2 to 3 bits each sufficing with saturation. The lease table stores epoch_id and time-to-live values per line or per region, decremented by a rack timer wheel. The control plane maintains a tree catalog of pre-computed multicast trees generated by the fabric controller, with the MC-NIC caching the most common RSB patterns. Filter epochs are rotated lazily by the home, with RLDs opportunistically re-adding hot lines during normal traffic without requiring a hard stop.

Alternative embodiments provide additional flexibility and optimization opportunities. XOR-based filters may replace CBF or CQF implementations with XOR filters for lower memory and constant-time queries, while retaining conservative delete semantics via rack-presence counters in the RLD. Per-tenant filters can partition the GDI by TenantID, leveraging MF-TLP's tenant fields to isolate interference and reduce false positives across tenants. CSID variants may encode not only scope but also consistency class such as SC or RC, allowing the home to choose ordering strength per operation, aligning with the configurable consistency mechanisms.

The HPD-MIT architecture strictly generalizes the MF-TLP directory protocol by hierarchically factoring sharer state, using probabilistic rack summaries to cut global invalidation traffic, and exploiting transaction-layer multicast and switch-assist replication. The approach differs materially from CXL back-invalidate or small-domain snooping in that it is multicast-aware at the MF-TLP transaction layer, hierarchical in state placement, and probabilistic only at rack granularity—never at the per-node correctness boundary—ensuring that sequential or release-consistent semantics are preserved under the already described ordering controls. This embodiment is fully implementable with the MF-TLP header extensibility, directory semantics, MC-NIC pipeline, switch-assist capabilities, and QoS/ordering mechanisms already disclosed, providing a foundation for novel features including probabilistic rack summaries, CSID-scoped invalidations, and multicast tree-based coherence fan-out.

In further embodiments, a time-bounded lease protocol is provided for the coherent memory fabric to reduce invalidation fan-out and control coherence traffic in read-mostly or bursty-write workloads, while preserving the correctness guarantees of the Memory-Fabric Transaction Layer Protocol (MF-TLP). In the Epoch-Leased Coherence (ELC) mode, read-shared accesses are served together with a Lease-Token (LT) that carries an epoch stamp and time-to-live (TTL). A cache holding an LT treats the corresponding line as valid until the lease's expiry epoch, while writers request exclusive ownership by supplying a desired target epoch E_target. The home memory-node directory grants exclusivity immediately if all outstanding leases will expire not later than E_target, and otherwise the directory issues pre-revocation messages only to lease holders whose leases overlap the requested window, thereby pruning invalidation fan-out. Coherence control traffic for lease issuance, pre-revocation, and acknowledgements is transported on ordered lanes as already contemplated for MF-TLP coherence messages, ensuring globally consistent visibility without relying on higher-layer software sequencing.

The ELC mechanism integrates into the MF-TLP header framework via extension headers that carry lease metadata, and executes in the MC-NIC pipeline alongside existing directory maintenance, transaction parsing, and scheduling/QoS units previously described. ELC can operate concurrently with vectorized and fused transactions, atomic/reduction operations, and tenant/QoS policies already disclosed.

The system employs specific definitions and time base mechanisms for coherence management. An epoch represents a monotonically increasing logical time reference used to bound lease validity. In one embodiment, the home memory-node MC-NIC maintains an Epoch Counter E_home advanced by a calibrated oscillator, while in another embodiment, epochs advance according to ordered transport ticks or fabric-synchronized time if available. Each compute-side MC-NIC maintains a local E_local and periodically receives Epoch Sync beacons piggybacked on MF-TLP control traffic, allowing bounded skew where the absolute value of E_local minus E_home is less than or equal to A. A safety slack a greater than or equal to A is applied by requesters when interpreting TTLs to ensure that lease expiry, as observed by a cache, is conservative with respect to the home's epoch.

The Lease-Token (LT) is implemented as a tuple carried in MF-TLP coherence metadata, comprising a line_tag, epoch_start, ttl, lease_id, and policy_flags, where epoch_start represents the home's epoch at issuance, ttl encodes a lease duration in epochs, lease_id provides a per-line nonce for cancellation and renewal correlation, and policy_flags encode lease class such as read-only, read-mostly, or write-sensitive, along with renewal permissions and revocation urgency. The effective expiry is calculated as epoch_expire equal to epoch_start plus ttl. The LT travels in the response to a read-shared request and may be cached beside the line state in the requester's MC-NIC and/or private cache controller.

The ELC mechanism utilizes the MF-TLP extension header facility to encode lease metadata in coherence-bearing transactions through specific header structures. The Lease Extension Header (LEH) comprises fields including lt_present as a single bit, epoch start as 32 bits, ttl as 24 bits, lease_id as 24 bits, and policy as 8 bits, and is present in Read-Shared Response, Pre-Revoke, Lease-Renew Ack, and Write-Grant packets. The Writer Target Epoch (WTE) subfield contains E target as 32 bits and wait_policy as 3 bits in EXCL_REQ and UPGRADE_REQ messages, where wait_policy indicates whether the requester is willing to wait until E target without pre-revocation, is willing to accept partial pre-revocation, or requires immediate ownership via pre-revocation.

The protocol introduces new and refined opcodes and control messages, including EXCL_REQ with E target parameter for requesting exclusive ownership targeting epoch E_target, PREREVOKE with lease_id for directed invalidation to non-expired lease holders only, LEASE_RENEW request and LEASE_RENEW_ACK for renewal handshake operations, and LEASE_CANCEL with lease_id for optional early surrender by readers. All messages carry MF-TLP Transaction IDs and travel on coherence-priority lanes managed by the scheduler 450.

The directory and cache state extensions provide enhanced tracking capabilities. For each coherent line, the memory-node MC-NIC directory state is augmented with a sharer_set as before, or alternatively a rack-scoped sharer summary in hierarchical deployments, a lease_table containing tuples of node_id, lease_id, and epoch_expire for active leases, and lease_policy parameters per line or region including base TTL range specified as ttl_min to ttl_max, renewal policy, and writer fairness parameters. On the compute-side, each caching node records, with a line in Shared-Leased (SL) state, the lease_id, epoch_expire, and policy_flags. Upon expiry as determined by E_local plus a being greater than or equal to epoch_expire, the line transitions to Shared-Stale (SS) state and is treated as invalid for coherent re-use, though it may be used under non-coherent read policy if the application marks the region as stale-tolerant through an optional policy bit tied to consistency class.

The protocol flows for read-shared operations with lease issuance begin when a compute node issues a Read under coherence. Upon directory hit, the home MC-NIC consults the directory, and if no conflicting exclusive owner is present, it returns the line with an LEH carrying epoch_start equal to E_home, ttl equal to f_read of line, region, and load where f_read is a policy function, and a freshly allocated lease_id. During cache admission, the requester caches the line in SL state and arms a local lease timer using E_local and slack σ, and on eviction, it clears the state and may send LEASE_CANCEL as an optional optimization.

The exclusive write request with target epoch flow initiates when a writer issues EXCL_REQ with E target and a wait_policy. The home directory performs overlap computation by constructing set H containing tuples of node_id and lease_id where epoch_expire for that node_id is greater than E target. If H is empty, the directory schedules grant at E_target without issuing invalidations. When H is not empty and wait_policy allows, the directory performs selective pre-revocation by issuing PREREVOKE with lease_id only to nodes in H, where PREREVOKE carries the line tag, the lease_id to cancel, and optionally a Grace Epoch E_grace greater than or equal to E_home that allows short local use before invalidation, such as to drain outstanding reads. During ack aggregation, upon receiving PREREVOKE, a node invalidates the line if still present and lease not expired and returns an ACK. The home aggregates ACKs, possibly via rack-local or switch-assist if present, and when complete, updates the directory to exclusive and returns Write-Grant.

For writer “wait until” operations without pre-revocation, when wait_policy equals WAIT_UNTIL, the home computes E_ready as the maximum epoch_expire of active leases and either immediately grants if E_ready is less than or equal to E_target, or enqueues the request in a grant queue keyed by E_ready, serviced when E_home advances to E_ready. The ordered transport and MC-NIC scheduler ensure that coherence control messages and Write-Grant appear in program order as perceived by participants.

Lease renewal operations allow readers to request extension of a lease by sending LEASE_RENEW with line_tag, lease_id, and Δttl prior to expiry. The home applies admission control whereby if no writer is pending, it responds with LEASE_RENEW_ACK with updated ttl, and otherwise it may deny or cap the extension to ensure writer fairness. Renewals reset epoch_start to E_home to eliminate drift accumulation. For eviction and early surrender, upon eviction or when a line is no longer needed, a cache may transmit LEASE_CANCEL with lease_id, causing the home to remove the entry from lease_table, allowing subsequent writers to proceed without addressing that node.

The ordered transport and QoS mechanisms ensure proper sequencing and prioritization. All coherence control packets for ELC, including EXCL_REQ, PREREVOKE, LEASE_RENEW, acknowledgements, and Write-Grant, are carried over ordered transport lanes such as UET ordered streams or InfiniBand ordered classes to preserve the global ordering constraints required by the chosen memory model. The MC-NIC scheduler unit 450 uses coherence-priority classes to bound latency, while bulk data and vector payloads use elastic lanes, as previously described. Per-tenant QoS tags allow the fabric to prioritize or throttle lease traffic fairly among tenants.

The policy, parameterization, and fairness mechanisms provide sophisticated control over lease behavior. TTL selection through the function ttl equals f read of line, region, and load may consider observed read-hit rate, write frequency, line temperature, and tenant SLOs, subject to the range ttl_min to ttl_max. For example, ttl may be calculated as clamp of ttl_min plus a times r_hit minus β times w_rate, bounded by ttl_min and ttl_max, with α and β configured per region. Regions marked read-mostly receive longer TTLs, while write-hot regions receive minimal TTLs.

The bounded staleness contract allows applications to annotate regions with consistency class via MF-TLP metadata, such as sequential, release, or relaxed consistency. ELC honors these annotations by restricting TTL and renewal under sequential consistency to ensure observed ordering equivalent to the base protocol, while release consistency allows longer TTLs between synchronization points or fences. The MF-TLP specification already contemplates per-operation consistency selection, which ELC leverages for this purpose.

Writer fairness and starvation freedom are ensured through multiple mechanisms. To prevent writer starvation, the home directory enforces a maximum renewal depth per line, a writer priority window that temporarily suppresses renewals when a writer has waited beyond W_max, and optional age-based TTL decay whereby each successive renewal halves the TTL down to ttl_min. These controls ensure eventual exclusivity without requiring global invalidations.

The system provides sophisticated interactions with other mechanisms in the fabric. In hierarchical directory deployments with RLD/GDI structures, rack-local directories (RLDs) hold precise per-node lease tables and maintain rack-presence with the global directory (GDI). On EXCL_REQ with E target, the home queries the GDI for candidate racks, then requests from each involved RLD the subset of non-expired lease holders where epoch_expire is greater than E_target, and issues PREREVOKE only to those nodes. This approach preserves the multicast fan-out advantages of the hierarchical design while adding lease pruning capabilities.

ELC composes seamlessly with vectorized and fused transactions by applying batch lease issuance and batch pre-revocation. For a vector read of k lines, the home returns a vector of LTs in a single response, while for a vector write/GRS packet, the home evaluates overlap per line and aggregates PREREVOKE messages by destination to minimize traffic, then issues a single Write-Grant when all affected leases are either expired or acknowledged.

For atomic and reduction operations, atomic read-modify-write operations require exclusivity and thus trigger EXCL_REQ. Commutative reductions to designated reduction locations may either proceed under exclusive ownership obtained via ELC, or be executed by in-network reduction engines as disclosed, which do not expose shared cached copies and therefore bypass ELC entirely.

The correctness and memory model preservation ensures that ELC maintains the line-granular coherence invariant whereby no two nodes may hold conflicting exclusive and shared-valid copies simultaneously. Under sequential consistency, the use of ordered lanes, transaction identifiers, and grant-after-ack ensures that a write's visibility follows invalidation of all overlapping leases. Under release consistency, long leases are permissible between synchronization operations, with PREREVOKE messages carrying fence semantics when needed, and a Write-Grant acting as an acquire for the writer. The MF-TLP framework already defines selectable consistency models, and ELC specializes the coherence message scheduling accordingly.

Regarding false positives and negatives, because leases are time-bounded and managed by the home directory, the protocol admits neither false positives in the form of unnecessary invalidations beyond intentional pre-revocations, nor false negatives in the form of missed invalidations. Any lease that would conflict with an imminent writer must either expire before E_target or receive a PREREVOKE and acknowledge before the Write-Grant is issued.

Failure handling and recovery mechanisms provide robustness against various failure modes. For lost control packets, the home sets timers per outstanding PREREVOKE, and on expiry, it retransmits or forces a lease cancel by marking the lease as expired and requiring the node to revalidate on next access as a defensive policy. Clock skew is handled through the safety slack σ, which ensures local expiry is not later than the home's expiry determination, with optional Epoch Sync beacons recalibrating A. Upon node crash detected through heartbeat failure, the home marks that node's leases as void and proceeds. Periodic lease table reconciliation requests using MF-TLP control messages allow the home and RLDs to resynchronize lease state after transient fabric faults.

The implementation details for enablement include specific MC-NIC additions. The Lease Engine, implemented as a microsequencer adjacent to the directory interface, maintains the lease_table, issues LTs on read responses, computes set H for EXCL_REQ with E_target, issues PREREVOKE to only overlapping leases, aggregates acknowledgements, and triggers Write-Grant when complete. The Epoch Counter and Timer Wheel maintain E_home and a timer wheel keyed by expiry epochs to wake waiting writers and prune leases efficiently. Scheduler hooks ensure that the existing coherence-priority lane in scheduler 450 is parameterized to admit PREREVOKE and Write-Grant ahead of bulk traffic under congestion.

Cache controller hooks include the addition of SL and SS states, specifically Shared-Leased and Shared-Stale states to the cache controller, with SS lines triggering revalidation or lease renewal before coherent use. A per-line lease timer provides countdown functionality driven by E_local with slack σ. Header processing capabilities ensure that the protocol parsing engine extracts LEH fields on receipt and stamps them on responses, while outgoing EXCL_REQ and PREREVOKE messages incorporate WTE/LEH fields as appropriate.

Alternative embodiments provide additional flexibility and optimization opportunities. Ticketed leases may replace time with ticket counts, such as N reuses, for bursty workloads, with the home decrementing tickets on observed reuses, approximated via sampled acknowledgements. Lease-by-region approaches allow regions such as pages or segments to obtain a region-LT, amortizing per-line metadata in streaming analytics applications. Hybrid ELC plus Federated approaches combine ELC with domain-scoped coherence, where cross-rack traffic uses short TTLs while intra-rack traffic uses longer TTLs to reduce intra-domain invalidations, consistent with the configurable domain semantics elsewhere disclosed.

The ELC architecture offers a principled middle ground between immediate global invalidation and no hardware coherence, bounding staleness by time while preserving strict visibility when required by the consistency class. The approach reduces invalidation storms in read-mostly regions by allowing writers to wait until lease expiry or pre-revoke only the overlapping subset, and fits naturally within the MF-TLP packet model, extension headers, directory flows, ordered transport, and NIC scheduler mechanisms already described for the coherent memory fabric. This detailed embodiment is fully supported by the MF-TLP packet extensibility, coherence directory flows, transport ordering integration, vector/atomic semantics, and NIC pipeline elements described throughout the specification, thereby enabling time-bounded, tokenized coherence at the transaction layer.

In further embodiments, the coherent memory fabric provides a SELCC-on-Silicon (SoS) compatibility mode in which the memory-centric network interface controller (MC-NIC) at a memory node terminates latch-based one-sided atomics, including compare-and-swap (CAS) and fetch-and-add (FAA) operations, directed at a latch word while simultaneously projecting the resulting ownership into the MF-TLP directory state machine. This embodiment supplies a hardware substrate that is a strict superset of software-level SELCC latch protocols, whereby software may continue to use latch semantics via RDMA-style atomics or via native MF-TLP LATCH verbs, yet the home memory-side MC-NIC enforces fabric-wide coherence by driving directory updates and, when indicated, emitting MF-TLP invalidations and acknowledgements without involving any remote CPU. The SoS path leverages existing MF-TLP packet parsing, atomic/reduction execution in the NIC, directory interface, vectorized transaction handling, scheduler/QoS, and ordered transport classes disclosed elsewhere herein.

The latch object is realized as an aligned 64-bit latch word located in the target memory node, co-resident with or address-adjacent to the latched data region. In one embodiment, the word is encoded with bits 63 through 56 containing the tenant_id_hash, bits 55 through 48 containing the owner_epoch as a monotone ticket to avoid ABA problems, bits 47 through 32 containing the owner_node_id, bit 31 serving as the x_intent exclusive intent bit, bit 30 serving as the x_owned exclusive granted bit, bit 29 serving as the s_count_sat shared counter saturated flag, bits 28 through 12 containing the s_count representing shared holders up to 2\hat{ }17−1, and bits 11 through 0 containing the latch_version for read-side validation. Other encodings, such as owner UUID or separate lease bits, are contemplated, with the salient invariant being that CAS can atomically transition the word between Shared (S) and Exclusive (X) intent/owned states, and FAA can manipulate a saturated shared count when operating in shared-only modes. The latch word is ordinary memory with no special coherency in and of itself, with coherence being provided by the MF-TLP directory and coherence messages coordinated by the MC-NIC as described herein.

The MF-TLP transaction set is extended with a LATCH primary opcode whose sub-operations include LATCH_CAS taking parameters addr, expected, desired, and mode for atomic compare-and-swap on the latch word with side-effect projection into the directory state machine, LATCH_FAA taking parameters addr, delta, and mode for atomic add on shared count, LATCH_RD taking addr parameter for reading the latch for diagnostics, and VLATCH_* for vectorized latch operations. LATCH packets carry an extension header containing a lock_class field of 4 bits, a mode field of 4 bits, a target_epoch field of 32 bits, a policy field of 8 bits, and a nonce field of 16 bits, where lock_class identifies the software synchronization class such as reader/writer, mutex, or upgradeable, mode disambiguates semantics such as “X-acquire with invalidations,” “S-acquire only,” or “X-upgrade,” target_epoch optionally cooperates with Epoch-Leased Coherence (ELC), policy encodes fairness/backoff and return conventions, and nonce allows idempotent retries. These fields ride in the MF-TLP extension header mechanism already defined for carrying transaction-metadata beyond the base header.

In an alternative embodiment providing compatibility personality, the memory-side MC-NIC exposes an RNIC-compatible persona for incoming one-sided atomics from legacy stacks and maps them internally to LATCH_CAS/LATCH_FAA micro-operations before directory projection, while the compute-side may also issue native MF-TLP LATCH verbs. In both paths, the home MC-NIC is the only active participant on the memory side, with no remote CPU involvement.

The SoS fast-path is executed by a Latch Engine embedded alongside the atomic/reduction block and the coherence directory interface of the MC-NIC through a sophisticated execution pipeline. The protocol parsing engine first detects LATCH_* opcode or an RNIC atomic mapped to a latch operation and extracts LXH plus TenantID and Transaction ID. The memory access unit then fetches the 64-bit latch word. For the CAS/FAA micro-sequence, LATCH_CAS computes the success condition where load equals expected and determines the candidate desired value, while LATCH_FAA computes new as load plus delta and checks for saturation.

During the directory projection shadow phase, if the requested operation would result in exclusive ownership with x_owned set or x_intent transitioning to x_owned, or a transition that adds or removes shared holders through s_count increment or decrement, the system does not commit to memory yet but instead runs a shadow commit in the directory interface. For exclusive acquire or upgrade operations, the system consults directory state for sharers, and if present, issues MF-TLP invalidations to sharers, hierarchically via rack-local fan-out if enabled, collects acknowledgements, then marks directory owner as owner_node_id. For shared acquire operations, the system adds the requester to the sharer set or increments rack-local count. For shared release operations, the system removes the requester from the sharer set or decrements the count.

After the directory shadow completes successfully, the system atomically writes the desired or new latch value to memory, with write combining using ECC/checksums per existing memory access rules, and generates the completion MF-TLP response, including prior and new latch values per policy. All coherence control traffic, including invalidations, updates, and acknowledgements, flows over ordered, priority lanes managed by scheduler 450, with the completion held until directory effects are visible. This sequence ensures that CAS success with exclusive ownership is linearized only when the global coherence preconditions of no other valid shared copies are met. Equivalently, if CAS fails or coherence side-effects cannot be completed, the memory is not modified and the requester receives a failure code.

The directory projection semantics implement a hybrid lock plus directory approach. For shared acquisition, a LATCH_FAA with +1 and S parameter or LATCH_CAS variant requesting S results in directory marking of the requester as a sharer and latch increment or bit-set reflecting shared mode. The cache may fill the line in Shared state under MF-TLP and store advisory latch metadata for software's benefit. For exclusive acquisition, a LATCH_CAS that transitions to exclusive, such as x_intent transitioning to x_owned with owner_node_id set, triggers invalidations to all sharers before committing the latch word to exclusive. The invalidation fan-out is carried as MF-TLP messages and may be hierarchically replicated by a rack-local directory or switch assist where available. Upon collecting INV_ACK from all addressed sharers, the directory records the new owner and the latch write is committed, after which the grant representing CAS success is returned.

For downgrade and release operations, on LATCH_CAS releasing exclusive by clearing x_owned and owner fields, the home directory marks owner as null and optionally releases queued writers or readers. In failure paths, if conflicting state is detected, such as when the directory indicates a modified sharer that fails to acknowledge, the Latch Engine aborts and returns CAS failure or a retry token, leaving the latch and directory unchanged.

All coherence control under SoS uses ordered transport classes and MF-TLP Transaction IDs so that invalidation strictly precedes a CAS success grant for exclusive transitions, maintaining the selected memory consistency model of sequential or release consistency. Readers using shared latches observe lines consistent with the MF-TLP shared state, while writers gain exclusivity only when no valid shared copies remain per directory. Because the CAS completion is delayed until directory work is done, linearization of latch transitions coincides with coherence visibility, preserving lock semantics and memory ordering without remote CPU participation.

The system provides Vector-LATCH (VLATCH) capabilities for multi-key structures, addressing the motivation that data structures such as B-trees and hash-chains often require multiple latches, such as leaf and parent latches, to perform structural changes, where issuing N discrete CAS operations can cause overhead and deadlock. A single MF-TLP VLATCH packet encodes an ordered list of latch addresses with per-element modes in the vector descriptor, plus a canonical sort key such as ascending address or application-defined key to impose a deadlock-free global order. The packet structure contains count equal to k, order equal to canonical, and an array of tuples containing addr_i, mode_i, expected_i, and desired_i for i from 1 to k.

For NIC expansion and execution, the MC-NIC expands the vector, acquires or upgrades latches in strictly canonical order using repeated LATCH_CAS micro-operations, and projects each step into the directory as previously described. If any acquisition fails, the NIC rolls back previously acquired latch words and directory projections through release or downgrade operations in reverse order and returns a structured status bitmap indicating success or failure per element. This represents an application of the vectorized transaction machinery already disclosed, specialized for latch objects with atomicity at the vector granularity. Deadlock-freedom is ensured through canonical ordering across all nodes preventing cyclic wait, for example, a total order by address, tenant, and region ensures any two VLATCH acquisitions compete in the same order.

The SoS system composes with epoch-leased shared copies whereby when LATCH_CAS seeks exclusivity, the directory computes overlap with non-expired leases and either pre-revokes only overlapping lease holders or waits until all leases expire before completing the CAS and writing the latch word's x_owned bit. The LXH.target_epoch field allows a writer to request “grant no later than E_target” so that SoS can prune invalidations using ELC or choose to block until the epoch boundary. This integration reduces invalidation storms for read-mostly regions while preserving lock semantics.

For fairness, starvation freedom, and backoff guidance, the Latch Engine maintains per-latch wait queues, either logical or implicit, and may encode fairness hints in CAS failures, such as backoff intervals, ticket numbers using owner_epoch, or retry after epoch instructions. Policies include FIFO ticketing where owner epoch increments on each grant, and writer preference after K failed attempts to prevent reader starvation. These hints are returned in the completion header and may be consumed by software transparently.

The SoS system enforces tenant isolation by verifying that TenantID in the MF-TLP header matches either the tenant_id_hash baked into the latch word or a per-region capability table before performing CAS/FAA and directory projection. This prevents cross-tenant latch capture and is enforced in the parsing engine prior to memory access. The scheduler unit 450 applies per-tenant budgets to latch and control traffic.

In hierarchical deployments, the rack-local directory (RLD) holds precise per-node sharer maps or per-rack counts and can translate the directory projection into rack-scoped invalidations, with Top-of-Rack switches optionally replicating invalidations and returning a merged acknowledgement to the home NIC. SoS leverages this path transparently when invalidating sharers on exclusive acquisition.

Error handling and recovery mechanisms provide robustness through multiple approaches. ABA protection is provided through the owner epoch field acting as a ticket, where LATCH_CAS compares both value and epoch, incrementing on each successful grant, preventing ABA when latch memory is reused. For partial failure in VLATCH operations, if the N-tuple cannot be acquired, the NIC rolls back directory and latch changes already made, using vector-status to report per-element faults, with idempotent retries gated by LXH.nonce. Timeout handling ensures that if invalidation acknowledgements are not received within a fabric-configured timeout, the Latch Engine aborts and returns a retry code, with periodic reconciliation ensuring directory and latch converge.

The micro-architectural enablement includes a Latch Engine implemented as a dedicated micro-sequencer adjacent to the atomic/reduction block that performs latch load, CAS/FAA compute, directory shadow transaction, coherence message emission for INV/ACK, and commit on success. The Latch Engine interfaces to the protocol parsing engine for opcode and LXH extraction, the memory access unit for aligned 64-bit reads and writes of the latch word, the coherence directory interface for sharer queries, owner updates, and invalidate fan-out, the scheduler/QoS unit 450 for coherence-priority lanes, and the fabric interface 460 for ordered transport and error detection. Vector execution leverages the existing vector descriptor infrastructure and consolidated response machinery, with the NIC accumulating individual CAS outcomes into a status bitmap in the response payload.

Alternative embodiments provide additional implementation flexibility. Latch co-location places latch words in a reserved metadata segment of each page, with the MC-NIC deriving latch address from data address by fixed offset, reducing pointer chasing. Split latch implementations maintain a directory-only latch with no memory word for hot locks, where the latch state lives entirely in the home NIC with exclusive owner tickets and shared counters projected to caches, useful for ultra-hot locks that would otherwise thrash memory. UFUNC-guarded latch approaches allow user-defined UFUNCs, implemented as typed micro-operations, to execute on data after a latch is acquired, such as for structure-modifying reductions, reusing the programmable in-NIC compute path.

The SoS architecture provides drop-in compatibility for latch-style software such as SELCC while upgrading correctness from “latch only” to “latch plus hardware directory coherence,” whereby the CAS success becomes globally coherent by construction, exclusive grants are not observed before sharers are invalidated, and vectorized latch acquisition reduces packet count and deadlock risk for multi-key operations. Unlike host-centric coherence models, all control runs in-NIC with ordered, prioritized coherence traffic, and the mechanism composes with hierarchical directories and epoch-leased optimizations. This SoS embodiment is fully enabled by the MF-TLP extensible header format, the MC-NIC parsing/atomic/reduction/directory pipeline, the coherence protocol flows, and the vector transaction machinery already set forth in the specification, and it supports future claims directed to a memory-centric NIC that executes latch atomics and coherently projects the result into a directory state machine via MF-TLP.

In further embodiments, the interconnect fabric includes a switch-resident sharer cache at the top-of-rack (ToR) that accelerates coherence fan-out by replicating invalidations at line rate and merging acknowledgements on behalf of a home memory node. The memory-centric NIC (MC-NIC) at the home node emits a single MF-TLP invalidation (INV) packet per target rack carrying either a Sharer-List slice (SLS) containing explicit local node identifiers or a compact Sharer-Cache-Key (SCK) that indexes previously cached sharers at the ToR. The ToR parses MF-TLP extension headers, looks up or populates the Sharer-List, replicates the INV downstream to the precise set of local compute-side MC-NICs, collects per-node ACKs, and returns a single merged acknowledgement upstream to the home node. By moving fan-out into the switch data path using protocol-level hints, SSR-IR eliminates serialization of many per-node invalidations at the home MC-NIC while preserving the directory-based correctness rules already disclosed for MF-TLP coherence. The design reuses MF-TLP's extensible header format, routable transaction model, ordered transport for coherence control, and the possibility of in-switch processing described for in-network reductions.

The architectural components comprise multiple cooperating elements within the fabric. The home memory-node MC-NIC, serving as the directory owner, terminates MF-TLP requests, consults the distributed directory to identify sharers, and emits coherence messages including invalidations and updates when granting exclusive ownership, as illustrated in the baseline flow of issuing INV to sharers, awaiting ACKs, then finalizing ownership. SSR-IR augments this functionality by targeting racks rather than individual nodes, whereby for a hot line, the MC-NIC transmits one rack-scoped INV containing a Sharer-List slice or SCK to each involved ToR rather than N discrete per-node INVs.

The ToR switch implements sophisticated sharer cache and ACK-merge functionality through an MF-TLP-aware pipeline. The parser recognizes opcodes and extension headers, match-action tables index a Sharer Cache (SC) by SCK or by the tuple of line_tag and domain, the replicator emits per-port INVs to local nodes, and the aggregator merges per-node INV_ACK packets into a single INV_SUMMARY_ACK back to the home. This in-fabric switch processing is consistent with the disclosure that extension headers can instruct intermediate switches to replicate payloads and that switches may perform in-network operations such as reductions on MF-TLP streams.

When a rack-local directory (RLD) is present, the ToR may consult it to retrieve a precise list of local sharers or to validate a cached list before replication, otherwise the ToR relies solely on its SC entry, which is refreshed opportunistically by the home MC-NIC. The RLD participation is compatible with the base directory-driven invalidation and acknowledgement flow.

The packet-level interfaces leverage MF-TLP extension headers for switch assist functionality. MF-TLP already supports extension headers between the base header and payload, and these headers can carry optional information that intermediate switches parse to replicate traffic or change scheduling. SSR-IR defines two such extensions, specifically a Sharer-List slice (SLS) and a compact Sharer-Cache-Key (SCK). The SLS comprises fields including slice id as 12 bits, domain as 12 bits, epoch as 16 bits, count as 8 bits, and an array of node_id values according to count. The SLS encodes local node identifiers relative to the ToR that currently cache the line within a coherence domain such as a rack, with the epoch supporting staleness checks and incremental refresh. The SCK comprises fields including home_id as 12 bits, line_tag_hash as 32 bits, domain as 12 bits, and epoch as 16 bits. The SCK indexes a ToR Sharer Cache entry populated previously by an SLS-bearing INV, whereby on a subsequent write, the home sends just the SCK, and the ToR recovers the cached list and replicates without resending SLS.

The switch-visible control opcodes leverage and extend existing coherence messages. SSR-IR reuses standard coherence messages INV and INV_ACK and adds a switch-aggregation acknowledgement INV_SUMMARY_ACK. INV represents a rack-scoped invalidation from home to ToR, with SLS or SCK in the extension header. INV_ACK represents per-node acknowledgement between ToR and node. INV_SUMMARY_ACK represents a ToR to home merged acknowledgement that carries acked_count, missing_count, and error_bits to summarize the rack's response. These control packets ride on ordered transport lanes as already contemplated for MF-TLP coherence control.

The ToR micro-architecture for enablement includes sophisticated parsing and match-action capabilities. The ToR's ingress pipeline extends its programmable parser to recognize MF-TLP opcodes and parse extension headers including SLS and SCK. The parser forwards decoded keys to a match-action table that implements SC-Lookup functionality, whereby hit equals SC.lookup of SCK. On a hit, the system retrieves local_ports and epoch values, while on a miss or epoch mismatch, the system falls back to SLS payload if present, otherwise forwards the INV to the RLD if available or to all candidate ports under a conservative policy.

The Sharer Cache (SC) structure is implemented as a set-associative SRAM keyed by SCK or by the tuple of home_id, line_tag_hash, and domain, with entries comprising a key field, an epoch field containing a short version to detect staleness, a port_bitmap array with one bit per local downlink port for Np ports, a ttl field containing time-to-live in cycles or microseconds, and a stats field containing hits, last_access, and error mask information. Typical resources include 16 to 64k entries, with Np representing ports per ToR such as 16 to 64 ports, and ttl tuned to rack traffic patterns. Storage per entry comprises approximately 16 bytes for key, 2 bytes for epoch, 8 bytes for bitmap, 2 bytes for ttl, and 4 bytes for stats, totaling approximately 32 to 40 bytes. Entries are populated from an SLS or from RLD replies and aged out when TTL expires or epoch changes.

The replication and ACK aggregation mechanisms operate at line rate. On replicate operations, the egress block emits per-port INV packets with the same Transaction ID and coherence metadata as the upstream INV, substituting per-node destination addressing. A per-rack ACK aggregator tracks expected responders using the port_bitmap, counts INV_ACK arrivals, sets error bits for timeouts or NACKs, and returns a single INV_SUMMARY_ACK upstream when complete. This aggregation aligns with the base requirement that the home collect acknowledgements before granting ownership, now with a rack-level acknowledgement rather than many per-node acknowledgements.

To maintain sequential and ordered visibility, all SSR-IR control flows including INV, INV_ACK, and INV_SUMMARY_ACK are bound to ordered transport streams such as UET ordered classes. The ToR preserves per-transaction ordering on replication and only emits INV_SUMMARY_ACK after all addressed local nodes have responded, enabling the home to linearize grants exactly as in the baseline directory flow.

The protocol flows demonstrate system operation through multiple scenarios. The first-touch populate flow begins when the home MC-NIC determines sharers for a line by directory and groups by rack, sending for each rack a single INV with SLS carrying SLS and epoch to the ToR. The ToR installs or refreshes the SCEntry keyed by SCK derived from the INV or by the tuple of home_id, tag, and domain, then replicates INV to the local node set in port_bitmap. Local nodes return INV_ACK, the ToR aggregates and returns INV_SUMMARY_ACK, and the home finalizes the directory entry and grants exclusivity, consistent with the base MF-TLP coherence flow.

The steady-state cache-hit flow operates efficiently for subsequent writes, where the home emits INV with SCK. The ToR's SC-Lookup hits, replicates immediately at line rate, and returns INV_SUMMARY_ACK, with no per-event sharer list serialization occurring at the home MC-NIC. When RLD-assisted validation is optionally employed, if a version or epoch mismatch is detected or the SC misses, the ToR queries the RLD for the authoritative local sharer set, updates the SC, and proceeds to replicate, providing precise fan-out while keeping the home MC-NIC's fan-out constant in the rack count.

In failure and fallback scenarios, if the ToR cannot assemble an NV_SUMMARY_ACK within a timeout due to conditions such as a port failure, it returns a summary with errors, and the home may fall back to per-node INVs or a re-probe via the RLD for that rack. The directory still requires acknowledgement before granting exclusive ownership, as in the baseline design.

The header formats and correctness hooks ensure proper operation across the system. The upstream INV retains the MF-TLP coherence metadata including line tag and state bits, and Transaction ID so that replicated INVs and the aggregated ACK are correlated with the correct directory transaction, matching MF-TLP's design for routable, correlatable requests and responses. For governance and isolation, packets also carry Tenant ID and priority per the MF-TLP header, with the ToR enforcing tenant isolation by replicating only to nodes authorized for that tenant/domain and by shaping replication with the same QoS semantics used elsewhere in the fabric. Cross-layer signaling ensures that if replication would momentarily exceed egress capacity, the ToR can apply backpressure and schedule the replicated INVs using transport feedback, consistent with MF-TLP's cross-layer signaling such as transport backpressure throttling high-fan-out coherence bursts.

The data structures and sizing in one embodiment include a Sharer Cache (SC) with 32k entries, 4-way set associative, 32 bytes per entry totaling approximately 1 MB SRAM. Each entry stores a port bitmap, for example 64 ports requiring 8 bytes, epoch requiring 2 bytes, TTL requiring 2 bytes, stats requiring 4 bytes, and key requiring 16 bytes as truncated hash plus home ID. Replacement uses SRRIP or LRU algorithms, with a small negative cache for “no sharers” avoiding pointless replications on cold lines. The aggregator table maintains 4 to 8k in-flight INV contexts with Transaction ID, bitmap_pending, and expiry fields, implemented in a modest BRAM/SRAM. Timers ensure per-entry TTL decays on each epoch tick or microsecond timer, with the entry becoming invalid on expiry. These structures are conventional and implementable in modern programmable or fixed-function switches while preserving the extensible header and ordered-lane constraints of MF-TLP.

The system provides sophisticated interactions with other MF-TLP features. When integrated with hierarchical directories and domains, SSR-IR composes with rack-local directories and coherence domains, where the DomainMap or probabilistic rack filters identify which racks to notify, and ToRs within those racks perform precise replication to local nodes, preserving hierarchical scaling while reducing home-side serialization. For vectorized transactions, when a write upgrade covers multiple lines such as a vector grant of exclusivity across adjacent cache lines, the home may issue one INV per rack per vector segment with a single SCK, allowing the ToR to burst-replicate to all local nodes. The vector descriptor remains in the packet for data operations, with the ToR only interpreting the coherence header portion for invalidations. The presence of switch-resident logic for in-network compute is already contemplated for reductions, and SSR-IR represents an orthogonal assist that does not transform payload data but replicates coherence control and merges acknowledgements, both at the transaction layer.

SSR-IR preserves the baseline directory invariants whereby the home grants exclusivity only after receiving an ACK from each targeted rack as INV_SUMMARY_ACK, which itself represents complete per-node invalidations in that rack. All such control traffic runs on ordered transport streams, and the ToR's aggregation therefore cannot reorder invalidation relative to the grant, maintaining sequential or release consistency per MF-TLP. False replication, such as from a stale SC entry, is benign whereby non-sharer nodes respond with no-op ACK, while actual sharers are still invalidated due to the conservative list or RLD validation, and a miss or epoch mismatch triggers SLS refresh or RLD lookup before replication.

Failure handling and recovery mechanisms ensure robust operation. For cache staleness, if INV_SUMMARY_ACK signals missing_count greater than 0 or an epoch mismatch, the home sends a follow-on INV with SLS for refresh or addresses nodes individually, with the ToR updating its SC entry. Port or node failure causes a per-rack timeout that causes the ToR to set error bits and return early, with the home engaging standard recovery such as fencing the line or quiescing or revoking the domain. Switch failover scenarios where the ToR reboots result in an empty SC, with the first post-reboot INV including SLS to repopulate. Security is maintained as the ToR verifies Tenant ID and domain against an access table before replication, with unauthorized ports being masked from port_bitmap.

Performance considerations demonstrate the scalability benefits where S represents sharers per rack and R* represents the number of racks with sharers. Baseline home-side fan-out is O of the sum of S_r equal to O of S times R* INV packets. SSR-IR reduces that to O of R* upstream INVs, one per rack, plus O of S_r local replications inside each ToR. The home's serialization cost scales with R* rather than S, and ACK traffic upstream collapses from the sum of S_r to R* via INV_SUMMARY_ACK. Cross-layer backpressure prevents bursts from overloading egress.

Alternative embodiments provide additional implementation flexibility. Spine-level fan-out enables a spine switch to cache multi-rack sharer sets as the union of ToR bitmaps and issue multicast branches to multiple ToRs, each of which performs local replication and ACK merge, forming a two-tier replication tree. Negative caches allow ToRs to maintain short-lived “no local sharers” entries to avoid unnecessary replication on cold lines. CDID-aware caching incorporates Coherence-Domain ID in the SCK, with DomainMap flips migrating an entry across domains by copying or invalidating the SC entry on domain change. Programmable parsing enables the ToR parser to be microsequenced to recognize future MF-TLP opcodes and headers without replacing silicon.

The implementation details for enablement include specific switch pipeline enhancements. The ToR's ingress pipeline adds an MF-TLP parser stage, a SC lookup stage using single-cycle SRAM, and a replicator that clones frames to the port_bitmap with per-clone destination rewrites. The ACK aggregator keeps an in-flight context keyed by Transaction ID, with each local INV_ACK clearing a bit in bitmap_.pending. When bitmap_pending equals 0 or timeout occurs, the ToR emits INV_SUMMARY_ACK upstream with a compact status. Extension headers are consumed at the ToR, and the replicated INV packets presented to hosts carry only the standard coherence header fields they already parse. The presence of extension headers that switches can interpret and act upon is expressly contemplated in the MF-TLP packet format.

Home MC-NIC changes include a tree-selector that groups sharers by rack and emits one INV per rack, preferring SCK when an entry is hot and falling back to SLS on first touch, epoch change, or error. The MC-NIC's scheduler continues to run coherence traffic on ordered lanes and correlates INV_SUMMARY_ACK to outstanding transactions before granting exclusivity, as in the baseline directory flow.

SSR-IR cuts invalidation serialization at the home MC-NIC, reduces upstream ACK traffic, and exploits rack-locality, all without altering transport MAC/TCP or relying on host CPUs. Unlike bus-centric coherency or device-to-device snooping, it operates at a routable transaction layer with switch-enforced replication and merge semantics keyed by MF-TLP headers and extension fields. The embodiment is transport-agnostic supporting UET/IB/RDMA, leverages extension headers designed for in-network hints, and composes with vector operations, atomics, and hierarchical directories previously described. This switch-resident embodiment is fully enabled by MF-TLP's routable, extensible packet structure, directory-driven invalidation flows, ordered transport for coherence control, and the architecture's allowance for intermediate switch participation in transaction execution. It supports claim language directed to a top-of-rack switch that caches sharer lists and replicates MF-TLP invalidations at line rate, returning a single merged acknowledgement upstream.

In further embodiments, the Memory-Fabric Transaction Layer Protocol (MF-TLP) introduces a fused multi-operation transaction implemented as a Gather-Reduce-Scatter (GRS) packet that expresses, in a single routable request, a gather of N operands from arbitrary addresses including contiguous, strided, or index-listed addresses, an in-NIC reduction over those operands using a typed, programmable reduction operator such as integer/floating-point sum, min, max, saturated add, dot-product, or mixed-precision accumulation including FP8/bfloat16, and a coherent scatter of one or more reduced results to one or more target addresses. The home memory-side MC-NIC parses the fused operation, expands the vector descriptors into memory micro-operations, streams fetched values into a pipelined ALU/reduction engine, and then commits the reduced results with directory-consistent writes while amortizing coherence control via batched invalidation/update flows. This embodiment generalizes the vector descriptor and in-network reduction capabilities of MF-TLP into a single, typed, chain-encoded transaction, reducing packet overhead, fabric hops, and control-plane chatter compared to issuing separate gather, atomic, and scatter verbs. The implementation leverages MF-TLP's extensible header, vector descriptors, in-NIC atomic/reduction logic, and directory-based coherence already disclosed.

The packet structure and encodings employ a sophisticated Fused-Op Chain extension. GRS uses the MF-TLP extension-header facility to encode a Fused-Op Chain (FOC) immediately following the base header. The FOC carries three segments, specifically GATHER leading to REDUCE leading to SCATTER, with each segment containing compact, typed subfields parsable at line rate by the MC-NIC parser. The base header continues to include the opcode, Transaction ID, addressing/vector descriptors, tenant/QoS, and coherence metadata, as in prior sections.

The FOC.GATHER segment comprises fields including g_mode as 3 bits, base as 64 bits, count as 20 bits, stride as 32 bits or alternatively list_len as 20 bits with list_base as 64 bits, index_fmt as 2 bits where 0 represents offset32, 1 represents offset64, 2 represents addr64, and 3 represents seg+off, elem_type as 5 bits supporting i8, i16, i32, i64, fp16, bf16, fp32, fp64, and fp8 in e4m3/e5m2 formats, align as 3 bits, and flags as 7 bits. The g_mode field selects strided, indexed-by-offset, or explicit address gather, whereby the vector descriptor field 316 is thus generalized to support non-contiguous scatter/gather in a single transaction, consistent with MF-TLP's vector semantics.

The FOC.REDUCE segment comprises r_opcode as 6 bits supporting SUM, MIN, MAX, DOT, AMAX, L2, and other operations, r_assoc as 1 bit and r_comm as 1 bit representing algebraic properties, acc_type as 5 bits specifying accumulator precision such as fp32 for fp8 inputs, k_segments as 16 bits for segmented/partitioned reduction groups, neutral as 64 bits providing an optional identity value, scale as 16 bits, shift as 6 bits, sat as 1 bit, rnd as 2 bits for mixed-precision controls, and ufunc_id as 10 bits for programmable UFUNC slot selection. The accumulator precision may exceed input precision, for example fp8 to fp32 conversion, with scale/shift/saturate/round controls to implement quantization or numerically robust summation. The ufunc_id enables a user-defined reduction path via the in-NIC compute slot, while r_assoc and r_comm allow the NIC to pipeline and reorder safely.

The FOC.SCATTER segment comprises s_mode as 3 bits, base as 64 bits, count as 20 bits, stride as 32 bits or alternatively list_len as 20 bits with list_base as 64 bits, result_layout as 3 bits supporting SINGLE, PER-SEGMENT, or PER-BLOCK options, coherence as 3 bits supporting write-noalloc, write-through, or exclusive modes, ppcc as 3 bits, and cdid as 12 bits. The result layout field allows one reduced scalar for SINGLE mode, k-segment output for group-by operations, or per-block outputs for block-reduce operations. The coherence and PPCC/CDID bits are honored during the scatter phase as described elsewhere for per-packet consistency and domain scoping.

For typed payload handling, indexed gather operations may include compressed index vectors in the request payload, while for DOT and other operators, an auxiliary operand vector may be included such as a second multiplicand. Reduction constants including neutral/identity values reside in the REDUCE fields. The response may return final results if requested and a status bitmap.

The MC-NIC execution pipeline for enablement reuses and extends the MC-NIC blocks 410/420/430/440/450/460, specifically the parser, memory access, coherence directory interface, atomic/reduction engine, scheduler/QoS, and fabric interface previously described. The GRS fast-path operates through multiple stages beginning with parse and plan operations where the protocol parsing engine 410 decodes the FOC and vector descriptors, building an execution plan comprising a list of gather micro-operations, an ALU program for the reduction engine 440, and a set of scatter destinations with coherence attributes.

During gather expansion and prefetch, the memory access unit 420 expands the gather into micro-reads, optionally coalescing addresses by cache line to minimize transactions. Address translation and alignment are handled per MF-TLP's virtualization/translation path, with reads streaming into the reduction engine through a flow-controlled FIFO. The pipelined reduction phase employs the atomic/reduction logic 440 to execute the selected r_opcode using a widened accumulator of acc_type and programmable scale/shift/sat/md parameters, supporting mixed-precision operations such as accumulating fp8 in fp32 then quantizing to fp16 or bf16. Where algebraic properties permit, the engine performs tree-style accumulation and segment boundaries for k_segments by zero-cost marker tokens. The ufunc_id diverts streams through a UFUNC slot when non-builtin operators are requested.

The coherent scatter with batched directory updates involves the coherence interface 430 grouping scatter destinations by cache line and rack/domain, then issuing domain-scoped invalidation/update messages on ordered lanes for each unique line requiring exclusivity or write-through, batching sharer lookups and acknowledgement aggregation. Only after the required acknowledgements are observed does the memory access unit commit the reduced results to memory as write-no-allocate, write-through, or exclusive per coherence specifications. Upon completion, the NIC returns result values if requested, a per-element status bitmap optionally, and any directory outcome codes such as retry-suggested indications. The scheduler/QoS 450 ensures coherence control retains priority over bulk streaming, consistent with MF-TLP governance.

The operational semantics and memory model ensure proper linearizability and visibility. Each destination cache line updated by the scatter is linearized at the home NIC when the corresponding coherence control completes on ordered transport with invalidations/updates acknowledged, consistent with MF-TLP's directory flow. The GRS completion is not exposed to the requester until all addressed lines meet their PPCC obligations for SC/TSO/RC consistency. Atomicity granularity provides element-wise atomicity with respect to other memory and atomic operations to the same destination address, while programs requiring all-or-nothing semantics across multiple outputs may request transactional scatter at the cost of potential rollback/retry under conflict. Consistency class and domain scope are managed through per-packet PPCC and CDID in the SCATTER segment directing lane binding and domain scoping, such as SC on ordered streams, RC with acquire/release fences at packet boundaries, and TSO with NIC-enforced store ordering. Out-of-domain reads produced by GRS for validation may utilize version tags/leases as described elsewhere.

Coherence traffic minimization is achieved through multiple mechanisms. For rack/domain batching, prior to the scatter, the NIC compacts destination addresses by cache line and groups them by coherence domain, then issues one rack-scoped invalidation per line/domain and aggregates acknowledgements, leveraging MF-TLP's directory-driven invalidation and ordered-lane completion semantics. Switch assist optionally enables deployments with switch-resident replication such as ToR sharer replication/ACK merge to further reduce home-side fan-out, whereby the NIC emits a single rack-scoped INV per line and the ToR handles local replication/acknowledgement merge before the NIC commits the write, utilizing the switch-interpretable extension headers already contemplated by the MF-TLP format.

Advanced features provide sophisticated enablement details for various use cases. Segmented reductions where k_segments exceeds 1 enable GRS to perform multiple independent reductions in a single packet, for example group-by aggregation where k disjoint key-sets are reduced concurrently. The segment stream interleaves gather values with segment markers, the reduction engine maintains k accumulators, and emits k results with result_layout equal to PER-SEGMENT. Mixed precision and quantization support allows inputs to be low precision including INT8, FP8 e4m3/e5m2, or BF16, with the accumulator running in higher precision such as FP32, followed by post-scale/round/saturate operations before scatter. These controls reside in REDUCE fields and are executed by the reduction pipeline to minimize numeric error and store bandwidth.

DOT and AXPY fusion capabilities enable r_opcode equal to DOT to request fused multiply-accumulate over two gather streams, while AXPY operations computing y equals alpha times x plus y are realized by DOT over x and alpha with scatter accumulated into y. The NIC performs coherent read-modify-write on destination lines via the directory flow. Failure-atomic completion and status reporting allow the NIC to return a status bitmap indicating per-element or per-segment success, protection faults, or retry suggestions. A transactional scatter option as a bit in coherence requires all destinations to be prepared with coherence ready before any write, and if not, the NIC defers/rolls back and returns a RETRY completion with conflict hints, compatible with MF-TLP's multi-operation semantics. For vectorization limits and chunking, when handling very large gathers, the NIC may chunk the operation into windows of W elements, returning a single completion when all chunks commit, with the scheduler 450 interleaving chunks with higher-priority coherence and tenant traffic.

Example flows demonstrate practical applications of the GRS functionality. For distributed ML gradient aggregation, multiple compute nodes send GRS packets targeting parameter shards at memory nodes, using GATHER to collect embedding-index gradients across discontiguous slots, REDUCE with mixed-precision SUM converting fp8 to fp32, and SCATTER to write reduced shards into parameter memory with write-through so downstream trainers observe coherent updates. Ordered-lane coherence ensures visibility before the next training step. For database group-by operations, a query worker issues GRS with k_segments equal to the number of groups mapped to a memory shard, using GATHER to collect source measures per row, REDUCE to compute SUM/MIN/MAX per segment, and SCATTER to write results into a compact per-group table. Coherence batching prevents eviction storms when many workers reduce into the same rack-local shard. For graph analytics frontier reduction, a GRS AMAX operator computes next-frontier priorities by using GATHER to collect neighbor weights, REDUCE to compute maximum values, and SCATTER to write a single priority per vertex. The NIC linearizes per-vertex writes via ordered coherence messages to sharers in the domain.

Transport binding and governance provide proper traffic management. For ordered versus elastic lanes, coherence control and SC-class scatter commits ride ordered transport streams such as UET/IB ordered classes, while bulk gather reads and intermediate ALU streaming can utilize elastic streams with replay where permitted by PPCC. The scheduler/QoS and multi-tenant isolation mechanisms ensure the scheduler 450 enforces tenant quotas and prioritizes coherence and SC completions over bulk gathers, with Tenant ID from the MF-TLP header governing access-control to source/destination regions.

Correctness and progress guarantees ensure proper system operation. Coherence safety is maintained as directory-consistent invalidation/update flows precede the visibility of scatter writes, with GRS not exposing a reduced result until all targeted lines meet coherence preconditions. Forward progress is ensured under contention, where the NIC may split GRS across line conflict classes and serialize per-line updates while keeping the ALU busy, guaranteeing eventual completion. Idempotence is provided through a nonce in the base header, allowing in-NIC replay suppression in the presence of transport retries.

Alternative embodiments provide additional implementation flexibility. Tree-structured in-fabric reduction enables switches to perform partial reductions on GRS streams for associative/commutative operations before forwarding to the home NIC, which completes scatter, with extension headers set by the NIC marking reduction-eligible payloads. Segment-tree and block-reduce forms allow GRS to encode block sizes so the NIC performs blockwise reductions such as L2 norms per block and scatters per-block outputs. Compression-aware GRS includes a pre-ALU dequantizer that maps INT8/FP8 inputs to FP16/FP32 accumulators, with a post-ALU quantizer applying user-selected rounding and saturation before scatter as per REDUCE controls.

The implementation details for the micro-architecture include a sophisticated reduction engine implemented as a deeply pipelined ALU with widened accumulators, segment tracking using small SRAM of k accumulators, a scale/shift/sat stage, and an optional UFUNC slot. The engine accepts one value per cycle at line rate for small types such as i8/fp8, with internal widening to fp32 for numeric operations. Directory interaction is managed through the coherence interface 430 exposing a batch API with prepare operations on lines arrays returning acknowledgements, followed by commit operations on lines arrays. This interface folds multiple scatter targets per rack into one invalidation wave and consumes INV_ACK/summary-ACK before enabling the memory-write stage. The parser and fabric interface components ensure the parser 410 micro-sequences the FOC, while the fabric interface 460 binds SC control to ordered streams and applies link framing and error codes per MF-TLP norms.

The GRS architecture provides significant advantages by collapsing gather, reduce, and scatter operations into a single MF-TLP transaction that executes in-NIC and coherently, resulting in fewer packets, fewer round trips, and no remote CPU involvement in coherence, while supporting typed, mixed-precision reductions with vector-grade addressing. Neither RDMA nor CXL nor NVLink FAM teaches a single-packet gather-reduce-scatter with integrated directory semantics at a routable transaction layer, making this embodiment distinctly novel. This long-form embodiment is fully enabled by the MF-TLP header extensibility, vector descriptors, in-NIC atomic/reduction engines, directory-based coherence flows, the scheduler/QoS pipeline, and ordered transport binding already disclosed in the specification, and supports future claims to an MF-TLP packet encoding a chained gather-reduce-scatter executed in-NIC with coherence.

In further embodiments, the coherent memory fabric introduces a User-Defined Function (UFUNC) facility that enables tenants to deploy typed, sandboxed micro-programs into memory-centric NICs (MC-NICs) and, where provisioned, MF-TLP-aware switches, to perform custom reductions and element-wise transforms directly on MF-TLP vector streams. UFUNCs are carried, referenced, and governed entirely at the transaction layer using MF-TLP extension headers, thereby remaining transport-agnostic and preserving routability across the fabric. The MC-NIC validates and attests UFUNC bytecode against a declared type signature and explicit resource caps, executes it in a time-sliced engine under scheduler-enforced tenant quotas, and commits results with directory-consistent coherence ordering on ordered transport lanes, as already provided for reductions and control traffic in MF-TLP.

The packet-level interface employs a UFUNC extension header whereby MF-TLP request packets may carry one or more extension headers between the base header and payload, with prior sections already teaching the use of extension headers for replication hints and application annotations. UFUNC reuses this facility to introduce a UFUNC header containing fields including FuncID, CodeHash, TypeSig, ResourceCap, Flags, and Nonce. The header may accompany vector, fused such as GRS, or atomic-reduce opcodes, with intermediate switches and MC-NICs parsing it at line rate alongside the MF-TLP opcode, vector descriptors, tenant/QoS tags, and coherence metadata. The FuncID uniquely names a previously installed UFUNC instance in the device's code cache. The CodeHash comprises a cryptographic digest of the UFUNC bytecode or micro-operation bundle, whereby when non-zero, it binds the transaction to a measured image. The TypeSig encodes the operator's typed interface, including input types such as fp8 e4m3, accumulator types such as fp32, output types such as bf16, segmenting parameters, and neutral element specifications, allowing the NIC to enforce shape and type safety. The ResourceCap declares upper bounds for per-packet cycles, scratch bytes, and outstanding contexts, enabling scheduler admission and time-slicing. The Flags field includes determinism and fence-awareness bits so the NIC can integrate PPCC/ordered-lane semantics. The Nonce participates in idempotent replay suppression with the MF-TLP Transaction ID.

The control verbs for UFUNC define control-plane MF-TLP verbs including UFUNC_LOAD for installing code plus metadata and returning a device-local FuncID, UFUNC_QUERY for capabilities inquiry, and UFUNC_EVICT for removal. These are implemented as ordinary MF-TLP packets using the same header/payload structure already described for semantic control, routed to the target device's management endpoint.

The program representation and typing employ sophisticated mechanisms for safe execution. The UFUNC ISA/bytecode is encoded as a compact, RISC-like micro-operation stream or eBPF-like bytecode over a fixed register file with deterministic, bounded execution. Instruction classes include arithmetic and logic operations on scalar lanes, mixed-precision accumulate operations such as fp8 to fp32 conversion with scale/shift/saturate parameters, comparisons and clamps, reduction combiners that are associative/commutative or explicitly ordered, and data movement to and from a small scratch window. Loops are bounded by immediate limits validated at load time, with recursion and unstructured jumps being disallowed. The ISA is purposely side-effect constrained whereby UFUNCs may not issue arbitrary loads or stores into fabric memory, but operate on values streamed by the vector/gather front-end and deliver results to the scatter/commit back-end. This model aligns with the existing MF-TLP pipeline that feeds operands to in-NIC reduction logic and then commits results under directory control.

The type system captures comprehensive typing information through TypeSig, which includes input element type, accumulator type, output type, optional segmentation K, neutral element, and rounding/saturation rules. For example, a specification of input equal to fp8 e4m3, accumulator equal to fp32, output equal to bf16, round equal to rtne, and saturation equal to on directs widening in the ALU and post-quantization on commit, representing capabilities already contemplated for typed reductions in the MF-TLP reduction/atomic block. The MC-NIC rejects packets where the vector descriptor's element type or segment parameters do not unify with TypeSig.

Device-side attestation, validation, and caching provide security and performance optimization. During load and attestation operations, on UFUNC_LOAD, the MC-NIC's parsing engine ingests the code object and metadata, computes CodeHash, and compares it to signed metadata including provider/tenant certificate, installing only on success. The code is bound to a TenantID present in the MF-TLP header and a governance policy in scheduler 450, enabling per-tenant quotas and priority boosting for coherence traffic relative to bulk streams as earlier disclosed.

The code cache stores validated UFUNCs with LFU/LRU eviction, with the cache index comprising FuncID plus version CodeHash. When a subsequent data packet references a known FuncID, loading is elided, otherwise the NIC refuses execution and may request reload. Safety checks are enforced through a static verifier that ensures no unbounded loops, no uninitialized reads, no memory access outside the scratch window, determinism through no wall-clock or RNG access, and type compatibility with TypeSig. These properties guarantee replay safety with MF-TLP's Transaction ID semantics and ordered completion rules.

The execution pipeline and ordering integrate seamlessly with existing MC-NIC architecture. The placement in MC-NIC positions the UFUNC execution unit alongside the existing atomic/reduction logic in block 440, accepting a stream of values from the memory access unit 420 through the gather/vector expander via a flow-controlled FIFO. Its outputs feed the coherence directory interface 430 and commit path. The protocol parser 410 configures the UFUNC unit per packet by selecting FuncID, binding TypeSig, and setting segmentation, while scheduler 450 enforces per-tenant budgets and binds control traffic to ordered lanes. This mirrors the MC-NIC decomposition already disclosed through blocks 410/420/430/440/450/460.

Fences and PPCC integration ensure UFUNC honors per-packet consistency classes by running under a fence-aware micro-sequencer. For SC requests, the UFUNC completion is withheld until all directory actions and ordered-lane acknowledgements retire, while for RC, REL and ACQ edges are mapped to replay-queue quiescence and admission, respectively. This leverages the fabric's ordered transport classes and cross-layer signaling previously taught. Integration with vectors and GRS allows a UFUNC to be referenced by a vector, multi-operation, or GRS packet, whereby the front-end expands gather addresses defined by descriptor 316, streams N elements into the UFUNC, and the back-end scatters per-segment or per-block outputs. The UFUNC thus generalizes fixed reductions into programmable reductions/transforms while preserving the one-packet semantics of vectorized transactions.

Resource governance and progress mechanisms ensure fair and efficient execution. Time-slicing and preemption ensure each UFUNC executes within a timeslice budget declared by ResourceCap. The UFUNC engine maintains preemptible contexts including program counter, registers, and scratch pointer, enabling fair multiplexing across tenants and latency-sensitive coherence control, as prioritized by scheduler 450. On budget exhaustion, the engine yields, and the scheduler may resume it later without violating packet ordering guarantees, with completion being withheld until all slices finish. Scratch and spill buffers are implemented as a bounded, device-local SRAM window whose size is limited by ResourceCap, with the verifier preventing aliasing into arbitrary memory, and only the commit path interacting with fabric memory under directory control. Backpressure and cross-layer signals ensure transport backpressure is propagated to the parser/scheduler, which may throttle new UFUNC admissions or chunk large vectors, exactly as contemplated for MF-TLP cross-layer control to avoid high-fan-out bursts.

Switch-resident UFUNC capabilities are optionally provided where permitted by silicon capabilities. Fabric switches such as ToR or spine switches may host a restricted UFUNC profile for stateless, associative/commutative transforms including partial sum, max, or quantize-then-sum operations. The switch uses the UFUNC extension header containing FuncID, CodeHash, and TypeSig to match a locally attested operator, and on hit, applies the operator in-flight and forwards the transformed stream toward the home NIC, which completes directory-consistent commits. This extends the prior teaching that in-network reduction logic may aggregate partial results in a switching element, now generalized to typed, attested operators.

Correctness and security properties ensure robust system operation through multiple guarantees. Coherence safety ensures UFUNC results are committed only after the directory interface has issued required invalidations/updates and received acknowledgements on ordered streams, preserving line-level linearization points as in the base protocol. Determinism and replay properties ensure UFUNCs are deterministic with respect to their inputs and TypeSig, with absence of time/RNG/syscalls ensuring that MF-TLP's Transaction ID plus Nonce model can suppress duplicates without semantic divergence. Isolation is maintained through execution bound to TenantID 318, with the scheduler 450 enforcing quotas and switches and NICs shaping per-tenant traffic using existing QoS mechanisms. Memory safety is ensured as no arbitrary fabric reads or writes are permitted, with UFUNCs operating only on streams supplied by the vector/gather unit and writing via the commit path that already enforces coherence metadata 319.

Exemplary UFUNCs demonstrate practical applications including mixed-precision sum/quantize operations where inputs of fp8 e4m3 accumulate to fp32 and output to bf16 with round-to-nearest-even and saturation controls in TypeSig. Top-K thresholding operations scan a segment, compute K-th order statistic in scratch, emit per-element mask and reduced sum for survivors, and scatter mask/result to typed destinations under directory control. Optimizer update operations similar to Adam combine gradient and momentum streams with bounded arithmetic and output two updated state vectors, with the UFUNC remaining pure and stateless across packets by consuming prior state via gather and emitting new state via scatter under the NIC's commit path.

Failure handling mechanisms provide robust error management. Verification failure scenarios where TypeSig mismatches, loop bounds exceed ResourceCap, or code fails attestation result in the device returning a typed UFUNC_NACK completion. Timeout and preemption conditions where the timeslice is exceeded yield UFUNC_RESUME status, with completions being withheld until all slices finish. Switch miss conditions where a switch lacks the referenced FuncID or CodeHash result in the packet being forwarded unchanged, with the home NIC executing the UFUNC or sending NACK, preserving correctness.

The implementation details for enablement include specific micro-architectural components. The UFUNC engine comprises a fetch/decode block, a 4 to 8-stage pipelined ALU with widened accumulators for mixed precision, a small register file, a scratch SRAM, and a context table for preemption. It shares the gather ingress with unit 420 and the commit/coherence egress with blocks 430/440, while the scheduler 450 arbitrates slices among tenants and gives precedence to coherence control over bulk UFUNC streams. Parser integration extends the protocol parsing engine 410 to recognize the UFUNC extension and to populate per-packet configuration registers by selecting FuncID, loading TypeSig fields, and setting segmentation. The parser microsequencer model in the MC-NIC already anticipates extensibility of header formats. Transport binding ensures UFUNC control including LOAD/EVICT/NACK/RESUME and coherence messages ride ordered streams such as UET/IB, while bulk operand fetches may use elastic classes with replay, per the cross-layer binding previously taught.

Alternative embodiments provide additional implementation flexibility. Capability-scoped UFUNCs allow devices to advertise UFUNC capability sets via UFUNC_QUERY, including supported types, scratch size, and maximum cycles, with packets potentially carrying fallback FuncIDs. Stateful UFUNC windows provide a constrained mode allowing ephemeral state across packets within a domain epoch, with state residing in device-local SRAM and being checkpointed or invalidated on epoch roll-over coordinated by the directory, preserving coherence semantics. Multi-device UFUNC trees enable associative UFUNCs to be split across switches for partial operations and the home NIC for final operations, leveraging the previously disclosed in-network reduction concept for hierarchical aggregation.

The UFUNC architecture advances the fabric from fixed-function reductions to programmable, safe, typed near-memory compute, expressed and governed at the MF-TLP transaction layer. It preserves routability, coherence, and multi-tenant governance by building atop existing extension headers, vector descriptors, directory flows, and ordered transports, and it composes with vector/GRS packets to collapse multi-stage dataflow into single-packet, in-NIC execution. Neither RDMA nor CXL nor GPU-centric NVLink fabrics teach typed, attested, per-tenant operators executed inside NICs/switches under a routable memory protocol with directory integration. This UFUNC embodiment is fully enabled by MF-TLP's extensible headers, vector and reduction semantics, MC-NIC functional decomposition, multi-tenant QoS, and ordered-transport coherence already set forth in the specification, and it supports claims directed to a typed, attested user-defined operator executed within a memory-centric NIC or switch under MF-TLP control with tenant QoS and directory-consistent ordering.

In additional embodiments, the Memory-Fabric Transaction Layer Protocol (MF-TLP) is extended with Fabric-Durable Coherence (FDC), a durability-aware coherence regime that unifies cache coherence ordering with persistence ordering for writes into persistent memory regions including PMEM/NVRAM/DAX regions hosted on memory nodes. In FDC, MF-TLP packets carry an explicit Persist Class that instructs a memory-side MC-NIC to perform the normal directory-based coherence sequence, drive media-level persistence through flush to the persistent domain before completion, and optionally coordinate a replicated mirrored durable commit across two or more memory nodes prior to acknowledging the operation to the requester. The MC-NIC realizes this by augmenting the existing parsing, memory-access, coherence, and scheduling pipeline comprising blocks 410/420/430/440/450/460 with a Persist Engine and a Replicated Commit Coordinator, while exploiting MF-TLP's routable, extensible header format, ordered transport binding for coherence/control, and Transaction-ID-based correlation. This produces transaction-layer durability semantics integrated with coherence, representing capabilities not taught by RDMA, CXL, or GPU-centric fabrics, and maps naturally onto persistent arrays such as PCM/ReRAM/MRAM or battery-backed NVDIMM already contemplated in the architecture.

The packet-level interface employs Persist-aware headers whereby MF-TLP admits extension headers between the base header 310 and payload 320, with FDC introducing a Persist extension containing multiple fields. The PersistClass (PC) field encodes durability intent for the request, with examples including PRelaxed for no extra durability action, PBarrier for durability fence for all prior writes in the same PersistGroup, PCommit where the addressed writes must be durable before completion, and PMirror with Quorum specification where commit must be durable on a replication set with quorum equal to 1, 2, or N. The PersistGroupID (PGID) groups related writes and fences into a durability epoch such as a WAL record or application transaction. The ResilienceGroupID (RGID) names a replication set of two or more memory nodes provisioned for mirrored durability. The Durability Sequence Number (DSN) comprises a monotone counter carried on responses to mark persisted order, whereby requesters may later request reads at least as durable as a specified DSN. The Flags field provides scope/domain selection and optional Return-upon-LocalDurable versus Return-upon-GlobalDurable policy specifications. These fields coexist with the standard opcode 312, address/vector 314/316, tenant/QoS 318, coherence metadata 319, and Transaction ID 311 used for correlation and replay-safe completion.

Control verbs for FDC define management operations including PERSIST_CAPS_QUERY whereby the device reports media and quorum capabilities, PGID_BEGIN/END for optional demarcation of durable epochs, and REPLICA_SET_UPDATE with RGID for administrative programming of mirrors, conveyed as MF-TLP control packets over the same routable framework.

The MC-NIC micro-architecture extensions for enablement include a Persist Engine within blocks 420/430. The memory access unit 420, already responsible for mapping MF-TLP writes into local memory operations, adds a Persist Engine that classifies target ranges as PMEM versus DRAM, enqueues PMEM flushes into a persist queue, and tracks per-PGID ordering. The coherence directory interface 430 is extended with a Durable-Commit FSM that couples directory acknowledgements with media flush acknowledgements before exposing completion on ordered streams. For persistent arrays, the write opcode may be mapped to a buffered commit into persistent memory arrays with explicit flush on fence/commit, as noted in the base description.

The Replicated Commit Coordinator (RCC) operates when RGID is set, whereby the home MC-NIC's 430 module acts as a two-phase commit coordinator across a replica MC-NIC set. The coordinator issues PREPARE-PERSIST control to each replica, awaits PREPARED responses indicating durable locally with per-replica DSN, then emits COMMIT or ABORT on failure. The coordinator aggregates replica outcomes and only then signals completion to the requester, integrating with the existing ordered transport treatment of coherence control. The scheduler/QoS integration in unit 450 prioritizes coherence and durability control over bulk traffic, admits persist work subject to tenant quotas, and can batch media flushes for the same PGID to amortize cost while preserving per-packet semantics.

The end-to-end operational semantics provide comprehensive durability guarantees. For single-node PCommit operations providing coherent plus durable semantics, a compute node issues a WRITE with opcode equal to WR, PC equal to PCommit, PGID equal to g, CDID equal to domain, and PPCC equal to SC. The home MC-NIC consults the directory, issues invalidation/update MF-TLP control to sharers on ordered transport, and awaits acknowledgements as in the baseline flow. After coherence acknowledgements, the Persist Engine programs the PMEM controller to flush to the persistent domain, and upon media-flush-ack, stamps a DSN. The NIC returns a completion carrying the DSN and PGID, with linearization occurring at the point both coherence acknowledgements and media durability are achieved.

PBarrier operations provide durability fence semantics whereby a FENCE with PC equal to PBarrier and PGID equal to g forces all prior writes in PGID g that have completed coherence to also reach durable media before the fence completes. The Persist Engine drains the persist queue up to the fence and returns a DSN_fence that can be used by readers to enforce a “read-at-least-as-durable-as” constraint. The fence runs on ordered lanes, reusing the transport binding used for coherence control.

Mirrored PCommit operations employ two-phase, quorum-based durability. For a WRITE with PC equal to PMirror with Quorum equal to 2 and RGID equal to R, the coordinator performs PREPARE-PERSIST to each replica MC-NIC in set R, with each replica performing local coherence, flushing to durable media, and replying PREPARED with DSN_i. Upon achieving quorum such as both replicas in a dual configuration, the coordinator sends COMMIT, causing replicas to mark the record durable, and the coordinator returns a single Durable-Ack with DSN equal to the maximum of DSN_i values. If a replica times out, policy selects ABORT to fail the operation or DEGRADED-COMMIT with policy signaling such as return-upon-local-durable. All control messages ride on ordered streams.

Read-durability constraints allow a reader to issue READ with MinDSN equal to x to require a value at least as durable as DSN equal to x. The home NIC may serve from local media if DSN of the line is greater than or equal to x, or delay completion until the line is replayed/applied from the durability log if recovery is in progress. The Transaction ID 311 still correlates request and response operations.

The directory, ordering, and correctness mechanisms ensure proper system operation. Coherence-to-durability ordering defines a per-line linearization point whereby a PCommit/PMirror completes after directory-driven invalidations/updates are acknowledged and the persist barrier for the affected lines is crossed through local media flush and, if replicated, quorum commit. MF-TLP already requires that coherence control use ordered transport classes, which FDC reuses to serialize control relative to data commits.

PPCC and domains interact with FDC such that SC writes with PCommit complete on ordered lanes only after durable acknowledgement, RC RELEASE with PBarrier ensures all prior PGID writes become durable before dependent operations issue, and out-of-domain readers may use Version/DSN validation prior to consuming data. When integrating with hierarchical directories and switch assists in racks employing rack-local directories (RLDs) or switch-resident replication, FDC remains unchanged whereby the home MC-NIC still waits for INV/ACK completion from the targeted domain, possibly aggregated by a ToR, before issuing the persist phase. The persist phase is never acknowledged early by the network, with only the media or replica MC-NICs able to assert durable completion.

Failure handling, idempotence, and recovery mechanisms ensure robust operation. Transaction ID and replay safety leverage the existing Transaction ID 311 and optional Nonce to allow idempotent retries. If an in-flight PCommit is retried after a fabric timeout, the home MC-NIC consults its Durability Log to determine whether the write was already PREPARED and/or COMMITTED, with duplicate execution being suppressed and exactly-once durable commit being preserved.

Crash recovery procedures ensure each memory node maintains a small replicated durability log indexed by PGID and Transaction ID in PMEM. On reboot, the node controller replays COMMIT-marked entries and discards ABORT/partial PREPARE entries, then reconstructs per-line DSN. The baseline architecture already includes persistent arrays and a node controller that manages allocation and directory tables, to which this log naturally attaches. For replica divergence and reconciliation, if a mirrored write commits on one replica but not the other due to coordinator failure after quorum, the recovering coordinator uses the Durability Log and DSN metadata to reconcile to the higher DSN, ensuring prefix-durability. Reads with MinDSN safeguard clients from observing values older than required durability.

Detailed flows demonstrate exemplary operations. For FDC single-line PCommit, the Parser 410 decodes PC equal to PCommit, the Coherence interface 430 issues invalidations to sharers and awaits acknowledgements on ordered transport, the Persist Engine in 420 requests media flush, on flush-ack 430 stamps DSN and returns Durable-Ack, and Scheduler 450 ensures this control path preempts bulk vectors as needed.

For mirrored vector PCommit with batching, when processing a vector scatter into PMEM with PC equal to PMirror with Quorum equal to 2, the MC-NIC coalesces destinations by cache line, runs per-line PREPARE-PERSIST on replicas in parallel, aggregates PREPARED responses with DSN_i values, issues COMMIT, and returns once quorum durability is achieved for every line. Failures produce a RETRY/DEGRADED status bitmap per line without violating linearizability.

For PBarrier with PPCC equal to RC, a producer issues streaming writes with RC semantics, then a FENCE with PC equal to PBarrier and PGID equal to g. The replay queues in the NIC used to enforce RC edges prevent subsequent dependent operations from issuing until the fence's Durable-Ack arrives, with the fence riding ordered lanes like other control messages.

Data structures and sizing in one embodiment include a Persist Queue with 4 to 16k entries per MC-NIC, storing address, line_tag, PGID, PC, and state fields, coalescing lines and tracking flush dependencies. The Durability Log comprises a circular PMEM region with records containing TID, PGID, address, line_tag, dsn, and stage fields, bounded in size since only PREPARE/COMMIT control is logged. The Replica Context Table maintains up to 4 to 8k concurrent two-phase contexts keyed by TID and RGID with quorum counters and timeouts. All structures integrate into the existing MC-NIC blocks and management plane already detailed for parsing, memory access, directory participation, and scheduling.

Interactions with existing MF-TLP features demonstrate comprehensive integration. For Vector and GRS transactions, the scatter phase of vector or GRS writes may carry PCommit/PMirror, causing the NIC to batch coherence plus persist per destination line before completion, reusing the vectorization semantics and batched directory updates. Tenant governance ensures Tenant tags 318 and scheduler 450 apply quotas to durability work such as throttling PMEM flush bandwidth per tenant without violating per-packet ordering guarantees. Cross-layer signaling allows transport backpressure to throttle PREPARE/COMMIT bursts, with MF-TLP already contemplating cross-layer signals for high-fan-out coherence throttling, which FDC leverages similarly.

FDC provides MF-TLP with transaction-layer durability semantics tightly coupled with directory-based coherence, including two-phase, quorum-based mirrored commit, while remaining routable and transport-agnostic. The approach eliminates ad-hoc host-side flushing protocols, exposes per-packet durability to applications for DAX/WAL/metadata updates, and enables exactly-once durable updates under failures using the existing Transaction ID machinery and device-side logs. None of the prior fabrics described in the base document teach durability-aware MF-TLP with atomic mirrored commit at the transaction layer. This long-form embodiment is fully enabled by the MF-TLP extensible header, MC-NIC functional decomposition through parser 410, memory access 420, directory interface 430, atomic/reduction 440, scheduler 450, and fabric 460, directory-based coherence with ordered transport, and the persistent memory arrays already contemplated in the base disclosure. It supports claim language directed to a durability-aware MF-TLP transaction executed by a memory-centric NIC that integrates directory coherence with media-level persistence and optional mirrored two-phase commit prior to completion.

In further embodiments, the Memory-Fabric Transaction Layer Protocol (MF-TLP) introduces capability-tagged memory access enforced per packet at the memory-centric NIC (MC-NIC). Each MF-TLP transaction carries in cleartext for routing the existing TenantID 318, opcode 312, address/vector descriptors 314/316, coherence metadata 319, and Transaction ID 311, while a new Capability Token (CapToken) extension authenticates the request and, when enabled, provides inline AEAD such as AES-GCM for payload confidentiality and integrity. The MC-NIC validates the CapToken against a per-tenant capability table, derives or selects the associated crypto context, authenticates Additional Authenticated Data (AAD) bound to the MF-TLP header fields, and decrypts/encrypts the payload at line rate before any memory access or directory side effects occur. Admission and steady-state execution are governed by the existing scheduler/QoS unit 450 using TenantID for per-tenant rate and latency SLOs, while the address translation unit (ATU) 118 applies per-tenant address maps to restrict access to authorized regions. This security path operates entirely at the transaction layer using MF-TLP extension headers, preserving routability and compatibility with ordered transports and directory coherence already disclosed.

The packet-level interface employs a CapToken extension header whereby MF-TLP allows extension headers to carry optional, switch/NIC-interpretable metadata. The system defines a CapToken header placed between the base header 310 and payload 320, structured with CapID as 24 bits indexing per-tenant capability context, KeyEpoch as 8 bits providing short epoch/version for rekey and policy rotation, IV as 96 bits serving as AEAD per-packet IV such as GCM nonce either derived or explicit, MAC as 128 bits providing AEAD tag such as GCM tag authenticating AAD plus ciphertext, PolicyHash as 128 bits optionally containing hash of canonical capability policy snapshot, and Flags as 8 bits specifying AUTH_ONLY, CONF_ONLY, AEAD_AESGCM, AEAD_CHACHA, and other options.

The AAD for the AEAD computation binds immutable MF-TLP header fields including opcode 312, address/descriptor 314/316, TenantID 318, coherence metadata 319, Transaction ID 311, and selected governance bits, so that intermediates can route the packet in clear, yet any tampering is detected when the NIC authenticates the CapToken. Payload bytes including operands, write data, and vector bodies are AEAD-protected, while headers remain visible but integrity-bound.

The capability semantics define that CapID indexes a per-tenant capability entry that enumerates permitted opcodes including read/write/atomic/GRS/UFUNC, address ACLs as ranges, pages, or objects enforced via the ATU 118, vector bounds including maximum list length and stride, coherence/consistency permissions such as SC versus RC class use, and crypto mode specifying AUTH-only versus CONF+AUTH and key size. Packets whose descriptors or header fields do not unify with the installed capability are refused without side effects. Control verbs for management operations include CAP_LOAD, CAP_UPDATE, and CAP_EVICT that install or rotate capability entries and keys, returning device-local CapID handles. These use the same control-plane framing and extension header mechanism previously taught for semantic controls.

The MC-NIC micro-architecture for enablement places capability enforcement within the MF-TLP pipeline. Referring to the MC-NIC functional decomposition comprising parser 410, memory access 420, coherence interface 430, atomic/reduction 440, scheduler/QoS 450, and fabric I/O 460, capability enforcement is implemented by a Capability & Crypto Gate (CCG) inserted between 410 and the rest of the pipeline. The parser 410 recognizes the CapToken extension, extracts CapID/KeyEpoch/IV/MAC/Flags, and constructs the AAD from the base header fields already parsed including opcode 312, address/316, TenantID 318, coherence 319, and Transaction ID 311. The CCG consults a per-tenant CapTable, authenticates and decrypts if enabled using the inline AEAD engine, and only then emits micro-operations to 420/430/440. If authentication fails or the capability policy disallows the operation, the packet is dropped and a typed AUTH_NACK completion is returned, with no directory traffic or memory touch occurring prior to success.

The CapTable and ATU coupling ensures comprehensive access control. Each CapTable entry indexed by CapID contains TenantID, KeyEpoch, KeyHandle, Policy, AddrACLs, PermMask, VecBounds, UFUNCMask, and a GHASH precompute for AES-GCM to accelerate tag verification. After authentication, the ATU 118 enforces AddrACLs when translating fabric addresses to local memory, with requests failing ACL checks being rejected. This couples cryptographic identity to address translation cleanly within the MC-NIC.

The AEAD datapath implements high-performance cryptographic operations through an inline crypto block supporting AES-GCM-128/256 and optional ChaCha20-Poly1305 with a dual-lane GHASH pipeline and a streaming CTR or ChaCha core sized to the NIC's line rate. The engine consumes the AAD from parsed headers, authenticates and decrypts the payload into a secure FIFO feeding 420/440, and re-encrypts response payloads toward 460 using a fresh IV. Control and coherence packets usually carry no ciphertext, with their integrity still bound via AAD when AUTH_ONLY is set. The existing scheduler/QoS unit 450 admits capability-validated transactions and enforces per-tenant quotas for bandwidth/IOPS/latency, honoring the TenantID 318 field already present in the header. Crypto work is prioritized beneath coherence control but above bulk streams, aligning with prior governance disclosures.

Keys, nonces, and replay protection mechanisms ensure cryptographic security. The key hierarchy and rotation system provisions per-tenant root keys into a secure element on the MC-NIC at CAP_LOAD. The NIC derives per-capability session keys using TenantRoot, CapID, and KeyEpoch, and rotates keys on CAP_UPDATE without disrupting in-flight transactions as capabilities carry KeyEpoch. Keys are zeroized on CAP_EVICT. IV construction and uniqueness are maintained whereby the IV nonce for AEAD may be explicit in CapToken or derived from CapID, KeyEpoch, TransactionID 311, and packet sequence, ensuring uniqueness even under vectorized or multi-operation flows. The CCG implements a per-capability sliding window to reject replayed IV and MAC pairs, keyed by CapID and KeyEpoch. AAD binding includes the immutable header fields comprising opcode 312, address/descriptor 314/316, TenantID 318, coherence metadata 319, and Transaction ID 311, so that intermediates cannot alter semantics such as addresses or coherence scope without voiding the MAC at the home NIC.

The operational semantics provide comprehensive security across all operation types. For the read path with AUTH_ONLY, the NIC authenticates header fields through AAD and returns plaintext data, while with CONF+AUTH, the NIC authenticates and then encrypts the response payload before transmission. Coherence metadata remains clear but secured via AAD, preserving directory participation. For write, vector, atomic, and fused operations carrying ciphertext payloads, the NIC authenticates and decrypts into a secure FIFO, then executes the memory operation locally including in-NIC atomics/reductions and commits coherently per the base protocol. Vector descriptors 316 are header fields in AAD and thus unencrypted, with their integrity being protected. Scatter results in responses may be re-encrypted as required.

Coherence and ordering mechanisms maintain protocol correctness whereby coherence control including invalidations and updates still rides ordered transport classes, with capability validation occurring before any directory side effects. Because coherence metadata 319 participates in AAD, an adversary cannot widen or narrow the coherence scope without MAC failure. Domain and consistency interaction ensures per-packet consistency classes and domain IDs when used remain in clear and are bound by AAD. The NIC's fence/replay machinery therefore applies unchanged, with capability gates simply qualifying admission.

Switch interoperability and assists maintain fabric functionality while preserving security. For routing and replication, because the base header remains clear albeit MAC-bound, switches can route and, where provisioned, replicate coherence control per earlier switch-assist teachings without decrypting user payloads. Replication of ciphertext is safe, as only the home NIC or an attested UFUNC-capable device possesses keys to interpret payloads. Optional trusted in-switch compute allows that if a switch hosts UFUNC logic and is part of a trusted crypto domain, a CapToken scope flag may authorize the switch to use a delegated key handle for AEAD on specific flows such as associative in-network reductions. Otherwise, switches pass ciphertext unchanged, with UFUNC support and extension headers for in-fabric processing already being contemplated.

Failure handling and telemetry provide robust error management. AUTH_NACK responses are generated on MAC failure, capability mismatch, or ACL violation through ATU, whereby the MC-NIC returns a typed AUTH_NACK bound to Transaction ID 311, with no memory or directory mutations occurring. Replay detection ensures duplicate IV and MAC within the window are dropped and counted. Key epoch drift handling allows that if the CapToken carries a stale KeyEpoch, the NIC may accept under a grace window or require resubmission post CAP_UPDATE. Per-tenant counters ensure the scheduler/QoS exports per-tenant auth/crypto statistics to guide rate/SLO governance.

Data structures and sizing in one embodiment include a CapTable with 64K entries, each approximately 128 to 192 bytes containing CapID, TenantID, KeyEpoch, KeyHandle, PermMask, AddrACLs pointers, VecBounds, UFUNCMask, GHASH H precompute, and stats. The replay window comprises a per-CapID bitset or LRU window over IV and TID pairs, with size trading off false-positive rate versus SRAM. The key store implements small tamper-resistant RAM for per-tenant roots and session keys. The crypto pipeline provides two 128-bit lanes for GHASH and one or two counter lanes sized to NIC SERDES width. These blocks sit between 410 and 420/430/440 and reuse 450/460 for admission and egress.

Examples demonstrate practical applications of the security architecture. For a multi-tenant disaggregated database, a query engine in Tenant A issues a vector read with CONF+AUTH, whereby the NIC authenticates header fields including vector descriptor 316 and TenantID 318, decrypts response payloads for Tenant A only, and enforces address ACLs via ATU 118. Tenant B cannot forge access because the MAC binds AAD to Tenant A's headers and CapID. For encrypted GRS update operations, a trainer issues a GRS that carries encrypted gradient blocks, the NIC authenticates and decodes, performs in-NIC reduction 440, and commits coherently, with the completion payload being re-encrypted to the requester. Coherence directory flows through 430 on ordered lanes proceed only after successful authentication. For capability-scoped UFUNC operations, a UFUNC transformation is permitted only if UFUNCMask in the capability includes the referenced FuncID, otherwise the NIC returns AUTH_NACK, with UFUNC execution and attestation being described elsewhere and CTM-AIG binding invocation rights cryptographically.

Correctness and security properties ensure comprehensive protection through multiple guarantees. End-to-end integrity of semantics is maintained as the AEAD AAD covers opcode 312, address/descriptor 314/316, coherence metadata 319, TenantID 318, and Transaction ID 311, with any in-flight modification being detected at the home NIC. Pre-execution gating ensures no memory access through 420, atomic/reduction through 440, or coherence through 430 occurs before capability authentication, eliminating time-of-check/time-of-use races. Least privilege is enforced as ATU 118 enforces ACLs tied to CapID, preventing cross-tenant data exfiltration even with valid transport. Performance isolation is maintained as scheduler 450 governs crypto and memory work per TenantID for SLO adherence.

Alternative embodiments provide implementation flexibility including AEAD variants such as AES-GCM-SIV for nonce-misuse resistance or ChaCha20-Poly1305 for low-cost cores, negotiated in Flags. Header encryption subset options allow optionally encrypting coherence metadata or selected extension headers when intermediate switches need not interpret them. Attested in-switch decrypt capabilities allow for associative reductions at trusted ToR, provisioning a delegated CapID with scope restricted to specific opcodes and flows, with the home NIC retaining final commit control.

The implementation details for enablement include specific datapath timing whereby the parser 410 outputs AAD fields in the first cycles, the CCG begins GHASH on AAD while the payload arrives. With explicit IV, the counter stream starts once the first ciphertext block is received, while with derived IV, the CCG computes IV from CapID, KeyEpoch, and TID in parallel. A positive MAC check gates the memory access 420 micro-operations, while a negative check triggers fast-path AUTH_NACK generation. The scheduler 450 tags flows by TenantID to apply quotas, using the same governance hooks described for multi-tenant operation.

ATU coupling ensures that on success, the ATU 118 translates addresses only if they lie within AddrACLs, with vector descriptors 316 being expanded under the same guard whereby list elements are bounds-checked before issuing micro-reads/writes. The response path for CONF+AUTH encrypts the response payload with a fresh IV and MAC computed over the same AAD, now including response opcode/result header fields. The Transaction ID 311 again binds replay suppression on the requester side.

CTM-AIG moves isolation and confidentiality into the memory fabric's transaction layer, not merely at transport/VM boundaries. The architecture binds identity and policy to each packet via CapToken, authenticates the semantics of the operation through headers while encrypting data, couples cryptographic identity to address translation through ATU 118 and scheduler 450 governance, and preserves directory coherence and ordered-transport semantics without involving remote CPUs. Existing RDMA, CXL, or proprietary GPU fabrics do not teach per-packet capability authentication with inline AEAD integrated with a routable, coherent memory protocol as described herein. This long-form embodiment is fully enabled by MF-TLP's extensible headers, existing header fields including TenantID, vector descriptors, coherence metadata, and Transaction ID, the MC-NIC pipeline through 410/420/430/440/450/460, ATU 118, and the ordered transport binding already disclosed, and supports claims to capability-tagged, per-packet authenticated memory transactions with inline AEAD executed in a memory-centric NIC with directory-consistent coherence.

In additional embodiments, MF-TLP introduces a federated address-translation plane and a virtual-address-coherent directory mode that together allow selected memory regions to be addressed, cached, and kept coherent by virtual line address (VA) rather than physical line address (PA). A per-tenant Fabric-TLB (F-TLB) resident in MC-NICs is synchronized via new MF-TLP address-translation opcodes and extension headers, enabling routable, transaction-layer ATS semantics independent of any specific PCIe/CXL instantiation. Packets may carry an AddrMode selector choosing between PA and VA modes, and when in VA mode, the TenantID already present in MF-TLP headers serves as the protection and tagging domain for per-tenant F-TLBs and VA directory entries. The memory-side MC-NIC resolves a VA to the current physical home or memory object backing using its F-TLB and a local translation manager, then performs directory-consistent coherence on VA-tagged lines keyed by TenantID, VA_line, and PT_Version. This enables alias control under page remapping or migration, proactive translation prewarm piggybacked on data-bearing packets, and shoot-down/refresh of fabric-resident translations without involving remote CPUs, while preserving the routable, extensible MF-TLP header model and the MC-NIC pipeline comprising parser 410, memory access 420, coherence directory interface 430, atomic/reduction 440, scheduler/QoS 450, and fabric I/O 460 previously disclosed.

The packet-level interface implements sophisticated addressing mode and VA scope capabilities. MF-TLP already permits the address field 314 to represent a virtual address mapped through a translation structure or a physical address, and this embodiment formalizes the selection with an AddrMode bit in the header and extends the address semantics for VA-coherent operation. When AddrMode equals VA, the address is interpreted as a virtual line address within a tenant's address space and is coherent on VA, whereby directory entries are keyed on TenantID 318 and VA_line, optionally with a page-table version PT_Version, rather than PA. The header continues to carry opcode 312, vector descriptor 316, TenantID 318, coherence metadata 319, and Transaction ID 311, maintaining routability and compatibility with ordered transports.

The protocol introduces address-translation control verbs carried as ordinary MF-TLP packets with extension headers. ATREQ, representing Address-Translation Request, queries or prewarms translations for TenantID and VA_page pairs and may be issued by compute- or memory-side MC-NICs. ATRESP, representing Address-Translation Response, returns PA_page, permissions, PT_Version, and TTL representing time-to-live or lease, along with optional homonym/synonym flags. ATINV, representing Invalidate Translation, invalidates TenantID, VA_page, and PT_Version across a scope such as rack or domain using the same ordered control lanes used for coherence. ATSYNC, representing Barrier, orders translation updates with respect to MF-TLP data operations and fences. These opcodes reuse MF-TLP's extension header facility for optional metadata including PT root ID, policy bits, and prefetch hints, consistent with the packet's extensible header design.

Piggyback translation hints enable data-bearing vector or fused operations such as GRS requests to include a Translation-Hint extension listing VA pages they will touch. On ingress, intermediate or destination MC-NICs may prewarm their F-TLBs via ATREQ prior to executing the memory micro-operations, shrinking first-touch latency while amortizing hint cost in existing packets.

The MC-NIC micro-architecture for enablement includes a Fabric-TLB and translation manager whereby the memory access unit 420 is augmented with a translation manager and a per-tenant Fabric-TLB (F-TLB) caching VA_page to PA_page mappings along with permissions, PT_Version, and TTL. On AddrMode equal to VA requests, the parser 410 forwards TenantID and VA to the translation manager, where a hit yields the PA_line to service the request, while the coherence interface 430 opens or consults a VA-keyed directory entry. A miss triggers ATREQ to the tenant's authoritative translation source such as a host IOMMU or a fabric translation service, with ATRESP installing the F-TLB entry. The base disclosure already contemplates a translation module in unit 420 for virtualized addressing, and this embodiment federates and exposes it at the transaction layer.

The coherence directory interface 430 is extended with a dual-key directory comprising PA-keyed legacy entries and VA-keyed VAC entries. A VAC entry stores TenantID, VA_line, PT_Version, sharer_set, state as S/E/M, and PA_binding. On first touch, the directory binds the VA_line to the current PA_line and PT_Version, records sharers, and services read/write per the usual protocol including invalidations and updates but indexed by VA_line. Writes that gain exclusive ownership proceed only if the current F-TLB PT_Version for that VA matches the entry's PT_Version, otherwise a rebind flow runs. Coherence control continues to ride ordered transport streams as previously taught. The scheduler 450 prioritizes ATINV/ATSYNC control alongside coherence invalidations, with translation work being admitted under per-tenant quotas using the TenantID 318 governance hooks already present.

The operational semantics provide comprehensive VA-coherent read and write operations. For read operations in VA mode, the home MC-NIC receives READ with AddrMode equal to VA, resolves VA to PA through F-TLB, ensures or creates a VAC entry, and returns data. The requester may cache the line under VA, with the directory sharer set being tracked per TenantID and VA_line. For write operations in VA mode, on WRITE-EXCL with AddrMode equal to VA, the home NIC checks PT_Version for the VA, issues invalidations to sharers identified in the VA directory on ordered lanes, upon acknowledgement commits to PA, and updates the VAC entry state. These steps mirror the base directory flow with the index/key substituted by VA.

Page remap and migration rebind operations occur when the tenant's page table remaps VA_page to PA′_page for migration, NUMA rebalance, or tiering. The authoritative translation agent issues ATINV for TenantID, VA_page, and old PT_Version into the fabric. On ATINV receipt, each home NIC freezes the matching VAC entry, drains outstanding operations on ordered lanes, rebases the PA_binding to PA′ upon ATRESP with PT_Version+1, thaws the entry and resumes service under the new binding/version. Sharers holding VA-tagged lines are invalidated or retagged by the home NIC as part of the freeze/thaw process. This preserves single-system image semantics as VA lines move without exposing stale PAs.

Aliases and synonyms are handled whereby if two VAs from the same tenant temporarily map to the same PA creating a synonym, the translation manager may set an Alias bit in both VAC entries and maintain a shared PA_binding token, with invalidations affecting both VAs. If a VA maps to different PAs across time creating a homonym, PT_Version disambiguates, and a request with a stale version triggers rebind before service. Hybrid VA/PA operation allows regions to opt out of VAC and use PA-keyed directory for applications such as MMIO or DAX with fixed physical layout, with the AddrMode bit remaining per packet, enabling mixed traffic in the same fabric.

Translation federation flows demonstrate exemplary operations. For compute-initiated prewarm, before issuing a vector read to a hot index set, a compute NIC sends or piggybacks ATREQ for the corresponding VA pages. Memory-side NICs install F-TLB entries on ATRESP and, when the vector arrives, resolve VA to PA with F-TLB hits, with data returning under VA-coherent tracking. This leverages vector descriptors 316 and extension headers to amortize hints. For memory-initiated learning, upon repeated VAC misses to a small working set, the home NIC may issue speculative ATREQ for adjacent VA pages with configurable stride/coverage, prewarming translations similar to a page-walk cache, all within the MF-TLP control plane. For federation with nested translation serving virtualized tenants, ATREQ/ATRESP may carry nested translation metadata for guest VA to guest PA to host PA mappings. The home NIC caches the composed mapping and a composite PT_Version comprising a tuple of guest and host versions. The TenantID 318 disambiguates tenants and binds F-TLB entries to per-tenant policy.

Integration with coherence, security, and consistency ensures comprehensive system operation. For coherence ordering and fences, AT control including ATINV/ATSYNC and coherence invalidations both use ordered transport classes. A write-exclusive in VA mode linearizes after VA-directory invalidations/acknowledgements and any AT rebind required by version mismatch, then commits to PA and completes, matching the ordered-lane model previously disclosed. Capability and access control ensure per-packet TenantID and capability enforcement such as CapToken/ATU ACLs continue to gate admission, with the ATU 118 enforcing that a resolved PA lies within the tenant's authorized map before the memory access unit 420 executes. VA-mode does not bypass capability policy but rather binds translation and access control in the NIC datapath. Consistency classes and domains apply unchanged whereby per-packet consistency class including SC/TSO/RC and coherence domains such as rack/cluster operate normally, with VAC requests in SC riding ordered lanes, RC requests honoring acquire/release edges via the NIC's replay queues, and domain scoping limiting ATINV fan-out for large deployments.

Data structures in one embodiment include F-TLB entries containing TenantID, VA_page, PA_page, permissions, PT_Version, TTL, and alias_flags with LRU state. VAC directory entries contain TenantID, VA_line, PT_Version, sharer_set/rack scope, state, PA_binding, and lease/version. The AT context table tracks in-flight ATREQ/ATINV keyed by TenantID, VA_page, and TID 311 for correlation and replay safety. These integrate into the existing MC-NIC blocks 410/420/430/450/460.

Failure handling and progress mechanisms ensure robust operation. For stale version handling, a VA request carrying or implied by PT_Version equal to v encountering v′ greater than v triggers rebind, with the NIC returning a RETRY_SUGGEST status if immediate service is not possible. For ATRESP timeout, the translation manager may fallback to PA mode if permitted by policy or fail closed with no directory side effects. Replay safety ensures the Transaction ID 311 correlates AT control/responses with data operations, with duplicate ATRESP/ATINV being idempotent.

Example end-to-end flows demonstrate practical applications. For VA-coherent read-mostly regions, a distributed analytics job maps a columnar dataset into a tenant VA range flagged VAC-enabled. Readers issue READ with AddrMode equal to VA, and the memory node NIC maintains a VA-keyed sharer set and serves coherent copies without exposing PA churn as pages migrate across DRAM tiers. Lease/version metadata in the directory throttles excessive AT rebinds. For live migration across memory nodes, an operator migrates a VA page from node A to node B. The translation authority emits ATINV for VA_page and version v, A freezes VAC entries, drains, and acknowledges. After ATRESP advertises PA′ and v+1, A forwards or redirects subsequent VAC requests, with the sharer set being preserved by VA identity, not by PA, so caches remain coherent through the transition on ordered lanes. For VA-mode GRS operations, a GRS packet in VA mode gathers discontiguous VA elements, the home NIC resolves each VA to PA using its F-TLB prewarmed by piggybacked ATREQ, performs the reduction, and scatters to VA outputs under VAC directory control, amortizing both address translation and coherence in one transaction.

Switch assists optionally allow a ToR switch to cache ATRESP summaries such as TenantID and VA_page to next-hop for PA_page mappings to accelerate routable translation redirection without exposing raw PAs, similar in spirit to the switch-resident sharer cache for invalidations. Switches remain stateless with respect to coherence, with authoritative VAC and F-TLB state residing in home NICs.

ATF-VAC elevates address translation to a routable, transaction-layer service tightly integrated with coherence and multi-tenant isolation. Unlike PCIe ATS, which is link-local and host-centric, ATF-VAC operates end-to-end over MF-TLP, leverages TenantID scoping, and enables VA-coherent directories that remain stable under page migration, reducing shootdowns, avoiding PA churn in sharer tables, and enabling translation prewarm on the same packet flows as data. The design composes with MF-TLP's extensible header model, directory flows, and MC-NIC pipeline already disclosed. This long-form embodiment is fully enabled by MF-TLP's extensible header structure, the address field's VA/PA capability, the MC-NIC decomposition through 410/420/430/440/450/460, and the directory-based, ordered-transport coherence already disclosed, and it supports claims directed to a routable, transaction-layer address-translation federation with VA-coherent directory entries and per-tenant Fabric-TLBs synchronized via MF-TLP control opcodes.

In further embodiments, the Memory-Fabric Transaction Layer Protocol (MF-TLP) introduces topology-aware routing classes and coherence-priority lanes that explicitly differentiate coherence control traffic, such as invalidations, updates, and lease acknowledgements, from bulk data traffic, such as vector/GRS payloads. Packets carry a Priority Subfield and Routing-Class (RCID) in the MF-TLP header so that MC-NICs and MF-TLP-aware switches can steer coherence messages onto low-latency, ordered lanes with latency SLOs, while directing bulk streams to elastic lanes with congestion control and shaping. Cross-layer signals, already contemplated for coupling MF-TLP and the transport, are used bidirectionally whereby the fabric advertises lane-level backpressure to NIC schedulers, and memory-node NICs throttle invalidation fan-out to avoid incast collapse. A Token-Bucket plus Earliest-Deadline-First (EDF) scheduler in the MC-NIC 450 enforces per-tenant curves and per-class SLOs at injection, converting Ultra-Ethernet Transport (UET), InfiniBand, or like transports into coherence-aware substrates under MF-TLP control.

The packet-level interface implements header fields and classes through Priority and RCID field encodings. The MF-TLP header already includes a TenantID 318 with an optional priority subfield used for governance, and this embodiment formalizes two additional encodings within MF-TLP extension space, specifically RCID as Routing-Class Identifier and Deadline/Latency-Hint. RCID enumerates at least COH_CTL, COH_DATA, BULK_VEC, and GRS_RESP, where COH_CTL denotes coherence-control messages transported on ordered lanes with low latency, while BULK_VEC denotes elastic, congestion-controlled flows for vectors/GRS. The Deadline/Latency-Hint field, which is optional, provides a relative deadline in slots or microseconds used by NIC EDF scheduling and, where provisioned, by MF-TLP-aware switches. These fields coexist with opcode 312, address/descriptor 314/316, coherence metadata 319, and Transaction ID 311, preserving routability and compatibility with the protocol's extensible header model.

Ordered versus elastic lane binding ensures MF-TLP binds COH_CTL packets to ordered transport streams such as UET ordered classes to guarantee consistent visibility, while BULK_VEC binds to elastic classes that admit reordering and apply congestion control. This separation represents an explicit instance of the previously disclosed MF-TLP/transport cross-layer mapping. Topology scope hints are provided through an optional TopoScope subfield that restricts the expected fan-out domain, such as rack, pod, or fabric, to support locality-aware replication and scheduling. Intermediates can exploit the scope to preselect shortest-diameter paths for COH_CTL and lower-priority ECMP paths for BULK_VEC. The fabric types contemplated, including leaf-spine and torus topologies, are compatible with such scoping.

The MC-NIC micro-architecture extensions for enablement implement placement and admission gate functionality. Referring to the MC-NIC decomposition comprising parser 410, memory access 420, coherence interface 430, atomic/reduction 440, scheduler/QoS 450, and fabric I/O 460, the parser 410 extracts TenantID/priority, RCID, and optional Deadline information. The scheduler/QoS unit 450 implements per-tenant token buckets for rate and burst control per RCID, EDF scheduling across eligible RCID queues, and lane selection between ordered and elastic options. Only packets admitted by 450 are enqueued to fabric interface 460 for the corresponding lane. This builds on the previously described scheduler 450 and MF-TLP/transport cross-layer interplay.

The Token-Bucket plus EDF implementation details provide sophisticated traffic management whereby each tenant t and RCID c has parameters r_t,c and b_t,c, and a packet of size S is eligible if tokens are greater than or equal to S. Among eligible queues, EDF selects the earliest deadline, and if no deadline is present, the NIC derives one from a class SLO and topology distance. EDF is implemented in hardware as a min-heap or calendar queue, with token buckets being updated per lane clock. The design ensures that COH_CTL packets meet micro-burst latency targets even during heavy BULK_VEC traffic.

Cross-layer backpressure and fan-out control mechanisms ensure stable operation whereby the fabric interface 460 exports per-lane backpressure through credits or ECN. When COH_CTL lane occupancy crosses a threshold or ordered-lane credits dip, 450 applies a fan-out limiter to the coherence interface 430, which batches or defers invalidation trees to contain incast. This realizes the earlier teaching that transport backpressure can throttle high-fan-out coherence bursts at the MF-TLP layer.

Topology-aware deadline synthesis and pathing provide intelligent routing decisions. For local deadline computation, for COH_CTL traffic, the NIC estimates a deadline D equal to now plus a times H plus β, where H is hop count to the farthest target from a local topology cache, a represents an estimated per-hop budget, and β represents switch/endpoint service slack. For BULK_VEC, D is omitted or set looser to avoid starving control. Where the transport exposes ordered classes with timing hints, the deadline is copied into the extension header as AAD-bound and honored hop-by-hop.

Route-class binding ensures the RCID selects a queue class on each hop, with COH_CTL mapping to low-latency/ordered and BULK_VEC mapping to elastic. In leaf-spine fabrics, COH_CTL prefers rack-local or minimum-diameter paths to ToR-resident sharer caches when present, while BULK_VEC uses ECMP across spines. The base disclosure contemplates leaf-spine and ordered-stream carriage, and this embodiment ties them explicitly to coherence versus bulk classes.

The operational semantics demonstrate practical implementation across different traffic types. For coherence write-exclusive operations using COH_CTL, on a write-exclusive request, the coherence interface 430 builds an invalidation set, tags packets with RCID equal to COH_CTL, stamps a deadline, and injects them into ordered lanes. Scheduler 450 ensures tokens for COH_CTL are provisioned ahead of bulk and will preempt BULK_VEC if necessary to meet deadlines. Acknowledgements return on the same class, with completion to the writer being released only after ordered-lane acknowledgements retire, as in the base coherence flow.

For bulk vector/GRS operations using BULK_VEC, vector/GRS packets set RCID equal to BULK_VEC and use elastic classes. If elastic-lane backpressure rises through ECN or credit loss, 450 rate-limits BULK_VEC via token buckets without affecting COH_CTL injection, honoring the packetized vector semantics and payload separation previously taught. Mixed incast/egress shaping operates when an invalidation tree targets many racks, such as with hierarchical directories, whereby 430 emits a bounded wavefront of up to K rack heads per RTT window, where K is computed from ordered-lane credits. This prevents coherence incast at the memory node and leverages the previously disclosed cross-layer throttling concept.

Switch-resident assists optionally allow MF-TLP-aware switches to classify packets via RCID/priority and map them to hardware queue classes, apply EDF within a class for packets carrying deadlines, and replicate COH_CTL at ToR for local sharers, returning an aggregated INV-ACK upstream. The switch behavior remains stateless with respect to directory contents, with all coherence semantics residing at the endpoints.

Data structures and parameters in one embodiment include per-tenant class records containing TenantID, RCID, r, b, class_SLO, and deficit_counter. EDF queues are maintained one per RCID with min-heap on deadline and enqueue_seq. The topology cache stores dest_rack to hop count and spine set mappings, refreshed out-of-band. Lane telemetry provides moving averages of ordered/elastic occupancy and credits exported by 460 to 450. These integrate with MC-NIC blocks 410/420/430/440/450/460 previously described.

Failure handling and progress mechanisms ensure robust operation under stress. Deadline miss protection ensures that if a COH_CTL packet risks missing its deadline based on egress telemetry, 450 raises its local priority within the class and optionally defers bulk admission until backlog drops. For backpressure storms, if ordered-lane credits reach zero for T intervals, 430 flips to lease-deferral mode when enabled, issuing leases instead of immediate invalidations until pressure subsides, with the behavior being transparent to correctness. Class fallback ensures that if a device lacks class support, RCID is ignored and transport defaults apply, with correctness maintained though only SLOs relax.

Example flows demonstrate the system operation in practical scenarios. For rack-local coherence under bulk load, an analytics job streams BULK_VEC while a concurrent writer issues COH_CTL invalidations to approximately 64 rack-local sharers. The scheduler 450 drains COH_CTL first via EDF and token buckets, the ToR replicates acknowledgements and collapses them upstream, and the write completes at the directory's linearization point with bounded latency despite bulk congestion.

For cross-rack invalidation with fan-out throttle, a hot line has sharers across four racks. When ordered-lane credits fall due to unrelated control bursts, 450 restricts the wavefront to two racks per window, each rack's ToR replicates locally, and the memory node observes a smooth acknowledgement train rather than incast. For GRS coexistence, a GRS packet using elastic lanes shares links with COH_CTL. Backpressure marks only throttle BULK_VEC, while COH_CTL continues on ordered lanes to satisfy coherence SLOs, per the protocol stack's cross-layer model.

The implementation details for enablement include a hardware scheduler whereby the 450 unit implements per-class token buckets in SRAM and EDF via a hardware min-heap with 2 to 4K entries per class. Tokens accrue per lane clock, admission checks are one cycle with speculative dequeue. The parser 410 emits TenantID, RCID, size, and optional Deadline to the scheduler, while 460 feeds back credits/ECN, closing the loop. This reuses the previously disclosed scheduler/QoS block and fabric interface behavior.

Lane mapping ensures ordered versus elastic lanes are realized using transport capabilities such as UET ordered streams and port queue classes, with RCID to queue class mapping being table-driven to accommodate different transports. The mapping is configured out-of-band and may be advertised to switches supporting RCID classification. Header processing ensures RCID and Priority Subfield piggyback on existing MF-TLP header and extension-header parsing, with no payload changes required, and existing opcodes including read/write/atomic/reduce/vector remaining intact.

TARC-CB decouples coherence control from bulk movement at the transaction layer, making the transport coherence-aware under MF-TLP's direction. It improves tail latency for invalidations/acknowledgements and stability during incast by combining priority/RCID tagging, ordered-lane binding, and token-bucket plus EDF scheduling with cross-layer backpressure. Unlike link-local QoS knobs, TARC-CB is routable and semantic-aware whereby the packet's coherence role is visible end-to-end, and the MC-NIC coordinates issuance with the directory and transport to meet SLOs even at data-center scale. This long-form embodiment is fully enabled by MF-TLP's extensible header, the MC-NIC functional decomposition through 410/420/430/440/450/460, directory-based coherence with ordered transport, and cross-layer signaling already disclosed, and supports claims directed to a topology-aware, transaction-layer scheduling and routing method that tags coherence versus bulk classes and enforces latency SLOs using token-bucket admission and earliest-deadline-first on coherence-priority lanes.

In additional embodiments, the Memory-Fabric Transaction Layer Protocol (MF-TLP) is extended with a graph pointer-chase offload that executes multi-level indirect addressing, specifically pointer/ID to address to payload mappings, near memory in the memory-centric NIC (MC-NIC), collapsing what would otherwise be multiple request/response round-trips into a single packetized transaction. A new VFETCH_NEXT micro-opcode and family of related sub-operations permits a requester to supply a vector of base indices and a compact description of one or more indirection levels, such as index-to-pointer tables, CSR/COO adjacency arrays, or nested embedding tables. The MC-NIC expands the index vector, performs the first-stage lookups locally to materialize physical addresses or ranges, issues second-stage reads from those resolved addresses optionally across multiple memory nodes, and returns a batched response or commits a coherent scatter while executing directory updates in batch by reusing the vector batch-update machinery. This “index to address to value” fusion eliminates intermediate network hops, and in the CSR case of “row to start/end to neighbor list,” turns graph pointer-chasing into a single routable transaction layer operation. The design composes with MF-TLP vector descriptors, per-packet consistency and domain scoping, switch-resident replication for coherence control, UFUNC programmable operators, capability-tagged security, and VA-coherent translation.

The packet structure and encodings implement a sophisticated opcode family by adding an MF-TLP VFETCH_NEXT primary opcode and two specialized forms. VFN-IDX provides indexed table indirection in embedding-style operations that follow an index to address or offset table then fetch payload elements. VFN-CSR provides compressed sparse row operations in adjacency-style processing that follow row_idx to row_ptr[row] and row_ptr[row+1] mappings to enumerate a variable-length neighbor range, then fetch neighbor IDs and optional neighbor payloads.

The VFETCH_NEXT extension (VNE) header is placed after the base MF-TLP header and parsed at line rate, comprising vfn_kind as 2 bits specifying VFN-IDX, VFN-CSR, VFN-COO, or reserved, levels as 2 bits limited to 1 or 2 to prevent unbounded chasing, elem_type as 5 bits supporting i8, i16, i32, i64, fp16, bf16, fp32, and fp8 types, idx_count as 20 bits representing the number of base indices supplied, max_out as 20 bits providing an optional cap on outputs either per index or total, mode as 3 bits specifying READONLY, RMW_ACCUM, or SCATTER_OUT, ppcc as 3 bits and cdid as 12 bits for per-packet consistency and coherence domain, and flags as 8 bits for bounds-checking, deduplication, stable-order, and other options.

VFN-specific sub-descriptors encode how to interpret the indirection. The IDX-DESC for VFN-IDX contains table_base as 64 bits, entry_fint as 3 bits specifying OFFSET32, ADDR64, or SEG+OFF, entry_stride as 16 bits, addr_scale as 4 bits providing shift for element size, payload_base as 64 bits, and payload_stride as 24 bits. This encodes a flat index to offset or address table and how to form the payload address. The CSR-DESC for VFN-CSR contains rowptr_base as 64 bits, rowptr_fint as 2 bits for 32-bit or 64-bit format, colidx_base as 64 bits, colidx_fmt as 2 bits, payload_base as 64 bits, payload_stride as 24 bits, fetch_neighbors as 1 bit, fetch_payload as 1 bit, and k_per_row as 16 bits providing an optional bound per row. This expresses classic CSR where rowptr gives start/end and colidx holds neighbor IDs or offsets, with fetch_payload requesting a secondary dereference into a payload vector table.

The vector index payload in the request body carries the base index vector comprising rows or IDs. Index vectors may be unencrypted or AEAD-protected per capability policies. An optional Translation-Hint list of VA pages can be present to prewarm destination Fabric-TLBs.

Within the existing MC-NIC decomposition comprising parser 410, memory access 420, coherence interface 430, atomic/reduction 440, scheduler/QoS 450, and fabric I/O 460, specific blocks are extended for VFETCH_NEXT execution. The parser and planner 410 decodes VFN-* opcodes, extracts VNE, IDX-DESC/CSR-DESC, and the index vector, then builds an execution plan comprising stage-1 micro-reads for index or rowptr reads, address/range synthesis, stage-2 micro-reads for payload or neighbor lists, and optional scatter or UFUNC post-processing. Plans are chunked to respect idx_count, max_out, and tenant quotas.

A Pointer-Chase Engine (PCE) augments the memory access unit 420 with sophisticated multi-stage processing. For Stage-1, the engine reads index table entries for VFN-IDX or reads rowptr[row] and rowptr[row+1] for VFN-CSR. The address/range compute phase converts entries to PA_line plus offset for IDX operations or to start/end neighbor ranges for CSR operations. Stage-2 issues coalesced payload reads for IDX or colidx range reads for CSR, obeying k_per_row caps. Chunking and coalescing operations group micro-operations by cache line and by rack/domain to minimize coherence/control overhead and build one batched response.

The coherence and batch commit functionality in 430 operates differently based on mode. For READONLY mode typical for pointer-chase, the system treats second-stage lines as shared and avoids ownership upgrades. For RMW_ACCUM/SCATTER_OUT modes, the NIC pre-arranges domain-scoped invalidations in batch with one wave per destination line and commits results after ordered-lane acknowledgements, reusing vector batch-update semantics. Aggregated INV_ACK such as ToR merge is honored when available.

Optional UFUNC fusion through 440 operates when the request includes a UFUNC FuncID, streaming second-stage values through the UFUNC engine for operations such as segment-sum over neighbors before forming the response/commit. The scheduling and SLOs in 450 treat coherence/control including invalidations/acknowledgements as COH_CTL and pointer-chase micro-reads as BULK_VEC traffic, applying token-bucket plus EDF per tenant and backpressure-driven fan-out throttling.

The operational semantics and memory model ensure proper atomicity and visibility. For READONLY VFN, each element read is atomic with respect to concurrent writers at line granularity with no ownership taken. For RMW_ACCUM/SCATTER_OUT, per-line linearization occurs when the ordered-lane coherence control completes, with VFN completion withheld until all required lines meet PPCC obligations. Per-packet consistency and domains are managed whereby the request's PPCC and CDID steer transport binding and scope, with SC using ordered lanes for any control and response completion, RC/TSO using unordered for bulk micro-reads with fence-aware replay at boundaries, and domain scoping limiting coherence fan-out for scatter/accumulate results. Bounded chasing ensures levels is constrained to 1 or 2 to preclude unbounded traversal, with the engine enforcing max_out and k_per_row caps to guarantee predictable resource use and progress.

For VFN-IDX embedding-style two-stage gather, the requester issues VFN-IDX with indices array, IDX-DESC, and mode equal to READONLY. The PCE reads table_base[index] to retrieve addr in a coalesced manner. The PCE synthesizes payload_addr equal to payload_base plus addr times addr_scale plus stride and issues second-stage reads. The MC-NIC returns a single batched payload list with an optional status bitmap for faults and OOB conditions, ordered per the stable-order flag.

For VFN-CSR neighbor list enumeration with optional payload, the requester issues VFN-CSR with rows array, CSR-DESC, fetch_neighbors equal to 1, and fetch_payload as 0 or 1. For each row, PCE reads rowptr[row] and rowptr[row+1] to obtain the start/end range. PCE reads colidx[start:end], and if fetch_payload equals 1, translates neighbor IDs to payload addresses and fetches those as well. The NIC returns variable-length neighbor vectors and optional payloads with segment markers per row, truncated at k_per_row if set, plus a status/length table.

For fused neighbor reduction using UFUNC in GNN inference, the requester supplies UFUNC for segment-wise SUM/MEAN/MAX over neighbor features. The NIC streams neighbor features through UFUNC and returns one reduced feature vector per row, eliminating the scatter phase and minimizing network egress.

Data structures and micro-architecture include Index FIFO and Row FIFO buffers for base indices/rows for Stage-1. I-TLB/F-TLB hooks enable PCE to consult the Fabric-TLB in VA mode to resolve VA to PA for table_base/rowptr_base/colidx_base/payload_base, with misses triggering ATREQ and results installing in F-TLB. The line coalescer merges micro-reads by PA line, respecting alignment and stride. The range scheduler for CSR schedules start/end ranges into read bursts capped by max_out and ordered by canonical row and start key to ensure deterministic completion when requested. The batch coherence context tracks destination lines for RMW/SCATTER, issues one domain-scoped invalidation wave per unique line, and awaits merged acknowledgements. Sizing examples include 8 to 32k entry I-TLB/F-TLB, 8 to 16 outstanding range bursts, and 2 to 4k in-flight element contexts per packet, chunked if larger.

Correctness, security, and governance mechanisms ensure robust operation. Safety and bounds enforcement ensures hardware enforces max_out, k_per_row, and levels less than or equal to 2. OOB table or CSR accesses set status bits and skip offending elements with no memory side effects occurring for those elements. Capability and ACL enforcement operates when capability-tagging is active, whereby the Capability & Crypto Gate authenticates the packet and the ATU enforces address ACLs before stage-1 reads, with per-tenant quotas in 450 bounding resource usage. Replay/idempotence is maintained through Transaction ID plus Nonce driving duplicate suppression, with VFN responses including a deterministic ordering bitmap when stable ordering is requested. VA-coherence in VA mode uses VAC directory entries keyed by TenantID and VA_line for any coherent scatter stage, with ATINV events freezing/rebinding VAC entries before resuming.

Integration with other MF-TLP features demonstrates comprehensive system compatibility. Vector batching and ordered lanes ensure coherence control created by RMW/SCATTER rides ordered streams while bulk stage-1/2 reads use elastic classes with EDF scheduling for control priority. Switch assists through ToR replication reduce upstream invalidation fan-out if RMW/SCATTER is requested, while VFN-READONLY produces no invalidations. Translation federation operates when Translation-Hint is present, causing destination MC-NICs to issue ATREQ for the listed VA pages before stage-1 begins, hiding F-TLB fill latency. UFUNC fusion with a UFUNC FuncID in the VNE causes second-stage values to stream through the UFUNC engine, enabling per-row segment-reductions, clipping, thresholding, or quantization inline. Persistence optionally ensures that if VFN requests a durable scatter such as writing back updated edge weights, PersistClass fields ensure media-level durability before completion.

Failure handling and progress mechanisms provide robustness. Partial completion handles large graphs served in chunks, with each response carrying done and next_offset cursors per row/index for continued traversal. Timeouts for Stage-2 misses or cross-node reads that time out yield RETRY-SUGGEST status for those elements, with other elements completing without rollback. Deadlock avoidance through canonical scheduling using row-major, increasing address order and bounded levels avoids circular waits, with the scheduler able to interleave VFN chunks with higher-priority coherence traffic.

Alternative embodiments provide implementation flexibility including VFN-COO for coordinate list support where each input is a direct row and column pair with Stage-1 elided. Two-hop chaining with limited levels equal to 2 permits ID to neighbor list to neighbor payload in one packet, with the second hop's max_out2 bound preventing explosion. On-switch partial enumeration allows trusted switches to cache small CSR ranges and return partial neighbor lists directly in a stateless manner, with the home MC-NIC completing the remainder as an extension of switch assists without altering endpoint correctness. Dedup/filter provides a NIC-side optional dedup pass using a bitset per chunk to remove repeated neighbors before payload fetch, with bounded SRAM.

The architecture provides significant advantages including fewer RTTs and packets by converting 2 N or worse request/response pairs into one VFN transaction, collapsing index lookup plus payload fetch near memory. The approach is transport-agnostic and routable, expressed at the MF-TLP transaction layer rather than tied to link-local verbs, and compatible with UET/IB classes and ordered lanes. The system is coherent and programmable, integrating directory semantics for any write/accumulate scatter and supporting UFUNC for on-the-fly aggregation of neighbor features. Security and multi-tenancy are ensured through capability-tagging, per-tenant governance, and VA-coherent operation where desired. This long-form embodiment enables and supports claims directed to a two-stage vector pointer-chase operation executed in a memory-centric NIC that follows indirection tables or CSR adjacency near memory, batches second-stage reads, and integrates directory-consistent ordering for any scatter/accumulate updates expressed as a single MF-TLP transaction.

In a preferred embodiment, a Hybrid CXL-MF-TLP Coherence Bridge (HCB) enables interoperability between a host-centric CXL coherence domain and a NIC-centric, fabric-wide MF-TLP coherence domain to provide transparent, scalable, multi-tenant shared memory across racks and clusters using commodity transports including Ethernet with UET, RoCE, or InfiniBand. A Coherence Translation and Aggregation Node (CTAN) is realized as a top-of-rack appliance, or as a line-card or baseboard module, exposing CXL 3.x ports on a server-side interface and MF-TLP ports on a fabric-side interface; the CTAN is implemented as an MC-NIC-centric system-on-chip integrating functional blocks on a single ASIC or across multiple dies. A CXL Home-Agent Proxy (CHAP) terminates CXL.cache and CXL.mem transactions, presents to attached hosts as a virtual Home Agent and to pooled Type-3 memory devices with appropriate device semantics, and supplies snoop filtering and home-agent-compatible ordering for host-visible cache lines. An MF-TLP Directory/Coherence Agent (MDA) acts as the authoritative directory for HCB-mapped regions, maintaining per-line sharer and owner state across the MF-TLP domain and issuing MF-TLP coherence traffic—including targeted invalidations (INV), updates (UPD), acknowledgments (ACK), and lease-token grants—for MF-TLP caches. A Lease/Epoch Translator (LET) maps CXL snoop/ownership states (Invalid, Shared, Exclusive, Modified, and Owned) to MF-TLP coherence states augmented with lease tokens, while maintaining epoch counters and time-to-live parameters such that persistent exclusive ownership observed in CXL is represented as time-bounded MF-TLP leases. A Vector/Atomic/Reduction Engine (VARE), positioned on the fabric side of the bridge, executes vectorized scatter/gather operations, typed atomic read-modify-write operations, and numeric-aware reductions (NAR), while exposing to hosts a simple CXL-visible register file with a memory-mapped doorbell to trigger one-shot vector operations. A Transaction Logger (TxLog) with an associated write-ahead-log (WAL) buffer implements redo logging for failure-atomic vector writes that cross the CXL and MF-TLP domains and coordinates two-phase commit when writes are mirrored across multiple memory nodes. A Security/Governance Engine (SGE) maps MF-TLP TenantID values to CXL identifiers (PASID, VMID, FunctionID), enforces per-packet capability token checks, provides authenticated encryption (AEAD) for payloads where configured, and implements per-tenant queuing, credit management, deficit-round-robin/priority scheduling, and service-level objective enforcement. A Multicast/Sharer Filter unit (MSF) maintains regional sharer maps using bit-strings or Bloom filters, performs lowest-common-ancestor replication of INV and UPD messages within the switching hierarchy, and aggregates acknowledgments prior to responding to CHAP; high-rate fabric I/O supports UET/RoCE/InfiniBand on the MF-TLP side alongside multi-port CXL 3.x PHYs on the server side. Deployment modes include a top-of-rack CTAN that aggregates many servers and CXL Type-3 sleds per rack, an inline CTAN realized as a PCIe/CXL add-in card that bridges a single server to the MF-TLP domain, and a shelf CTAN placed in composable memory trays fronting large persistent-memory pools.

Addressing across the MF-TLP domain employs a Global Fabric Address (GFA), and the HCB introduces a Bridge Address Map (BAM) whose entries include a GFA_prefix (48-64 bits) indicating the fabric-global address prefix, a CXL_dpa_base (64 bits) indicating the device physical address base for Type-3 devices, a cxl_fabric_id (16 bits) identifying the CXL fabric domain, a bridge_mode field (3 bits) selecting among transparent, cache-proxy, and page-export modes, a tenant_id (32 bits), a lease_policy (16 bits) encoding ttl_us, renewal, and pregrant parameters, a sharer_bloom K (3 bits) indicating the number of Bloom-filter hashes, and a dir_ptr (48 bits) pointing to directory metadata; the BAM maps host pages pinned for export, Type-3 memory slices pooled into MF-TLP regions, and MF-TLP regions mounted into a host's address space via ACPI tables or device BARs. MF-TLP packets that traverse the bridge carry a BRGX extension header (32 bytes) containing, in order, a TenantID (bits 0-31), a DomainID corresponding to the CXL_fabric_id (bits 32-47), a BridgeClass identifying HOST_HA, TYPE3_DEV, PROXY_ONLY, or CTAN origination (bits 48-63), a monotonic LeaseEpoch (bits 64-79), a LeaseTTL_us field (bits 80-95), a ConsistencyMode enumerating SC, RCsc, RCpc, or RMO (bits 96-103), a ReduceSem field encoding NAR_FP8_FP32, SUM, MAX, DOT, or UFUNC (bits 104-111), a Capabilities bitfield indicating support for WAL, two-phase commit, AEAD, NAR, UFUNC, and multicast (bits 112-127), a SharerFilterHint carrying a Bloom hash seed (bits 128-143), a QoSClass distinguishing COH, HOT, BULK, and CTRL traffic (bits 144-159), a TxGroupID used for ATOM_GROUP multi-line commit coordination (bits 160-191), an AckVectorOfs indicating an offset for aggregated acknowledgments (bits 192-223), and reserved bits (224-255); BridgeClass identifies the originating side, LeaseEpoch and LeaseTTL us transport lease semantics across domains, and ReduceSem together with TxGroupID coordinates reduction and atomic groups through the bridge. Coherence state translation adheres to a precise mapping wherein CXL Invalid maps to an MF-TLP invalid (INV) state with no sharers, CXL Shared maps to MF-TLP SHARED with a Lease(LR) providing time-bounded read permissions for multiple sharers, CXL Exclusive maps to MF-TLP EXCL with a Lease(LW) as a predictive write lease with no other sharers, CXL Modified maps to MF-TLP OWNER with exclusive modified ownership and other copies invalidated, and CXL Owned maps to MF-TLP OWNER_SHARED combining ownership with read-mostly replication; the LET enforces lease timeouts such that an expiring Shared lease reverts to invalid absent renewal, and Exclusive/Modified grants require pre-invalidation within MF-TLP prior to granting ownership to a new writer.

Operationally, for a host-initiated CXL.mem read to an HCB-mapped address, a BAM hit causes CHAP to consult its snoop filter and, upon a miss, forward the request to MDA, which injects an MF-TLP READ tagged with BRGX fields including TenantID, DomainID, and ConsistencyMode set to sequential consistency; the target MC-NIC executes the memory access, with VARE optionally expanding a supplied vector descriptor into parallel sub-reads, returns data to MDA, and CHAP synthesizes a CXL.mem completion while filling host cache lines and recording a Lease(LR) in LET, with the directory adding the host as a sharer and MSF updating the Bloom or bitset. For a host write-upgrade (CXL.cache read-for-ownership), CHAP issues an upgrade intent to MDA, which computes sharers from directory metadata and transmits MF-TLP invalidations carrying the current LeaseEpoch solely to affected racks, MSF performs lowest-common-ancestor replication and aggregates acknowledgments, MDA then grants exclusive ownership and CHAP returns CXL snoop responses to the host while LET issues a Lease(LW) and starts a lease timer, the write completes, and directory ownership is updated. For host vector scatter/gather via a doorbell protocol, the host writes a vector descriptor into a CTAN MMIO region and rings the doorbell; VARE parses the descriptor and emits a single MF-TLP VREAD carrying BRGX, executes parallel sub-reads from remote MC-NICs, aggregates results into a single consolidated completion, and CHAP performs DMA to host memory and signals completion; if the descriptor specifies a numeric-aware reduction (e.g., SUM of FP8 inputs with FP32 accumulation), VARE performs the typed reduction near memory prior to return. For in-network reduction across multiple hosts and memories, hosts or GPUs place partial results in CTAN registers or issue MF-TLP REDUCE operations, VARE selects an aggregation topology (in-switch where available or CTAN-local), executes the specified NAR including compensation and rounding as indicated, MDA writes the final result to a designated GFA address, and CHAP returns completions to contributors as memory-mapped I/O completions or coherent stores. For failure-atomic vector writes that span domains, the host prepares a vector write list and rings the doorbell, whereupon TxLog appends redo records tagged by TxGroupID to persistent storage (e.g., NVRAM or mirrored persistent memory), MDA issues remote MF-TLP WRITEs and awaits an aggregated acknowledgment vector from MSF, a commit record is appended upon success, or TxLog performs replay to completion or abort and cleanup on failure, and the host receives a per-element status bitmap enabling retry of only failed elements.

The system furnishes default sequential consistency for host-visible operations by having CHAP serialize cross-domain completions and supports release-consistency modes (RCsc/RCpc) as indicated by BRGX.ConsistencyMode with hardware fence translation such that host SFENCE/MFENCE instructions are realized as MF-TLP barriers accompanied by an epoch increment; for UFUNC regions, compiler annotations are honored and CHAP ensures write-publish semantics into MF-TLP prior to software notification. Tenant identity is first-class in BRGX and BAM; SGE authenticates per-packet capability tokens and may apply AEAD to payloads, maps host PASID/VMID to TenantID and address-space tags to prevent cross-tenant exposure, and enforces UFUNC attestation with signed micro-operation bundles subject to per-tenant resource limits and deterministic execution budgets. Quality-of-service and governance are implemented using a dual-level scheduler that separates traffic classes for coherence, hot latency-sensitive, bulk data, and control traffic, and applies per-tenant DRR with SLO hints such as deadlines and minimum bandwidth, while backpressure is exerted by CHAP advertising credits to throttle host-originated vector operations under congestion and VARE executes a work-conserving policy within tenant caps. Scalability is achieved by sharer filtering using hierarchical caches of sharer bitsets and Bloom filters at top-of-rack and leaf positions to reduce coherence fan-out, by lease mechanisms in which short-lived Shared or Exclusive leases expire without global invalidation and predictive write pre-grants assign a Lease(LW) to the likely next writer based on access history, and by directory sharding across CTANs via consistent hashing on the GFA prefix with each shard's MSF maintaining local sharer maps. A representative microarchitecture pipeline on the CXL ingress includes CHAP decode (approximately three to five cycles), snoop filter SRAM access (approximately one to two cycles), enqueueing to MDA, BRGX composition (fixed thirty-two bytes), and fabric egress; the MF-TLP ingress includes parse, vector expansion with DMA into an issue queue, directory port coherence checks, ALU/NAR processing (approximately one to eight cycles per lane), aggregation, BRGX completion generation, CHAP completion, and host cache fill, targeting an internal CTAN pipeline budget below two hundred nanoseconds with end-to-end latency dominated by transport and serialization. Storage provisioning for an illustrative implementation includes directory storage on the order of sixty-four bytes of metadata per line across approximately sixty-four million lines (about four gibibytes, optionally backed by HBM), rack-granular Bloom filters with m≈2048 bits and k=3 per sixty-four-kiloline region yielding approximately 0.75% false positives with fallback to explicit targeted queries, and TxLog capacity of sixteen to sixty-four gibibytes of NVRAM suitable for thousands of concurrent ATOM_GROUP transactions. Control-plane integration advertises HCB regions to operating systems and hypervisors via ACPI and PCIe tables, composes HCB slices into pods and virtual machines through Kubernetes custom resources and a fabric manager API to realize Memory-as-a-Service, and supports hot add and remove by atomically updating BAM entries and migrating directory ownership using a quiesce-and-drain protocol with an epoch barrier and lease expiry. In edge and recovery scenarios, high-availability failover triggers TxLog replay from a mirrored peer and a directory cold-start from a compact checkpoint with in-band presence probes; split-brain is prevented by coupling DomainID with a monotonic LeaseEpoch disciplined by a time source such as PTP to reject stale epochs; if sharer density exceeds Bloom-filter performance envelopes, explicit sharer lists are engaged for hot lines and MSF automatically selects the appropriate mode per line. This embodiment is well-suited for ubiquitous deployment insofar as it integrates into existing CXL build-outs with servers perceiving a standard CXL fabric and requiring no application modifications for baseline use, operates atop Ethernet/UET/InfiniBand to leverage existing datacenter networks without introducing a forked fabric, supports incremental adoption beginning with cache-proxy and vector-doorbell acceleration before enabling full MF-TLP coherence, and embeds cloud-grade tenancy and governance to isolate workloads and enable billing keyed by TenantID in alignment with XaaS monetization models.

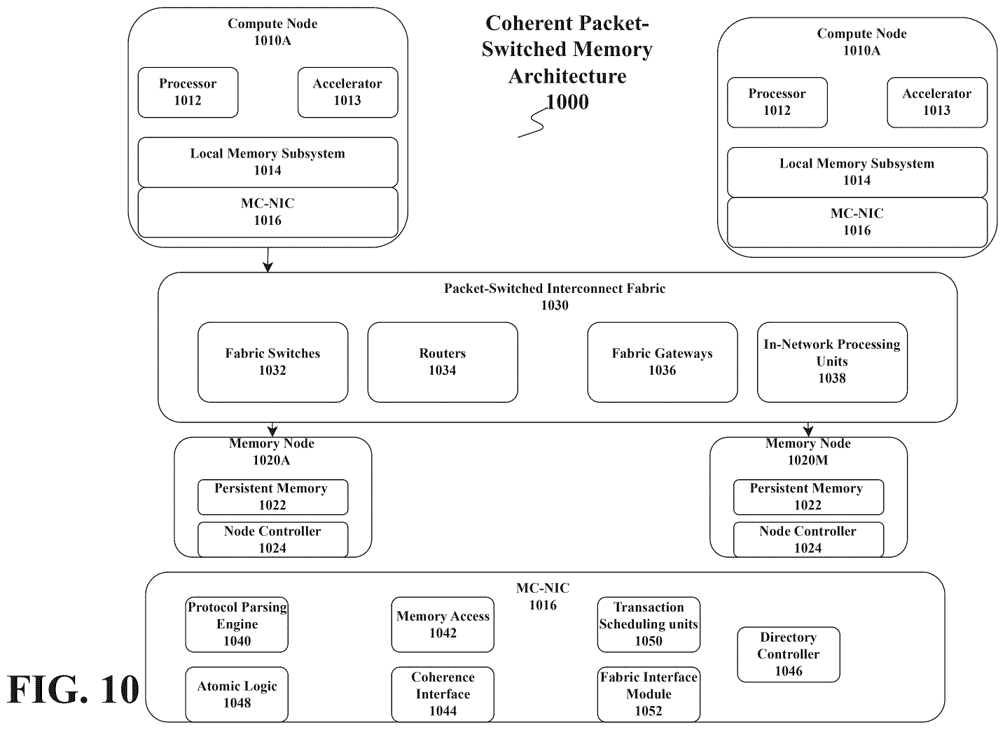

FIG. 10 is a block diagram illustrating a high-level system architecture 1000 implementing a coherent, packet-switched memory fabric designed for distributed, disaggregated computing environments. The system provides a unified addressable memory plane across multiple compute clusters, each comprising heterogeneous processing elements and memory resources. This architecture establishes the foundational framework for the Memory-Fabric Transaction Layer Protocol (MF-TLP) and the memory-centric network interface controllers (MC-NICs) that enable vectorized, atomic, and reduction operations directly within the network fabric.

The system 1000 includes a plurality of compute nodes 1010A-1010N interconnected with a plurality of memory nodes 1020A-1020M through a packet-switched interconnect fabric 1030. Each compute node 1010 comprises one or more general-purpose processors 1012, high-performance accelerators 1013 (e.g., GPUs, tensor processors, FPGAs, or domain-specific AI cores), and a local memory subsystem 1014. The local memory subsystem may consist of multi-tier volatile memory, including high-bandwidth memory (HBM), DDR5 DRAM, or SRAM-based cache hierarchies. Compute nodes further incorporate one or more MC-NICs 1016 that act as the transaction endpoints for MF-TLP packets, translating routable memory operations into low-latency, coherent access commands.

Each memory node 1020A-M includes a persistent memory array 1022 coupled with a node controller 1024. The persistent memory array may include DRAM, phase-change memory (PCM), magnetoresistive RAM (MRAM), resistive RAM (ReRAM), or other non-volatile memory technologies capable of byte-level addressing. The node controller 1024 manages address range allocation, directory tracking, and transactional consistency across the memory space. In some embodiments, the controller also hosts an embedded MF-TLP termination engine capable of executing atomic, vector, or reduction transactions initiated by remote compute nodes. The memory nodes collectively form a disaggregated memory pool that is dynamically mapped into the virtual address spaces of participating compute nodes.

The interconnect fabric 1030 is implemented as a multi-tier packet-switched network comprising fabric switches 1032, routers 1034, and fabric gateways 1036. The fabric may employ Ethernet with Ultra-Ethernet Transport (UET), InfiniBand, or CXL-over-Ethernet as its transport layer. Switching elements are MF-TLP-aware and incorporate programmable routing pipelines that interpret addressing and coherence metadata within packet headers. In some embodiments, the switches 1032 include in-network processing units 1038 that execute collective reduction or aggregation functions on data streams, enabling near-data compute at line rate. The routing topology may follow a leaf-spine configuration, torus, dragonfly, or hierarchical mesh, depending on the deployment scale and latency requirements.

At the control plane, the system supports a global address fabric that assigns each memory range a fabric identifier (FID) used for routing and coherence tracking. Each MF-TLP packet encapsulates an operation code, a FID, and optional vector descriptors or tenant identifiers. When a compute node issues a memory transaction, its local MC-NIC 1016 generates an MF-TLP request that includes the necessary routing and consistency metadata. The interconnect fabric 1030 forwards the packet to the appropriate destination node based on the FID, ensuring that all routing, security, and QoS policies are enforced transparently in hardware.

Within each MC-NIC 1016, incoming MF-TLP requests are parsed by a protocol parsing engine 1040 that decodes the opcode, address, and coherence fields. The memory access engine 1042 converts routable fabric addresses into local memory operations. The coherence interface 1044 exchanges state updates with a directory controller 1046, which may be distributed across nodes or centralized per memory region. The MC-NIC further integrates atomic and reduction execution logic 1048 for in-network arithmetic, transaction scheduling units 1050 for prioritization and ordering, and fabric interface modules 1052 for packet ingress and egress with error detection and retry mechanisms.

The architecture 1000 provides fabric-wide cache coherence, ensuring that all compute nodes observe a consistent view of shared data regardless of physical memory location. Directory-based coherence protocols maintain sharer lists, ownership states, and version identifiers. Read requests are directed to the home memory node or to other sharers depending on policy, while write requests trigger invalidation or update sequences propagated as MF-TLP coherence messages. These coherence transactions are performed concurrently with normal read/write/atomic traffic, leveraging the same packet infrastructure and routing paths.

In one embodiment, the interconnect fabric implements predictive coherence and lease-based consistency, allowing compute nodes to cache lines for a bounded duration without immediate invalidations. This approach minimizes coherence chatter for read-heavy workloads. In another embodiment, coherence enforcement is hierarchical-leaf-level switches track per-rack sharers, while spine-level controllers handle cross-rack coherence domains. The design scales linearly with the number of nodes, supporting thousands of compute devices while preserving microsecond-level access latency.

The architecture 1000 is designed for heterogeneous workload acceleration. Vectorized MF-TLP transactions allow compute nodes to perform scatter/gather memory accesses for embedding lookups or sparse matrix multiplications in AI inference. Atomic MF-TLP transactions enable lock-free synchronization primitives such as counters, mutexes, and distributed hash-table updates. Reduction operations executed in-network allow gradient accumulation and collective operations (e.g., all-reduce) to complete with minimal data movement. Together, these capabilities transform the interconnect from a passive transport medium into an active, memory-centric compute substrate.

Quality-of-service (QoS) and multi-tenant governance are integral to the architecture. Each MF-TLP packet may carry a tenant ID and priority tag, allowing switches and NICs to enforce isolation, rate limits, and service-level objectives. Administrators may configure per-tenant bandwidth pools, latency classes, and preemption rules, ensuring predictable performance in shared environments. Security is enforced through per-packet authentication fields and optional encryption at the transport or transaction layer.

This represents the top-level framework for the coherent memory fabric system described throughout this disclosure. The combination of distributed compute devices, disaggregated memory nodes, programmable MC-NICs, and MF-TLP-aware interconnect fabric creates a unified platform for memory-centric computing. This system delivers coherent, routable memory transactions with native support for atomic, reduction, and vectorized operations-scaling from single-rack deployments to data-center-scale fabrics and forming the architectural foundation for all subsequent figures and embodiments described herein.

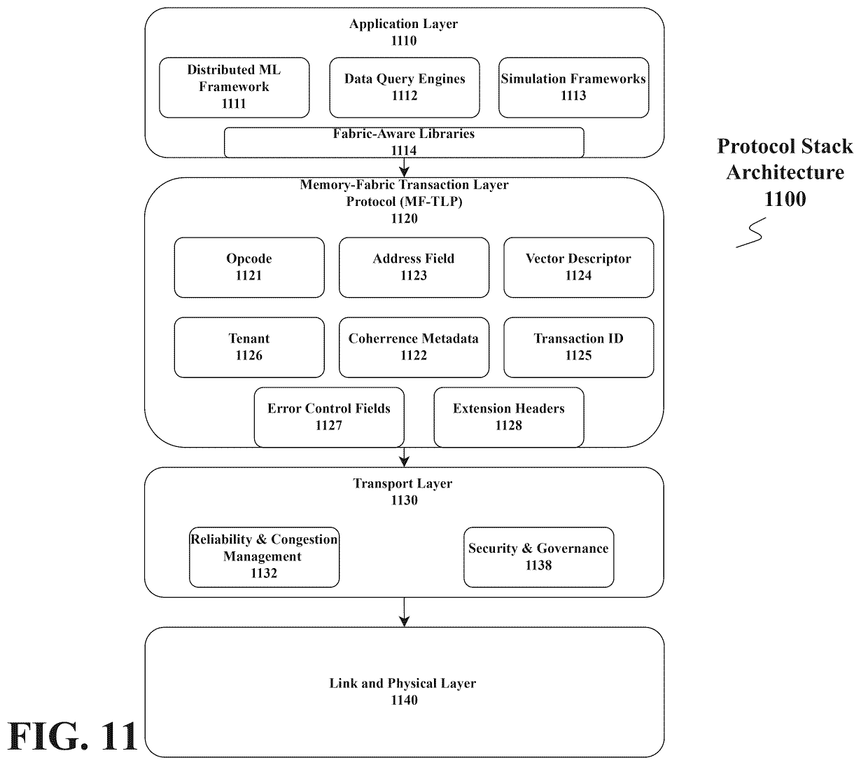

FIG. 11 is a block diagram illustrating an exemplary architecture of a protocol stack architecture 1100 that defines the logical layering of the Memory-Fabric Transaction Layer Protocol (MF-TLP) within the coherent memory fabric system. The stack demonstrates how MF-TLP serves as an intermediate abstraction between high-level application semantics and the underlying transport and physical signaling layers. It enables routable, cache-coherent memory transactions across distributed compute and memory resources.

At the uppermost layer of the architecture resides the application layer 1110. The application layer represents software workloads that issue memory-centric operations, including distributed machine learning frameworks 1111, database query engines 1112, and simulation or analytics frameworks 1113. These applications generate high-level commands such as memory reads, writes, atomic updates, and collective reductions. Rather than interacting directly with transport protocols or RDMA primitives, the application layer issues requests via fabric-aware libraries or APIs 1114 that expose memory-fabric verbs (e.g., mf_read( ), mf_write( ), mf_atomic_add( ), mf_reduce( ), or mf_vector_scatter( )), allowing developers to program in a load/store abstraction while the underlying system transparently handles packetization and routing.

Immediately below the application layer is the Memory-Fabric Transaction Layer Protocol (MF-TLP) 1120. This layer provides a standardized packetized transaction framework that encapsulates memory operations into routable request and response packets. Each MF-TLP transaction carries an opcode 1121 specifying the operation type (read, write, atomic, reduction, vector, or fused operation) along with coherence metadata 1122, address or object identifiers 1123, and optional vector descriptors 1124 for multi-address or stride-based access patterns. The protocol also includes transaction identifiers 1125 for matching responses, tenant and priority tags 1126 for governance, and error-control fields 1127 for reliability. The MF-TLP layer provides ordering, acknowledgment, and completion semantics independent of the transport implementation.

The MF-TLP layer 1120 serves as a semantic boundary between software-level memory operations and the network transport layer 1130. The transport layer 1130 may be implemented using one or more existing high-performance interconnect standards, such as Ultra-Ethernet Transport (UET), InfiniBand, PCIe/CXL over Ethernet, or RDMA-capable fabrics (e.g., RoCEv3). The transport layer 1130 is responsible for packet delivery, sequencing, congestion control, and link-level error recovery. In one embodiment, MF-TLP transactions are mapped onto UET flows, where each flow guarantees in-order delivery of coherence messages. In another embodiment, RDMA verbs are used to transport MF-TLP packets, leveraging zero-copy placement into NIC memory while preserving MF-TLP's higher-level transaction semantics.

The transport layer 1130 may include reliability and congestion-management modules 1132 that monitor round-trip latency and dynamically adjust packet pacing. These mechanisms can provide priority for coherence messages or atomics, ensuring fairness and minimizing tail latency in large fabrics. In some embodiments, the MF-TLP layer may inject congestion awareness flags or flow-class identifiers into its packet headers to influence scheduling within the transport layer, thereby achieving cross-layer coordination between transaction semantics and network behavior.

Below the transport layer 1130 lies the link and physical layer 1140. The physical layer 1140 defines signaling, framing, and serialization for transmission across electrical, optical, or wireless media. Exemplary embodiments may employ 400 G or 800 G Ethernet PHYs, optical coherent interconnects, or future terabit-class fabrics using PAM-4 modulation or co-packaged optics. In smaller deployments, CXL 3.0 or PCIe 6.0 physical links may be used for intra-rack connections, while long-haul links may rely on Ethernet over DWDM. The link layer may provide cyclic redundancy checks and forward error correction to guarantee end-to-end reliability for MF-TLP transactions.

The MF-TLP layer 1120 interacts bidirectionally with both the application and transport layers. From the application layer's perspective, MF-TLP provides an API that accepts memory verbs and produces completion events. From the transport layer's perspective, MF-TLP generates formatted packets containing self-describing headers that allow intermediate devices, such as MF-TLP-aware switches or fabric gateways, to parse and route transactions without reassembly. This enables stateless routing for most operations while maintaining transaction integrity through identifiers and sequence counters.

In some embodiments, MF-TLP may support extension headers 1128 for additional functionality beyond the base specification. Extension headers may carry predictive prefetch hints, congestion marks, multicast replication instructions, or fabric-wide synchronization barriers. These extensions allow the protocol to evolve without breaking backward compatibility, since legacy devices can forward or ignore unrecognized extension headers while newer devices interpret them to perform advanced in-network operations.

The MF-TLP stack also accommodates security and governance layers integrated at the transaction or transport boundary. Each packet may be signed or encrypted using tenant-specific keys 1138, and authentication metadata may be included in an optional header extension. Switches or MC-NICs can validate such metadata before execution, enforcing access control and isolation for multi-tenant deployments.

In an alternative embodiment, MF-TLP may operate in conjunction with software-defined fabric controllers responsible for dynamically provisioning address ranges, quality-of-service classes, and routing policies. The controller communicates with MC-NIC firmware to register new memory objects, assign fabric identifiers, and manage coherence domains. Such orchestration allows dynamic scaling of the coherent memory fabric and provides the flexibility to migrate workloads between compute nodes without disrupting transaction semantics.

The protocol layering shown in FIG. 11 therefore establishes the foundation of the coherent memory fabric's logical design. By positioning MF-TLP 1120 between application semantics 1110 and the transport/physical substrate 1130-1140, the system enables routable, coherent, and memory-aware transactions independent of any specific interconnect technology. This design allows developers to leverage familiar memory-access paradigms while achieving the performance, scalability, and resilience of a distributed packet-switched fabric.

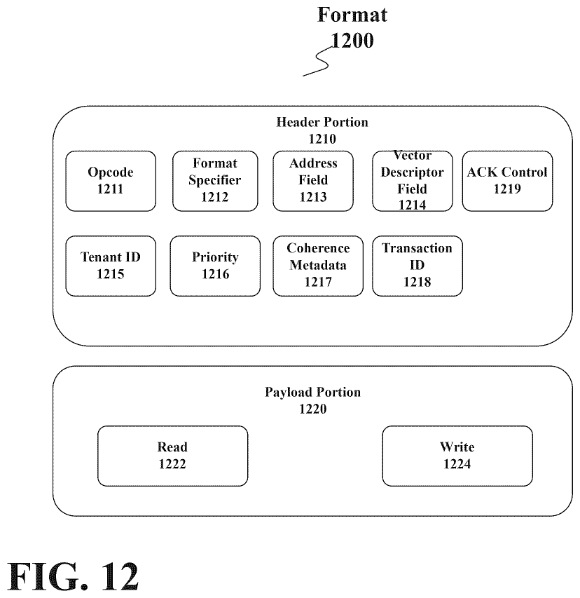

FIG. 12 is a block diagram illustrating an enhanced exemplary packet structure 1200 employed by the Memory-Fabric Transaction Layer Protocol (MF-TLP), which defines an enhanced routable and extensible packet format for performing coherent memory operations across a distributed memory fabric. The MF-TLP packet format enables load/store semantics, atomic operations, reductions, and vectorized transactions to be expressed as self-describing, routable packets compatible with heterogeneous interconnect technologies such as Ultra-Ethernet Transport (UET), InfiniBand, or Compute Express Link (CXL) extended over Ethernet.

Each MF-TLP packet 1200 is divided into three principal portions: a header portion 1210, an optional extension header stack, and a payload portion 1220. The header portion 1210 conveys routing, semantic, and control information required for the transaction, while the payload portion 1230 carries operands, data values, or result content associated with the operation. This structure allows intermediate devices—such as memory-centric network interface controllers (MC-NICs) and MF-TLP-aware fabric switches—to parse, forward, and optionally execute packet operations without software intervention.

The header 1210 begins with an opcode field 1211 that identifies the transaction type. The opcode may encode operations such as READ, WRITE, ATOMIC, REDUCE, VECTOR, or FUSED. Sub-opcodes may further specify typed arithmetic (e.g., integer, floating-point), logical (e.g., AND, OR, XOR), or comparison operations (e.g., compare-and-swap, test-and-set). In certain embodiments, the opcode field is accompanied by a format specifier 1212 that identifies the structure of the payload and any sub-operation sequencing. This allows the same packet type to represent both scalar and vector operations within the same header template.

Following the opcode, an address field 1213 specifies the physical, virtual, or object-based target of the transaction. In one embodiment, this field encodes a fabric identifier (FID) used for routing within the coherent memory fabric. The FID may include subfields identifying the destination memory node, partition, and address offset within the node's persistent memory array. In another embodiment, the address field 1213 encodes a globally unique object handle used for memory-object addressing, allowing applications to refer to logical data structures independent of their physical placement.

Adjacent to the address field 1213 is a vector descriptor field 1214, present when the opcode specifies a vectorized operation. The vector descriptor may include a base address, stride, and length, describing a contiguous sequence of memory elements, or an explicit offset list referencing multiple non-contiguous addresses. In one embodiment, the descriptor can include multiple “segments,” each defining its own stride and count, allowing a single MF-TLP packet to describe a hybrid access pattern combining contiguous and sparse regions. The MC-NIC parsing engine expands these descriptors into discrete memory accesses while maintaining ordering guarantees defined by the descriptor sequence.

To support governance and prioritization, the header further includes a tenant identifier field 1215 and an optional priority field 1216. The tenant identifier associates the transaction with a specific process, virtual machine, or security domain, enabling multi-tenant isolation and per-tenant quality-of-service enforcement. The priority field specifies relative scheduling class, allowing latency-sensitive coherence messages or atomic operations to be elevated above bulk transfers.

The header 1210 may also include a coherence metadata field 1217, which encodes state bits, version tokens, or lease information for enforcing fabric-wide coherence. The coherence metadata allows the packet to carry sufficient information for directory controllers or intermediate coherence managers to determine whether invalidations or updates must be propagated. For example, in a write-back scenario, the coherence metadata field may indicate that the transmitting node holds the most recent version, prompting the receiving node to update its directory entry without additional round-trip queries.

Each MF-TLP packet further includes a transaction identifier field 1218 and an acknowledgment control field (ACK) 1219. The transaction identifier uniquely associates request and response packets, supporting pipelined, out-of-order, or split transactions. The acknowledgment field specifies completion requirements, enabling fine-grained control over whether the destination must issue explicit acknowledgments or aggregate completions. Together, these fields ensure reliable and ordered completion of memory transactions even in large, asynchronous fabrics.

An extension header stack provides optional, variable-length capability. Each extension header includes a type identifier and a length field, followed by extension-specific content. Example extension types include: (a) predictive prefetch directives, enabling early staging of data into cache before explicit requests arrive; (b) replication control extensions, instructing switches to multicast payloads to multiple destinations; (c) congestion-control hints, allowing end nodes to mark packets as delay-tolerant or latency-critical; and (d) security extensions, which may carry message authentication codes, digital signatures, or encryption initialization vectors. Devices that do not recognize a particular extension header simply skip it based on the encoded length, preserving backward compatibility.

The payload portion 1220 carries data values associated with the operation. For READ 1222 requests, the payload is typically absent, while READ 1222 responses contain the returned data. For WRITE 1224 operations, the payload includes the data to be written. For ATOMIC and REDUCTION operations, the payload may include one or more operands, while the result is returned in the response packet or committed directly to memory. In vector operations, the payload may include a series of elements corresponding to the addresses specified in the vector descriptor 1214. Payload size may be fixed or variable, with packet segmentation supported for large transfers.

In some embodiments, MF-TLP packets include an error-detection and correction field 1232 appended to the payload. This field may implement cyclic redundancy checks (CRC-32/CRC-64) or stronger forward-error-correction (FEC) codes to guarantee integrity across multi-hop routes. The receiving device validates the checksum before executing the operation; if corruption is detected, the packet may be dropped or retransmitted automatically using retry identifiers in field 1218.

In another embodiment, the packet format supports chained transactions, wherein the payload of one packet contains control descriptors for subsequent operations. This allows operations such as scatter/gather, fused read-modify-write, or pipelined reductions to be encoded as a single stream of linked MF-TLP packets, reducing CPU intervention and enabling hardware-level flow control. The MC-NIC hardware recognizes chain identifiers in field 1212 and processes each subsequent descriptor autonomously until the chain terminates.

To support scalable coherence and performance, the MF-TLP format may also define a QoS profile field and a timestamp or epoch counter. The QoS field communicates performance objectives such as latency targets or bandwidth reservations to switches and schedulers, while the timestamp allows for ordering and deadline-aware arbitration. Together, these fields permit time-sensitive or real-time workloads to coexist with bulk analytic operations on the same physical fabric.

In operation, MF-TLP packets may be transmitted, forwarded, and executed entirely in hardware. MC-NICs and MF-TLP-aware switches can parse the header 1210 and extension stack without accessing the payload 1230, applying routing, filtering, or aggregation actions directly based on header content. This design decouples control and data paths, allowing line-rate execution of coherent memory transactions and enabling features such as in-network atomicity, aggregation, and vector expansion to occur transparently to the software stack.

The MF-TLP packet format 1200 thus provides a foundational building block for the coherent memory fabric architecture. By defining a compact, extensible, and self-describing packet structure, the format enables diverse memory operations—including scalar, vectorized, and collective transactions—to be executed and coherently managed across a distributed, heterogeneous environment. The architecture described herein ensures both backward compatibility with existing transports and forward scalability toward future network fabrics capable of terabit-scale bandwidth and sub-microsecond latencies.

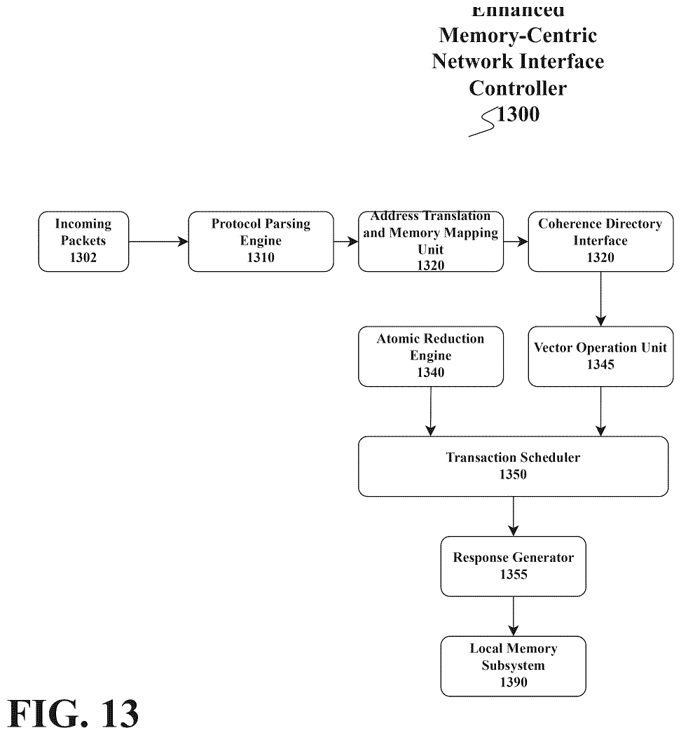

FIG. 13 is a block diagram illustrating an exemplary architecture of an enhanced memory-centric network interface controller (MC-NIC), which acts as the primary hardware termination point for Memory-Fabric Transaction Layer Protocol (MF-TLP) packets within the coherent memory fabric architecture. The MC-NIC 1300 is a specialized, programmable network interface device that integrates packet parsing, address translation, coherence management, atomic and reduction execution, scheduling, and fabric communication capabilities. Unlike conventional NICs that merely forward packets or perform basic RDMA operations, the MC-NIC executes semantic-aware memory transactions directly in the data path, thereby transforming the interconnect into an active, memory-centric compute layer.

The MC-NIC 1300 comprises several functional modules interconnected by an internal high-bandwidth switch fabric or crossbar. Incoming MF-TLP packets 1302 are received from the fabric interface and are processed through a pipeline of specialized engines that perform decoding, routing, execution, and response generation. Outgoing MF-TLP packets generated by the NIC are transmitted back into the interconnect fabric toward other compute nodes, memory nodes, or switches.

At the ingress of the MC-NIC 1300 is the fabric interface block 1360. The fabric interface block performs the physical and link-layer operations necessary to exchange MF-TLP packets over the transport medium. It includes serializers/deserializers (SerDes), protocol framing logic, and error-checking mechanisms. The block is further equipped with flow-control and congestion-notification logic, enabling the MC-NIC to participate in end-to-end congestion management schemes such as explicit congestion notification (ECN) or fabric credit-based throttling. The interface also verifies cyclic redundancy checks (CRC) or forward-error-correction codes appended to incoming packets and handles retransmission or retry requests in case of transient link errors.

Packets validated at the fabric interface are passed to the protocol parsing engine 1310. The parsing engine 1310 is responsible for decoding the MF-TLP header, extracting the opcode 1211, address 1213, vector descriptor 1214, tenant identifier 1215, and coherence metadata 1217 fields, as described with respect to FIG. 12. The parsing engine determines the packet class (e.g., read, write, atomic, vector, or reduction) and forwards it to the appropriate execution path. In some embodiments, the parsing engine 1310 implements a microcoded instruction sequencer allowing field-programmable decoding rules to support future protocol extensions. In alternative embodiments, the parsing logic is fully hard-wired to enable line-rate decoding at 400 Gb/s and beyond, ensuring deterministic latency for all transactions.

Coupled to the parsing engine is the address translation and memory-mapping unit 1320. This unit converts global fabric addresses into local physical or virtual addresses within the attached memory subsystem. In one embodiment, the unit 1320 maintains a multi-level translation look-aside buffer (TLB) or address translation cache to accelerate repeated access to common address ranges. In another embodiment, it supports programmable mapping tables to allow virtualization of memory objects, such that distributed memory resources appear as a contiguous logical address space. The translation unit also enforces access permissions derived from tenant identifiers and may reject or quarantine unauthorized memory operations.

Once translation, the packet and associated address are forwarded to the coherence directory interface 1330. This module maintains or consults directory structures that record the coherence state (shared, exclusive, modified) and sharer lists for memory lines managed by this MC-NIC. When a read request arrives, the directory interface determines whether the line can be served locally or whether it must issue a fetch or invalidation command to other sharers. In the case of a write request, the coherence interface generates and transmits MF-TLP invalidation or update messages to maintain consistency across the fabric. The coherence directory interface may maintain an embedded cache of recent directory entries, synchronized with global or regional directory managers distributed throughout the fabric.

For packets that include computational semantics, the MC-NIC 1300 integrates an atomic and reduction execution engine 1340. The atomic logic executes indivisible read-modify-write operations such as fetch-and-add, compare-and-swap, bitwise logical transformations, and typed floating-point operations. The reduction logic performs in-network aggregation by combining multiple partial results received from distributed sources into a consolidated value. The reduction engine may support associative and commutative operations such as addition, minimum, maximum, and bitwise AND/OR, as well as programmable arithmetic kernels defined by user software. The engine operates directly on data fetched from the local memory or on operands carried in packet payloads, committing the results to memory or returning them in completion packets.

Adjacent to the atomic and reduction execution engine is the vector operation unit 1345. This unit interprets vector descriptor fields in MF-TLP packets and expands them into multiple discrete memory accesses or update commands. The vector unit can issue multiple read or write operations in parallel using an internal micro-scheduler that ensures address-ordering and completion aggregation. The unit consolidates results into a single response packet or into a sequence of batched completions depending on the descriptor type. The vector operation unit may also support fused operations, such as read-modify-write sequences or scatter/gather updates combined with atomic arithmetic transformations.

The MC-NIC 1300 further includes a transaction scheduler and QoS controller 1350. The scheduler maintains multiple queues corresponding to transaction classes (e.g., coherence, atomic, vector, bulk transfer) and applies programmable priority weights or latency targets. The scheduler enforces tenant-specific quotas derived from tenant identifiers and priority tags in packet headers. In certain embodiments, a deadline-aware arbiter ensures that coherence messages and control transactions receive precedence under load, while bandwidth-intensive bulk transfers are rate-limited to avoid congestion. The QoS controller may interface directly with higher-level orchestration software that dynamically adjusts priorities based on workload characteristics or service-level objectives.

The response generator 1355 constructs completion or acknowledgment packets once an operation is finalized. Each response includes the corresponding transaction identifier, status indicators (success, error, timeout), and, where applicable, data payloads or updated values. The response generator also aggregates results for vectorized or reduction transactions, encoding them into a single MF-TLP response to minimize return-path traffic.

In one embodiment, the MC-NIC 1300 further comprises an extension processor or programmable logic fabric 1365. This block provides reconfigurable compute capability within the NIC, enabling user-defined extensions such as compression, encryption, checksum computation, or domain-specific arithmetic kernels. The extension processor may be implemented using field-programmable gate array (FPGA) fabric or a lightweight RISC-V core. Configuration data for the extension processor can be loaded at runtime via control registers accessible through the host interface or the management plane.

To ensure data reliability and integrity, the MC-NIC 1300 may integrate error detection and correction mechanisms. These mechanisms compute CRCs for outgoing packets, validate incoming packets, and perform retransmission in case of detected corruption. The MC-NIC may also implement end-to-end retry semantics based on acknowledgment control fields embedded in MF-TLP headers, ensuring that even under congestion or transient network errors, all memory transactions complete deterministically and coherently.

In some embodiments, the MC-NIC 1300 interfaces with a management controller responsible for firmware, telemetry, and monitoring. The management controller maintains counters for transaction latency, queue utilization, and error statistics, and may expose them to external orchestration systems through a control API. The controller can dynamically reconfigure operational parameters, update firmware, and apply patches to parsing microcode or scheduling logic without disrupting in-flight transactions.

All modules within the MC-NIC 1300 are coupled by an internal on-chip interconnect 1385 providing high-bandwidth, low-latency communication among functional blocks. In some embodiments, the interconnect employs a hierarchical crossbar or a network-on-chip (NoC) topology with dedicated channels for control, data, and coherence traffic. The design allows concurrent processing of multiple transactions, enabling full-duplex operation and scalability across increasing link speeds and core counts.

FIG. 13 thus provides a comprehensive view of the internal architecture and functional composition of the enhanced MC-NIC. Each sub-module works collaboratively to terminate MF-TLP packets, execute memory operations proximate to data, and maintain coherence across the distributed memory fabric. By offloading memory transactions from host processors to network interfaces, the MC-NIC reduces latency, minimizes CPU overhead, and converts the interconnect into a fully programmable, compute-capable memory fabric—a foundational component of the coherent memory system.

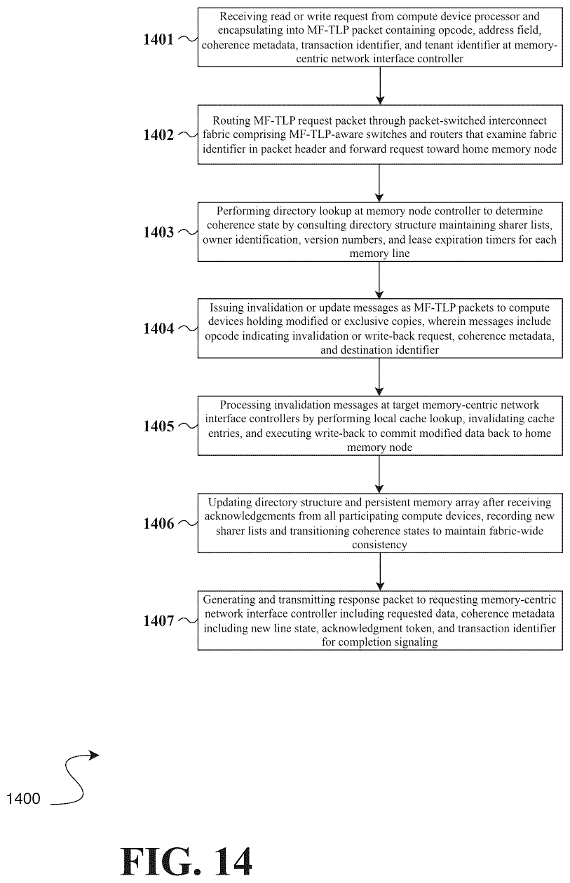

FIG. 14 is a flow diagram illustrating an exemplary cache coherence protocol flow 1400 implemented across a distributed coherent memory fabric using the Memory-Fabric Transaction Layer Protocol (MF-TLP). The protocol flow depicts a complete transaction sequence demonstrating how directory-based coherence is maintained across multiple compute devices and memory nodes interconnected by a packet-switched fabric, ensuring that all devices within the system observe a consistent and up-to-date view of shared memory data even as concurrent read, write, atomic, and reduction operations occur within the fabric.

The coherence flow begins at step 1401, where a compute device processor initiates a memory operation—either a read request or write request—targeting a cache line or memory range that may be hosted on a remote memory node. The compute device's memory-centric network interface controller (MC-NIC) receives this request and encapsulates it into an MF-TLP packet. The packet contains several critical fields: an opcode indicating the operation type (read, write, atomic, or reduction), an address field identifying the target memory location using a fabric identifier (FID) or object handle, coherence metadata specifying the current state of the requester's local cache line (typically “invalid” for initial reads or “shared” for upgrade requests), a transaction identifier for matching subsequent responses, and a tenant identifier for governance, quality-of-service scheduling, and multi-tenant isolation. The MC-NIC may also include additional fields such as priority tags, vector descriptors for multi-address operations, and security extensions depending on the operation characteristics and system configuration.

At step 1402, the MF-TLP request packet is transmitted into and routed through the packet-switched interconnect fabric. The fabric comprises multiple layers of MF-TLP-aware switches and routers that provide intelligent packet forwarding capabilities. Each switching element along the path examines the fabric identifier (FID) encoded within the packet header to determine the appropriate forwarding path. The switches parse the MF-TLP header without accessing the payload, enabling line-rate forwarding and stateless routing for most operations. The routers apply programmable routing policies based on coherence metadata, priority fields, and network topology, forwarding the request toward the home memory node responsible for managing the targeted address range. In some embodiments, intermediate switches may maintain transient coherence tracking tables or employ multicast capabilities for efficient invalidation propagation, particularly in large-scale fabrics with hierarchical coherence domains. The fabric may also implement congestion control mechanisms, explicit congestion notification (ECN), and quality-of-service (QoS) prioritization to ensure coherence messages receive appropriate scheduling precedence over bulk data transfers.

Upon arrival at the destination memory node in step 1403, the node controller extracts the MF-TLP request packet and performs a directory lookup operation. The node controller consults its directory structure, which maintains comprehensive coherence metadata for each memory line managed by the node. Each directory entry includes multiple fields: the line address or range identifier, current owner identification specifying which compute device holds exclusive or modified rights, a list of sharers enumerating all compute devices with valid shared copies, version numbers or epoch counters for tracking data freshness, and optional lease expiration timers for time-bounded coherence protocols. The directory lookup determines the current coherence state of the requested memory line—whether it exists in an invalid, shared, exclusive, or modified state across the distributed system. For read requests, the controller checks whether any compute device currently holds a modified or exclusive copy. For write requests, the controller identifies all sharers that must be invalidated before ownership can be transferred. The directory structure may be implemented as a centralized table within the memory node, a distributed hash table partitioned across multiple nodes, or a hierarchical structure with local rack-level directories and global spine-level coordination.

Based on the directory lookup results, step 1404 determines whether coherence maintenance actions are required. If the directory indicates that other compute devices hold modified, exclusive, or shared copies of the requested memory line—and the incoming request requires exclusive access or updated data—the node controller generates and issues invalidation or update messages. These coherence messages are encoded as specialized MF-TLP packets with opcodes indicating invalidation requests, write-back commands, or ownership transfer directives.

Each message includes the memory line address, coherence metadata specifying the current version and required state transition, and a destination identifier referencing the specific compute device's MC-NIC that must process the message. For write requests to shared lines, the node controller issues invalidation messages to all sharers enumerated in the directory. For read requests when another device holds a modified copy, the controller issues a write-back request to the owning device. These coherence messages are transmitted through the same interconnect fabric used for data operations, leveraging the fabric's routing infrastructure and potentially receiving elevated priority scheduling to minimize coherence latency. In embodiments supporting multicast or broadcast capabilities, a single invalidation packet may be replicated by fabric switches to reach multiple destinations simultaneously.

At step 1405, the target compute devices receive and process the invalidation or update messages at their respective memory-centric network interface controllers. Upon receiving a coherence message, each MC-NIC performs a local cache lookup to determine if the specified memory line is present in its cache hierarchy. If the line exists and is valid, the MC-NIC must take appropriate action based on the message type and the line's current state. For invalidation messages, the MC-NIC marks the cache entry as invalid, preventing future local accesses until the line is re-fetched. If the MC-NIC holds the line in a modified state—meaning it contains the most recent version of the data—it must execute a write-back operation before invalidation. The write-back is performed by constructing an MF-TLP response packet containing the modified data in the payload, coherence metadata indicating a “Modified-to-Shared” or “Modified-to-Invalid”state transition, and the transaction identifier from the original invalidation request. This write-back packet is transmitted back through the fabric to the home memory node, ensuring that the authoritative copy of the data is updated before any other device receives access. The MC-NIC then sends an acknowledgment message to the memory node controller confirming that the invalidation has been processed and any required write-back has been initiated. This acknowledgment is critical for maintaining ordering guarantees and ensuring the memory node can safely proceed with the original requesting operation.

Step 1406 describes the memory node's processing after receiving write-back data and acknowledgments from all participating compute devices. The node controller collects acknowledgments from every device that was sent an invalidation or update message, ensuring that all coherence actions have completed before finalizing the operation. If write-back data was received, the controller commits this data to the persistent memory array, updating the authoritative copy maintained by the memory node. The directory structure is then updated to reflect the new coherence state: for read operations, the requesting device is added to the sharer list and the line state is transitioned to “Shared”; for write operations, the requesting device is designated as the exclusive owner, all previous sharers are removed from the list, and the line state is transitioned to “Modified” or “Exclusive.” The directory may also update version numbers, increment epoch counters, or establish new lease timers depending on the coherence protocol variant in use. In hierarchical coherence implementations, this step may involve propagating directory updates to higher-level coordination points or synchronizing distributed directory replicas. The updated directory ensures that future operations targeting the same memory line will correctly reflect the current distribution of valid copies across the fabric.

Finally, at step 1407, the memory node controller generates and transmits a response packet back to the original requesting compute device. This response packet is constructed as an MF-TLP packet containing several components: the requested data in the payload (for read operations) or a status confirmation (for write operations), coherence metadata indicating the new cache line state that the requester should adopt (“Shared” for reads, “Modified” or “Exclusive” for writes), an acknowledgment token confirming successful completion of all coherence operations, and the transaction identifier matching the original request for proper response correlation. Additional fields may include quality-of-service indicators, completion timestamps, or security validation tokens. The response packet is routed through the interconnect fabric back to the requesting device's MC-NIC, which receives the packet, validates its contents, and takes final actions. For read responses, the MC-NIC inserts the returned data into its local cache hierarchy with the specified coherence state and signals completion to the processor, allowing the original memory operation to complete. For write responses, the MC-NIC records the granted ownership state, enabling subsequent local writes without additional fabric transactions until another device requests the line. The transaction identifier enables the MC-NIC to match the response to any pending operations and properly sequence completions in the presence of out-of-order fabric delivery.

This complete coherence protocol flow demonstrates how MF-TLP-based directory coherence maintains fabric-wide consistency across distributed memory resources. By encoding all coherence metadata, invalidation commands, write-back data, and acknowledgments as routable MF-TLP packets, the system achieves scalable cache coherence without centralized arbitration bottlenecks. The protocol supports various optimizations including lease-based coherence to reduce invalidation traffic for read-dominated workloads, version-based tracking to minimize explicit coherence messages, hierarchical directory structures that localize coherence operations within racks or regions, and predictive invalidation mechanisms that anticipate access patterns to preemptively issue coherence messages. Error handling and reliability are ensured through transaction identifiers that enable retransmission of lost messages, timeout mechanisms for detecting failed participants, and fabric-level retry logic that guarantees delivery even under congestion or transient errors. The flow scales efficiently across thousands of compute nodes while maintaining microsecond-class coherence latency, enabling the memory fabric to support both traditional cache-coherent shared memory semantics and advanced operations such as atomic read-modify-write sequences, vectorized scatter-gather accesses, and collective reduction operations—all with full coherence guarantees maintained transparently by the MF-TLP protocol infrastructure.

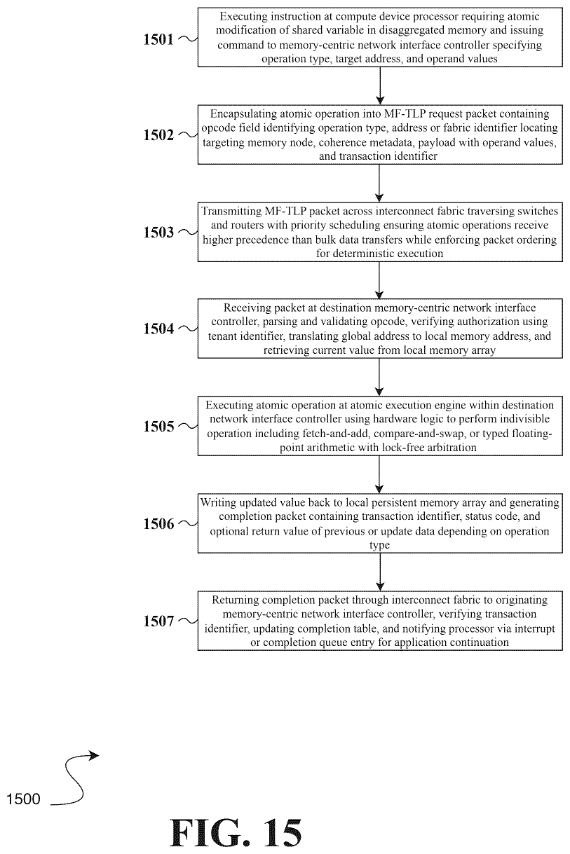

FIG. 15 is a flow diagram illustrating an exemplary method for atomic operation flow 1500 implemented within the coherent memory fabric using the Memory-Fabric Transaction Layer Protocol (MF-TLP). The flow describes the complete sequence by which a compute device issues, transmits, executes, and completes an atomic memory operation—such as a fetch-and-add, compare-and-swap, or typed floating-point reduction—directly at a memory-centric network interface controller (MC-NIC) proximate to the target memory node. This process enables in-network atomicity, ensuring that complex synchronization and update primitives are performed without round-trip latency to host processors or software-managed locks, thereby providing hardware-enforced atomic semantics across disaggregated memory resources in the distributed fabric.

The atomic operation sequence begins at step 1501, where a processor within a compute device executes an instruction requiring an atomic modification of a shared variable located in disaggregated memory. These atomic operations are fundamental primitives for distributed computing and include various operation types: incrementing distributed counters used for statistics gathering or resource allocation, updating shared hash-table entries in distributed key-value stores, performing conditional swaps for lock-free synchronization mechanisms, accumulating gradients during distributed machine learning training, or executing compare-and-swap operations for implementing wait-free data structures. When the processor encounters such an instruction, it issues a command to its local memory-centric network interface controller, specifying several critical parameters: the operation type (such as atomic add, atomic subtract, atomic minimum, atomic maximum, compare-and-swap, test-and-set, fetch-and-add, fetch-and-or, or typed floating-point operations), the target address identifying the memory location to be modified, and one or more operand values that will be used in the computation. The processor may issue this command through various mechanisms including direct register writes to the MC-NIC's memory-mapped control registers, enqueueing a descriptor into a dedicated atomic operation queue, or invoking a runtime library function that formats the request according to the fabric's API specifications. The MC-NIC driver or runtime library receives this command and formats it into a standardized memory operation descriptor containing all necessary fields, then enqueues the descriptor into the NIC's transmission queue for subsequent processing and packetization.

At step 1502, the memory-centric network interface controller encapsulates the atomic operation into an MF-TLP request packet. This encapsulation process involves constructing a properly formatted packet according to the MF-TLP protocol specification. The packet header includes multiple essential fields: an opcode field that precisely identifies the atomic operation type, distinguishing between different atomic variants such as ATOMIC_FETCH_ADD for fetch-and-add operations, ATOMIC_CAS for compare-and-swap operations, ATOMIC_SWAP for unconditional exchange operations, ATOMIC_MIN or ATOMIC_MAX for finding extreme values, or ATOMIC_FADD_FP32 for single-precision floating-point atomic additions. The header also contains an address field or fabric identifier (FID) that locates the target memory node within the distributed fabric topology, enabling the packet to be routed through the interconnect to the correct destination. A coherence metadata field indicates the requester's current cache state and consistency requirements, specifying whether the operation requires strict ordering, release consistency, or relaxed memory semantics. The packet payload carries the operand or operands to be applied during the atomic computation—for instance, the increment value for a fetch-and-add operation, both the expected comparison value and the new replacement value for a compare-and-swap operation, or the partial result value for a reduction operation. Additional header fields include a transaction identifier that uniquely associates this request with any subsequent response or completion message, enabling proper matching in the presence of out-of-order delivery or multiple concurrent operations; optional acknowledgment control bits that specify whether the operation requires explicit completion notification or can proceed with fire-and-forget semantics; tenant and priority identifiers for multi-tenant governance and quality-of-service enforcement; and optional extension headers for security, encryption, or advanced routing directives. The MC-NIC may also include retry counters, timeout values, and error-checking codes to ensure reliable delivery and execution even under transient network conditions.

In step 1503, the constructed MF-TLP packet is transmitted across the interconnect fabric, traversing the packet-switched network infrastructure connecting compute devices and memory nodes. The packet may traverse multiple MF-TLP-aware switches and routers as it propagates through the fabric topology, which may be organized as a leaf-spine configuration, torus, dragonfly, or hierarchical mesh depending on the deployment scale and interconnection requirements. During this traversal, the interconnect fabric provides several critical services to ensure proper atomic operation delivery and execution. The fabric enforces packet ordering within atomic operation classes, guaranteeing deterministic execution semantics—this means that multiple atomic operations targeting the same address from the same source will arrive and execute in the order they were issued, preventing race conditions and ensuring predictable behavior. The priority field within the packet header ensures that atomic operations receive higher scheduling precedence than bulk data transfers or large vector transactions at every switching element along the path, thereby minimizing synchronization latency and ensuring that time-critical atomic updates complete quickly even under heavy fabric load. Some embodiments utilize fabric multicast optimizations, allowing a single atomic packet to be replicated by intelligent switches and delivered to multiple destination nodes simultaneously—this capability is particularly valuable for updating replicated counters, broadcasting synchronization signals, or maintaining consistency across mirrored data structures. The switches and routers parse the MF-TLP headers without accessing the payload, enabling line-rate forwarding that maintains high throughput even for small atomic operation packets. Advanced fabric implementations may provide additional features such as congestion notification to dynamically adjust transmission rates, explicit flow control to prevent buffer overflow at destination NICs, or quality-of-service shaping to balance atomic operation traffic against other workload types sharing the same physical links.

Upon arrival at the destination memory node in step 1504, the MF-TLP packet is received and processed by the memory-centric network interface controller associated with that node. The protocol parsing engine within the destination MC-NIC extracts and decodes the packet header, identifying it as an atomic operation request and determining the specific operation type from the opcode field. The NIC performs several validation and authorization checks: it verifies that the opcode is recognized and supported by the hardware implementation, confirms that the operation is permitted by checking the tenant identifier against access control policies to enforce multi-tenant isolation and security boundaries, and validates that the packet has not been corrupted during transmission by checking error-detection codes or cryptographic authentication fields if security extensions are enabled. Once validated, the address translation and mapping unit within the MC-NIC translates the global fabric address or object identifier into a local physical memory address within the node's address space. This translation may involve consulting a translation lookaside buffer (TLB) or address translation cache to accelerate repeated accesses, applying programmable mapping tables that enable memory virtualization and flexible address assignment, or performing permission checks to ensure the requesting device has appropriate read-modify-write access rights to the target location. After successful address translation, the memory access engine initiates a read operation to retrieve the current value stored at the targeted memory location from the local memory array. This retrieval accesses the persistent memory subsystem, which may consist of DRAM, high-bandwidth memory (HBM), phase-change memory (PCM), or other memory technologies, reading the data that will serve as input to the atomic computation. The retrieved value is temporarily held in the MC-NIC's internal registers or buffers, ready to be processed by the atomic execution engine in the subsequent step.

Step 1505 describes the execution of the atomic operation itself, performed entirely within the hardware logic of the atomic execution engine located in the destination memory-centric network interface controller. The atomic engine is a specialized hardware block designed to execute indivisible read-modify-write sequences without software intervention or lock acquisition. Upon receiving the retrieved memory value and the operand(s) from the packet payload, the engine performs the requested computation according to the operation type. For a fetch-and-add operation, the engine adds the operand value to the retrieved data, producing a sum that will be written back while potentially returning the original value as the completion result. For a compare-and-swap operation, the engine compares the retrieved stored value against an expected operand provided in the packet—if they match exactly, indicating that no other operation has modified the location since it was last observed, the engine replaces the value with a new operand also provided in the packet; if they do not match, the operation fails and returns the current value without modification, allowing the requesting software to retry with updated expectations. For a typed floating-point atomic operation, the engine applies arithmetic using hardware floating-point units that support single-precision (FP32), double-precision (FP64), or half-precision (FP16) formats, enabling operations such as atomic floating-point addition for gradient accumulation in neural network training or atomic minimum/maximum for finding extreme values in analytics workloads. The atomic engine guarantees that these operations are truly indivisible—meaning that no other concurrent operation can interleave and observe or modify the same memory location during the read-modify-write sequence, ensuring that the atomic semantics are preserved even under heavy contention from multiple compute devices attempting simultaneous updates. To achieve this indivisibility, the atomic engine employs lock-free hardware arbitration mechanisms that serialize concurrent atomic requests targeting the same address or cache line. In some embodiments, a conflict resolution queue maintains pending operations and ensures they execute in transaction-identifier order, providing deterministic behavior and preventing livelock conditions. In other embodiments, the MC-NIC leverages coherence metadata from the directory structure to identify any compute devices that currently hold cached copies of the target memory line—before committing the atomic result, the NIC may proactively trigger invalidation messages to these sharers, ensuring that the updated value is globally visible and that no stale cached copies remain in the fabric after the atomic operation completes.

Following the completion of the arithmetic or logical transformation in step 1506, the atomic execution engine writes the updated value back to the local persistent memory array, committing the result of the atomic operation to the authoritative memory location. This write-back operation ensures that the modified data is durably stored and becomes the new canonical value for subsequent read or atomic operations targeting the same address. After completing the write-back, the MC-NIC generates a completion packet that will be returned to the requesting compute device to signal successful execution and provide any required result data. The completion packet is constructed as an MF-TLP response containing several components: the transaction identifier matching the original request, enabling the requesting MC-NIC to correlate the completion with the outstanding operation and update its internal tracking structures; a status code indicating whether the operation succeeded, failed due to a comparison mismatch (in the case of compare-and-swap), or encountered an error condition such as memory access violation or data corruption; and an optional return value containing either the previous value (for fetch-and-add and similar operations that return the pre-modification state), the updated value (for operations that return the post-modification state), or a success/failure indicator (for conditional operations like compare-and-swap). The specific content of the return value depends on the operation type as encoded in the original opcode—some operations inherently return values while others may suppress responses to reduce network traffic for fire-and-forget updates. In some embodiments, the destination MC-NIC performs additional verification steps before finalizing the completion packet. An error detection and correction block checks data integrity using techniques such as ECC validation on the memory read, CRC verification on the packet payload, or end-to-end integrity checks spanning the entire atomic operation sequence. If an error is detected—such as a bit flip in memory, packet corruption during transmission, or inconsistent state in the coherence directory—the MC-NIC issues a negative acknowledgment (NACK) packet to the requester containing a detailed error code and a retry recommendation, potentially including diagnostic information to aid in error recovery or system debugging. The requesting MC-NIC can then retransmit the atomic operation using its built-in retry logic, employing exponential backoff or alternative routing paths to work around transient faults and ensure reliable completion even in the presence of network congestion, link errors, or memory soft errors.

At step 1507, the completion packet is returned through the interconnect fabric following a reverse path back to the originating compute device's memory-centric network interface controller. The fabric routes the completion packet using the same infrastructure that carried the original request, potentially taking advantage of any path diversity or adaptive routing capabilities to optimize latency or avoid congested links. Upon receiving the completion packet, the originating MC-NIC performs several processing steps to finalize the atomic operation from the requester's perspective. The NIC verifies that the transaction identifier in the completion packet matches an outstanding atomic operation in its internal tracking structures, confirming that this completion corresponds to a previously issued request and is not a duplicate or spurious message. Once matched, the NIC updates its completion table or operation tracking registers to record that the atomic operation has finished, freeing any associated resources such as transaction identifiers, retry timers, or queue entries. If the completion packet includes a return value—such as the previous value from a fetch-and-add or the comparison result from a compare-and-swap—the NIC extracts this data and makes it available to the requesting processor or application software. The notification mechanism varies by implementation: the MC-NIC may signal the processor via a hardware interrupt that triggers an interrupt service routine in the operating system or runtime, write a completion queue entry to a memory-mapped structure that the application polls or monitors, update a memory location specified by the original request to allow synchronous waiting, or directly inject the result into the processor's cache hierarchy or register file if supported by the system architecture. For fetch-and-add or compare-and-swap operations where the application needs the returned value, this data is made available so that software can observe the previous state, determine whether a conditional operation succeeded or failed, or use the result in subsequent computations. With the completion notification delivered, the compute device can continue execution without requiring any global locks, software-based synchronization barriers, or additional round-trips to memory—the atomic operation has been completed entirely in hardware using the fabric's distributed mechanisms, minimizing latency and eliminating the overhead traditionally associated with software synchronization primitives.

The atomic operation flow 1500 supports numerous advanced features and optimizations that extend beyond the basic execution sequence. In certain embodiments, atomic operations may be fused with other transaction types to create powerful composite primitives. Vector atomic operations allow a single MF-TLP packet to carry a vector descriptor specifying multiple memory addresses, with the atomic engine applying the same atomic function to each address in sequence or in parallel—this enables efficient batch updates for scenarios like updating multiple counters, modifying scattered hash table entries, or accumulating values across sparse data structures. Atomic-reduction hybrid operations combine multiple operand packets arriving from different source compute devices, with in-network aggregation logic merging the operands before committing a single consolidated result to memory—this dramatically reduces memory bandwidth and contention for collective operations such as all-reduce in distributed machine learning, where thousands of gradient contributions must be accumulated into shared parameter tensors. These fused operations enable extremely high throughput, supporting millions of atomic updates per second across the distributed fabric, which is essential for workloads such as neural network training with data parallelism, real-time analytics pipelines processing streaming events, or graph analytics algorithms that perform massive numbers of edge weight updates.

The system incorporates predictive atomic prefetching and speculative reservation mechanisms to further reduce latency. Predictive logic within the MC-NIC monitors access patterns over time, detecting repeated atomic operations targeting the same addresses—common scenarios include frequently updated counters for request statistics, regularly modified model parameters during iterative training, or hotspot locations in concurrent data structures. When these patterns are detected, the MC-NIC can pre-stage the corresponding cache lines into the NIC's local SRAM or cache hierarchy before receiving the next atomic request, effectively hiding the memory access latency and ensuring near-zero execution time once the request arrives. Speculative reservation mechanisms allow an MC-NIC to acquire exclusive ownership of a memory line in advance when patterns suggest imminent atomic operations, preventing the need for coherence negotiations during the critical path of atomic execution. These predictive techniques significantly improve performance for workloads with regular or predictable atomic access patterns while maintaining full correctness through rollback mechanisms if predictions prove incorrect.

The atomic operation framework provides flexible ordering and consistency guarantees to balance correctness requirements against performance optimization opportunities. The MF-TLP protocol supports multiple consistency models indicated by a consistency field in the packet header. Under sequential consistency, each atomic operation is observed globally in the exact order it was issued by each compute device, providing the strongest guarantees but potentially limiting performance due to strict serialization requirements. Release consistency enforces ordering only at explicitly marked synchronization boundaries such as lock acquire and release operations, allowing independent atomic operations to reorder freely between synchronization points while still maintaining correct behavior for properly synchronized programs. Relaxed consistency permits aggressive reordering of atomic operations targeting independent addresses, maximizing throughput by allowing the hardware to execute operations opportunistically without waiting for prior operations to complete, though this requires careful programming to avoid unexpected behaviors. The system may also support hybrid models where different regions of memory or different operation types are governed by different consistency rules, allowing fine-grained control over the performance-correctness tradeoff based on application requirements.

Advanced embodiments implement hierarchical atomic domains that enable the system to scale across thousands of compute nodes while maintaining strict correctness. In a hierarchical configuration, atomicity is enforced locally within rack-level NIC clusters using fast local arbitration mechanisms, while global atomicity across racks is coordinated through higher-level spine controllers that maintain cross-rack ordering and consistency. This hierarchical approach allows most atomic operations to complete within a local domain with minimal latency, reserving the more expensive global coordination only for operations that genuinely span multiple domains. The interconnect fabric's routing hardware can further optimize atomic traffic through request coalescing—when multiple atomic packets from different sources are destined for the same target address and are pending in switch buffers, the switches can merge redundant fetch-and-add operations into a single combined update that adds all operands together, dramatically reducing wire traffic and destination NIC load while preserving the cumulative effect of all individual operations.

Error handling and reliability mechanisms ensure robust atomic operation completion even under adverse conditions. Each atomic operation carries sufficient metadata to enable end-to-end error detection, including checksums on the packet payload, sequence numbers for detecting lost or duplicated packets, and timestamps for identifying stale or delayed operations. If errors are detected at any stage—memory corruption, packet transmission errors, directory inconsistencies, or timeout conditions—the system employs automatic retry logic with configurable retry limits and exponential backoff to recover from transient faults. For persistent errors indicating hardware failures or misconfiguration, the MC-NIC generates detailed error logs that can be collected by system management software, enabling proactive maintenance and fault isolation.

This flow illustrates the complete lifecycle of an MF-TLP atomic operation—from request generation at the compute device, through in-fabric routing with priority scheduling, to hardware-level execution with lock-free arbitration at the destination MC-NIC, and finally through completion notification back to the originator. This flow demonstrates how the coherent memory fabric provides hardware-enforced atomic semantics across disaggregated memory resources, eliminating the need for software locking mechanisms, reducing synchronization overhead from milliseconds to microseconds, and enabling scalable distributed synchronization for demanding workloads including neural network training with thousands of workers accumulating gradients into shared parameters, distributed counters and statistics collection across data center infrastructure, transactional key-value stores maintaining consistency without database locks, fine-grained graph analytics performing atomic edge weight updates during iterative algorithms, and real-time streaming systems aggregating partial results from distributed processing nodes. By offloading atomic execution to the network interface controllers and leveraging the fabric's routing and arbitration infrastructure, the system transforms synchronization from a performance bottleneck into a near-zero-overhead operation, fundamentally enabling new classes of distributed algorithms and applications that were previously impractical due to synchronization costs.

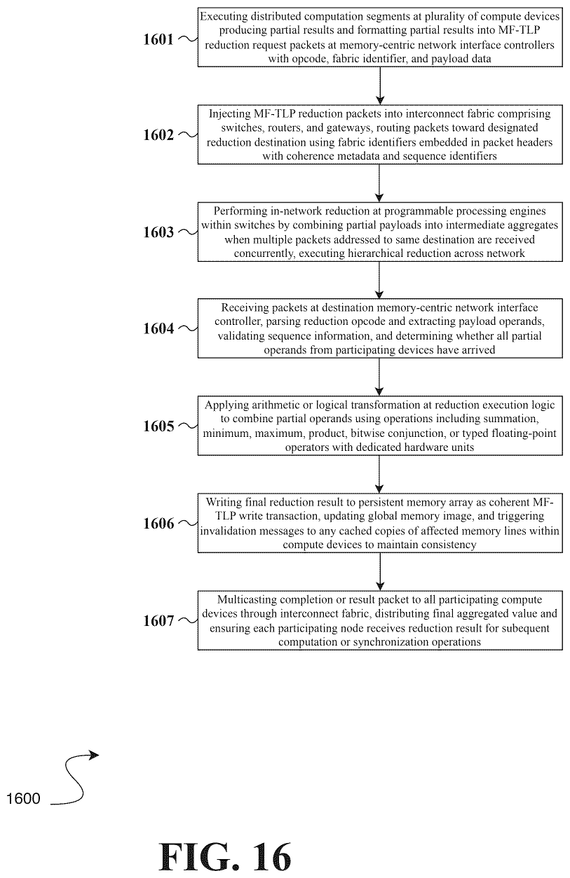

FIG. 16 is a flow diagram illustrating an exemplary method for reduction operation flow 1600 carried out within the coherent memory fabric using the Memory-Fabric Transaction Layer Protocol (MF-TLP). The flow demonstrates how multiple compute devices can concurrently transmit partial results into the packet-switched fabric, where these results are aggregated either by memory-centric network interface controllers or by in-network reduction engines located within fabric switches or routers, with the final aggregated value then written to memory and optionally distributed to all participating devices. This process provides a hardware-accelerated implementation of collective operations—such as ALL-REDUCE, REDUCE-SCATTER, ALL-GATHER, or gradient accumulation—without requiring CPU intervention, software synchronization barriers, or centralized coordination by host processors. The reduction flow enables efficient execution of distributed machine learning training where gradients from thousands of workers must be accumulated, high-performance analytics queries that aggregate partial results from distributed data processing, parallel scientific simulations that combine intermediate computations, and any workload requiring collective communication patterns with minimal latency and maximum throughput.

The reduction operation sequence begins at step 1601, where a plurality of compute devices each execute a segment of a distributed computation that produces a partial result contributing to a larger aggregate calculation. These partial results represent intermediate outputs from parallelized workloads that have been decomposed across multiple processing nodes for concurrent execution. Common examples include gradient vectors generated during neural network backpropagation, where each compute device processes a different batch of training data and produces gradients representing the required parameter updates for its assigned batch; partial sums or aggregates from distributed analytics queries, where each node processes a partition of a large dataset and computes local statistics, counts, or accumulations; partial results from Monte Carlo simulations, where each device runs independent simulation trials and produces statistical samples that must be combined; intermediate values from iterative numerical solvers, where each node computes updates for its assigned portion of a problem domain; or partial reductions from map-reduce style computations, where mappers have produced intermediate key-value pairs that must be reduced by combining values with identical keys. Each compute device includes a local memory-centric network interface controller that is responsible for formatting these partial results for transmission across the fabric. The MC-NIC receives the partial result data from the compute device's processor or accelerator, either through direct memory access (DMA) from memory buffers, explicit writes to NIC control registers, or descriptor-based queue submissions. The MC-NIC then formats this data into one or more MF-TLP reduction request packets, constructing properly formatted packets according to the protocol specification. Each packet carries an opcode field indicating a reduction operation and specifying the particular reduction function to be applied—such as REDUCE_SUM for summation, REDUCE_MIN for minimum value selection, REDUCE_MAX for maximum value selection, REDUCE_PROD for product multiplication, REDUCE_AND or REDUCE_OR for bitwise logical operations, or typed floating-point operators like REDUCE_FP32_ADD for single-precision floating-point addition. The packet includes a fabric identifier (FID) that specifies the reduction target, identifying the destination node or memory location where the final aggregated result should be stored. The payload contains the actual partial data values to be aggregated—these may be scalar values, vector arrays, matrix blocks, or complex data structures depending on the operation requirements. Additional fields in the packet header include coherence metadata specifying consistency requirements, sequence identifiers or epoch numbers that allow the system to distinguish between different reduction operations and ensure that partial results from the same logical reduction are combined correctly, reduction group identifiers that enable multiple independent reductions to proceed concurrently without interference, segment indexes that specify the ordering of partial contributions for operations where sequence matters, transaction identifiers for tracking completion and enabling error recovery, and tenant and priority tags for governance and quality-of-service enforcement in multi-tenant environments.

At step 1602, the MF-TLP reduction packets from all participating compute devices are injected into the interconnect fabric, entering the packet-switched network infrastructure that connects compute nodes, memory nodes, and storage resources. The fabric comprises multiple layers of MF-TLP-aware switches, routers, and gateways arranged in a topology such as leaf-spine, fat-tree, dragonfly, or hierarchical mesh configuration optimized for collective communication patterns. As packets enter the fabric, they are routed toward a designated reduction destination using the fabric identifiers embedded in their packet headers. The routing infrastructure examines these identifiers and forwards packets along paths determined by the fabric's routing tables and algorithms, which may employ static routing based on preconfigured paths, adaptive routing that selects paths dynamically based on current congestion levels, or topology-aware routing that exploits the structure of reduction trees for optimal aggregation patterns. The packets carry coherence metadata that ensures proper memory consistency semantics throughout the reduction operation, preventing race conditions or inconsistent views of partial results. Sequence identifiers enable the destination and intermediate aggregation points to correctly order and combine packets even when they arrive out-of-order due to adaptive routing or variable path latencies. The fabric may implement priority scheduling for reduction packets, elevating them above bulk data transfers to ensure low-latency completion of time-critical collective operations. In advanced embodiments, the fabric supports multicast or broadcast capabilities that enable efficient distribution of intermediate or final results to multiple destinations simultaneously, which is particularly valuable for operations like all-reduce where every participant needs to receive the final aggregated value. The switches and routers maintain internal buffers and flow control mechanisms to prevent packet loss during periods of congestion, ensuring that all partial contributions eventually reach their destination or aggregation point. Quality-of-service mechanisms enforce per-tenant bandwidth allocations and latency targets, allowing multiple independent applications or training jobs to share the same physical fabric while maintaining performance isolation and fairness guarantees.

Step 1603 describes a critical optimization that distinguishes MF-TLP reduction operations from traditional network-based collective operations: the performance of in-network reduction directly within the fabric infrastructure itself. Some embodiments of the interconnect fabric incorporate programmable in-network processing engines within the switches and routers, providing computational capabilities beyond simple packet forwarding. These processing engines are equipped with arithmetic logic units, accumulator registers, and control logic capable of executing reduction operations on packet payloads as they traverse the network. When multiple reduction packets addressed to the same destination are received concurrently at a switch—whether they arrive simultaneously on different input ports or are queued in buffers waiting for transmission—the in-network processing engine can combine these partial payloads into intermediate aggregates before forwarding them downstream toward the destination. This combination is performed according to the reduction function specified in the packet opcode: for summation operations, the engine adds the payload values together; for minimum or maximum operations, it compares values and selects the appropriate extreme; for logical operations, it applies bitwise conjunction or disjunction. By performing this aggregation within the fabric switches rather than waiting until all packets reach the final destination, the system achieves hierarchical reduction across the network topology. In a multi-level switching hierarchy, first-level switches aggregate packets from locally connected compute devices, producing intermediate results that are forwarded to second-level switches, which further aggregate these intermediates, and so on up the hierarchy until the final aggregate reaches the root or destination node. This hierarchical approach dramatically reduces the load on the destination MC-NIC, which would otherwise need to receive and process packets from potentially thousands of sources sequentially. It also reduces overall network bandwidth consumption, as fewer packets traverse the higher levels of the switching hierarchy, and decreases end-to-end latency by overlapping computation with communication—aggregation begins as soon as the first packets arrive at each switch rather than waiting for all packets to traverse the full network path. The in-network engines maintain local registers or small buffers to hold partial aggregates, tracking which reduction group and sequence number each aggregate corresponds to so that independent reductions can proceed concurrently without interference. These engines may implement pipelined architectures that allow continuous streaming of reduction operations at line rate, processing new packets every clock cycle without stalling even as aggregation proceeds. Hardware support for various data types—including 8-bit, 16-bit, 32-bit, and 64-bit integers, single-precision and double-precision floating-point, or even custom types like brain floating-point (bfloat16)—ensures compatibility with diverse workload requirements. Some implementations provide programmable reduction templates that allow switches to be configured with custom aggregation functions beyond the standard arithmetic operations, enabling application-specific optimizations or novel collective communication patterns.

Upon reaching the destination node in step 1604, which may be a dedicated reduction coordination node, a memory node hosting the target address for result storage, or a compute node designated as the root of a reduction tree, the arriving reduction packets are received and processed by the destination memory-centric network interface controller. The protocol parsing engine within the MC-NIC examines incoming packets, decodes the MF-TLP headers, and identifies them as reduction operation packets based on the opcode field. The parsing engine extracts the payload operands—the partial or intermediate aggregated values carried by each packet—along with associated metadata including the reduction group identifier, sequence number, transaction identifier, and any extension headers providing additional context. Once extracted, this information is forwarded to reduction tracking logic within the MC-NIC that maintains state for in-progress reduction operations. The MC-NIC validates the sequence information carried in each packet, checking that sequence numbers or epoch counters match the expected values for the current reduction operation and detecting any gaps, duplicates, or out-of-sequence arrivals that might indicate packet loss or misordering. The MC-NIC determines whether the received packet completes a reduction epoch—meaning that all expected partial operands from participating devices have now arrived—or whether additional contributions are still pending. This determination may be based on explicit participant count information provided when the reduction was initiated, completion detection protocols where a designated controller signals when all participants have contributed, or timeout-based mechanisms that finalize reductions after a configurable waiting period. To make this determination, the MC-NIC consults internal tracking structures that record which participants have contributed to each active reduction, maintaining bitmaps, counter arrays, or other data structures that enable efficient detection of completion conditions. If packets are still pending, the received operands are buffered in the MC-NIC's local memory or register files, waiting for the remaining contributions to arrive. The MC-NIC may maintain multiple concurrent reduction operations in various states of completion, allowing different reduction groups or independent reduction operations to proceed in parallel without blocking each other. Error detection mechanisms verify packet integrity using checksums or CRC codes, identifying and discarding corrupted packets while potentially requesting retransmission from the source if reliability protocols are enabled. Security validation ensures that all contributing packets originate from authorized participants with appropriate tenant identifiers and access permissions, preventing malicious or erroneous contributions from compromising the reduction result.

Once the MC-NIC determines that all required partial operands have arrived, step 1605 proceeds with the final aggregation phase where the reduction execution logic applies the requested arithmetic or logical transformation to combine all partial operands into a single final result. The reduction execution logic is a specialized hardware block within the MC-NIC designed specifically for high-throughput aggregation operations. This logic includes dedicated arithmetic units optimized for the reduction operations most commonly required by distributed workloads: multi-input adder trees for summation that can combine dozens of operands in a single clock cycle using hierarchical addition stages; comparator networks for minimum and maximum operations that efficiently select extreme values from large sets; multiplier arrays for product reductions; bitwise logic gates for conjunction, disjunction, or XOR operations; and floating-point arithmetic units that support IEEE 754 or custom floating-point formats with appropriate handling of special values like infinities, NaNs, and denormalized numbers. For summation operations—by far the most common type in machine learning gradient accumulation—the reduction engine adds all partial operands together, accumulating the sum in high-precision internal registers that may use wider bit widths than the input operands to prevent overflow or maintain numerical accuracy for large-scale reductions involving thousands of contributions. For minimum or maximum operations, the engine compares all operands pairwise or using tournament-style comparison trees to identify the extreme value, potentially also recording auxiliary information like the index or source identifier of the contributing device that provided the extreme value. For product operations, the engine multiplies operands sequentially or using parallel multiplier units, with careful attention to numerical stability and overflow handling. For typed floating-point operators, the engine implements the specific arithmetic semantics required by the data type, such as stochastic rounding, truncation modes, or special handling of subnormal values that may be required for machine learning applications using reduced-precision arithmetic. The reduction engine may employ various optimizations to improve performance and accuracy: Kahan summation or compensated summation algorithms that track and correct for accumulating rounding errors in floating-point addition, ensuring that the final sum remains accurate even when combining millions of small values; parallel reduction trees that exploit instruction-level parallelism and pipelining to maximize throughput; mixed-precision accumulation where inputs are converted to higher precision before summation and then rounded back to the target precision after aggregation; or specialized hardware for operations like variance calculation, vector normalization, or softmax computation that combine multiple arithmetic primitives. In embodiments supporting programmable reduction templates, the firmware can dynamically configure the reduction engine's arithmetic units to implement custom operations defined by application software, allowing user-defined aggregation functions to execute at hardware speeds. The reduction engine maintains partial aggregates in on-chip SRAM registers, local memory buffers, or cache hierarchies until all contributors for a given operation group have been received, providing low-latency access to intermediate state and enabling rapid accumulation as packets arrive. Throughout the reduction process, the engine tracks metadata such as the number of contributions received, the current accumulated value, overflow flags, error status indicators, and completion progress, making this information available to monitoring and debugging systems for operational visibility.

Following the completion of the aggregation computation in step 1606, the destination MC-NIC generates the final reduction result and prepares to store it in the coherent memory fabric. The final result value is written to the persistent memory array associated with the memory node, committing it to durable storage at the memory location specified by the original reduction operation's target address. This write is executed as a coherent MF-TLP write transaction, ensuring that the memory update is performed atomically and consistently with respect to all other memory operations in the fabric. The MC-NIC constructs an MF-TLP write packet containing the final reduction result as the payload, along with the target address, coherence metadata indicating that this write produces a modified state requiring invalidation of cached copies, and transaction identifiers for tracking completion. The write operation updates the global memory image, making the reduction result visible to any subsequent read operations targeting that address. To maintain fabric-wide cache coherence, the write transaction triggers invalidation messages that are sent to any compute devices that currently hold cached copies of the affected memory lines. The MC-NIC consults the directory structure or coherence tracking metadata to identify which compute devices have cached the target memory location, then generates and transmits MF-TLP invalidation packets to those devices. These invalidation messages ensure that no stale cached copies of the memory location remain after the reduction result has been written, preventing inconsistent views of the data and guaranteeing that any future reads will retrieve the updated value either from the memory array or from valid cached copies reflecting the post-reduction state. The invalidation messages include coherence metadata specifying version numbers or epoch counters that enable receiving devices to properly sequence the invalidation with respect to other coherence operations. The destination MC-NIC may wait for acknowledgments from all invalidated devices before considering the write operation fully completed, ensuring strong consistency semantics. In some embodiments, the memory write and invalidation generation are pipelined or overlapped with the final stages of the reduction computation itself, hiding the latency of coherence operations and enabling back-to-back reductions to proceed at high throughput without stalling. The written result is tagged with metadata indicating its provenance, timestamp, reduction group identifier, and any other information required for debugging, auditing, or consistency verification.

Finally, at step 1607, the system distributes the final reduction result back to all participating compute devices, ensuring that every node that contributed a partial operand receives the aggregated value. This distribution is accomplished through the multicasting of completion or result packets to all participants through the interconnect fabric. The destination MC-NIC or intermediate fabric switches generate MF-TLP result packets containing the final aggregated value in the payload, along with the reduction group identifier, sequence number, and transaction completion tokens that allow receiving devices to correlate the result with their original contributions. If the reduction opcode included flags specifying that result distribution is required—as is the case for all-reduce operations where every participant needs the final sum—the MC-NIC transmits these result packets using multicast addressing capabilities in the fabric. In fabrics supporting native multicast, a single result packet can be replicated by switches to reach all participants simultaneously, significantly reducing the distribution latency and bandwidth consumption compared to sending individual unicast packets to each destination. In fabrics without hardware multicast support, the MC-NIC may send multiple unicast result packets or use hierarchical distribution trees where result packets are forwarded to intermediate aggregation points that further distribute them to subsets of participants. The result packets traverse the fabric following routing paths determined by multicast forwarding tables or distribution tree topologies, with switches and routers forwarding copies of the packet to all output ports that lead to registered participants in the reduction group. Each participating compute device receives the result packet at its local MC-NIC, which validates the packet, extracts the final aggregated value, and makes it available to the local processor or application software. The result may be written directly into a pre-specified memory location accessible by the application, signaled through an interrupt or completion queue entry that notifies waiting software, or inserted into the compute device's cache hierarchy for immediate use by subsequent computations. This result distribution enables synchronization across all participating devices—each node now knows the global aggregate and can proceed with subsequent computation phases that depend on this value, such as applying accumulated gradients to update model parameters, using global statistics to normalize local computations, or determining termination conditions based on aggregate metrics. The result distribution mechanism includes reliability features such as acknowledgment collection, where the coordinator waits for confirmations from all participants before considering the reduction fully completed, and timeout-based retransmission, where result packets are resent to any devices that fail to acknowledge within a configurable interval. Transaction identifiers in the result packets enable participants to distinguish between results from different reduction operations that may be in flight concurrently, preventing confusion when multiple overlapping reductions are executing simultaneously.

The reduction operation flow 1600 incorporates numerous advanced features and optimizations that extend its capabilities beyond basic aggregation. The system supports hierarchical or multi-domain aggregation, where large-scale reductions spanning thousands of devices are decomposed into smaller local reductions performed within rack-level or cluster-level domains, followed by global merging performed by higher-level MC-NICs or spine switches. Each hierarchical stage uses its own MF-TLP reduction group identifiers and maintains independent completion tracking, allowing the protocol to merge partial aggregates recursively while maintaining deterministic completion ordering and minimizing coordination overhead. This hierarchical approach enables the reduction architecture to scale linearly with the number of participating devices, preventing centralized bottlenecks that would otherwise limit performance in large deployments. Local reductions complete quickly within their domains, and only the intermediate aggregates need to traverse the higher levels of the network hierarchy, dramatically reducing wire traffic and end-to-end latency compared to flat reduction trees where all partials converge on a single destination. The system employs pipelined streaming modes where partial aggregates are accumulated and forwarded concurrently as packets arrive, rather than buffering all operands before beginning aggregation. This streaming approach allows large-scale reductions to process at line rate without requiring massive buffer space, enabling continuous reduction execution even for operations involving gigabytes of partial data. Each switch and MC-NIC maintains only the state needed for active reductions rather than storing all individual contributions, keeping memory footprint bounded and enabling sustained high throughput.

To ensure consistency and reliability throughout the reduction process, the MF-TLP reduction flow integrates comprehensive transactional acknowledgment and error control mechanisms. Each reduction packet carries a transaction identifier that uniquely associates it with a specific reduction operation, allowing the system to track the progress of individual operations and correlate acknowledgments with their corresponding requests. Optional acknowledgment control bits in the packet header specify the desired acknowledgment behavior, such as per-packet acknowledgments that confirm receipt of each individual contribution, or aggregated acknowledgments where the destination confirms completion of the entire reduction epoch in a single message. The destination node generates acknowledgment packets that are returned to all contributing devices, potentially including a finalization token that identifies the completed reduction epoch and allows participants to release any resources or state associated with that operation. These acknowledgments enable reliable completion detection, ensuring that all participating devices know when the reduction has finished and the result is available. If any packet is dropped due to buffer overflow, link errors, or congestion, the source MC-NIC detects the loss through timeout mechanisms or explicit negative acknowledgments and retransmits the missing packet based on its transaction identifier. Hardware CRC codes and forward-error-correction fields appended to the packet payload guarantee data integrity throughout the aggregation chain, detecting bit flips, corruption, or transmission errors that might otherwise produce incorrect reduction results. The system maintains end-to-end integrity checking spanning from the original partial result generation at the compute device through all in-network aggregation stages to the final result storage and distribution, ensuring that the computed aggregate accurately reflects all contributions without data corruption.

Advanced embodiments incorporate programmable reduction templates that provide unprecedented flexibility in defining custom aggregation functions. Rather than supporting only a fixed set of reduction operations hardcoded in the MC-NIC firmware, these systems allow runtime software to dynamically instantiate hardware pipelines for user-defined aggregation functions. Reduction templates can be specified using domain-specific languages, bytecode representations, or intermediate representations similar to those used in compiler toolchains. The template describes the sequence of arithmetic, logical, and data movement operations required to implement the custom reduction, potentially including complex multi-stage pipelines combining multiple primitive operations. MC-NIC firmware interprets these templates and programs the reduction engine's arithmetic units accordingly, configuring multiplexers, arithmetic operators, accumulator registers, and control flow logic to implement the desired function. Some implementations provide field-programmable gate array (FPGA) fabrics or coarse-grained reconfigurable arrays within the MC-NIC that can be dynamically reconfigured to implement custom reduction hardware, achieving performance comparable to hardwired implementations while maintaining programmability. This flexibility allows the system to offload arbitrary collective operations directly into the NIC or network layer—operations such as vector normalization that combines summation with division, momentum updates that blend current and historical gradients using weighted averaging, quantized reductions that convert between different numerical precisions during aggregation, or custom domain-specific aggregations required by specialized machine learning architectures or scientific simulation codes. By enabling hardware acceleration of these complex collective operations, the system eliminates the need for multiple round-trips or software-managed reduction sequences, collapsing multi-step operations into single hardware-executed primitives.

The reduction flow interacts comprehensively with the fabric's coherence and governance subsystems to maintain consistency and enforce resource management policies. Before committing a reduced value to memory, the destination MC-NIC consults the directory controller to ensure that no other node currently holds the target address in a modified state that would conflict with the reduction result write. If necessary, coherence invalidations are issued proactively to bring all cached copies into a consistent state before the reduction completes, preventing coherence violations and ensuring that the memory system observes a well-defined serialization of operations. The directory is updated to reflect the new memory state, recording which devices have been invalidated and tracking the coherence state of the memory line containing the reduction result. Tenant identifiers embedded in the reduction packet headers enable enforcement of per-tenant quotas and isolation policies even for shared aggregation nodes, ensuring fairness in multi-tenant environments such as AI training clusters where multiple independent jobs may compete for reduction resources. The system can enforce bandwidth limits, latency targets, or throughput guarantees on a per-tenant basis, preventing any single tenant from monopolizing reduction engines or network resources to the detriment of others. Quality-of-service controllers within switches and MC-NICs schedule reduction packets according to their priority tags and tenant allocations, providing differentiated service levels that allow time-critical reductions to complete quickly while lower-priority operations are deferred when resources are scarce.

In alternative embodiments, reduction operations may be vectorized or fused with atomic updates to create powerful composite primitives that combine multiple semantic operations into single hardware-executed transactions. A vectorized reduction packet includes multiple address/stride pairs in its header, specifying a scatter-gather pattern across memory, with the reduction engine performing simultaneous aggregation across multiple memory regions. This enables operations like reducing multiple independent parameter tensors in parallel, computing multiple aggregate statistics simultaneously, or implementing complex communication patterns required by advanced distributed algorithms. Fused reduction-atomic operations first aggregate distributed values as described above, then apply an atomic operation such as compare-and-swap or fetch-and-add to the final result before committing it to memory. These fused operations enable complex synchronization patterns such as distributed lock management implemented entirely in hardware—for example, multiple compute devices can contribute votes for a lock acquisition decision, the fabric aggregates these votes using a reduction operation, and then atomically updates a lock variable only if the aggregated vote count exceeds a threshold, all without any software intervention or additional network round-trips. Similarly, barrier synchronization can be implemented through reduction-based counting where each participant contributes a unit value, the fabric sums these contributions, and the resulting count atomically triggers barrier release when it matches the expected participant count. These fused operations dramatically simplify the implementation of distributed coordination primitives and enable hardware-accelerated execution of synchronization patterns that would traditionally require complex software protocols.

In predictive and adaptive configurations, the system monitors traffic patterns and dynamically optimizes reduction execution based on observed behavior. Using machine learning-driven telemetry collected from prior reduction epochs—such as participant arrival patterns, common reduction tree topologies, frequent operand value distributions, or temporal correlations between consecutive reductions—the fabric can predict upcoming reduction operations and pre-allocate resources to reduce setup latency. Switches may pre-activate reduction paths by reserving buffer space, configuring arithmetic units, and establishing routing entries before the first packets arrive, eliminating configuration overhead from the critical path. MC-NICs can prefetch target cache lines for result storage into local caches before the final aggregate is computed, hiding memory access latency and enabling immediate write-back when reduction completes. The system may dynamically reconfigure reduction tree topologies based on observed congestion patterns, hot-spot analysis identifying bottleneck switches, or real-time measurements of path latencies, adapting the aggregation hierarchy to avoid overloaded network segments and maintain balanced traffic distribution. Adaptive routing algorithms can steer reduction packets away from congested areas, and switches can dynamically adjust the aggressiveness of in-network aggregation based on current load—performing more aggressive combining when congestion is high to reduce downstream traffic, or allowing more packets to flow through when resources are abundant to minimize aggregation latency. These adaptive mechanisms ensure sustained line-rate performance across varying workload conditions and fabric scales.

This flow provides a comprehensive view of how the MF-TLP framework enables reduction operations to execute efficiently, coherently, and scalably across a disaggregated memory fabric. By executing arithmetic and logical aggregations directly in the interconnect hardware—either within programmable switches performing in-network reduction or at MC-NIC endpoints performing final aggregation—the system achieves dramatically higher throughput, lower latency, and minimal software overhead compared to traditional approaches that require host CPU intervention for collective operations. Typical reduction operations that might require tens of milliseconds using software-based MPI collective libraries or parameter servers can complete in single-digit microseconds using hardware-accelerated MF-TLP reductions, representing thousand-fold latency improvements that fundamentally change the economics and feasibility of distributed computing. The described reduction flow forms the hardware foundation for collective intelligence workloads including distributed AI training where gradient aggregation is the primary bottleneck, high-performance analytics that aggregate partial results from massively parallel queries, parallel simulation environments requiring frequent synchronization of distributed state, graph analytics algorithms performing iterative aggregation over network structures, and scientific computing applications that solve large-scale systems through domain decomposition and iterative refinement. By maintaining full coherence integration with the global memory fabric—triggering appropriate invalidations, updating directory state, and ensuring consistency across all cached copies—the reduction mechanism seamlessly integrates with the broader memory system, allowing reduction results to be immediately consumed by subsequent operations without additional synchronization overhead or consistency concerns. The combination of in-network aggregation, hardware-accelerated final reduction, coherent result storage, and efficient multicast distribution creates a complete collective communication primitive that operates at wire speed, scales linearly with fabric size, and provides the performance characteristics required by the most demanding distributed applications in modem data centers.

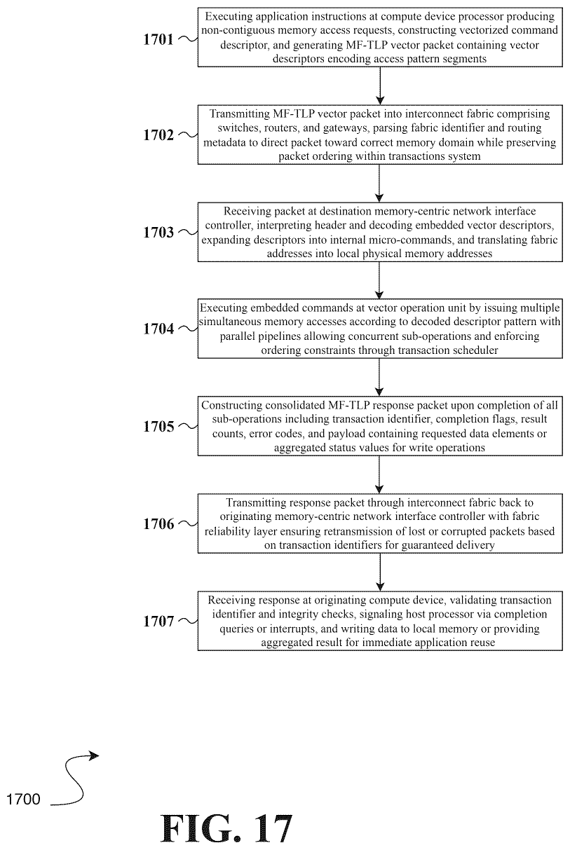

FIG. 17 is a flow diagram illustrating an exemplary method for implementing the Memory-Fabric Transaction Layer Protocol (MF-TLP) across a coherent, packet-switched memory fabric 1700. The flow depicts the complete sequence of operations by which a compute node issues a multi-address memory request, encodes it as a vectorized MF-TLP packet, transmits the packet through the interconnect fabric, expands and executes the constituent memory operations at the destination memory-centric network interface controller, and aggregates the results into a consolidated response that is returned to the originating device. This process enables multiple discrete memory accesses to be executed in a single transaction, dramatically reducing packet overhead by eliminating the need to send individual packets for each memory reference, reducing network latency through batched processing, and reducing host-side synchronization burden by allowing applications to issue complex multi-address operations without managing individual completion events. Vectorized transactions are particularly valuable for workloads that exhibit irregular or sparse memory access patterns, such as embedding table lookups in recommendation systems where each input example requires fetching multiple non-contiguous embedding vectors, graph analytics workloads that traverse adjacency lists with unpredictable pointer patterns, sparse matrix operations that access non-zero elements scattered across memory, database query processing that gathers tuples from distributed index structures, or scientific simulations that perform scatter-gather updates to distributed arrays based on particle positions or mesh connectivity.

The vectorized transaction sequence begins at step 1701, where a compute device processor executes application-level or middleware instructions that produce non-contiguous memory access requests requiring data from multiple disparate memory locations. These access patterns typically arise in workloads involving sparse or irregular data structures where the addresses to be accessed cannot be predicted in advance or cannot be expressed as simple contiguous ranges. Common examples include recommendation model inference where each user-item interaction requires looking up embedding vectors for potentially hundreds of sparse feature identifiers scattered across large embedding tables, social network graph analytics where traversing connections from a vertex requires fetching adjacency information from addresses determined by the graph structure rather than regular arithmetic patterns, molecular dynamics simulations where particle interactions require gathering position and velocity data for spatially proximate particles whose locations are not contiguous in memory, or database join operations where matching tuples must be fetched from index structures using keys computed during query evaluation. When the compute device's software stack—whether application code, runtime libraries, or specialized middleware—detects that multiple non-contiguous memory references can be coalesced into a single vectorized operation, it constructs a vectorized command descriptor that compactly represents the entire access pattern. This coalescing may be performed explicitly by the application using specialized APIs that expose vectorized memory operations, automatically by compiler optimization passes that analyze memory access patterns and transform sequences of scalar loads or stores into vector operations, or dynamically by runtime systems that buffer individual requests and batch them when patterns are detected. The vectorized command descriptor is transmitted to the memory-centric network interface controller through various mechanisms such as writing to memory-mapped NIC control registers, enqueueing descriptors into dedicated submission queues, or invoking driver functions that package the request for NIC consumption. The descriptor specifies several critical parameters: the target memory region or fabric identifier indicating which memory node or address range contains the data, the number of vector elements representing how many discrete memory locations will be accessed, the element stride if the access pattern follows a regular strided sequence where addresses increment by a fixed offset, and any operand data to be written for vector write or update operations. Upon receiving this descriptor, the memory-centric network interface controller processes it and generates a corresponding MF-TLP vector packet containing one or more vector descriptors, each encoding a segment of the overall access pattern. The encoding format varies by implementation and access pattern characteristics: in one embodiment, each vector descriptor defines a tuple of (base address, stride, count) specifying a strided sequence beginning at a base address and progressing by a fixed stride for a specified count of elements—this compact representation is highly efficient for regular access patterns like strided array accesses or matrix column/row operations. In another embodiment suitable for irregular patterns, the descriptor comprises an explicit offset list enumerating arbitrary address sequences, with each entry specifying an individual address or offset relative to a base pointer—this format provides maximum flexibility at the cost of larger descriptor size. Hybrid encodings combine both approaches, using strided representations for regular segments and explicit lists for irregular portions. The MF-TLP vector packet header includes multiple essential fields that enable proper routing, execution, and governance: an opcode field identifying the operation as vectorized and specifying the operation type such as VECTOR_READ for fetching data from multiple addresses, VECTOR_WRITE for storing data to multiple locations, VECTOR_ATOMIC for performing atomic operations at multiple addresses, or VECTOR_REDUCE for combining values from multiple locations using an aggregation function; a fabric identifier (FID) that specifies the destination memory node or partition responsible for managing the address range being accessed, enabling the fabric to route the packet to the correct endpoint; a transaction identifier that uniquely associates the request with any subsequent responses, enabling proper matching in the presence of out-of-order delivery and supporting retry mechanisms; a tenant identifier and priority tag for governance and quality-of-service enforcement, allowing multi-tenant systems to isolate workloads and provide differentiated service levels; and coherence metadata indicating desired caching semantics such as “Shared” for read-only access allowing caching at multiple locations, “Exclusive” for read-modify-write sequences requiring sole ownership, or “Non-coherent” for operations on uncached data structures. The packet payload may optionally contain inline operands or data values to be stored at each target location for write or update operations, or may be omitted for read operations where the payload will be filled during the response phase.

At step 1702, the originating memory-centric network interface controller transmits the constructed MF-TLP vector packet into the interconnect fabric, injecting it into the packet-switched network infrastructure connecting compute devices, memory nodes, and other fabric resources. The fabric comprises multiple layers of MF-TLP-aware switches, routers, and fabric gateways arranged in topologies such as leaf-spine, fat-tree, dragonfly, or hierarchical mesh configurations optimized for both point-to-point and collective communication patterns. Each network element along the packet's path performs header parsing to extract the fabric identifier and routing metadata, using this information to determine the appropriate output port or next-hop destination that will move the packet closer to the target memory domain. The switches and routers apply their configured routing algorithms—which may be static table-based routing using preconfigured forwarding entries, dynamic adaptive routing that selects paths based on current congestion and link utilization, or topology-aware routing that exploits structural properties of the network for optimal path selection. Throughout this traversal, the fabric preserves packet ordering within a transaction stream, ensuring that dependent operations arrive and execute in the correct sequence to maintain memory consistency and prevent ordering violations. Certain advanced implementations support packet partitioning, where intelligent fabric elements analyze the vector descriptors within a packet and determine that different segments target different memory shards or nodes. In such cases, the fabric can replicate or split a single vector packet into multiple routed sub-flows, each carrying only the descriptors relevant to a specific destination. This dynamic partitioning enables efficient execution of vector operations that span multiple memory nodes, allowing each node to process only its relevant portion rather than forcing a single node to handle the entire operation and forward elements to other nodes. Intermediate devices within the fabric may also perform in-network preprocessing optimizations such as address bucketing that groups addresses by cache line or memory bank to enable more efficient access scheduling at the destination, stride normalization that detects and compresses regular patterns within seemingly irregular descriptor lists, or descriptor reordering that sorts addresses to match the optimal access order for the destination memory subsystem. These preprocessing operations reduce downstream network interface controller workload and improve memory access efficiency. The fabric implements quality-of-service mechanisms that schedule vector packets according to their priority tags, providing differentiated latency and bandwidth guarantees for different traffic classes—time-critical vector operations supporting interactive workloads may receive elevated priority while bulk data movement vector operations tolerate higher latency in exchange for better throughput. Flow control and congestion management mechanisms prevent buffer overflow and ensure that vector packets can make forward progress even during periods of high network utilization.

Upon arrival at the destination memory node in step 1703, the MF-TLP vector packet enters the protocol parsing engine within the destination memory-centric network interface controller, which is responsible for interpreting the packet structure and extracting the information needed for execution. The parsing engine examines the packet header to identify the operation type from the opcode field, recognizing it as a vectorized transaction and determining the specific vector operation variant such as read, write, atomic, or fused operation. The engine then decodes the embedded vector descriptors, extracting the addressing information that specifies which memory locations should be accessed. For strided descriptors, this involves reading the base address, stride value, and element count, then using this information to compute the sequence of target addresses that will be accessed. For explicit offset list descriptors, the engine reads each address or offset entry, potentially performing validation checks to ensure addresses fall within allowed ranges and don't violate protection boundaries. The parsing engine determines how many discrete memory operations are represented in the packet by examining descriptor counts and formats, calculating the total workload that must be executed to satisfy the vector request. It also determines whether the operations are homogeneous—meaning all operations are of the same type, such as a vector of reads or a vector of writes—or heterogeneous, involving mixed operation types such as some reads combined with some writes or atomic updates within the same vector packet. This classification influences how the operations will be scheduled and executed. Once the descriptors have been decoded and validated, the parsing engine expands them into internal micro-commands that represent the individual memory operations to be performed. These micro-commands are stored in a vector execution queue within the network interface controller, where they await scheduling and execution. Each micro-command contains the local address to access, the operation type to perform, any operand data needed, and metadata such as sequence identifiers for ordering enforcement and completion tracking. The address translation unit within the network interface controller then processes these micro-commands, converting the fabric-wide virtual addresses or object identifiers into local physical addresses within the memory array attached to this node. This translation process may involve consulting translation lookaside buffers (TLBs) that cache recent address mappings for fast lookup, accessing page tables or address mapping structures that define the virtual-to-physical translation for the node's address space, or applying programmable address transformation functions that enable flexible memory virtualization and partitioning schemes. The translation unit also performs permission checking, verifying that the requesting device and tenant have appropriate access rights to each target address, enforcing security policies that prevent unauthorized memory access, and potentially applying address range validation that ensures operations don't stray outside allocated memory regions. Throughout this parsing and translation phase, the network interface controller maintains metadata tracking for the vector transaction, recording the transaction identifier, expected number of operations, completion requirements, and any special processing flags that will govern subsequent execution stages.

Step 1704 describes the actual execution of the vectorized memory operations by the vector operation unit within the destination network interface controller. The vector operation unit is a specialized hardware block designed to efficiently execute multiple memory accesses in parallel, maximizing throughput and minimizing latency for vector transactions. Upon receiving the expanded micro-commands from the execution queue, the vector unit begins issuing memory access requests to the local memory subsystem. For stride-based descriptors, the unit automatically increments addresses after each operation according to the specified stride value, generating a regular sequence of memory requests without requiring explicit address computation for each element. For explicit offset list descriptors, the unit issues requests to arbitrary locations as specified in the decoded descriptor, supporting fully irregular access patterns where addresses have no predictable relationship to each other. The vector unit contains multiple parallel pipelines that enable dozens or hundreds of sub-operations to be in flight concurrently, exploiting memory-level parallelism and overlapping the latency of different memory accesses to achieve high aggregate throughput. Each pipeline can independently access the memory subsystem, with load/store units, cache interfaces, and memory controllers supporting concurrent operations from multiple vector elements. The memory subsystem may employ various optimizations to accelerate vector access: bank interleaving that distributes addresses across multiple memory banks to enable parallel access without conflicts, prefetching that anticipates upcoming addresses in stride-based patterns and pre-loads data into caches, or access coalescing that combines multiple vector elements accessing the same cache line into a single memory transaction. Each sub-operation generates a local acknowledgment or completion signal when it finishes, enabling fine-grained progress tracking that allows the network interface controller to monitor execution and detect any operations that fail or stall. The transaction scheduler coordinates these concurrent memory accesses, enforcing ordering constraints based on the operation semantics and any dependencies specified in the original vector packet. For example, write operations may need to be serialized relative to prior reads to maintain write-after-read correctness and prevent data races where a write overwrites data before a dependent read observes it. Independent read operations, conversely, can be executed out of order and in parallel since they don't modify state and therefore cannot interfere with each other. The scheduler applies dependency analysis to identify which operations can proceed concurrently and which must be sequenced, constructing an execution schedule that maximizes parallelism while respecting correctness constraints. Priority tags and quality-of-service indicators from the original packet influence scheduling decisions, allowing high-priority vector operations to preempt or bypass lower-priority operations when resource contention occurs. The scheduler merges completion responses from individual sub-operations belonging to the same vector group, aggregating their results and metadata into a unified transaction context that will eventually form the basis for the consolidated response packet. As operations complete, the scheduler updates internal tracking structures to record which elements have finished, accumulates any result data for read operations, collects status codes indicating success or failure for each sub-operation, and determines when the entire vector transaction has completed and is ready for response generation.

In certain advanced embodiments, the vector operation unit is coupled to atomic and reduction logic blocks that enable fused operations to be performed within the same vector packet, combining multiple semantic operations into single hardware-executed sequences. For instance, a single MF-TLP vector packet may request that each element fetched during a vector read be atomically incremented before the value is returned, implementing a distributed counter increment across multiple memory locations in a single transaction. Similarly, a vector packet might specify that multiple retrieved elements should be combined using a reduction operator such as summation to produce a scalar aggregate, maximum to find the largest value, or minimum to identify the smallest value, with only this final reduced result returned rather than all individual element values. These fused operations execute within the same hardware pipelines as the vector read and write operations, maintaining atomicity guarantees that ensure each fetch-and-modify sequence executes indivisibly without interference from concurrent operations, and preserving coherence by properly integrating with the fabric's directory-based consistency mechanisms. Fused vector operations dramatically reduce network traffic for workloads that need to both access and modify distributed data, or that require aggregation of scattered values-rather than performing vector reads followed by separate atomic updates or reductions, the entire sequence executes as a single fabric transaction with lower latency and higher efficiency.

At step 1705, once all sub-operations within the vector transaction have been completed successfully—meaning all memory accesses have been performed, all results have been collected, and all status information has been aggregated—the response generator within the destination memory-centric network interface controller constructs a consolidated MF-TLP response packet that will return the results to the requesting compute device. The response generation process begins by creating a packet header that reproduces essential information from the original request, most critically the transaction identifier that enables the originating network interface controller to match the response with the corresponding request and properly complete the operation. The header includes completion flags that indicate overall success or failure of the vector transaction, result counts specifying how many elements were successfully processed, and error codes if any sub-operations failed due to access violations, memory errors, permission denials, or other exceptional conditions. The error reporting may be granular, identifying specifically which vector elements encountered problems rather than reporting only aggregate success or failure, enabling selective retry or error handling for failed elements while preserving results from successful operations. For read-type vector operations—where the purpose is to fetch data from multiple memory locations—the response payload contains all requested data elements concatenated in the same order as the descriptor sequence specified in the original request. This ordering preservation is critical for correct operation, as the requesting application expects to receive results corresponding to each descriptor element in a predictable sequence that allows proper interpretation and use of the returned data. The data elements are packed efficiently into the payload to minimize packet size while maintaining alignment requirements for different data types. For write-type vector operations—where the purpose is to store data to multiple locations—the response payload may be omitted entirely if the originating device only needs confirmation of completion rather than return data, significantly reducing response packet size and network bandwidth consumption. Alternatively, the response may carry aggregated status values such as a count of total updates successfully applied, a bitmap indicating which elements completed versus which failed, or summary statistics about the write operation. For fused vector operations that combine reads with atomic modifications or reductions, the response payload contains the specific values dictated by the fusion semantics: for atomic fetch-and-add operations, the payload includes the previous values at each location before the atomic increment; for reduction operations, the payload contains the final reduced scalar value resulting from combining all vector elements. The response generator may apply compression or encoding optimizations to reduce payload size, particularly for sparse vectors where many elements have zero or default values, or for patterns where consecutive elements have predictable relationships that can be represented compactly.

Step 1706 describes the transmission of the constructed response packet through the interconnect fabric back to the originating memory-centric network interface controller, completing the round-trip journey of the vector transaction. The response packet is injected into the fabric at the destination node and begins traversing the network toward the originating compute device. The fabric's routing infrastructure examines the response packet header to determine its destination, using the source address from the original request or explicit return path information encoded in the response header to select appropriate forwarding paths. The fabric may employ reverse path routing that sends responses back along the same path used by the request, ensuring symmetric latency characteristics and potentially leveraging any cached routing state established during the request phase. Alternatively, the fabric may use adaptive routing for responses that selects currently optimal paths based on real-time congestion and link status, potentially delivering responses via different routes than the requests traveled if network conditions have changed. During this return transmission, intermediate fabric nodes may perform response aggregation if multiple partial responses exist from different destination nodes—this situation arises when a vector operation was partitioned across multiple memory nodes during the request phase, with each node processing a subset of vector elements and generating a partial response. The aggregation logic within switches combines these partial responses into a single consolidated packet that contains all results, reducing the number of packets the originating device must process and simplifying completion handling. The aggregation preserves element ordering and properly merges status codes, ensuring that the consolidated response accurately represents the combined results of all partial operations. The fabric's reliability layer provides end-to-end delivery guarantees through mechanisms such as acknowledgment-based protocols where the receiving node confirms receipt of responses, triggering retransmission from the sender if acknowledgments don't arrive within timeout intervals. Lost or corrupted packets are automatically detected through sequence number gaps, checksum failures, or timeout expirations, and the fabric initiates retransmission procedures based on the transaction identifiers that uniquely identify each vector operation. Error correction codes appended to response packets enable detection and correction of bit errors that occur during transmission, maintaining data integrity even in the presence of transient link errors or electromagnetic interference. Priority scheduling within the fabric ensures that response packets receive appropriate service levels based on their priority tags, preventing response delivery from being unduly delayed by bulk data traffic or lower-priority operations. Flow control mechanisms prevent response packets from being dropped due to buffer overflow at intermediate switches or at the destination network interface controller, using credit-based schemes or explicit backpressure signals to regulate transmission rates and ensure buffer availability.

When the response packet arrives at the originating compute device in step 1707, the memory-centric network interface controller receives it and performs several processing steps to complete the vector transaction from the requester's perspective. The network interface controller validates the transaction identifier in the response header, matching it against outstanding vector operations that are awaiting completion and confirming that this response corresponds to a previously issued request rather than being a spurious or duplicated packet. This matching process consults internal tracking structures that record all in-flight vector transactions, looking up the entry corresponding to the received transaction identifier and retrieving associated context such as the original command descriptor, application completion handler information, and memory buffer addresses where results should be stored. The network interface controller performs integrity checks on the response packet, validating checksums or CRC codes to detect any corruption that occurred during transmission, verifying that payload sizes match expected values based on the original request, and ensuring that the packet structure conforms to the MF-TLP protocol specification. If integrity checks fail, the network interface controller may request retransmission of the response or escalate the error to higher-level error handling mechanisms. Once validated, the network interface controller signals the host processor or application software that the vector operation has completed, using various notification mechanisms depending on system architecture and application requirements: completion queue entries may be written to a memory-mapped queue structure that the application polls periodically to discover completed operations, allowing batched completion processing with low interrupt overhead; hardware interrupts may be generated to immediately notify the processor of completion, enabling low-latency response to time-critical operations; callback functions registered by the application may be invoked directly by NIC firmware or driver software, providing application-specific completion handling without generic interrupt processing overhead; or memory-mapped status registers may be updated atomically, allowing the application to spin-wait on completion flags for extremely latency-sensitive operations. For vector read operations, the data elements returned in the response payload are written to local memory at addresses specified in the original command descriptor, making the fetched data immediately available for use by application logic. The data placement may involve direct memory access (DMA) transfers that move payload contents into application buffers without processor involvement, cache-line-sized writes that populate the processor's cache hierarchy for rapid access, or direct delivery to accelerator memory for operations where GPUs or other specialized processors will consume the data. For vector write operations where the response contains only status information rather than data payload, the network interface controller extracts error codes and completion counts, making this information available to the application through completion queue entries or status registers that report operation success and any exceptional conditions encountered. For fused or reduction vector operations where the response contains a single aggregated result rather than per-element data, the processor receives this consolidated value and can immediately reuse it in subsequent computations without additional software post-processing or reduction logic—the hardware-computed aggregate is directly usable, eliminating latency and complexity associated with software-managed reductions. The completion notification includes metadata such as the number of elements successfully processed, total bytes transferred, execution latency measurements, and any warning or error conditions that occurred during processing, providing comprehensive visibility into operation outcomes for debugging, performance monitoring, and adaptive algorithm tuning.

The vectorized transaction flow 1700 supports numerous advanced features and optimizations that extend its capabilities beyond basic multi-address access. Certain embodiments implement multi-destination execution, where a single MF-TLP vector packet targets multiple memory nodes simultaneously, enabling vector operations that span distributed memory resources across racks or clusters. In this mode, the originating network interface controller constructs a vector packet containing descriptors for addresses mapped to different memory nodes, and the fabric intelligently partitions this packet during routing such that each destination node receives only the descriptors relevant to addresses it manages. Each destination network interface controller processes its assigned subset of descriptors independently and in parallel with other nodes, generating partial results that are forwarded to an aggregation node designated to combine them into the final consolidated response. The aggregation node collects partial responses from all participating destinations, merges the data or status information according to element ordering, and produces a single unified response packet that is returned to the originating device. This multi-destination model allows large vector operations to be partitioned dynamically across the available memory nodes, providing near-linear scalability with the number of nodes and enabling efficient execution of vector operations that would otherwise be constrained by single-node memory bandwidth or processing capacity.

The vectorized flow incorporates predictive and adaptive optimizations that learn from access patterns and speculatively prepare for future operations. The originating memory-centric network interface controller maintains a descriptor pattern cache that records recently used vector sequences, storing information such as common base addresses, stride values, element counts, and operation types for vector transactions issued by the application. When a subsequent vector request matches a cached pattern—determined by comparing new descriptor parameters against cached entries using exact or approximate matching heuristics—the network interface controller can generate the MF-TLP packet header and descriptors autonomously without requiring full CPU involvement or descriptor construction overhead. This pattern matching and reuse accelerates frequent vector operations, reducing software overhead and enabling higher transaction rates. Predictive prefetch engines within the network interface controller analyze vector access patterns to anticipate future requests, using heuristics such as detecting regular stride increments in successive vector operations, identifying repeated access to the same base addresses with varying offsets, or learning application-specific patterns through machine learning-based prediction models. When a pattern is detected and a future access is predicted with high confidence, the prefetch engine may speculatively pre-issue MF-TLP read packets for the next expected vector range while the current transaction is still in progress, overlapping communication and computation phases to hide latency. The prefetched data is stored in the network interface controller's local cache or staging buffers, ready for immediate delivery if the predicted access occurs. If predictions prove incorrect, prefetched data is simply discarded with minimal overhead, while correct predictions significantly reduce effective latency for subsequent operations.

For coherence and consistency maintenance, the coherence controller within the network interface controller interacts extensively with the vector execution unit to ensure that vectorized operations integrate properly with the fabric's directory-based coherence protocols. Traditional coherence mechanisms issue individual coherence messages for each cache line accessed, which would generate enormous coherence traffic for large vector operations touching hundreds or thousands of cache lines. To address this scalability challenge, the coherence controller for vector operations employs batched coherence protocols that aggregate updates for all addresses in a vector region into single unified coherence transactions. When a vector write or update operation modifies multiple memory locations, the coherence controller identifies all cache lines affected by the vector, determines which compute nodes currently hold cached copies of these lines by consulting the directory structure, and generates a single multi-address invalidation message that specifies all affected cache lines rather than sending individual invalidations for each line. This batched approach reduces invalidation traffic by orders of magnitude while ensuring that cached copies in other compute nodes are properly invalidated before subsequent conflicting accesses can observe stale data. Similarly, for vector read operations, the coherence controller can batch coherence requests to acquire shared access rights for all elements simultaneously, reducing round-trip delays and protocol overhead compared to sequential coherence transactions for each element.

Error resilience and retry handling are integral to the vectorized flow's design, ensuring robust operation even in the presence of transient failures, memory errors, or network disruptions. Each sub-operation in the vector descriptor sequence carries a local sequence identifier that uniquely identifies its position within the overall vector transaction. When an error occurs during execution of one or more elements—such as a memory parity error, an access protection violation, a timeout waiting for memory response, or a transient communication failure—the destination network interface controller records which specific sequence identifiers encountered errors and includes this information in the response packet. The originating network interface controller can then selectively reissue MF-TLP packets containing only the failed elements, retrying specific sub-operations without re-executing the entire vector transaction and avoiding redundant processing of elements that completed successfully. This selective retry mechanism minimizes overhead and ensures forward progress even when intermittent errors affect subsets of a large vector operation. Optional transaction checkpoints enable the system to preserve partial results across retry attempts—as vector elements complete successfully, their results are written to intermediate buffers or checkpoint state, and subsequent retry operations can resume from these checkpoints rather than restarting from scratch. This checkpointing is particularly valuable for very large vector operations where failures affecting a small fraction of elements would otherwise require complete re-execution of potentially thousands of operations.

In alternative embodiments, the vectorized flow operates in streaming mode to handle vectors larger than available network interface controller buffers or to support continuous dataflow patterns. In streaming mode, very large vector operations are automatically divided into successive packets representing contiguous “tiles” or chunks of the overall vector. Each tile contains a subset of descriptors covering a manageable number of elements that fits within buffer constraints, and tiles are issued sequentially or with controlled pipelining to maintain continuous throughput without overwhelming buffer resources. The destination network interface controller processes each tile independently as it arrives, executing the contained operations and immediately pipelining results to the response generator without waiting for the entire vector to arrive. Results are streamed back to the originating device as they become available, allowing the application to begin consuming early results while later portions of the vector are still being processed. This streaming approach provides constant-rate throughput for arbitrarily large vectors, eliminating the need for massive buffers to hold complete vector state and enabling efficient processing of vectors that exceed any fixed buffer size limit. Streaming mode is ideal for continuous dataflow applications such as GPU parameter updates where model parameters are fetched or updated in large sequential batches, real-time signal analysis that processes long streams of sampled data, or data pipeline stages that transform streaming inputs using vectorized operations without materializing complete intermediate results.

Security and governance policies are deeply integrated into the vectorized transaction framework, ensuring that multi-address operations respect isolation boundaries and resource allocation policies. The tenant identifier included in each vector packet allows both the fabric infrastructure and destination network interface controllers to enforce per-tenant access control, ensuring that vector operations can only access memory regions allocated to the requesting tenant and preventing cross-tenant information leakage or unauthorized access. Per-tenant bandwidth guarantees and quality-of-service policies apply to vector traffic, ensuring that no single tenant can monopolize vector processing resources or network bandwidth to the detriment of other tenants sharing the infrastructure. Packets may include cryptographic signatures or message authentication codes (MACs) computed over both header and payload contents, enabling the destination network interface controller to verify packet authenticity and integrity before vector execution begins. These signatures prevent tampering attacks where malicious actors might attempt to modify vector descriptors or operand data in flight, ensuring that only authentic requests from authorized sources are processed. Optional encryption of payload data protects sensitive information during transmission across shared fabric infrastructure, with decryption performed at the destination network interface controller using tenant-specific keys established through secure key exchange protocols.

This flow therefore presents a comprehensive model for executing vectorized memory transactions across a coherent memory fabric, demonstrating how compact descriptor encoding enables efficient representation of complex multi-address access patterns, how parallel network interface controller execution exploits memory-level parallelism to achieve high throughput, how fused arithmetic support allows combining multiple operation types into single transactions, how coherence integration maintains consistency across distributed cached copies, and how predictive optimization techniques adapt to application behavior to reduce latency. Through the MF-TLP vector mechanism, multiple discrete memory operations can be performed at line-rate and at massive scale, with the entire transaction sequence—from descriptor construction through parallel execution to result aggregation-executing in hardware without per-element CPU involvement. This hardware-accelerated approach eliminates the enormous overhead traditionally associated with managing individual memory operations for irregular access patterns, reducing latency from the milliseconds typical of software-managed scatter-gather to the microseconds achievable with network interface controller hardware execution. The vectorized transaction framework provides a foundational hardware substrate enabling high-performance execution of modem workloads including AI training and inference with sparse embeddings and irregular tensor operations, distributed simulation with dynamic particle interactions and adaptive mesh refinement, real-time analytics processing streaming events with complex access patterns, graph analytics traversing irregular connectivity structures, and database query processing gathering distributed data using computed indexes. By coalescing multiple memory operations into single transactions, the system dramatically reduces packet overheads that would otherwise dominate network bandwidth in fine-grained access patterns, lowers completion notification overhead by providing unified transaction completion rather than per-operation events, and enables better resource utilization through batched processing at every layer from application software through network interface controller hardware to memory subsystem controllers. The combination of flexible descriptor formats supporting both regular and irregular patterns, parallel execution with dynamic scheduling and ordering enforcement, integrated coherence maintaining fabric-wide consistency, comprehensive error handling with selective retry, and adaptive optimizations learning from access patterns creates a complete vectorized memory system that transforms the coherent memory fabric from a simple load-store interface into an intelligent, high-throughput engine for complex memory operations spanning distributed resources.

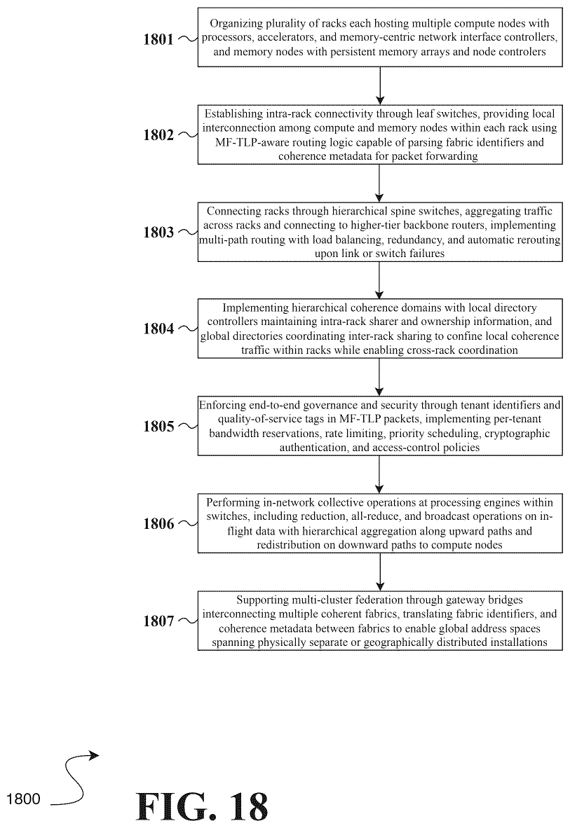

FIG. 18 is a flow diagram of an exemplary method for a fabric-wide topology 1800 for a coherent memory fabric configured to operate at rack, cluster, and data-center scales, demonstrating the architectural organization and interconnection structure that enables the Memory-Fabric Transaction Layer Protocol (MF-TLP) to provide a globally coherent, routable memory system spanning multiple physical enclosures, equipment racks, clusters, or even geographically distributed data halls. This macro-scale topology represents the physical and logical organization of compute resources, memory resources, and networking infrastructure that collectively implement the coherent memory fabric vision, where thousands of compute devices and memory nodes interact through a unified address space with hardware-enforced consistency guarantees, microsecond-scale access latencies, and transparent scalability from single-rack deployments to data-center-wide installations. The architecture demonstrates how distributed compute and memory resources integrate through intelligent packet-switched networking to overcome the limitations of traditional server-centric designs where memory is tightly coupled to individual processors, enabling instead a disaggregated model where compute and memory scale independently, resources are pooled and shared across workloads, and the fabric provides a high-performance substrate for modern distributed applications including large-scale machine learning training, real-time analytics processing, distributed databases, and scientific computing.

The foundational organizational structure described in step 1801 comprises a plurality of racks, each representing a standard data center equipment enclosure housing multiple server chassis, storage systems, and networking equipment in a physically co-located configuration. Within each rack, multiple compute nodes are deployed, with each compute node representing a server or processing unit containing one or more general-purpose processors such as x86, ARM, or RISC-V CPUs that execute application software and operating system code; accelerator subsystems including graphics processing units (GPUs) optimized for parallel floating-point computation and commonly used in machine learning training and inference, tensor processing units (TPUs) providing specialized hardware acceleration for neural network operations, field-programmable gate arrays (FPGAs) offering reconfigurable logic for custom algorithm acceleration, or domain-specific AI inference cores designed for efficient execution of trained neural network models. Each compute node includes a memory-centric network interface controller that serves as the critical gateway between the local processing resources and the fabric-wide coherent memory system, providing the hardware termination point for MF-TLP transactions, implementing local packet generation and reception, executing in-network atomic and reduction operations, and enforcing per-node quality-of-service policies and tenant isolation boundaries. The memory-centric network interface controller acts as an intelligent agent that offloads memory-related operations from host processors, manages local cache coherence state, tracks outstanding transactions, and handles protocol-level details of MF-TLP packet construction, transmission, reception, and processing. Alongside the compute nodes, each rack hosts multiple memory nodes that provide the persistent storage substrate for the coherent memory fabric. Each memory node contains a persistent memory array implemented using various memory technologies such as dynamic random access memory (DRAM) providing high-bandwidth, low-latency volatile storage suitable for active working sets; phase-change memory (PCM) offering byte-addressable non-volatile storage with performance intermediate between DRAM and flash; magnetoresistive RAM (MRAM) providing non-volatile storage with DRAM-like latency and endurance; resistive RAM (ReRAM) utilizing resistance change mechanisms for dense, low-power non-volatile storage; or hybrid configurations combining multiple memory technologies in tiered hierarchies that balance performance, capacity, cost, and persistence requirements. Each memory node includes a node controller that manages the local memory resource, handling responsibilities including address translation between fabric-wide virtual or global addresses and local physical addresses within the memory array, maintaining sharer tracking information that records which compute nodes currently hold cached copies of each memory line, and performing coherence enforcement by issuing invalidation messages, responding to coherence queries, and updating directory state to maintain fabric-wide consistency. The node controller maintains comprehensive directory tables that record ownership and sharing information for each memory line or memory region under its management, tracking whether lines are in invalid, shared, exclusive, or modified states, maintaining lists of sharer identifiers for shared lines, recording owner identification for exclusively held lines, storing version numbers or epoch counters for detecting stale accesses, and managing lease expiration timers for time-bounded coherence protocols. Each memory node is assigned a globally unique Fabric Identifier (FID) that encodes its location within the topology hierarchy, including coordinates specifying its rack identifier, cluster or pod identifier, and regional or data center identifier, enabling efficient routing of MF-TLP packets to the correct memory node regardless of where requests originate within the fabric.

Step 1802 describes the establishment of intra-rack connectivity, providing high-bandwidth, low-latency interconnection among compute nodes and memory nodes within each individual rack. This local connectivity is implemented through leaf switches that act as the first-tier aggregation points in the switching hierarchy, providing multiple high-speed ports to which compute and memory nodes connect via short electrical or optical links. The leaf switches implement the physical layer interfaces for packet transmission and reception, supporting various interconnect standards such as 100 Gigabit Ethernet, 200 Gigabit Ethernet, 400 Gigabit Ethernet, or future terabit-class interfaces using advanced modulation schemes and parallel lanes; InfiniBand EDR, HDR, or NDR providing low-latency, high-throughput interconnection with native remote direct memory access (RDMA) capabilities; or Compute Express Link (CXL) extended over Ethernet enabling cache-coherent protocols over packet-switched fabrics. These leaf switches are MF-TLP-aware, meaning they incorporate protocol intelligence beyond simple Ethernet or standard networking capabilities, including routing logic specifically designed to parse MF-TLP packet headers, extract fabric identifiers that indicate destination nodes, interpret coherence metadata fields that specify cache state and consistency requirements, and make intelligent forwarding decisions based on this protocol-specific information rather than treating packets as opaque payloads. The MF-TLP-aware routing logic within leaf switches examines destination FIDs in incoming packets, consults local routing tables that map FID ranges to output ports, and forwards packets toward their destinations with minimal latency and maximum throughput. For packets targeting memory nodes within the same rack, the leaf switch can complete forwarding entirely within the local tier, delivering packets directly from source compute nodes to destination memory nodes without involving higher-level switching infrastructure, thereby achieving the lowest possible latency and consuming no inter-rack bandwidth for local operations. The leaf switches maintain forwarding state that tracks active flows, manages buffer allocation to prevent head-of-line blocking, implements priority queuing to provide differentiated service for different traffic classes, and monitors link utilization to enable adaptive load balancing across multiple available paths. Coherence metadata parsing enables leaf switches to provide protocol-aware optimizations such as prioritizing coherence control messages over bulk data transfers to minimize synchronization latency, detecting and combining multiple invalidation messages targeting the same destination to reduce control traffic, or identifying opportunities for in-network coherence aggregation where multiple coherence operations can be batched for efficiency. The intra-rack connectivity fabric provides full bisection bandwidth, meaning that the aggregate bandwidth available between any two subsets of nodes within the rack equals the total injection bandwidth of the smaller subset, eliminating bottlenecks and ensuring that communication patterns do not suffer performance degradation regardless of traffic distribution. This high-performance local connectivity enables compute nodes within a rack to access memory nodes in the same rack with latencies measured in hundreds of nanoseconds to single-digit microseconds, providing performance approaching that of directly attached memory while maintaining the flexibility and scalability benefits of disaggregated architecture.

Step 1803 extends connectivity beyond individual racks through hierarchical spine switches that aggregate traffic across multiple racks and provide interconnection to higher-tier backbone routers or optical fabrics enabling data-center-wide or campus-wide deployments. The spine switches represent the second tier in the switching hierarchy, connecting to multiple leaf switches distributed across different racks and providing the high-bandwidth interconnection fabric that enables any compute node in any rack to access any memory node in any other rack within the deployment. Each spine switch includes multiple high-radix ports connecting downward to leaf switches in various racks and upward to optional super-spine switches, backbone routers, or optical circuit switches that provide even higher-level aggregation for very large deployments. The spine layer implements the same MF-TLP-aware routing intelligence as leaf switches, parsing packet headers to extract destination FIDs and forwarding packets along optimal paths toward target racks and nodes. When a compute node generates an MF-TLP packet targeting a memory node in a different rack, the packet first traverses the local leaf switch, which recognizes from the destination FID that the target lies outside the local rack and forwards the packet upward to an appropriate spine switch. The spine switch examines the FID's rack coordinate, determines which egress path leads to the target rack, and forwards the packet downward to the corresponding remote leaf switch, which finally delivers the packet to the destination memory node. This hierarchical forwarding enables efficient packet delivery with routing table sizes that scale logarithmically with the number of nodes rather than linearly, as each switch need only maintain next-hop information for rack-level or cluster-level destinations rather than tracking every individual node in the fabric. The interconnection topology implements multi-path routing, providing multiple parallel links between leaf and spine tiers that enable load balancing across paths to maximize aggregate throughput and provide redundancy for fault tolerance. Multiple physical links between any pair of switches can be bonded into logical high-bandwidth channels, or traffic can be distributed across links using various load balancing strategies including per-flow hashing where packets belonging to the same transaction stream follow the same path to preserve ordering but different flows spread across available links; per-packet spraying where individual packets can take different paths with reordering buffers at destinations reassembling streams; or adaptive routing where switches dynamically select paths based on real-time congestion measurements, avoiding overloaded links and steering traffic toward underutilized resources. MF-TLP packets carry flow group identifiers that specify ordering requirements, allowing the fabric to preserve ordering for packets within the same transaction or coherence sequence while enabling independent flows to be routed across different physical paths for maximum utilization. If link failures or switch failures occur—whether due to hardware faults, bit error rates exceeding thresholds, or administrative actions taking equipment offline—the system automatically reroutes traffic without invalidating coherence state or losing transaction progress. The MF-TLP protocol's retry and re-acknowledgment semantics, encoded in packet headers through transaction identifiers, sequence numbers, and acknowledgment control fields, enable the fabric to detect lost or corrupted packets due to failed links and automatically retransmit them over alternate paths, ensuring reliable delivery despite transient or permanent infrastructure failures. Routing algorithms continuously monitor link health and propagate failure information through the control plane, updating forwarding tables to avoid failed components and redistributing traffic across surviving paths with minimal disruption to ongoing operations.

Step 1804 describes the implementation of hierarchical coherence domains that enable the coherent memory fabric to scale to thousands of nodes while maintaining the cache consistency guarantees essential for correct program execution. Traditional coherence protocols that maintain global consistency through broadcast mechanisms or fully centralized directories encounter scalability walls as the number of nodes increases, suffering from bandwidth bottlenecks at centralized points, latency increases due to long-distance coordination, or protocol complexity that becomes unmanageable at large scales. The hierarchical coherence approach addresses these scalability challenges by organizing the fabric into nested coherence domains at different granularities, with local coherence mechanisms handling most operations within small groups of nearby nodes and global coherence mechanisms invoked only when operations cross domain boundaries. Within each rack, a local directory controller maintains detailed sharer and ownership information for memory lines that are frequently accessed by compute nodes within that rack, tracking which specific nodes hold cached copies, which node owns a line exclusively if any, what coherence states various cached copies occupy, and what version numbers or epoch counters apply to detect stale accesses. The local directory enables most coherence operations to complete entirely within the rack: when a compute node requests read access to a memory line and the local directory indicates that the line is available locally in the rack's memory node with no exclusive owners, the read can be satisfied entirely through intra-rack communication without involving any higher-level directories or remote nodes. Similarly, when a compute node writes to a shared line, the local directory can issue invalidations to all sharers within the rack efficiently through broadcast or multicast mechanisms that leverage the high-bandwidth, low-latency intra-rack fabric. Local coherence traffic—including read requests, write requests, invalidation messages, and acknowledgments—is confined within racks whenever the sharing pattern permits, dramatically reducing the bandwidth consumed in the higher-level spine fabric and avoiding latency penalties associated with cross-rack coordination. Across racks, a global directory system maintains metadata summarizing inter-rack sharing patterns at coarser granularity than the detailed per-line tracking performed by local directories. The global directory may be implemented in spine switches as distributed logic that maintains summary information about which racks contain sharers of particular memory regions, in dedicated management nodes that serve as centralized or partitioned global coherence coordinators, or in hierarchical configurations where multiple levels of global directories track sharing at increasing scales. The global directory does not track individual compute node identities for every cached line, which would create unsustainable metadata overhead, but instead maintains coarse-grained information such as which racks have any sharers, which rack contains the exclusive owner if any, or aggregate version information that enables detection of cross-rack coherence violations. When a compute node in one rack attempts to access memory that is exclusively owned by a node in a different rack, the local directory recognizes that it cannot satisfy the request locally, consults the global directory to identify which rack contains the owner, and sends a coherence request to that remote rack's local directory, which then issues appropriate invalidations or transfers ownership as required. This hierarchical coordination occurs only when necessary—the vast majority of memory accesses in well-designed applications exhibit locality and can be satisfied within local coherence domains, with only occasional cross-rack sharing requiring global directory involvement. The hierarchy enables the system to scale to thousands of nodes because the local directories absorb most coherence traffic and present only aggregate load to the global directory, preventing bottlenecks and allowing near-linear scaling of coherence bandwidth and throughput. Optimization techniques further improve hierarchical coherence performance: local directories can cache information about remote sharing patterns to accelerate repeated cross-rack accesses; global directories can use bloom filters or other approximate data structures to track sharing at reduced metadata cost; and directories can employ lease-based protocols where sharing permissions are granted for time-bounded intervals, reducing the frequency of coherence messages by allowing nodes to retain cached copies without continuous directory interaction until leases expire.

Step 1805 addresses the enforcement of end-to-end governance and security throughout the fabric-wide topology, ensuring that multi-tenant workloads can share infrastructure safely while receiving predictable performance and maintaining isolation boundaries that prevent information leakage or unauthorized access. Each MF-TLP packet traversing the fabric carries tenant identifiers that uniquely associate the packet with a specific customer, application, user, or security domain, enabling infrastructure at every level—from memory-centric network interface controllers through leaf switches and spine switches to memory node controllers—to enforce policies tailored to that tenant's requirements and entitlements. Quality-of-service tags embedded in packet headers specify the service class or priority level for each transaction, allowing the fabric to provide differentiated treatment based on workload criticality, latency sensitivity, or bandwidth requirements. For example, packets belonging to real-time inference workloads serving end-user requests may carry high-priority tags ensuring low-latency forwarding through switch queues and rapid processing at memory nodes, while packets associated with batch training jobs or background analytics may use lower-priority tags accepting higher latency in exchange for not interfering with interactive workloads. Switches throughout the hierarchy—both leaf switches handling intra-rack traffic and spine switches managing inter-rack flows—implement per-tenant bandwidth reservations that guarantee minimum throughput allocations for each tenant regardless of competing load from other tenants, preventing any single aggressive tenant from monopolizing fabric bandwidth to the detriment of others sharing the infrastructure. Rate-limiting mechanisms enforce maximum bandwidth caps for tenants, preventing accidental or malicious oversubscription that could degrade fabric performance for other users and enabling fine-grained control over resource consumption for cost allocation and capacity planning. Priority scheduling algorithms within switch queues and arbiters ensure that high-priority packets receive expedited processing, with strict priority schemes preempting lower-priority traffic for ultra-low-latency requirements or weighted fair queuing schemes providing proportional bandwidth sharing based on priority levels while preventing starvation of lower-priority flows. Each memory-centric network interface controller implements per-tenant counters tracking metrics such as packets transmitted and received, bytes transferred, transactions completed, cache hits and misses, and latency distributions, providing comprehensive visibility into resource usage patterns that enable accounting, debugging, and capacity planning. Policy enforcement hardware within network interface controllers throttles or shapes outgoing transactions to comply with global service-level objectives, applying token bucket or leaky bucket algorithms to smooth bursty traffic, implementing admission control that rejects or queues new transactions when limits are exceeded, or providing backpressure signals to application software indicating that rate limits are being approached. Security mechanisms integrated throughout the topology protect against various threat models: cryptographic authentication fields in MF-TLP packets enable verification that packets originate from authorized network interface controllers rather than rogue devices injected into the fabric or compromised nodes attempting to masquerade as legitimate participants; fabric-wide sequence tokens or nonces prevent replay attacks where captured packets are retransmitted to perform unauthorized operations; message authentication codes (MACs) or digital signatures computed over packet contents enable detection of tampering during transmission, ensuring that neither headers nor payloads are modified by malicious intermediate switches or man-in-the-middle attackers. Fabric gateways connecting different security zones or administrative domains enforce access-control policies that restrict which compute nodes may access particular memory ranges, implementing address-based filtering that permits or denies transactions based on source tenant, destination address, and operation type. These gateways can maintain access control lists (ACLs) specifying allowed or denied combinations of tenant and memory region, consult centralized policy servers for dynamic authorization decisions, or implement capability-based security where tokens embedded in packets prove the bearer's right to access specific resources. Switches within the fabric maintain integrity checklists or watchdog logic that monitors packet headers for anomalies such as malformed field encodings, invalid state combinations, suspicious patterns indicative of attacks, or violations of protocol state machines, rejecting potentially malicious or corrupted packets before they reach memory nodes where they might cause data corruption, security violations, or denial-of-service conditions. Advanced security configurations employ encryption of payload data to protect sensitive information during transmission across shared fabric infrastructure, with tenant-specific encryption keys established through secure key exchange protocols and cryptographic operations performed at network interface controllers to minimize performance impact.

Step 1806 describes fabric-level load distribution and collective processing capabilities provided by in-network processing engines embedded within switches at various levels of the hierarchy. These processing engines represent computational logic beyond traditional packet forwarding, providing the ability to perform arithmetic, logical, or data movement operations directly on packet payloads as they traverse the network, transforming the interconnect from a passive transport medium into an active computational fabric that can accelerate collective communication patterns essential for distributed applications. The in-network processing engines are deployed within spine switches or aggregation switches that see traffic from multiple sources converging toward common destinations, providing optimal placement for operations that combine or transform data streams. These engines implement collective operations such as REDUCE, where multiple partial results from distributed compute nodes are combined using associative and commutative operators like summation, minimum, maximum, logical conjunction, or user-defined aggregation functions to produce a single consolidated result; ALL-REDUCE, where the reduction operation produces a result that is then distributed back to all participating compute nodes, enabling every node to receive the global aggregate; and BROADCAST, where data from a single source is efficiently replicated and distributed to multiple destinations through tree-structured forwarding that minimizes wire traffic compared to unicast transmission to each destination individually. When MF-TLP packets carrying partial results for a reduction operation arrive at a switch, the in-network processing engine recognizes them through opcode fields and reduction group identifiers in the packet headers, buffers the arriving packets temporarily in local storage, extracts payload data representing partial values, applies the specified reduction operation to combine the values using dedicated arithmetic units or programmable logic, and generates a new packet containing the intermediate aggregate that is forwarded toward the next aggregation point or final destination. This in-network aggregation proceeds hierarchically: leaf switches combine packets from compute nodes within their local rack producing rack-level intermediate aggregates, spine switches combine intermediate aggregates from multiple racks producing cluster-level results, and super-spine switches or root nodes combine cluster-level aggregates producing the final global result. Partial results are thus aggregated incrementally along the upward path toward the top of the network hierarchy, dramatically reducing the volume of data that must traverse higher levels of the fabric compared to naive approaches where all partial results flow to a single aggregation point before being combined. On the downward path from the aggregation root back toward compute nodes, switches can efficiently redistribute the final result through multicast or broadcast mechanisms, replicating the result packet at each branching point in the network tree such that every participating compute node receives the final aggregate with minimal network traversal and latency. This hierarchical aggregation model provides enormous performance benefits for distributed workloads: AI training jobs with thousands of GPUs performing data-parallel training can aggregate gradients from all workers into updated parameter tensors using in-network reduction, completing gradient synchronization in microseconds rather than the milliseconds required by software-based parameter servers or host-managed reduction trees; high-performance analytics queries executing distributed aggregations can combine partial sums, counts, or statistics from thousands of data partitions with minimal latency and network bandwidth consumption; scientific simulations performing iterative solvers can efficiently exchange boundary conditions and synchronize global state using hardware-accelerated collectives rather than explicit point-to-point communication patterns requiring thousands of message exchanges. The in-network processing engines reduce end-to-end data movement by orders of magnitude compared to host-based collective implementations, as data is aggregated progressively as it flows through the fabric rather than requiring transmission of all data to central aggregation points, and they reduce latency by performing arithmetic operations at line rate within the network hardware rather than requiring data to be transferred to host processors, processed through software, and transmitted back into the network.

Finally, step 1807 describes support for multi-cluster federation enabling multiple independent coherent fabrics to be interconnected into larger-scale systems spanning multiple data centers, geographic regions, or administrative domains. In this configuration, multiple coherent memory fabrics—each with its own directory hierarchy, address space management, and potentially running under different administrative control—are connected through specialized gateway bridges that translate between different fabric instances while maintaining global coherence semantics. These gateways act as border routers between fabrics, performing protocol translation, address space mapping, coherence metadata conversion, and policy enforcement for cross-fabric transactions. When a compute node in one fabric issues a memory operation targeting an address located in a different fabric, the local network interface controller generates an MF-TLP packet with a fabric identifier indicating the remote destination, local switches forward the packet to the fabric gateway serving the appropriate remote fabric, the gateway translates the source fabric's identifier and address format into the destination fabric's conventions, adjusts coherence metadata to reflect any differences in directory organization or consistency protocols between the fabrics, and injects the translated packet into the destination fabric where it is routed normally to the target memory node. Responses follow the reverse path, with the gateway performing inverse translations to return results to the originating fabric. This gateway-mediated interconnection enables global address spaces that span physically separate installations, allowing applications to transparently access memory resources across geographic distances while maintaining coherent semantics—a compute node can read or write memory regardless of whether the memory resides in the local data center or in a remote facility connected via wide-area networks. Coherence messages exchanged between fabrics may be compressed using dictionary coding, run-length encoding, or other techniques to reduce wide-area bandwidth consumption and compensate for the limited bandwidth and high latency of inter-site links compared to intra-site fabric interconnection. Gateways can employ checkpointing mechanisms that batch multiple coherence operations into larger transactions, reducing protocol overhead and amortizing the latency penalties associated with wide-area communication. Advanced gateway implementations support sophisticated coherence protocols adapted for high-latency environments: lazy release consistency allowing compute nodes to defer coherence enforcement until synchronization points rather than maintaining strict order for every operation; home node migration that dynamically relocates the authoritative copy of frequently shared data closer to its primary consumers to reduce average access latency; or eventual consistency modes that permit temporary divergence between replicas with eventual reconciliation through version vectors or conflict-free replicated data type (CRDT) mechanisms. The gateway architecture enables federated deployments supporting diverse use cases: disaster recovery configurations where multiple data centers maintain coherent replicas enabling seamless failover if one site becomes unavailable; geographic distribution placing compute and memory resources near end users to minimize latency for globally distributed applications; or hybrid cloud deployments where on-premise fabric infrastructure extends into public cloud environments through gateway connections, enabling workload migration and capacity bursting while maintaining consistent programming models. Through multi-cluster federation, the coherent memory fabric architecture scales beyond the limits of any single physical installation, enabling truly global-scale coherent memory systems that span continents while providing the same load-store programming interface and hardware consistency guarantees available within single-rack deployments.

This flow represents the comprehensive macro-scale topology of the coherent memory fabric system, demonstrating how physical infrastructure including compute nodes, memory nodes, leaf switches, spine switches, and gateway bridges combines with protocol-level mechanisms including hierarchical coherence directories, multi-path routing, quality-of-service enforcement, security and governance policies, in-network collective processing, and multi-cluster federation to create a scalable and secure substrate for memory-centric computing across thousands of nodes. Through its combination of MF-TLP-aware switching infrastructure that understands memory-specific protocol semantics beyond generic packet forwarding, hierarchical coherence control that confines most traffic to local domains while enabling global consistency, multi-path reliability providing redundancy and automatic failover, comprehensive governance mechanisms ensuring fair resource allocation and tenant isolation, and in-network compute capability transforming the interconnect into an active processing substrate, the architecture provides the foundation for disaggregated computing where memory and compute resources scale independently, workloads flexibly utilize pooled resources, and applications achieve performance approaching directly attached memory despite operating across distributed fabric infrastructure. This design enables independently scalable compute and memory resources that can be provisioned and upgraded separately based on workload requirements rather than being constrained by fixed server ratios, deterministic coherence across wide-area deployments maintaining sequential consistency or relaxed memory models as required by applications, and seamless extension of MF-TLP semantics from chip-level interconnects through rack-scale fabrics to full data-center and multi-site deployments, providing a unified programming model and consistent performance characteristics across all scales. The fabric-wide topology supports modern distributed workloads including large-scale neural network training distributing computation across thousands of accelerators while maintaining coherent access to shared parameters and gradients, real-time analytics ingesting streaming data at terabit rates while performing in-network aggregation and filtering, distributed databases scaling to petabyte-scale datasets while providing strong consistency guarantees through coherent memory operations, and scientific computing applications requiring high-performance communication and fine-grained synchronization across massive parallel computations. By transforming the data center network from a simple interconnect providing packet delivery into an intelligent coherent memory fabric providing load-store semantics, atomic operations, reductions, vectorized transactions, and hardware-enforced consistency, the topology enables a fundamental shift in distributed computing architectures—from message-passing models requiring explicit communication primitives and software-managed coherence to memory-centric models where applications simply read and write memory regardless of physical location while the fabric transparently handles routing, coherence, governance, and optimization.

In certain embodiments, the coherent memory fabric of FIGS. 10-18 is integrated with kernel-level and hypervisor-level orchestration components. The operating system registers the fabric as a NUMA-far memory node accessible through a Fabric Memory Driver. The driver intercepts far-page faults, issues MF-TLP transactions to the appropriate MC-NIC, and updates local page tables upon data return. Prefetch and swap-out daemons use telemetry metrics (latency, queue depth, thermal state) to migrate pages proactively.

A hypervisor layer enforces multi-tenant governance by associating each MF-TLP packet with a Tenant-ID and policy token. The MC-NIC parses these tags to apply rate limiting, bandwidth ceilings, and priority scheduling. Tenant isolation is thus enforced in hardware, preventing resource interference while enabling fair-share access to shared far-memory pools.

The cache controllers within MC-NICs or memory nodes host programmable policy modules that define cache-line pinning, promotion, and eviction rules. Policies may reflect workload type, telemetry thresholds, or service-level objectives. Modules can be updated at runtime without firmware rebuilds, providing adaptive tiering across HBM, DRAM, and persistent tiers.

Telemetry collected from NICs, bridges, and memory nodes feeds back into the OS and hypervisor orchestration daemons. This closed-loop mechanism enables dynamic adjustment of caching, migration, and governance parameters based on observed workload and network conditions, maintaining low-latency coherence while optimizing power and utilization.

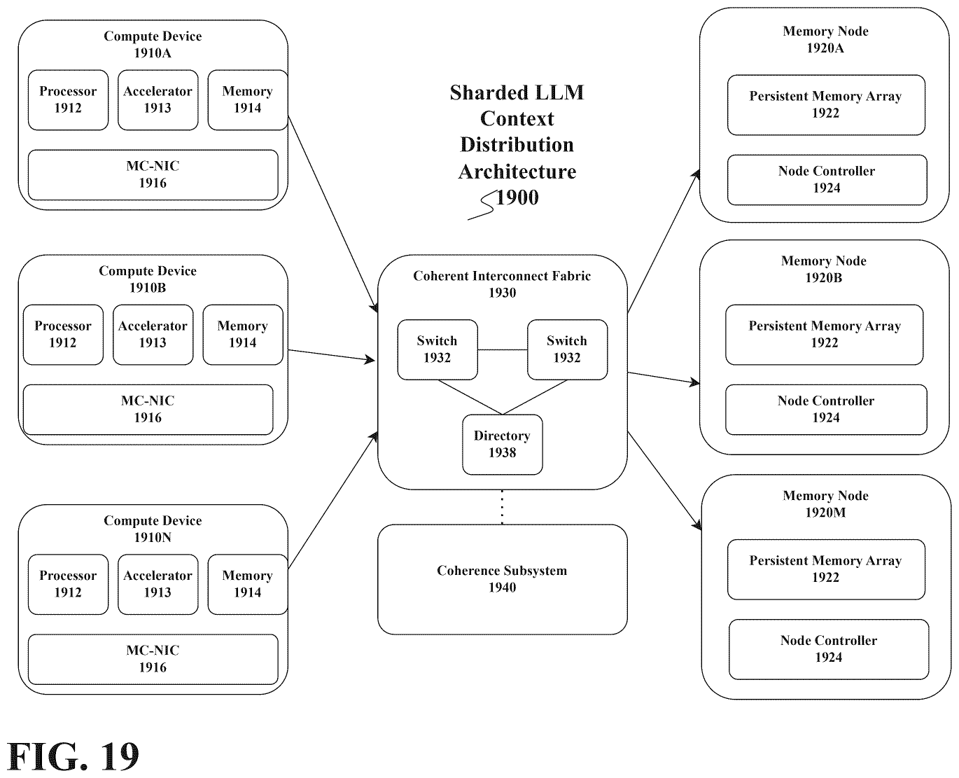

FIG. 19 is a block diagram illustrating an exemplary architecture of a sharded large-language model (LLM) context distribution architecture 1900 implemented over the coherent memory fabric. The embodiment demonstrates how a million-token sequence context may be distributed, cached, and coherently accessed across a plurality of compute nodes and memory nodes interconnected by the Memory-Fabric Transaction Layer Protocol (MF-TLP) and associated memory-centric network interface controllers (MC-NICs). The architecture enables large-context inference and training workloads to operate on datasets far exceeding the local memory capacity of individual accelerators, while maintaining deterministic latency and global coherence across all participating nodes.

A collection of compute devices 1910A, 1910B, 1910N—each containing one or more processors 1912, high-performance accelerators 1913 (e.g., GPUs, TPUs, or AI ASICs), and local memory 1914—are coupled to the coherent interconnect fabric 1930 through MC-NICs 1916. The compute nodes execute transformer-based models in which a key/value (K/V) cache must persist across multiple attention windows. In conventional architectures, the K/V cache for a million-token sequence cannot fit in on-board HBM and must be repeatedly re-fetched or recomputed. In the embodiment shown, the K/V cache is horizontally partitioned into context shards 1920A-1920M, each mapped to a distinct memory node 1920 comprising a persistent memory array 1922 and node controller 1924.

Each shard represents a contiguous range of the token sequence—for example, tokens 0-100 k, 100 k-200 k, 200 k-300 k, and so on—stored across distributed memory nodes within the fabric. The memory nodes 1920 communicate with compute devices 1910 via MF-TLP packets routed through the interconnect fabric 1930. When the model's attention mechanism advances through the sequence, MF-TLP read transactions 1932 are issued from the requesting accelerator 1913 to retrieve only the active shard segments required for the current attention window. The MC-NIC 1916 encapsulates each request into a vectorized MF-TLP packet containing one or more vector descriptors identifying the K/V offsets to be fetched, thereby amortizing header overhead across multiple contiguous tokens.

To maintain performance at scale, the MC-NIC 1916 implements predictive prefetching logic that analyzes recent attention patterns and model telemetry to forecast which shards will be needed next. Based on these predictions, the NIC proactively issues low-priority MF-TLP read operations to stage upcoming token blocks into on-chip SRAM or into near-memory buffers within the memory node controllers 1924. Prefetched shards remain coherent with other fabric participants via MF-TLP coherence messages carrying lease tokens or version identifiers encoded in packet headers. When the compute node subsequently requests the prefetched region, the data is returned immediately from local cache without incurring remote latency.

The coherence subsystem 1940 maintains global consistency of the distributed K/V cache. Each memory node 1920A-M or associated switch-level directory 1938 stores sharer information for the K/V address range it owns. When a compute device 1910 modifies a portion of the cache (e.g., during fine-tuning or gradient checkpointing), the corresponding MC-NIC 1916 issues write-invalidate transactions encoded as MF-TLP coherence packets. These messages propagate through the fabric 1930 to all other sharers recorded in the directory, ensuring that stale copies of the updated region are invalidated or refreshed. The coherence protocol thereby guarantees that each token's key/value vectors remain synchronized across the distributed memory hierarchy.

In certain embodiments, the memory nodes 1920A-M may participate in in-network reduction or aggregation of model state updates. For instance, when multiple compute devices generate partial gradient deltas for overlapping token segments, the reduction engine 1926 integrated into each MC-NIC 1916 or switch 1932 performs local summation before committing a consolidated update to the persistent memory array 1922. These operations are executed as MF-TLP reduction transactions, enabling line-rate arithmetic near the data source and minimizing redundant traffic through the network.

The architecture also supports hierarchical context caching. Hot shards predicted for near-term reuse are temporarily replicated into cache tiers within the fabric switches 1932 or into NIC-resident HBM caches, whereas cold shards are retained in remote NVM. MF-TLP packets carry caching hints and QoS tags allowing programmable promotion or demotion policies. Such hierarchical management ensures that high-attention tokens remain close to compute while rarely accessed segments remain in far memory without degrading inference throughput.

This demonstrates how the coherent memory fabric enables scalable, fine-grained partitioning of large-language-model contexts across multiple nodes, combining predictive prefetch, vectorized MF-TLP transactions, and distributed coherence to deliver million-token sequence processing with near-local memory latency. The architecture unifies compute and memory resources under a single packet-switched, memory-semantic domain, providing the foundation for subsequent embodiments that extend these principles to multimodal pipelines and fabric-object collectives.

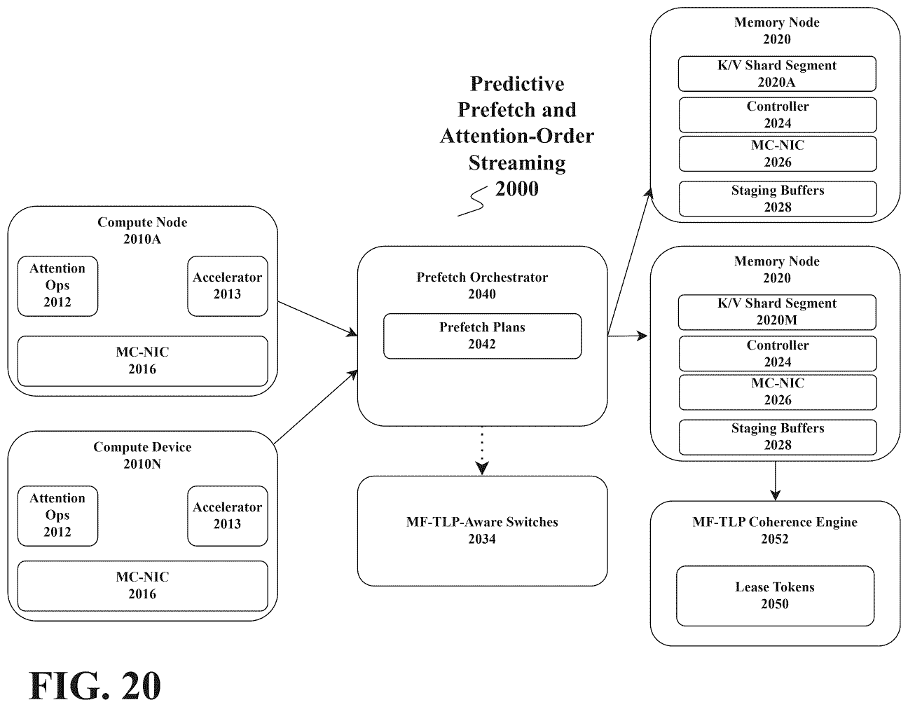

FIG. 20 is a block diagram illustrating an exemplary system of a predictive prefetch and attention-order streaming 2000 within the coherent memory fabric architecture, according to an embodiment. The embodiment expands upon the sharded large-language-model (LLM) context system, focusing on how Memory-Fabric Transaction Layer Protocol (MF-TLP) telemetry and orchestration logic enable predictive data staging and ordered token streaming to support ultra-large attention windows exceeding one million tokens.

Each compute node 2010A, 2010B, and 2010N executes a sequence of attention operations 2012 across distributed K/V shard segments 2020A-2020M stored in memory nodes 2020. The MC-NICs 2016 attached to the compute nodes continuously monitor token-access telemetry, including key/value address ranges, access frequency, stride distance, and attention-head reuse metrics. This telemetry is exported as fabric metadata streams 2032 that describe access patterns observed during recent attention computations. The metadata streams are consumed by a prefetch orchestrator 2040, implemented in firmware within the MC-NIC or as a supervisory service running on a control processor connected to the fabric.

The prefetch orchestrator 2040 analyzes incoming telemetry to predict the future sequence of shard accesses for each attention head or model layer. Using temporal correlation and stride-detection heuristics, the orchestrator generates prefetch plans 2042 that specify target addresses, expected time windows, and priority levels for upcoming token blocks. These plans are transformed into low-priority MF-TLP prefetch packets, which are dispatched ahead of actual demand to the corresponding memory nodes 2020.

At each destination, the memory-node controllers 2024 and their local MC-NICs 2026 receive the prefetch packets and allocate staging buffers 2028 in near-memory SRAM. Prefetched data blocks are tagged with lease tokens or epoch identifiers 2050 in their coherence metadata fields, ensuring that prefetched lines remain valid until consumed or until lease expiration. When the compute node subsequently issues a demand read for the same address range, the MF-TLP coherence engine 2052 validates the lease token and returns the prefetched data immediately, avoiding round-trip latency to remote NVM.

During inference, the attention pipeline within each accelerator 2013 processes tokens in a streaming fashion. The pipeline emits demand MF-TLP read requests for the active shard range while simultaneously updating its telemetry counters. As each attention window advances, newly prefetched shards replace consumed ones in a sliding-window buffer, maintaining a constant population of hot token segments. The orchestrator 2040 updates prefetch plans dynamically based on real-time feedback from the telemetry stream, thereby implementing a closed-loop predictive scheduling system that adapts to model behavior.

In certain embodiments, predictive prefetching is augmented by attention-order correlation tables maintained within each MC-NIC. These tables store the most recent access sequence for each model layer or attention head, indexed by input context identifiers. When a similar sequence appears, the NIC proactively replays previously learned prefetch patterns. This approach effectively caches prefetch “scripts” in hardware, providing microsecond-scale response to repeating access motifs common in autoregressive decoding.

To prevent congestion, prefetch packets are marked with priority and throttling metadata, allowing MF-TLP-aware switches 2034 to defer or reschedule speculative transfers under load. The orchestrator dynamically tunes prefetch depth and concurrency based on congestion reports or buffer utilization metrics returned through fabric telemetry channels. Thus, prefetch traffic opportunistically fills idle bandwidth while preserving deterministic latency for demand reads and atomic updates.

The predictive prefetch system operates coherently with other MF-TLP mechanisms. Each prefetch packet carries standard coherence metadata, ensuring that prefetched lines participate in the same directory-based protocol as normal reads or writes. If a prefetched line is invalidated by a concurrent update elsewhere in the fabric, the coherence controller automatically cancels or refreshes the staged data. This integration preserves strict consistency and fault-tolerant execution even under speculative data movement.

This demonstrates how predictive telemetry and attention-order analysis transform the MF-TLP fabric into an adaptive, self-optimizing memory plane. By combining real-time access monitoring, orchestrated prefetch planning, and hardware-level lease enforcement, the system sustains near-local latency for multi-million-token attention contexts. The approach eliminates host intervention and manual caching heuristics, enabling large-scale transformer models to operate natively over disaggregated, coherent memory fabrics.

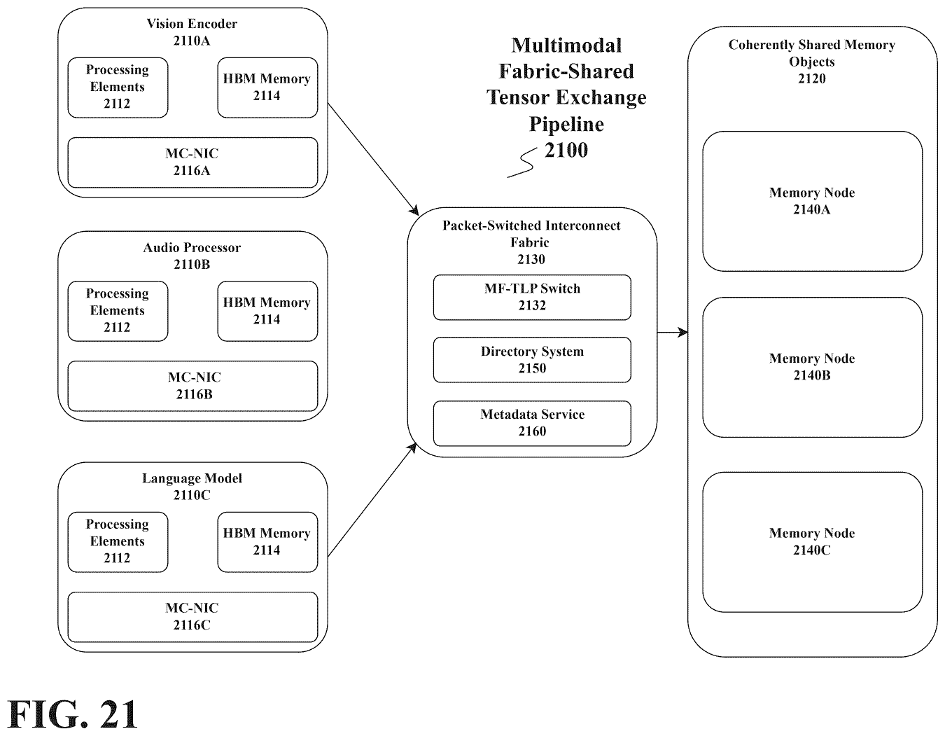

FIG. 21 is a block diagram illustrating an exemplary architecture of a multimodal fabric-shared tensor exchange pipeline 2100 that leverages the coherent memory fabric of the present disclosure to enable zero-copy communication of embeddings, feature maps, and tensor data across heterogeneous accelerators. The embodiment demonstrates how vision, audio, and language processing models exchange multimodal feature tensors through shared coherent memory regions managed by the Memory-Fabric Transaction Layer Protocol (MF-TLP) and executed by Memory-Centric Network Interface Controllers (MC-NICs) without software-level replication or host mediation.

A multimodal computing environment 2100 comprises a plurality of accelerator subsystems 2110A-2110C, each optimized for different modalities such as image encoding, speech processing, or text generation. Each accelerator subsystem 2110 includes one or more processing elements 2112 (e.g., GPUs, DSPs, tensor processors, or neural inference cores) and a local high-bandwidth memory subsystem 2114. The accelerators are connected to the packet-switched interconnect fabric 2130 through MC-NICs 2116A-C, which provide hardware-level access to a set of coherently shared memory objects 2120 located across distributed memory nodes 2140A-2140C.

Each shared memory object 2120 represents a coherent tensor region (for example, an image embedding array, an audio spectrogram tensor, or a text feature vector batch) mapped into the global fabric address space. These tensors are accessible to any participating accelerator through MF-TLP packets that encapsulate vectorized memory operations with explicit coherence metadata. The MF-TLP header specifies an object handle or fabric identifier (FID), an operation code (read, write, atomic, or reduction), and optional vector descriptors describing strided or multi-offset access patterns within the tensor layout.

When the vision encoder accelerator 2110A completes feature extraction on an image batch, its MC-NIC 2116A packages the resulting feature tensors into one or more MF-TLP write transactions 2132. Each write packet carries multiple descriptors defining the target regions of a coherent tensor object 2120 in the shared memory pool. The payload of each MF-TLP packet contains the serialized tensor elements or fragments, while the coherence metadata ensures that the written regions transition to a valid and globally visible state. The NIC hardware computes checksums and updates directory entries associated with the modified addresses, guaranteeing that downstream consumers observe consistent tensor data.

The language model accelerator 2110B, which consumes vision embeddings for caption generation, issues corresponding MF-TLP read transactions. These read packets identify the same tensor object 2120 and address offsets using vector descriptors retrieved from a metadata catalog. Upon receipt, the destination MC-NIC 2116B coordinates with the coherence directory to verify sharer state, retrieves the requested data directly from the memory node 2140A-C that holds the object, and returns a consolidated response packet containing the tensor slices. The entire exchange occurs without host CPU copies or PCIe staging, effectively eliminating N-fold data replication across devices.

To ensure deterministic performance, each tensor object 2120 carries quality-of-service (QoS) and access-control attributes encoded in its fabric metadata. These attributes specify permitted accessors, priority levels, and congestion-handling policies. The interconnect fabric 2130 enforces these attributes through MF-TLP header tags parsed by MF-TLP-aware switches 2132, which schedule or throttle packets accordingly. In some embodiments, the fabric may apply differentiated service queues to isolate high-priority real-time audio streams from bulk embedding transfers, ensuring temporal coherence and latency predictability across concurrent workloads.

The MC-NICs 2116 incorporate a programmable tensor-aware caching subsystem that optimizes access to shared multimodal tensors. Frequently reused embeddings or feature slices are promoted to local HBM caches under programmable policies, while less active data remains in far memory. Each MF-TLP header includes caching hints—for instance, “PIN,” “PROMOTE,” or “EVICT”—allowing the NIC hardware to automatically adjust placement tiers in response to observed access frequency. The programmable caching subsystem can dynamically allocate on-device cache lines to active tensor shards, minimizing redundant fabric transactions and improving throughput for repetitive cross-modal lookups.

The architecture further supports streaming multimodal pipelines wherein tensors produced by one modality are consumed by another in overlapping phases. For example, while the vision encoder 2110A is generating feature maps for the next batch, the language model 2110B concurrently reads embeddings from the previous batch through MF-TLP vectorized reads. The MC-NIC scheduling unit maintains out-of-order completion queues that align with pipeline dependencies, ensuring that data produced in epoch N becomes visible to downstream consumers precisely when required.

Coherence is preserved automatically across modalities by the fabric-wide directory system 2150. Each memory node 2140A-C maintains per-object sharer lists and ownership states. When a tensor region is updated by an encoder, the directory issues targeted invalidation messages to all sharers listed in its table, prompting their MC-NICs to refresh cached tensor fragments. If the tensor object participates in a collective operation (such as a reduction of multimodal attention weights), the directory coordinates with reduction engines in switches or MC-NICs to combine partial results before committing the final value back into memory.

Security and isolation are ensured through tenant identifiers and access domains attached to each tensor object 2120. Every MF-TLP transaction carries a tenant ID verified by both the MC-NIC and the fabric switches. Unauthorized or cross-tenant accesses are blocked at the network level, while encryption or authentication extensions can be applied using MF-TLP extension headers. This allows multiple workloads or customers to share the same multimodal memory fabric safely and efficiently.

In some embodiments, the multimodal tensor pipeline is augmented by a metadata exchange service 2160 implemented via MF-TLP message-class transactions. This service manages tensor schemas, dimensional metadata, and allocation handles, ensuring that producers and consumers interpret shared tensors consistently. Metadata objects can be cached locally in NIC firmware or broadcast through fabric collectives when models are updated, maintaining synchronization across heterogeneous frameworks.

The system also supports real-time tensor reduction and fusion operations for cross-modal attention mechanisms. MC-NICs or in-fabric compute engines perform operations such as weighted averaging, normalization, or projection directly on shared tensor objects. For example, the audio and text models may each compute partial attention matrices that are aggregated in-network by switch-resident reduction logic and written back to a unified tensor region accessible by the multimodal decoder. This distributed execution model avoids high-latency host aggregation and provides near-deterministic inference pipelines.

Therefore this subsystem demonstrates how the coherent memory fabric of the present embodiment transforms multimodal pipelines into a shared, memory-centric communication domain. By enabling zero-copy tensor exchange, programmable caching, in-network reduction, and directory-managed coherence, the architecture allows vision, audio, and language accelerators to operate on shared data as though it were locally resident. This unification of modalities within a coherent packet-switched fabric eliminates redundant data movement, improves bandwidth efficiency, and delivers real-time performance for complex multimodal AI workloads.

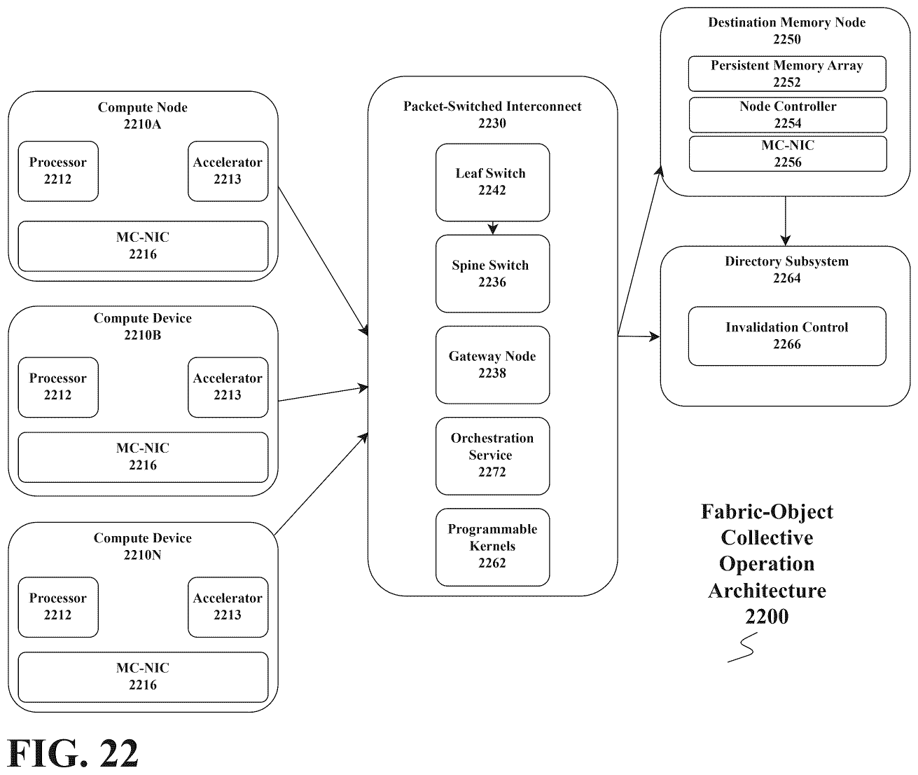

FIG. 22 is a block diagram illustrating an exemplary architecture of a fabric-object collective operation 2200 implemented within the coherent memory fabric described herein. The embodiment demonstrates how the Memory-Fabric Transaction Layer Protocol (MF-TLP), operating over a distributed hierarchy of Memory-Centric Network Interface Controllers (MC-NICs) and MF-TLP-aware switches, enables collective communication primitives—such as REDUCE, REDUCE-SCATTER, ALL-GATHER, and ALL-REDUCE-VEC—to execute directly within the interconnect fabric. By offloading these operations from host processors and performing them near the memory where tensor data resides, the system minimizes latency, reduces network traffic, and achieves deterministic scaling across thousands of compute nodes.

A plurality of compute devices 2210A, 2210B, and 2210N each include one or more processors 2212, accelerators 2213 (e.g., GPUs, TPUs, or tensor processors), and a local MC-NIC 2216 connected to the packet-switched fabric interconnect 2230. The compute devices participate in a distributed workload—such as transformer model training, multimodal fusion, or data-parallel analytics—wherein each node produces a partial tensor result (for example, a gradient vector, attention weight block, or statistical metric). These partial tensors are encoded into MF-TLP reduction packets, each containing operation type, target fabric object identifier, payload data, and coherence metadata.

Each MF-TLP packet is routed across the fabric interconnect 2230, which comprises leaf switches 2242, spine switches 2236, and optional gateway nodes 2238. The fabric topology forms a hierarchical reduction tree, where each intermediate switch and NIC can perform arithmetic or logical operations directly on in-flight data. MF-TLP headers carry collective operation codes (e.g., REDUCE_SUM, REDUCE_MAX, ALLGATHER_VEC) and group identifiers that associate packets with a particular collective epoch or training step. The switches parse these headers in hardware and direct packets along aggregation paths defined by the collective routing policy.

Within the switch reduction engines, payloads from multiple contributors are combined using typed arithmetic or logical operators. For instance, gradient values may be summed element-wise using 32-bit or 16-bit floating-point arithmetic; activation statistics may be reduced using min/max operators; or logical consensus may be computed via bitwise conjunction or disjunction. Each engine includes a streaming accumulation buffer and a vector arithmetic unit configured to process multiple tensor elements per clock cycle. The switch aggregates partial results as packets arrive, emitting a single aggregated packet upstream toward the destination memory node.

The destination memory node 2250 comprises a persistent memory array 2252 and a node controller 2254 coupled to a local MC-NIC 2256. When aggregated packets 2246 reach the destination, the MC-NIC 2256 finalizes the reduction by combining any residual partials in hardware and committing the resulting tensor to the memory array 2252. The MF-TLP header for each transaction includes a transaction identifier and an epoch marker, allowing the node controller to detect completion of all contributors. Upon finalization, the MC-NIC 2256 generates completion packets which may be multicast or broadcast to participating nodes, signaling that the reduction or collective operation is complete and that the updated tensor is coherent and ready for reuse.

In some embodiments, the collective operation may employ hierarchical aggregation. Each rack-level sub-fabric performs an intra-rack reduction using local switches and NICs 2216; the resulting partial aggregates are then forwarded to higher-level spine switches 2236 for inter-rack combination. This two-tiered hierarchy drastically reduces inter-rack bandwidth requirements by localizing the majority of data movement within each rack. The MF-TLP protocol maintains end-to-end ordering and consistency across these hierarchical stages using embedded sequence numbers and group completion tokens.

The collective architecture further supports vectorized collectives, wherein multiple contiguous or non-contiguous memory addresses are included within a single collective operation descriptor. For example, an ALL-GATHER-VEC operation may aggregate embeddings scattered across many memory nodes by issuing MF-TLP packets whose vector descriptors list the offsets of each segment. The receiving MC-NIC expands these descriptors and performs parallel transfers, returning a consolidated payload to each participant. This mechanism eliminates the need for separate gather and redistribution phases, significantly reducing synchronization overhead.

In another embodiment, the collective reduction engines and MC-NICs support programmable arithmetic kernels 2262. Using a microcoded instruction interface, the engines can execute user-defined operators such as normalization, scaling, activation fusion, or gradient clipping. Each programmable kernel is loaded from a shared template stored in firmware or distributed through MF-TLP control messages. During execution, the switch dynamically instantiates the appropriate arithmetic logic, performs the operation on streaming data, and reverts to standard reduction mode once the collective completes.

To maintain coherence, the destination MC-NIC 2256 interacts with the fabric directory subsystem 2264. Prior to committing reduced tensors to memory, the NIC issues invalidate-on-write transactions 2266 to all sharers listed in the directory entry for the affected object, ensuring that old copies in accelerator caches are purged. When the updated tensor is written back, the directory updates its sharer list to reflect the new ownership state. This guarantees that subsequent reads by participating nodes fetch the finalized, consistent version of the data.

Collective operations may also produce multiple distributed results rather than a single global tensor. For example, a REDUCE-SCATTER operation divides the reduced tensor among compute nodes 2210A-2210N, with each node receiving a distinct partition. In this case, the MC-NIC 2256 divides the final aggregate tensor into contiguous slices and transmits them via MF-TLP write packets to the corresponding nodes, updating the directory metadata to record each node as the new home for its segment.

Quality-of-service (QoS) and fairness are maintained throughout the collective flow. MF-TLP headers include tenant identifiers and priority classes that influence switch scheduling and link allocation. Fabric schedulers implement weighted round-robin or latency-aware policies that ensure high-priority collectives—such as time-critical gradient synchronization—receive preferential treatment, while background analytics share residual bandwidth. Telemetry modules embedded in MC-NICs 2216 periodically report throughput and latency metrics to an orchestration service, enabling dynamic adjustment of routing or priority weights for subsequent collective epochs.

In advanced embodiments, collective operations are executed in streaming mode. Instead of waiting for all contributors to complete before aggregation begins, the switch reduction engines perform pipelined accumulation on incoming data streams. Packets are combined as they arrive, and partial results are forwarded continuously toward the root. This streaming execution model overlaps computation and communication, providing near-linear scalability across thousands of nodes and eliminating global synchronization barriers.

Security and isolation are preserved even during large-scale collectives. Each collective group is associated with a group authentication key used to sign or encrypt MF-TLP packets. Switches and MC-NICs verify these signatures to prevent unauthorized injection of packets into collective flows. Multi-tenant fabrics can thereby execute independent collectives concurrently without data leakage or interference.

Therefore, this demonstrates how the coherent memory fabric of the present embodiment elevates the interconnect to an active, computation-capable fabric. By executing reductions, gathers, and other collective operations directly within switches and NIC hardware, the system eliminates host-processor bottlenecks, reduces bandwidth consumption, and provides deterministic, scalable performance for distributed AI training, analytics, and multimodal data processing. This embodiment forms the foundation for higher-level orchestration systems that exploit in-fabric collectives as first-class primitives for large-scale, memory-centric computing.

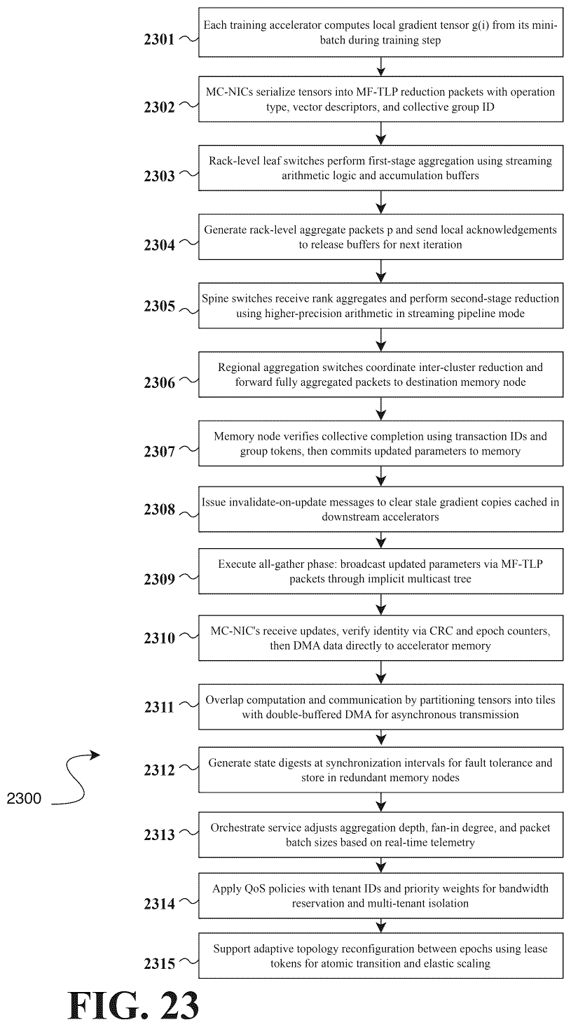

FIG. 23 is a flow diagram illustrating an exemplary method for a hierarchical collective execution flow 2300 for large-scale distributed model training using the coherent memory fabric and the memory-fabric transaction layer protocol (MF-TLP). This shows how reduction and all-gather collectives are executed across multiple hierarchical tiers—device, rack, cluster, and data-center—through a combination of MC-NIC-resident computation, in-switch aggregation engines, and directory-coherent memory nodes. The architecture enables trillion-parameter language-model training to scale efficiently across thousands of accelerators while maintaining deterministic synchronization and minimizing inter-rack network congestion.

In an initial step 2301, each training accelerator within the distributed system computes its local gradient tensor gᵢ corresponding to its assigned mini-batch during the current training step. These accelerators, which include GPUs, TPUs, and AI ASICs, operate in parallel across thousands of compute nodes organized hierarchically into racks, clusters, and data centers.

In step 2302, the memory-centric network interface controllers (MC-NICs) attached to each accelerator serialize these gradient tensors into streams of MF-TLP reduction packets. Each packet is carefully structured with operation type specifications (such as REDUCE_SUM), vector descriptors that specify element ranges, the target fabric object identifier (FID) representing the global model parameter shard, coherence metadata for maintaining consistency, and a collective group identifier that associates packets with the current training epoch.

Moving to step 2303, these MF-TLP reduction packets are injected into the rack-level leaf switches that form the first tier of the aggregation hierarchy. The packets are routed through the fabric interconnect using predetermined paths defined by the collective routing policy, with MF-TLP headers parsed in hardware to direct packets along optimal aggregation paths.

In step 2304, the leaf switches perform first-stage aggregation using their integrated reduction engines, which consist of streaming arithmetic logic and accumulation buffers implemented in high-bandwidth on-switch SRAM. As packets arrive from multiple nodes within the rack domain, the reduction engine accumulates them element-wise, combining partial gradients from all local contributors to produce a rack-level partial aggregate p^{r}.

Proceeding to step 2305, once all local contributions have been received and processed, each leaf switch generates a rack-level aggregate packet and emits it upstream toward the spine switches. Simultaneously, the switches send local acknowledgments back to each contributing MC-NIC to signal completion of the first-stage reduction, allowing the NICs to release their buffers for the next iteration.

In step 2306, the spine-tier switches receive these rack-level aggregates from multiple leaf domains and perform second-stage reduction using higher-precision arithmetic logic. These switches operate in a streaming pipeline mode, enabling them to begin processing new packets even while previous aggregations are still in flight, thereby maintaining continuous data flow through the hierarchy.

At step 2307, regional aggregation switches coordinate inter-cluster reduction at the data center scale, combining the spine-level aggregates from multiple clusters into fully reduced results. These switches forward the completely aggregated packets toward the destination memory nodes that serve as the root of the reduction tree. The destination memory node's MC-NIC receives the fully aggregated packet and verifies collective completion using transaction identifiers and group tokens embedded in the MF-TLP headers. After verification, it finalizes the reduction and commits the updated parameter shard to the persistent memory array, ensuring the operation occurs coherently with respect to all sharers tracked in the fabric directory.

Moving to step 2308, before writing back the updated parameters, the node controller issues invalidate-on-update messages to all shares listed in the directory entry for the affected memory regions. These invalidation messages ensure that stale gradient copies cached in downstream accelerators are purged, guaranteeing that subsequent forward passes will consume the latest parameter values.

In step 2309, the system initiates the all-gather phase to distribute updated parameters back to all participating nodes. The memory node issues MF-TLP broadcast packets carrying parameter tensors tagged with sequence identifiers and coherence metadata, which propagate through the fabric via an implicit multicast tree rooted at the parameter memory. Rach spine and leaf switch in the hierarchy replicates these broadcast packets to all downstream links in their subtree, efficiently distributing the updated parameters throughout the entire system. The switches use hardware-based packet replication to minimize latency and maximize throughput during this distribution phase.

In step 2310, MC-NICs at each compute node receive the parameter updates and verify their integrity using CRC checks and epoch counters. Upon successful verification, they directly DMA the data into accelerator memory without requiring host CPU intervention, completing the collective operation cycle. The system initiates the all-gather phase to distribute updated parameters back to all participating nodes. The memory node issues MF-TLP broadcast packets carrying parameter tensors tagged with sequence identifiers and coherence metadata, which propagate through the fabric via an implicit multicast tree rooted at the parameter memory.

Concurrently in step 2311, the system maintains overlapping computation and communication by partitioning tensors into tiles. While the reduction engine processes tile t₁, accelerators are already computing gradients for tile t₂, with MC-NICs supporting double-buffered DMA engines that enable asynchronous transmission with separate completion queues.

In step 2312, at predetermined synchronization intervals, each aggregation tier generates state digests representing accumulated partials and sequence progress. These digests are stored in redundant memory nodes to enable rapid resynchronization if a switch or node fails mid-collective, with the MF-TLP layer supporting retransmission and idempotent replay semantics for deterministic recovery.

In step 2313, orchestration service analyzes real-time telemetry (link utilization, latency histograms, error rates) and dynamically adjusts aggregation depth, fan-in degree, and packet batch sizes for next epoch based on predictive models.

In step 2314, applying QoS policies using tenant identifiers and priority weights to enforce bandwidth reservation, implement weighted fair queuing in switches, and maintain isolation between concurrent multi-tenant training jobs sharing the fabric.

Finally, in step 2315, the fabric orchestration service continuously analyzes real-time telemetry including link utilization, latency histograms, and error rates from switches and MC-NICs. Supporting adaptive topology reconfiguration epochs using lease tokens for atomic transition and elastic scaling. This telemetry feeds predictive models that dynamically adapt aggregation depth, fan-in degree, packet batch sizes, and even topology configuration per training epoch, while enforcing QoS policies through tenant identifiers and priority weights to maintain isolation between concurrent multi-tenant training jobs sharing the same fabric infrastructure.

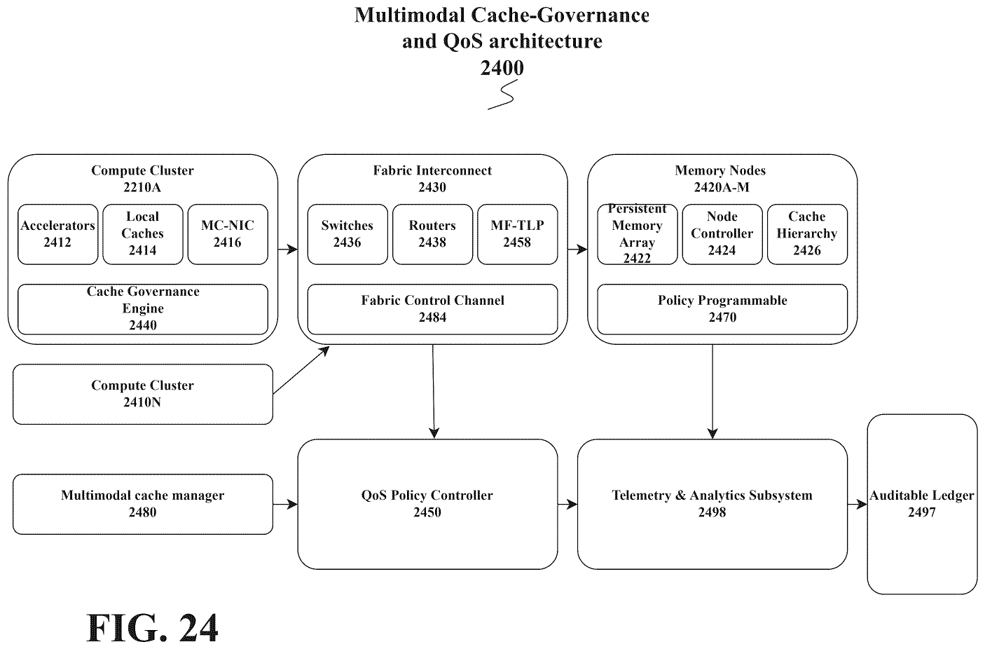

FIG. 24 is a block diagram illustrating an exemplary architecture of a multimodal cache-governance and quality-of-service (QoS) architecture 2400 implemented within the coherent memory fabric. The embodiment demonstrates how Memory-Fabric Transaction Layer Protocol (MF-TLP) metadata fields, programmable Memory-Centric Network Interface Controllers (MC-NICs), and fabric-level policy engines cooperate to provide tenant-aware cache management, workload prioritization, and performance isolation across heterogeneous compute and memory resources. This framework enables multiple AI and analytics workloads—potentially owned by different tenants or service domains—to share the same disaggregated memory fabric while maintaining predictable latency, fairness, and security.

The system comprises a plurality of compute clusters 2410A-2410N, each executing multimodal workloads such as image-text captioning, speech-to-text transcription, or cross-domain retrieval. Each cluster includes one or more accelerators 2412 (e.g., GPUs, NPUs, or ASICs) attached to local caches 2414 and connected to the fabric interconnect 2430 through MC-NICs 2416. The MC-NICs interface with distributed memory nodes 2420A-2420M, each comprising a persistent memory array 2422, node controller 2424, and cache hierarchy 2426 implementing multi-tier storage across high-bandwidth memory (HBM), dynamic RAM (DRAM), and non-volatile memory (NVM).

Each MF-TLP packet transmitted within the fabric carries embedded tenant and QoS metadata, including a Tenant-Identifier (Tenant-ID), a Service-Level Class (SLC), and a Priority Weight (PW). The Tenant-ID uniquely associates each transaction with a logical tenant, project, or workload, while the SLC and PW fields define latency sensitivity, bandwidth reservation, and preemption hierarchy. Upon packet ingress, both the MC-NIC 2416 and the intermediate fabric switches 2436 parse these metadata fields to determine routing, scheduling, and cache-allocation decisions.

Within each MC-NIC 2416, a cache-governance engine maintains a tenant cache ledger—a dynamically updated table tracking the proportion of local cache resources allocated to each active tenant or workload. Each ledger entry records the total bytes pinned, eviction priority, access frequency, and cumulative latency statistics. The cache-governance engine continuously reconciles ledger entries with real-time telemetry received from local cache controllers and fabric-wide policy managers. The MC-NIC adjusts replacement policies in hardware by modifying least-recently-used (LRU) queues, admission probabilities, and pinning flags on a per-tenant basis, thereby ensuring that cache occupancy aligns with predefined service-level objectives.

At the fabric level, a QoS-policy controller 2450 aggregates telemetry from all participating MC-NICs, switches, and memory nodes. Telemetry data include link utilization, average and tail latency, cache-hit ratios, queue depth, and transaction completion rate for each Tenant-ID. The controller applies multi-dimensional optimization algorithms to compute updated scheduling weights and cache-allocation budgets. These policies are then propagated to each MC-NIC and switch via MF-TLP control messages using a special management opcode. The entire loop executes at sub-second timescales, enabling continuous adaptive QoS regulation even under rapidly changing workload mixes.

Each switch 2436 and router 2438 in the interconnect fabric implements a tenant-aware scheduler with priority and fairness queues. The scheduler uses the SLC and PW fields to assign packets to appropriate service classes—such as low-latency control, real-time inference, or background training. Weighted round-robin or deficit-fair-queuing algorithms ensure proportional bandwidth allocation, while strict priority scheduling may be temporarily enabled for control-plane traffic. The scheduler also interacts with a fabric congestion manager, which detects persistent head-of-line blocking and dynamically adjusts per-tenant window sizes or throttling factors.

On the memory-node side, the cache hierarchy 2426 includes policy-programmable cache controllers 2470. Each controller hosts a policy-execution module that executes micro-policies loaded from the QoS-policy controller 2450. A micro-policy defines actions such as: Pin: retain a cache line for a specific tenant until expiration or explicit release; Promote: move a line from DRAM to HBM upon increased access frequency; Demote: migrate cold data to NVM under capacity pressure; and Invalidate: force eviction of stale lines when directory coherence signals updates from remote nodes. Policies are represented as compact state machines executed by programmable finite-state controllers, enabling line-rate enforcement without CPU intervention.

To coordinate across modalities, the system introduces multimodal cache integrated into the orchestration layer. This manager maps data types (e.g., image embeddings, speech spectrograms, text tokens) to modal priority classes. For instance, vision features required for cross-modal attention may receive hot-cache designation, while archived audio sequences are marked as cold-cache candidates. The multimodal cache manager communicates these designations to all relevant MC-NICs through a fabric control channel 2484, causing each NIC's cache-governance engine 2440 to reprioritize its local ledger entries accordingly.

In multi-tenant environments, isolation boundaries are enforced both logically and physically. Each tenant is assigned a virtual cache domain 2490, which may map to a subset of physical memory lines distributed across multiple nodes. MF-TLP transactions from one domain are prevented from displacing lines belonging to another domain through tag-based partitioning enforced by cache controllers. Optionally, cryptographic techniques—such as per-tenant encryption keys and integrity tags—may be applied to cached lines, ensuring confidentiality and tamper resistance across shared memory hardware.

The architecture also implements policy-driven eviction coordination across the fabric. When the QoS-policy controller 2450 determines that global cache pressure exceeds a threshold, it issues a fabric-wide eviction directive specifying target tenants or data classes. Upon receipt, each MC-NIC and cache controller performs prioritized demotion of selected entries while preserving lines associated with higher-tier SLCs. This coordinated eviction prevents thrashing and maintains balanced hit ratios among competing workloads.

Performance metrics are continually audited through a distributed telemetry and analytics subsystem 2498. MC-NICs, switches, and memory nodes export timestamped events—including MF-TLP queue depth, packet drop count, and cache latency histograms—to an analytics aggregator. The aggregator correlates this information to generate fabric health dashboards used by orchestration services for predictive maintenance and capacity planning. Machine-learning models running within the aggregator predict impending congestion or cache saturation and proactively recommend policy adjustments, which the QoS-policy controller 2450 enacts automatically.

In some embodiments, tenant migration or workload rebalancing occurs transparently through coordinated cache migration. When the orchestration layer decides to move a tenant's workload from one rack to another, the MC-NICs involved initiate cache replication transactions using MF-TLP vectorized reads/writes to copy the tenant's active cache lines to the new domain. Coherence metadata ensures that both old and new caches remain consistent until the migration completes, at which point lease tokens for the old region expire and ownership transfers atomically.

Security and accountability are enhanced by an optional auditable ledger 2497 maintained by the QoS-policy controller 2450. Each tenant's cache allocation, policy updates, and QoS adjustments are cryptographically signed and timestamped, enabling post-hoc verification of resource usage for billing or compliance purposes.

This describes a comprehensive framework for multimodal cache governance and quality-of-service control within the coherent MF-TLP memory fabric. Through tenant-encoded packet metadata, hierarchical policy propagation, programmable cache controllers, and real-time telemetry, the system achieves fine-grained performance isolation, adaptive resource allocation, and deterministic behavior for heterogeneous AI workloads. This design transforms caching and QoS from static configurations into dynamically orchestrated, fabric-wide services, supporting secure and efficient sharing of disaggregated memory resources across multimodal and multi-tenant computing environments.

In an additional embodiment, the cache-governance framework incorporates programmable caching-policy modules that enable fine-grained, real-time control of memory tiering and data movement. Each cache controller executes modular policies supplied by the orchestration layer to dynamically adjust line promotion, demotion, and eviction according to observed workload telemetry. These policies may be securely distributed and authenticated by the management plane, and may include autonomous learning components that adapt behavior based on cache-hit statistics or latency trends. The architecture supports telemetry aggregation, machine-learning-driven optimization, and fault-tolerant rollback of policy updates, allowing the coherent memory fabric to function as a programmable, self-tuning cache hierarchy responsive to both tenant governance and workload priorities.

In an additional embodiment, the coherent memory fabric extends into a unified AI-factory orchestration environment that integrates large-language-model (LLM) training, multimodal inference, and hierarchical policy control into a single disaggregated platform. The orchestration layer coordinates memory allocation, quality-of-service enforcement, caching, and collective operations across clusters and racks, forming a self-managing, self-governing computing fabric. The environment supports multi-tenant governance, telemetry-based adaptation, predictive resource scaling, and secure cross-modal data sharing. Through coordinated use of MF-TLP transactions, programmable cache controllers, and global policy orchestration, the system delivers deterministic performance, elasticity, and isolation for large-scale AI and analytics workloads operating across coherent, packet-switched infrastructures.

In one embodiment, the ReasoningBank functionality is realized as a dynamic ephemeral memory capsule mechanism built on IFERS's coherence capsule architecture. Each reasoning episode is encapsulated in a temporary coherence capsule that leverages the underlying memory fabric's ability to provide on-demand, bounded coherence windows for selected data. Within a capsule, the agent assembles relevant knowledge and intermediate results into a self-contained context that remains consistent for the duration of the task. The capsule state is maintained in a high-speed Immediate Ephemeral Layer of memory and tagged with a time-to-live (TTL) and scope (e.g., which agent or process threads participate), mirroring the hardware-level coherence capsules' participant-bounded semantics. When the task is completed or the TTL expires, the capsule commits any learned insights to long-term storage and then dissolves, ensuring that ephemeral working memory does not pollute the global state. This design allows the agent to rapidly create and tear down task-specific reasoning contexts, enabling agile adaptation to new problems while preserving global memory coherence.

In another embodiment, the reasoning-memory repository of the agent is structured into hierarchical memory tiers to prioritize and manage learned strategy artifacts. The tiers include an Immediate Ephemeral Layer (IEL) for freshly distilled knowledge (short-term memory within recent capsules), a Rolling Mid-Term Layer (RML) for strategies that have shown ongoing relevance, and a Deep Reservoir (DR) for long-term or foundational knowledge. Abstracted strategy artifacts (also referred to as memory capsules or templates) are promoted or demoted among these tiers based on metrics such as surprise value, usage frequency, contribution to successful outcomes, and recency of access. For instance, if a newly learned strategy from an ephemeral capsule leads to a significant performance boost (high surprise and high utility), the system promotes it from the IEL to the RML for continued use. Conversely, artifacts that become stale or less useful over time may be demoted toward the deep reservoir or pruned entirely. This hierarchical memory design ensures that the agent's reasoning bank remains both dynamic and focused: it retains critical learned strategies at-hand for rapid retrieval while gradually forgetting or archiving less useful knowledge. The IFERS framework's Strategy Abstraction Layer (SAL) oversees this process, abstracting raw experiences into machine-usable strategy representations and assigning them to appropriate memory tiers. By using SAL-managed coherence capsules for memory operations, the agent can safely update or query different tiers without interfering with other ongoing tasks, thereby maintaining stability in a multi-tenant or multi-task environment.

In another embodiment, each strategy artifact stored in the ReasoningBank is represented in a structured, machine-usable form that the reasoning engine can easily apply or adapt. For example, an artifact may be a symbolic template or program sketch encoding a generalized solution pattern, a decision-graph fragment capturing key branching logic, an MST-based structural fingerprint of an optimal plan, or a vector embedding enriched with metadata about its context. These artifacts are abstracted using the SAL to strip away task-specific details and capture the essence of the strategy in an architecture-native format (e.g., as a capsule graph or template). When the agent faces a new task, a retrieval interface selects a subset of relevant strategy artifacts from the repository based on the task representation (which may include the task's state, goals, or semantic domain). The selected artifacts serve as memory capsules of experience that condition the agent's reasoning process—for instance, by priming the reasoning engine with a proposed plan outline, constraints, or heuristics extracted from past successes. Because the artifacts are stored with rich structural metadata (e.g. domain tags or causal schemas), the retrieval can perform analogical matching, fetching strategies that solved analogous problems even if the surface details differ. This enables experience reuse: the agent leverages prior knowledge to guide new reasoning, reducing redundant exploration and providing a head start on complex tasks.

In another embodiment, the reasoning engine itself operates in a graph-of-thought execution framework native to IFERS, which synergizes with the capsule-based memory system. The reasoning engine can construct its problem-solving process as a directed acyclic graph (DAG) of logical operations or thought steps. Each node in this graph might represent a sub-goal or an intermediate inference, and edges represent dependencies or flows of information. This DAG can include branch nodes where multiple hypotheses or action paths are explored in parallel, and merge nodes where insights are combined—effectively a graph-of-thought strategy that allows branching and reconvergence of reasoning threads. Because the architecture supports such DAG execution natively, the agent can interleave memory retrieval and computation at various nodes: for example, at a branch node the agent may spawn a new coherence capsule to retrieve relevant strategies for that branch, or at a merge node it may commit a partial result into the ReasoningBank for future reuse. Alternative implementations of the reasoning engine include Monte Carlo tree search or other search/planning algorithms that benefit from memory guidance. For instance, a Monte Carlo Tree Search (MCTS) planner can use upper-confidence bounds to systematically explore actions, while consulting stored strategy artifacts as priors for promising moves. In reinforcement learning embodiments, the agent's policy-learning process (such as a policy-gradient or Q-learning algorithm) is augmented by the memory capsules: the agent treats the retrieved strategy artifact as an initial policy or as an exploration bonus, and the self-evaluation signals (described below) serve as additional reward shaping derived from past experience. In all such cases, framing the reasoning process as a graph or tree enables deeper integration with the memory system—partial results can be captured as subgraphs (capsules) and reused later, and the overall reasoning graph can be more efficiently traversed by reusing known good substructures.

In one embodiment, a judgment module monitors the outcomes of the agent's reasoning trajectories and produces self-evaluation signals that drive learning in the closed-loop system. This module evaluates each completed reasoning trajectory or intermediate decision against criteria such as success or failure of the task, confidence level of the result, novelty of the solution, and uncertainty or risk associated with the decision. The judgment module can be implemented via a combination of techniques: for example, rule-based checks or invariant validations for detecting obvious errors, simulation-derived correctness estimates (if a simulator or model of the environment is available), ensemble critic models or learned reward models that estimate the quality of an outcome, or even a large language model acting as a “judge” to score the plausibility of a reasoning chain. The self-evaluation signals generated (which may take the form of scalar rewards, confidence scores, or categorical feedback like “novel but risky”) are fed back into the agent's memory synthesis process. In real time, these signals inform which parts of a reasoning trajectory to trust, which strategies to generalize, and which mistakes to avoid in the future. During training or fine-tuning phases, the judgment signals also modulate gradient updates: for instance, a high-confidence successful strategy might be used to fine-tune the agent's policy network or value function, whereas a failure signal might trigger the agent to adjust how it retrieves or applies certain memory artifacts. By incorporating an explicit self-critique mechanism, the system ensures that memory updates (described next) are based on quality assessments, not just raw experience.

In another embodiment, the system includes a memory-synthesis module that transforms selected portions of reasoning trajectories and their outcomes into updated strategy artifacts for storage in the ReasoningBank. After an agent completes a task (or even sub-tasks within a larger problem), this module determines what new knowledge should be extracted and preserved. Guided by the self-evaluation signals from the judgment module, the memory-synthesis process filters out low-quality or irrelevant trajectory segments and focuses on the valuable insights—for example, a successful workaround that overcame a novel obstacle, or a preventative rule inferred from a failed attempt. The module then abstracts these insights into the representation expected by the memory repository (e.g., converting a sequence of actions into a generalized plan schema or turning a problem-specific solution into a domain-agnostic strategy template). In doing so, it may merge the new insight with existing artifacts or update an artifact's metadata. For instance, if two different trajectories arrived at complementary partial solutions, the memory synthesizer can fuse these into a single improved artifact: it might merge sub-structures from each to form a more complete strategy, select the best overall plan among them (a consensus), or even learn a meta-strategy for choosing between them in the future. This fusion can be orchestrated by specialized strategy fusion engines running within the agent or the memory fabric. In some implementations, the memory-synthesis uses IFERS's user-defined function (UFUNC) controllers at the memory-fabric level to perform in-network combination of strategy data. For example, the system can offload a merge operation to a UFUNC-enabled NIC or accelerator, which takes multiple candidate strategy artifacts as input and produces a unified artifact by computing a consensus or union of their knowledge. The result of memory synthesis is then committed to the reasoning-memory repository: new artifacts are stored (or existing ones updated) in the appropriate tier, ready to inform subsequent tasks. Crucially, this update is done in a thread-safe, coherence-controlled manner—for a single-agent system, the coherence capsule encapsulating the task ensures that memory writes (artifact updates) happen atomically at capsule commit. In multi-agent scenarios, a cross-agent memory synthesis workflow (described later) handles coordination so that only validated, non-conflicting updates enter the shared memory.

In another embodiment, the IFERS framework includes an Adaptive Elastic Funnel (AEF) controller that dynamically allocates computation and memory to reasoning based on task difficulty, novelty/surprise, uncertainty, or mission criticality. The AEF monitors signals including: (i) retrieval confidence from the hierarchical reasoning-memory (e.g., whether the current problem is well-covered by existing strategy artifacts in IEL/RML/DR), (ii) surprise/novelty metrics (deviation from prior distributions or SAL-labeled scenario priors), (iii) path-uncertainty in the active reasoning graph, and (iv) external criticality indicators (cost of error, safety, regulatory stakes). Upon trigger conditions—such as low retrieval confidence, high novelty, elevated uncertainty, or high criticality—the AEF scales up exploration for that task. Scaling occurs along multiple axes: parallel variant execution (spawn multiple independent trajectories/hypotheses for self-contrast), sequential self-refinement (extend the depth of a single trajectory and revisit earlier decisions), and on-the-fly breadth/depth control (adjust branching factor or lookahead horizon). The AEF enforces compute budgets and early-promotion/early-stopping rules and can fork an uncertain partial plan into diverging subpaths to probe alternatives. For high-stakes decisions (e.g., robotic surgery), the controller allocates maximal compute with redundancy and verification, while routine scenarios conserve resources—thereby applying elastic, context-aware test-time scaling consistent with the AEF design.

In another embodiment, outputs produced by parallel or sequential reasoning are fused into improved strategy artifacts through a compositional artifact-synthesis module that both yields the final answer and updates long-term memory. A judgment module evaluates each trajectory (success/failure, confidence, efficiency, loop detection) to rank/filter candidates. The synthesis module merges complementary substructures (e.g., one trajectory's high-quality plan with another's edge-case guardrails) into a unified strategy artifact, optionally accompanied by meta-policy cues encoding when to prefer particular tactics. Where trajectories yield distinct viable plans, the system may select a single best plan by consensus or predicted utility, while still committing alternatives for future reuse. Post-fusion, the system performs a memory commit that promotes artifacts to appropriate tiers (IEL-RML-DR) and records preventative rules distilled from failure traces. This turns extra compute spent during AEF-driven exploration into durable knowledge assets in the hierarchical repository.

In one embodiment, the hierarchical reasoning-memory and AEF operate in a closed-loop, self-evolving architecture across training, fine-tuning, and deployment. The loop integrates retrieval→scaled exploration→self-evaluation→memory synthesis/commit. During initial training (including simulation curricula), the AEF encourages deeper exploration in novel scenarios to bootstrap a broad base of artifacts; the SAL partitions experiences by domain and maintains capsules (e.g., navigation, language, control), each with domain-specific abstraction templates. In fine-tuning, retrieval is narrowed to SAL-relevant artifacts; the AEF often reduces breadth but increases depth for precision adjustments, while the synthesis module conducts gradient-aligned pruning/weighting to down-rank artifacts that conflict with observed update signals. In deployment, the same loop runs continuously: the SAL orchestrator prioritizes memory capsules and compute budgets from live feedback; out-of-distribution events temporarily elevate exploration in ephemeral capsules whose distilled learnings are later abstracted and committed to the Deep Reservoir (DR) for global improvement.

In another embodiment, the system leverages bootstrapped memory capsules and reinforcement-guided refinement during training to enrich the repository prior to deployment. Selected capsules may be pre-seeded with domain templates (e.g., mathematical reasoning patterns; basic robotic navigation) to jump-start capability. As the agent practices, self-evaluation signals (including critic/LLM-judge and outcome rewards) are used to refine strategy artifacts, akin to regret-minimization over abstraction choices. The platform periodically runs pruning and compression—e.g., influence- or gradient-based attribution—to remove stale or redundant artifacts and retain high-leverage patterns in RML/DR. The result is a lean, high-signal memory at handoff to production.

In another embodiment, IFERS extends to a distributed, multi-agent cloud-edge system. Each specialized agent (on robot, mobile, edge sensor, or cloud) maintains its local reasoning engine and local capsules within the hierarchical memory. A cloud orchestration engine decomposes incoming jobs into subtasks and assigns them to agents most likely to have relevant experience, using SAL domain labels and resource/latency constraints. A shared reasoning-memory service mediates knowledge exchange. For time-bounded collaboration, the orchestrator instantiates a distributed “coherence capsule” across participating agents via a memory-semantic fabric that provides low-latency, strongly consistent reads/writes on authorized artifacts only for the duration of that task. Agents co-edit constraints, propose strategy fragments, observe near-real-time updates, and converge on a joint plan. On completion, the capsule is closed; a normalized, abstract final artifact is committed to global memory, and local isolation resumes—delivering collaboration benefits without indiscriminate pooling.

In another embodiment, privacy and security govern multi-agent knowledge sharing. The shared service enforces tenant/agent-level isolation with namespacing and access control; artifacts are encrypted at rest and in transit and can be decrypted only within trusted hardware enclaves during authorized retrieval/fusion. For selected operations, homomorphic computation supports ranking/evaluation over encrypted artifacts. The SAL further ensures abstracted sharing (templates, distilled decision graphs) rather than raw logs. Policy constraints (e.g., data residency, safety rules) are applied to condition AEF decisions and sharing scope. A cross-agent memory-synthesis workflow performs validation and consensus (e.g., quorum of judgment modules) before promoting any shared artifact into the global Deep Reservoir. For long-running efforts, the orchestration engine inserts graph-of-thought checkpoints to capture validated sub-graphs mid-execution and commit them early, building a repository of reusable intermediate lemmas.

In another embodiment, the IFERS fabric-level orchestration performs scenario-based capsule prioritization to optimize across operating stages. The SAL (or a higher-level scenario manager) labels tasks/contexts by domain (e.g., navigation, conversational AL, industrial control) and maintains separate or overlapping pools of coherence capsules per domain. The orchestration engine tunes compute budgets and capsule sizes by scenario and continuously updates retrieval and AEF parameters from performance telemetry (success, quality, utilization). Parameter tuning is framed as contextual bandits/regret minimization, continuously learning how many trajectories to run and which memory tiers to favor per scenario across training (encourage exploration in weak domains), fine-tuning (focus depth on target domain), and deployment (continual meta-learning). This harmonizes hierarchical memory with AEF to deliver robust improvements across single-device and cloud-edge multi-agent settings.

In a preferred embodiment the Adaptive Elastic Funnel (AEF) controller operates as follows: it allocates additional compute at runtime based on retrieval confidence, novelty/surprise, uncertainty, or task criticality by adaptively varying (i) the number and concurrency of reasoning trajectories (parallel variants and/or sequential self-refinement), (ii) search breadth/depth (branching factor and look-ahead horizon), and (iii) early-stop/early-promotion criteria. This exemplary MaTTS-style implementation—referenced in the immediately preceding highlighted examples—represents one instantiation of the broader AEF framework, which may employ alternative adaptive compute allocation strategies. The hierarchical reasoning-memory stack (comprising IEL/RML/DR tiers and referenced in prior drafts as “ReasoningBank,” “memory bank,” or equivalent) stores abstracted strategy artifacts including human-interpretable, machine-usable templates (titles/descriptions/content), decision-graph fragments, and preventative rules distilled from both successes and failures. This stack is indexed and curated via the Scenario Abstraction Layer (SAL) with promotion/pruning policies informed by surprise, usage, contribution, and related signals. The system implements “closed-loop self-evolution” through a persistent cycle: retrieve→AEF-guided exploration→self-evaluation/judgment→compositional memory fusion & commit. This cycle operates across training, fine-tuning, and deployment to convert test-time compute into durable memory assets and improved future policy, implementing the feedback/continuous-learning loop.

In an embodiment, the fabric exposes an Attention-Window Streaming (AWS) opcode that delivers contiguous chunks of a tenant's KV window directly from memory nodes into on-GPU SRAM/HBM in decode order, with ordered visibility guaranteed by MF-TLP control lanes. The requester issues VREAD_AWS with a VECX descriptor encoding (layer, head, token-span) ranges; the destination MC-NIC (410/420) expands the descriptor, coalesces adjacent lines, and returns a single consolidated response in logical token order to avoid host-side reassembly. A small Window Sequencer behind 450 interleaves AWS returns with high-priority late-layer reads, honoring per-packet Priority/Tenant tags to preserve latency SLOs during decod. This eliminates host marshalling of thousands of strided reads and is enabled by MF-TLP's vector/extension and scheduler semantics.

In an embodiment, logits post-processing is offloaded to a Numeric-Aware Reduction (NAR) Logit Compressor integrated in 440, invoked by a REDUCE_LOGITS opcode carrying the NAR extension fields (InType/AccType/Codec/OutType, stochastic rounding, compensation) so that top-K or thresholded logits are computed in-fabric and returned in a compact, self-describing block format before sampling. The destination MC-NIC widens to AccType, executes a compensated tree reduce, then emits TOPK(K) or THRESH(τ) blocks per the NAR codec, reducing egress bandwidth and queue occupancy without changing storage semantics. This directly reuses the typed-reduction/NAR pipeline already disclosed for gradient fusion.

In an embodiment, the fabric provides a Speculative Decode Verifier (SDV) as a UFUNC program behind the scheduler to validate speculative tokens (e.g., draft or assistant tokens) in-place near memory. The requester sends UFUNC_EXEC{verify_draft} chained after a VREAD of model slices; the MC-NIC sandbox executes a bounded micro-program that re-evaluates a light check (e.g., layer-subgraph or rule constraints) over the speculative continuation and returns an accept/reject bitmap in a single completion, while the coherence interface fences any dependent cachelines before visibility to other consumers. UFUNC budget/attestation are enforced via the existing extension and scheduler guards.

In an embodiment, the MC-NIC implements a Sampler-as-a-Service (SaaS) operator that accepts compressed logits blocks (from the previous embodiment or GPU) and performs temperature, top-p/ε and repetition penalty entirely in-fabric, returning only the sampled token id and optional RNG seed update. The opcode UFUNC_EXEC{sample} consumes NAR-encoded logits (BMASK/TOPK/BFQ) and produces a token/score pair; stochastic determinism is provided by counter-based PRNG seeded from immutable MF-TLP header fields (TxnID, address, segment id) so retries are bit-identical. This collapses multiple host round-trips into a single fabric exchange and leverages the programmable micro-pipeline with bounded WCET and capability guards.

In an embodiment, Attention-Chunk Multicast (ACM) uses MF-TLP's switch-assist and directory hints so that identical attention chunks needed by many decode workers in the same rack are replicated at ToR and ack-merged upstream, turning an O(N) fan-out into O(branching-factor) traffic. The memory home sends a single DATA+CAF (coherence-assist flag) carrying a Sharer-Summary slice; ToR replicates to local subscribers and returns one aggregated acknowledgement, preserving ordered commit semantics at the home. This exploits the fabric's directory-assist and multicast/ack-aggregation disclosures while remaining packet compatible.

In an embodiment, Failure-Atomic Vector Parameter Update (FAV-PU) is used for paged LoRA/adapter deltas and routing-table pushes during live serving. The host issues VWRITE_TXN with the Vector-Tx extension (VTXE) in ALL_OR_NOTHING mode across non-contiguous pages, journaling redo entries in on-NIC persistent buffers, batching directory invalidations and persisting a commit marker before completion; the response includes a status bitmap so only failed lanes are retried. This ensures crash-safe, group-atomic deployment of model fragments and is natively supported by the vector-transaction and persistent-commit path already specified.

In an embodiment, Tokenizer/Detokenizer Near-Memory Kernels are realized as DSK (domain-specific kernels) over the UFUNC/programmable data-plane, accepting VECX-encoded byte streams and emitting token ids or vice-versa in a single consolidated completion. The kernel uses on-NIC scratch for rolling hashes and trie steps, with per-invocation budgets and bounded loops enforced by the verifier; results are committed with single-copy atomicity and directory invalidations before visibility. This offloads high-QPS, memory-bound pre/post steps from hosts without altering application semantics.

In an embodiment, Tier-Aware KV Placement (TA-KVP) binds MF-TLP's global address indirection to KV cache classes: hot KV shards map to Tier-0 (HBM-adjacent on NIC), warm shards to DRAM pool, cold shards to PMEM, with GAIT/PLR entries steering per-tier routes and REMAP_NOTICE handling online migration under coherence. A KV-class hint in an extension header allows the MC-NIC to admit reads from replicated RO-regions locally while scheduling background promotion/demotion via the placement manager, amortizing latency tails during long-context decode.

In an embodiment, DMTD-Compute Offload (DMTD-CO) extends the refill path so that early/middle layer passes for τ-1 tokens are computed in-NIC by a constrained UFUNC operator that applies a fixed, attested subgraph (e.g., Wq/Wk/V projections plus rotary) to produce batch KV entries near memory, followed by VWRITE_REFILL_KV scatter commit with ordered invalidations. The scheduler treats UFUNC compute as Bulk-class but allows deadline hints for decode cadence; capability/attestation guardrails ensure only approved subgraphs execute, preserving determinism and QoS isolation.

In an embodiment, Cross-Tenant SLO Guardrails for Serving are enforced by the per-tenant Security & QoS Complex (SQC): inference-critical classes (latency-class reads for late layers, AWS reads, SDV/SaaS control) are admitted to Coherence/Latency queues with deadline-aware EDF, while Bulk classes (refill, staging copies, optimizer checkpoints) are slice-scheduled and token-bucket limited per TenantID/ClassID. Under congestion, the scheduler borrows credits from Atomic to Coherence within configured caps and emits pacing hints, guaranteeing bounded p-tail for decode even in multi-tenant fabrics.

In an additional embodiment, Expert-Shard Multicast Coherence (ESMC) combines the MoE prefetcher with directory-assist so that co-activated expert shards are prepositioned and later updated (e.g., hotfix or A/B routing weights) via vector update+multicast with rack-local ack aggregation. The home directory scopes invalidations to racks predicted by telemetry, ToRs replicate updates to local compute MC-NICs, and a single upstream ack finalizes ownership, drastically reducing update latency while preserving correctness under the hierarchical directory semantics.

In a novel embodiment, In-Fabric Sharded KV Garbage Collection (SKV-GC) runs as a low-duty UFUNC background task: given a compact map of live token spans, the NIC performs vector mask-delete on stale KV slices in RO-replicated pools, returns a reclamation report, and triggers lease-token revocations or version bumps so future reads cannot observe reclaimed spans. The task is scheduled in BACKGROUND class with strict budgets and yields to Coherence/Latency traffic per the scheduler's class hierarchy.

In a novel embodiment, Sequence-Level Capsule Commit (SLCC) binds a coherence capsule to a full decode sequence: all KV writes, AWS reads, SDV checks and SaaS samples for a sequence execute within a capsule scope carrying a CAP/TTL and PART fields; at CAPSULE_COMMIT, the NIC tears down the micro-directory and persists optional audit tokens while exposing only final artifacts to other readers. This offers a scalable, bounded-scope coherence alternative to global domains for serving pipelines.

In another embodiment, the fabric supports live deployment of programmable UFUNCs to MC-NICs at runtime using a pair of MF-TLP control opcodes UFUNC_LOAD and UFUNC_SWAP, each carrying a UFUNC Deployment (UFD) extension header comprising: func_id (16-bit), version (16-bit monotonic), image_hash (256-bit), cap_vector (bitmask of allowed memory/object classes), wcet_cycles (32-bit bound), scratch_quota_kb (16-bit), concurrency_limit (16-bit), and attest_sig (elliptic-curve signature over header). The Protocol Parsing Engine (410) validates UFD, streams the code image into a sealed code store on the MC-NIC, and registers the program with the Program Context Table (PCT); the Scheduler/QoS Unit (450) will admit subsequent UFUNC_EXEC requests only when the program's version and budgets match UFD and the Verification Micro-Controller (VMC) asserts attest_ok for image_hash. A zero-downtime replace flow is provided: UFUNC_SWAP installs version+1 in parallel, gates new invocations to the successor, and drains in-flight contexts before finalizing. All steps ride ordered control lanes so that capability and version state cannot reorder relative to executions.

In another embodiment, runtime DSK-NIC kernel replacement uses a KERNEL_LOAD opcode with a Domain Kernel Descriptor (DKD) extension header carrying: kernel_id, type_sig, semantics (associative/commutative/compensated), numeric_modes (in/out types, rounding, stochastic seed policy), and limit_contract (cycles/scratch/state). The Atomic/Reduction micro-pipeline exposes a Kernel Dispatch Table (KDT) indexed by kernel_id so that REDUCE_CUSTOM packets can bind to newly loaded DSK kernels at line rate, reusing the Numeric-Aware Reduction (NAR) header and block codecs for bandwidth-efficient egress. The VMC enforces bounded loops and determinism; on violation, 450 raises ERR_OPLIMIT and aborts with coherent rollback per the base commit/visibility semantics.

In another embodiment, dynamic policy distribution is realized by POLICY_UPDATE packets carrying a Tenant QoS Policy (TQP) extension: tenant_id, class_weights (Coherence/AtomicNector/Bulk), min/max_rate per class (token-bucket), deadline_hint ranges, and borrow_caps (e.g., Coherence←Atomic). Upon ordered receipt, the SQC installs TQP in the QoS Policy Table, and the Scheduler immediately applies EDF within deadline-bearing queues and DRR across tenants, with credit borrowing bounded by borrow_caps. Counters for p50/p95/p99 latency, deadline miss/tardiness, per-class backlog, and backpressure episodes are exposed as telemetry vectors readable via POLICY_READBACK control packets, enabling outer-loop orchestration to adapt policies on sub-second cadence without resetting data plane state.

In another embodiment, the fabric introduces Self-Verifying Execution Capsules (SVECs) to bind code provenance and execution budgets to coherent visibility. An SVEC is initiated by adding a Capsule Control (CAPC) extension to UFUNC/REDUCE/GRS packets: fields include cap_id (64-bit), ttl_us (24-bit), participants (cardinality), cap_policy (must-attest, must-deterministic, snapshot-read), and optional AEAD tag over immutable MF-TLP fields. The MC-NIC parser (410) allocates an SVEC context; all operations bearing the same cap_id execute with verified code images and bounded WCET, and their commit is gated on (i) ordered invalidations/updates over coherence control lanes, and (ii) VMC's attest_ok. On CAPSULE_COMMIT, the NIC emits a single completion and tears down the capsule micro-directory; on CAPSULE_ABORT or TTL expiry, speculative results are discarded, guaranteeing that un-attested or non-deterministic executions never become architecturally visible.

In another embodiment, runtime secure update of UFUNC/DSK images is supported without halting packet forwarding by a two-phase activation: (1) LOAD_PREPARE places an image into a shadow slot; the VMC verifies signature and static properties (bounded loops, scratch bounds, type safety). (2) LOAD_COMMIT toggles the KDT/PCT pointer. In-flight invocations complete on the prior slot, while new invocations bind to the new slot; a drain barrier ensures no mixed-version reduction state coexists on the same address lines. The control path for LOAD_* runs on ordered lanes to serialize with respect to the directory and scheduler state, ensuring global observability of version transitions.

In another embodiment, the fabric provides Dynamic Orchestration Messages (DOMs) to enable outer-loop autonomy. A TELEMETRY_PUSH packet carries rolling aggregates—queue depths per class, per-tenant latency histograms, VECX decode stalls, NAR codec hit-rates, UFUNC overrun counts—into a Telemetry/Analytics Subsystem, while ORCH_HINT directs MC-NICs to alter per-region CONSISTENCY_CLASS (SC/RC/WC/TM) or to shrink vector chunk sizes under congestion, respecting ordered-lane safety and directory ordering. The orchestration plane can also issue ROUTE_PREF to steer latency-sensitive flows to low-jitter paths and bulk flows to high-throughput paths, reusing the fabric's path-label hints.

In another embodiment, Trust-Elevated UFUNCs add a Trust Capsule (TRC) extension combining code_hash, attest_sig, capabilities, and nonce as Additional Authenticated Data (AAD) for MF-TLP encryption so that any tampering with semantics or capabilities is rejected before execution. The SQC enforces tenant/domain ACLs and per-program budgets; the parser validates the TRC before admitting the packet into the action pipeline. For multi-tenant fabrics, per-tenant key ladders derive traffic keys from hardware root keys, allowing UFUNCs to run on plaintext in NIC scratch while keeping wire payloads confidential; trust domains are enforced with namespace separation and capability binding to TenantID/CDID fields.

In another embodiment, the MC-NIC hosts a Live UFUNC Loader (LUL) sub-system: a micro-DMA paths images into sealed SRAM, computes on-NIC image_hash, verifies attest_sig, resolves relocations to NIC-resident service routines (vector gather/scatter, NAR, VECX decode), and emits an install ack to the orchestrator. The VMC integrates with 450 to ensure preemption points and WCET enforcement; any overrun triggers ERR_OPLIMIT and an abort before commit, preserving sequential consistency at line granularity and preventing starvation of Coherence/Atomic classes.

In another embodiment, Runtime Verification Exceptions (RVEs) are surfaced as negative completions carrying compact reason codes: UFUNC_TIMEOUT, UFUNC_TYPE_MISMATCH, UFUNC_BUDGET_EXCEEDED, ATTN_DET_FAIL. The Reorder & Retire unit converts RVEs into tenant-visible events without poisoning unrelated transfers, and telemetry increments per-tenant counters; escalation policies (e.g., program eviction on repeated RVE within a sliding window) can be enforced to preserve fabric stability under misbehaving tenants.

In another embodiment, hot-patch UFUNC fencing is accomplished by SWAP_FENCE: the orchestrator issues an ordered control packet identifying func_id, version_old, version_new and a fence cookie. MC-NICs bind new invocations to version_new and return the cookie in completions. Once a quorum of NICs report the cookie (or timeouts elapse), the orchestrator issues SWAP_RECLAIM to garbage-collect version_old. Directory ordering and ordered-lane binding ensure no mixed-version visibility on coherent lines during the transition.

In another embodiment, Data-Plane Introspection is supported via a Program Debug and Trace (PDT) extension which, when enabled by policy, accumulates per-invocation summary metadata—cycles consumed, scratch used, VECX elements processed, NAR codec selection—into a bounded on-NIC ring. The host or orchestrator retrieves summaries using PDT_READ packets over best-effort lanes; PDT is designed to never block commit or alter execution order, preserving real-time guarantees while enabling statistical observability and capacity planning.

In another embodiment, the Scheduler/QoS implements adaptive class mixing: Vector and Bulk classes are slice-scheduled into quanta (e.g., 32-256 elements) interleaved with Atomic and Coherence classes to avoid long head-of-line blocking. Deadline-aware EDF across Coherence/Latency queues selects earliest deadlines first; class credit borrowing allows Coherence to borrow from Atomic up to a configured cap under backpressure, documented in QoS telemetry and repaid as credits drain. The scheduler exports backpressure hints upstream to throttle issuance of large VECX vectors when ECN marks accumulate, maintaining bounded tail latency for latency-critical flows.

In another embodiment, Secure Multi-Tenant UFUNC Execution is achieved by tenancy-sealed code slots keyed by TenantID and CDID; the TRC binds code_hash to those identifiers, and capabilities are enforced per tenant. UFUNC programs cannot access memory regions outside their tenant/domain capability list, with capability indices validated in hardware for every LD/ST/ATOMIC/GATHER/SCATTER. The deterministic schedule and resource budgets guarantee a non-interference property: a misbehaving tenant cannot starve another's Coherence/Atomic traffic or violate their SLO envelopes.

In another embodiment, Consistency-Class Hints are carried as a CONSISTENCY_CLASS extension (SC/RC/WC/TM) and enforced; the orchestrator can re-tag regions at runtime via ordered control messages. Under TM regions, RSL/WSL logs and shadow commit logs are used; the VMC can act as a validation advisor, but failure to validate forces ABORT and architectural invisibility of partial results. This provides per-region tailoring of ordering and visibility semantics without changing application code.

In another embodiment, the orchestration plane maintains UFUNC catalogs and attestation registries, publishing catalog digests and capability constraints to tenants. Tenants request UFUNCs by func_id/version, and the orchestrator ensures availability across NIC cohorts. Anti-entropy periodically reconciles code slots and policy tables using CATALOG_SYNC control packets over ordered lanes, healing drift without halting traffic and ensuring consistent programmability across the fabric.

In another embodiment, Packet-Layer Encryption and Integrity include MF-TLP payload encryption and header-integrity with AEAD; TenantID, Opcode, Address/Vector, CDID/mm_class, and TRC fields form AAD. The SQC's key ladder derives per-tenant per-flow nonces (H(TenantID|TxnID|Sequence|Direction)), ensuring that header tampering is detected and rejected before execution. For wire-only compression (e.g., NAR responses), compression precedes encryption to preserve compression gains, as taught in the base NAR design.

In another embodiment, Dev-to-Prod Promotion of UFUNC/DSK kernels is formalized: tenants deploy to a staging cohort of NICs, collect PDT/telemetry, then issue ROLL_PROMOTE to expand to additional cohorts. Telemetry-driven traffic-shaping gradually increases the proportion of traffic to the new kernel (canary), and failures trigger ROLLBACK to the prior version. Cohort selection and promotion ride ordered control lanes, with directory and scheduler safety ensuring coherent visibility and SLO preservation throughout.

In another embodiment, the fabric exposes benchmark anchors via BENCHMARK_START/STOP control packets: a NIC calibrates vector throughput, reduction latency, class mix efficiency, and deadline miss rates under shaped test flows. Results are returned via BENCHMARK_REPORT to a fabric controller which uses the standardized metrics to calibrate class weights and budgets across tenants. The toolchain thus provides a unified, repeatable benchmarking surface for in-network compute and scheduling, addressing the orchestration/benchmarking gaps highlighted for adoption.

In another embodiment, Dynamic Function-Chain Graphs are realized by sequencing UFUNC and DSK kernels on a per-packet DAG, declared using a CHAIN extension header containing a compact list of kernel_id/opcode and data-dependency edges. The NIC expands the chain, ensures each stage's budgets and attestation prior to execution, and performs consolidated commit at chain end: either all outputs become visible under SC/TM semantics, or none (abort), preserving snapshot consistency across multi-stage transformations. The approach generalizes gather-reduce-scatter into programmable multi-stage pipelines with full coherence semantics.

In another embodiment, Fine-Grained Replay Safety is extended to UFUNC/DSK contexts by deriving the stochastic seed from immutable headers (TxnID, address/line_tag, segment_id, tenant), making retries bit-identical. The Reorder & Retire unit deduplicates using replay tokens attached to vector segments and UFUNC chains; negative completions include retry masks so that only failed elements or chain segments are retried, preserving bandwidth and latency predictability.

In another embodiment, Switch-Resident Assist supports replication/aggregation for control flows: switches cache Sharer-Filter Slices and can replicate SWAP_FENCE, POLICY_UPDATE, and small ORCH_HINT messages within a rack, returning a single upstream acknowledgement to the home NIC. This reduces control-plane fan-out and convergence time without altering directory authority or ordered-lane semantics.

In another embodiment, Persistent Control State (policy tables, catalogs, code slots) is guarded by MF-TLP's Fabric-Durable Commit (FDC): control updates write to persistent arrays, flush media, and only then release completions; optional Mirror2 durability class mirrors updates to a second NIC. Recovery replays commits idempotently to reconstruct policy/catalog state, ensuring operational continuity after power events, consistent with base durability semantics.

In another embodiment, Unified Orchestration APIs allow external controllers to push POLICY_UPDATE, UFUNC_LOAD/SWAP, CHAIN templates, and CONSISTENCY_CLASS transitions through MF-TLP control messages; SQC validates tenant authorization and enforces scheduling budgets. Publication of telemetry schemas (p50/p95/p99, misses, credit borrowings, backpressure) supports automated outer-loop control and capacity planning.

In another embodiment, a management-plane composition service assigns Coherence-Domain Identifiers (CDID) and Tenant Identifiers (TID) to composed memory regions, and the MC-NIC instantiates per-CDID lease epochs that gate visibility and ordering of MF-TLP transactions. The MC-NIC exposes per-CDID status bitmaps and congestion credits as telemetry, while hardware enforces isolation/QoS using the TID and priority fields already carried in MF-TLP headers, ensuring tenant-aware admission without changing the external API surface.

In another embodiment, NAR is extended with a Negotiated-Numerics (NN) capsule in the MF-TLP extension header: each request advertises an ordered set of acceptable codecs and precision/rounding policies; the destination returns an Acknowledged-Numerics (AN) capsule bound to the request's lease epoch. A Wire-Only-Compress bit signals that compression applies to the wire image while the commit into coherent memory remains full-precision, preserving determinism under fabric-wide coherence.

In another embodiment, the VECX facility is made compression-aware (VECX-CA): compressed descriptors (DELTA, BITSET, DICT, HYBRID) are expanded by the Descriptor Expansion Unit (DEU) into burst groups aligned to device-internal boundaries, while the Response Consolidator preserves single-completion ordering and may return a compact success bitmap for partial-success policies. Opportunistic pre-compression of responses reduces egress bandwidth without altering VECX's EOV single-completion semantics.

In another embodiment, Residual/Error-Feedback (EF) buffers used by NAR are tenant-scoped and cryptographically bound to an attested codec image identified in an MF-TLP extension field; a mismatch forces a hardware fallback to lossless or wire-only numerics while maintaining replay safety using the deterministic stochastic-rounding seed derivation already taught.

In another embodiment, the MC-NIC implements failure-atomic multi-pool vector commit: scatter/RMW vectors that span multiple targets are executed with a two-phase vector commit in which each lane carries a per-lane token; a hardware status bitmap records partial success, and a fabric fence releases global visibility only when all lanes complete within the lease epoch—else only failed lanes are retried under the original NAR/codec contract.

In another embodiment, collective-aware admission control binds NAR parameters across a fused Gather-Reduce-Scatter (GRS) so that the codec/scale/rounding policy remains constant for the collective's duration, eliminating numeric drift across multi-hop routes while preserving typed, compensated accumulation in the MC-NIC reduction pipelines.

In another embodiment, a Compression-Lease (C-Lease) augments coherence leases: a C-Lease tags a cache line or page range with (codec, scale, rounding, seed) for a bounded epoch; compatible readers validate the tag to avoid recompression, while writers invalidate the C-Lease and force re-negotiation alongside coherence actions, thereby reducing churn yet preserving directory consistency.

In another embodiment, the MC-NIC scheduler maintains a Codec Scheduling Table (CST) that co-optimizes path selection, NAR codec choice, and VECX tiling under a policy vector (latency target, power cap, and cost mode). The CST feeds into the existing EDF/credit scheduler, ensuring policy is enforced at the packet layer without altering application semantics.

In another embodiment, UFUNCs hosted in the MC-NIC accelerate codec side-computations: dictionary warm-start/refresh for VECX-DICT, per-page entropy/sparsity sketches to guide mode selection, and EF updates for lossy reductions. Sketches are exported via a control namespace so compilers and runtime shims can pre-select DELTA/BITSET/DICT or NAR codecs with foreknowledge of data distributions.

In another embodiment, the MC-NIC maintains Per-Page Entropy Maps (PPEM) and Per-Page Sparsity Maps (PSM) updated online from returned responses and local memory observations; the maps bias VECX mode selection (e.g., BITSET for clustered sparsity, DICT for skewed hot sets) and trigger tier promotion when entropy rises, improving steady-state codec efficacy without software intervention.

In another embodiment, dual-plane integrity is enforced for compressed flows by combining (i) a wire-plane checksum over the compressed payload and headers and (ii) a memory-plane Merkle path over the logical, decompressed words; a mismatch triggers lane-granular retries using VECX's POS-ordered response machinery, preserving single-completion semantics.

In another embodiment, codec-aware coherence extends the directory to track a numeric/codec view per sharer (e.g., “q8.3@seed S”). Readers with mismatched views are either lazily invalidated or re-materialized at the MC-NIC using the bound NAR policy before exposure to the requester, preserving bit-wise reproducibility under mixed decompression points.

In another embodiment, KV-cache streaming for transformer inference splits the cache across near-memory and a compressed tier: the MC-NIC executes a fused gather-quantize-pack UFUNC for cold segments under NAR, assigns a C-Lease to the packed region, and serves hot segments from uncompressed local memory. A predictive unroll prefetcher expands compressed segments into NIC SRAM to feed batched attention while maintaining ordered, single-completion responses.

In another embodiment, the NAR header carries a Stochastic-Rounding Determinism (SRD) field (seed/stream-id) derived from immutable MF-TLP identifiers as already taught, guaranteeing that stochastic rounding remains reproducible across retries, alternate paths, and heterogeneous endpoints for audit-grade replay.

In another embodiment, multi-path codec diversity reduces tail latency: a requester emits two MF-TLP sub-flows with distinct NAR codec settings (fast/light vs compact/heavy). The MC-NIC accepts the earliest verified completion and cancels the lagging twin using a Cancellation Token tied to the vector's status bitmap and POS ordering to avoid duplicated side-effects.

In another embodiment, Compression-Aware Flow Control (CA-FC) denominates credits in post-compression bytes. The MC-NIC continually learns expansion factors per flow from returned AN capsules and adjusts sender-side estimators to avoid buffer overruns caused by variable-ratio codecs while preserving priority of latency-sensitive coherence and reduction traffic.

In another embodiment, cross-tier shadowing maintains a lossy-compressed base plus an exact, sparse-masked delta shadow in near memory. A fused merge UFUNC applies the shadow to a freshly decompressed base on demand, achieving near-lossless effective accuracy with substantially lower steady-state bandwidth for iterative ML updates.

In another embodiment, a VECX coalescer in the MC-NIC issues a single macro-burst to a compressed backing region, decompresses once into NIC SRAM, and fulfills many lanes from the same slab while preserving POS ordering and EOV single-completion behavior, thereby amortizing decompression overhead across sparse gathers.

In another embodiment, management-plane “hints” (e.g., maintenance, energy-cap, burst-SLA) are translated into in-packet mode switches that toggle CST policies, NAR codec choices, and VECX tiling at the MC-NIC. The packet contract—not the control plane-remains the source of truth, and enforcement occurs within the existing MF-TLP governance/QoS fields.

In another embodiment, a Compression Heat Index (CHI) per tenant is computed from PPEM/PSM, EF magnitude, retransmit statistics, and tail latency. The CHI controller automatically raises precision or disables lossy modes when accuracy risk is detected, flips to wire-only compression for numerically sensitive collectives, and proactively promotes hot regions to lossless tiers, all while preserving MF-TLP ordering and single-completion rules.

In another embodiment, epoch-bound snapshot/replay stamps a fence with (CDID, epoch, AN) and yields a fabric-consistent snapshot token; subsequent reads using that token must observe the same acknowledged numerics/codec as recorded, enabling reproducible analytics while other flows evolve under new policies.

In another embodiment, lane-local logical CRC is appended by the MC-NIC over decompressed words (while the wire carries only compressed payload+tag); verification occurs prior to exposure to the requester. Failures trigger lane-selective retries or alternate-path fetch using the SEGSEQ and POS machinery of VECX streaming.

In another embodiment, Compression-Miss Cost (CMC) integrates decompression cycles, expansion factor, path latency, and EF impact to drive near-memory hotset pinning: the MC-NIC pins lines with high CMC in local memory and demotes low-CMC lines to compressed backing tiers, maintaining SLA while optimizing bandwidth/$ across vector and collective traffic.

In another embodiment, MC-NIC architecture comprises several interconnected components that enable high-performance memory-fabric transactions. The core system includes a Parser 410, Verification Micro-Controller (VMC), Security/Key Controller (SQC), Descriptor Expansion Unit (DEU) for VECX operations, Atomic/Reduction unit 440 supporting typed atomics and compensated reductions, a Coherence/DIRECTORY interface, Scheduler 450 implementing an EDF+DRR hybrid with credit borrowing, Ingress/Egress DMA modules, a Telemetry/Control port, and an On-NIC SRAM complex containing command FIFOs, status bitmaps, per-tenant EF buffers, PPEM/PSM tables, and CST. Data flows through the system from ingress to Parser 410, through VMC/SQC gates, to DEU/VECX, then to Atomic/Reduction 440 and/or Coherence interface, through Scheduler 450, and finally to egress. Control flows run from VMC/SQC to Scheduler 450 for admission control, from Scheduler 450 to Atomic/Reduction 440 for grants, with backpressure signals returned to Parser 410. The MF-TLP base header carries version, type, length, source ID, destination ID, transaction ID, CDID, sequence number, and priority fields, followed by zero or more extension capsules. The UFD (UFUNC Dispatch) capsule includes UFID, PCT-index, KDT-index, LeaseEpoch, and Flags. The DKD (Dictionary/Key Data) capsule carries DictID, DictVer, Mode, and inline seeds. The TQP (Tenant QoS Policy) capsule contains Class, EDF-Deadline, and BorrowCap fields. CAPC (Capability) and TRC (Trace/Replay/Commit) capsules carry attestation nonces, snapshot tokens, and commit sequence markers. The NAR capsule includes Codec, Precision, Rounding, Scale, WireOnly, and SRD-Seed fields. VECX descriptors encode Mode options of DELTA, BITSET, DICT, or HYBRID, along with BaseAddr, Stride, Lanes, LaneBitmap, POS, and EOV fields.

The verification Micro-Controller operates on UFUNC programs compiled to a restricted NIC-IR, analogous to eBPF semantics. The instruction set includes integer add/sub/mul operations, fused MAC, fixed-point shift/scale, min/max, saturating cast, compare/branch, bounded loop, table read/write, and vector map/reduce intrinsics, while prohibiting unbounded recursion and indirect jumps. The memory model defines two regions: RO for read-only capsule data that remains immutable during invocation, and R1 for bounded scratch space allocated per-tenant with size declared at load. All DMA and coherence side effects are expressed via declarative opcodes such as grs.map, reduce.add_typed, and coh.fence that compile to MF-TLP sequences under VMC mediation.

Static analysis in the VMC applies abstract interpretation to compute loop trip bounds from explicit pragma bounds or affine loop forms, rejecting any loop with unknown bounds. The system checks memory safety via region+offset interval analysis, side-effect discipline via a finite set of effect tags including READ_ONLY, REDUCE_T, SCATTER, and FENCE, and determinism by requiring explicit SRD seeds for any stochastic rounding intrinsic. WCET calculation assigns each NIC-IR opcode a tabled cycle cost, annotates loops with max_iters, computes total WCET as the sum of operation costs times count plus DMA_budget plus coherence fence budget, and compares against the TQP EDF-Deadline. Programs exceeding budget are rejected or forced into degraded mode such as WireOnly compression or smaller tile sizes.

The UFUNC lifecycle transitions through several states: Loaded, which upon successful verification becomes Prepared with an immutable PCT snapshot, then Active when bound to a LeaseEpoch, followed by Draining where no new binds occur while in-flight operations complete, and finally Retired. UFUNC_LOAD triggers entry to the Loaded state, UFUNC_VERIFY gates progression to Prepared, SVEC binding transitions to Active, UFUNC_SWAP marks the old function as Draining while the new enters Active, and completion of all status bits releases to Retired.

The Scheduler classifies traffic into CTRL, COH, VEC, BULK, and COLL (collectives) categories. Per-class queues implement an EDF wheel for CTRL/COH/COLL using deadline and sequence ordering where deadlines come from TQP in microseconds, with a guarded minimum grant ensuring starvation-free service. Deficit Round Robin handles VEC/BULK traffic with per-class quantum in bytes post-compression, where each dequeue decrements deficit by actual post-compression length and skips when deficit falls below zero until replenished. The borrowing mechanism allows VEC to borrow BorrowCap credits advertised in TQP when EDF classes are idle and VEC backlog exists, with borrow ledgers repaid by reserving a fraction of future DRR quanta until balance reaches zero. Preemption points cut VEC/BULK slices at POS boundaries or at maximum micro-slice size of 8 KB post-compression so CTRL/COH can preempt at bounded latency. Admission control NACKs packets lacking LeaseEpoch or with expired AN numerics back to Parser 410, while CST provides per-class codec caps and path hints.

The scheduling pseudo-order serves any CTRL older than deadline_now first, then serves COH until directory latency watermark is met, followed by COLL slices until collective CSV quorum is satisfied, runs DRR for VEC and BULK with borrowing if eligible, recomputes watermarks, and repeats the cycle.

Key data structures include the Program Context Table (PCT) entry containing UFID, NIC-IR hash, R0 base and length, R1 base and length, EffectsMask, WCET cycles, SRD seed base, and Flags. The Kernel Dispatch Table (KDT) entry holds KDT-index, UFID, TileShape parameters including rows, cols, and stride, NAR defaults for Codec, Precision, Rounding, and Scale, GRS signature, FencePolicy, and MaxInFlight. The QoS Policy Table (QPT-491) entry contains TID, Class, EDF-Deadline, BorrowCap, Priority, DropPrecedence, PathHint, and CMC threshold. The SVEC context micro-directory maintains SVEC-id, ReadSet hash, WriteSet hash, LeaseEpoch, StatusBitmap pointer, POS cursor, EOV seen flag, CommitToken, and FDC token. Ordered control lanes are implemented as virtual channels with strict priority: CTRL0 for attestation/leases, CTRL1 for directory invalidations, COH for coherence data, then COLL, VEC, and BULK. Each lane uses a monotonically increasing 24-bit sequence number scoped by SrcID, DstID, and Lane. Parser 410 validates in-order progression with gaps triggering re-request timers. Deadlock avoidance prohibits credit dependency inversions, with CTRL lanes having dedicated credits and ability to preempt VEC/BULK at POS boundaries. Mapping to transports including UET, InfiniBand, Ethernet, and CXL-over-Ethernet occurs via DSCPNC tags chosen to preserve physical ordering on CTRL lanes end-to-end.

The security and key controller derives per-tenant packet and UFUNC keys via HKDF-SHA3-256 using inputs of RootKey, TID, CDID, UFID, and Epoch to generate K_pkt for header MAC, K_capsule for capsule integrity, K_srd for SR seed wrap, and K_code for UFUNC image wrap. The RootKey is provisioned into the MC-NIC during attested bootstrap, tenant SubRoot keys are wrapped under RootKey and rotated on epoch boundaries, and the SQC exposes unwrap of K_code to VMC only after successful UFUNC attestation. Capsules including UFD, DKD, TQP, CAPC, and TRC carry truncated MACs verified on Parser 410 ingress.

A complete GRS transaction with UFUNC inside SVEC under TQP proceeds through multiple phases. In the prepare phase, the orchestrator emits UFD referencing a specific UFID, TQP specifying Class as COLL with EDF deadline of 250 microseconds and BorrowCap of 2, and NAR with DICT codec, q8.3 precision, stochastic rounding, and SRD-Seed, while allocating SVEC-id and activating LeaseEpoch E. During ingress, Parser 410 authenticates capsules using SQC MAC, VMC loads NIC-IR for the UFID, verifies bounds and effects, computes WCET within EDF limits, and binds SVEC to LeaseEpoch E. The gather phase sees DEU expanding a VECX-DICT for 4,096 lanes, Scheduler 450 issuing POS-sliced reads to sources, directory permitting shared reads, and PPEM/PSM hinting that DICT is efficient. In the reduce phase, Atomic/Reduction 440 performs typed compensated accumulation, SRD guarantees reproducible stochastic rounding, and EF updates are written to tenant EF buffer. During scatter, results are quantized per AN numerics with WireOnly set to 0 for committed quantization, and the status bitmap captures any lane failures. The fence/commit phase emits a TRC capsule with CommitToken, Scheduler 450 prioritizes fence on CTRL1, and failed lanes are retried with original AN. Finally, completion returns one EOV completion including compact success bitmap, SVEC transitions to Committed, and FDC token is persisted.

Failure recovery mechanisms handle multiple scenarios. During UFUNC_SWAP failure, the old UFUNC remains in Draining with its PCT snapshot pinned, new binds fail closed, and on restart the VMC reloads from FDC token, replays SVECs whose CommitToken is absent from the durable log, and honors status bitmap to re-issue only failed lanes. For mid-SVEC crashes, FDC records SVEC-id, LeaseEpoch, POS cursor, status bitmap, and optional CommitToken, with recovery replaying from the last POS boundary while ordered control lanes ensure fences and invalidations are re-applied in order. Attestation or key mismatches cause SQC to reject capsule MAC, dropping the packet with negative completion on CTRL0 and quarantining UFUNC code pages until re-attestation. Deadline misses trigger Scheduler 450 to demote the flow by switching to WireOnly or lower-ratio NAR, splitting VECX tiles, or escalating priority if policy allows, with a TRC note marking that committed numerics differ from requested.

Determinism and numerical contracts are enforced through SRD seeds derived as HKDF of K_srd with Seq, SVEC-id, and LeaseEpoch, ensuring retry and path-independent stochastic rounding. A dual-plane integrity scheme computes a wire-plane CRC over compressed payload and a memory-plane hash over decompressed logical words before exposure, with mismatches triggering lane-level retries using the status bitmap.

PPEM and PSM are updated lazily from return traffic, with PPEM binning byte-level entropy and PSM tracking lane occupancy and run lengths. CST selects codec, precision, and path tuples based on per-tenant Compression Heat Index (CHI) and Compression-Miss Cost (CMC). CA-FC counts credits in post-compression bytes, learning expansion factors from AN capsules and adjusting sender estimators to prevent buffer overruns.

Practical implementation bounds guide development without limiting scope. Maximum UFUNC image size is 64 KiB NIC-IR with R1 scratch limited to 128 KiB per tenant. VECX lanes per descriptor support up to 65,536 with micro-slices limited to 8 KiB post-compression. Status bitmap granularity provides 1 bit per lane with optional run-length encoding on wire. The sequence field uses 24 bits per lane requiring fence and flush on wrap. Deadline resolution operates at 1 microsecond with BorrowCap ranging from 0 to 255 quanta. Attestation uses SHA3-256 hash with capsule MAC using 64-bit truncated tags. These values are exemplary and may be scaled based on available SRAM and bandwidth resources.

In another embodiment, the architecture is extended with a CoherenceCapsuleRank-guided, fuzzy coherence capsule that adaptively recruits and manages participants for capsule-scoped directory coherence using machine-learned relevance signals derived from structured attention, while preserving the existing MF-TLP packet model, MC-NIC enforcement of OWN/VER/IMM/CAP/TTL/PART metadata, DAM-assisted multicast and acknowledgement aggregation, and Self-Verifying Execution Capsule (SVEC) commit gating. The base protocol retains the disclosed MF-TLP header fields—OWN (ownership token), VER (monotonic version), IMM (immutability/publish), CAP (capsule identifier), TTL (capsule expiry), and PART (participant cardinality)—and the capsule flow in which the home MC-NIC seeds a micro-directory keyed by CAP and address ranges or vectors, issues targeted invalidations or updates only to participants during the capsule, and tears down capsule state at COMMIT or TTL expiry to resume federated semantics. This embodiment introduces two new, optional MF-TLP extension elements within the existing extension header area: a CoherenceCapsuleRank Mask (CCRK) that compactly conveys a rank-ordered set of candidate sharers and address-range weights; and a Capsule Membership Policy (CAPMASK) that specifies thresholds, K-of-N budgets, and on-line adaptation rules for promotion and demotion among membership tiers. These additions are wire-compatible with the current MF-TLP header and extension facilities used for capsule control and switch-assist annotations, and are parsed alongside existing OWN/VER/IMM/CAP/TTL/PART fields at line rate by the MC-NIC.

In another embodiment, control-plane and data-plane responsibilities remain strictly separated for feasibility and safety. The CoherenceCapsuleRank inference runs on an orchestrator or DPU that already participates in the 15471C QoS and orchestration loop; the orchestrator transmits CCRK and CAPMASK via ordered control lanes using the existing ORCH_HINT and POLICY_UPDATE discipline to ensure deterministic application of control actions and to keep the learning system off the critical data path. The same QoS surface used for Tenant QoS Policy (TQP) distribution mediates capsule-related control traffic and rate-limits reconfiguration bursts. The viability framework's ordered control lanes and sub-second actuation cadence are preserved, allowing the ranking engine to steer capsule membership frequently while maintaining stability and correctness.

In another embodiment, the MC-NIC is augmented with a Rank Mask Unit (RMU) that is limited to decompressing CCRK into egress membership bitmasks, tracking per-candidate counters for read misses and version-conditioned stalls, maintaining compact watchlists (e.g., Bloom or quotient filters keyed by {addr, node}), and executing CAPMASK's promote/demote rules; no transformer executes in the NIC. Upon CAPSULE_BEGIN, the home MC-NIC seeds a “hard” participant set with the top-K ranked candidates and installs transient directory entries keyed by CAP and the vectorized address set; a “shadow” set drawn from the soft tail is monitored but not accorded full coherence messaging. Write or atomic operations within the capsule generate invalidations or updates to the hard set only, while shadow participants are serviced under federated rules using version-conditioned reads and immutable witness tokens, with the RMU promoting a shadow to hard if on-line counters or periodic low-cost re-ranking indicate rising relevance, bounded by the CAPMASK budget and PART limits. The capsule continues to carry the immutable OWN/VER/IMM/CAP/TTL/PART semantics in every MF-TLP transaction so that non-members remain correct under federated access, with reads optionally specifying VER≥X to block until a published or reduced version is visible. At CAPSULE_COMMIT the commit is gated both on aggregated acknowledgements for the current hard set and on attest_ok from the verifier, providing atomic, attested completion; if any step fails or TTL expires, speculative effects are discarded and capsule state is torn down.

In the preferred form, the system instantiates a fuzzy coherence capsule in which prospective participants are assigned graded membership values computed by an out-of-data-path ranking engine that implements an in-context ranking model (CoherenceCapsuleRank). The ranking engine forms a prompt comprising an instruction segment that encodes the capsule's intent and address-set summary, a query segment that captures workload-locality hints (e.g., recent read/write histograms and lease/epoch observations), and N document or cache segments that summarize candidate sharers or address-range blocks. During fine-tuning and inference, CoherenceCapsuleRank enforces inter-document block sparsity so that document tokens attend locally within each candidate while query tokens attend globally across the full prompt, and it introduces an auxiliary attention loss at a selected middle layer to sharpen the attention mass on truly relevant candidates. This architecture exploits the empirically observed emergence of query-document relevance signals in middle layers and converts them into efficient ranking scores during prefill, yielding an inference path that scales linearly with the number of candidates and supports alternate attention-based inference without full decoding. The resulting attention-derived relevance scores are normalized over the document tokens and aggregated into a per-candidate score S(q, d_k) that the engine exports as a rank-ordered shortlist and a soft tail.

In another embodiment, control-plane and data-plane responsibilities remain strictly separated for feasibility and safety. The CoherenceCapsuleRank inference runs on an orchestrator or DPU that already participates in the QoS and orchestration loop; the orchestrator transmits CCRK and CAPMASK via ordered control lanes using the existing ORCH_HINT and POLICY_UPDATE discipline to ensure deterministic application of control actions and to keep the learning system off the critical data path. The same QoS surface used for Tenant QoS Policy (TQP) distribution mediates capsule-related control traffic and rate-limits reconfiguration bursts. The viability framework's ordered control lanes and sub-second actuation cadence are preserved, allowing the ranking engine to steer capsule membership frequently while maintaining stability and correctness.

In another embodiment, the MC-NIC is augmented with a Rank Mask Unit (RMU) that is limited to decompressing CCRK into egress membership bitmasks, tracking per-candidate counters for read misses and version-conditioned stalls, maintaining compact watchlists (e.g., Bloom or quotient filters keyed by {addr, node}), and executing CAPMASK's promote/demote rules; no transformer executes in the NIC. Upon CAPSULE_BEGIN, the home MC-NIC seeds a “hard” participant set with the top-K ranked candidates and installs transient directory entries keyed by CAP and the vectorized address set; a “shadow” set drawn from the soft tail is monitored but not accorded full coherence messaging. Write or atomic operations within the capsule generate invalidations or updates to the hard set only, while shadow participants are serviced under federated rules using version-conditioned reads and immutable witness tokens, with the RMU promoting a shadow to hard if on-line counters or periodic low-cost re-ranking indicate rising relevance, bounded by the CAPMASK budget and PART limits. The capsule continues to carry the immutable OWN/VER/IMM/CAP/TTL/PART semantics in every MF-TLP transaction so that non-members remain correct under federated access, with reads optionally specifying VER≥X to block until a published or reduced version is visible. At CAPSULE_COMMIT the commit is gated both on aggregated acknowledgements for the current hard set and on attest_ok from the verifier, providing atomic, attested completion; if any step fails or TTL expires, speculative effects are discarded and capsule state is torn down.

In another embodiment, DAM-assisted replication in the switching elements is combined with the CCRK guidance to reduce invalidation fan-out and collapse acknowledgement implosion without altering directory authority. The home unicasts a single CAF-enabled coherence message whose CCRK hints allow the DAM to prioritize or pre-seed egress selection; switches replicate to downstream egresses, install per-transaction PAT entries, and aggregate acknowledgements using AAT tokens into a single upstream completion to the home directory controller. Correctness and ordering remain anchored by the home's directory and MF-TLP coherence metadata, with the home gating commit on the aggregated acknowledgement exactly as in the baseline flow, and with conservative fallbacks to CGID-named groups, Sharer-Cache (SC) hints, or broadcast-within-subtree when state is absent or stale. This composition reduces the algorithmic cost of invalidation from O(number of sharers) at the home to O(branching factor) in the fabric while preserving linearizability and providing per-tenant isolation via tenant-scoped SC/GT partitions.

In another embodiment, the fuzzy capsule composes with the region-selectable memory consistency classes to tailor ordering and visibility to the workload phase. For regions bound to Sequential Consistency (SC), the home directory maintains a single global order and the fuzzy capsule reduces fan-out by narrowing the aggregator's hard set while holding commit until ordered-lane coherence completion; for Release Consistency (RC), the capsule admits out-of-order local execution with explicit acquire/release fences, and CAPMASK policy may be tuned to promote readers that cause post-release revalidation; for Weak/Write-Combining (WC), background write coalescing proceeds with federated readers outside the hard set; and for Transactional Memory (TM) regions, the capsule wraps the transactional group so that read-set and write-set validation is combined with capsule-scoped directory ownership acquisition under SVEC control, enabling atomic, attested multi-line commits. The CONSISTENCY_CLASS selector, lease/epoch tokens, and transactional extensions already defined in MF-TLP provide the packet-visible contract for these behaviors, and the fuzzy capsule's selective recruitment further reduces the cost of coherence under each class.

In another embodiment, the ranking engine's training and inference procedures are explicitly defined. During fine-tuning on internal capsule logs, the model is trained with the standard next-token objective in combination with an auxiliary InfoNCE loss computed at a chosen middle layer 1* that pushes attention mass from signal-carrying query tokens toward the ground-truth relevant “document” blocks (candidate sharers or address ranges). At inference, the orchestrator constructs chunked prompts that map address-space blocks or node candidates to document segments, enforces structured sparsity so that each candidate self-attends locally while the query attends globally, computes attention logits over document tokens, normalizes over the candidate set to produce S(q, d_k), and exports the top-K list and soft tail as CCRK. This inference pathway is efficient because it leverages attention-based relevance during prefill without requiring full sequence generation, enabling sub-second control-loop operation at the scale contemplated by the orchestration framework.

In another embodiment, the method of operation comprises receiving a capsule begin request identifying an address-set and optional CAPMASK parameters; generating, by an orchestrator executing a CoherenceCapsuleRank model, a CCRK vector of candidate participants with ranked scores based on structured attention over chunked summaries; transmitting, over ordered control lanes, the CCRK and CAPMASK headers to the home MC-NIC; instantiating, at the home MC-NIC, a capsule micro-directory that assigns hard membership to the top-K candidates and shadow membership to a soft tail; issuing coherence invalidations or updates selectively to the hard set, while servicing shadow and non-members under federated version-conditioned reads and immutable witness tokens; adaptively promoting or demoting candidates between shadow and hard based on observed stalls, read-miss counters, and periodic delta-rank queries; aggregating acknowledgements in the fabric via DAM using PAT and AAT; and committing atomically under SVEC gating only after both aggregated acknowledgements are received and attest_ok is asserted by the verifier. If the TTL elapses or attestation fails, the capsule aborts, speculative effects are discarded, and federated access semantics resume.

In another embodiment, the system further comprises telemetry and governance surfaces that integrate the fuzzy capsule with the orchestrator's policy loop. Program Debug and Trace (PDT) accumulates per-capsule counters such as invalidations per hard member, late promotions, and version-stall frequency; BENCHMARK reports calibrate per-tenant budgets; and POLICY_UPDATE packets carry TQP descriptors that bound capsule-related traffic classes and deadline hints. ORCH_HINT messages are delivered on ordered control lanes to ensure deterministic actuation of CCRK/CAPMASK changes fabric-wide, meeting the viability requirement for stable sub-second control by construction.

In another embodiment, the fuzzy capsule provides quantifiable scalability and safety advantages over static capsule recruitment. Because only the top-K members receive capsule invalidations and participate in acknowledgement waves, the fabric's home-node amplification is bounded by K rather than the total potential sharer count, while DAM collapses acknowledgements to a single upstream completion. Outside the hard set, federated safety holds through version-conditioned reads and immutable witness tokens, and adaptive promotion acts as a guardrail when predictions are imperfect. The commit semantics remain those of attested transactional memory and are unaffected by the ranking heuristic: the home directory is still authoritative, ordered-lane coherence underpins linearizability, and SVEC enforces atomicity and attestation at COMMIT.

In another embodiment, variations include RMU implementations that prioritize ranked multicast on DAM trees by supplying the CCRK shortlist as a seed for GT/SC selection, with conservative fallbacks to CGID groups or Bloom-seeded Sharer-Summary TLVs; an optional consistency-aware CAPMASK that adjusts K and thresholds based on CONSISTENCY_CLASS and lease/epoch policy; and a vectorized mode in which a single vector packet carries OWN/VER/IMM/CAP context and applies CCRK across a compressed, non-contiguous address set, with the MC-NIC expanding and scheduling local micro-operations while preserving capsule semantics for touched lines. All such variations reuse the MF-TLP extension header area and switch instruction space already defined, integrate with the directory-assist module's PAT/GT/SC structures, and rely on the same per-tenant isolation and congestion-aware throttling mechanisms.

In another embodiment, a non-transitory machine-readable medium stores instructions that, when executed by an orchestrator processor, cause the system to construct chunked prompts describing capsule context and candidate sharers, execute a CoherenceCapsuleRank model with structured attention and an auxiliary middle-layer attention loss to obtain attention-derived relevance scores, compute a top-K shortlist and a soft tail from normalized document-token attention, transmit CCRK and CAPMASK over ordered control lanes, and update these controls based on PDT telemetry and capsule outcomes; and further stores instructions that, when executed by an MC-NIC, cause parsing of OWN/VER/IMM/CAP/TTL/PART/CCRK/CAPMASK, instantiation of a capsule micro-directory with hard and shadow membership, targeted invalidation and update issuance limited to the hard set, adaptive promotion/demotion of members under CAPMASK policy, and SVEC-gated commit after receipt of aggregated acknowledgements from the directory-assist module.

In view of the foregoing embodiments, the application of CoherenceCapsuleRank methods to capsule recruitment transforms coherence from a static, heuristic-driven expense into a predictive, policy-governed service. The structured-attention architecture and middle-layer attention signals provide an efficient and empirically validated ranking primitive that is order-of-magnitude more efficient at inference than full decoding baselines for in-context ranking, and, when combined with the capsule and DAM machinery, they yield a fabric that spends coherence budget only where it matters while preserving the system's strong safety and attestation guarantees. The result is a technically correct and highly utilitarian enhancement that integrates cleanly with MF-TLP packet semantics, MC-NIC enforcement, switch-resident replication/aggregation, region-selectable consistency, and SVEC commit gating, and that scales capsule coherence overhead from the number of potential sharers to the active hot set without compromising correctness.

In an additional embodiment, the system operates through a sophisticated orchestration between host systems and Memory-Centric Network Interface Controllers (MC-NICs), establishing a streaming paradigm that maintains coherence while dramatically improving throughput and reducing metadata overhead. At its core, FNSI transforms how data movement occurs across the memory fabric by treating streams as primary citizens rather than decomposed packet sequences, thereby enabling direct memory access patterns that maximize cache-line locality and minimize transaction overhead.

The stream establishment process begins when a requester initiates a STREAM_SETUP transaction carrying a StreamDesc extension that comprehensively defines the stream parameters. This descriptor contains critical fields including a 32-bit stream identifier for unique stream identification across the fabric, a 64-bit buffer base address specifying the host memory location, a 32-bit buffer length defining the stream capacity, a 16-bit credit quantum value that governs flow control granularity, an 8-bit notification policy that determines completion signaling behavior, and a memory model class designation that specifies whether the stream operates under ordered or elastic semantics. Upon receiving this setup request, the target MC-NIC allocates the necessary stream state within its internal management structures, establishes a binding between the stream and the tenant governance framework within the scheduler component, and responds with a STREAM_SETUP_ACK message containing an opaque handle that serves as the stream reference for all subsequent operations.

Once the stream is established, data movement proceeds through STREAM_DATA records that reference contiguous host buffer regions, enabling a fundamental shift in how the memory fabric handles bulk transfers. The memory access unit performs single, large Direct Memory Access operations directly to a Stream Buffer ring structure on the receiving host, completely avoiding the traditional scatter operation into individual packet buffers that characterizes conventional network interfaces. This architectural approach maximizes cache-line locality by maintaining data contiguity and reduces the overhead associated with managing multiple small transfers. The parser recognizes STREAM_* opcodes at line rate, maintaining full throughput while processing streaming semantics without introducing processing bottlenecks or requiring packet reassembly logic.

The notification system implements a threshold-based approach that dramatically reduces PCIe metadata traffic and cache thrashing compared to traditional per-packet I/O completion models. The system exposes the head and tail pointers of the Stream Buffer as host-mapped Memory-Mapped I/O words, allowing direct visibility into stream progress without requiring explicit polling or interrupt generation for each data unit. The MC-NIC updates the tail pointer upon DMA completion but critically only raises STREAM_NOTIFY interrupts when the difference between the current tail position and the last notified position equals or exceeds the configured credit_quanta threshold. This design ensures that ordered STREAM_NOTIFY completions are emitted only when producer and consumer pointers cross the predetermined notify_policy thresholds, consolidating multiple packet completions into single notification events while maintaining precise flow control.

The FNSI architecture seamlessly integrates with the existing MF-TLP backpressure and credit pipeline infrastructure to prevent buffer overruns under congestion or overload conditions. Backpressure signals from the fabric I/O component and memory subsystem propagate through the same credit-based interfaces already established between the scheduler and its downstream units. This integration ensures that stream ingress naturally stalls under congestion conditions without requiring packet drops or complex recovery mechanisms. The system maintains separate ordered lanes for control plane operations and elastic lanes for bulk data movement, consistent with MF-TLP's architectural separation of ordered and elastic traffic classes. When stream termination is required, a STREAM_CLOSE operation ensures all outstanding bytes are properly drained and associated state is cleanly freed, maintaining system integrity across stream lifecycle transitions.

In an advanced embodiment, FNSI provides deep integration with vector and Generalized Reduction System (GRS) operations through a STREAM_REF extension mechanism. This extension allows vector descriptors to directly consume streams as input sources, enabling the Descriptor Expansion Unit to transform the stream's contiguous memory regions into properly formatted element tuples. These tuples are then fed directly into reduction and Universal Function (UFUNC) processing paths, ultimately completing with a single consolidated response rather than requiring multiple intermediate operations. This architectural fusion collapses the traditional “stream to packetize to vectorize” pipeline into a single unified “stream to vector” operation within the NIC hardware, simultaneously reusing the one-packet consolidate semantics of vector/GRS transactions while maintaining directory-consistent commits through component.

The FNSI implementation incorporates comprehensive security and capability scoping through a sophisticated cryptographic framework. Each stream carries a StreamCap sub-header containing a per-stream capability Message Authentication Code (MAC) that cryptographically binds the stream to its TenantID, permitted opcodes, address class restrictions, and memory model class designation. The parser component validates this MAC as Additional Authenticated Data (AAD) under the link's Authenticated Encryption with Associated Data (AEAD) protocol, ensuring that any attempt to tamper with stream semantics results in authentication failure. This security model aligns seamlessly with the per-packet CapToken governance already established in the base MF-TLP architecture, extending the same security guarantees to streaming operations without introducing new attack surfaces or requiring separate security mechanisms.

For applications requiring durability guarantees, FNSI supports a DurableStream designation that fundamentally alters stream commitment semantics. When a stream is marked as durable, STREAM_COMMIT operations leverage PersistClass semantics, including PCommit for persistent memory commitment and Mirror2 for replication-based durability. These operations ensure that stream boundary markers achieve persistence or replication before becoming visible to consumers, effectively integrating durability with coherence at the transaction layer. This capability enables FNSI to support applications ranging from traditional networking to persistent memory programming and distributed storage systems, all while maintaining the same streaming interface and performance characteristics. The persistence module coordinates with the directory component to ensure that durability operations maintain consistency with the overall memory fabric coherence protocol, preventing scenarios where volatile and durable data could become inconsistent.

In an additional embodiment, an opportunistic Resource Interleaving (ORI) system represents a groundbreaking advancement in maximizing computational resource utilization within network-attached processing elements by intelligently exploiting pipeline stalls and idle cycles that naturally occur during high-priority transaction processing. The system operates through a sophisticated micro-scheduler embedded within the scheduler/QoS unit that identifies and leverages predicted pipeline bubbles caused by memory access latencies, coherence protocol waits, and other systemic delays to execute bounded, preemptible computational tasks without impacting the Service Level Objectives (SLOs) of primary workloads. This architectural innovation transforms what would traditionally be wasted processing cycles into productive computational opportunities, achieving significantly higher effective utilization rates while maintaining strict quality-of-service guarantees for latency-sensitive control and coherence traffic classes.

In the ORI system, a micro-scheduler operates as a sophisticated prediction and scheduling engine that monitors pipeline behavior at sub-microsecond resolution to identify exploitable execution windows. The system exports telemetry from the scheduler unit with unprecedented temporal granularity, enabling real-time identification of bubbles caused by memory subsystem stalls, coherence protocol delays, and fabric congestion events. When the prediction logic determines that a stall window will persist for a duration greater than or equal to the sum of a task's Worst-Case Execution Time (WCET_cycles) plus a configurable guard interval, the micro-scheduler becomes eligible to dispatch opportunistic compute tasks into the idle resources. This predictive approach ensures that opportunistic tasks can complete within the available window without interfering with the resumption of primary workload execution when the stall condition resolves. The ORI system introduces specialized task marking through the UFUNC_EXEC and DSK KERNEL opcodes that accept an EXEC_OPPORTUNISTIC flag along with a WCET_cycles bound parameter, explicitly identifying tasks suitable for opportunistic execution. These marked tasks must possess two critical properties: idempotency, ensuring that partial execution followed by preemption and restart produces correct results, and bounded resource consumption, guaranteeing predictable execution characteristics. The parser unit (element 410) extracts these parameters and binds the WCET_cycles specification into per-packet control registers, making this timing information immediately available to the scheduling infrastructure. The micro-scheduler implements comprehensive admission control by consulting multiple credit sources before committing to opportunistic task execution, including ingress elastic-class credits that indicate available input bandwidth, memory-unit credits from component 420 that confirm memory subsystem capacity, and egress TX ring credits from the fabric I/O unit 460 that ensure output path availability. Only when end-to-end credits across all these dimensions indicate a safe execution window does the system admit an opportunistic micro-slice for processing. The ORI architecture leverages existing preemptible execution context infrastructure within the UFUNC engine to enable seamless checkpoint and resume operations at micro-slice boundaries. The UFUNC engine maintains comprehensive execution state including the program counter, architectural registers, and scratch memory pointers, all of which can be atomically saved when preemption is required and restored when execution opportunities arise. When a pipeline stall terminates earlier than predicted or when a higher-priority task arrives, the micro-scheduler immediately preempts the executing opportunistic task, preserving its state for potential future resumption while ensuring zero impact on the latency characteristics of primary workloads. This preemption mechanism operates within individual time slices rather than across transaction boundaries, maintaining the macro-level Earliest Deadline First (EDF) and credit-based scheduling policies that govern overall system behavior while enabling fine-grained resource reclamation at the micro level.

The ORI system extends beyond simple pipeline bubble filling to encompass comprehensive cross-unit resource optimization across multiple computational elements within the network processing infrastructure. Idle ALU slots are dynamically identified and made available for opportunistic micro-kernel execution, with the system ensuring that only tasks meeting the WCET_cycles constraints are scheduled into these transient availability windows. Similarly, idle lanes within the Domain-Specific Kernel (DSK) library, including specialized processing elements such as QADD8_SAT for saturating arithmetic, HISTO for histogram operations, and TOPK for selection algorithms, accept ORI-flagged work when their deterministic scheduling analysis confirms completion within the available bubble duration. The Map Lanes and Combine/Reduce Tree infrastructure participates in this opportunistic execution model by accepting compatible work only when per-kernel scheduling guarantees can be met; otherwise, descriptors remain queued in the standard scheduling structures awaiting traditional execution slots.

Critical to the ORI system's correctness is its strict preservation of transaction ordering and coherence protocol safety despite the introduction of opportunistic execution. The fence-aware micro-sequencer ensures that completion ordering follows established synchronization semantics, preventing any possibility of memory consistency model violations due to opportunistic task interleaving. The system maintains complete separation between the opportunistic execution layer and the directory-based coherence mechanisms, ensuring that coherence safety remains unchanged from the baseline architecture. Opportunistic tasks complete atomically with respect to coherence observations, and their results are committed through the same consolidated response paths used by regular transactions, maintaining architectural transparency to external observers while maximizing internal resource utilization. The ORI system incorporates sophisticated thermal and power awareness through integration with platform-level power management infrastructure. A P-state governor, exposed through the same Memory-Mapped I/O (MMIO) telemetry namespace that reports credits, latency histograms, and backpressure episodes, continuously monitors system thermal state and power delivery headroom. When sustained die temperature approaches thermal limits or when Voltage Regulator Module (VRM) headroom diminishes below safe thresholds, the scheduler unit automatically reduces the ORI issue rate, throttling opportunistic task admission to maintain thermal design power compliance and preserve quality-of-service predictability for coherence and atomic transaction classes. This thermal-aware throttling operates as a smooth gradient rather than a binary on/off mechanism, allowing the system to extract maximum opportunistic compute capacity while respecting platform-level constraints. Through the comprehensive application of opportunistic resource interleaving across all available computational resources, the ORI system achieves substantial improvements in effective ALU duty cycle and overall computational throughput without requiring additional hardware resources or compromising existing performance guarantees. The micro-scheduler's sub-microsecond telemetry and prediction capabilities enable aggressive identification and exploitation of even brief idle periods, while the bounded, preemptible execution model ensures that these optimizations never impact primary workload latencies. The system's ability to operate within the existing credit-based flow control infrastructure means that backpressure and congestion management mechanisms continue to function correctly, with opportunistic tasks naturally backing off when system load increases. This architectural approach transforms the traditional trade-off between resource utilization and latency predictability into a win-win scenario where both metrics improve simultaneously through intelligent scheduling and resource management.

According to an additional embodiment, a Fabric-Native ML Evaluation (FAME) system represents a paradigm shift in machine learning model assessment by enabling comprehensive, cryptographically verifiable performance evaluation directly within the network fabric infrastructure, eliminating the traditional requirement to move data to external compute resources for model validation. The system operates through an extension of the MF-TLP protocol that introduces specialized ML evaluation opcodes, beginning with BENCHMARK_START, which carries a Benchmark Descriptor containing references to datasets and metric suites resident in fabric memory along with target identifiers for either UFUNC-based models (target_ufunc_id) or Domain-Specific Kernel implementations (DSK KERNEL_ID). This architectural approach transforms the MC-NIC from a mere data movement device into an intelligent evaluation platform capable of executing complete ML model assessments with cryptographic attestation, providing verifiable performance figures that establish trust in in-network ML deployments while maintaining the coherence and ordering guarantees of the underlying memory fabric. The FAME execution pipeline orchestrates a sophisticated workflow entirely within the fabric infrastructure, beginning when the memory access unit streams dataset shards from their residence in fabric memory directly to the computational units. The UFUNC engine or DSK kernels consume these data streams to generate predictions, operating under strict deterministic execution constraints that ensure reproducible results across multiple evaluation runs. These predictions flow to designated output locations while maintaining separation between ordered control plane operations and elastic bulk data movements. Upon completion of the prediction phase, an EVALUATE_RESULTS opcode triggers the invocation of a specialized evaluator UFUNC that loads both the generated outputs and the ground truth data from fabric memory, performing comprehensive metric computations including domain-specific measures such as accuracy for classification tasks, ROC-AUC for binary classification performance assessment, and ROUGE scores for natural language processing applications. The evaluator produces a typed, structured report that captures not only the raw metrics but also metadata about the evaluation context, enabling comprehensive performance analysis.

Central to FAME's trustworthiness is its enforcement of deterministic execution through the UFUNC verifier, which applies strict constraints prohibiting unbounded loops, random number generation, and system calls that could introduce non-determinism into the evaluation process. This verification ensures that re-executions of the same evaluation workload under identical TypeSig specifications and input data yield bit-identical metric results, establishing a foundation for reproducible ML benchmarking. The system maintains this determinism while respecting the fabric's ordering semantics, with control and dataset traffic utilizing ordered streams to preserve causality, while bulk example data leverages elastic traffic classes for maximum throughput. The fence-aware micro-sequencer manages timing boundaries and synchronization points, ensuring that directory linearization points are preserved throughout the evaluation process, thereby maintaining consistency with the broader memory fabric coherence protocol while enabling deterministic replay of complex ML evaluation workloads.

The FAME system culminates its evaluation process with the generation of a BENCHMARK_REPORT that undergoes cryptographic signing through existing UFUNC attestation paths, binding the performance metrics to both the TenantID and the CodeHash of the evaluated model. This cryptographic binding creates an unforgeable chain of trust linking the reported metrics to the specific model implementation and the tenant context in which it was evaluated, providing third parties with verifiable evidence of model performance. The attestation mechanism leverages the existing security infrastructure of the UFUNC framework, ensuring that any tampering with either the model code or the evaluation results would invalidate the cryptographic signature, thereby detecting attempts to misrepresent model performance. This cryptographically secured reporting enables trusted model deployment decisions in environments where performance claims must be independently verifiable, such as regulated industries or multi-tenant cloud infrastructures where model performance directly impacts service level agreements.

To support independent verification of evaluation results, FAME incorporates sophisticated durability mechanisms that ensure metric artifacts can be reliably retrieved and re-validated by third parties. The system includes a Durability Sequence Number (DSN) emitted by memory-side persistence logic when metric artifacts are flushed to persistent storage or replicated according to the configured PersistClass policy, which may include PCommit for local persistence or Mirror2 for cross-node replication. This DSN serves as a temporal anchor point, enabling third parties to issue reads with “at least as durable as DSN” semantics, guaranteeing they observe the complete evaluation state necessary for independent metric recomputation. The integration of durability with the evaluation pipeline ensures that performance claims can be audited long after the initial evaluation, supporting compliance requirements and enabling longitudinal performance studies across model versions.

FAME introduces an advanced reproducibility mechanism through Golden-Run Capture and Deterministic Replay capabilities that enable perfect reconstruction of evaluation executions across different devices and time periods. When the BENCHMARK_CAPTURE flag is set, the MC-NIC emits a compact Transaction Trace (TT) alongside the evaluation outputs, capturing critical execution metadata including vector descriptor identifiers, UFUNC FuncID and CodeHash values, TypeSig specifications, and consolidated-response dwell times that characterize the temporal behavior of the evaluation. This trace undergoes persistence through PCommit operations and may be replicated via Mirror2 protocols across multiple memory nodes for durability. Subsequently, a BENCHMARK_REPLAY packet can utilize this captured trace to replay the exact element ordering and timing fences on a different device, enabling cross-device reproducibility verification under identical contractual specifications. This capability proves essential for validating that model behavior remains consistent across heterogeneous deployment environments and for debugging performance variations observed in production deployments.

In an extension of the base FAME architecture, the system supports deployment of lightweight evaluator UFUNCs directly onto Top-of-Rack (ToR) and spine switches that provide restricted UFUNC execution profiles. The orchestrator installs these sampling evaluators into the network switching infrastructure, where they intercept every N-th evaluation stream in-flight for checksum verification and precision audits, while the home NIC continues to complete directory-consistent commits for the full evaluation workload. This architectural approach yields continuous quality telemetry with near-zero perturbation to tenant workloads, as the sampling occurs through passive observation rather than active intervention in the primary data path. The sampling evaluators can detect drift in model behavior, identify potential data corruption issues, and provide early warning of degraded model performance, all while maintaining the line-rate processing characteristics expected of modern switching infrastructure.

The FAME system achieves its capabilities while maintaining seamless integration with the existing memory fabric infrastructure, preserving all coherence, ordering, and persistence guarantees of the underlying MF-TLP protocol. The evaluation pipeline respects the separation between ordered and elastic traffic classes, ensuring that control plane operations maintain their latency and ordering properties while bulk data transfers achieve maximum throughput through elastic lanes. The system's use of the fence-aware micro-sequencer ensures that all evaluation operations respect transaction boundaries and synchronization requirements, preventing any possibility of coherence violations or ordering anomalies. Furthermore, the integration with existing persistence mechanisms means that evaluation results benefit from the same durability and consistency guarantees as regular memory operations, enabling FAME to support mission-critical ML deployments where evaluation correctness and availability are paramount. This deep integration ensures that FAME can be deployed incrementally within existing memory fabric infrastructures without requiring architectural changes or compromising existing workload performance characteristics.

In another embodiment, a Stream-Aware GRS (S-GRS) mode allows a single MF-TLP transaction to: (i) gather from a STREAM_REF, (ii) apply a typed UFUNC/DSK transform, then (iii) scatter to multiple typed destinations with batched directory updates—returning a single completion. The parser micro-sequences the fused chain, binding SC control to ordered lanes and elastic bulk to vector payloads, exactly as in the existing fused GRS semantics, but with stream ingestion as the gather source.

In another embodiment, FNSI adds deadline hints (deadline_ns) to STREAM_SETUP so that 450's deadline-aware policy can prioritize stream-bound control and small, latency-critical chunks under congestion while bulk slices remain elastic. The telemetry namespace is extended with per-stream P50/P95/P99, miss counts, and dwell times, enabling the control plane to tune credit_quanta and notify_policy online.

In another embodiment, the coherent memory fabric is configured to accelerate Large Language Model (LLM) inference by offloading the dequantization and correction of compressed Key-Value (KV) cache entries into the memory-centric network interface controller (MC-NIC) 400. This embodiment introduces a specialized in-NIC hardware engine, the Numeric-Aware Dequantization and Correction (NADC) Engine, which performs these transformations at line rate, thereby reducing fabric bandwidth consumption by up to 8× compared to transmitting uncompressed 16-bit data and freeing the primary accelerator's resources for core computational tasks. In this embodiment, the Memory-Fabric Transaction Layer Protocol (MF-TLP) is extended with a new opcode, designated VREAD_DECOMP_KV. This opcode signifies a vectorized read operation specifically for compressed KV cache data. An associated MF-TLP extension header is defined to carry metadata required for the transformation, including pointers to the memory locations of pre-loaded linear correction adapter weights and configuration parameters for a Hadamard rotation. An accelerator, such as a GPU 113, initiates the operation by issuing a single VREAD_DECOMP_KV transaction. The vector descriptor 316 within the packet header specifies the list of compressed KV cache entries to be fetched from the disaggregated memory pool. Upon receipt of a VREAD_DECOMP_KV packet, the protocol parsing engine 410 of the destination MC-NIC 400 recognizes the specialized opcode and dispatches the request to the NADC Engine. The NADC Engine is a new compute unit integrated with or adjacent to the existing atomic and reduction logic 440. Concurrently, the memory access unit 420 fetches the requested 2-bit compressed KV cache data blocks, along with their associated scale and zero-point metadata, from the local memory array 122. The NADC Engine executes a fixed-function, multi-stage, pipelined transformation on the incoming compressed data stream. The pipeline comprises the following stages: Dequantization: The engine first unpacks the 2-bit data and applies the scale and zero-point factors to restore an intermediate floating-point representation (e.g., FP16 or BF16). Hadamard Rotation (for Value Tensors): For data identified as value tensors, the engine applies a Fast Hadamard Transform. This is implemented in hardware using an efficient butterfly network of adders and subtractors, leveraging the computational properties of Hadamard matrices to perform the rotation with minimal latency. Linear Correction (for Key Tensors): For data identified as key tensors, the engine applies a learned linear correction to compensate for quantization errors. This correction is performed by a small, dedicated matrix multiplier within the NADC engine. The weights for this linear adapter are small and constant with respect to sequence length and are pre-loaded into a dedicated SRAM region within the MC-NIC by the fabric's hierarchical orchestration layer when a model or tenant context is established. After the NADC pipeline completes the transformation, the MC-NIC assembles the now fully-corrected, full-precision key and value tensors into a consolidated response packet. This response is transmitted back to the requesting accelerator. From the perspective of the accelerator, it has performed a single, logical read operation and has received ready-to-use, full-precision data, with the entire complexity of dequantization, rotation, and correction being handled transparently within the fabric. This operation is a read-side transformation and does not modify the canonical, compressed KV cache data stored in memory 122. As such, it preserves the single source of truth and does not interfere with the fabric's directory-based coherence protocol, as described in FIG. 5. Any updates to the KV cache itself would proceed as standard coherent write operations. The utility of this embodiment is significant, as it directly addresses a critical bottleneck in modem AI infrastructure, enabling the deployment of LLMs with much longer context lengths on existing hardware by drastically reducing the memory bandwidth required for KV cache access.

In another embodiment, the coherent memory fabric implements a Fabric-Level MoE Prefetch Orchestrator, a closed-loop, telemetry-driven system that leverages the predictability of expert selection in Mixture-of-Experts (MoE) models to hide the latency of expert parameter fetching. This system uses the fabric's native predictive prefetch capabilities, as enabled by the PREDICTIVE_PREFETCH MF-TLP opcode, to proactively move expert data into memory tiers closer to the requesting compute node before it is explicitly demanded.

The system operates through a continuous feedback loop between the data plane (MC-NICs) and the control plane (hierarchical orchestration layer). The process comprises three main stages: Prediction: The hierarchical orchestration layer, a core component of the architecture as described in paragraphs and, is augmented with a software or firmware component known as the MoE Prediction Module. This module ingests the real-time stream of telemetry from across the fabric. It applies a simple predictive model, such as a Markov model tracking expert selection transitions between layers or a frequency counter updated with data from the prefill stage of inference, to forecast which experts are most likely to be required in the immediate future for each active inference request; Prefetch Issuance: Based on these predictions, the orchestration controller issues high-priority PREDICTIVE_PREFETCH MF-TLP transactions. This is a first-class operation already supported by the MF-TLP protocol, as described in paragraphs and. The prefetch command targets the memory nodes 120 storing the predicted expert's parameters and instructs the fabric to move the data into a memory tier closer to the requesting compute node 110, such as a cache on the node's top-of-rack switch 132 or a memory node within the same rack.

This proactive data movement ensures that by the time the accelerator 113 requires an expert's parameters, they are already resident in a low-latency, high-bandwidth memory tier, effectively hiding the cross-fabric fetch latency. This prefetching mechanism is a speculative optimization. If a prediction is incorrect, the prefetched data is simply evicted from the local cache according to standard policies (e.g., LRU), and the accelerator issues a normal demand fetch. There is no correctness issue, only a potential for wasted bandwidth on mispredictions. The fabric's underlying directory-based coherence protocol ensures that if expert parameters are updated, any prefetched copies are correctly invalidated, guaranteeing data consistency. In a further aspect of this embodiment, a two-level optimization strategy is employed. First, at model deployment time, the global orchestration layer performs intelligent static placement. Using offline-profiled data on expert popularity and co-activation frequency, it can proactively replicate globally “hot” experts across multiple racks and co-locate expert pairs with high co-activation affinity on memory nodes within the same rack. Second, the dynamic prefetching mechanism described above operates as a real-time refinement on top of this static layout, handling the temporal, request-specific patterns that cannot be predicted offline. This combination of static planning and dynamic adaptation provides a comprehensive solution to the MoE data movement problem.

In another embodiment, the coherent memory fabric provides a DMTD-Aware Fabric Scheduling and Offload mechanism, a hardware-software co-design that leverages the fabric's intrinsic Quality of Service (QoS) and vectorized transaction capabilities to manage and accelerate the asymmetric computational pattern of Direct Multi-Token Decoding (DMTD). This mechanism ensures performance isolation between the algorithm's distinct phases, guaranteeing low latency for critical-path operations while maximizing efficiency for bulk data movement. The mechanism relies on tight coordination between the host scheduler on the compute device 110 and the hardware features of the MC-NIC 400 and MF-TLP-aware switches 132.

The system implements QoS-driven performance isolation to optimize the Disaggregated Memory Token Dispatch (DMTD) algorithm's execution. During the latency-critical partial forward pass of a DMTD cycle, the host scheduler tags associated MF-TLP packets with the highest QoS priority by setting appropriate values in the priority subfield of the Tenant ID field within the MF-TLP base header. Hardware-based Transaction Scheduling and QoS Units, present in both MC-NICs and switches, recognize these priority tags and grant preferential treatment by placing packets in high-priority queues and allowing them to bypass congestion from lower-priority traffic such as KV cache refill operations. This hardware QoS implementation is critical for preventing bandwidth-intensive phases from stalling latency-sensitive operations.

The system also implements vectorized KV cache refill offload for the cyclical refilling step of DMTD. This bandwidth-heavy operation, which writes newly computed KV cache entries for skipped layers, is offloaded to the fabric using a single MF-TLP transaction designated VWRITE_REFILL_KV. This vectorized write operation uses a vector descriptor to identify multiple tokens and their corresponding KV cache values. Destination MC-NICs leverage their native vector processing capabilities to execute highly efficient, parallelized scatter-write operations to their local memory arrays, ensuring maximum data movement efficiency for bandwidth-sensitive phases while the latency-sensitive phases receive prioritized low-latency service through the hardware QoS system.

In-Fabric KV Cache Dequantization introduces the VREAD_DECOMP_KV opcode, a vectorized read that instructs the destination MC-NIC to fetch compressed KV cache data and execute the NADC pipeline for dequantization, rotation, and correction before returning full-precision results. This is supported by the NADC Parameter Header extension, which carries pointers to memory locations of linear correction adapter weights and configuration parameters for Hadamard rotation.

MoE prefetching utilizes a Telemetry Extension Header that provides a standardized, compact format for transporting MoE expert selection telemetry, including request IDs, layer IDs, and expert IDs from compute-side MC-NICs to the orchestration layer.

The system extends MF-TLP and MC-NIC capabilities to provide direct hardware acceleration for parallel evaluation of sequential models including RNNs, state-space models, and diffusion models. These models, which involve sequential nonlinear recursions, can be parallelized by solving equivalent fixed-point problems where each iteration reduces to evaluating a Linear Dynamical System (LDS) using parallel scan algorithms.

The nonlinear recursion descriptor includes a scalar or vector parameter that modulates the magnitude of each iterative update, x(k+1)=x(k)+αΔx(k)x(k+1)=x(k)+αΔx(k). This parameter governs the aggressiveness of the solver's correction step. When enabled, the solver dynamically adjusts as based on convergence metrics (e.g., residual norm reduction, gradient magnitude, or stability thresholds). This allows the hardware to automatically dampen or accelerate updates-stabilizing oscillatory behaviour in stiff systems and improving convergence efficiency in well-conditioned regimes.

In-Fabric Parallel Scan introduces the LDS_PARALLEL_SCAN collective opcode to execute parallel scan as a native, first-class collective operation. Requesters initiate operations with a single packet carrying parameters including initial state, vector descriptors pointing to transition matrices in coherent memory, and destination addresses for computed state sequences. MF-TLP-aware switching elements and MC-NICs participate in hierarchical, tree-based execution of associative operators, with atomic/reduction blocks performing matrix operations. This transforms communication-heavy scans into single, efficient, hardware-accelerated fabric transactions.

Fused Jacobian Computation implements the FIXED_POINT_ITERATION opcode, which orchestrates entire fixed-point iterations within the fabric. This transaction composes Gather-Reduce-Scatter semantics with User-Defined Function capabilities, specifying gather descriptors for current state sequences, UFUNC identifiers for Jacobian computation, scatter descriptors for distribution, and implicit triggers for LDS_PARALLEL_SCAN operations. MC-NICs execute pre-loaded, sandboxed micro-programs that compute both next state estimates and appropriate Jacobian approximations, keeping the entire iterative refinement loop within the fabric to eliminate multiple host round-trips.

The MF-TLP fabric serves as the implementation layer for cooperative optimization between cloud tenants and infrastructure providers, enabling two control loops: a fast micro-level loop for real-time optimizations and a slower macro-level loop for strategic adaptations.

Micro-level control implements TENANT_INTENT extension headers allowing tenants to express preferences such as collective algorithm choices, compression budgets, or latency SLOs. Complementary PROVIDER_HINT headers are dynamically inserted by MF-TLP-aware switches to carry real-time infrastructure state information including congested path IDs and preferred reduction tree roots. MC-NIC schedulers and collective engines parse these headers to dynamically select optimal algorithms and topologies for specific transactions, enabling sub-millisecond adaptations at fabric speed.

Macro-level control introduces a native publish-subscribe mechanism using the FABRIC_EVENT opcode for low-priority control packets. These packets carry structured event data such as resource availability updates or impending failure notices. Tenant orchestration services subscribe by programming MC-NICs to listen for tagged events, which can trigger interrupts or queue placements for consumption by macro-level control loops like Kubernetes schedulers or distributed training frameworks. This creates a secure, scalable eventing system built directly into the memory fabric.

The system adapts multi-die chip telemetry principles to the data-center-level fabric, creating a built-in observability plane for performance tuning and debugging. MC-NICs and switches act as distributed data generators collecting fine-grained performance telemetry including vector operations, coherence invalidations, queue depths, and per-packet latencies into per-tenant buffers.

The TELEMETRY_CONTROL opcode family manages monitoring sessions through START_MONITORING commands containing unique session IDs. Participating MC-NICs determine local temporal regions of interest based on workload-specific events and forward this information to designated aggregator MC-NICs. Aggregators compute global temporal regions by analyzing all participant data and broadcast results back to nodes. TELEMETRY_DATA packets, tagged with tenant IDs, session IDs, and global region IDs, stream telemetry to central collection points, enabling reconstruction of time-coherent, fabric-wide views of distributed transaction execution. This fabric-native telemetry provides essential feedback loops for self-optimizing fabrics, supplying real-time data needed for cooperative control loops to enhance performance, reliability, and efficiency.

In an additional embodiment, the system is enhanced with a Hardware-Accelerated Fixed-Point (HFP) Solver, a specialized micro-engine that directly implements the theoretical framework for parallelizing nonlinear sequential computations using Linear Dynamical Systems (LDS). This embodiment transforms the complex, high-latency task of iterative fixed-point solving—which traditionally requires numerous round-trips orchestrated by a host CPU—into a single, atomic, “fire-and-forget” MF-TLP transaction that executes entirely within the fabric. The HFP Solver is designed to accelerate a broad class of sequential problems defined by the nonlinear recursion xₜ₊₁=fₜ₊₁(xₜ), which are common in generative AL, physics simulations, and optimization problems. By offloading the entire iterative loop to the MC-NIC, this embodiment dramatically reduces host CPU overhead and network traffic, enabling real-time performance for computations that would otherwise be prohibitively slow.

The HFP Solver is realized through a new MF-TLP opcode, SOLVE_NONLINEAR_RECURSION, and a dedicated controller integrated within the MC-NIC. The SOLVE_NONLINEAR_RECURSION opcode is accompanied by a Nonlinear Recursion Descriptor (NRD) extension header that serves as a complete manifest for the solver, providing the hardware with all necessary parameters to execute the task autonomously. The NRD contains several critical elements: a chain_id reference to a pre-loaded Dynamic Function-Chain Graph that allows the user to declaratively define the arbitrary nonlinear function fₜ that the solver will iterate upon; a solver_method enumerated type (e.g., NEWTON, QUASI_NEWTON, PICARD) that instructs the hardware on the specific linearization strategy to employ, allowing users to trade computational cost per iteration for convergence speed based on the mathematical properties of their problem; a jacobian_mode that specifies how the Jacobian matrix Aₜ₊₁ required for first-order methods like Newton's is to be computed (e.g., via an ANALYTICAL UFUNC provided by the user, approximated using FINITE_DIFFERENCES, or bypassed with IDENTITY for Picard iterations); an initial_guess_ptr fabric address pointing to the initial trajectory guess $x_{1:T}\hat{ }{(0)}$ which serves as the starting point for the iterative refinement; convergence_tol and max_iterations termination criteria that bound the execution, ensuring the hardware loop completes either upon reaching the desired precision or after a fixed number of steps; and an output_ptr destination fabric address where the final, converged solution will be coherently written.

Integrated within the MC-NIC's Scheduler/QoS Unit 450, a new Fixed-Point Iteration Controller (FPIC) acts as a stateful micro-engine that orchestrates the entire solving process. Upon receiving a SOLVE_NONLINEAR_RECURSION packet, the FPIC executes a hardware-accelerated loop without any host intervention. The process begins with initiation and state setup, where the Protocol Parser 410 identifies the opcode and routes the packet to the Scheduler 450, which delegates control to the FPIC. The FPIC reads the NRD, fetches the initial guess from fabric memory, and initializes its internal state machine with the iteration count set to zero. In the linearization phase, for the current iteration i, the FPIC invokes the specified UFUNC chain to compute the nonlinear function evaluation yₜ=fₜ₊₁(xₜ⁽ⁱ⁾). Based on the solver_method and jacobian_mode, it then derives the parameters for the Linear Dynamical System (LDS) that approximates the problem for this iteration: xₜ₊₁⁽ⁱ⁺¹⁾=Aₜ₊₁xₜ⁽ⁱ⁺¹⁾+bₜ₊₁. For a Newton iteration, this involves invoking a second UFUNC to compute the Jacobian matrix Aₜ₊₁, while for a Picard iteration, Aₜ₊₁ is simply the identity matrix.

The FPIC then dispatches the resulting LDS problem to the fabric's Atomic/Reduction Unit 440, a powerful hardware block natively designed for collective operations that executes an associative scan (parallel prefix) algorithm over the sequence length T. This step solves the linear system in logarithmic time, O(log T), producing the next trajectory guess $x_{1:T}\hat{ }{(i+1)}. Following this, the FPIC utilizes the vector capabilities of the MC-NIC's execution engines to compute the L2 norm of the difference between the new and previous trajectories: $error=∥x\hat{ }{(i+1)}−x\hat{ }{(i)}∥_2, with this computation also performed entirely in-network. The FPIC then compares the computed error against the convergence_tol. If not converged and the iteration count is less than max_iterations, the FPIC increments its counter and loops back to the linearization phase, using x⁽ⁱ⁺¹⁾ as the input for the next iteration. If converged or max_iterations is reached, the FPIC proceeds to the finalization step, initiating a coherent write of the final solution to the output_ptr via the Coherence/Directory Interface (430), ensuring the result is atomically visible across the fabric, and then sends a single completion packet back to the originating host, signaling the successful conclusion of the entire iterative process.

This embodiment provides a transformative leap in capability by moving beyond simple offloads to in-network algorithmic acceleration. In terms of latency reduction, a conventional software-driven approach would require each of the k iterations to necessitate multiple round-trips across the fabric: one to dispatch the computation of fₜ, another to compute the Jacobian, a third to launch the parallel scan, and a fourth to check for convergence, resulting in latency proportional to k times the network round-trip time. In stark contrast, the HFP Solver collapses this entire multi-roundtrip dialogue into a single transaction, with all iterations occurring at hardware speed within the fabric. For sequences of length T>100, this can yield a 10-100× reduction in end-to-end latency. The architecture provides complete host CPU offload, freeing the host processor from the burden of managing the iterative loop, checking for convergence, and scheduling network operations. This not only saves valuable CPU cycles for application logic but also eliminates context switching and OS scheduler overhead, leading to more predictable system performance. Furthermore, because the entire process is managed by deterministic hardware and leverages the fabric's native primitives—including the parallel scan and coherent memory commits—the solver guarantees bit-reproducible results and ensures that the final solution is consistent with the fabric's memory model.

This embodiment enables real-time, in-fabric acceleration of critical sequential models that were previously latency-bound. In generative AI sampling, each denoising step in diffusion models involves solving a nonlinear recursion to predict the next state, and the HFP Solver can parallelize the entire sampling trajectory, dramatically accelerating image, audio, and video generation. For physics and engineering simulations, implicit time-stepping schemes in complex simulations often require solving nonlinear systems at each step (e.g., xₜ₊₁=xₜ+Δt·f(xₜ₊₁)), and the HFP Solver can offload these solvers directly into the fabric, enabling faster and larger-scale simulations. In optimization problems, advanced optimization algorithms like sequential quadratic programming involve iteratively solving a linearized subproblem, and the HFP Solver provides a native hardware primitive for this core computational pattern.

### Exemplary Computing Environment

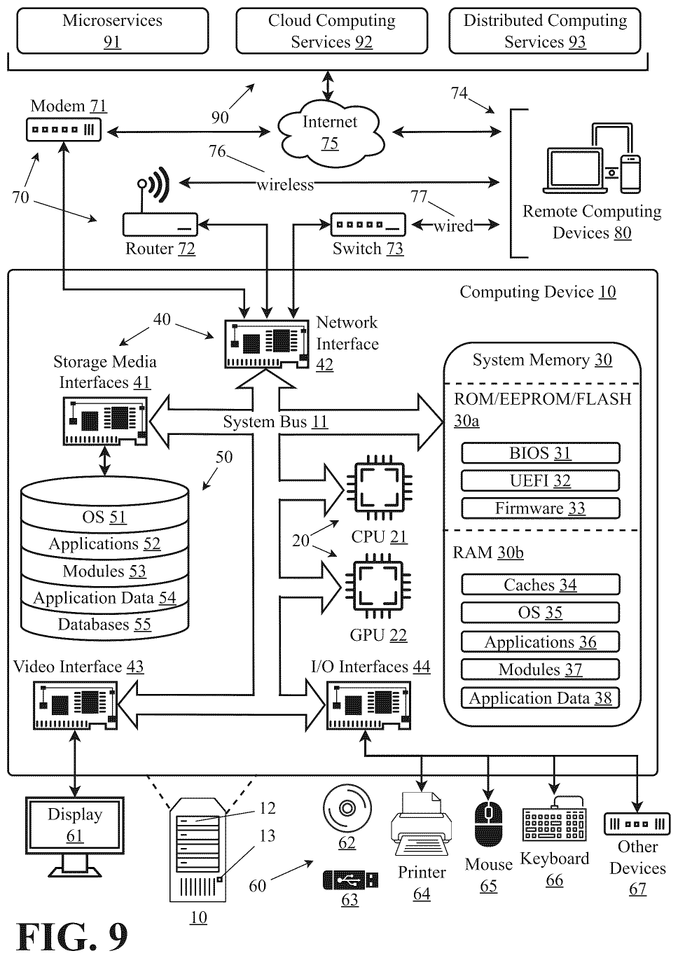

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 12, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

The adaptive elastic funnel system implementation necessitates a specialized hardware architecture that transcends conventional computing configurations to efficiently process high-dimensional scenarios and execute tensor network compression operations at scale. Computing device 10 incorporates custom-designed tensor processing units (TPUs) with sophisticated systolic array architectures featuring up to 16,384 multiply-accumulate (MAC) units arranged in a 128×128 matrix, enabling highly parallelized execution of tensor contractions with throughput exceeding 45 TFLOPS for 16-bit floating-point operations. These TPUs implement hardware-level support for tensor train decomposition with dedicated circuitry for singular value decomposition operations, reducing computational complexity from O(d\hat{ }n) to O(d·n) for n-dimensional tensors with dimension size d. The system further utilizes reconfigurable field-programmable gate arrays (FPGAs) with at least 2 million logic cells and 6,800 digital signal processing (DSP) slices, programmed with custom HDL-defined logic blocks specifically optimized for implementing differentiable logic evaluation structures and adaptive list labeling operations. These FPGAs achieve sub-microsecond latency for logical circuit evaluation through direct hardware implementation of sigmoid-based continuous relaxations of Boolean operations. For secure delegation operations, the system employs quantum-resistant secure enclaves implemented via trusted execution environments (TEEs) such as Intel SGX, AMD SEV, or ARM TrustZone, providing hardware-enforced memory isolation with cryptographic attestation capabilities and support for post-quantum cryptographic primitives including lattice-based encryption schemes such as CRYSTALS-Kyber. The memory subsystem implements a hierarchical architecture with at least three distinct tiers: high-bandwidth memory (HBM2E) incorporating 8-16 stacked DRAM dies connected by through-silicon vias (TSVs) delivering up to 1.6 TB/s bandwidth for the universal multi-modal KV cache operations; intermediate GDDR6X memory providing 1 GB/s per pin data rates for less latency-sensitive operations; and non-volatile memory express (NVMe) storage utilizing 3D-NAND technology with quad-level cell architecture for persistent caching of partial computations. This multi-tiered memory system is interconnected through a custom network-on-chip (NoC) topology that implements priority-based routing with quality-of-service guarantees, ensuring that criticality signals from the adaptive elastic funnel mechanism receive preferential bandwidth allocation. For distributed processing scenarios, the hardware architecture incorporates high-speed interconnects such as NVLink achieving 900 GB/s bi-directional bandwidth between processing nodes, or InfiniBand HDR providing 200 Gbps connectivity with remote direct memory access (RDMA) capabilities that minimize communication overhead during delegated task execution. This sophisticated hardware foundation is essential for implementing the adaptive elastic funnel's algorithmic innovations, including the hybrid greedy/non-greedy placement strategies that achieve O(log n (log log n)c) insertion complexity and O(1) amortized probe operations—performance characteristics that would be fundamentally unattainable using general-purpose computing hardware alone. Additionally, the system employs application-specific integrated circuits (ASICs) specifically designed for Monte Carlo Tree Search operations with dedicated random number generation units and tree traversal acceleration logic, delivering up to 10 million node evaluations per second for critical scenario exploration. This comprehensive hardware architecture provides the specialized computational foundation necessary for implementing the full scope of the adaptive elastic funnel system with the performance, security, and efficiency characteristics described throughout the specification.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

In certain implementations, the computing environment of FIG. 9 is augmented to expressly support fabric-coherent operation and CXL bridging: the interfaces 40 optionally include CXL 3.x ports capable of CXL.cache and CXL.mem transactions with switch and device-attach ports for Type-1/2/3 devices, and the system may instantiate a CXL Home-Agent Proxy (CHAP) that terminates CXL transactions and presents virtual Home Agent semantics to attached hosts and pooled Type-3 memory devices; the network interface(s) 42 may be realized as a memory-centric NIC (MC-NIC) integrating programmable packet-processing pipelines with on-NIC SRAM/TCAM, vector/atomic/reduction execution units, and a directory/coherence engine whose per-line metadata can be stored in HBM or on-package SRAM; the networking stack may support user-space kernel-bypass, in-switch multicast replication, per-packet capability tokens, authenticated encryption (AEAD), and protocol extension headers (e.g., BRGX) conveying TenantID, DomainID, lease epoch/TTL, consistency mode (e.g., SC/RCsc/RCpc/RMO), and reduction semantics to carry MF-TLP over Ethernet/UET, RoCE, or InfiniBand; directory metadata may be sharded across devices and kept in high-bandwidth memory with sharer filters (bitsets/Bloom filters) cached in on-NIC SRAM and with scalable acknowledgment-aggregation buffers to accelerate multicast invalidations and updates; non-volatile media (e.g., NVRAM, PMem, or mirrored persistent memory) may host write-ahead logging (WAL) and transaction metadata to support failure-atomic vector writes, two-phase commit, and per-element status bitmaps; the environment may translate processor fences (e.g., SFENCE/MFENCE) into fabric barriers with epoch increments to provide default sequential consistency while allowing programmable relaxed modes (RCsc/RCpc/RMO) where configured; a Security/Governance Engine (SGE) may map PASID/VMID/FunctionID to TenantID, enforce per-packet capabilities and optional AEAD, and implement per-tenant queuing, credits, deficit-round-robin/priority scheduling, and SLO constraints; control-plane integration may expose HCB regions via ACPI/PCIe tables and compose regions via Kubernetes CustomResourceDefinitions and a fabric-manager API, supporting hot add/remove by atomically updating bridge maps and migrating directory ownership with epoch barriers; optional datapath units may provide fixed-point or compensated floating-point (e.g., Kahan-style) arithmetic to ensure deterministic UFUNC/NAR reductions; and, unless expressly required, references to TPUs, quantum/optical accelerators, or other specialized devices are exemplary rather than limiting—the minimal configuration comprises CPU(s) with at least one MC-NIC/CTAN exposing CXL 3.x ports and a high-speed fabric port, with the foregoing functions realizable in hardware, firmware, or software on a single device or distributed across multiple devices.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on non-transitory machine readable storage media to:
establish a coherent, packet-switched memory fabric interconnecting a plurality of compute devices, accelerators, and memory nodes distributed across a data-center-scale topology;
implement a Memory-Fabric Transaction Layer Protocol (MF-TLP) defining routable packet formats for memory operations comprising read, write, vectorized, atomic, reduction, collective, and predictive-prefetch transactions;
operate a plurality of memory-centric network interface controllers (MC-NICs) each configured to terminate MF-TLP packets, translate the packets into local memory operations, and execute arithmetic, logical, or tensor transformations proximate to memory;
maintain fabric-wide coherence of distributed data objects and tensors by recording sharer information, enforcing lease or version policies, and propagating invalidation and update messages among caches and memory nodes; and
coordinate hierarchical collective routing and orchestration of MF-TLP packets through MF-TLP-aware switches implementing multi-path forwarding, congestion-adaptive scheduling, and in-network aggregation of model or tensor data.

2. The computer system of claim 1, wherein the MF-TLP protocol further supports predictive-prefetch directives that analyze temporal or attention-order telemetry to issue speculative read transactions that stage token or tensor shards into near-memory buffers before demand access.

3. The computer system of claim 1, wherein the MF-TLP packet comprises a header portion encoding one or more fields selected from: opcode, fabric identifier, object or tensor handle, vector or stride descriptor, tenant identifier, coherence metadata, priority tag, and transaction identifier, and a payload portion comprising operand or tensor data.

4. The computer system of claim 1, wherein the MC-NIC comprises a tensor-aware execution pipeline including a parsing engine, address-translation unit, vector and reduction engine, programmable cache-governance controller, and transaction scheduler configured for tenant-aware quality-of-service enforcement.

5. The computer system of claim 1, wherein the MC-NIC or an MF-TLP-aware switch performs collective operations comprising reduce, reduce-scatter, all-gather, or vectorized aggregation using associative or commutative functions on gradient or embedding tensors.

6. The computer system of claim 1, wherein the fabric enables multimodal tensor sharing among heterogeneous accelerators by mapping vision, audio, and language feature tensors to coherent memory objects accessible via vectorized MF-TLP read and write packets without host-mediated copies.

7. The computer system of claim 1, wherein the coherent fabric incorporates programmable caching-policy modules executing modular rules for pinning, promoting, demoting, or evicting cache lines in accordance with real-time workload telemetry, energy budgets, and service-level objectives.

8. The computer system of claim 1, wherein the MF-TLP fabric enforces tenant-aware governance using identifiers and service-class weights carried within packet headers to allocate bandwidth, control cache occupancy, and guarantee latency bounds across multi-tenant workloads.

9. The computer system of claim 1, wherein a hierarchical orchestration layer manages policy distribution, telemetry aggregation, and collective scheduling across rack-level and global controllers to dynamically rebalance workload, memory, and energy utilization.

10. The computer system of claim 1, wherein the coherent memory fabric supports elastic scaling and federated operation across clusters by dynamically extending the MF-TLP address space, replicating directory entries, and synchronizing model or tensor updates through asynchronous collective replication.

11. A computer-implemented method comprising executing software instructions stored on non-transitory machine-readable storage media for:
generating and transmitting Memory-Fabric Transaction Layer Protocol (MF-TLP) packets across a coherent packet-switched fabric interconnecting compute devices, accelerators, and memory nodes;
processing MF-TLP packets at memory-centric network interface controllers (MC-NICs) that terminate, translate, and execute arithmetic, logical, or tensor operations proximate to target memory;
maintaining fabric-wide cache and tensor coherence by updating sharer records, propagating invalidations or version tokens, and applying lease-based consistency; and
routing and aggregating MF-TLP packets through hierarchical collective topologies providing synchronized reduction, predictive prefetch, and congestion-managed multi-path delivery across racks or clusters.

12. The computer-implemented method of claim 11, further comprising encoding in each MF-TLP packet header an opcode, fabric identifier, vector descriptor, predictive-prefetch directive, tenant identifier, coherence metadata, and transaction identifier defining packet semantics and routing behavior.

13. The computer-implemented method of claim 11, further comprising executing predictive-prefetch operations by collecting telemetry from attention or workload streams, generating speculative MF-TLP reads for anticipated token or tensor ranges, and staging prefetched data in near-memory caches for subsequent use.

14. The computer-implemented method of claim 11, further comprising performing multimodal tensor exchanges wherein embeddings or feature maps produced by one accelerator are written into coherent memory objects and consumed by other accelerators through vectorized MF-TLP transactions without host intervention.

15. The computer-implemented method of claim 11, further comprising performing collective tensor reductions by aggregating partial tensors received from multiple compute devices through MC-NIC and switch-resident reduction engines executing associative arithmetic operations in the network.

16. The computer-implemented method of claim 11, further comprising applying programmable caching policies within MC-NICs or memory-node controllers, each policy defining promotion, demotion, or eviction behavior responsive to real-time cache-usage telemetry or tenant priority.

17. The computer-implemented method of claim 11, further comprising enforcing tenant-aware quality-of-service policies by reading tenant identifiers and priority weights from MF-TLP headers and adjusting queue scheduling, bandwidth allocation, or cache partitioning accordingly.

18. The computer-implemented method of claim 11, further comprising coordinating hierarchical orchestration among rack-level and global controllers to distribute policy modules, synchronize directory updates, and reconfigure collective trees based on telemetry feedback.

19. The computer-implemented method of claim 11, further comprising performing elastic scaling and federation by dynamically adding or migrating nodes, extending MF-TLP address ranges, and maintaining directory coherence across geographically distributed clusters.

20. The computer implemented method of claim 11, further comprising securing MF-TLP transactions and policy modules through authenticated headers, encrypted payloads, and auditable policy ledgers recorded by orchestration services to ensure integrity, compliance, and traceability across the coherent memory fabric.
